(19) United States
(12) Patent Application Publication
(10) Pub. No.: US 2026/0220288 A1
(43) Pub. Date: Jul. 30, 2026

(54) SYSTEMS AND METHODS FOR BUILDING MATERIAL BASED DETERMINATIONS

(71) Applicants: Emidio Antonio PIERMARINI, London Greater London (GB); Octagon I/O Ltd, London (GB)

(72) Inventors: Emidio Antonio Piermarini, London (GB); Raphael Scheps, London (GB); Kiran Singh, Stockton-on-Tees (GB); Oliver Nicholas Bennet Greet, London (GB); Eduardo Aguilar Pelaez, London (GB); Gideon Thorne Farrell, London (GB); Kyle Michael Michael Scheps, Geneva (CH); Djelal Osman, London (GB); Alessandro Lazzarini Barnabei, London (GB); Max Ronan Treacy, London (GB)

(73) Assignee: Octagon I/O Ltd, London (GB)

(21) Appl. No.: 19/146,793

(22) PCT Filed: Jan. 12, 2024
(86) PCT No.: PCT/US2024/011507

§ 371 Date: Jul. 9, 2025

Related U.S. Application Data
(60) Provisional application No. 63/438,772, filed on Jan. 12, 2023.
(60) Provisional application No. 63/438,777, filed on Jan. 12, 2023.
(60) Provisional application No. 63/544,091, filed on Oct. 13, 2023.
(60) Provisional application No. 63/605,990, filed on Dec. 4, 2023.

(51) Int. Cl. G06F 21/62

(52) U.S. Cl. CPC G06F 21/6218; G06F 2221/2141

(57) ABSTRACT

Methods, systems, and computer program products for construction data linkage are provided. An example method includes receiving a first data element including one or more first data values and receiving a second data element including one or more second data values. The method further includes determining an association between the first data element and the second data element and generating a data linkage between the first data element and the second data element based on the association. The first data element and the second data element are associated with a building element and may be associated with one or more of a spatial representation associated or a structural progress flow associated with the structure, a first sensor device, a crush test result, a mix identifier, and/or a status identifier associated with a construction site resource.

### TECHNOLOGICAL FIELD

The present international application claims priority to U.S. Provisional Patent Application No. 63/438,772, filed Jan. 12, 2023, U.S. Provisional Patent Application No. 63/438,777, filed Jan. 12, 2023, U.S. Provisional Patent Application No. 63/544,091, filed Oct. 13, 2023, and U.S. Provisional Patent Application No. 63/605,990, filed Dec. 4, 2023, the entire contents of which applications are incorporate by reference in their entirety.

### TECHNOLOGICAL FIELD

Embodiments of the present disclosure relate generally to building materials, such as those used in the construction of structures, and, more particularly, to sensor-based methods, systems, and techniques for determinations associated with building materials.

### BACKGROUND

Building materials, such as cementitious mixtures, are widely used in the construction of structures (e.g., foundations, substructures, superstructures, tunneling, etc.). Given the various material properties, performance, compositions, conditions, formulations, etc. associated with building materials and the potential for one or more of these details to vary with time (e.g., during a curing process or the like), accurate determination and tracking of these details is often useful to successful construction operations. Through applied effort, ingenuity, and innovation, many of the problems associated with conventional building material determination methods and systems have been solved by developing solutions that are included in embodiments of the present disclosure, many examples of which are described in detail herein.

### BRIEF SUMMARY

Embodiments of the present disclosure therefore provide for methods, systems, apparatuses, and computer program products for construction data linkage. An example computer-implemented method for construction data linkage may include receiving a first data element including one or more first data values and receiving a second data element including one or more second data values. The method may include determining an association between the first data element and the second data element and generating a data linkage between the first data element and the second data element based on the association.

Additionally or alternatively, in any of the embodiments described herein, the first data element and the second data element may be associated with a building element.

Additionally or alternatively, in any of the embodiments described herein, one or more of the first data element and the second data element are associated with one or more of a spatial representation associated with a structure; a structural progress flow associated with the structure; one or more data entries associated with at least a first sensor device; one or more data entries associated with a crush test result; one or more data entries associated with a mix identifier; and/or a status identifier associated with a construction site resource.

Additionally or alternatively, in any of the embodiments described herein, the data linkage between the first data element and the second data element may be determined based on the one or more first data values and the one or more second data values.

Additionally or alternatively, in any of the embodiments described herein, the data linkage between the first data element and the second data element may be determined based on one or more data entities other than the first data element and the second data element.

Additionally or alternatively, in any of the embodiments described herein, the data linkage between the first data element and the second data element and define an associated confidence value.

Additionally or alternatively, in any of the embodiments described herein, the data linkage between the first data element and the second data element may define one or more data dependencies between the first data element and the second data element.

Additionally or alternatively, in any of the embodiments described herein, the one or more data dependencies may be configured to dynamically modify the second data element in response to a modification associated with the first data element and/or dynamically modify the first data element in response to a modification associated with the second data element.

Additionally or alternatively, in any of the embodiments described herein, the one or more first data values and/or the one or more second data values may be generated based at least in part operations associated with a sensor device.

Additionally or alternatively, in any of the embodiments described herein, the data linkage between the first data element and the second data element may be updated in response to performance of one or more machine learning (ML) models.

Additionally or alternatively, in any of the embodiments described herein, the first data element and the second data element may be stored by a database including a plurality of data elements, one or more of which are associated with material identifiers indicative of respective formulations defining a proportion of constituent components forming the building material.

Additionally or alternatively, in any of the embodiments described herein, the method may further include receiving an access request associated with the database and permissioning access to at least a portion of the material identifiers stored by the database.

Additionally or alternatively, in any of the embodiments described herein, a method for construction data access may be provided. The method may include receiving an access request that includes one or more data entries associated with a user, determining one or more access permissions for the access request, and providing access to a database including a plurality of data elements, one or more of which are associated with material identifiers indicative of respective formulations defining a proportion of constituent components forming the building material.

Additionally or alternatively, in any of the embodiments described herein, the access request may be received in response to one or more sensor device registration operations.

Additionally or alternatively, in any of the embodiments described herein, the access to the database for the user may be limited based at least or in part one or more of the access permissions.

Additionally or alternatively, in any of the embodiments described herein, the access request may be received in response to the one or more measurement operations performed by a sensor device.

Additionally or alternatively, in any of the embodiments described herein, the one or more access permissions for the access request may be determined based at least in part on a material identifier associated with the one or more measurement operations.

Additionally or alternatively, in any of the embodiments described herein, the method may further include supplying one or more data entries associated with the user that are received with the access request to a machine learning (ML) model, wherein the one or more access permissions for the access request are based at least in part on an output of the ML model.

Additionally or alternatively, in any of the embodiments described herein, the method may include modifying the one or more access permissions of the access request in response to a modification to the one or more data entries associated with the user.

Additionally or alternatively, in any of the embodiments described herein, wherein the database including the plurality of data elements, includes one or more of which are associated with material identifiers indicative of respective formulations defining a proportion of constituent components forming the building material is iteratively updated.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described certain example embodiments of the present disclosure in general terms, reference will now be made to the accompanying drawings. The components illustrated in the figures may or may not be present in certain embodiments described herein. Some embodiments may include fewer (or more) components than those shown in the figures.

FIG. 1 illustrates an example system for building material determinations in accordance with an example embodiment of the present disclosure;

FIG. 2 illustrates an example supply chain with which, in whole or in part, the example system of FIG. 1 may be implemented in accordance with one or more example embodiments of the present disclosure;

FIG. 3 illustrates a block diagram of example circuitry (e.g., server circuitry) that may be specifically configured in accordance with an example embodiment of the present disclosure;

FIGS. 4A-4E illustrate example sensing considerations in accordance with one or more example embodiments of the present disclosure;

FIGS. 5A-5J illustrate various system and response charts for use in accordance with one or more example embodiments of the present disclosure;

FIG. 6 illustrates an example block diagram of a sensor device that may be used in accordance with one or more example embodiments of the present disclosure;

FIG. 7 illustrates an example block diagram of a piezo-based sensor device that may be used in accordance with one or more example embodiments of the present disclosure;

FIGS. 8A-8E illustrate an example piezo-based sensor device that may be used in accordance with one or more example embodiments of the present disclosure;

FIGS. 9A-9B illustrate installation of the example piezo-based sensor device of FIGS. 8A-8E in accordance with one or more example embodiments of the present disclosure;

FIGS. 10A-10B illustrate installation of the example piezo-based sensor device of FIGS. 8A-8E in conjunction with a container in accordance with one or more example embodiments of the present disclosure;

FIG. 11 illustrates installation of the multiple example piezo-based sensor devices in accordance with one or more example embodiments of the present disclosure;

FIGS. 12A-12B illustrate an example multi-piezo sensor device that may be used in accordance with one or more example embodiments of the present disclosure;

FIGS. 13A-13C illustrate an example dodecahedron device with multiple piezo sensors that may be used in accordance with one or more example embodiments of the present disclosure;

FIGS. 14A-14C illustrate example T-BAR resonator based sensor devices that may be used in accordance with one or more example embodiments of the present disclosure;

FIGS. 15A-15B illustrate example resonating elements that may be used in accordance with one or more example embodiments of the present disclosure;

FIGS. 16A-16B illustrate example ring shaped piezo resonating elements that may be used in accordance with one or more example embodiments of the present disclosure;

FIGS. 17A-17D illustrate an example optomechanical based sensor device that may be used in accordance with one or more example embodiments of the present disclosure;

FIGS. 18A-18B illustrate an example optomechanical sensing and electromechanical actuator resonance device that may be used in accordance with one or more example embodiments of the present disclosure;

FIGS. 19A-19C illustrate an example photomechanical device that may be used in accordance with one or more example embodiments of the present disclosure;

FIGS. 20A-20B illustrate example capacitive and inductive, respectively, sensor devices that may be used in accordance with one or more example embodiments of the present disclosure;

FIGS. 21A-21B illustrate example concentric coil based sensor devices that may be used in accordance with one or more example embodiments of the present disclosure;

FIGS. 22A-22D illustrate example conductivity measurement devices that may be used in accordance with one or more example embodiments of the present disclosure;

FIG. 23 illustrates an example spectroscopy based sensor device that may be used in accordance with one or more example embodiments of the present disclosure;

FIGS. 24A-24C illustrate an example laser-induced breakdown spectroscopy (LIBS) device that may be used in accordance with one or more example embodiments of the present disclosure;

FIGS. 25A-25E illustrate another example LIBS sensor device that may be used in accordance with one or more example embodiments of the present disclosure;

FIGS. 26A-26C illustrate an example suitcase LIBS sensor device that may be used in accordance with one or more example embodiments of the present disclosure;

FIGS. 27A-27D illustrate an example optical sensor device that may be used in accordance with one or more example embodiments of the present disclosure;

FIG. 28 illustrates a front view of hyperspectral imaging devices that may be used in accordance with one or more example embodiments of the present disclosure;

FIGS. 29-30C illustrate example hyperspectral imaging devices that may be used in accordance with one or more example embodiments of the present disclosure;

FIGS. 31A-31C illustrate an example embedded large area tunable MOEMS-Filter hyperspectral imager that may be used in accordance with one or more example embodiments of the present disclosure:

FIGS. 32A-32B illustrate an example non-embedded large area tunable MOEMS-Filter hyperspectral imager that may be used in accordance with one or more example embodiments of the present disclosure;

FIGS. 33A-34C illustrate an example piezoelectric cube sensor device that may be used in accordance with one or more example embodiments of the present disclosure;

FIGS. 35A-35B illustrate an example electrochemical cube sensor device that may be used in accordance with one or more example embodiments of the present disclosure;

FIGS. 36A-36B illustrate an example magnetochemical cube sensor device that may be used in accordance with one or more example embodiments of the present disclosure;

FIGS. 37A-37B illustrate an example mid frequency electromagnetic wave cube sensor device that may be used in accordance with one or more example embodiments of the present disclosure;

FIGS. 38A-38B illustrate a photonic wave cube sensor device that may be used in accordance with one or more example embodiments of the present disclosure;

FIGS. 39A-39B illustrate an example point cube sensor device that may be used in accordance with one or more example embodiments of the present disclosure;

FIGS. 40A-40C illustrate various example opening configurations for an assembled cube sensor device that may be used in accordance with one or more example embodiments of the present disclosure;

FIGS. 41A-47 illustrate various example attachment devices and mechanisms that may be used in accordance with one or more example embodiments of the present disclosure;

FIG. 48 illustrates an example attachment implementation that may be used in accordance with one or more example embodiments of the present disclosure;

FIG. 49 illustrates a flowchart of an example method for construction data linkage in accordance with some embodiments of the present disclosure;

FIG. 50 illustrates a flowchart of an example method for construction data access in accordance with some embodiments of the present disclosure;

FIG. 51 illustrates a flowchart of an example method for sensor context awareness in accordance with some embodiments of the present disclosure;

FIG. 52 illustrates a flowchart of an example method for spatial representation updating based on sensor context awareness data in accordance with some embodiments of the present disclosure;

FIGS. 53-58 illustrate a flowchart of an example method for material identifier determinations (e.g., mix fingerprinting) in accordance with some embodiments of the present disclosure;

FIGS. 53-58 illustrate flowcharts of an example method for material identifier determinations (e.g., mix fingerprinting) in accordance with some embodiments of the present disclosure;

FIGS. 59-60 illustrate flowcharts of an example method for structural building block related determinations (e.g., pour design and sequencing) in accordance with some embodiments of the present disclosure;

FIGS. 61-93 illustrate example milestone diagrams and building cycles as relevant to the structural building block related determinations of FIGS. 59-60 in accordance with some embodiments of the present disclosure;

FIGS. 94-99 illustrate flowcharts of an example method for material or mix identifier determinations (e.g., mix optimization) in accordance with some embodiments of the present disclosure;

FIGS. 100-115 illustrate example project logistics network and solutions (e.g., construction resource positioning) in accordance with some embodiments of the present disclosure; and

FIGS. 116-120 illustrate example user interfaces (UIs) that may be generated and/or presented to a user as related to any of the embodiments of the present disclosure.

### DETAILED DESCRIPTION

### Overview

Various embodiments of the present disclosure will now be described more fully hereinafter with reference to the accompanying drawings in which some but not all embodiments are shown. Indeed, the present disclosure may be embodied in many different forms and should not be construed as limited to the embodiments set forth herein; rather these embodiments are provided so that this disclosure will satisfy applicable legal requirements. Like reference numerals refer to like elements throughout.

The terms “illustrative,” “exemplary,” and “example” as may be used herein are not provided to convey any qualitative assessment, but instead merely to convey an illustration of an example. Thus, use of any such terms should not be taken to limit the spirit and scope of embodiments of the present disclosure. The phrases “in one embodiment,” “according to one embodiment,” and/or the like generally mean that the particular feature, structure, or characteristic following the phrase may be included in at least one embodiment of the present disclosure and may be included in more than one embodiment of the present disclosure (importantly, such phrases do not necessarily refer to the same embodiment).

Embodiments of the present disclosure may be described below with reference to block diagrams and flowchart illustrations. Thus, it should be understood that each block of the block diagrams and flowchart illustrations may be implemented in the form of a computer program product; an entirely hardware embodiment; an entirely firmware embodiment; a combination of hardware, computer program products, and/or firmware; and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### Building Material Stages

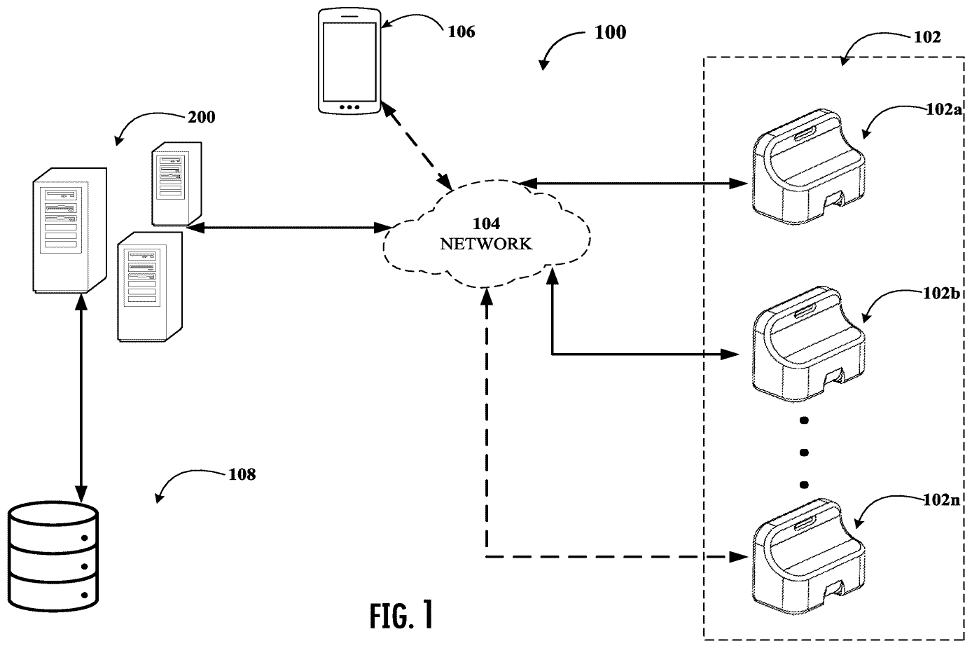

As described hereafter, the embodiments of the present disclosure may leverage various sensors (e.g., sensor devices 102a-n in FIG. 1) in order to generate data associated with and/or indicative of building materials and/or the construction of one or more structures using these building materials (e.g., a construction process). For example, the embodiments described herein may be leveraged at any stage of the construction process in that sensors may be applied to various stages in the lifecycle of the building material (e.g., a cementitious mixture or concrete). As described hereinafter, the methods and systems of the present disclosure are described with reference to a cementitious mixture as an example “building material.” The present disclosure, however, contemplates that the techniques described herein for building material related determinations may be applicable to any material used in the construction of structures without limitation. Furthermore, the present disclosure may, for example, use the terms “cementitious mixtures” and “concrete” interchangeably.

For use in the embodiments described hereinafter, a cementitious mix (e.g., an example building material) may include various stages that exist in the supply chain or otherwise including a raw materials stage, a concrete production stage, and an in-situ concrete construction stage. With reference to raw materials, aggregates may be (1) extracted (e.g., quarrying of coarse and fine aggregates or dredging of fine aggregates), (2) crushed and processed, (3) subjected to additional grading or processing to achieve the desired grading (e.g., particle size distribution), and (4) transported via lorry or rail to nearby consumers. With reference to Portland cement, the stages may include (1) extraction of raw materials (e.g., limestone, clay, and/or chalk), (2) crushing and grinding of the raw materials, (3) blending the materials in the correct proportions, (4) burning the blended raw materials in a kiln (e.g., at 1,500° C. or the like) to produce clinker, (5) grinding the clinker with up to 5% gypsum to produce Portland cement where the fineness of powder is selected to achieve an appropriate strength grade (e.g., lower grade cement is ground more finely to improve strength development), and (6) transporting (e.g., via road, rail, ship) to consumers.

With regard to Ground Granulated Blast-furnace Slag (GGBS), slag from blast-furnace iron production is quenched (e.g., rapidly cooled down in water) to produce granules, the slag is ground down into a powder (e.g., which may be slightly finer than cement), and this product is transported to consumers. With regard to Fly ash/Pulverized fuel ash (PFA), the residuals of coal combustion are captured at coal-fired power plants and transported to consumers. For blended cements, Portland cement may be blended with GGBS and/or PFA. This blending may occur at a factory and then shipped to a consumer or each component may be separately shipped to the consumer for custom blending. With regard to admixtures, these components may be provided separately by chemical supplies to consumers.

In the concrete production stage for ready-mix concrete, raw materials are stored at the plant in silos (e.g., cement, GGBS, PFA), heaps (e.g., aggregates), or in IBCs (e.g., admixtures). When an order is provided, raw materials are mixed together at the plant (i.e., in a process termed wet-mix) before being placed in a lorry that agitates the mix en route to the site). For pre-cast concrete, molds are prepared with rebar or other structural supports provided in the molds before fresh concrete is placed into the molds. Once the concrete gains sufficient strength, the molds are removed, and the element is lifted and stored in a laydown yard to continue gaining strength. Once the concrete has again gained enough strength, the hardened unit is then shipped to the construction site for installation. For in-situ concrete construction, a formwork is erected to support the fresh concrete in the desired geometry, and rebar (e.g., structural support(s)) is installed into the formwork. Fresh concrete is delivered to the site and is placed into the formwork (e.g., either directly from the chute of the lorry, or using a crane with a skip, or using a concrete pump).

Following pouring of the concrete (e.g., the example building material) in pre-cast examples and in-situ examples to form an example element, the strength of the concrete may be tested prior to the removal of formwork, molds, or other support structures. By way of example, a sample (e.g., cube or cylinder shaped sample) may be prepared and cured in water at a standardized temperature. By way of a non-limiting example, the sample may be cured in water at approximately 20° C.; however, the present disclosure contemplates that standardized temperature may vary based on the location (e.g., country or other jurisdiction) at which the concrete is used. To verify that the concrete satisfies the structural design requirements, the sample may, for example, be crushed after a determined time period (e.g., seven (7) days, twenty-eight (28) days, etc.). To ensure that the support structures (e.g., mold, formwork, etc.) remain for a sufficient time (e.g., as opposed to being removed by a contractor, pre-cast manufacturer, or other entity associated with the building material) an early strength may be tested. For example, destructive tests may, as described above, be performed on samples and non-destructive tests, such as rebound hammers or in-situ sensors may be used.

Once the example element is completed (e.g., reach sufficient strength), the element may be loaded or otherwise structurally connected with additional elements formed of concrete (e.g., the example building material). The preparation of these new building elements may be completed substantially the same as the prior building element (e.g., having similar construction stages). The remainder of the activities associated with the structure (e.g., building or the like), such as mechanical, electrical, and/or plumbing operations (MEP operations) and/or the installation of flooring, exterior facades, etc. may occur thereafter. The order or timing for these operations may vary based on the various properties associated with the building elements relevant to these operations.

Following completion of the structure (e.g., completion of the construction operations), the building elements (e.g., formed of concrete or otherwise) that form the building may experience various loads, strains, and/or stresses from the regular operation of the structure. An example building may, for example, experience people walking on a floor, wind contacting the structure, etc. Furthermore, natural phenomena, such as wind, rain, heat, etc. and natural disasters (e.g., earthquakes or the like) may influence the behavior of the materials used to form the structure. In some instances, portions of the structure (e.g., one or more building elements) may require repair in order to ensure sufficient structural integrity. In some instances, various conditions of the structure may be monitored in order periodically to assess the structural integrity of the building.

Example Variables Impacting or Associated with Building Materials

As described above and further hereafter, building materials (e.g., cementitious mixtures, concrete, etc.) may be associated with a plurality of variables that impact the performance, installation, longevity, etc. associated with the building elements formed of these building materials. Although described herein with reference to example variables associated with the building material, the present disclosure contemplates that any attribute, characteristic, property, feature, parameter, etc. may be accounted for by the embodiments described herein. In other words, the variables described hereinafter represent a non-exhaustive list of some variables that may impact or otherwise be associated with building materials.

With continued reference to an example concrete building material, the material may be associated with a composition and proportioning that may be responsible for the baseline performance and properties of the cementitious mixture. Various additional factors, described hereafter, may impact these baseline properties. Mixing may refer to the effective combining of constituents (e.g., any part or component element of the building material) to achieve a heterogeneous mixture having determined properties. Compaction may refer to any operation that removes air present in concrete (e.g., an example building material) following a mixing operation. As would be evident to one of ordinary skill in the art in light of the present disclosure, each percentage of air by volume within concrete may operate to reduce the strength gain of concrete approximately five (5) percent. By way of a non-limiting example, uncompacted concrete may have approximately five (5) percent of air present resulting in an approximate twenty-five (25) percent reduction in strength relative to compacted concrete.

The temperature of a building material (e.g., a cementitious mixture) may further impact the rate of reaction of the materials that form the mixture, and by association, the rate of strength development for the building material. By way of non-limiting example, building materials that are subjected to extreme temperatures may have adverse effects (e.g., delayed ettringite formation, unbound water freezing, etc.). As would be evident to one of ordinary skill in the art in light of the present disclosure, curing concrete at relatively warmer temperatures may accelerate the initial rate of strength gain, these temperatures may also limit long-term strength gain of the building material (e.g., the crossover effect). In contrast, the curing of concrete at relatively cooler temperatures may result in relatively slower initial strength gain but higher ultimate compressive strength. As described herein, curing may refer to the condition of the building material after mixing and placement. For example, curing may require maintaining adequate moisture in concrete within a proper temperature range in order to aid cement hydration. Furthermore, curing may involve the prevention of excess evaporation. By way of example, a concrete pour may be covered (e.g., via a sheeting, curing membrane, frost blanket, and/or the like) in order to at least partially prevent excess evaporation.

As described herein, durability may refer to any variables that impact the long-term performance or integrity of the building material. By way of example, various mechanisms or environmental factors (e.g., acids, alkalis, chlorides, sulfates, etc.) for deterioration may exist that contribute to the degradation in performance of the building material. This deterioration may refer to a loss of strength in the concrete as well as in the reinforcing steel or equivalent material contained within the concrete (e.g., due to corrosion or the like), leading to loss in performance of the structure.

As defined herein, concrete may be associated with one or more fresh properties as would be understood by one of ordinary skill in the art. These fresh properties may, for example, be influenced by the proportioning of ingredients in the concrete and may encompass chemical and mechanical properties. Workability is a fresh property that may refer to the ability of the material to flow or otherwise move into the required shape. Segregation is a fresh property that may occur if the coarse and fine components of the concrete tend to separate due to gravity. Bleeding is a fresh property that is similar to segregation in that the free water in the cementitious mixture is pushed upward to the surface due to the settlement of heavier solid particles such as cement and water. Plastic shrinkage is a fresh property that may be caused by the loss of water due to evaporation from the surface of newly laid concrete. Setting is a fresh property that may refer to the process, caused by chemical reactions during initial hydration of materials, leading to a gradual development of rigidity or stiffness of a cementitious mixture. Fresh properties of concrete or cementitious mixtures may be relevant to the handling and placement of concrete and may further impact the durability of a concrete structure. Another factor in determining concrete's fresh properties is the relative congestion of the reinforcement within the formwork (e.g., requiring higher flow concrete) and/or whether the building material requires a particular open life. By way of example, relatively large concrete pours may require a cementitious mixture with a slow setting time to ensure the element may be poured without the concrete setting before filling the entire formwork. As described herein, shrinkage may refer to a side effect of concrete curing which in practical terms can result in non-ideal joints or interfaces between concrete elements being at different relative ages, or any variation in mix design, and is an important aspect on adjacent pour design and construction joint design.

As would be evident to one of ordinary skill in the art in light of the present disclosure, a cementitious mixture used in forming structures may be formed of a variety of components, constituents, etc. based on the various attributes of the structure. By way of a non-limiting example, a cementitious mixture may include Portland cement as described above that chemically reacts with water to bind other components in a process referred to as hydration. GGBS (e.g., latent hydraulic materials) and PFA (e.g., pozzolanic materials) participate in the hydration reaction but are activated by calcium oxide released by the Portland cement. Water reacts with the binder components during the hydration reaction resulting in strength gain. The addition of water may result in an increased workability but may result in a reduction in strength. Said differently, the ratio between water and binder is relevant to the overall strength and durability of the resultant concrete.

As described herein, an aggregate may refer to the non-reactive components of the concrete that may, for example, form the vast majority (e.g., by weight) of the cementitious mixture due to the cost difference (e.g., cheaper cost) relative cement and water alone. The aggregate may provide mass to the resulting product, and properties of the aggregate, such as grading and angularity, implicate the fresh and hardened properties of the resultant concrete. Fine aggregates, such as sand, may also impact fresh mechanical properties, and the angularity of coarse aggregates may impact long-term mechanical properties of the concrete, such as strength, due to aggregate interlock. In some instances, the geology (e.g., limestone, gravel, granite, magnetite, etc.) of the aggregate may at least partially impact the long-term strength of the concrete.

As described herein, admixtures may refer to additives that may, for example, modify one or more properties or behaviors associated with concrete. By way of a non-limiting example, admixtures may include water-reducing admixtures, retarding, accelerating, waterproofing, aeration, and/or the like. In some implementations, fibers may be incorporated into concrete (e.g., in the cementitious mixture) so as to improve various performance characteristics of the concrete. By way of a non-limiting example, fibers may operate to improve the tensile strength of the concrete, improve the concrete's resistance to wear, and/or improve the concrete's fire resistance. As would be evident to one of ordinary skill in the art in light of the present disclosure, the particular combination and proportioning of materials forming the cementitious mixture may be varied to achieve the fresh and hardened properties necessary for a particular building element (e.g., formed of the building material).

### Building Material Related Definitions

As used herein, the terms “mix,” “mixture,” “composite,” and similar terms may be used interchangeably to refer to a collection of materials (e.g., constituent components, constituent elements, constituent parts, etc.) that are combined together. A mixture may be homogenous in which the composition of the constituent parts are substantially uniform throughout. Alternatively, a mixture may be heterogenous in which the composition or proportion of the constituent parts varies throughout. As described hereinafter, a mix or mixture of the present disclosure may refer to a cementitious mixture (e.g., a combination of constituent components that are combined to, following curing, form concrete) as an example building material. The present disclosure, however, contemplates that the device, systems, methods, techniques, etc. described with reference to cementitious mixtures may be applicable to building materials, extracted materials, or industrial materials of any type without limitation.

As used herein, the terms “mix formulation” and “mix design” may be used interchangeably to refer to a proportion of constituent components, parts, or elements that form a mix or mixture. In some embodiments, the mix formulation may refer to a chemical composition of constituent components, parts, or elements forming the mix or mixture. As described herein, for example, a cementitious mixture (e.g., an example building material) may be formed of a cementitious material (e.g., Portland cement), water, aggregates (e.g., sand gravel limestone), admixtures, and/or the like. The relative proportion of these constituent components may be defined by the mix formulations described herein. As described herein, the mix formulation may refer to a target set of constituent component proportions of which any particular instantiation of that mix formulation should be composed. In some embodiments, mix designs may refer to proportions of constituent component parts associated with one or more targets for contextual material properties. In another embodiment, mix designs may also include the steps (and associated timings) for mixing of a proportion of constituent components or raw materials. As would be evident to one of ordinary skill in the art, any particular instantiation of a mix formulation may include naturally variability in the proportions of constituent components for the same mix formulation.

As used herein, a “batch” may refer to a physical instantiation of a mix formulation. For example, a batch may include an associated volume and may often exist as a batch at the material manufacturer's factory and throughout transit. Once a particular batch is pumped, the volume(s) associated with the batch may be referred to herein as one or more “pours.” A “pour” may refer to a defined volume (e.g., at least partially enclosed via a mold, formwork, or otherwise) into which at least a portion of one or more batches of a mix formulation are provided. A “pour” as described herein may be cured with the intent of forming an element of a structure (e.g., a building element).

A mix formulation, and the batches, pours, building elements, etc. associated with the mix formulation, may further include various “material properties.” The term “material property” may refer to any physical or chemical attribute, characteristic, parameter, feature, etc. of the materials described herein. The material properties of a material may include one or more of static material properties, compositional material properties, contextual conditions, and/or contextual material properties as defined hereinafter. Although described herein with reference to an example framework for distinguishing between types or categories of material properties, for example static material properties vs. contextual material properties, the present disclosure contemplates that the devices, systems, methods, techniques, etc. of the present disclosure may be applicable to any determinable, measurable, and/or derivable attribute associated with building materials, formed of cementitious mixtures or otherwise.

As used herein, the terms “static material property” and “static property” may be used interchangeably to refer to any attribute, parameters, characteristic, state, and/or the like of a material (e.g., an example building material) that is independent of the context within which the material is used (e.g., an attribute that is context independent). By way of a non-limiting example, static material properties may include density (e.g., of water or other materials), particle size, homogeneity, fineness, specific gravity, natural variability, embodied carbon data, aggregate grading, porosity, and/or the like. Although described herein with reference to example static material properties for example cementitious mixtures, the present disclosure contemplates that static material properties may include any context independent attribute of any type for any material.

As used herein, the terms “compositional material property” and “compositional property” may be used interchangeably to refer to any attribute, parameter, characteristic, state, and/or the like indicative of the proportions by which a material (e.g., a composite material as described herein) is composed of other materials (e.g., raw materials as defined herein). A compositional material property may, for example, provide an indication of the mix formulation or compositions as defined herein at various levels of granularity. By way of example, the proportional relationship of constituent components or composition may be provided as a percentage of volume, by particle number, by mass, and/or any other relevant metric, relationship, etc. In some embodiments, the compositional material property may, for example, be provided as an absolute mass, mass density, or other representation. The present disclosure contemplates that information associated with the compositional material properties of a particular material may be provided by any relationship, proportionality, metrics, etc. By way of a non-limiting example, a cementitious mixture (e.g., an example building material) may include compositional material properties that are representative of the atomic composition (e.g., by chemical element percentage or the like) of the building material, the compound composition (e.g., by chemical compound percentage or the like), the molecular composition (e.g., by chemical molecule percentage or the like), by raw material composition (e.g., concrete raw materials, as defined herein, or the like).

The compositional material properties of a building material may further vary in time such that the above mix formulations described herein may further evolve in time. By way of example, a particular instantiation of a mix formulation (e.g., a batch or the like) may vary after creation of the instantiation (e.g., after leaving a batching facility or the like), such as by the addition of water to a cementitious mixture during transit. As such, the material identifiers described herein that may, for example, be indicative of the formulation of a building material may refer to a set of time-dependent compositional material properties for the building material. Said differently, the compositional material properties for a building material that are determined by the techniques described herein may represent the formulation of a particular instantiation at the time at which the data on which the compositional material property is generated. Additionally or alternatively, the compositional material properties may be representative of a theoretical or idealized mix formulation as associated with various target contextual material properties as defined herein (e.g., C80 concrete, C60 concrete, C40 concrete, etc.).

As used herein, the terms “contextual material condition,” “contextual condition,” and “context” may be used interchangeably herein to refer to any imposed state or attribute that at least partially defines the instantiated context in which a building material is used. The contextual condition may, for example, be associated with various characteristics, attributes, aspects, etc. of an external environment of the building material and/or may be associated with characteristics, attributes, aspects, etc. of the building material. With reference to an example building material, contextual material conditions may be associated with temperature data, insulation data, structural data, environmental data, structural burden data, batching plant data, pump contextual condition data, truck contextual condition data, kiln contextual condition data, temporal data, spatial data and/or the like. By way of continued example, insulation data may be indicative of a formwork type, a formwork coating, the presence or absence of blankets or other coverings. Example structural data as a contextual material condition may refer to data pertaining to the geometry, physical form, structure, layout, arrangement, configuration, and/or content (e.g., rebar or the like) of a pour. As such, the structural data may be indicative of or otherwise associated with element type data, geometry or dimensional data, exposure data (e.g., surface area of concrete exposed to air, surface area of concrete exposed to other materials, such as formwork, etc.), reinforcement geometry data (e.g., data entries associated with rebar or the like), and/or data associated with the external environment of the same. Example spatial data as a contextual material condition may refer to data pertaining to the global location (e.g., latitude, longitude and altitude), or relative location of a building material at a construction site or related location (e.g., location of a pour in relation to gridlines, or another pour, or location of a precast unit in a precast yard).

Environmental data as an example contextual material condition may include meteorological data, such as ambient temperature data, humidity data, precipitation data, and/or other atmospheric effects (e.g., wind data, storm data, lightning data, etc.). Environmental data may further include electromagnetic radiation data, data indicative of mechanical vibration and/or other mechanical disturbances, geological data (e.g., the type of soil surrounding foundations may impact its behavior), and/or oven data (e.g., instance in which ovens are used for curing, particularly in precast implementations).

Structural burden data as an example contextual material condition may include load data and/or load path data, stress data, strain data, and/or batching plant data (e.g., volume of batch, mixing data, mixing intensity data, rate of rotation, etc.). Truck or transport contextual condition data may be indicative of the volume of the load (e.g., one or more batches in transport), truck rotational data (e.g., rotational velocity or the like), etc. Kiln contextual condition data may include data indicative of the temperature inside the kiln, the raw materials inside the kiln, and/or the volume of materials (e.g., raw materials, desired output materials, waste materials, etc.) inside the kiln,

Temporal data as an example contextual material condition may include any information used to denote a time or timeframe. In some instances, the temporal data may be indicative of time in absolute terms or relative context dependent terms. For example, the temporal data may include data indicative of a date and time, a period of time or duration (e.g., time between two dates or the like), a season, a year, a construction stage, time stamp data, data stamp data, and/or the like. As described herein, the temporal data associated with an example building materials may be data that is associated with one or more processes or operations. For example, the temporal data may be indicative of a particular date and/or time at which one or more pours were poured.

As used herein, the term “contextual material property” may be used to refer to any material property that is context-dependent and that may change with differing contextual conditions. By way of continued example with reference to a cementitious mix as the example building material, the compressive strength of the cementitious mixture may increase over time in a manner that is dependent upon temperature, geometric shape, humidity, wind, and exposure and/or the like. As would be evident to one of ordinary skill in the art in light of the present disclosure, data described herein related to contextual material properties may be time dependent, and may be composed of discrete, or continuous time series data. By way of a non-limiting example, contextual material properties may refer data indicative of compressive strength (e.g., 7-day strength, 28-day strength, 42-day strength, full strength profile, etc.), shrinkage, workability, tensile strength, flexural strength, stress, strain, calibration data related thereof, structural health, reactivity, flow rate, specific surface area, and/or the like. The present disclosure contemplates that the contextual material properties described herein may include any determinable, measurable, derivable, etc. metric associated with the example building material based on the intended application of the devices and systems described herein. As used herein, “target contextual material properties” may therefore refer to a set of contextual material properties that are to be achieved (e.g., within applicable tolerances or the like) by the system, users, models, etc. described herein attempts to achieve for the particular mixture (e.g., as defined by mix identifier, mix classification, mix formulation, etc.).

As used herein, the term “raw material” may be used to refer to any material described herein that is associated with only static material properties as defined above. By way of a non-limiting example, water, fly ash, sand, and/or the like may be raw materials in the databases and models described herein that are associated with only static material properties (e.g., density and pH, for example). Conversely, the term “composite material” may refer to a material that is identified by both static material properties and compositional properties in the databases and models described herein. The present disclosure contemplates that the provided delineation between raw materials and composite material is in reference to the way in which these materials may be stored and/or identified by the databases and models described herein. For example, a raw material may be reclassified to a composite material whenever such material is defined to have compositional material properties. For example, a fly ash may initially exist in the databases described herein as a raw material. The fly ash, however, may be updated to include material properties other than static materials properties, such as the atomic or molecular constituent components of the fly ash. As such, the fly ash may be reclassified as a composite material. In other embodiments, raw material and composite material may be interpreted by their physical or chemical meanings, namely, where a raw material is a component material used to make a product (wherein the product may be a composite material), and a composite material is a combination of two or more materials with different physical or chemical properties.

As described herein, the term “batch variability” may be used to refer to the variability in the contextual material properties, the static material properties, and/or compositional material properties of a material (e.g., as defined by an associated mix formulation) across batches. As would be evident to one of ordinary skill in the art, batch variability may result from the tolerances or other uncertainty of the quantities (e.g., the mixing proportion tolerances), the contextual conditions during batching, and/or also the natural variability in the properties of the raw material. As such, the embodiments of the present disclosure operate to account for batch variability in the performance of the operations described herein.

As used herein, the terms “mix identifier” “material identifier,” “material classification” and/or the like may be used to refer to any mechanism of identifying a material, mixture, a family/type of material or mixtures, or any characterizing feature of materials or mixtures. The mix identifiers, such as described with reference to mix fingerprinting and mix optimization, may be based on the composition (e.g. mix formulation, chemical composition, etc.), material properties, a unique designator or identifier, and/or any information that identifies a particular mix formulation. In some embodiments, the mix identifier may include mathematical functions that represent particular volumes in mix space as defined herein. By way of a non-limiting example, a mix identifier may include a strength-grading based identification methodology in which particular mix formulations are identified by compressive strength (e.g., in megapascals or the like). In particular, a C40 mix may be defined as a concrete mixture that reaches a minimum of 40 MPa of compressive strength by 28 days, if cured as a standard cube (or cylinder) in standard conditions (in a temperature-controlled water bath at a fixed temperature). A C60 mixture has a similar definition but instead must reach a minimum of 60 MPa. Although described herein with reference to compressive strength as an example mechanism by which mix formulations may be identified (e.g., via mix identifiers), the present disclosure contemplates that any of the material properties (e.g., static material properties, compositional material properties, contextual conditions, and/or contextual material properties) described herein may be used to generate material identifiers.

Therefore, the mix identifiers described herein provide information (e.g., data entries) regarding the particular mixtures (e.g., mix formulation) on which the models of the present disclosure are operating. By way of continued example, in the absence of additional information, the models described herein may determine that a mix formulation identified as C40 within the applicable database(s) will reach a minimum of 40 MPa within the contextual conditions described above (e.g., standard conditions). As would be evident to one of ordinary skill in the art, this data associated with the mix identifier for the mix formulation may narrow a mix's expected strength performance over time in any given context (e.g., target contextual material properties), where such performance may be determined by the models described herein. By way of a non-limiting example, if a model of the present disclosure is used to estimate the mix formulation of a mixture based on the concrete specifications to which it was designed, that strength specification may be used by the model to determine potential candidate mix formulations in the mix space.

As used herein, “mix space” and “mixture space” may refer to an N-dimensional space, such that all points in the domain of the N-dimensional space represent all possible mix formulations (where such space may be an infinite space). In the context of example building materials, mix space may refer to the space representing all possible cementitious mixtures used for construction, and whose N-dimensional coordinates include every material or non-material property that uniquely defines a mix formulation (e.g., composition) in the models and databases described herein. As would be evident to one of ordinary skill in the art, many N-dimensional spaces exist in which a mixture may be defined, and the number of dimensions may change depending, for example, upon the information available to a models or databases described herein, or upon the information deemed minimally sufficient to characterize a mixture uniquely (up to some tolerance or precision) with respect to other mix formulations.

As such, the present disclosure contemplates that there are multiple ways of representing an N-dimensional mix space. By way of example, in some embodiments, N may represent the number of possible constituent component types (e.g., the mix space representing all mixtures comprising quantities of water, cement, and aggregate will be of dimension 3). Another example representation of mix space may be an N-dimensional manifold representing mixes by their static material properties where N is the number of types of static properties.

Another example representation of mix space may be an N-dimensional manifold representing mixes by their contextual material properties where N is the number of types of contextual material properties.

The dimensions of a mix space may also be any combination of these data types. The present disclosure further contemplates that an example mix space may include different levels of granularity such that a classification of mix families or types are used by the mix identifier as opposed to a particular mix formulation. Said differently, mix space may be defined by any base and/or representation, different dimensionalities may exist, and equivalence relations and/or mappings may be generated between these different bases for mix space. These representations may be either discrete or continuous. The mix space may further include subcategories (e.g., mix families, mix types, and/or mix classes) of mixes in mix-space (e.g., as defined by material properties, formulations, identifiers, or the like) that share at least one common characteristic.

As used herein, the terms “first dataset” and associated “first data entries” are used to refer to data that, in some embodiments, is received by the systems, models, etc. of the present disclosure as an input. By way of a non-limiting example, the first dataset may include data associated with various materials properties that are input by a user, generated by a sensor device (for example, a maturity or temperature sensor), other device, received from a database, received from a prior iteration of one or more of the models described herein, and/or the like, such as in the mix optimization and mix fingerprinting operations described herein.

Additionally or alternatively, in some embodiments, the first dataset may include data generated by, received from or associated with a wave-based sensor (e.g. a mechanical or electromagnetic wave-based sensor configured to excite and/or measure a cementitious mixture, or configured to measure electrochemical or electromechanical parameters of a building material).

Additionally or alternatively, in some embodiments, the first dataset may include data associated with sensor context awareness as described herein (e.g., data associated with a building material, a pour implicating the building material, an environment of the building material, etc.). Additionally or alternatively, in some embodiments, the first dataset and associated first data entries may be associated with a material identifier. Additionally or alternatively, in some embodiments, the first dataset and associated first data entries may be associated with a spatial representation (e.g., a Building Information Modeling (BIM), floorplan or the like) as described herein. Additionally or alternatively, in some embodiments, the first dataset and associated first data entries may be associated with a measurement type of a building material (e.g., a mix fingerprinting operation, a sensor device measurement or the like). Additionally or alternatively, in some embodiments, the first dataset and associated first data entries may be associated with a structural progress flow as described herein. Additionally or alternatively, in some embodiments, the first dataset and associated first data entries may be associated with a construction site resource, construction status identifier, and/or the like.

As would be evident to one of ordinary skill in the art in light of the present disclosure, the first dataset and associated first data entries may be associated with, indicative of, or otherwise related to any of the attributes, characteristics, parameters, metrics, etc. of the construction or building related material operations, systems, devices, etc. described herein without limitation. Said differently, the first dataset and associate first data entries may refer to the data structure by which data associated with the embodiments described herein is stored, regardless of data type, model used, system deployed, etc. The present disclosure further contemplates that additional datasets (e.g., second dataset or the like) may include data entries associated with any of the same or different data types described herein with reference to the first dataset. In other words, the present disclosure contemplates that any number of different datasets of any type may be used by the embodiments herein.

As used herein, the terms “sensor,” “sensor device,” “transducer,” and “device” may be used interchangeably and/or collectively to refer to any hardware or circuitry component configured to generate data, such as first data entries, that is associated with a building material, construction resource, contextual awareness, and/or the like without limitation. As described hereinafter, a sensor device may include any relevant circuitry, components, etc. configured to generate data that is indicative of, for example, the material properties (e.g., static material properties, compositional material properties, contextual conditions, contextual material properties, etc.) of a building material. The present disclosure contemplates that each of the techniques, models, etc. of the present disclosure may be implemented with any number of the sensor and/or sensor devices and/or transducers and/or devices described herein, alone or in any combination.

Sensor devices may be used in association with “actuators” which as used herein may be used to refer to any element or circuitry component that is able to cause, generate, adjust and/or generally control any force, field or energy excitation or disturbance (including for example mechanical excitations, or electromagnetic excitations, and in particular wave-based excitations, through force or field couplings). In some embodiments, sensor, sensor device, transducer, actuator, and device may be used interchangeably to reference any of their respective meanings, in a context dependent way. In some embodiments, an example “transducer” may be intrinsically resonating in that the configuration of the transducer (e.g., by geometry or the like) produces or is otherwise associated with resonant behaviors (e.g., oscillatory resonance, wave-based resonance modes, etc.).

As used herein, “wave-based sensor” may be used to refer to any device which may generate, adjust, or control a time-varying excitation (based on an input signal) and/or sense a response to an excitation including, but not limited to, of a target material, or another material coupled (directly or indirectly) to the target material. Such a wave based sensor may be, used to generate or otherwise make use of and sense waves, excitations, and/or oscillations (such as electromagnetic waves, electric currents and/or mechanical stresses) as described herein. Furthermore, “wave-based” may refer to any device, technique, sensory, etc. that employs one or more actuators to excite a host material, or a second material that is coupled to the host material. The excitation may be a time varying signal (e.g., an oscillatory signal, a wave, etc.). Wave-based devices, techniques, and sensing may also employ sensors to measure the response of the host material (directly, or indirectly through the response of the second material, or another material coupled to the host material). For the avoidance of doubt, the “wave-based” techniques described herein may encompass, without limitation, excitations, oscillations, and waves, and may further encompass any device configured to take input signals and generate, adjust, control an excitation of a field, force, or form of energy, such as via an actuator defined herein, as well as a response (e.g., material response, coupled medium response, etc.) to such excitation, oscillation, or wave.

As used herein in respect of wave-based sensors (or other, related devices), a “frame” may be used to refer to refer to fixtures, surfaces, volumes, membranes, and/or shapes of any kind which may be disposed as part of, in, around or in proximity of wave-based sensors, actuators or device housings as described herein. In some embodiments, devices, including their sensors and/or actuators may be at least partially embedded within frames, disposed within their inner volumes, in proximity to them and/or the like. In some embodiments, the devices described herein, or their component parts (e.g., sensors or actuators) may be physically bonded to frames (e.g., to produce a sensor/actuator-frame composite) or otherwise coupled (e.g., through a field, at a distance). As such, a frame may span any geometry that may or may not be contiguous. In some embodiments, frames may be made of materials or configured in geometries to manipulate waves (including their waveforms and direction of travel), oscillations and/or excitations (for example, through wave reflections, absorption or diffraction, polarization, or oscillatory dampening, inertial, inductive, capacitive or elastic effects, and the like).

As used herein, the terms “contextual awareness data,” “sensor context awareness,” “self-detection data,” and “context awareness data” may be used interchangeably to refer to data that is associated with a first sensor device considering a building material, associated with the building material under consideration by the first sensor device, associated with a pour implicating the building material under consideration by the first sensor device; and/or associated with an environment of the building material under consideration by the first sensor device. In some embodiments described hereinafter, sensor context awareness data may refer to S-data, M-data, P-data, and/or E-Data. As used herein, S-data may refer to data entries that are indicative of the sensor device itself, M-data may refer to data entries that are associated with the material surrounding the sensor device (e.g., if the sensor device is embedded) or the material under consideration by the sensor (e.g., if the sensor is directed at or mounted on the material), P-data may refer to data entries that are indicative of the pour or volume in which the sensor device is located or is considering, and E-data may refer to data entries that are associated with the environment of the pour. In some embodiments, sensor context awareness data may include combinations of these data types and/or these data types for connected elements (wherein a connected element represents a connection between building elements (e.g., physically connected, a nearest neighbor, or within each other's load paths etc.)).

As used herein, a “structural progress flow” may be used to refer to one or more operations that are performed to construct a structure. The structural progress flow may, for example, define an ordering of steps with associated material, resources, etc. that are required for constructing the structure. In some embodiments, the structural progress flow may include temporal or time related data that defines the time (e.g., actual or expected) at which particular operations defined by the structural progress flow are to be performed. In other embodiments, the structural progress flow may include spatial or geometry related data (e.g. actual or proposed) that defines the geometries, layouts, subdivisions, slicings, and positions of building elements that have or may be constructed as a result of the operations defined by the structural progress flow (including for example drawings, pour layouts, BIM models and the like). The present disclosure contemplates that the structural progress flow may include explicit operations (e.g., instructions for performing a particular operation) as well as implicit operations (e.g., an operation that is a prerequisite for a subsequent operation must be performed first). The present disclosure contemplates that the structural progress flow, in some embodiments, may be dynamically modifiable to account for changes associated with construction site resources.

As used herein, a “structural building block” may be used to refer to one or more of the following: A building element (actual or planned); A structural progress flow; and/or any element which comprised a non-permanent portion, part, piece, constituent, etc. of a structure of the present disclosure at one moment in time (actual or planned); Any construction resource. In one embodiment, the structural building block may, for example, define: one or a plurality mixes to be used in one or a plurality of concrete pours comprising an overall structure; one or a plurality of rebar designs to be placed in one or a plurality of concrete pours; a plurality of pours comprising a pour layout; a sequence of pouring operations comprising a pour sequence; a geometry design defining the geometry of one or a plurality of pours comprising a structure, the geometry of any portion, part, piece, constituent, etc. of a structure, including the entire structure; one or a plurality of construction joints to be used at the boundary between building elements; a construction schedule comprising a set of operations alongside associated timestamps and timelines that are performed to construct a structure; a concrete cycle comprising a set of operations alongside associated timestamps and timelines that are performed to construct an individual building element comprising a structure, which optionally may be a pour, and optionally may be a repeatable set of operations for other analogous building elements in the structure: one or a plurality of formwork elements temporarily installed during a concrete cycle; one or a plurality of steel beams comprising the structure; one or a plurality of precast concrete elements; a substructure comprising a structure; a superstructure comprising a structure; one or a plurality piles comprising a structure; one or a plurality of chainage structures comprising an infrastructure project (e.g. road, bridge etc. . . . ); one or a plurality of MEP (mechanical, electrical and plumbing) elements comprising a structure, in particular in its operational life; and/or one or a plurality of facade elements comprising a structure. The present disclosure contemplates that the structural building blocks, in some embodiments, may comprise expected, proposed or target building blocks, designs to be specified before construction. In some embodiments, these proposed or target building blocks may be dynamically modifiable to account for changes associated with building blocks.

As used herein, a “structural building design” or “building design” may be used interchangeably to refer to any information associated with a structure, constructed, undergoing construction, and/or under construction planning, detailing any one or a plurality of aspects, requirements, targets and/or preferences of its: ultimate physical form; its properties, or any properties of any building elements forming it, including structure physical properties, contextual material properties, compositional properties and/or any other relevant property; its structural progress flow; and/or any other construction resource. The structural building design may, for example, define: one or a plurality of building blocks specified to comprise a structure; an aesthetic preference associated with the structure; a strength requirement on one or a plurality of mixes comprising one or a plurality of pours comprising the structure; a shrinkage requirement on one or a plurality of pours comprising the structure or the like.

As described herein, a structure may be formed of various structural building elements (e.g., formed of a cementitious mixture or the like), and, as such, may be associated with a “pour layout” or “pour layout design” that refers to a spatial representation of how one or more concrete pour are to be defined, such as by the subdivision of concrete pours (e.g., building elements) described herein. In some embodiments a “material design identifier” may be used to refer to one or more configurations associated with the pour layout, such as the configuration of rebar.

As used herein, a “construction site resource,” “construction resource,” “construction asset,” and/or “construction object” may be used interchangeably to refer to any asset, device, system, etc. that may be used in the construction of a structure (including the manufacturing, production or construction of any of its prefabricated components, readymix batches, or other constituent components). By way of a non-limiting example, a construction site resource may refer to raw materials, composite materials, support structure or formwork, etc. used in the formation of structures. Additionally, a construction site resource may refer to transportation devices or systems (e.g., trucks, cranes, etc.), manufacturing equipment or systems (e.g. precast ovens, production lines, batching machines), harvesting devices or systems (e.g., raw material related devices located at quarries or the like), and/or the personnel that operate these devices and systems. Furthermore, a construction site resource may refer to the sensors, sensor devices, transducers and actuators used, in some embodiments, to perform the operations of the present disclosure. As such, the present disclosure contemplates that any of the assets described herein as associated with or otherwise related to the use of building materials to construct structures may be considered a construction site resource, without limitation.

As used here, “status,” “construction status,” and/or the like may be used to, in conjunction with the structural progress flow or otherwise, indicate the state of any measurable entity (e.g., a construction site resource or the like) associated with a construction site or project (including, but not limited to on jobsites, factories, batching plants and any other location related to construction operations). As such, a “status query” may refer to any request relating to the state of a measurable entity (e.g., construction site resource or the like) associated with the construction site. In some embodiments, the statuses described herein may further be associated with status types, such as concrete statuses, completion statuses, sensor device status, and/or requirement statuses. For example, a concrete status may refer to status queries associated with mixtures (e.g., cementitious mixes or the like), completion statuses may refer to status queries associated with the completion of a process or subprocess associated with a construction project through time (e.g., as defined by the structural progress flow or otherwise), sensor device statuses may refer to status queries associated with sensor devices, and/or requirement statuses may refer to status queries associated with whether a measurable entity (e.g., construction site resource or the like) has met a requirement. The present disclosure contemplates that the statuses described herein may be associated with any construction site resource as defined above without limitation.

As used herein, a “building element” may refer to any portion, part, piece, constituent, etc. (actual or intended) of a structure (permanent or temporary) of the present disclosure. By way of example, a building element of the present disclosure may, in some embodiments, refer to a pour of a cementitious mixture as defined above. In some embodiments, a building element may refer to a collection of pours forming a structure, substructure, or the like. Said differently, the present disclosure contemplates that the granularity of the building element may vary based on the intended application of the device, system, and/or method described herein. In some embodiments, a building element may refer to one or more batches of concrete intended to be poured into a structure. In some embodiments, a building element may refer to temporary fixtures associated with the structure (such as formwork, falsework, propping, scaffold and the likes, which may be generally referred to as temporary works building elements).

As used herein, a “data value” may include any piece of information relating to a measurable entity, such as an example temperature reading. A “data type” may refer to a categorization of data values, such as thermal data for the example temperature reading. The terms “data source” and “data entity” may be used interchangeably to refer to a data store that holds data values (e.g., a specific BIM model or the like). The terms “data source type” and “data entity type” may be used interchangeably to refer to a categorization or type of data source or data entity. For example, a data entity may refer to as an instantiation of a data source (e.g., BIM model may be a class of data entities).

As used herein, a “data element” may include a data value of a certain type stored within a data entity of a certain type (e.g., an element in a BIM model). A data element may, for example, be continuous or discrete. A discrete data element may include a data element that represents discrete information that is self-contained (e.g., a concrete cube test crush result). A continuous data element may include a data element that represents continuous information that may be arbitrarily subdivided or combined (e.g., a slab in a BIM model may be subdivided into pours of arbitrary size).

As used herein, a “measurable entity” may refer to a physical object or entity (e.g., a pour) that may be measured or observed. In this way, the measurable entity represents the actual physical object as opposed to the corresponding digital representation (e.g., digital twin) of the object.

As used herein with reference to logistics related implementations, a “positioning device” may refer to as device that has capabilities (alone or as part of a system) to make positioning determinations or characterizations. A “gateway” may refer to a network connected device (e.g., Internet connected device, for example over LTE, 5G or NB-IoT) that is configured to locally communicate with beacons (over BLE, BLE Long Range, BLE Mesh, LoRa, Sigfox, and/or the like). A “beacon” may refer to a battery powered device that can send and receive wireless signals to other beacons and/or gateways and/or other devices (over BLE, BLE Long Range, LTE, GPRS, 2G/3G/4G/5G, NB-IoT, LoRa, Sigfox and so on). In some instances, beacons may not be directly connected to the internet. In some instances, a beacon may include a cellular interface). To this end, “global position” may refer to the position of a device with respect to a global frame of reference (e.g., a latitudinal and longitudinal location) while a “relative position” as used herein may refer to a location with respect to two or more construction resources, with respect to gridlines, and/or the like. In some non-limiting examples, a construction asset may refer to an any object that may be act on a construction resource as defined herein and on other construction assets. A construction object in such an example may be acted upon by a construction asset but may not act on a construction resource as defined herein. This is analogous to plant and machinery (construction assets), which can act on prefabricated building elements (construction objects) by moving them, whereas building elements cannot act on plant or machinery to move them. The present disclosure contemplates that the delineation between construction resources, construction assets, and/or construction objects may vary based on the intended application of the systems described herein. In some embodiments, two or more construction resources can interact.

An “interaction” as used herein in the context of construction logistics, may refer to a discrete instance of a construction process occurring within a continuous time interval, involving two or more construction resources, oftentimes evolving location of one or more construction resources, and oftentimes with one resource being active (in that it can drive forward an interaction) and the other passive (in that it is unable to drive an interaction, and is subjected to it). Examples of interactions include but are not limited to an operative driving a nail with a hammer, a tower crane lifting a precast concrete until, an excavator lifting a bucket of soil, a robot painting a wall, etc. The present disclosure contemplates that the delineation between active and passive construction may vary based on the intended application of the systems described herein.

As used herein, the terms “data,” “content,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein as receiving data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein as sending data to another computing device, it will be appreciated that the data may be sent directly to another computing device or may be sent indirectly via one or more intermediary computing devices, such as, for example, one or more servers, relays, routers, network access points, base stations, hosts, and/or the like.

### Building Material Determination Systems

FIG. 1 illustrates an example system for building material based determinations (e.g., system 100). It will be appreciated that the system 100 is provided as an example of an embodiment(s) and should not be construed to narrow the scope or spirit of the disclosure. The depicted system 100 of FIG. 1 may include a server 200 communicably coupled with one or more sensor devices 102a-n via a network 104. The server 200 may be configured to control or otherwise influence operations of the one or more sensors device 102a-n and as described hereafter and may be configured to receive from the one or more sensor devices 102a-n datasets comprising data entries associated with various measurements (e.g., measurement types) of a building material. Still further, the server 200 may comprise or be communicably coupled with one or more databases 108. In some embodiments, the system 100 may further include various user devices 106 (e.g., mobile phones, laptop computers, etc.) by which a user associated with the system 100 may interact with the system 100, such as via a user interface of the user device 106.

Although described hereinafter with reference to a server 200, the present disclosure contemplates that the operations described hereafter with reference to the server 200 may be performed by any computing device, system orchestrator, central processing unit (CPU), and/or the like. Furthermore, although illustrated as a single device (e.g., server 200), the present disclosure contemplates that any number of distributed components may collectively be used to form the server 200 and/or to perform the operations associated with the server 200. In some embodiments, the server 200 may comprise, in whole or in part, one or more of the sensor devices 102 and/or the user device(s) 106. In any embodiment, the server 200 may be configured to, based upon the data received from the various sensor devices 102a-n and/or databases 108, generate a material identifier associated with a building material, generate sensor context awareness data, generate and/or modify a structural progress flow, and/or generate construction status identifiers as described hereafter.

To facilitate or otherwise enable this connectivity between devices, the communication network 104 may be any means including hardware, software, devices, or circuitry that is configured to support the transmission of traffic (e.g., data, signals, etc.) between components of the system 100. For example, the communication network 104 may be formed of components supporting wired transmission protocols, such as, digital subscriber line (DSL), Ethernet, fiber distributed data interface (FDDI), or any other wired transmission protocol obvious to a person of ordinary skill in the art. The communication network 104 may also be comprised of components supporting wireless transmission protocols, such as Bluetooth, IEEE 802.11 (Wi-Fi), or other wireless protocols obvious to a person of ordinary skill in the art. In addition, the communication network 104 may be formed of components supporting a standard communication bus, such as, a Peripheral Component Interconnect (PCI), PCI Express (PCIe or PCI-e), PCI eXtended (PCI-X), Accelerated Graphics Port (AGP), or other similar high-speed communication connection. Further, the communication network 104 may be comprised of any combination of the above mentioned protocols. In some embodiments, such as when one or more sensor devices 102a-n and the server 200 are formed as part of the same physical device, the communication network 104 may include the on-board wiring providing the physical connection between the component devices.

In some embodiments, the system 100 may include one or more databases 108 configured to store data generated by the server 200, the one or more sensor device 102a-n, or the like. The database(s) 108 may be accessible by the server 200, such as to retrieve data for comparison with data generated by the one or more sensor devices 102a-n. In some embodiments, the database(s) may operate as a repository for material identifiers (e.g., generated by the methods described herein or otherwise) associated with compositions of building materials, unique mixture related classifiers of the building materials, and/or one or more material properties of the building materials. Furthermore, the database(s) 108 may be configured to store data associated with performance of the machine learning models and artificial intelligence algorithms described herein. The present disclosure contemplates that the database(s) 108 described herein may be configured to store any of the data entries generated by the sensor devices 102a-n of the present disclosure, data associated with operations performed on the data entries generated by the sensor device 102a-n, and/or the like without limitation.

Although illustrated in FIG. 1 as separate entities, the present disclosure contemplates that the server 200 and the one or more sensor device 102a-n may, in some embodiments, include common components and/or functionality. By way of example, the embodiments of the present disclosure are described hereinafter with reference to the server 200 performing the various building material related operations based on data entries generated by the sensor devices 102a-n. The present disclosure, however, contemplates that, in some embodiments, the sensor devices 102a-n may be configured to, in whole or in part, perform the building material operations described herein. Said differently, the present disclosure contemplates that each of the devices described herein may include the components necessary to perform one or more of the operations described hereinafter. Furthermore, although illustrated in FIG. 1 with one or more sensors device 102a-n communicably coupled with the server 200 via the network 104, the present disclosure contemplates that the system 100 may include any number of intermediary devices communicably coupled within the system 100. By way of a non-limiting example, the system 100 may include various host devices, gateway devices, etc. that receive data generated by the sensor devices 102a-n and provide this data to the server 200.

### Example Supply Chain

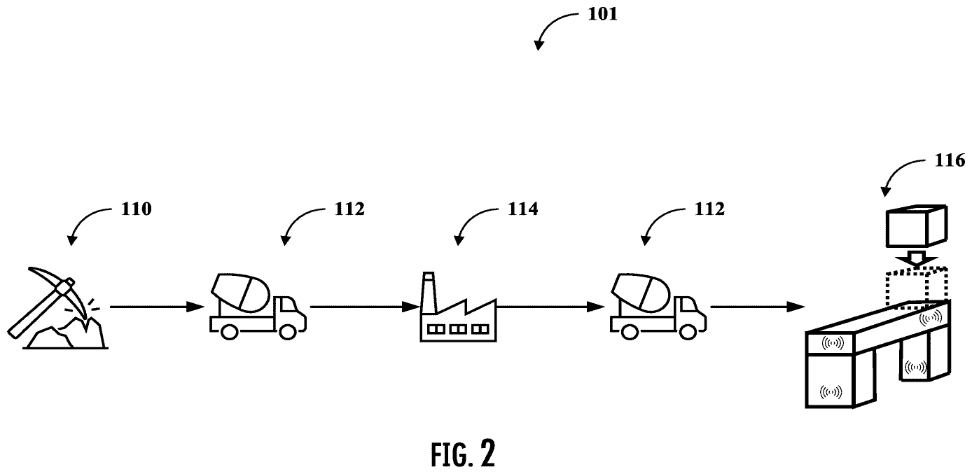

As shown in FIG. 2, an example supply chain 101 is illustrated with which, in whole or in part, the example system of FIG. 1 may be implemented. As shown, the preparation and installation of a building material may occur in various stages. As such, the data described hereinafter (e.g., generated by applicable sensors or otherwise) may not be limited to use with ongoing or finished pours of a building material (e.g., cementitious mixture or the like). For example, the supply chain 101 may include a first stage 110 in which raw materials (from which the cementitious mixture is derived) are acquired (e.g., harvested, mined, excavated, manufactured or gathered); a second stage 114 in which these raw materials are processed and/or combined to create the cementitious mixture or further parts thereof (e.g., in a cement plant/ready-mix batching plant); the final stage 116 of ultimately pouring the cementitious mixture; and typically one or more intervening transit stages 112 in which the raw materials, intermediate products or final cementitious mixtures are transported from one stage to its subsequent stage.

At every such stage in supply chain 101, data may be generated (e.g., by the one or more sensor devices 102a-n) and transmitted to the server 200 indicative of measurements, properties, attributes, and/or characteristics of these raw materials (e.g., aggregates), intermediate products (e.g., Portland cement) and cementitious mixtures (e.g., concrete). For example, sensors 102a-n disposed on or in part of a site, such as a quarry or materials processing system or plant (such as a batching plant for processing aggregates like sand, crushed rock, or gravel), may be capable of measuring and outputting an indication of a raw material's material properties (e.g., density, granularity, hardness, and/or the like) during first stage 110 or second stage 114. Additionally or alternatively, one or more sensor devices 102a-n may be disposed in, or on, one or more vehicles that are configured to make, mix and/or transport cementitious mixtures or their constituent raw materials as part of a transit stage 112. For instance, either a traditional barrel truck or a volumetric mobile mixer may contain sensor devices 102a-n configured to monitor properties of a cementitious mixture and/or pours thereof, or (e.g., in the case of a volumetric mobile mixer) properties of raw materials used in the cementitious mixture. The vehicle(s) may be configured to supply (e.g., transmit wirelessly in real time) the monitored properties for use by the server 200. The present disclosure contemplates that the system 100 may employ any number of sensor devices 102a-n at one or more of the stages 110, 112, 114, 116 illustrated in FIG. 2 or otherwise based on the intended application of the system 100.

### Example Server Circuitry

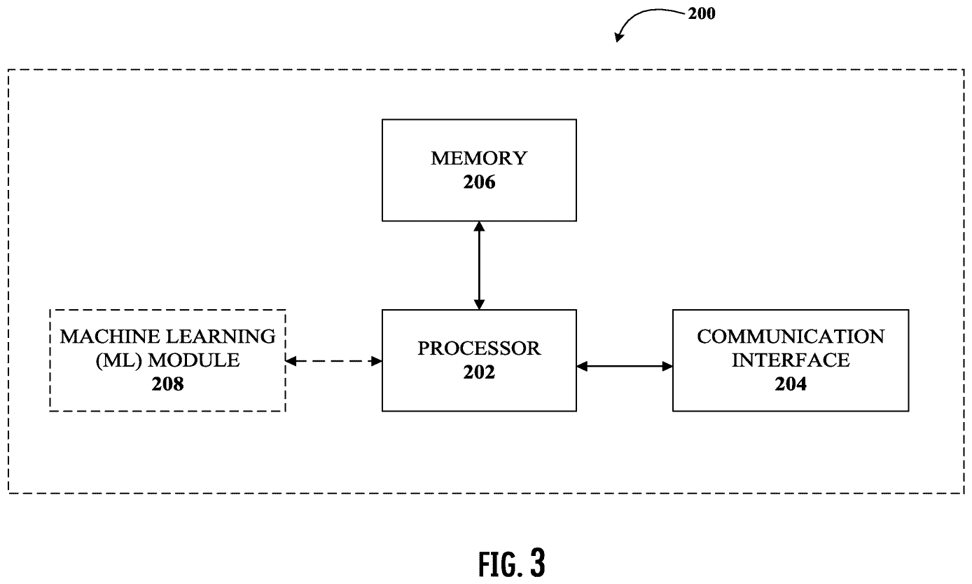

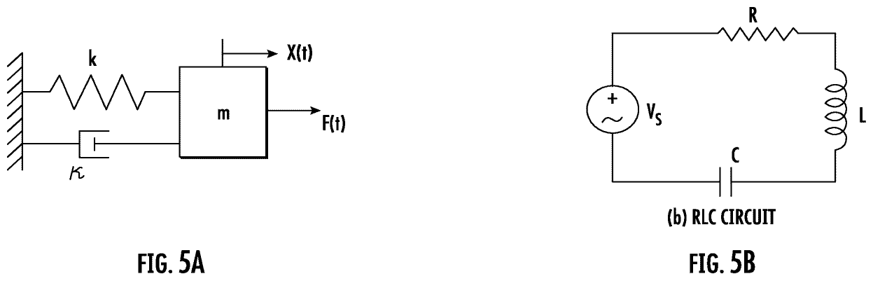

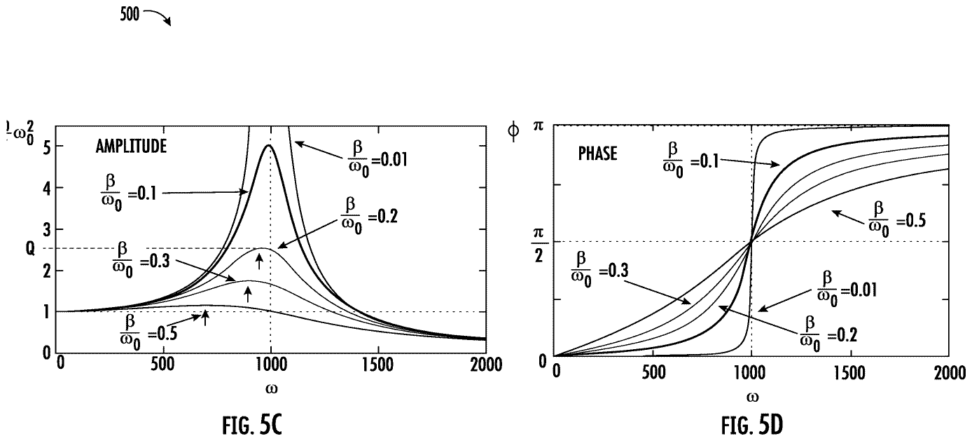

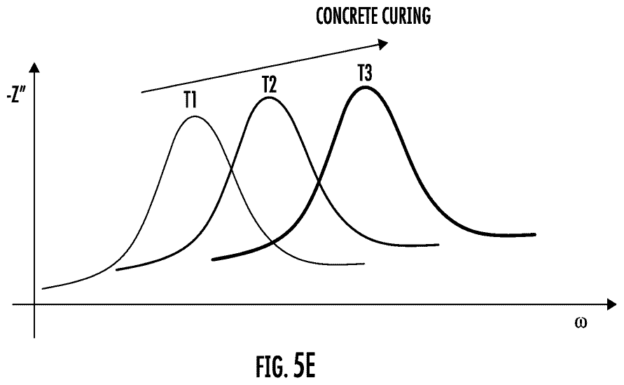

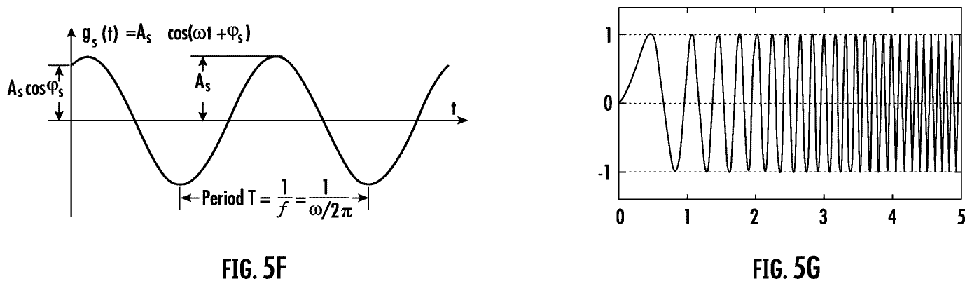

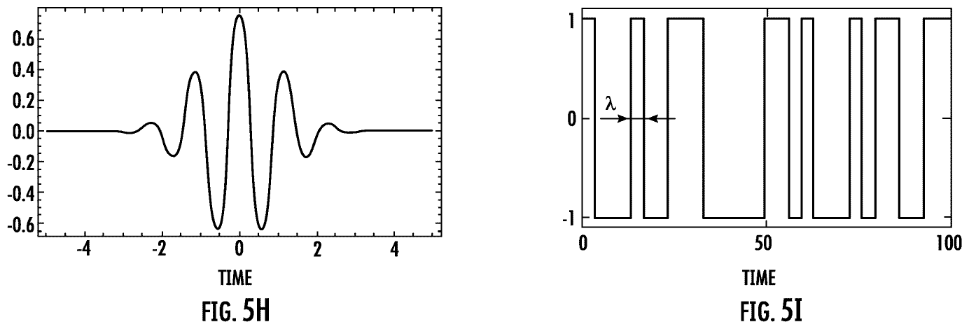

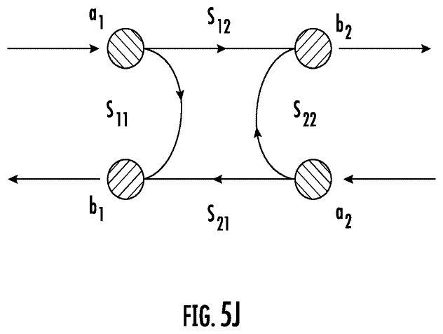

With reference to FIG. 3, example circuitry components of the server 200 are illustrated that may, alone or in combination with any of the components described herein, be configured to perform the operations described herein with reference to FIGS. 5-20. As shown, the server 200 may include, be associated with or be in communication with processor 202, a memory 206, and a communication interface 204. The processor 202 may be in communication with the memory 206 via a bus for passing information among components of the server 200. The memory 206 may be non-transitory and may include, for example, one or more volatile and/or non-volatile memories. In other words, for example, the memory 206 may be an electronic storage device (e.g., a computer readable storage medium) comprising gates configured to store data (e.g., bits) that may be retrievable by a machine (e.g., a computing device like the processing circuitry). The memory 206 may be configured to store information, data, content, applications, instructions, or the like for enabling the apparatus to carry out various functions in accordance with an example embodiment of the present disclosure. For example, the memory 206 could be configured to buffer input data for processing by the processor 202. Additionally or alternatively, the memory 206 could be configured to store instructions for execution by the processor 202.

The server 200 may, in some embodiments, be embodied in various computing devices as described above. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present disclosure on a single chip or as a single “system on a chip.” As such, in some cases, a chip or chipset may constitute means for performing one or more operations for providing the functionalities described herein.

The processor 202 may be embodied in a number of different ways. For example, the processor 202 may be embodied as one or more of various hardware processing means such as a coprocessor, a microprocessor, a controller, a digital signal processor (DSP), a processing element with or without an accompanying DSP, or various other circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processing circuitry may enable multiprocessing within a single physical package. Additionally or alternatively, the processing circuitry may include one or more processors configured in tandem via the bus to enable independent execution of instructions, pipelining and/or multithreading.

In an example embodiment, the processor 202 may be configured to execute instructions stored in the memory 206 or otherwise accessible to the processor 202. Alternatively or additionally, the processing circuitry may be configured to execute hard coded functionality. As such, whether configured by hardware or software methods, or by a combination thereof, the processing circuitry may represent an entity (e.g., physically embodied in circuitry) capable of performing operations according to an embodiment of the present disclosure while configured accordingly. Thus, for example, when the processing circuitry is embodied as an ASIC, FPGA or the like, the processing circuitry may be specifically configured hardware for conducting the operations described herein. Alternatively, as another example, when the processor 202 is embodied as an executor of instructions, the instructions may specifically configure the processor to perform the algorithms and/or operations described herein when the instructions are executed. However, in some cases, the processor 202 may be a processor of a specific device configured to employ an embodiment of the present disclosure by further configuration of the processing circuitry by instructions for performing the algorithms and/or operations described herein. The processor 202 may include, among other things, a clock, an arithmetic logic unit (ALU) and logic gates configured to support operation of the processing circuitry.

The communication interface 204 may be any means such as a device or circuitry embodied in either hardware or a combination of hardware and software that is configured to receive and/or transmit data, including media content in the form of video or image files, one or more audio tracks or the like. In this regard, the communication interface 204 may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

The communication interface 204 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 204 may provide for communications under various telecommunications standards (e.g., 2G, 3G, 4G, 5G, and/or the like) using their respective layered protocol stacks. These communications may occur through a transceiver, such as radio-frequency transceiver. In addition, short-range communication may occur, such as using a Bluetooth, Wi-Fi, or other such transceiver (not shown).

In some embodiments, the server 200 may deploy one or more machine learning (ML) models to perform the operations described herein. To this end, the server 200 may include a machine learning (ML) module 208 comprising circuitry configured to ingest data, such as a multivariate N-dimensional space of time-series data where N is the number of different measurement types (e.g., data of different types) and, via a various ML and/or artificial intelligence techniques described hereafter, output a material identifier indicative of one or more of a composition of the building material, a unique mixture related classifier of the building material, or one or more material properties of the building material. The ML module 208 may leverage the processor 202 to perform its associated operations and may, for example store any results in the memory 206 and/or databases 108.

Of course, while the term “circuitry” should be understood broadly to include hardware, in some embodiments, the term “circuitry” may also include software for configuring the hardware. For example, although “circuitry” may include processing circuitry, storage media, network interfaces, input/output devices, and the like, other elements of the server 200 may provide or supplement the functionality of particular circuitry.

### Example Sensor Device Hardware

As an initial matter, the present disclosure contemplates that any embodiment and/or any method described herein, in full or in part, of any device, sensor, actuator, transducer, accessory and/or any other component which may be described herein associated with any device herein may be used in combination to produce another embodiment of the present disclosure. Any embodiment and/or any method described herein may be used, in full or in part, for any part of any method described in any other section herein, in any of their embodiments, in full or in part.

### Overview

This section sets out the details of novel hardware devices, sensor devices, and associated methods, including but not limited to, embodiments configured to determine characteristics, attributes, properties and/or any other information/data associated with the physical existence and behavior of matter, which in some embodiments may comprise building materials such as cementitious materials, mixes and composites, and/or raw materials.

The data determined by these methods, hardware and/or devices may, in full or in part be used to execute, or otherwise enable, any of the methods and/or systems described in any section herein, in full or in part, in any of their embodiments, for example mix optimization, mix fingerprinting, status inference, context awareness, linkage, pour design and sequencing, and construction resource positioning related methods and embodiments. Embodiments of use cases (for example, for the aforementioned models) may include the use of such data to build empirical models, physio-chemical models, or for training, retraining and/or updating of machine learning models, or their use as inputs into such models, or out of such models.

Particular methods for novel sensing techniques, and for the characterization of materials are disclosed. Devices (such as sensor devices, communication devices and/or personal devices) and their characteristics, operating principle, purpose, particular embodiments, implementations and/or example use case are also disclosed. Systems (for example, of one or more devices executing one or more methods) are also described, including distributed systems which may be composed of a plurality of devices.

Some embodiments of devices comprise sensors, and/or actuators (which may be separate, or one and the same element). ‘Actuators’ herein may be taken to mean an element that is able to cause, generate, adjust and/or generally control any force, field or energy excitation or disturbance (including for example mechanical excitations, or electromagnetic excitations, and in particular wave-based excitations). Wave-based sensor devices are a particularly important class of embodiments. Generally, they comprise devices which may employ input signals (which may be oscillatory in nature) to cause, generate and/or control an excitation (which may be a time varying or oscillatory excitation, including in some embodiments a traveling wave, such as an electromagnetic or mechanical wave). These excitations are typically generated in a material of interest (also referred to as a ‘host material’ or simply ‘material’ and/or ‘medium’, ‘target material’, ‘material under consideration’, ‘surrounding material’ and/or other terms which based on their context are meant to designate the material), or in another associated medium or material, which may be coupled with the material of interest (e.g. physically coupled, or otherwise coupled). Sensors and actuators may make use of forces or field couplings of various types (e.g. electro-mechanical, electro-electromagnetic, opto-mechanical and so on). “Wave-based” may be interpreted accordingly, to relate to any wave-based device (including to devices that are based on oscillations, and so is not limited to traveling wave based excitations).

General considerations for devices (all or parts of which may be used in association with any device embodiment) are described. This includes device types, the advanced mechanical and industrial design used to adapt them to harsh construction environments, as well as smart power management. A particularly important part of such considerations includes the installation and activation mechanisms (in particular for devices to be embedded in concrete), as well as the geometry of the devices (which may include containers or receptacle-like features into which materials such as concrete can flow, for further material analysis). Advanced power management techniques are then disclosed, as well as signal processing, excitation, sampling and synchronization techniques, and advanced RF used for communication out of or in proximity of building materials. Sensor and actuator selection considerations, and data processing techniques are also described.

Wave-based sensors are then introduced. The general formalism, techniques and methods are introduced, including the mathematical models used to describe them. Techniques that apply to all wave-based sensors are disclosed, including MAIS (a new form of impedance spectroscopy), and novel use of Scattering Parameter analysis for material related determinations. Generally, the use of frames (as described later) to control and manipulate wave-based signals and designs, including for the enhancement of resonance modes, is also outlined. Finally, specific wave-based sensor types are described, categorized as (1) mechanical wave-based sensing (which actuate or sense mechanical excitations in materials, or related mediums); (2) electromagnetic wave-based sensing (which actuate or sense electric, magnetic or electromagnetic excitations in materials, or related mediums); and (3) finally, other categories of wave based sensors are briefly outlined (such as thermal wave-based sensing, through thermal excitation). Positioning & Interaction sensors are then touched on (with reference to the construction resource positioning section). Finally, specific example embodiments of multivariate or complex devices, which may utilize one, or multiple techniques, sensors, sensor types, actuators and/or actuator types (in particularly innovative combinations) for material characterization are described.

### GENERAL CONSIDERATIONS

### Devices Hardware Considerations

### Device Types

### Sensors & Node Devices

Sensor devices and/or node devices are devices which may typically be used to sample, monitor, store and/or transmit data sampled from sensor elements, and to excite actuator elements. They may be composed of a Microcontroller Unit (MCU), battery, electronics circuitry, communication interface and a sensor and/or actuator and/or transducer. They may be independent, or coupled. In one embodiment, the sensor device may be a passive cable assembly requiring a node device for active operation. In another embodiment, the sensor device may operate on a standalone basis. Any number of configurations of one or more of these components may be applicable.

Sensor and Node devices may communicate via any number of communications interfaces (as described later), which may be wired or wireless. They may communicate to other sensor devices, node devices, and hub devices and/or without loss of generality any other device type configured to receive communications. In certain cases, the sensor or node devices will not have a direct connection to the internet and will therefore require a hub (or gateway) device, or a personal device (such as a smartphone) to relay the data to other parts of the system.

### Hubs/Gateways Devices

The hub (or gateway) is a device which may be used to transmit data collected from node devices and/or sensor devices (or data about itself) to the internet/the cloud/a server/any external store of data. In some embodiments, the hub may also be a central control point, in charge of communicating directly to sensor devices and/or nodes. Those gateways or hubs may include any of the communication protocols listed in the communications section below and/or anywhere herein (to communicate with nodes and/or sensor devices, e.g. LoRa), and also any communication protocol that allows it to connect to the internet and cloud (e.g. cellular, including 3G/4G/5G, NB-IoT, ethernet or satellite connectivity). Hubs may be mains powered (typically using an industrial plug), or battery powered. Hubs may be rechargeable and may employ energy harvesting techniques (as described later).

### Accessories

Sensors, Nodes, Hubs and other Devices may optionally be coupled to accessories which fulfill various functions (e.g. structural/mechanical, or sensing & actuation expansion modules, wireless communication expansion modules etc. . . . ). Sensing & actuation expansion modules may take the form of another housing with a connector, or a cable assembly, which may be wired into a physical interface on the sensor device (e.g. through a connector on the initial device), or otherwise coupled (e.g. over any wireless or communication interface).

One embodiment of this is defined as a ‘tail’, with a plurality of sensor and/or actuators and/or transducers of one or more types. For example, a cable assembly with multiple temperature sensors is called a multi-probe thermal tail, as it can provide temperature measurements from a plurality of sensors, at a plurality of locations (for example, to build a spatial thermal profile, at different locations within a cementitious mixture during hydration). Optionally, the relative positioning between probes on tails may be determined using context awareness techniques (as further described elsewhere).

Tails may be attached to a device in a plurality of ways (some of which may be modular, and may be configured at the point of use, and in other embodiments that may require to be coupled at the point of manufacture). Overmolding techniques may be used. Applying overmolding to encapsulate the sensor device and attachment mechanism would create a unified, durable unit that may allow the device to withstand harsh construction environments (in particular those in a concrete pour, which can be exposed to pokers for compaction).

Optionally, to protect the electronics in the sensor body or tail probes, a low pressure and/or low temperature overmold may be used, or multiple layers, with a low-pressure, low temperature inner overmold, and a different outer aesthetic mold. Tails may have various configurations (e.g. daisy chain topologies; star topologies; 2D arrays, 3D arrays, and other topologies that may be used to establish an N-port system of sensors and/or actuators and/or transducers).

Mechanical/structural modules may enable new activation or attachment mechanisms or create new boundary conditions to enhance particular sensing or actuation characteristics (e.g. enhance resonance modes). Wireless communication modules will enable new forms of wireless communication. Other modules with other capabilities may also be built (e.g. a data processing module with a specific chipset, or a memory module). Modules may provide a combination of features (e.g. both a multiplicity of sensing and/or actuation elements, and a new communication interface). Without loss of generality, any accessory may be connected to, attached to, combined with or otherwise used in association with, any device embodiment herein.

### Personal Devices

Smartphones, tablets and mobile apps play a central role in this invention (and may in some embodiments remove the need for a hub). Sensor, node and hub devices may, optionally, be equipped with a Bluetooth radio and/or other, in some embodiments similar, communications interfaces configured to allow communication with a mobile phone. The smartphone may also be augmented using peripherals (through wireless or wired connections) that may enable support for any one or a plurality or combination of additional communication protocols, so as to communicate with a sensor device, node device or hub device.

Smartphone-based Registration: Each device (sensors, nodes, hubs etc.) may have a QR code that is used to identify the device, which may optionally be tied to a unique identifier or serial number for itself, or its individual sensor transducers. Mobile applications can be used to register sensor devices, nodes or hubs, or any other devices (see linkage section). Registration involves linking a device to device platform metadata—e.g. naming of a sensor device, or linkage of a sensor device to a particular element, pour, user, site or organization (with particular reference to the linkage section). This linkage may be stored in the cloud (on a server) or another device (e.g. a local server).

Smartphone-based Configuration: Smartphones may determine device configuration (e.g. by fetching from the cloud), based on a number of factors (including through linkage or context-awareness). They may fetch custom firmware to be flashed on the device, or particular configurations or settings (e.g. the monitoring and sampling frequencies for a given sensor device, or the transmission power for RF communications).

Smartphone Data Collection & Analysis: Smartphones and mobile apps may also be used to collect data from devices, which can then be stored locally, or transmitted to the cloud for storage and further analysis. This may include sensor measurements from a sensor device, or diagnostic and usage data from any hardware. Alternatively, certain computations may be carried out on the smartphone/personal device.

Device and Smartphone Sensor Fusion: The combination of measurements from the smartphone itself (e.g. GPS location, photographs or videos, the use of an onboard LIDAR sensor, or any communication modules) and measurements from device can also be used to further increase the level of insight and value being provided (e.g. to position a sensor, or any of the other context awareness, linkage or fingerprinting methods).

Generalization to other device types: The above, and the implementations herein generalize to any device type (whether they are a smartphone, tablet or other similar computing device, that is able to connect to the internet, and also has wireless interfaces such as Bluetooth, or a hub, node or sensor device). Generally, device functionality is interchangeable, and methods described can run on any combinations of hardware (distributed or not, local or cloud based etc.).

Sensors. Actuators & Transducer(s)

Devices may include one or more sensor elements and/or one or more actuator elements of different types. Some techniques will be passive (only requiring sensor elements), and others will be active, requiring actuator elements (that takes an input signal and generates an output excitation). In active systems, the sensor element typically measures the material response for analysis (the response of the element itself, or of the material of interest, or any other related element). Active techniques will require at least one actuator and one sensor. Devices may also employ transducers (which convert one form of energy into another), and vice versa (e.g. mechanical energy to electrical energy). All actuators (in the general sense of the term) are transducers, but not all sensors are transducers (some sensors, such as the photoelastic elements described later, exploit changes in their properties caused by their environment, which need independent excitation to be measured).

Despite the subtle differences between the physical meaning of these terms, in the context of hardware, the terms ‘sensors’, ‘actuator’, ‘transducer’ or ‘element’ may be used interchangeably to describe an element of a device used for detection, measurement, excitation, or actuation.

Sensors, actuators and/or transducers may exploit various physical couplings—e.g. electro-mechanical, electro-chemical, electro-magnetic, electro-thermal, magneto-mechanical, magneto-chemical, magneto-thermal, photo-mechanical, photo-electric, photochemical, photo-thermal, as well as third order couplings. This includes any possible combinations of couplings between electric fields, magnetic fields, electromagnetic fields/waves (including optical waves and photonics, but also RF waves), mechanical displacements & waves). The devices that exploit these couplings may be reciprocal (acting as both actuators and sensors), or non-reciprocal (only acting as a sensor or actuator). Different combinations of reciprocal or non-reciprocal coupling based devices may be constructed or used to sense different phenomena in materials such as concrete.

### Mechanical & Industrial Design

### Device Geometry & Size

Different shapes and sizes are considered for devices, including for sensor devices, or gateways/hubs and node devices. This will very depend on whether the device is intended to be embedded, surface mounted on, directed at or in proximity of concrete. Shapes may be cylindrical, polyhedral, cuboidal, spherical, or any 2D plate, or 3D volume. The device may include concave or convex elements that make adherence to the host material it considers (including its subcomponents, such as rebar in reinforced concrete), or attachment to particular types of materials easier. Devices may also be designed to change shape over time, through various forms of actuation (for example, made of adaptive materials or metamaterials).

Devices may also have different sizes. Ranging from miniaturized ‘smart dust’ or ‘smart aggregate’ intended to be mixed into the concrete during batching (from nanometers to centimeters in width), to small devices (a few centimeters) that may be designed to attach to rebar in a concrete pour, to much larger devices that may sit on top or in proximity of the material of interest, anywhere on the jobsite, or be attached to a crane hook or plant and machinery.

Various concave and convex features, and attachment methods will allow robust attachment to other materials such as rebar (for embedded devices intended to be disposed in reinforced concrete), or external poles, scaffolding (for external devices intended to be installed on the jobsite), and generally any other materials present on a construction site or related location (more information in the attachment section). Convex sections of enclosures, or frames may also act as receptacles to be filled by host materials (e.g. concrete), which can then be analyzed by onboard sensors. Device geometry may also include one or more holes (e.g., ring topologies, or cuboid edges connected by vertices, with empty faces allowing access to the inner volume) to allow host materials to flow in between different sensors on the device. They may be a combination of the above (convex-like shapes or frames with holes). They may be shaped like a concrete cube or cylinder (those used for standard compressive strength crush testing) and be inserted into those cube or cylinder molds. One embodiment includes a concave area with a grip that supports easy and robust installation on reinforcement bars of different sizes, using a cable tie or strap system.

Devices may also have hydrodynamic features intended to promote the flow and full encapsulation of concrete around the device (e.g. angled top-hat or curves). This may include holes throughout the geometry, angled surfaces, concave elements around which the concrete can flow etc. This may include (1) streamlined shapes such as oval or teardrop profiles, rounded edges and corners, and gradual tapering; (2) surfaced textures, including smooth polished surfaces to reduce friction and facilitate flow of concrete around the device; (3) grooved or ribbed surfaced that may be strategically placed to help guide the concrete flow, ensuring complete coverage (these may also be used for attachment); (4) small strategically located protrusions which can may help distribute the concrete mix evenly around the device; (5) channels and pathways on the surface of the device to promote flow of concrete and eliminate air pockets; (6) symmetries along the expected axes of concrete flow to ensure even flow distribution; (7) the use of fins to stabilize the device; (8) the use of flexible materials that may adjust to the flow of concrete to minimize voids;

If a strap or band is embedded into the device, the feature of the strap may also be optimized based on hydrodynamical considerations (similar to those above, e.g. tapered designs, rounded edges). Grooves on the strap may help guide the concrete. The strap may be made of flexible materials.

Finally, if the device is designed to be installed on rebar, various curvatures, including a negative triangular space bases (which will provide two contact points for circular rebar of different sizes), polygonal shapes, or compositions of multiple spherical or elliptical profiles may be used to promote adherence to the rebar.

### Material(s)

Devices (including sensor devices, nodes and hubs) have enclosures that can be made of a large variety of materials. These may include plastics such as acrylic (PMMA), acrylonitrile butadiene styrene (ABS), nylon (polyamide, PA), polycarbonate (PC), polyethylene (PE), polyoxymethylene (POM), polypropylene (PP), polystyrene (PS), thermoplastic elastomer (TPE), thermoplastic polyurethane (TPU).

Particular components may include different metal parts, which may be made of steel, aluminum etc. Careful positioning of metal parts and plastic parts is considered to promote wireless communication (in particular for embedded devices). Positioning of the antenna in respect of any of the materials used, and in respect of likely external materials (such as the rebar, onto which it is contemplated that embedded devices would typically be attached) is also carefully considered (usually, disposed away from such conductive elements, unless they can be exploited as signal resonators).

Device (in particular embedded sensor devices) shapes and material may be optimized for adherence. This includes the use of coatings or specific textured surfaces, and the use of composites and polymers (e.g. epoxies) to increase adhesion with host materials. Generally this will ensure that air gaps inside the concrete are avoided.

### Installation

The invention considers devices that may be embedded in, mounted on or directed at a host material, or any hybrid of these (e.g. a device may be partially embedded and partially mounted on a concrete pour). It also considers devices in proximity of or intended to generally be installed in the vicinity of the construction site, or a related location (e.g. the prefabrication factory). Devices may be installed further afield for long range techniques (e.g. for LoRa hubs, where the gateway may be kilometers away from the sensor device). Other considerations for installation of sensor devices include the following.

Sensor & Actuator Position and Orientation: The position and orientation relative to the concrete's structural features, particularly the rebar, can be relevant for exciting the correct volume, and accurate data collection and interpretation. For concrete characterization, the sensor device should be placed to ensure that the concrete is the primary material being excited and monitored as opposed to being near another dominant material (e.g. the rebar).

Depth of Installation: The installation depth is critical for ensuring sufficient sampling volume while maintaining communication capabilities via the RF interface. A coplanar installation with the top rebar may be ideal. Pressure sensors or other context awareness techniques are often used to inform depth.

Networked Data Collection: For applications like tomography, synchronized operation and knowledge of sensor distances are essential for accurate wave propagation analysis. These can be pre-defined or inferred from measurements (e.g. detection of existing RF signals in the environment such as Wi-Fi or BLE packets, or transmission of time and date for radio-controlled clocks (RCC), or other context awareness methods).

### Physical Interfaces and Modularity

Devices may include buttons, to power them on or off, or may be activated automatically through a different set of methods, described in the activation section below.

Buttons may also be used to change settings or modes on devices. Button types may include (without limitation): Push Button Switches, Toggle Switches, Slide Switches, Rotary Switches, Tactile Switches, Rocker Switches, DIP Switches, Key Switches, Piezo Electric Switches, Capacitive Touch Buttons, Microswitches, Pushwheel Switches, Encoder Switches, Limit Switches, Latching Switches, Soft Switches, Magnetic Switches. Buttons are selected based on handling (which often requires gloves).

Devices may also include a connector interface or other modular element, to allow for expandability of the system (either to antenna/RF systems which may be positioned inside or outside the concrete, or additional sensor probes, or other smart devices through a wired connection). The connector may also be used for diagnostics purposes (to access internal systems of the device). See section later in this document about the Sensing Cube System.

### UX Feedback

Devices may provide user feedback through one or more LEDs (e.g. to indicate the device has been activated, or connectivity to the cloud, to indicate sampling and any number of other device statuses). These LEDs may blink, breathe or provide solid colors. Devices may be configured using a mobile phone camera, pointed at the LEDs, which are configured to blink in any number of patterns. Devices may also include physical screens (including OLED displays, LCD displays, e-ink etc.). Devices may provide feedback through vibration and/or sounds, including advanced haptic feedback solutions.

For embedded devices, once they are embedded, this UX feedback would no longer be visible. Instead, digital feedback may be provided through mobile apps that are wirelessly connected to the embedded devices (including displays of signal strength, battery life, orientation and position of the device, and any of the measurements and/or context awareness outputs contemplated in other sections of this document).

Devices may also be interacted with or configured based on motion, rotations or forces applied on to them (e.g. through the use of inertial sensors). For example, shaking the device one or more times in sequence, or rotating the device in a particular sequence of rotations, or moving the device in particular sequences may change particular parameters, which may then optionally be displayed on a mobile device/app for confirmation.

### Attachment

The devices in this invention are designed to be integrated throughout the lifecycle of concrete, including into concrete pours or elements (installed prior to pouring, e.g. on rebar, and covered with concrete). Various attachment methods are designed to ensure optimal functionality (e.g. wireless communication) and secure placement throughout the concrete lifecycle.

Attachment designs consider factors such as sensor shape, resonance influence, and aggregate interference, and make use of various materials and coatings. They are resilient to diverse material environmental conditions, and do not compromise the host material's structural integrity. They ensure secure attachment to different components of the concrete (e.g., elements of the pour structure such as reinforcement bars, otherwise referred to as ‘rebar’ or formwork, concrete drums in trucks etc.). Attachment methods are classified as follows (non-exhaustive): (1) straps, bands or ties; (2) clamps, clips and fasteners; (3) adhesive and welding techniques; (3) magnetic attachments (that snap on to rebar); (4) innovative materials; (5) other; and (6) floating or sinking configurations (no attachment).

### Attachment Methods

### Overview of Attachment Methods

### Straps and Bands:

Straps, bands and ties, optionally integrated into the device housing, can be used for securing the sensor to the rebar. Optionally, the geometry of the devices may include convex features that wrap around the rebar, or grooves, slits, clasps and indents for the strap, to promote a tighter coupling with the rebar.

Elastic Straps with Multiple Turns: Straps made from durable, elastic materials can be wound around one or multiple times, providing a tight grip & preventing slippage.

Angled Multi-Strap System: Implementing multiple straps attached at various angles to each other, forming a web-like structure. This approach evenly distributes the load and holds the device firmly in place.

Stretch Straps with Attachment Holes: Similar to a watch band, these straps would have multiple holes along their length, allowing for adjustable attachment points. The design would enable a customizable fit for different rebar sizes.

Velcro Straps: Using Velcro (hook and loop) straps for easy, adjustable, and reusable attachment. The Velcro provides a strong grip and can be easily repositioned as needed.

Two Perpendicular Straps: Employing a configuration where two straps extend perpendicularly from the device, attaching to the corner of a rebar grid. This setup secures the device to the corner of the rebar grid, and ensures no rotations are possible (keeping any RF components facing up).

Four Perpendicular Straps: Employing a configuration where four straps extend perpendicularly from the device, attaching to a rebar grid. This setup evenly distributes the load and secures the device in the center of a rebar square.

Diagonal Strap System with Hooks: Implementing a spider-like fitting, where diagonal straps with hooks extend from the device. The hooks latch onto the rebar, holding the device securely at the intersection of the grid. These may also be used to fix the device at the corner.

Snap-On Straps: Implementing a snap-on wristband, which can be straightened and then slapped onto the rebar to curl and grip firmly. This may, for example, be made of a strip of bistable spring steel (which has two stable states: straight and coiled). One face of the steel may also be bonded onto a rubber-like material, which may be soft enough to imprint the rebar grooves to increase adherence).

Other: Multiple straps, optionally at angles to each other; Stretch straps with holes for attachment (e.g. with a pin buckle, or an extruding elements to attach the strap to);

Velcro Straps (e.g. with loop fastening); Elastomeric bands; Zip Ties (e.g. use heavy-duty zip ties to secure the housing to the rebar); Velcro Straps; Ratchet Straps; Cable ties: Cable ties with integrated mounts; Bungee Cords; Rubber Bands; Lashing Straps; Plastic Buckles and/or Straps; Nylon Webbing; Rubber or Silicone Straps; Cinch Straps; Ladder Lock Straps; Plastic Buckle Straps; Tie-down Rings; Adjustable Toggle Latches; Straps that lock through pin buckles, deployment buckles, diver clasps, spring latches or sliding buckles. Indentations, grooves and slits on the main body of the device to guide the strap.

### Clamps, Clips & Fasteners:

Different clamp configurations are considered for attachment Convex Enclosure Design: The body of the electronic enclosure may be convex to better conform to the cylindrical surface of the rebar, enhancing attachment stability. Some examples below.

Full Clamp: A complete clamp encircles the rebar, providing a firm grip. Optionally, a spring-like mechanism on the inside of the clamp, or a flexible clamp material (e.g. elastomeric band) or other mechanism to support different rebar sizes. Clamp closure may activate the device.

Half Clamp: This type of clamp partially surrounds the rebar, suitable for situations where full encirclement is not feasible. Otherwise, similar features to the full clamp.

Quarter Clamp: This smaller clamp offers a less intrusive attachment method, ideal for limited space or specific sensor orientations. Otherwise, similar features to the full clamp.

Prefabricated Holders: Using holders that clip onto the rebar (e.g. through elastic bending) which are optionally fully integrated into the enclosure. These holders would simplify the installation process and ensure a secure attachment. Holders may have elastic properties, fitting various rebar sizes. Optionally, multiple holder sizes may be modularly mountable onto the device.

Threaded Fasteners: Using threaded fasteners that can be screwed into designated points on the rebar or the formwork, or a frame, providing a strong and adjustable attachment.

Others: Pipe Clamps; Cable Clamps; P-Clips: Metal or plastic clips adapted to rebar geometries; Hose Clamps; Dual Lock Fasteners: Stronger alternatives to traditional hook and loop fasteners; Spring Clamps; Carabiners; Clip-on Brackets: Custom brackets; Metal Strapping e.g. Jubilee Clips; Cable Glands which are adapted to secure the housing in place;

C-Clamps; Spring Clamps; Aluminum Tap; Key Rings; Metal Hose Clamps; L-shaped Brackets; Screw Clamps; Copper Wire Twists: Twist copper wire around the housing and rebar; Tie Wire; Binder Clips; Gooseneck Clamp; Hitch Pins; Screw-in Eyelets: Screw eyelets into the housing for attachment points; Saddle Clamps; Steel Cable and Crimps; J-Bolts; U-Bolts; Hinged Clamps; Hose Clamp with D-Ring. Semi-circular full loop that clamp around the rebar (optionally activated upon closure). Claw Clips.

### Adhesive and Welding Techniques:

Various adhesive and welding techniques may be used to bond devices (e.g. to rebar). The selection of adhesive will be critical to ensure compatibility with the sensor coating and the reinforcement material.

Electrically conductive bonds allow for rebar to be used as ground or signal propagating medium (e.g. for electrochemistry).

Particular embodiments include: Electrically activated binding agents (that bond once an electrical signal has been applied, e.g. by the device); Industrial Grade Adhesive Strips; Epoxy Resins applied to housing for bonding; Gaffer Tape; Industrial strength double-sided tape. Hook and Loop Tape. Conductive Adhesives (for electrochemistry).

Magnetic Attachment (to Wrap or Fix onto Rebar, or Other Metallic Structure);

Using strong magnets or electromagnets on the device or the strap, such as neodymium or solenoids, allows for easy and adjustable attachment to steel reinforcement.

Wrap-Around Magnetic Strips: Using flexible magnetic strips that can be wrapped around the rebar. These strips would contain magnets at intervals to ensure a strong, uniform attachment along the entire length of the rebar.

Magnetic Clips: Designing clips with embedded neodymium magnets that can be easily snapped onto the rebar. The magnetic force ensures a secure attachment, ideal for quick installations.

Electromagnets: Electromagnets may be used for electrically and magnetically controlled actuation.

Magnetic base: a strong electromagnet bonded to a flexible (e.g. rubber or silicon) element which creates a concave inner surface or negative triangular space.

Magnetic clamp: A magnetic clamp. In one configuration this is made up of two individual elements, snapped together to fix the device.

Other: Magnetic Mounts; Magnetic Tape; Magnetic Hooks; Magnetic Welding Squares.

### Innovative Materials and Geometries:

These embodiments make use of various smart materials to wrap or attach the device.

Shape-Forming Alloys: Using alloys that change shape in response to temperature or electrical input (or other coupling), allowing the device to grip onto the rebar more effectively.

Expanding Foam Casings: Using casings filled with a chemical compound that expands and hardens around the rebar (e.g. expanding foam). This method would ensure a custom fit for each installation.

Rebar Sleeves with Integrated Sensing: Creating sleeves that slide over the rebar and are equipped with integrated sensors. These sleeves could be made from materials that enhance sensor performance, such as elastomers. Sleeves may also open and close (e.g. using velcro), to allow for installation after the rebar has been installed (to avoid having to slide it in from the stop-end). Shrinking sleeve may also be constructed. When pulled, their inner diameter shrinks (e.g. constructed through cylindrical, helically wound braid, or a common biaxial braid).

Flexible Sensor Strips: Using flexible sensor strips that can bend around the rebar, conforming to its shape. These strips could house various sensors themselves made of traditional rigid electronics.

Flexible Electronics: A flexible printed circuit board (PCB) can be designed to wrap around the rebar, providing a compact and secure attachment that conforms to the rebar shape. Several antennae may be disposed along the circumference, which can then be adaptively selected to maximize transmission.

Electrically Activated Binding Agents: Using a compound that bonds to the rebar when an electrical signal is applied (which could be user activated, or automatically activated upon installation), creating a strong, permanent attachment.

Other: Casings that evolve and ‘grow’ around the rebar (e.g. expanding foams); Memory wires (heats and wraps/secures around rebar); Meshes (create a mesh or net around the housing and secure it to the rebar); Inflatable attachment systems (e.g. inflatable cuff). 2×C brackets; Hung with cord from 3 or 4 points (which maintains distance from rebar). Suction Cups; Elastic Wrapping (e.g. a strap or elastic surface or film that can be wound around the device & rebar or otherwise used to fully encapsulate and immobilize the assembly. Cling-film like materials may be employed).

### Dual Point and Multi-Point Systems:

Generally dual point attachment systems that exploit any of the mechanisms listed above, providing increased stability and redundancy. In some cases, these dual point systems also prevent rotations, which enable better RF communication.

### Floating or Sinking Device Configuration:

For areas where direct attachment to rebar is not viable, a floating or sinking device setup can be employed, allowing the sensor to remain in the desired location within or on the surface or bottom of the concrete pour. Optionally, buoyancy may be tuned (e.g. electronically through adaptive enclosures, that control the volume and surface area of the device).

### Device Activation, Registration & Configuration

Device activation may refer to how the device powers up or moves out of a low-power mode or sleep mode into a higher power operational mode. Several mechanisms are contemplated, including both mechanical, electrical and sensory approaches, tailored to minimize premature activation and optimize device lifespan and UX. Devices may also be ‘always active’ if they can harvest sufficient energy, or be low power enough that they last long enough on the shelf, in transit and in operation.

Registration and Configuration have been further described in the ‘smartphone’ section above, and in the linkage section. Devices may also be registered or configured without a smartphone (possibly even automatically based on their contextual conditions through the use of context awareness).

Activation methods for the sensors are twofold: active and passive. Active modes involve direct commands via the device interfaces (e.g. physical or RF interfaces) to initiate specific device functions, while passive modes rely on environmental triggers, such as stress or chemical changes in the concrete, to automatically activate the sensors. In both active and passive modes, the system can dynamically adjust device activation based on the construction environment, material properties, and specific monitoring needs (e.g. through context awareness).

Deactivation or decommissioning may also be carried out (e.g. using a smartphone, or remotely from a cloud platform, through any internet connected infrastructure). Decommissioning access control may be based on permission rules and require authentication between the device being deactivated and the user (optionally, server-confirmed). Deactivation may temporarily deactivate the device (reversible), or permanently disable a device (optionally, through an irreversible hardware mechanism).

### Mechanical Activation

Button Activation: A physical button or switch can be incorporated into the device (e.g., of any of the types described under physical interfaces). This method provides a tangible and straightforward way for users to manually activate the device. Special considerations are taken to prevent accidental activation during handling or transport such as button covers, and to make it friendly to construction gloves; Mechanical Configuration of Housing: Other features in the housing are moved from their default position, which leads to activation (optionally through various sensor methods.

### Electronic Activation

Electronic Conduction-based Activation: A mechanical action (e.g., pulling a chord blocking current flow) creates an electrical contact, closes a circuit and leads to activation.

### Sensory Activation

Magnetic Activation: Incorporating a magnetic sensor, such as a hall effect sensor, allows for activation by removing a magnetic card or tag. This method ensures that the device remains in sleep mode until it is deliberately activated on site.

Chemical Activation: When embedded, the sensor can automatically activate the electrochemical conductivity between two electrodes on the outside of the device allowing it to only activate when placed within wet concrete.

Light-Based Activation: The device can be equipped with light sensors that detect when it is enveloped by concrete, triggering activation. This method is especially useful for ensuring the device activates only when in its intended operational environment.

Radio Frequency (RF) Activation: The device can be activated remotely using RF signals. This method is beneficial for activating devices that are already embedded in concrete or difficult to access physically.

Mechanical Activation: The device can be configured to be activated when a mechanical pressure or stress is applied onto it (e.g. when concrete covers it).

Combined Sensory Activation: To further minimize the risk of premature activation, a combination of sensory methods (light and RF, for instance) can be used. This redundancy ensures activation only under specific conditions, enhancing reliability.

### Miscellaneous Activation Methods:

Voice Recognition; Gesture Control (inertial sensors or cameras to detect predefined displacements or hand gestures); displacements of device (e.g. shaking the device to activate); Proximity Sensors; Motion Sensors; Biometric Recognition; Mobile App Control; Wireless signal strength; Time-Based Activation; RFID/NFC signal based activation; Capacitive Touch Controls; Wireless Remote Control;

### State Machine and Logic

### State Transition

Sleep/Low Power Mode: The device initially remains in a low-power sleep mode to conserve energy during storage and transit.

Activation: Upon receiving the correct activation signal (mechanical, electrical or sensory), the device transitions to an active state.

Operational Mode: In this mode, the device begins its primary functions, such as sensing and data transmission.

### Debouncing Logic

To prevent false activations, the device employs a debouncing logic mechanism. This mechanism ensures that the activation signal is stable and deliberate before transitioning the device to the operational mode.

### Activation Upon Attachment of Device Housing:

Particularly advantageous embodiments include those that activate upon or after the attachment of the device housing (e.g. to concrete). These include:

Magnetic Attachment: Activation by magnetic reed switch of similar (upon clipping or clamping, or attachment of strap).

Quick-Release Clamps: Designing a quick-release clamp mechanism can allow for rapid attachment and detachment. Clamp completes a circuit to activate.

Suction Cups with Activation Sensors: Suction cups designed with built-in sensors to detect when the device is securely attached. The activation process is initiated once the sensor confirms proper attachment, either via pressure or deflection.

Twist-Lock Mechanism: Implementing a twist-lock mechanism can provide a secure attachment to a rebar. Activation sensors can be triggered when the device is securely twisted into place, the bayoneted or similar could feature contacts which when in the correct orientation, activates the device.

Spring-Loaded Mechanism: Devices can be equipped with a spring-loaded mechanism that expands or contracts to securely attach to rebars of varying diameters. Activation can be tied to the successful attachment.

Screw Thread System: Using a screw thread system for attachment provides a secure and adjustable connection. Activation sensors can be linked to the final tightening of the screw, completing the circuit.

Smart Straps with RFID or NFC: Straps with embedded RFID (Radio-Frequency Identification) or NFC (Near Field Communication) tags can be used for attachment. Activation occurs when the device recognizes a unique tag associated with the rebar.

Adhesive Pads with Pressure Sensors: Utilize strong adhesive pads that adhere to the rebar and integrate pressure sensors. Activation occurs when the sensors detect sufficient pressure, indicating a secure attachment.

Climbing Grips with Activation Buttons: Device with climbing grips that wrap around the rebar. Integrate activation buttons within the grips, requiring a specific hand movement or pressure to activate the device.

Pneumatic Grippers: Pneumatic grippers that use compressed air to securely hold onto the rebar. Activation can be tied to the pressurization process, ensuring a strong grip before the device becomes operational.

Cam Lock System: A cam lock system where a rotating cam secures the device onto the rebar. The cam rotation can trigger the activation process.

Threadless Attachment System: A threadless attachment system that relies on interlocking grooves or teeth for secure attachment. An activation mechanism can be linked to the successful interlocking of these components.

Ultrasonic Attachment Confirmation: Utilize ultrasonic sensors to confirm attachment by measuring the distance between the device and the rebar. Once the optimal distance is achieved, the device can be activated.

Electrostatic Adhesion: Explore the use of electrostatic forces for attachment. Activation can occur when the device establishes a stable electrostatic connection with the rebar.

Self-Adapting Clamps: Design clamps that can adapt to rebar of different diameters. Sensors within the clamps can detect the rebar's dimensions and adjust the clamping force accordingly, triggering device activation.

Smart Fabric Straps: Integrate smart fabric straps with conductive fibers. The straps can be wrapped around the rebar, and activation is initiated when the conductive fibers make a complete circuit.

Shape Memory Alloy Grips: Design grips made of shape memory alloys that can deform to securely grip the rebar. Activation occurs when the alloy reaches its pre-programmed shape and forms a circuit and attachment loop.

Piezoelectric Latching: Utilize piezoelectric materials in the attachment mechanism. The pressure applied during attachment generates electric charge, triggering activation through a piezoelectric sensor.

Expandable Net System: Employ an expandable net or mesh system that can wrap around the rebar and automatically tighten. Sensors in the net can confirm proper attachment, activating the device.

Infrared Alignment: Implement infrared sensors to assist in aligning the device with the rebar. Activation is triggered when the infrared beams align correctly, indicating a precise attachment.

The above are illustrative of the general concept. Any combination of the sensors and actuators described herein, and any of the attachment methods, may be used for automatic activation (e.g. through the use of context awareness techniques, or any coupling).

### Miscellaneous Automatic Activation Methods

More generally, automatic activation can be coupled to a number of different sensors, which may be triggered based on any number of statuses (see the statuses in the status inference section, with particular reference to device statuses). Automatic activation based on when the device is unboxed, installed on rebar, but also when it is covered by or comes into contact with a host material such as concrete, or based on a threshold physical measurement (e.g. applied strain) are all considered.

### Specific Embodiments of Device Attachment & Activation

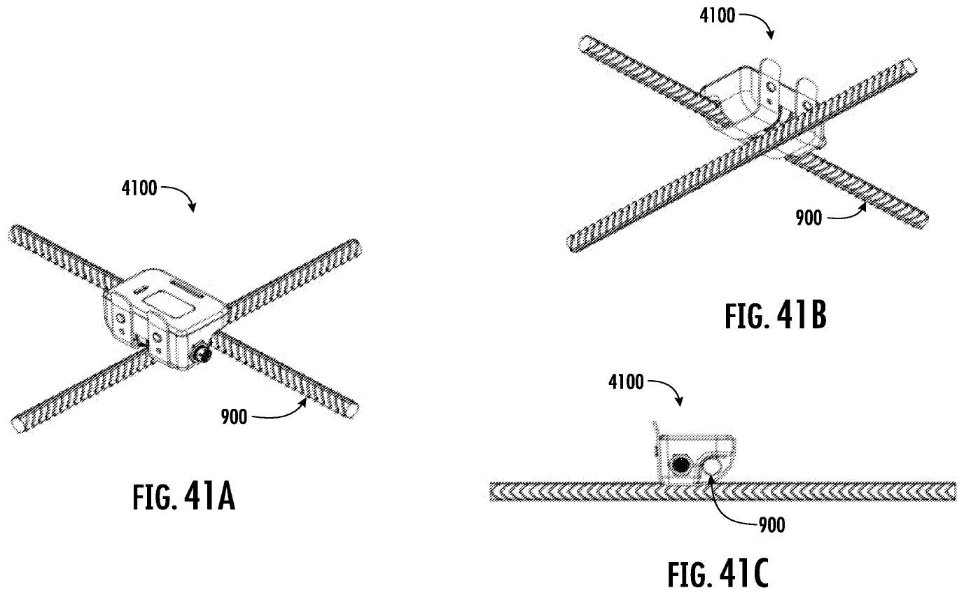

With reference to FIGS. 41A-41C, an example device attachment 4100 is illustrated attaching an example sensor device to rebar 900 (e.g., an anti-roll rotation device attachment and activation implementation). As shown, the attachment 4100 may operate to attach a sensor device via attachment 4100 to rebar 900 to be able to securely prevent slippage by straddling a second rebar that is placed perpendicularly underneath to the main rebar anchor. As visible for the quarter-cylinder-shape, the device is secured to a primary rebar that prevents yaw and pitch rotation in the vertical and lateral axes while the secondary rebar affixing prevents roll in the longitudinal axis.

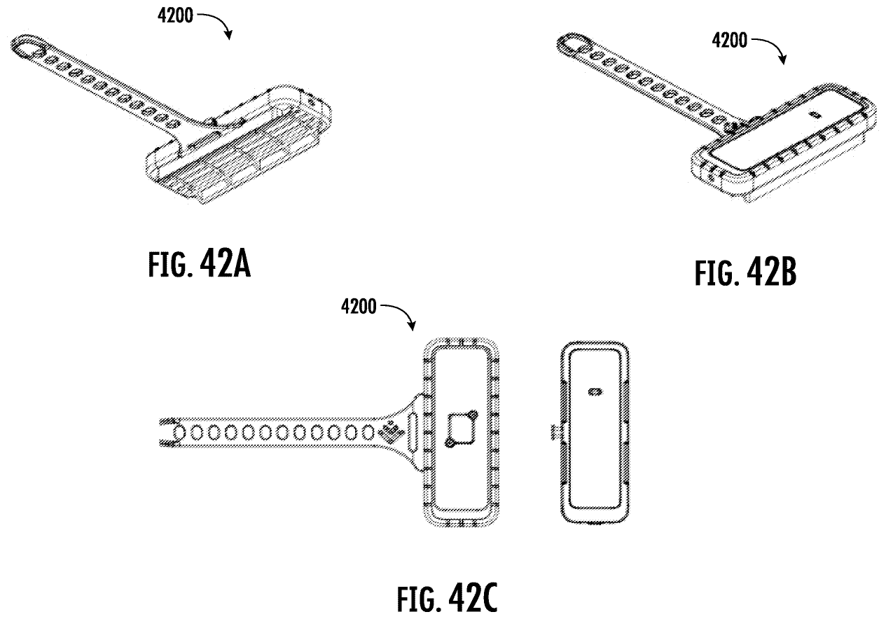

With reference to FIGS. 42A-42C, an example device attachment 4200 is illustrated attaching an example sensor device to rebar 900 (e.g., a flexible boot implementation). As shown, a sensor device may be designed with mating pogo pins on its back (and in this embodiment is elongated, and thin, so as not to experience torque around the rebar). A boot made of elastomeric material and a integrated pogo circuit is designed. When the device is inserted into the boot, the pogo pins come into contact with the pogo circuit on the boot. This electronically couples the device to the boot and activates the device. The underside of the boot is designed to provide a high contact surface area and mechanical compliance to result in an enhanced curvature mating when under pressure from the wrist strap being secured. Optionally, the pogo contact area on the inside of the boot connects to one or more exposed electrodes on the underside of the boot. Alternatively, the underside of the boot is made of a conductive material.

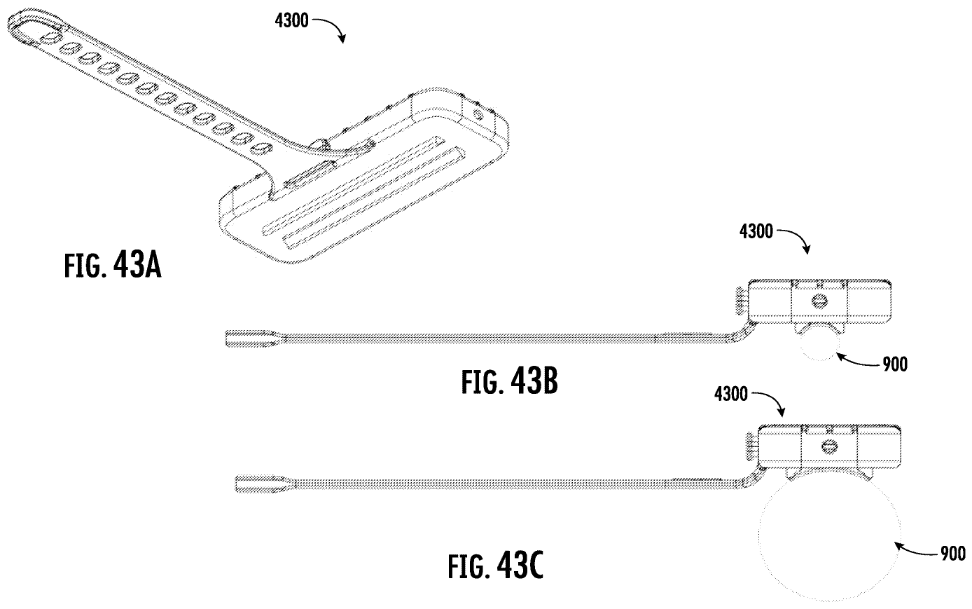

With reference to FIGS. 43A-43C, an example device attachment 4300 is illustrated attaching an example sensor device to rebar 900 (e.g., flexible boot variation). This variation of the boot of FIG. 42 has adjustable profile pads on the underside (that can be adjusted based on rebar size) and adhesive material for varying rebar 900 sizes (to further promote adherence).

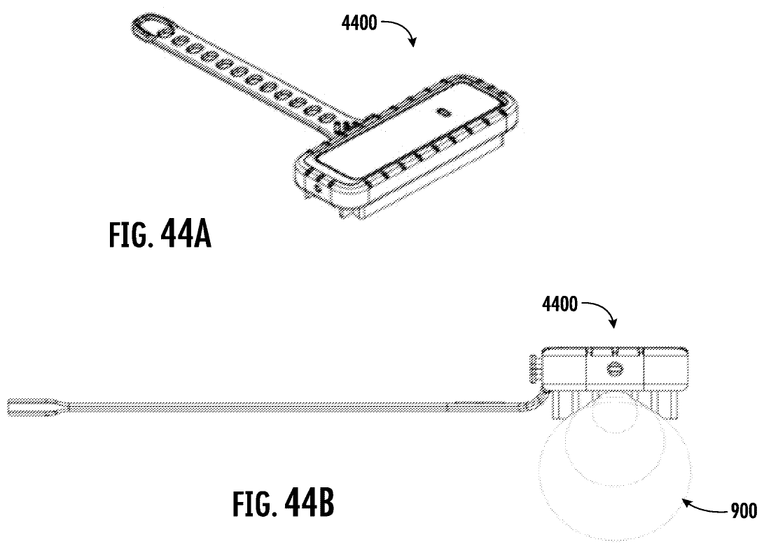

With reference to FIGS. 44A-44B, an example device attachment 4400 is illustrated attaching an example sensor device to rebar 900 (e.g., another flexible boot variation). This instantiation of the boot of FIG. 42 may have an elastomer profile on the underside so as to be compatible and adhere well with rebars 900 of varying gauges. The profiling may feature multiple diameter apertures (so that various gauges are directed to adhere to it in different ways).

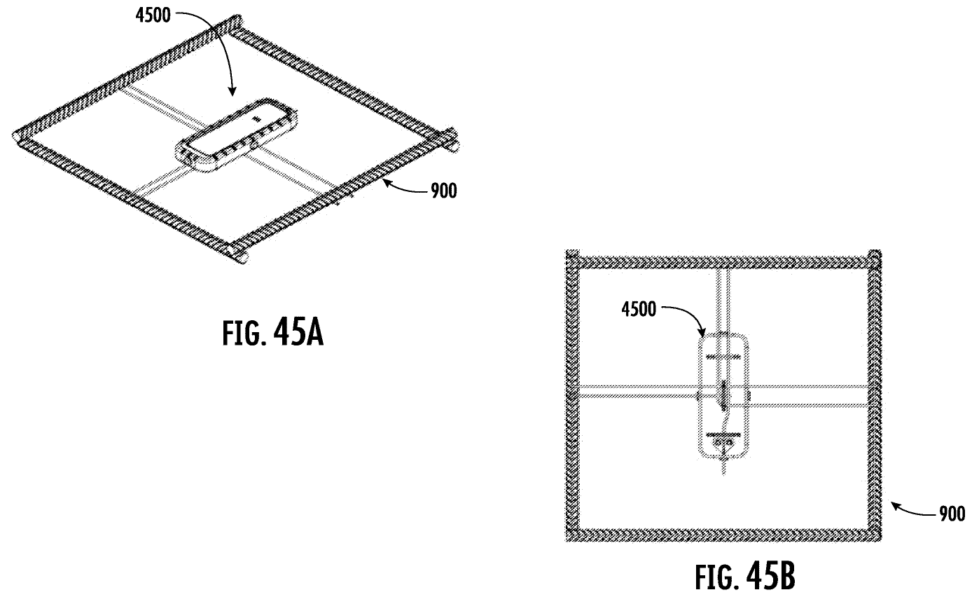

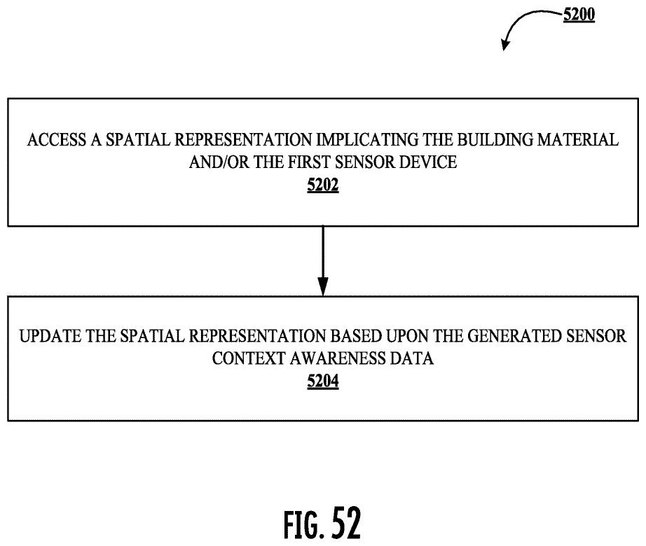

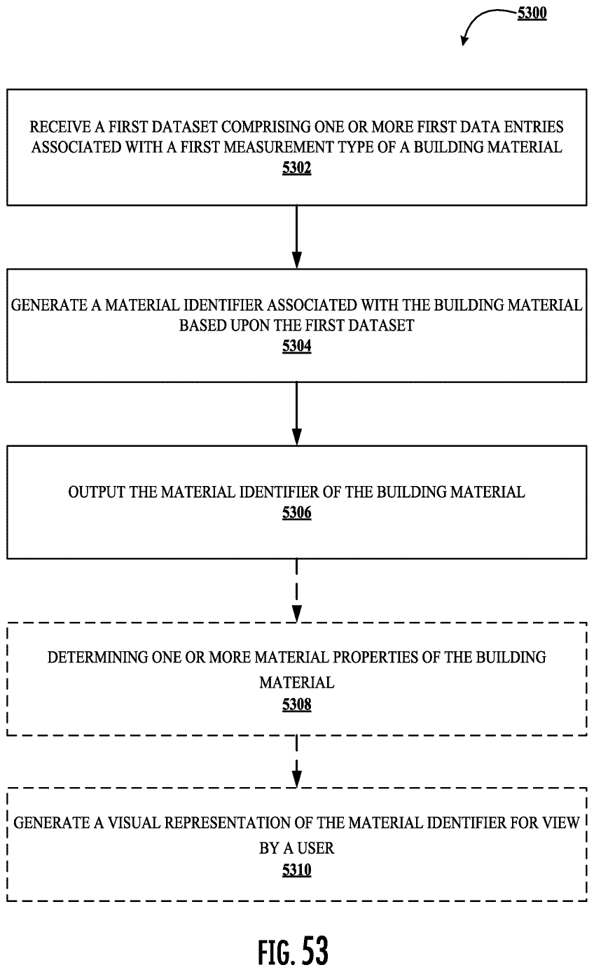

With reference to FIGS. 45A-45C, an example device attachment 4500 is illustrated attaching an example sensor device to rebar 900 (e.g., flexible boot attachment). As shown, the flexible boot of FIG. 52 may be held to the rebar 900 with a cord that weaves through the underside of the device and around rebar in order to suspend it using tension and in so doing providing an affixing technique that allows the device to be sufficiently separated from the conductive rebar 500 so as to carry out electromagnetic or mechanical sensing and excitation.

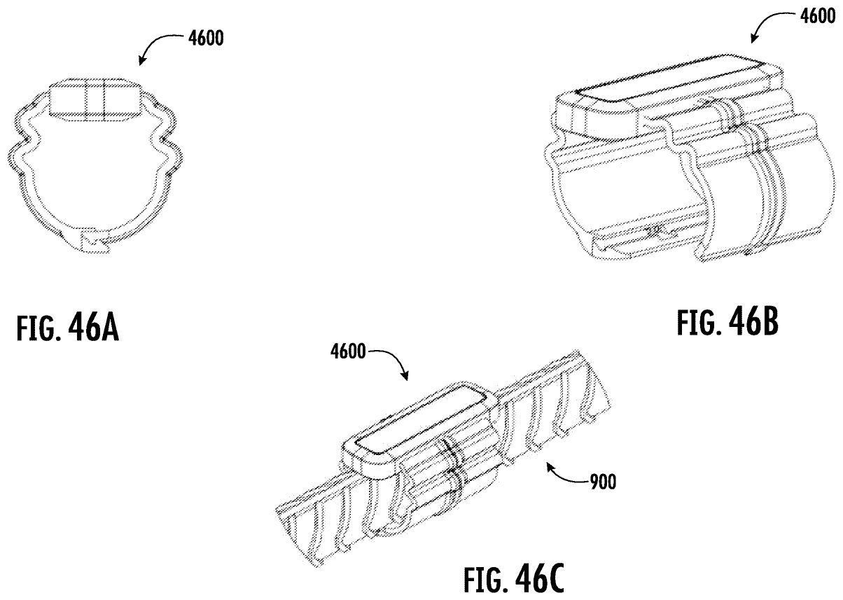

With reference to FIGS. 46A-46B, an example device attachment 4500 is illustrated attaching an example sensor device to rebar 900 (e.g., flexible contact clip). As shown, the attachment presented depicts a clip that can deform under pressure in the vertical direction so as to go around rebar 900 of different gauges. The joining points of the two sides of the clip both interlock mechanically as well as connect electronically (or in an alternative embodiment, magnetically) so as to activate the device whenever the clip has been securely closed.

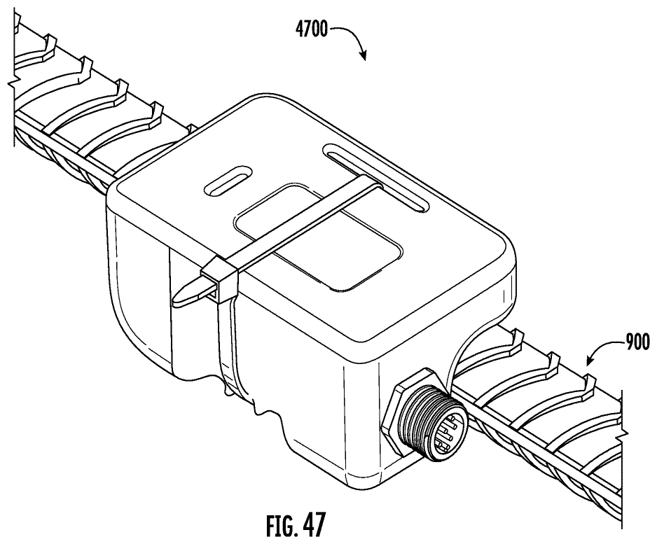

With reference to FIGS. 47, an example device attachment 4700 is illustrated attaching an example sensor device to rebar 900. As shown, the attachment mechanism of FIG. 47 depicts a strap wiring mechanism for sensor devices to be attached to rebar 900. In this embodiment, an elongated hole exists on the sensor device casing which allows the wire to be wound around the device and the rebar and locked onto itself. The sensor device may define a quarter-spherical shape to naturally slot onto the rebar.

### Advanced Power Management

Devices may be powered using batteries of different types (including rechargeable batteries such as lithium ion based chemistries, or single use battery chemistries such as lithium thionyl chloride), or single-use coin cell batteries. They may also employ duty cycling and smart power management, and/or energy harvesting techniques to extend their battery life. Specific power management circuitry and/or battery types may be employed to manage larger spikes in energy consumption (e.g. for wave-based sensing excitation). Energy requirements for actuation elements will depend on sampling frequency, desired probing distances, and on the number of sensor transducers.

### Power and Energy Capacity Requirements

The power and energy requirements of devices depend on the range and the number of excitation transducers, sensors, processing units as well as required battery life. We can benchmark against ultrasonic proximity sensing, where to achieve 0.1m to 10m range, roughly 336 mW is required. Particular embodiments (e.g. electronic-based) will be ultra-low-power, whereas others (e.g. LIBS) will require large peaks of power (for short periods of time). To ensure multi-year battery life in a small low-cost form-factor, various energy conservation methods are used (including smart duty cycling so that excitation measurements, and wireless communication, which are the highest power functions, are only carried out at required intervals).

### Adaptive Power Usage

Devices feature an adaptive approach to power consumption, with sensors entering a low-power sleep mode during inactivity (e.g. where continuous monitoring is not required). Power settings can either be automatically or remotely adjusted based on real-time data needs and battery status, or based on context awareness outputs, optimizing the balance between operational readiness and energy conservation. A reversion to and out of sleep mode may be triggered automatically after a predefined operational period or manually through a deactivation command, or automatically based on a wake-up signal (e.g. from a sensor, or through different duty cycling modes).

### Energy Harvesting

Devices may operate indefinitely through the combination of adaptive power usage and energy conservation, and energy harvesting techniques. Furthermore, wave-based sensor devices (which are described further down) generally use elements that may generate or receive waves and/or oscillations. These elements may be reused as energy harvesters during off-time (i.e. when they are not sampling). Key examples are included below.

Thermoelectric Harvesting: Thermal energy may be harvested into electric energy. In particular, the natural thermal gradients and differentials that exist within the materials that our devices are embedded or mounted on (e.g. concrete) are exploited for this. This is particularly relevant during curing (where thermal gradients are significant due to the hydration reaction), but also longer term (as a thermal differential will exist between the inside and outside of buildings, which are typically delimited by structural elements). In one embodiment, a thermoelectric generator (TEG) may be used to harvest thermal energy, which employs the Seebeck effect to transform temperature difference into electric energy. This typically consists of semiconductors connected in series and sandwiched between two plates, wherein an electric field is induced when there is a temperature difference. Other embodiments include (without limitation) thermionic converters, thermo-magneto-electric generators, piezoelectric energy harvesting from stresses caused by thermal expansion, thermo-galvanic cells or pyroelectric energy generators.

Photovoltaics: Photoelectric couplings may be employed to harvest energy from light sources, for example from Photovoltaic Cells (PVs). This may be used for devices installed externally (or on the surface of) materials. Beyond PVs, other techniques include (without limitation) Dye-Sensitised Solar Cells, Organic PVs, Perovskite Solar Cells, Photoelectrochemical Cells, Luminescent Solar Concentrators or Thermophotovoltaic Cells.

Mechanical Harvesting: Electromechanical couplings may be employed to harvest energy from mechanical displacements and oscillations. This includes (without limitations) ultrasonic wave energy harvesting from triboelectric nanogenerators, or the use of a piezoelectric or electrostrictive material in passive mode to collect energy. Generally vibrations, compressions or rotations can be transformed into electric potentials or magnetic fields, using any of the elements described under the relevant section of the wave-based sensing solutions (any mechano-electric, mechano-magnetic or electro-magneto-mechanic transducer).

Electromagnetic Harvesting. Electromagnetic energy may be harvested through carefully tuned antennas, induction loops, coils, antenna and coil arrays etc. Devices may also be designed for inductive charging. Devices embedded in host materials are inductively rechargeable using mobile external inductive chargers, enabling long term monitoring of the host structure through the embedded energy harvesting devices (with occasional maintenance). Alternatively, energy may also be distributed through rebar structures (with exposed rebar).

The harvested energy may be stored in batteries. In addition, batteries can be formed by using the medium that they are surrounded by for example the air with a Zinc air battery but also the chemicals available in material under consideration (e.g. concrete) reacting with certain parts of the sensors' outer part of the enclosure.

### Supercapacitors for Fast Charging and Peak Power Delivery

A number of this invention's hardware embodiments make use of supercapacitors, in particular for peak power delivery, fast charging and smart power management. Wave-based sensing excitation signals may require significant peak power (in particular when multiple ones are used as arrays). It may not be possible to draw such currents from standard batteries (e.g. coin cells). A particularly advantageous embodiment makes use of supercapacitors to manage the peak power requirements of the system. This enables the miniaturization of what would traditionally be quite bulky equipment into an ultra-low power system and allows us to choose lower-cost battery systems.

### Signal Processing, Excitation, Sampling & Synchronization

In this section, various techniques for signal excitation, processing, sampling and time synchronization are considered, to be executed by any device (or a plurality of devices), or a server.

Signal measurement, processing and generation on devices may be analogue or digital. For example, in the analog case, fourier analysis or other data processing techniques may be carried out by passing the input signal through a series of bandpass filters or fiber optic filters and reading the output voltages. In the digital case, an Analog to Digital Converter (ADC) is used to convert an analog excitation or output into a digital signal, which is then processed by the Microcontroller Unit (MCU).

### Distributed Approach

Devices may process data signals at the edge (rather than on the cloud), or offload processing to other devices (e.g. personal devices, or nodes or hubs), or to the cloud server, based on available computing power, power consumption (and desired device battery life) and the throughput of communication channels. For example, a fourier transform could be carried out at the edge, on the device itself. This may be done by the MCU on the device, or through custom circuitry (either through digital or analog signal processing). Data can also be synchronized from the cloud to the edge at different times (with devices storing data inputted by users on a cloud platform and vice versa). As such, system of devices operates as a fully distributed computing system (where each device is a node with different computing, memory, communication characteristics).

Signal processing may be split into stages where a first stage of the processing is carried out on the sensing device, then another step on the gateway and finally another step on the cloud. Depending on the complexity of a data operation, and on the bandwidth of the available communication channels, on-device memory & computation power, and latency requirements, and data co-location requirements, certain computations may be carried on the device, and others offloaded to an external device such as a mobile phone (over BLE), or to a server on the gateway, edge server or cloud (e.g. over LTE or nb-IoT and the internet). The pipelining and/or distribution of these operations may be carried out by a model (optionally, a machine learning model executed on the device, gateway, or server). For example, it may determine that it is more energy efficient to process the signal on the device and send the output to the server (rather than send the full signal to the server).

### Signal Generation and Detection

In some device embodiments, input or excitation signals need to be generated (for example to stimulate a transducer, in contact with a material in the context of wave-based sensing). Traditionally, such signals are excited and measured using bulky, expensive, and power hungry lab signal generators, oscilloscopes, impedance analyzers, vector network analyzers etc. The inventor's devices utilize ultra-low power and low cost electronics to achieve this, offering a step-change for the industry which will enable wide applicability.

Excitation signals may be generated using analogue and digital techniques. In one embodiment, to manage the power requirements of energy-intensive excitations, devices may include supercapacitors. The supercapacitor is controlled by a MOSFET (itself controlled by the MCU). The supercapacitor and transistor are used to generate AC signals by turning the tap on and off at the desired frequency. In other embodiments, more complex circuitry such as an H-bridge with output capacitors and using pulse width modulation (PWM) can be used to drive more finely controlled bipolar waves. These implementations are particularly advantageous to generate the required excitations to measure impedance, or T and S parameters (mentioned in other sections). For sensing and measurement (in particular for high-speed signals, such as S parameters of electromagnetic wave impedance), the inventors have also considered the use of high-speed electronics. Specific embodiments are described further later.

When measuring frequency responses of linear systems (e.g. impedance), in order to optimize for shorter measurement periods and lower power consumption, broad spectrum pulses or multi-sines can be used as these carry energy in all the frequencies. On the other hand when higher precision is required single frequency sinusoids can be used in order to characterize the frequency response more accurately. If a better time-frequency accuracy is required, either signals with multiple harmonics or wavelet pulses can be used at the excitation end (sending wavelet pulses), used at the receiving processing unit to analyze the signal or both in combination. Generally, any of the techniques described above enable the miniaturization & low-power nature of the invention, which enables wide use and embeddability for the concrete industry.

### Time Synchronization & Clock:

Devices will typically have an onboard clock. The accuracy of the onboard clock may vary device to device. Smart time drift compensation systems may be used to ensure synchronization across devices. Device clocks may also be updated when a connection to the internet, or to other devices that have a more recently updated clock is established. Distributed systems of devices, which communicate wirelessly or through wired connections are also considered. This may include Bluetooth Low Energy 5.2, and in particular techniques for highly accurate time synchronization between devices, broadcasting and Bluetooth mesh. This is particularly valuable in the case where sensor device arrays are put together, which may not be physically coupled. This allows, for example, in the case of wave based sensors, time synchronization of excitation signals across multiple devices, and accurate multi-reception (e.g. for tomography application, or radar/GPR applications). Different techniques are used for time drift management (including in one embodiment, a chip-scale atomic clock for ultra-high accuracy time synchronization). High accuracy time management opens up novel sensing techniques that exploit time, frequency and/or phase shifts (e.g. time domain reflectometry in concrete).

### Communication Methods

### Description of Communication Methods

In addition or alternative to the communication mechanisms and systems described in FIGS. 1 and 3, the embodiments of the present disclosure may use one or more of the following in any combination. Types of communication: Device communication is categorized as inter-device and intra-device communication. Inter-device communication relates to communication between devices and other devices (including communication to the internet). Intra-device communication represents communication (e.g. of digital or analogue signals) within the device, to its subcomponents (e.g. the MCU communicating with a sensor or actuator element, or communicating with an accessory). In both cases, communication can be wired or wireless (e.g. intra-device communication to an accessory may be wireless, although in some respects this could also be considered as two individual devices). Finally, some devices may be able to communicate with the internet over a backhaul (and connect their local networks to the internet).

### Wired Communication Protocols & Systems:

Methods to communicate via wired communication include (but are not limited to) 1-Wire; SPI (Serial Peripheral Interface); I²C (Inter-Integrated Circuit); UART (Universal Asynchronous Receiver/Transmitter); RS232; RS485; RS422; CAN (Controller Area Network); LIN (Local Interconnect Network); Ethernet (for networked devices); USB (Universal Serial Bus); Modbus (primarily in industrial contexts); TWI (Two Wire Interface, similar to I²C); SMBus (System Management Bus, derived from I²C); MIPI (Mobile Industry Processor Interface, for mobile devices); LVDS (Low-Voltage Differential Signaling); JTAG (Joint Test Action Group, used for debugging and programming); SPI/QSPI (Quad SPI for higher data rates); I2S (Inter-IC Sound, used for audio data transfer); SDIO (Secure Digital Input Output, for SD cards interfacing); PCIe (Peripheral Component Interconnect Express, for high-speed component communication); OneNet (for IoT devices); PPI (Parallel Peripheral Interface); SSC (Synchronous Serial Communication); FlexRay (for automotive networks).

### Wireless Communication Protocols & Systems

Physical Protocols: Classic Bluetooth; Bluetooth Low Energy (BLE); BLE Long Range; LoRa (Long Range); Sigfox; NB-IoT (Narrowband IoT); LTE-M (LTE for Machines); RPMA (Random Phase Multiple Access); 2G (GSM/GPRS/EDGE); 3G (UMTS/HSPA); 4G (LTE); 5G; Wi-Fi HaLow (802.11ah); Wi-Fi (802.11a/b/g/n/ac/ax); Zigbee; Z-Wave; Thread; RFID (Radio-Frequency Identification); NFC (Near Field Communication); ANT/ANT+; WirelessHART; ISA100.11a; EnOcean; Weightless; Insteon; 6LoWPAN (IPv6 over Low-Power Wireless Personal Area Networks); WiMAX

Internet Backhauls: Cellular Backhaul (2G, 3G, 4G/LTE, 5G); Ethernet Backhaul; Wi-Fi Backhaul; Fiber Optics; Microwave Links; Satellite Links; Copper Lines (DSL); Millimeter Wave Bands; Coaxial Cable;

### Device Types & Communication Modes

In the taxonomy of devices, Sensor Devices and Node Devices may either be able to connect directly to the internet through a wired or wireless interface, or they may communicate through a wired interface (into another device), or they may communicate through a wireless interface to one or more devices (directly or indirectly through other devices) over a local network. Typically, if at least one of the devices on the network is able to connect to the internet through a backhaul (e.g. a hub/gateway, or a personal device) then data from the sensor or node devices can be synchronized or transmitted to a server. Hubs/gateways are designed to communicate to the internet via backhaul (when a network is available and reachable), and act as bridges between the local network on which the sensor devices or nodes may communicate, and the internet.

Local networks can either be controlled by low power bespoke protocols or industry standards such as protobuf over Bluetooth Low Energy. The topology of the local network can be a star network controlled by either the hub/gateway or a smartphone device however in many circumstances the sensor and node devices can re-organize in a mesh-like low power network in order to share the data between them to both propagate it to the nearest gateway as well as for each sensor to hold the data of other sensors either temporarily or permanently in order to add data redundancy to the overall system.

Finally, the local and uplink network connections are optimized for low power consumption and do so using techniques such as adaptive transmission power control, heavy transceiver duty cycling, pre-agreed long latency rendezvous scheduling of synchronous transmit and receive actions on both parts of the network as well as pseudo-random digital encoding and noise-resilient radio-frequency modulation techniques to allow for a lower bit error rate and packet loss at lower power levels and signal to noise ratios during communications. All of the aforementioned techniques are used in conjunction to get the data from the sensors to the right destination whilst conserving energy in order for small batteries to last a long time or operate for longer periods of time on lower power budgets to allow for energy harvesting power operation to be viable.

### Considerations for Protocol Selection

Communication protocols such as BLE, NB-IoT and other cellular technologies, LoRa, Sigfox and more are all considered for our IoT devices. Some techniques are better suited to high data throughput than others. This includes both different physical frequencies (through changes in the physical hardware), and also different digital communication protocols that run on those physical layers. The choice of communication protocol may be based on battery life requirement (e.g. BLE, NB-IoT, or LoRa are lower power than regular cellular), bandwidth (e.g. LoRa is much lower bandwidth than LTE), range (e.g. LoRa or Sigfox are long range protocols, versus Bluetooth which is a shorter range protocol), and also whether or not the communication protocol is one way (in which case no acknowledgements are possible) or two way (and half duplex or full duplex), reliability, and/or unique protocol features (such as protocols using Remote Direct Memory Access (RDMA) for example).

Communication Through Intermediary Devices (e.g. Hubs)

In some configurations, an intermediary node, hub or personal device may be required for signals to reach an internet connected server (e.g. a LoRa device, which communicates with a LoRa hub, that acts as a LoRa to cellular bridge, by forwarding packets on to a server). These may be fixed in proximity to the devices being monitored (where proximity is defined by the range of the protocol being employed). Direct or indirect device communication to aerial vehicles (e.g. drones, acting as mobile hubs) or satellite-based systems would ensure that no gateway is required in permanent proximity of a sensor device, and data can be collected intermittently. Generally, these communication devices or relays may also be mobile (e.g. attached onto plant or machinery on the jobsite). All devices may also employ positioning technology (e.g. GPS other techniques).

### Advanced RF Techniques

Advanced RF techniques are also considered below. The advanced RF communication system is engineered to optimize data transmission between sensors embedded in/surface mounted on/directed at or in proximity of reinforced concrete and other devices or the internet (i.e. a server), and optimizing for reliability, efficiency, and power management in challenging construction environments. The system uses broadband radio frequency sensors and antennas, optimized for minimal signal attenuation and maximal reflection analysis, to enable real-time monitoring and reporting even in dense construction materials. The use of RF communications, including Bluetooth, LoRa, NB-IoT, LTE and other RF technologies, provides significant advantages in signal coupling and energy transmission. It ensures non-invasive material characterization and offers a high spatial resolution and sensing range, crucial for comprehensive material analysis.

Antenna Tuning, Impedance Matching & Amplification: Antenna tuning, and in particular, impedance matching for concrete (to reduce power loss) are implemented. Optionally, adaptive tuning elements are implemented, to modify the impedance of the antenna as the concrete is curing and hydration reaction changes the medium's electromagnetic wave impedance (e.g. electrically-tunable impedance matching). Impedance matching may be implemented using quarter wavelength plates. Adaptive Impedance Tuning may be done by using variable resistors, varactors and variable inductors or other variable property components (optionally electrically actuated) on the RF front-end. RF Amplifiers may be used to amplify the signal. Optionally, the settings on those RF amplifiers may be modified adaptively, based on whether or not the device is embedded in concrete (increasing output power based on the medium surrounding the RF elements).

Antenna Types: Several antenna types are considered. Here is a non-exhaustive list: Dipole Antennas; Monopole Antennas; Loop Antennas; Patch Antennas; Helical Antennas; Yagi-Uda Antennas; Log-Periodic Antennas; Bowtie Antennas; Slot Antennas; Vivaldi Antennas; Horn Antennas; Spiral Antennas; Ring Antennas (Circular Loop Antennas); Fractal Antennas; chip, PCB trace, or whip antennas. Antennas may be internal (mounted on the PCB-A, or fixed on the internal of a device), or may be external (connected through a coaxial connector). External antennas for embedded devices may be trailed out to or above the surface of the concrete (optionally for reuse), or closer to the surface of the concrete. Generally, wide-band or multi-band impedance antennas may be more advantageous as the impedance of concrete will vary over time. By varying the RF frontend impedance, with a wide-band antenna, maximal impedance matching can be achieved. Wave-based sensing of electromagnetic wave impedance (using other elements, or the same hardware) may be carried out to provide a feedback loop.

Antenna Arrays, Antenna Diversity & Beamforming: Antenna diversity is employed. Multiple antennas are spatially distributed. They may be oriented differently to ensure different polarization of electromagnetic waves and are used for signal generations and detection. This maximizes signal transmission and reduces the impact of multipath interference fading, increasing resilience. It has been shown by the inventors to demonstrate a significant improvement in performance of communication when in proximity of or embedded in fresh or cured concrete.

Antenna arrays may be installed on the device, to control direction and polarization of wave propagation. Phased array antennas may be employed, including for beamforming to direct RF communication towards specific locations (e.g. out of the concrete, or away from rebar). Adaptive beamforming is also implemented in some embodiments (based on feedback about success of communication, or other sensors (such as S parameter sensing).

MIMO techniques are also implemented in some embodiments. Other beamforming mechanisms may be employed (switched beam systems, adaptive array systems, digital beamforming, analog beamforming, time delay beamforming, lens based beamforming or butler matrix beamforming).

Multiple embedded devices can employ beam-forming techniques (e.g. based on phased array antennas) to communicate with each other, and with other devices on the outside of the concrete. They can also use the technique to avoid particular elements in the concrete such as the rebar.

### Automatic Transmission Power Adjustment

Based on RSSI Feedback: The system dynamically adjusts transmission power based on Received Signal Strength Indicator (RSSI) feedback from the counterpart device. This ensures optimal power usage & signal strength for reliable data transfer. Specific algorithms are also considered, that vary power output over time (to manage battery life whilst maximizing likelihood of communication through building materials such as concrete). Range extension techniques may also employ RF amplifiers, or mesh networks/daisy-chaining of communication over devices (so that signal can hop their way to a gateway).

Adaptive Rx Gain Settings: Receiver gain settings are adaptively adjusted to maintain optimal signal reception under varying environmental conditions and distances.

### Broad Spectrum Broadcasting and Management

Pseudo-Random Broadcasting: Utilizes a pseudo-random sequence for signal transmission, reducing the likelihood of signal interference and eavesdropping. Listen Before Speak Protocol: Implements a ‘listen before speak’ approach, where the device checks for channel occupancy before transmitting, minimizing the chances of collision with other signals. Quiet Channel Selection: the system can identify and select the least congested channels for data transmission, enhancing communication efficiency.

### Redundancy and Error Checking

CRC Checks: Incorporates Cyclic Redundancy Check (CRC) for error detection in transmitted data, ensuring data integrity. Frequency Hopping: Employs frequency hopping spread spectrum (FHSS) to reduce interference and improve security. The system rapidly switches frequencies during transmission, making it difficult to intercept or jam. Layered Redundancy: Multiple layers of redundancy are incorporated to ensure data transmission even in adverse conditions. Adaptive Redundancy Based on SNR: Similar to LoRa technology, the system increases redundancy (e.g., error correction coding) when the Signal-to-Noise Ratio (SNR) is low, enhancing reliability in poor signal conditions.

### Power Saving and Scheduling Techniques

Power Saving with Rendezvous Protocol: Inspired by Bluetooth Low Energy (BLE), the devices can enter a low-power sleep mode and wake up at predetermined intervals (rendezvous points) to communicate, significantly saving power. Scheduled Communication: Devices can agree on specific times (in seconds or minutes) to wake up and communicate, allowing them to remain in sleep mode in between, conserving energy.

### Other

RF Modulation Technique: Different RF modulation techniques may be used, including: Amplitude Modulation (AM), Frequency Modulation (FM), Phase Modulation (PM), Quadrature Amplitude Modulation (QAM), Frequency-Shift Keying (FSK), Phase-Shift Keying (PSK), Orthogonal Frequency-Division Multiplexing (OFDM), Chirp Spread Spectrum (CSS).

Encryption Techniques: different encryption techniques may be used, including: Advanced Encryption Standard (AES), or Elliptic Curve Cryptography (ECC).

Chirp Signal Modulation for Doppler Effect Resilience: the advanced RF communication system incorporates the use of chirp signals, which are frequency-modulated sounds where the frequency increases (‘up-chirp’) or decreases (‘down-chirp’) over time. This technique is instrumental in enhancing the resilience of the communication system caused by the Doppler effect, which can occur in dynamic construction environments. Signals are less susceptible to frequency shifts, and better detection and decoding in noisy environments such as construction sites. This is because the frequency variation inherent in chirp signals makes it easier to distinguish the intended signal from frequency shifts due to movement of the transmitter, receiver, or obstacles in the environment. In the context of embedded concrete sensors, chirp signals ensure reliable data transmission despite transmission through concrete. The chirp methodology integrates into existing RF hardware & protocols, and can be designed to be ultra-low power.

Other Wireless Communication Modes: Other ways of communicating (beyond traditional RF-based systems) are also considered. For example, communicating data through sound between a distributed network of sensor devices in a building element. This may be particularly relevant for devices deep in a pour. In the case of devices that may already have a piezo (for material property sensing), you could reuse the sensing element for communication during downtime. One could split the sweep length and have messages as well as sampling time. Likewise, the frequency spectrum could also be split up, with one part of the frequency spectrum used for messaging, and another for sampling. The use of vibration, lasers, and magnetic waves are also considered as part of this invention.

### Advanced Embedded Communication Embodiment:

In one particularly inventive embodiment, a device is designed to be embedded in concrete (and may be attached and/or activated through any of the methods described prior), to carry out one or more of the wave-based sensing or other non-wave-based sensing techniques (including maturity sensing, electromechanical sensing, electrochemical sensing, and electromagnetic wave impedance sensing). The device communicates out of the concrete through NB-IoT or 5G (or other cellular-based communication), and/or satellite communication, to communicate out of the concrete directly with cellular or satellite backhauls (with no phone, or hub required). To enable this, the various power management techniques described above may be employed (as cellular communications is typically higher power, duty cycling needs to be optimized, and various forms of energy may be harvested). The device also has a Bluetooth interface, for fallback communication with a mobile phone. The advanced RF techniques described above may also be employed. This is a step-change in concrete sensing as all embedded devices used for concrete monitoring to date, have required data collection through an intermediary smartphone.

### Sensor Selection Considerations

Virtually any material or device that has the capability to detect and/or respond to an abstract, non-tangible or physical property, is a sensor. Virtually any material or device that has the capability to transfer energy (of any form) into another system, is an actuator (in the broad sense of the term). Actuators are always transducers (they transduce energy). Sensors are, most of the time, but not always, transducers. The materials or devices with actuation, sensing or transduction capabilities are sometimes called ‘elements’ (sensing elements, actuation elements etc.).

Industrial processes in general are physical, chemical, electrical, or mechanical steps that result in the manufacturing of a product. This general rule applies to construction as well. It is essential to continuously measure, and accurately control, the status of each process to avoid unintended component changes and unstable conditions. It is also important for the success of a process to maximize the performance of underlying materials and equipment by monitoring the state of materials, production equipment and utility facilities, and performing optimal maintenance management. Finally, it is crucial to continuously monitor construction processes and resources also to increase visibility, knowledge, and understanding of construction across stakeholders, as well as to iterate on this knowledge to enable optimization of these construction processes and resources and generation of insights. That is why industrial sensors and instruments are designed for both process monitoring and asset monitoring. The devices in the logistics section of the document consider construction process and resource tracking, whilst many of the sensor devices in the hardware section, especially the wave-based sensor devices, consider construction and process monitoring, and in particular material characterization. The general concepts outlined in this section apply to either type of sensor, actuator, and/or transducer.

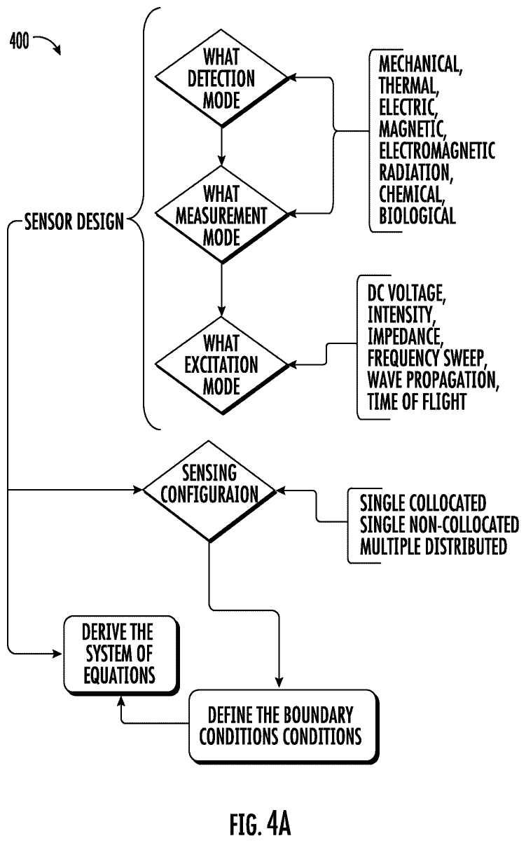

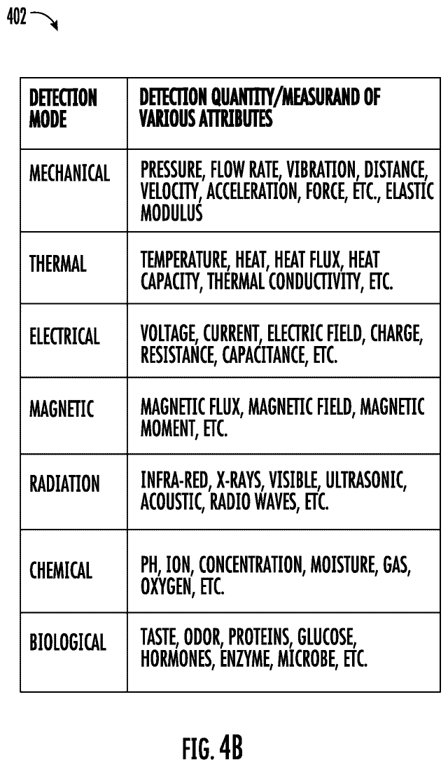

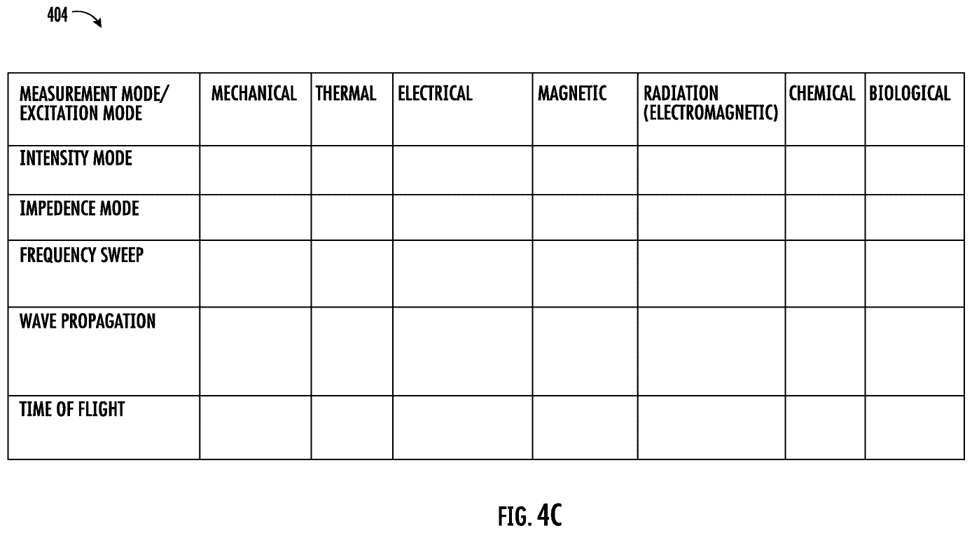

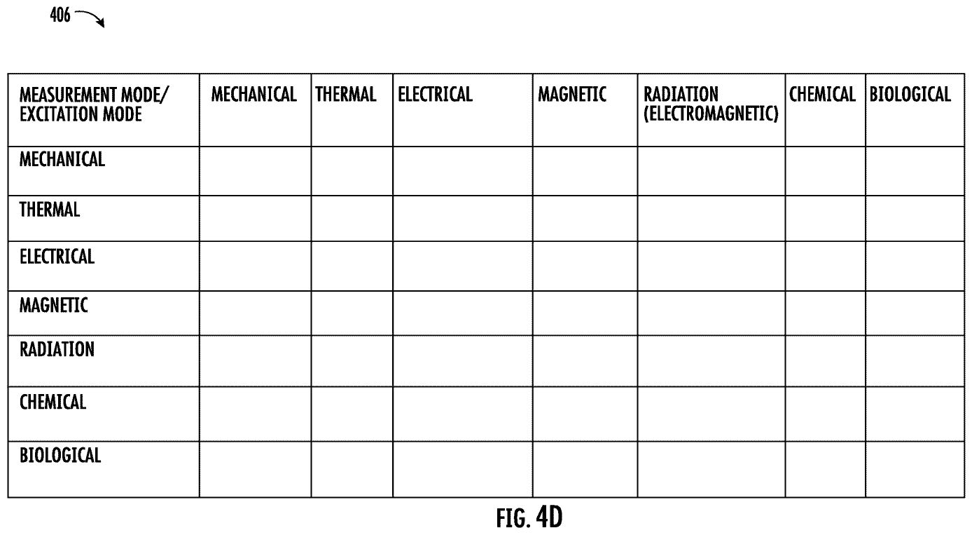

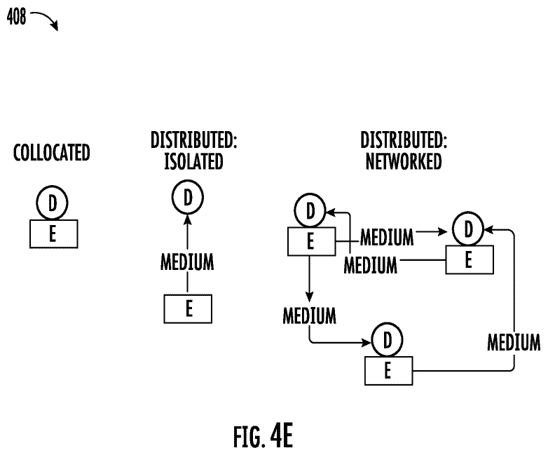

The aspects around selection or indeed design of a sensor may be categorized into four steps. The first three steps are related to sensor design: (1) the property to be detected, (2) the measurement technique and (3) the excitation mode, on which basis the main governing equations may be defined. Further to that a fourth question (4) as related to the sensing configuration from which the boundary conditions may be determined. To this end the workflow 400 in FIG. 4A, is instructive. Step 1—Detection Mode: The first question is what property of the medium does the system intend to measure?

The possible attributes of a domain that can be measured may be classified into 8 (non-exhaustive, non-limiting) categories as Mechanical, Thermal, Electric, Magnetic, Electro-magnetic, Radiation, Chemical, Biological. As shown in table 402 of FIG. 4B, there may be 8 detection modes and the typical quantities that are measured within each mode. Electro-magnetic can then be further broken down into low (ULF), medium (RF, Microwave, Terahertz) and high frequencies (IR, Visible, Ultraviolet, X-Ray & Gamma Rays). Note, these attributes fall within the material properties data classification described elsewhere (including compositional, static and contextual material properties).

Step 2—Activation Mode: The next question is how does the system activate the medium? The actuation mode may not be identical to the sensing mode. For instance, mechanical vibrations are often measured using a strain gauge, which converts changes in strain to resistivity in the gauge that then using a classical Wheatstone Bridge is cast as an electrical problem.

The activation step is the excitation mode. In order to sense properties there are many ways to excite the media. It may involve the simple application of a DC voltage as in the strain sensing example above or more likely, involve complex modes. These various excitation modes are illustrated in table 4040 in FIG. 4C. The excitation may be applied to the material under consideration, or another material directly or indirectly coupled to the material of interest.

Finally, the system may need to derive the calibration between the measured property and the property to be inferred (detected mode). For this reason typical linearity, consistency, robustness and a high signal-to-noise ratio are standard attributes of good sensors. The choice of activation mode and excitation mode may be impacted by the Material and/or System under consideration.

Step 3—Define the equations-Having identified the required property to be detected, the proposed property to be measured and the means to excite the medium, the next step is to combine the physico-chemical properties to identify the relevant system of equations. Typically there will be coupled effects where two or more properties will be coupled together. Further to this these couplings fall into two kinds: Collaborative Coupling: These work cooperatively or antagonistically and represent the detection and measurement modes discussed above, duly modified by the excitation mode. A single element may exhibit reciprocal couplings. These may further break down into two types of reciprocities: direct energy conversion reciprocity, and mutual influence reciprocity. Alternatively, a plurality of elements may be used, which individually are not reciprocally coupled, but as a system, are reciprocally coupled to form an actuator-sensor system.

Confounding Coupling: These are undesirable effects that will affect the measurement. These correspond to the Contextual Material or Device Properties that will likely impact the measured results and hence affect the calibration (e.g. the temperature of the medium), which will impact the sensor reading. These effects need to be measured/accounted for as well, which may be done using context awareness techniques.

The outcome of this section should be the basis system of equations that define the selected sensing configuration. These may be identified as primary and secondary couplings in a matrix 406, such as shown in FIG. 4D.

Step 4—Define the boundary conditions—This aspect accounts for the contextual conditions of the sensor device, in particular its physical placement, and its compositional material properties, in particular its sub-parts: the detection (D) and excitation (E) components (as shown in the illustration 408 in FIG. 4E). The system outlines three configurations: A single collocated device: where detection (by sensor) and excitation (by actuator) components are collocated on the hardware system. In this case, the medium to be sensed may typically either by hyper-local (boundary conditions at the excitation-detection interface) or involve some level of scattering or reflection off a boundary (e.g., between the measured medium and air, for example at the edge of a concrete block).

A single non-collocated device: where there is a physical gap between the detection (by sensor) and excitation (by actuation) components, taken up by the measurand. For example, in the time of flight sensing technique, a change in the medium bulk modulus will impact the time taken between the transmission and reception of an ultrasonic signal; Distributed sensing or several networked devices: where the excitation signal transmitted by one actuator may be received by one or more separate sensor devices. These may form a network of connected sensors that may further combine meta-data (e.g. clocks, or device platform metadata) to self-identify their presence and role. Note that additionally, the medium property being the object of the sensor measuring the excitation mode, and its housing (or any intermediary elements it may be bonded to), will also influence the type of boundary conditions intended to be utilized.

The table below outlines some of the types of sensors that are useful, alongside the principal properties they sense, and the general kinds of signal processing these sensors require (illustrative only, and other kinds of signal processing also applicable).

TABLE 1

| | Main | | | Cross- |
|---|---|---|---|---|
| Sensor | Property | Technique | Signal Processing | sensing |
| Electromechanical | Bulk | Pitch-catch/ | Denoising, Autoregression | Temperature, |
| guided- | modulus | Pulse-echo | for pulse detection, | resistivity, |
| wave based | (temperature | technique/Time- | Regression model for bulk | spectroscopy |
| sensor | adjusted) | of flight | modulus estimation, | |
| including | | (measures time | Classification of Phase, | |
| Piezoelectric | | between pulses)- | Cross-correlation for | |
| sensor, | | speed of sound in | perturbative mode | |
| Acoustic | | medium scales | | |
| (includes | | with root of ratio | | |
| Ultrasound) | | of bulk modulus | | |
| | | and density | | |
| Electromechanical | Density, | Resonance & | S-and T- parameter | Temperature, |
| impedance | Plasticity/ | attenuation of | measurement (N-port | resistivity, |
| based sensor | Viscosity | excitation signal. | systems), Denoising, | piezoelectric, |
| including | (temp. | Resonant | Autoregression (to | spectroscopy |
| piezoelectric | adjusted) | frequency scales | estimate dominant spectral | |
| sensors, | | with speed of | contribution), Spectral | |
| Acoustic | | sound, | decomposition - to find the | |
| (includes | | Frequency sweep | resonant frequency. | |
| Ultrasound) | | (including | Regression analysis to | |
| | | single/multi-sine, | map attenuation of | |
| | | chirp, wavelets) | amplitude to material | |
| | | | properties | |
| Strain gauge, | Viscosity | Vibrations as an | Denoise, Autoregression, | Temperature, |
| piezoelectric | | indirect measure | Spectral decomposition, | resistivity, |
| sensor. | | of turbulence in | Wavelet decomposition | spectroscopy |
| Accelerometers, | | flow regime. | | |
| magnetometer, | | | | |
| gyroscope, | | | | |
| microphone, | | | | |
| Impedance/ | Dielectric/ | Frequency | S-and T- parameter | Temperature |
| admittance, | permittivity | response function | measurement (N-port | |
| using | (adjusted for | techniques, | systems), Denoising, | |
| Electrochemical | temperature), | Resonant | Autoregression (to | |
| impedance | conductivity, | frequency | estimate dominant spectral | |
| sensors to | ionic | | contribution), Spectral | |
| characterise | mobility | | decomposition - to find the | |
| high | | | resonant frequency. Cross- | |
| frequency | | | correlation for | |
| properties of | | | perturbative techniques | |
| materials | | | | |
| Electromagnetic | Conductivity, | Frequency | S-and T- parameter | Temperature, |
| wave | dielectric | response function | measurement (N-port | geometric |
| impedance | permittivity, | techniques, | systems), Denoising, | boundaries |
| spectroscopy | density | signal attenuation | Autoregression (to | |
| | | measurement | estimate dominant spectral | |
| | | | contribution), Spectral | |
| | | | decomposition - to find the | |
| | | | resonant frequency. Cross- | |
| | | | correlation for | |
| | | | perturbative techniques | |
| Orientation | context | above capacitive | No spectral content | |
| (tilt sensors) | awareness | sensor, | expected. Standard | |
| | sensing | inclinometer, | Denoising (e.g. | |
| | | accelerometer, | oversampling for super | |
| | | magnetometer | resolution), +Regression | |
| | | and/or gyroscope | model to convert digital | |
| | | | signal into a property | |
| | | | estimate | |
| pressure | context | above capacitive | Standard | |
| | awareness | sensor, balloon- | Denoising, +Regression | |
| | sensing | sensors, | model to convert digital | |
| | | membrane | signal into a property | |
| | | sensors | estimate, time-domain | |
| humidity/RH | water | inverse | No spectral content | |
| or moisture | content | relationship | expected. Standard | |
| | | between | Denoising, +Regression | |
| | | resistivity and | model to convert digital | |
| | | RH (Resistive | signal into a property | |
| | | humidity sensors | estimate | |
| | | usually consist of | | |
| | | noble metal | | |
| | | electrodes either | | |
| | | deposited on a | | |
| | | substrate by | | |
| | | photoresist | | |
| | | techniques or | | |
| | | wire-wound | | |
| | | electrodes on a | | |
| | | plastic or glass | | |
| | | cylinder.) | | |
| pH | acidic/basic | combination | No spectral content | |
| | | sensors (two | expected. Standard | |
| | | electrodes) A | Denoising, +Regression | |
| | | combination | model to convert digital | |
| | | sensor uses two | signal into a property | |
| | | electrodes, a | estimate | |
| | | reference and a | | |
| | | sensing, to | | |
| | | measure the | | |
| | | relative | | |
| | | difference in | | |
| | | signal between | | |
| | | the two. Since pH | | |
| | | is a measure of | | |
| | | the ions in water, | | |
| | | these sensors | | |
| | | measure a small | | |
| | | electrical | | |
| | | difference | | |
| | | between the two | | |
| | | electrodes. The | | |
| | | positive or | | |
| | | negative strength | | |
| | | of this signal is | | |
| | | interpreted by a | | |
| | | circuit which | | |
| | | then spits out a | | |
| | | pH reading on | | |
| | | some sort of | | |
| | | digital screen. | | |
| Temperature, | Temperature | Thermocouple, | No spectral content | |
| thermal | | digital | expected. Standard | |
| differentials | | thermistor, | Denoising, +Regression | |
| and thermal | | digital | model to convert digital | |
| profiles, | | temperature | signal into a property | |
| thermal | | sensor etc. | estimate | |
| distribution | | | Features of temperature | |
| sensing | | | curve to include height of | |
| | | | exothermic peak, time to | |
| | | | peak, shape of | |
| | | | temperature rise curve | |
| Intensity | radiation | Further described | Further described | Temperature, |
| Spectroscopy | intensity | further down in | further down in | acoustic |
| (LIBS, NMR, | or an | document | document | sensors, |
| reflectance | atomic | | | piezoelectric |
| etc.) | response | | | |
| | to applied | | | |
| | radiation | | | |

Other sensors may include: Acoustic Emission Sensors; Capacitive Sensors; Chloride Ion Sensors; Crack Meters; Digital Image Correlation Systems; Displacement Sensors; Electrical Resistance Sensors; Electromagnetic Sensors; Fiber Bragg Grating Sensors; Fiber Optic Sensors; Ground Penetrating Radar (GPR); Infrared Thermography Sensors; Laser Doppler Vibrometers; Laser Scanning Systems; Magnetic Field Sensors; Moisture Sensors; Nuclear Magnetic Resonance (NMR) Sensors; Radar Sensors; Resistivity Sensors; Wireless Sensor Networks; X-Ray Diffraction Sensors; Linear Variable Differential Transformers (LVDT); Hall Effect Sensors; Gas Sensors; Eddy Current Sensors; Corrosion Potential Sensors; Bimetallic Sensors; Air Void Sensors; 3D Laser Scanners; Optical Fiber DTS (Distributed Temperature Sensing) Systems; GPS (Global Positioning System) Based Systems; Carbon Dioxide Sensors; Alkali-Silica Reaction (ASR) Sensors.

The table below maps, without limitation, a subset of various sensor types to the concrete lifecycle. This is non-exhaustive, and generally, all the devices, sensors or actuators may be used at any stage of the concrete lifecycle.

TABLE 2

| | Relevant Sensors by concrete lifecycle |
|---|---|
| Raw | All the devices and sensors mentioned in this document are usable in dry mixture |
| Materials | environments, for raw material characterization. This includes both dry and wet |
| & Cement | environments, including quarries and cement kilns. Specific Examples include: |
| Production | Temperature - Exothermic heat output monitoring (e.g. of the cement kiln to assess |
| Stage | carbon efficiency); |
| | Electrochemical Impedance, Conductivity & Resistivity; |
| | Electromechanical Impedance (in DC and AC modes); |
| | Optical to assess particulate gradings and fineness; |
| | Intensity Spectroscopy for Compositional Analysis and Reactivity Determination; |
| | Chemical Reactivity Sensing (e.g. chemical sensing); |
| | Passive RFID (or other tracing technology, including chemical) for provenance |
| | tracking. |
| Precast | Devices intended for embedding in concrete pours on jobsites may be repurposed |
| Factory | for precast factories (where the concrete is poured in factory environments). |
| | Specific examples include: |
| | Positioning Sensor Devices (e.g. embedded in precast unit or formwork); |
| | Temperature Sensor Devices (e.g. for oven temperature sensing, or thermal |
| | differentials of large elements); |
| | Maturity Sensor Devices (for optimisation of lifting times); |
| | Impedance-based Concrete Strength Estimation Sensor Devices (e.g. based on |
| | electrochemical impedance, electromechanical impedance, or electromagnetic |
| | wave impedance). |
| Batching | Devices may be integrated into the mixer, or batching equipment, or silo's at the |
| Plant | batching plant (e.g. to detect inhomogeneity or storage conditions). Specific |
| | examples include: |
| | Cameras inside mixers/imagery sensing (visible or other spectrum, including |
| | hyperspectral imaging); |
| | Temperature (e.g. in the mixer); |
| | Moisture/RH/water content (e.g. for aggregate in silo's in particular); |
| | Calorimetry-based measurements; |
| | Machine data from batching equipment (including e.g. batching records, tolerances |
| | etc.). |
| Truck | The combination of techniques and devices may be designed to be used within a |
| | concrete truck (e.g. through attachment to the inside of the drum). This integration |
| | allows for the monitoring of concrete mix during transit, providing valuable data |
| | on the material's workability and consistency. The proposed system integrates a |
| | variety of advanced sensors into concrete trucks, enhancing the monitoring and |
| | quality control of concrete mixtures during transit. These sensors are designed to |
| | assess critical properties of concrete, such as workability, wetness, and overall |
| | composition. They are attached using similar mechanisms to those contemplated |
| | in the attachment mechanisms, adapted to the curvature of the drum itself, |
| | including magnetic attachment, suction cups, straps and adhesives. Examples |
| | include: |
| | Electrochemical & Magnetochemical, Electromagnetic Wave & Terahertz |
| | Sensor Devices: integrated into the drum of the concrete truck. Using |
| | configurations like a single electrode/plate, two electrodes/plates, and |
| | interdigitated electrodes, coil configurations and antenna configurations, they are |
| | strategically placed to maintain consistent contact with the concrete mix. When |
| | more than one sensor is used the metal sheet of the drum can be used as shared |
| | electrical ground. They provide insights into the mix's ionic content and moisture |
| | level, and workability. Since varying moisture levels is the main reason concrete |
| | varies in strength, accurate moisture measurements are used to achieve the correct |
| | properties. Doing this on the wagon which is en route to site allows detection of |
| | added water which often leads to underperformance of concrete. |
| | Torque sensor Devices: Attached to the sides of the aforementioned sensor |
| | devices, a combination of flexible flaps and paddles are used to acquire further |
| | characterization of workability. Interdigitated sensors working as strain gauges on |
| | flexible flaps detect the torsion experienced by the flexible material and therefore |
| | can be used to infer the pressure applied on the flap as a proxy measure of viscosity. |
| | In addition, non-linear regimes experienced when the turning drum forces the |
| | sensor into and out of the concrete helps to further model the viscosity of the |
| | concrete mix under test. |
| | Accelerometer, gyroscope & Inertial Sensor Devices: In order to further evaluate |
| | the impact of the concrete mix in the truck a combination of sensors can be installed |
| | in a way so as to allow for the concrete slushing to move the sensor itself. In one |
| | embodiment, a three point anchoring with chains or straps to the inner wall of the |
| | drum, creating a star of chains allows for sensor on the dangling chains to detect |
| | the difference in acceleration signals as the drum turns when it is empty, or carries |
| | more or less concrete of varying workability and viscosity. In addition this would |
| | indirectly be able to tell in which direction the drum was turning in order to |
| | ascertain when the concrete is being pumped. By carefully analyzing the |
| | acceleration and gyroscope signals the system can calculate the material properties |
| | of the concrete mix, including workability. The inertial sensor's angular velocity |
| | and acceleration peaks would be analyzed to estimate viscosity or workability. As |
| | an example a sensor in an empty drum would suffer from many impacts and |
| | therefore high acceleration peaks however if it was within a very viscous material |
| | it would barely move and therefore its accelerometer would show low peaks since |
| | the medium viscosity acts like a Low Pass Filter. |
| | Temperature Monitoring: Incorporation of temperature sensors to monitor the |
| | temperature of the concrete mix, which is critical for proper curing and strength |
| | development. These sensors are distributed throughout the drum's interior, |
| | providing a comprehensive temperature profile of the entire mix. They track |
| | temperature fluctuations, and are vital for predicting curing strength. Multi-probe |
| | thermal tails (described earlier) may be disposed in a ring-like manner within the |
| | drum, using various attachment methods already described (e.g adhesive or |
| | magnetic mounting to the side of the drum). |
| | Viscosity - stepper motor to measure viscosity indirectly by monitoring the |
| | required current to make angular movements. E.g. The current required to move a |
| | paddle 30 degrees in free space will be lower than in water and itself lower than in |
| | curing concrete, the terminal current will be infinite as concrete that has reached |
| | maturity will not allow the stepper motor to move. Torque sensors. |
| | They may be used to deduce the concrete's viscosity and flow characteristics (to |
| | estimate slump). Changes in electrochemical impedance and magnetic properties |
| | are correlated to the concrete's workability. RF/microwave/Terahertz sensors play |
| | a crucial role in determining the moisture content of the mix, which is critical for |
| | assessing the curing potential and final strength of the concrete. Electrochemical |
| | sensors complement this by providing data on the ionic concentration, which is |
| | closely linked to the water-cement ratio. Real-time insights are provided back to |
| | the driver (e.g. through a mobile app) or remote monitoring stations, allowing for |
| | immediate adjustments to the mix if necessary (optionally automatic). Protective |
| | coatings, such as epoxy resins, safeguard the sensors against chemical degradation |
| | and physical abrasion of the drum. Optionally, machine learning models are used |
| | to characterize the sensor signatures (e.g. with inertial sensors, similar methods to |
| | those employed in the logistics invention may be employed). These sensors may |
| | also be used to estimate the embodied carbon associated with producing the |
| | building (e.g. where truck sensors provide an estimate of the energy used by the |
| | truck, and also the distance traveled to estimate carbon intensity involved in |
| | delivering the concrete). |
| Pump | The pump may also be instrumented with sensor devices such as: |
| | Viscosity Sensor Devices - based on turbulence detection (i.e. the Reynolds |
| | number) will change as the concrete thickens, a thin concrete will have more |
| | turbulence than a thick one meaning that when turbulence is no longer detected or |
| | lower we may be close to reaching the limits of pumpability. Turbulent flow could |
| | be detected by either sound or vibrations on a strain gauge, accelerometers, |
| | magnetometer, gyroscope, microphone or surface piezoelectric sensor. |
| | Rate of pumping - which may be obtainable from existing electronics or machine |
| | data made available by the pump. |
| Pour | The key material properties of interest in the pour are the compressive strength |
| | (and its evolution over time), the temperature and temperature differentials and |
| | profiles across the pour, the shrinkage (after the concrete has been poured, at one |
| | or more locations within the pour), and the compositional properties or formulation |
| | of the concrete used in the pour. Contextual condition data of interest may include |
| | the pour geometry, the depth of installation of a sensor etc. These are gathered |
| | using sensors that are mounted on, embedded in, or directed at the concrete (or |
| | somehow coupled to the concrete element). Other parameters of interest may |
| | include the rate of pour and/or pour pressure during pouring, and deformations such |
| | as strain, stress, tilt of the structure (which may induce differential shortening). |
| | Finally, crack monitoring may also be of interest. |
| | For material property analysis & identification methods (including |
| | fingerprinting & mix optimization method described herein): |
| | E&M Spectroscopy (including impedance-based such as electrochemical |
| | impedance spectroscopy, electromagnetic wave impedance spectroscopy, or |
| | optical spectroscopy techniques, or any other frequency response analysis); |
| | Mechanical Stress (incl. static or dynamic deformations, such as |
| | infrasound/sonics/ultrasonics and other mechanical oscillations or waves, and |
| | measurement of electromechanical impedance, using for example Piezo's or |
| | CMUT transducers). In some cases, resonance cavities are able to implement |
| | mechanical filters or amplifiers. Reducing the time error caused by sampling period |
| | length by sweeping the sound phase difference between source and sampling |
| | device. All kinds of waves are considered (transverse waves, longitudinal waves, |
| | and surface waves); |
| | Size of the element adapted to the size of the aggregate; |
| | Maturity and Temperature, including through the use of single or multi-probe |
| | thermal tails attached into an embedded device, or a surface mounted device. |
| | Enhanced Maturity Method; |
| | Humidity/RH or moisture; |
| | pH, standard pH sensor. |
| | For pour context awareness: |
| | Embedded: Pressure, gyro, accelerometer & inertial sensors; |
| | External: LIDAR, camera on phone. Multiple sensors communicating to each |
| | other and using time of flight or other methods; |
| | For construction status: |
| | Detecting ‘striking’ using acoustic wave sensing (e.g. Piezo) or E&M waves; |
| | Detection of presence of concrete (vs air), e.g. through a pressure sensor or a load |
| | cell, or a resistivity sensor |

### List of Other Relevant Sensors

List below, again non-exhaustive: Corrosion sensor on rebar to assess durability; The use of multiple sensors to assess homogeneity of properties across a volume of concrete; The use of adaptive lensing/beamforming techniques in the spectroscopy can be mirrored for other sensors, to generate multiple measurements by changing the focal length, equally the angular orientation of the probe. Analysis of variance between measurements from multiple samples is a good test of homogeneity (if only in the vicinity where samples are taken). Multiple sensors in multiple locations might be needed. An IR camera can provide surface/near surface based estimation of superficial homogeneity;

Key parameters relating to strength development of concrete to be measured include: Proportioning of raw materials in line with the intended mix proportions; quality and consistency of the raw materials; quality of mixing; quality of compaction; Therefore any sensors which can be used to measure these properties would be useful for fingerprinting.

Sensor Systems include: Temperature (temperature differentials in mass concrete; to calculate maturity and strength of concrete in-situ); Retrospective non-destructive inspection of concrete, including: Acoustic Emission Testing (AE), Ground Penetrating Radar (GPR); Electrochemical Impedance Spectroscopy—to monitor long term conductive stability of impedance resonance curves; Electromagnetic impedance—to monitor long term dielectric stability rebar in the concrete; Electromechanical impedance—to monitor the longer term aging of the pour; fiber optic systems are used to measure strain within concrete elements such as piles, or down the columns & cores of tall buildings (Bragg gratings etc.).

Existing Machinery & relevant machine data may also be used: Batch records (exact quantities measured during batching); the reason this may differ from the mix design itself is that the mix design specifies the target proportions/masses of each material. In practice, since aggregates are stored in open air and absorb variable quantities of moisture, the moisture present in these aggregates may be measured/estimated and compensated for. This means that the batch records may show that different quantities of raw materials are added each time, however with the objective of achieving the same overall proportioning.

### Data Cleaning and Management

In general, raw data must first be cleaned and managed before it can be processed by models. Cleaning data can involve:
Removing errors: The removal of erroneous, irregular or irrelevant data,
Data Conversion: The conversion of raw values into meaningful formats (e.g. from one measurement unit to another—such as from Fahrenheit to Celsius),
Data Pre-Processing and Feature Engineering: The enhancement of the data for the purposes of improving the performance of a machine learning model (e.g. increasing the contrast or color grading of an image, so as to increase the accuracy of a computer vision model),
Inference/Generation over Missing Data: Filling in missing data points using probabilistic inference, or through the use of generative models.

Further non-exhaustive examples may include:
Data Cleaning; Duplicate Detection and Removal; Inconsistent-Data Handling; Missing-Data Imputation; Outlier Detection and Handling; Data Standardization; Data Normalization; Data Validation; Data Transformation; Error Correction; Data Parsing; Data Formatting; Data Quality Assessment; Data Profiling; Data Dictionary Management; Name Matching and Resolution; Record Linkage; Data Scrubbing; Data Anonymization; Data Masking; Data De-identification; Data Encryption; Metadata Management; Version Control; Data Archiving; Data Purging; Data Backup; Data Recovery; Data Migration; Data Integration; Data Aggregation; Data Warehousing; Data Cataloging; Data Lineage Tracking; Data Quality Monitoring; Data Quality Analysis; Data Privacy Compliance; Data Security Measures; Data Access Controls; Data Ownership Assignments; Data Lifecycle Management; Data Synchronization; Data Loading and Unloading: Data Compression; Data Indexing; Data Partitioning; Data Replication; Data Deduplication; Data Masking; Data Shuffling; Data Sampling; Data Subset Selection; Data Resampling; Data Shaping; Data Augmentation; Data Labeling; Data Storage Optimization; Data Stream Processing.

### Signal Processing

Once the data has been cleaned and pre-processed, a variety of signal-processing techniques are used. Some non-exhaustive examples of these are:

Signal noise analysis; Smoothing and filtering; Auto-regression analysis; Auto-correlation analysis; Probabilistic analysis; Spectral decomposition.

### Multivariate Analyses and Machine Learning Models

A variety of multivariate models for the purposes of processing sensor data are used. These are typically categorized as either multi-dimensional embeddings or machine learning models. Some non-exhaustive examples of these are:

Physical/chemical models; Tree-based methods: Decision trees; Bagging trees; Random forests; Gradient boosted trees; Bayesian probability theory; Artificial Neural Networks: Convolutional networks; Recurrent neural networks; Transformers; Generative Adversarial Networks; Diffusion Systems; Multi-Modal Networks; Clustering Algorithms: K-means clustering; Hierarchical clustering; Density based spatial clustering; Spectral clustering; Affinity propagation; Gaussian mixture models; Support Vector Machines (SVM); Embedding/Dimensionality reduction methods; Principal component analysis (PCA); Independent component analysis (ICA); Multi-dimensional compression methods; Bayesian networks; Causal graphs; Ensemble Models.

Further Non-Exhaustive Examples May Include:

Missing Data Imputation; Outlier Detection and Handling; Data Transformation; Standardization; Normalization; Factor Analysis; Canonical Correlation Analysis (CCA); Multidimensional Scaling (MDS); Discriminant Analysis; Regression Analysis; MANOVA (Multivariate Analysis of Variance); MANCOVA (Multivariate Analysis of Covariance); Structural Equation Modeling (SEM); Path Analysis; Correspondence Analysis; Redundancy Analysis (RDA); Canonical Correspondence Analysis (CCA); Partial Least Squares (PLS); Procrustes Analysis; Ridge Regression; LASSO Regression; Bootstrap Methods; Jackknife Resampling; Leave-One-Out Cross-Validation (LOOCV); K-Fold Cross-Validation; Variable Selection Techniques; Feature Engineering; Time Series Analysis; Data Fusion; Ensemble Methods; Monte Carlo Simulation; Permutation Testing; Power Analysis; Markov Chain Monte Carlo (MCMC) Methods; Non-negative Matrix Factorization (NMF); Canonical Correlation Analysis (CCA); Independent Component Analysis (ICA); Bayesian Structural Time Series; Self-Organizing Maps (SOM); Quantile Regression; Copula Models; Data Smoothing Techniques; Functional Data Analysis; Robust Regression; Multilevel Modeling; Latent Class Analysis; Longitudinal Data Analysis; Survival Analysis: Fuzzy Clustering; Dempster-Shafer Theory; Symbolic Data Analysis; Kohonen Maps; Bootstrap Aggregating (Bagging); AdaBoost; Radial Basis Function Networks; Deep Belief Networks; Reinforcement Learning; Evolutionary Algorithms; Fuzzy Logic Systems; Gaussian Mixture Models; Causal Inference Methods; Multiple Correspondence Analysis (MCA); Response Surface Methodology; Multivariate Adaptive Regression Splines (MARS); Transfer Function Models; Grey System Theory.

### Wave-Based Sensing

### Introduction

The wave-based sensing aspect of this invention pertains to the generation, use of and sensing of waves, excitations or oscillations (such as electromagnetic waves and/or mechanical stresses) for the purposes of measuring and characterizing material properties. The material properties in question constitute any of a material's static, contextual and/or compositional properties, and also encompass inferences on the contextual conditions of the material or the device in question (where those conditions may relate to the environment in which the material or sensor device is placed, for example) and in general may be used to measure, characterize and/or otherwise generate any property and/or data type listed in any section herein.

The invention describes the use of mechanical stresses, electromagnetic waves, excitations and/or oscillations, generated and measured by various configurations of devices embodiments, wherein those devices may generally be distributed throughout, attached to the surface of, or externally placed with respect to a given material element.

By modifying various aspects of those generated waves, excitations and/or oscillations (either in part or in conjunction) devices, computational models, computer-implemented methods, and systems are able to infer the properties of a material in real-time; even for the case in which a material (such as a volume of curing concrete) has its properties change continuously during the measurement process. To this end, devices and systems generate or modify transmitted, resonant or passively received excitations, oscillations or waves by modulating: Wave amplitude or power; Wave frequency; the temporal phase of a wave; The polarization of a wave (wherein the wave is polarizable); The position from which the wave is emitted, or at which the wave is measured.

In general, these modulations may be varied actively over the course of the measurement process, and can involve operational modes that include (but are not limited to) the following: Amplitude/Power Modes: Continuous amplitude/power: Periodic amplitude/power; Pulsed amplitude/power (wherein the wave is generated over a discrete time window); Random adjustments to amplitude/power (relating to all of the above modes). Frequency Modes: Single frequency emission; Harmonic frequency emissions (i.e. multiple, simultaneous single-frequency emissions); Frequency sweeps (i.e., time-varying frequency change of single-frequency emission); Broadband emission (i.e. wave emission over a range of simultaneous frequencies); Random frequency emission (relating to all of the above modes). Temporal-Phase Modes: Pulsed timing; Fixed time-delays; Sweeped time-delays; Random time-delays (relating to all of the above modes). Polarization Modes: Circular polarization;

Uni-axial polarization; Random polarization. Position Modes: Fixed wave sources/wave receivers; Moving wave sources/wave receivers; Mixed combinations of moving and fixed wave sources/wave receivers; Wave sources/wave receivers internal to a material; Wave sources/wave receivers external to a material; Mixed combinations of internal and external wave sources/wave receivers; Any of the above in any combination.

Various inference techniques are discussed throughout this section, wherein the above-mentioned modal operations of various wave-based emission sources and receivers are used to calculate certain properties of the materials in question. Some of these techniques involve the use of wave-based interferometry, or of wave-based pulsed time-of-flight measurements, or of power-based measures (to name a non-exhaustive set). Many innovations relating to wave-based characterization of materials are disclosed, some of which involve the innovative use of scattering parameter estimation of multi-port signal flow networks as a means to represent real-world contextual material properties, and others involve innovative device designs, wherein the inventors describe the application of various wave-based analysis techniques at particularly novel sizes and energy scales for building materials related purposes, and/or utilize combinations of wave-based modes that are particularly novel in the context of material characterization.

Wave-based material characterization techniques cover both electromagnetic and mechanical waves as a means to probe underlying material properties. In each of these embodiments, systems operate over a broad range of amplitudes and frequencies and utilize all of the above-mentioned modal modulation methods. A notable example of a device innovation discussed in this document is the use of a novel on-chip, Vector Network Analyzer (VNA) device that is able to characterize material properties using either mechanical waves (e.g. via piezo-electric or CMUT transducers) or electromagnetic waves (via on-chip antennas or photonic devices), and which is embeddable within the material at small scales. Another notable example of an innovative device configuration is the use of high-power, high-frequency electromagnetic radiation in order to vaporize a localized volume of concrete, so as to measure its chemical composition directly via the use of a light-based spectroscopy technique on the resulting plasma, and to therefore provide a mix fingerprinting or mix optimization insight with respect to that building material.

Another notable example of an innovative modal operation is one in which the motion of wave sources and/or wave receivers from within, or external, to a given material are utilized, in order to create a 3D representation of its internal physico-chemical constituents or mechanical properties, or of a 3D distribution of some set of contextual conditions (such as the spatial distribution of temperature, force-loading, mechanical expansions or shrinkage). This technique is described as a form of material tomography, which is used in the broadest sense to measure a measurable material property as a function of spatial position within a material element.

In what follows, the formalism and physical principles underpinning wave-based characterization of materials is initially described. The principles that are used to represent a given device configuration and material by a system of physically relevant equations is detailed, describing the use of impedance, admittance representations, as well as scattering parameter representations. The manner in which the inventions are able to automatically solve for these quantities, for the purposes of measuring and tracking material properties, and for providing insights with respect those materials is set out in detail (for example, in the process of fingerprinting a concrete mix, or of recommending a concrete mix to meet a target set of static or contextual material conditions). We then move on to describe the details of certain wave-based devices, their constituent components and their configurations, along with the precise manner in which they are operated for the purposes of automated material analysis (as described above).

### Formalism & General Techniques

### Basic Formulation

The intent of this section is to formulate the fundamental scientific principles that underpin the sensing modalities discussed in the document, and in particular of wave-based sensors. The basic mathematical formulation of an oscillator is discussed (a building block of wave-based sensing), introducing concepts in mechanics and electrical circuits. The concepts of resonance and dissipation are also introduced (which are used across a number of wave-based sensor embodiments). We then examine the broad classifications in the realm of classical electromagnetism, as well as classical mechanics of materials. The effects of macroscopic media and the fundamental boundary conditions are probed further, as a precursor to the requirements associated with the design and configurations of sensors and actuators and the field couplings they employ. Guided wave techniques are exploited as well and the essential concepts around waveguides and resonators are outlined. Impedance is defined for a number of domains, and a new, enhanced impedance spectroscopy method is outlined (which goes beyond more traditional electrochemical impedance spectroscopy), as a key method for material characterization used by wave-based sensors. We note how the mathematics behind these concepts often transcend the physical aspects, thus an understanding of the mathematical structure and the essential physics is a key motivation for this section. These concepts are then employed in the design of novel wave-based sensors which are able to probe materials such as concrete.

### Oscillations: General Concepts

The harmonic oscillator is a fundamental system in physics, and a key building block of wave-based sensing. Albeit simple and linear the system displays various behaviors that are observed in more complex systems, including oscillations, resonance, and damping responses to excitations (such as the ones generated by wave-based sensors) in materials. These idealizations are also convenient to reduce to zeroth order system and can be used to cast fairly complex systems into simple idealizations.

Mechanical oscillators: An example of a mechanical oscillator is indicated by the spring-mass-dashpot system in FIG. 5A. The equation of motion for a mechanical oscillator reduces is:

$${x}^{″} + κ / {mx}^{′} + ( k / m ) x = f / m \qquad ( 1.1 )$$

Motion is confined to one direction x, the inertia of the system is represented by mass m, the spring constant k and the damping coefficient κ. Any external excitation force applied to the system is represented as ƒ. This excitation may be an impulse at one point in time or a continuous excitation (which may be periodic in nature). This force is analogous to the excitation driven by actuators in mechanical wave-based sensing devices.

Electrical oscillators: An example of an electrical oscillator is indicated by a RLC circuit in FIG. 5B. Its equation of motion is:

$${q}^{″} + r / {lq}^{′} + c / lq = v / l , \qquad ( 1.2 )$$

where q is the charge propagating in the circuit, noting that current i=dq/dt. Where l is the inductance (which is analogous to the inertia in a mechanical system), resistance r (which is analogous to damping in the mechanical system), and capacitance c (analogous to the elastic spring constant in a mechanical system) that stores energy in the circuit. An external voltage v (analogous to the force in the mechanical system, also referred to as the electromotive force) may be applied to the system. This excitation may be as an impulse applied at a singular point in time or as a continuous voltage. When exciting wave-based sensors with electronics, the input excitation is typically a time-varying voltage.

Oscillator behavior: Resonance and dissipation. Comparing the mechanical and electrical oscillator ODEs in (1.1) and (1.2), the essential structure of the harmonic oscillator can we written in terms of an arbitrary variable y, as

$${y}^{″} + β {y}^{′} + {ω}_{0}^{2} y = \vec{f} exp ( ιω t ) . \qquad ( 1.3 )$$

where \vec{ƒ} is the excitation amplitude, ω is the angular frequency (or angular velocity) of the excitation. The β term describes the dissipation which will lead to a damping of the oscillator and ω₀ refers to the resonant angular frequency of the system. In the electrical and mechanical oscillator examples above these respectively correspond to:

$$β = \frac{r}{l} = \frac{κ}{m} , \qquad ( 1.4 )$$

$${ω}_{0} = \frac{1}{\sqrt{lc}} = \sqrt{k / m} \qquad ( 1.5 )$$

The Q-value measures the energy dissipation of the system (higher Q-values correspond to less dissipation, narrower resonances, and higher amplitude response to excitation at the resonant condition).

$$Q = \frac{{ω}_{0}}{β} \qquad ( 1.6 )$$

The solution to the ODE can be used to derive an expression for the amplitude and phase of the response of the oscillator, given by and shown in FIGS. 5C-5D:

$${y}_{0} = \underline{f} / \sqrt{{( {ω}_{0}^{2} - {ω}^{2} )}^{2} + {( ω β )}^{2}} , \qquad ( 1.8 )$$

$$ϕ = arctan ( ωβ / ( {ω}_{0}^{2} - {ω}^{2} ) ) . \qquad ( 1.9 )$$

This is akin to measuring impedance response function using wave-based sensors (where, as a matter of fact, an equivalent circuit can be determined for the system made up by the wave-based sensor and building material).

### Resonances: Physical Meaning & Building Blocks

Physically, resonances may occur in systems for different reasons. In the context of wave-based sensing, we are principally interested in oscillatory resonances and wave-induced resonances. The former include those caused by LCR circuits in electronics, by material properties and geometry in mechanical systems such as vibrational modes, and other oscillatory resonances. The latter are caused by constructive and destructive superposition of waves (e.g. due to reflections, transmission of acoustic, elastic, electromagnetic or other waves). That is why in some embodiments, geometrical features and boundary conditions of wave-based sensors are designed so as to create different resonance modes, which can then more easily be measured by devices and systems.

Wave-based sensors will measure both oscillatory and wave-based resonances, and models are trained to distinguish between them, and their physical meaning, as well as to relate them back to characteristics of the material of interest. A number of building blocks are used across wave-based sensors to create, enhance or shift resonances of embedded oscillators, or generally manipulate oscillations and/or wave-based excitations which can then be used to determine characteristics of the material under consideration. These are generally referred to as ‘frames’, which may be disposed as part of, in, around or in proximity of wave based sensors, actuators or device housings. The sensors and/or actuators may be embedded within frames, disposed within their inner volumes, or in proximity to them and so on. They may be physically bonded to frames or otherwise coupled. Frames themselves may be made of various intrinsic or characteristic impedances (of any kind defined herein). Frame impedances may be designed to be lower than those of the host material of interest, or higher, or to be adaptively controlled to change the boundary of the system. A plurality of frames may be employed, together or separately, in conjunction with one or a plurality of wave based sensor devices (or any of their constituent parts).

Frames include, without limitation: Waveguides; Cavities; Reflectors, Concentrators, Prisms, Beamformers, Diffractors, Refractors and similar wave-directing, propagators and wave-shaping devices; Passive or insulating elements of various geometries, that may be bonded (physically or otherwise) to the sensors and/or actuators (directly or indirectly), optionally such elements with variable impedance across them, e.g. through various materials; Active or conductive elements of various geometries, that may be bonded (physically or otherwise) to the sensor and/or actuators (directly or indirectly); Bonding layers and/or coatings of different kinds; They may be made, in part, by elastic or stiff materials, capacitors or dielectrics, inductors or tunable masses, and other analogues in different domains (e.g. in the magnetic impedance, or optical impedance domain, and so on, or related to the coupling employed).

In the broadest sense, these frames may act as E&M or mechanical wave manipulation devices-directing, guiding and modifying waveforms to meet particular requirements which may lead to resonances. They may also act as mechanical (or other) resonance manipulators (oscillation resonances). Alternatively, the geometry of the sensor and/or actuator and/or transducer itself may be customized, to generate one or more particular resonance types. These techniques are a key embodiment for material characterization, in particular to understand the behavior of cementitious materials such as concrete.

### Electromagnetism

### Fundamental Equations for Electromagnetic Fields in a Medium

The fundamental equations governing electromagnetic phenomena are given by Maxwell's equations, where electric and magnetic field strength E and B are written in terms of the electric displacement D and magnetic intensity H that are related to the electric field and magnetic flux density by the constitutive relations:

$$D = ϵ E , B = μ H , \qquad ( 1.8 )$$

The electric permittivity e and magnetic permeability u depend on the medium within which the fields exist. These values in vacuum are fundamental physical constants related as μ₀=4π10⁻⁷H/m, ∈₀=1/μ₀c² where c is the speed of light in vacuum. The permittivity and permeability of a material characterize the response of that material to electric and magnetic fields. In simplified models, they are often regarded as constants for a given material; however, in reality the permittivity and permeability have a complicated dependence on the fields that are present as well as the evolving state of the medium such as concrete whilst it is curing. These parameters and their frequency-dependence are key measures of interest for some wave-based sensors.

It is worth noting that electromagnetic fields can exist in regions of space where there are no sources. They carry energy, momentum and angular momentum and hence have an existence completely independent of charge and current. Furthermore, Maxwell's equations are linear in fields and excitation for systems containing materials with constant permittivity and permeability (i.e., permittivity and permeability that are independent of the fields present). This is an aspect that can be exploited especially in distinguishing concrete (linear dielectric) from reinforced concrete where the presence of rebar will introduce variable permittivity and hence can be considered as a non-linear material. Generally, wave-based sensors are used to excite, measure and/or characterize the behavior of these electric and magnetic fields in materials of interest.

Maxwell's equations are tractable for well-defined sources/excitations. However for macroscopic aggregates of matter the system of equations is complex and (almost always) needs to involve some kind of averaging. The relevant field conditions are the macroscopically averaged values over a volume significantly larger than the point charge/current sources. Maxwell's equations for macroscopic media can be cast in terms of averaged quantities in E, B where the D, H are defined in terms of components of electric and magnetic dipoles. The concept of electric polarization is pertinent to several applications and especially when considering propagation of electric fields due to distributed charges or through a medium. We thus define the electric polarization P in a medium as a local induced dipole moment per unit volume, P(x)=Σᵢ Nᵢ<pᵢ> where pᵢ is the dipole moment of the i'th type of molecule in the medium, averaged over a small volume centered on x, indicated by operator Nᵢ. The macroscopic media may be treated as a material in general that contains different molecules, each molecule having zero net charge. Further to this the electric displacement and electric field are represented in this media as: With a similar analogy we define the average macroscopic magnetization or magnetic moment density as, M(x)=Σᵢ Nᵢ<mᵢ>, where mᵢ is the molecular moment of the i'th type of molecule in the medium, averaged over a small volume centred on x. The macroscopic Maxwell equations are a set of eight equations involving four field E, B, D, H. For a complete solution the constitutive relations need to be defined:

$$D = D [ F , B ] , H = H [ E , B ] ,$$

indicating non-simple dependence including past history (hysteresis) and non-linearity. Thus for most non-ferromagnetic materials (or non-magnetically coupled materials such as piezoelectrics) the fields are either weak enough or not affected by coupled effects such that the presence of the applied electric/magnetic field induces an electric/magnetic polarization proportional to the magnitude of the applied field, and the standard constitutive relations apply. Wave-based sensor devices are able to prove these phenomena in materials of interest.

### Boundary Conditions at Interfaces Between Differing Media

If we consider the boundary across two conducting media (1 and 2) then the normal components of the fields on either side of the surface of the boundary (across which the charge density ρ can flow) are related by,

$${( {D}_{2} - D )}_{1} ) \cdot n = ρ , ( {B}_{2} - {D}_{1} ) \cdot n = 0.$$

Similarly the tangential component of E across an interface is continuous whereas the tangential component of H is discontinuous by an amount equal to the surface current density. These discontinuity equations are useful in solving reflection and refraction properties across boundaries. Reflections of waves are often encountered by wave-based sensors (e.g. at the air to concrete boundary for a GPR wave), and their use for sensing is described further (see scattering section).

### Electromagnetic-Mechanical Coupling: Conservation of Energy and Momentum

Wave-based sensors leverage couplings between different fields or forces to transduce energy and generate an excitation or sense the response to such excitation. These couplings can be derived mathematically. For example, for a continuous distribution of charge and current, the total rate of doing work by the fields in a finite volume V is ∫ᵥJ·Edv. This power represents the conversion of electromagnetic energy into mechanical or thermal energy. This will be balanced by the rate of decrease of energy in the electromagnetic field within the volume V.

For macroscopic media linear in electric and magnetic properties with negligible dispersion, we can derive the energy conservation equation, where the rate of change of electromagnetic energy within a certain volume plus the energy flowing through the boundary surfaces of the volume per unit time is equal to the negative of the work done by the fields on the sources within the volume. This injection of energy into the system is ultimately how the energy is converted from electromagnetic into mechanical or thermal energy. Thus the equation of conservation of energy for the combined system is given by

$$\frac{dE}{dt} = \frac{d}{dt} ( {E}_{mech} + {E}_{field} ) = - ∮ n \cdot ( E \times H ) da , \\ where , \frac{{dE}_{mech}}{dt} = {\int }_{V} J \cdot E dv and , \\ \frac{{dE}_{f ield}}{dt} = {\int }_{V} udv = \frac{{ϵ}_{0}}{2} {\int }_{V} ( {E}^{2} + {c}^{2} {B}^{2} ) d v .$$

Similarly we can derive the equation for conservation of linear momentum to derive the momentum of all particles in the volume V, from Newton's second law, which when cast into its Cartesian components (denoted by x_{α}, α=1,2,3):

$$\frac{d}{dt} {( {P}_{mech} + {P}_{field} )}_{a} = ∮ s {\sum }_{β} {T}_{a β} {n}_{β} da , \qquad ( 1.38 )$$

Where,

$$\frac{{dP}_{mech}}{dt} = {\int }_{V} ( ρ E + J \times B ) dv .$$

and the electromagnetic momentum P_{field} in the volume V is defined as

$$\frac{{dP}_{field}}{dt} = {μ}_{0} {ϵ}_{0} {\int }_{V} ( E \times H ) dv .$$

The Maxwell stress tensor

$${T}_{a β} = {ϵ}_{0} [ {E}_{α} {E}_{β} + {c}^{2} {B}_{a} {B}_{β} ] - \frac{1}{2} ( E \cdot E + {c}^{2} B \cdot B ) {δ}_{a β} ,$$

is the α component of the momentum flux across surface S into volume V. This is the mechanical pressure exerted on surface S acting on the combined system of particles and fields inside volume V.

The type of medium will impact the P_{mech} term as the stress tensor in fluids and solids entails analysis of interplay of mechanical, thermodynamic and electromagnetic properties. These energy and momentum conservation equations form the basis set of equations from which we can build mathematical formulation for sensors based on the detection measurement and excitation mode and combined with the configuration to define the initial and boundary conditions under which the equations may be solved. For example the piezoelectric equations are formulated by accounting for the contribution of the mechanical stress tensor in coupling with the electric displacement via the constitutive equations. Thus these coupled electromechanical equations serve as the basis for the phenomenon of interest. These may be expanded to include the dissipative effects of temperature as well (which allows for normalization of their effects). This section is illustrative of an electromagnetic to mechanical coupling (demonstrating how a transducer is able to convert from one form of energy to the other). Wave based sensors make use of this and other similar field or force couplings across different domains.

### Wave Propagation Through a Medium

The basic feature of Maxwell's equations for electromagnetic fields is the existence of traveling wave solutions which represent the transport of energy from one point to another. Note that guided wave techniques are exploited by many of the wave-based sensors under consideration. We consider transverse, planar waves propagating through a non-conducting medium (spatially constant μ, ∈). If we apply a harmonic excitation (angular frequency, ω) to a uniform, linear medium, then Maxwell's equations, reduce to the wave equation,

$$( {∇}^{2} + μ ϵ {ω}^{2} ) E = 0$$

$$( {∇}^{2} + μ ϵ {ω}^{2} ) B = 0.$$

Thus a possible solution is a plane wave traveling along a given dimension that can support waves of wavenumber k, excited by an angular frequency ω. The wave number k and frequency ω are related by: k={square root over (()}μ∈)ω.

The phase velocity of the wave is given by:

$${v}_{p} = \frac{ω}{k} = 1 / \sqrt{( μϵ )} = c / n , n = \sqrt{\frac{μ ϵ}{{μ}_{0} {ϵ}_{0}}} .$$

The refractive index of the medium, n, is usually a function of frequency. The medium will support waves propagating at wave speed vₚ, in the ±x direction. Thus as the concrete cures it is anticipated that the medium permeability and permittivity of the medium will evolve. By measuring the wave speed (using pulse-echo/pitch-catch techniques for example), or the electromagnetic wave impedance, we can track the evolution of the concrete as it cures. Generally, various aspects or parameters of the wave-equation can be measured by wave-based sensors. Wave-based sensors may also excite and/or manipulate waves (e.g. through frames). The impact of these excitations and/or manipulations will influence the solutions to the wave equation (or other PDE) which describes the system.

Also note that for dispersive media where (μ, ∈ depend on ω) the wave will change shape as it propagates. This property is exploited by the inventor's refractive index sensors and photonic waveguides, where the excitation waveform and the change in shape of the detected waveform at the sensor are tracked.

### Electromagnetic Wave Impedance

Electromagnetic wave impedance defines the ratio between transverse components of the electric and magnetic fields supported by an EM planewave. In the wave regime (where conservation term dominates over the conductivity), the wave impedance of the medium as Z_{w}=\sqrt{μ/∈}. If the conductivity (σ) dominates over the conservation term (∈) this leads us to the quasi-static regime, where the impedance corresponds to Z_{qs}=\sqrt{iωμ/σ} noting that in this regime the electric lags the magnetic field by π/4 radians. For generalized conditions where conductivity and permittivity of the medium are of comparative levels, the overall impedance combines both quantities to yield an overall electromagnetic wave impedance,

$${Z}_{em} = \sqrt{i μ ω / ( σ + i ω ϵ )} .$$

In the sensors depending upon the excitation frequency we can trigger wave responses that correspond to different properties of the medium. By applying a sweep across a wide range of wave frequencies (or using other forms of excitation signals), the electromagnetic wave impedance spectra can be measured, to enable various properties of the medium to be characterized (see MAIS, introduced later). The evolution of properties over the curing cycle of concrete provide a definitive signature of the properties of the material.

### Cylindrical Resonators and Waveguides: TM and TE Waves

Wave propagation through a waveguide (e.g. a hollow cylinder filled with a dielectric) leads to different bounded propagation modes. In a resonator (which is typically fully enclosed, but may also be partially open), wave propagation leads to standing wave modes. Resonance modes may also be constructed from one or more frames (e.g. reflectors or concentrators disposed in various configurations to promote resonance). At the most general level, reflective and conductive boundaries are used to bound propagation, and generate resonances. This is a form of wave-manipulation, through frames.

Both waveguide propagation modes, and resonance modes caused by resonators, or frames are employed to enhance material characterization. In particular, waveguide, resonators, including conductive frames may be disposed within a material of interest (and their hollow or concave sections may be filled with a host material such as concrete). This changes their propagation and/or resonance modes. These changes can be measured to determine a characteristic of the medium. In practice, this is achieved by coupling a wave-based sensor to a frame. Sensors and/or actuators may be in, on, or disposed within a frame, or in proximity of the frame, and may be used to excite and/or detect the propagation modes and/or resonance modes.

For example, for hollow conductive cylinders filled with dielectric material such as curing concrete, the following wave equation and wave propagation modes emerge, and the wavenumber is related to the permittivity and permeability of the medium as follows.

Wave equation:

$$( {∇}_{t}^{2} + {ω}^{2} / {c}^{2} - {k}^{2} ) E = 0 , ( {∇}_{t}^{2} + {ω}^{2} / {c}^{2} - {k}^{2} ) B = 0$$

Propagation Modes:

TM (Transverse Magnetic or H waves) mode that requires:

B_{z}=0, everywhere, BC:E_{z|S}=0

or the TE (Transverse Electric, or E waves) mode that requires:

E_{z}=0, everywhere,

$$B C : \frac{\partial B}{\partial n} \vert s = 0$$

Where the wavenumber for a given angular frequency ω is:

$${k}_{m}^{2} = μ ϵ {ω}^{2} - {γ}_{m}^{2}$$

Where there is a spectrum of eigenmodes γₘ, m∈(1, 2 . . . )

In a further embodiment, where two concentric cylinders are filled with a dielectric medium (e.g. concrete), a third mode, so called ‘TEM’ propagation mode emerges (which together with the TE and TM modes, constitute a complete set of fields to describe the electromagnetic disturbance in a waveguide or resonator).

TEM (Transverse Electromagnetic Waves) mode that requires:

E_{z}=B_{z}=0 and Eₜ=E_{TEM} where the wavenumber is:

$$k = {k}_{0} = ω \sqrt{μ ϵ} = ω c$$

By coupling wave-based sensors to such waveguides (cylindrical, concentric cylindrical, or others), the frequency dependence of the complex permittivity ∈ and permeability μ can be determined, for example, by measuring the field response of the waveguide to an angular frequency sweep, which can be used to characterize aspects of the material, such as its E&M Impedance.

The wave impedance, Z will depend on the type of mode that has been excited. Therefore we have: Z_{TM}=k/∈ω=k/k₀\sqrt{μ/∈}, for TM waves

Z_{TE}=μω/k=k₀/k\sqrt{μ/∈}, for TE waves.

Furthermore, by solving the wave equation we can obtain the eigenvalues (natural frequencies) of the system that can be supported (equivalent to the resonant frequencies of the electromagnetic wave impedance in the waveguide filled with dielectric). These can be measured using wave-based sensors, to establish impedance responses (see later section on impedance spectroscopy).

A critical aspect of the design of a waveguide is the cutoff frequency, below which excitations will not propagate. For a given mode, we define the cutoff frequency,

$${ω}_{m} = \frac{{γ}_{m}}{\sqrt{μ ϵ}} ,$$

and the wavenumber in terms of cutoff frequency

$${k}_{m} = \sqrt{μ} ϵ \sqrt{{ω}^{2} - {ω}_{m}^{2}} .$$

Measuring the cut-off frequency as the dielectric medium evolves over time (e.g. concrete curing) can be another way of characterizing the material.

On the other hand for frequencies above the cutoff, (ω>ωₘ), the waves of mode m can propagate through the guide.

At the cut-off frequency, the group velocity of the wave is zero, the wave is effectively a standing wave, where the phase and group velocity of the waves are respectively given by,

$${v}_{p} = \frac{1}{\sqrt{μ ϵ}} \frac{1}{\sqrt{1 - {ω}_{m}^{2} / {ω}^{2}}} , {v}_{g} = \frac{1}{\sqrt{μ ϵ}} \sqrt{1 - {ω}_{m}^{2} / {ω}^{2}} , and {v}_{p} {ν}_{g} = 1 / ( μ ϵ ) .$$

These can be measured, again, as a way of characterizing the medium within or surrounding the waveguide.

Finally, the third mode supported by the concentric cylinder embodiment does not have a cut-off frequency, making it more advantageous for low-frequency excitations of the system.

Generally, this framework and these concepts apply across the entire electromagnetic spectrum, and in particular in the RF/Microwave/Terahertz range (where E&M waves propagate through mediums of interest such as concrete), but also for IR/Visible and beyond, in optical waveguide systems that may be coupled to the material of interest (see photonic waveguide section later). These concepts are used extensively by the device embodiments for wave-based sensing.

### Resonators

Resonators offer another embodiment for measuring and/or characterizing materials, which may be particularly advantageous as shifts in resonant frequencies caused by changes in material properties bounded by or surrounding the resonating frame can be measured.

For example, a cylindrical waveguide with endcaps is an interesting resonator class particularly from the perspective of sensor design. Assuming the walls of the resonator are of infinite conductivity, and the resonator is filled with a dielectric (μ, ∈) (e.g. which for example, may be curing concrete). Reflections at the end surfaces require the axial (z) dependence of the fields to support standing waves. For planar boundary conditions in the resonator then the solution admits solutions of wavenumber k=pπ/d, p∈(1, 2 . . . ).

For a TM field, the transverse electric Eₜ will vanish at the endcaps, hence E_{z}=ψ(x,y)cos(pπz/d), p∈(0, 1, 2 . . . ).

Equally, for TE field H_{z}→0, and hence H_{z}=ψ(x,y)sin(pπz/d), p∈(0, 1, 2 . . . ), where ψ represents the eigenvector that satisfies the wave equation.

As a result, the resonator can support modes of frequency,

$${ω}_{m , p}^{2} = \frac{1}{μ ϵ} [ {γ}_{m}^{2} + {( p π / d )}^{2} ] ,$$

where there is a spectrum of eigenmodes γₘ, m∈(1, 2 . . . ). These resonance frequencies form a discrete set that can be determined by the axial wavenumber k versus frequency in a waveguide by setting k=mπ/d.

In practice, this means that the excitations generated by wave-based devices will induce resonance modes in the resonator, which will depend on the permittivity and permeability of the dielectric that it contains. These can be measured, to characterize the evolution of the dielectric medium (e.g. concrete as it cures).

It is worth noting that it may be difficult to fill a closed cylindrical resonator with concrete, but that similar analysis can be carried out for an open-faced resonator (e.g. with the open face facing up, so that the inside is filled with concrete when it is poured on a slab). Or alternatively, holes and slits may be etched into the resonator to allow the concrete in. This may lead to signal leakage, but can be taken into account in the analysis. Finally, other resonance geometries may be constructed with frames disposed in different configurations.

For sensor design, a critical aspect is the dimensions of the resonating frame, which will impact the resonant frequencies and the region of the impedance spectrum that can be probed. Key considerations include (1) ensuring that the resonant frequencies of operation are within the range of interest for the host material; (2) that the resonant frequencies of operation must be well separated from other resonant modes of the sensor so that their resonance peaks are not confounded.

We note that there are other forms of resonances which can also be employed (beyond those caused by standing waves). This is described in the mechanical section but may also apply to E&M-based systems.

Power losses and Q factor of Resonator: The resonance response is not a delta function at the resonant angular frequency ω₀ but rather a narrow band of frequencies around the eigenfrequency over which appreciable excitation can occur. Dissipation of energy in the resonator walls as well as in the dielectric filling the capacity are the cause of smearing out of the modes. A measure of the sharpness of the response of the resonator to external excitation is the Q factor of the cavity, defined as the ratio of the time averaged energy stored in the capacity to the energy loss per cycle, where

$$Q = {ω}_{0} \frac{Stored Energy}{Power loss} .$$

The specific values are very much material and geometry dependent, and the Q-value of wave-based sensing system is an important consideration that applies to sensor design, and may also be informative of the material characteristics (and its evolution in time).

### Mechanical Waves, Resonance, Waveguides

### Mechanical Waves Basics: Compression/Shear in an Isotropic Elastic Medium

Similar formalism can be established for mechanical deformations in a medium (which are driven by mechanical wave-based sensors).

In the general formulation consider a sample of volume V of material as a static elastic solid subjected to applied surface forces, responding with small internal displacements u. If ƒ(x,t) is the applied force on particles inside V (which may be representative of a mechanical driving force exerted by a mechanical wave-based actuator element), then the stress tensor t and strain tensor e=u/L, (L being the characteristic length) has components that are related by the generalized version of Hooke's law:

$${τ}_{ij} = λ {e}_{kk} {δ}_{ij} + 2 {ve}_{ij}$$

and λ=K−⅔G, v=G are the Lame constants and K, G are the bulk modulus and shear modulus respectively. The generalized conservation of momentum for elastic deformation in an isotropic medium:

$$ρ \frac{{\partial }^{2} u}{\partial {t}^{2}} = f + ( λ + v ) ∇ ∇ \cdot u + v {∇}^{2} u$$

For a planar wave assumption the three orthogonal dimensions lead us to three uncoupled PDEs that permit wave propagation along the excitation vector (longitudinal vector) and orthogonal to the excitation (transverse vector).

Along the longitudinal vector the deformation travels with wavespeed cₚ=\sqrt{(λ+2v)/ρ},

It is the primary P-wave and is the fastest traveling wave in an elastic solid.

Along the transverse vector, the waves propagate at speed cₛ=\sqrt{v/ρ}, these are secondary S-waves. Wave-based sensors may be able to generate P-waves and S-waves in solids (or semi-solids/semi-liquids such as concrete), and analyze their characteristics in the material.

Most longitudinal propagating waves supported by an elastic medium are acoustic waves, they transmit energy by deforming the elastic medium through which they travel, and these which may be solid or liquid. Fluids cannot support shear, therefore acoustic waves in a fluid medium transmit energy only as a P-wave. However, solids can support S-waves and hence acoustic waves may propagate as either P- or S-waves in a solid.

For a fluid, the shear modulus is zero, and so the wave velocity (speed of sound) of the excitation reduces to c=\sqrt{K/ρ}, K being the bulk modulus of the medium and ρ being the density. As an example of linear wave propagation, we expect the amplitudes of scattered waves (reflected, refracted or transmitted across boundaries) to increase in proportion to the incident amplitude. We define the acoustic impedance of the fluid as Z_{ƒ}=ρc, where the impedance is essentially the ratio of pressure to particle velocity. In this context the impedance is high, if high pressure leads only to small particle velocity, whilst impedance is low if the particle motion is large even at low pressure.

For a solid, the wave velocity cₚ=\sqrt{(K+4/3G)/ρ}, and cₛ=\sqrt{G/ρ}. G can be determined by measuring the shear wave velocity, which can be substituted into the first equation to determine

$$K = ρ {c}_{p}^{2} - ( 4 / 3 ) G .$$

We would consider liquids and solids to vibrate in response to an initial excitation, in a mode consistent with the natural harmonics as determined by the eigensolutions of the system.

Cementitious Mixes such as concrete are a semi-fluid material at early ages and become elastic solids as they cure (up to some fracture point where they no longer behave in an elastic manner). This means that at early ages, it for the most part only supports P-waves, but as it cures, shear-modes will emerge. By measuring the P-wave & S-waves velocity (e.g. through time of flight analysis, or in the ultrasonic domain, by using the UPV technique), wave-based sensors can determine the Bulk and Shear Modulus'. This can be related back to the curing age, and ultimately the compressive strength (e.g. through models that relate the dynamic modulus, to the static modulus, and ultimately the compressive strength). An acoustic excitation would yield the dynamic Bulk and Shear modulus, which is closely related to the stiffness of the material but is distinct to their static analogue. For cementitious materials, the dynamic modulus can be related back to the static modulus through a number of relations and/or models (e.g. empirical or machine-learning based). Ultimately this can all be used to determine the compressive strength and/or other static or contextual material properties of the material.

Alternatively, instead of measuring the P & S wave velocity, the speed of sound in the medium at different ages can be determined using the resonance peaks in the mechanical impedance spectrum (where the mechanical impedance at a point is defined as the ratio of the force applied to that point and its velocity). A frequency sweep (or one or more other multi-frequency signals) are used to characterize the frequency response of mechanical impedance. Material excitation will induce a resonant response in the material at resonant frequencies, which will be consistent with the natural harmonics of the system. These can be related back to the wave velocity and modulus (analogous to a tuning fork). Mechanical impedance can be measured using any number of couplings (including through the electrical impedance of electromechanically coupled systems).

Ultimately, these and other related techniques (including generalized elastic wave impedance measurement) open up a whole series of solutions for mechanical-excitation wave-based sensing of concrete characteristics (which are further described in the mechanical wave-based section).

### Plane Waves at an Interface

If a plane wave strikes a plane interface obliquely, reflected and transmitted waves arise as in optics. If a longitudinal wave is incident at the boundary two waves are reflected, a longitudinal wave and a shear wave are generally reflected, the shear wave being generated by mode conversion to a longitudinal wave to satisfy boundary conditions. If only a shear wave is incident, there can be no mode conversion to a longitudinal wave as the boundary conditions will not support it. No mode conversion occurs at normal incidence or when a shear wave is incident at π/4. Furthermore the laws of refraction determine the direction of the reflected and transmitted waves. For example, if we assume a wave propagates in medium 1, with velocity c₁ and is incident, at the interface between media 1 and 2 at an angle α₁, then the wave transmitted in medium 2 will propagate with an angle that follows from Snell's law α₂=arcsin[c₂/c₁ sin(α₁)]. Further to this the reflection and transmission coefficient can be determined as well. This applies to various boundaries within concrete elements (e.g. the air to concrete boundary, but also the concrete to rebar boundary, or concrete to formwork boundary). In addition to time of flight (discussed prior), the attenuation of waves on reflection (or transfer) may be measured by wave-based sensors to further characterize the material under consideration.

### Mechanical Waveguides and Resonators

Mathematically the concepts developed around waveguides, frames and resonators for electromagnetic waves translate naturally to the other realms include mechanical waves. This can be understood from the consideration of the wave equation, allowing for the differences in physical contributions and the boundary conditions.

The phase velocity of the lowest propagating mode in an acoustic waveguide is generally close to the free-space sound velocity so sound velocity can conveniently be measured in a waveguide as a function of gas composition, temperature, and pressure, in the presence of a flow field, and even in turbulent flows. Similarly, damping of waves is a measure of the shear viscosity of the medium.

These ideas can be extended to a solid medium, specifically in the context of wave-based sensors. From a waveguide perspective, typically surface acoustic waves such as Lamb waves are excited. These travel along the direction of the boundary of the medium, are typically S-waves and may be directed by the excitation unit in a manner that triggers wave reflection back to a collocated sensor or transmission to a distinct sensing element. The critical propagation occurs through the medium and the properties of the medium may be measured, wave speed directly relating to the bulk modulus, the attenuation of waves relate to the shear modulus. We employ such waveguides in some embodiments. Their excitation modes can be characterized as a measure of the material of interest.

An equivalent electrical circuit can be constructed for mechanical systems, composed of wave-based sensors and frames (e.g. acoustic waveguides). This is used to understand and/or tune complex mechanical systems. One particularly inventive embodiment is the use of such equivalent circuits, to model and measure wave propagation scattering through the circuit by converting it into an N-port system and measuring its S or T parameters. This is developed in considerable detail further in this section under Scattering Parameters.

Resonators are another interesting class of systems that can be exploited mechanically as well. For example, in a drum-like instrument, mechanical excitations propagate through the elastic membrane of the drum and excite modes that are amplified by the resonance chamber within the drum itself. Standing waves are triggered by the excitation of the design of the resonator supporting the specific resonant frequencies of interest.

A wave-based sensor coupled with a resonator, disposed in a curing medium such as concrete, is a particularly innovative embodiment of the invention. Upon an input excitation signal, resonance frequencies will shift as materials evolve over time (e.g. such as concrete curing). Those shifts in resonance frequencies can be used to characterize the material. For example, the CMUT sensor generates mechanical deformations and oscillations (typically in the ultrasonic frequency domain) through changes in capacitance (a mechano-capacitance based coupling). CMUT is a novel MEMs transducer that comprises a membrane made up of a semiconductor layer (e.g. silicon), designed to create a cavity between the membrane and the substrate (e.g., concrete). The substrate and membrane are connected to electrodes that respond to an applied potential, with charge build-up. Oscillating potential (either as a frequency sweep or applying a series of pulses) will create a resonant condition in the resonator that will mechanically excite the transducer. The CMUT transducer can then be disposed within, on or in proximity of a frame (optionally which may have a receptacle for material such as concrete to flow into). For certain frame geometries and properties (e.g. reflector), the CMUT-frame-material system would exhibit resonance characteristics itself. In some respects, this becomes a double resonator (the CMUT transducer employs resonances but is itself used to construct a larger resonator). By coupling resonator systems to the host material (e.g. by placing sensors and actuators in receptacles that can be filled with concrete), we can enhance natural resonance frequencies of the host material, which can then be used to measure the speed of sound in the medium (from the resonance mode equations), and ultimately related back to the dynamic bulk and/or shear modulus. From there, the static modulus, and compressive strength, and/or other material properties can be determined (e.g. using physio-chemical, empirical, or machine learning, or hybrid models)

### Guided-Wave Based Sensing Modes

There are mainly three modes of guided wave propagation, (1) pitch-catch mode, (2) pulse-echo mode and (3) thickness mode. An example of a pitch-catch mode involves a pair of CMUT transducers attached on the plate-like structures. Ultrasonic guided waves are induced by the CMUT-actuator attached to the surface of a flat plate-like structure. As a result the ultrasonic disturbances occur and propagate radially around in the structure. The CMUT-sensor placed a distance away receives the electric charge signal, owing to the induced mechanical strains and output voltage signals (sensing waveform). In pulse-echo and thickness modes, the sensing and excitation elements are collocated and use a feature such as a boundary or rebar to reflect the wave and measure various properties.

Material property inspection is made possible by recording the change in wave form, signal attenuation, and time of flight. For global monitoring, P-waves are typically of interest as they have greater energy and can propagate further. Signal attenuation is interesting from the point of view of measuring the density of the medium.

In time-of-flight sensing the time delay between actuation and sensing provides a measure of the wavespeed vₚ=(K/ρ)^{0.5} where K is the bulk modulus of the medium and is a measure of the material strength at a given time. Density and bulk modulus (and hence ultimate strength) are properties that will evolve as the concrete cures. For longer term monitoring changes in applied and sensed wave-form can be examined. For example in the case of damage incurred over the life of the pour a wave-form change will be detected, either in terms of phase shift, pulse-width change, or attenuation in the received signal.

### Mechanical Vibrations

In the concepts discussed above we probe the mechanical properties of the medium by triggering P- or S-waves in the elastic medium. Another mechanism that may be exploited is by inducing transverse deformations in a sensor, that can be influenced and hence used to measure the physical properties of the surrounding medium.

An idealized example is a linear beam that vibrates in response to an external excitation. The idealized conception of a linear beam of length L, in a vacuum, responding to a small perturbation in the form of an initial deformation, w, that is orthogonal to the axis of the beam, and can be modeled using the Euler-Bernoulli beam equation,

$$E I \frac{{\partial }^{4} w}{\partial {x}^{4}} + ρ A \frac{{\partial }^{2} w}{\partial {t}^{2}} = 0$$

where E,I,ρ,A are respectively the Young Modulus, second moment of area of the cross section, density and cross section area of the beam. The system will support standing waves, and the beam equation provides an expression for the natural angular frequency

$$ω = \sqrt{( \frac{E I}{ρ A} ) {k}^{4}} ,$$

where k and the excitation response will depend on the boundary conditions. For example, a cantilevered beam will have a different modeshape compared to a pinned beam or a free-beam, hence the wave-based sensor configuration as well as geometric design will govern the response of the structure to an excitation.

From the perspective of the sensor, the excitation may be provided by a piezoelectric actuator (or a magnetoelastic, opto-mechanic or another form of coupling, or even a simple kick delivered by an impact hammer) that will provide a time varying excitation pulse, a harmonic response to frequency sweep, or an initial impulse that can trigger the natural modes of the system.

The system modes may be used to examine the progression of the system from base sensor characteristics (in air) which will be given by the expression above for its natural frequency. When the concrete is poured, the surrounding medium will impart its stiffness (K′) to the structure, as well as some inertia (m′), which can be measured by measuring the system natural response frequency,

$${ω}_{2} = \sqrt{( \frac{E I + {K}^{′}}{ρ A + {m}^{′}} ) {k}^{4}} ,$$

noting that in this instance the system is the sensor-in-the-medium. These properties will evolve as the concrete cures and can therefore be used to monitor the evolution of the mechanical properties. In addition we can track the workability of the concrete with a distributed sensor, which will be measured by the rate of damping of the applied deformations in the structure. It is worth noting that these concepts can extend to the in-plane excitation as well as torsional modes of a beam (sensor) as well, and combinations thereof, as for example represented in Piezo Embodiments.

### Differentiating Between Wave Resonances, and Mechanical Resonances

The above formalism, outlined for acoustic waves, and mechanical vibrations, can be generalized to any mechanical excitation. Similar relationships and embodiments hold for mechanical excitations and oscillations more generally (which may not necessarily be waves, but rather periodic forces that may be applied to a material). For a generalized mechanical excitation, the point mechanical impedance Z(ω)=F(ω)/v(ω), where F is the driving force v is the velocity at a point within the material. In the more generalised N-dimensional case, the mechanical impedance is defined by ZᵢⱼVⱼ=Fᵢ, where Zᵢⱼ is the Impedance matrix, representing the ratio of the fourier transforms of the force excitation and the velocity response.

Mechanical excitations will generate one or more mechanical resonance modes when a mechanical excitation wave-based sensor is coupled to a material of interest. By coupling the mechanical wave-based sensor and actuator to a frame (e.g. a waveguide, or a concave surface as described prior), those resonance modes can be enhanced, or additional resonance modes created, that may be used to determine characteristics of the material of interest.

### MAIS: Multi-Coupling Advanced Impedance Spectroscopy Techniques

A particularly inventive aspect of wave-based sensors, is their ability to measure the spectra of a whole new class of impedances, through a plurality of innovative couplings (so called multi-coupling advanced impedance spectroscopy ‘techniques’ or ‘MAIS’). This goes beyond the more traditional technique of electrochemical impedance spectroscopy (EIS, where an electrical potential applied across an analyte is used to determine the electrochemical impedance at a plurality of frequencies).

In MAIS, the response of a sample to one or more perturbation time-varying excitations (e.g. electric, mechanical, optical and so on) is monitored, and the fraction of energy that is stored (including stored potential energy—i.e. capacitive, dielectric or stiffness components, and also kinetic/magnetic energy—i.e. inductive or inertial components) versus the fraction of energy dissipated (resistive, damping component of impedance or other) by the sample, as well as the relaxation time scale (the time that it takes the sample to return to equilibrium after excitation by the input), is measured as a function of frequency.

The input to generate the excitation may take any of the forms described elsewhere herein, and the measured output impedances may take any of the forms described below, or any other impedance-like, or impedance analogous measure that may involve other fields, flows or forces. These generalized impedance measurements are typically complex, may be measured by detecting one or more amplitudes and phase shifts, or by measuring an input and an output voltage or current (when electrically coupled), or by measuring an inductance, capacitance and resistance of a circuit (or any of their analogues in non-electric domains).

Wave-based sensors are able to carry out MAIS techniques by exploiting couplings between different domains (e.g. electric, magnetic, electromagnetic, optical or photonic, chemical, mechanical, radiative or biological domains). For example, to characterize the mechanical impedance of a system, an electromechanically coupled sensor and/or actuator may be used to drive the excitation or sense the system. The measured output of the coupled system would be the electromechanical impedance (wherein the electrical impedance of the electromechanically coupled sensor is measured). It follows that other couplings may be employed—e.g. optomechanical, magnetomechanical, magnetochemical, optochemical, optoelectric and any other two coupling permutation. Higher order couplings (3 couplings, 4 couplings and so on, such as electro-magneto-mechanical, electro-opto-mechanical) may also be employed in certain embodiments, for example when a second order coupling that is not electronic in nature is measured by an electronic system. Below we outline the fundamental types of impedances (in respect of the physical phenomenon they are related to). When they are measured through a coupling, the coupling is typically prefixed to them and the measured impedance quantity is labeled after the “coupling type” and “phenomenon domain” (e.g. “electromechanical impedance” or “optomechanical impedance” and so on).

So far, three types of impedances have been described (electromagnetic wave impedance, acoustic impedance, and mechanical impedance), which can be measured by wave-based sensors, across a variety of frequencies. These impedances are associated, but physically distinct concepts. Broadly they may represent how a particular force, flux or flow is impeded by a system (or in the case of admittance, which is the inverse of impedance, how a particular force or flow is admitted by a system). We define these more formally below (without loss of generality for another related or similar form):

Electromagnetic Wave Impedance is Z_{w}=Eₓ/H_{y}, where Eₓ and H_{y} are the transverse components of the electric and magnetic field. For a wave travelling in a dielectric with dispersion and losses, this becomes: Z_{w}(ω)={square root over (iμω/(σ+iω∈)}) where μ, ∈ and σ are the permeability, permittivity and conductivity of the medium in which the electromagnetic wave is travelling.

Acoustic Impedance (for P waves at normal incidence) Zₐ(ω)=ρc, where ρ is the density of the medium, and c the speed of sound in the medium. The speed of sound in the medium may depend on frequency (in particular in resonators) and can be expressed in terms of the frequency ω and wavenumber k. In the frequency domain this becomes: Zₐ(ω)=ρω/k. This is the opposition to the flow of sound energy through a medium, measured in Rayls (acoustic ohms, of unit (kg/(s·m²))).

Mechanical Impedance Zₘ=F/v, where F and v are the driving force and velocity at a point. More generally, for an n dimensional linear system, mechanical impedance is defined in the frequency domain, as the ratio of the fourier transforms of the force excitation and the velocity response, which can be expressed as follows in summation notation: ZᵢⱼVⱼ=Fᵢ;

The technique is extended further, to other forms of impedance (for different forces, waves, fluxes or flows), which may all be measured by wave-based sensing systems (optionally at a plurality of frequencies). Below some additional examples of the different types of impedances the system is able to characterize through MAIS:

Electric Impedance, Zₘ(t)=V(t)/I(t), where V is the voltage across, and I is the current passing through the component of interest. This is typically further broken down into its real and imaginary components, Z=R+iX, where R is the resistance, and X is the reactance (itself made up of the capacitive and inductive reactances).

Elastic Impedance, which is an extension of Acoustic Impedance, to oblique incidences, that combines the density and velocities of both P-waves and S-waves in materials to provide an intrinsic property of the elastic medium. This can take various forms (including, e.g. an impedance matrix), or for example, Ver West's the Ray-Path Acoustic Impedance

$${Z}_{RI} ( ρ , {V}_{P} , {V}_{S} \vert p ) = ρ {V}_{P} / [ \sqrt{1 - {V}_{P}^{2} {p}^{2}} ] exp [ - 4 {V}_{S}^{2} {p}^{2} ρ / {ρ}_{0} ]$$

Magnetic Impedance, which refers to the opposition to the flow of an alternating magnetic field in a material. In the gyrator-capacitor model, this is Z_{B}(ω)=F(ω)/\dot{Φ}(ω). Alternatively, in the reactance-reluctance model the analogue is the magnetic reluctance, R_{B}=F/Φ (analogous to an electric resistance).

Thermal Impedance, which measures the resistance to heat flow through a material (in degrees kelvin per watt (K/W)), and is the generalization of thermal resistance to time-varying thermal excitations. This can be defined as the ratio between the temperature of the sample, and the thermal wave flux. In one embodiment this is expressed as

$${Z}_{θ} = [ {T}_{a c} ( x , t ) ] / [ - k ( \frac{d {T}_{a c}}{d x} ( x , t ) ] .$$

For a semi-infinite medium,

$${Z}_{θ} = \frac{1 - i}{ϵ \sqrt{2 ω}} ,$$

where ω is tie frequency of thermal oscillation, and ∈, the thermal effusivity.

Specifically, enhanced impedance spectroscopy techniques are applied by the inventions to the analysis of building materials, e.g. for determination of contextual material properties such as the compressive strength of concrete.

### Excitation Signals: Single, Multi-Sine, Chirp, Wavelet Etc

Traditional single-sine EIS techniques are slow, as they require the sequential excitation of a frequency sweep across low frequencies. This is typically done by applying one frequency at a time and measuring the system response. MAIS employs more advantageous techniques, through multi-frequency component excitation signals. In one embodiment, the measurement time is sped up by applying multiple frequencies of sine waves simultaneously to the system and measuring the cell's response. Simultaneous completion of the measurement at various frequencies is a particularly advantageous feature which will promote broader adoption of wave-based sensors. Systems are designed to allow for stability and linearity, despite more complex input signals.

Input excitations take a number of different forms. They include broad-band noise-like signals which can excite the system dynamics over a broad frequency range. Alternatively, the excitation signal may take the form of one or more chirps, wavelets, and DRBS (Discrete random binary sequence) waveform. Custom pulses and waveforms can be designed, for specific goals or specific sub-frequencies of interest. Intensity may also be modulated periodically to test linearity assumptions. Other periodic or non-periodic signals may be used (including those described elsewhere in this document, or similar signal excitations). Excitation signals fulfill certain properties including stationarity, bandwidth within the frequency of interest and a PSD that is large enough to yield a suitable signal-to-noise ratio. This may be achieved by the MCU on wave-based sensors (e.g. through analogue or digital systems, including controlling analogue signals through PWMs on the MCU).

### MAIS for Electrochemical Impedance Spectroscopy on Wave-Based Devices

In some embodiments, wave-based sensor devices make use of electrochemical impedance spectroscopy techniques to measure the current response of a circuit when a sample is subjected to a voltage excitation. The excitation may take many forms, such as those illustrated in FIGS. 5F-5H, including applied oscillating electric potential V(t)=V₀exp(iωt), I(t)=I₀ exp(iωt+φ), where V₀, I₀ are the amplitude of the voltage and current, ω is the frequency and φ is the phase difference between the current and voltage on account of complex electrical impedance Z, defined as Z(t)=V(t)/I(t)=Z₀ exp(iφ), where Z=V₀/I₀. Physically the impedance is the complex resistance of the sample, and is more conveniently expressed in the frequency domain into its real and imaginary parts Z=Z′−iZ″, where Z′ is the resistance R=Z₀ cos φ, and Z″ is the reactance X=−Z₀ sin φ.

We can express the capacitance of the empty cell C₀=∈₀A/d where ∈₀ is free-space permittivity, A, d are the sample/cell cross-sectional area and thickness respectively. We can cast the complex impedance components due to capacitance Z_{c}=(iωC₀)⁻¹ or inductance Z_{L}=iωL. In an RC circuit the potential balance equation yields V/R+CdV/dt=0, and the impedance is given as Z_{RC}=R(1+iωRC)⁻¹.

Relaxation time scales are an important consideration when performing spectroscopy particularly at lower frequencies when the excitation takes a finite time to decay. An equivalent circuit model to estimate the impedance in the circuit is required, typically these are modeled as an RC circuit from which we can estimate V(t)=V₀ exp(−t/RC), and τ=RC is the characteristic relaxation time scale. The relaxation time is measured alongside the impedance by wave-based sensors.

This enables the probing of relaxation processes such as lattice distortions, electrode polarization, dipole rearrangement, and electrical and ionic conduction, which are happening within the material (e.g. concrete). In the case of concrete, in particular fresh concrete, ionic conduction and dipole rearrangement will be the dominant modes in the spectra. These relate back, in particular, to pore diameter, which is known to correlate to strength. The system's models are used to determine the compressive strength, workability and other static or contextual, or compositional material properties.

An Nyquist plot shows the representation of the impedance spectrum in the complex plane. An RC circuit results in a spectrum in the shape of a semicircle; this is easily seen by expressing (1.90) in terms of the individual real and imaginary components of Z_{RC}. The maximum of the semicircle is given by ωₚτ=1, where ωₚ is the peak frequency, and t is as defined above, the RC time constant. A Bode plot, as illustrated in FIG. 5G, shows the frequency dependence of dielectric parameters. The Z′ and Z″ versus frequency spectra of the RC circuit are represented in the same graph. The peak frequency in the Z″ vs frequency spectrum (and change in slope in the Z′ vs frequency) corresponds to ωₚ.

Wave-based devices are able to reconstruct these plots for the material of interest (e.g. concrete as it cures), and key resonance peaks are used to further inform material identification and characterization. In particular, the execution of mix optimization, mix fingerprinting, context awareness, status inference or pour design and sequencing models wherein such models have either been trained on (or retrained/updated), or make us of electrochemical impedance spectroscopy data, or conductivity data (e.g. as an input, optionally live from a wave-based device) is seen as a particularly inventive embodiment.

Finally, the use of frames (as described above) are a particularly innovative embodiment in electrochemical techniques through wave-based sensing. In the electrochemical case, this may in particular, pertain to geometries of plates, electrodes, dispositions of conductive vs non-conductive charged elements within the media. These frames may also be used to change the electrochemical reaction diffusion equation boundary conditions (which governs the movement of ions in the material). In this context, frames may be produced out of semi-permeable membranes, to drive various diffusion pressure pathways through the material. Plates and electrodes may also be machined with protrusions and or voids to generate specific ion current modes, or through thin fluid layers between electrodes.

Specific device embodiments that are able to execute electrochemical MAIS techniques are described later.

### MAIS for Electromagnetic Wave Impedance Spectroscopy

Wave-based sensors exploit a particularly innovative aspect of MAIS which is further described here, namely: Electromagnetic Wave Impedance spectroscopy for material characterization and/or identification.

The electrical conductivity and dielectric permittivity determine the behavior of EM fields as they diffuse and travel through a medium/material of interest. For plane wave incidence the impedance for a homogeneous isotropic medium at a given excitation frequency is given by the equations in the “wave propagation through a medium” section. E&M Wave Impedance is affected by the dielectric permittivity, e at high frequencies and by the electrical conductivity, σ, at low frequencies. It is these properties that we can exploit in different regimes of the frequency spectrum to characterize a target material and its time evolving properties (e.g. curing of concrete). In sweeping the frequency across the spectrum from kilohertz to gigahertz (or employing a more advanced input excitation signals as described above) we can characterize the medium, including its compositional properties (e.g. elements such as water, lime, additives etc.), as well as its static and contextual material properties, which may be used to determine a fingerprint or identify (using for example, the system's mix fingerprinting models). In a particular embodiment, one or more of these data are used to train, retrain, or as an input of any of the mix optimization, mix fingerprinting, status inference, context awareness, or pour design and sequencing techniques described herein.

Another property of the system that can be exploited is the excitation amplitude to measure the attenuating properties of the medium, by sending EM waves of varying signal strength between a transmitting and receiving antenna. Concrete is known to be an effective EM wave signal attenuation medium. The density of the medium linearly impacts the extent of attenuation of the signal. An in-situ device may be employed to ramp up the transmission signal strength and measure the density of the material as it cures through a receiver antenna. Attenuation is almost independent of properties such as aggregate size making this method particularly robust to infer curing rate through the inference of density. Another area of applicability is in measuring the rheological properties (slump) of the material, which can be measured through the signal attenuation.

Concrete pours will almost always have embedded metallic rebar. Conducting pathways (rebar) thus considerably complicate the EM wave propagation spectrum. Its impedance and as attenuation for non-conducting media increases with frequency but decreases for conducting media. Such a composite material will have a complex structure, however through characterization steps discussed above, a material identifier for the composite can be characterized (optionally, in space too, through tomography). Frames (as described further above) play a particularly important role in the use of this technique for material characterization.

Specific embodiments and devices for MAIS E&M wave impedance material characterization are described in the electromagnetic mid-frequency wave-based sensing section (but may also be employed at other frequencies, in the material of interest, or in associated materials).

### MAIS for Electromechanical Impedance Spectroscopy

In this embodiment, MAIS devices configured with electromechanical transducers can be used to probe the mechanical properties of a medium via electrical stimulation (e.g. CMUT transducers). The use of CMUT and other electromechanical (or otherwise mechanically coupled) transducers to monitor the evolution of the fresh and hard properties of mixtures such as concrete is novel. Wave-based sensors discussed herein outline a number of realizations of this novel concept.

These wave-based devices are coupled into the mechanical regime through electronic couplings. Alternative embodiments may employ other couplings into the mechanical domain (e.g. opto-mechanical couplings, or electro-magneto-mechanical couplings such as those of EMAT transducers).

These mechanical devices are able to operate in a number of modes, which consider mechanical, acoustic and elastic impedance respectively. The former is for the most part used to consider local displacements & mechanical resonances (within the volume of influence of the transducer), whereas the second are used to measure properties related to wave propagation in the media, such as its attenuation, reflections and transmission through boundaries (including frames). Two mathematical embodiments were derived in the mechanical waves section, that demonstrate how mechanical or acoustic systems can lead to resonance modes (vibrational and wave-based respectively), which can be measured using the novel MAIS devices.

The fundamental concept of electromechanical model is that the electrical impedance is directly related to the mechanical impedance of a host material. Thereby allowing the monitoring of the host structure's mechanical properties using the measured electrical impedance. A simplified electrical circuit analysis can be used to illustrate the coupling properties of electromechanical transducer impedance. In one embodiment, capacitance of the transducer Cₜ generates a potential difference across the transducer Vₜ, in response to an applied voltage Vᵢₙ. As both Vᵢₙ and Vₜ may be treated as sources of voltage, the output voltage (Vₒᵤₜ) measured across the sensing resistor has two components; the first caused by Vᵢₙ and the second component caused by Vₜ. As such, Vₒᵤₜ can be obtained by the following equation:

$${V}_{out} ( ω ) = \frac{{Z}_{r} ( ω )}{{Z}_{t} ( ω ) + {Z}_{r} ( ω )} ( {V}_{in} ( ω ) + {V}_{t} ( ω ) ) ,$$

where the system is excited at frequency ω, and Zᵣ is the impedance at the sensing resistor, Zₜ is the transducer's impedance. The electrical impedance of the transducer, Zₜ=Zᵣ(Vᵢₙ+Vₜ)/Vₒᵤₜ−1) depends on the sensing voltage which is in turn a function of the structural properties of the medium (mass, stiffness and damping), and can be derived from the transducer's coupling equations (e.g. for a piezoelectric device, using the piezo-electric coupling equations and the electric displacement term D).

The transducer sensing sensitivity is closely related to the selected frequency band/wavelength of the excitation signal, which is emitted by the transducer's actuator, as well as the size, shape and topology of the transducer elements (actuator and/or sensor). By sweeping the excitation frequency (or any of the other advanced excitation modes described above for MAIS), the mechanical response is excited as well. The spectrum is determined, and its resonance/peak frequency is then measured. It is worth noting that (without loss of generality), for mechanical impedance, the frequency range is typically in the tens to hundreds of kilohertz range in order to elicit a mechanical response. For acoustic impedance configurations, sonics or ultrasonics may be used (e.g. starting at 2 MHz, and beyond). These electromechanical transducer systems are coupled with the various frames embodiment discussed prior, which stimulates resonant modes (similar to those derived earlier for mechanical waveguides and resonators, as well as vibrational modes).

In the case where the system is used in fresh concrete, one or more resonance modes may appear in the impedance/admittance spectra as peaks (optionally modified or enhanced by a frame). The peaks will shift as the concrete cures (and its modulus increases). The frequency of the resonance shift(s) can be related to the speed of sound in the medium, which can be related to the dynamic modulus, from which the static modulus and compressive strength can be determined (optionally, using an empirical model, physico-chemical models, or one or more machine learning models, including any of the models described elsewhere herein).

A particular innovative aspect of the use of MAIS-based, electromechanical impedance spectra, is the use of such spectra by the models described in mix fingerprinting, mix optimization, status inference, pour design and sequencing and/or context awareness, for training, retraining, or as inputs (optionally real-time inputs). Predicting, selecting, recommending, adjusting or generating material properties, such as compositional properties or contextual material properties, for a given contextual condition, optionally in conjunction with one or more other sensors (e.g. temperature) and optionally, a characteristic of the concrete (e.g., predicted heat rise, or activation energy) is a particularly important example embodiment.

The above system is considered for the condition where the sensing and actuation are collocated, in which case the impedance is a point frequency response function. We can also have distributed sensing, where the sensor is positioned a certain distance away from the actuation system. These generate a transfer frequency response function and the expression impedance is, Zₚ=Zᵣ(Vᵢₙ+Vₚ)/Vₒᵤₜ). This embodiment has the advantage that the domain of application of the sensor is significantly larger, and through coupling with frames (as described prior), several standing wave resonances emerge (through superposition, constructive and destructive interference etc.).

As noted, sensors typically exploit the concept of impedance matching where the transducer characteristics as well as sensor design characteristics (such as size) are tuned in a manner that matches the piezoelectric property impedance to the host material. This is intended to maximize sensitivity and sensor SNR. In a material where the properties are evolving (such as curing concrete) a tunable device where characteristics can be controlled (e.g. electronically) as the medium evolves, or as the concrete matures, would improve the sensor response and its scope. By tuning the piezoelectric properties, we can fingerprint properties of the host material as it evolves and is tracked. As in other techniques discussed above we can use these in absolute mode (full identification) or perturbative mode (tracking deviations due to failure).

### Specific Usage of MAIS in Concrete Applications

MAIS for concrete applications can have several manifestations. For example to characterize the curing of the concrete as it matures. It can also be used in a perturbative mode to measure deviation in properties. In the absolute state as the concrete cures chemical reactions take place whereby the impedance of the material under certain conditions changes. By characterizing this effect across different frequencies and under varying control conditions, it is possible to define a fingerprint for the concrete and to estimate the maturity state. It may also be used in tandem with orthogonal sensors such as a temperature sensor to correct for thermal effects. Further, it can be used to detect deviation in properties of concrete. For example, a contamination or deterioration in the concrete will result in a certain characteristic impedance at one frequency but not at another; A typical vector network analyzer (VNA) may be used to span from megahertz down to sub-hertz frequencies (with embodiments described further).

Once a pour is complete, we may use this sensor in tandem with a capacitive proximity sensor to provide context-awareness as construction around a pour proceeds. The operational principle of a capacitive proximity sensor is based on the change of a capacitance in an RLC resonant circuit. This leads to changes in the resonant frequency of the RLC circuit. It is first required to tune the RLC circuit to the area of resonance. At the resonant frequency, the impedance of the RLC circuit is at a maximum. A programmable frequency sweep and tuning capability of the VNA will be used to estimate the change in resonance frequency as the magnetic fields associated with rebar in an adjacent pour is introduced, and the extent of deviation can be characterized. This information can be used to provide context awareness around the pour.

Another example of usage of the MAIS device is to generate continuous structural evaluation reports and to evaluate conditions such as aging, corrosion of critical structures such as in bridges, or internal corrosion such as in rebar. This damage, if left unattended, may lead to premature failure requiring expensive repairs and/or replacement. MAIS is cheaper, less time consuming, and can be deployed where other traditional methods are impossible.

### Conclusion

MAIS offers a significant advantage over and above traditional methods. We have demonstrated several embodiments of MAIS, namely for the electromagnetic wave impedance, electrochemical impedance, and electromechanical impedance domains, and also touched on other couplings, such as (without limitation) electro-thermal, electro-elastic, or opto-mechanical techniques. We have also shown how the generalized use of frames, a key feature of some of the system's embodiments, can be used to enhance resonance modes, and novel types of field couplings can be employed for novel advanced material characteristics.

### Measuring Scattering Coefficients to Determine Material Properties: a Key Method in Wave-Based Sensing

In this section, we describe how various configurations of wave-based actuating and sensing devices are used to measure transmission and reflection coefficients in the material of interest (or a coupled medium), and how these can be used to determine characteristics of the material.

There are various names given to the reflection and transmission coefficients of transmission systems. Sometimes these are referred to as scattering parameters (S-parameters), or transmission parameters (T-parameters), wherein the naming convention used depends only upon the relative ordering of the signals in the mathematical formalism (and thus the S- and T-parameters being nothing more than naming conventions, characterizing the same system). Because S- and T-parameters define the reflection and transmission of complex wave amplitudes of equivalent units, the parameters themselves are unitless.

However, sometimes (particularly in electrical circuits) the transmission and reflection parameters are between wave amplitudes of differing units. For example, the input wave may be an oscillating current, and the output wave may be an oscillating voltage. In such cases the transmission and reflectance parameters will have units of impedance or of admittance. The use of S parameters (and their analogue) for material characterization (in particular, materials such as concrete, that evolve over time through chemical reactions), using wave-based sensor devices is a particularly novel and advantageous embodiment for characterization of the material properties. Conventional sensor systems, if any, fail to fully characterize or identify building materials (e.g., concrete or the like), particularly as related to their time-evolving material properties. As such, the systems and methods of the present disclosure, may present a novel embodiment for the following (non-exhaustive):
(1) The characterization and determination of building materials such as concrete, and in particular characterization and determination of such materials' time evolving properties, such as curing related properties, as well as other properties associated with non-linear effects of concrete;
(2) The novel integration of S-parameter measurements techniques onto small ultra-low power devices, which may be embedded or surface mounted on concrete;
(3) The application of S-parameter measurement techniques across varying types of wave-based sensing devices, including mechanical wave-based sensor devices (e.g. coupled electro-mechanically, opto-mechanically, magneto-mechanically etc.), E&M wave-based sensor devices (low, mid and high frequency), thermal wave-based sensing devices and others.

In what follows, we will discuss the formalism and methods by which scattering parameters are determined for the transmission of general waves through a medium (where that medium is in this case a material we wish to characterize); and where those waves might be electromagnetic or mechanical (e.g. acoustic/elastic) in nature. Whilst the techniques characterization of signal flow graph networks via transmission and reflection coefficients are described in the context of S parameters, all following techniques apply generally to the characterization of T-parameters, or of impedance coefficients, or of admittance coefficients, or of any coefficient that maps a measurable aspect of a transmitted wave amplitude to any other aspect of a propagated wave amplitude. We will refer back to this generalizability in more detail later.

### The Signal Flow Graph as a General Representation of any Set of Wave Interactions

In general, it is possible to represent any set of input and output signals, for any arbitrary system, as a signal flow graph. In such a formalism, the parameters that define the transmission and reflection coefficients are sometimes referred to as “scattering parameters” or S-parameters. As has been discussed herein, there are special cases in which the generalized scattering parameter is referred to under other terms (such as Transmission parameters, or T-parameters, referred to when the system in question is 2-port network of an arbitrary number of 2-port cells in a chain). There are also cases in which we may wish to know the “impedance” of the signals in question, whereby the impedance can only be calculated as a generally nonlinear function of the scattering parameters. Sometimes, when scattering parameters are converted into representative wave or signal impedance values, the graph that represents the port network in question is reduced, using the Mason rules of signal flow graph theory.

### Scattering Coefficients as Generally Linear or Nonlinear

Scattering coefficients (or scattering parameters) are often the name given to linear signal transmission systems, whereby the signals are characterized by transmission through a linear channel. A linear medium is one in which the scattering coefficients are not functions of the signals themselves (i.e. a scattering parameter, once known, never changes-regardless of the amplitude, phase or power flowing through any part of the medium). Not all systems are linear, and the inventor's methods and devices can also model nonlinear scattering (as mentioned above). In nonlinear systems, the scattering parameters are themselves also some function of the input or output signals flowing into or out of a given cell in the network. From Mason rules of signal flow graph theory, we derive that N-port linearized signal flow systems can be reduced to a 2-port nonlinear signal flow system, wherein the new scattering parameters are functions of both the linear scattering parameters and the intermediate signals in the original N-port graph.

### Antenna Transmitters and Receivers as Generalizable to all Wave Types

In what follows we will be using antennas to describe transmission and reception of electromagnetic waves. However, in all cases wherein we refer to antennas, we are able to replace those with generalized wave-based actuation and receiver devices, whereby the transmitter might be replaced with a driven mechanical actuator (in the case of the generation of a mechanical wave) and the receiver might be replaced by a passive mechanical sensor (in the case of a mechanical signal recorder). Likewise for other transmission and receiver systems, such as for visible light, wherein that transmitter might be a LASER, and the receiver might be a photonic diode. For waves that do not typically propagate in the medium under consideration, waveguides made of materials that do interact with the medium under consideration may be embedded and coupled into the medium under consideration, for which S parameters can be sensed.

### A 2-Port Scattering System as an Illustration of Material Measurement Systems

In what follows, the mathematical representation of a 2-port signal flow graph is illustrated as shown in FIG. 5J, wherein the signals are generally complex wave amplitudes, therefore representing any electromagnetic, mechanical-wave or electric transmission (where it is possible to take electrical transmission to be represented as real valued signals or scattering parameters if we wish, without loss of generality in the formalism).

Consider the following diagram, which represents a 2-port cell in a signal flow graph. The signals going into the cell are denoted by aⱼ, and the signals going out from the cell are denoted by bⱼ, where j denotes the j-th port in the system.

In general, the aⱼ and bⱼ are complex wave amplitudes, such that one might represent the input wave in the general functional form:

$${α}_{j} = {α}_{j} exp ( - i ω t ) ,$$

where i is the imaginary unit, ω is the frequency of the signal, t, denotes the time relative to an arbitrary null time (where t=0) and αⱼ is a real number that denotes the amplitude of the signal at the time t=0.

Whilst aⱼ is the complex amplitude, the product of aⱼ with its complex conjugate.

$${a}_{j}^{*}$$

is equivalent to the power transmitted into the system through the j-th port, such that

$${p}_{j} = {a}_{j} {a}_{j}^{*} = {α}^{2} .$$

where pⱼ is the power entering the cell through port j. The power exiting the cell through port j is given by

$${p}_{j}^{′} = {b}_{j} {b}_{j}^{*}$$

such that we can denote the net power passing through port j as

$${P}_{j} = {p}_{j} - {p}_{j}^{′} .$$

The above wave signals may be represented by a matrix multiplication of scattering signals, such that

$$[ \begin{matrix}{b}_{1} \\ {b}_{2}\end{matrix} ] = [ \begin{matrix}{s}_{11} & {s}_{12} \\ {s}_{21} & {s}_{22}\end{matrix} ] [ \begin{matrix}{a}_{1} \\ {a}_{2}\end{matrix} ] ,$$

and where we will henceforth reduce the above to the simplified linear algebra notation,

$$\underline{b} = S \underline{a} ,$$

where S denotes an (n×n) scattering matrix, such that the matrix element Sⱼₘ defines the signal scattering parameter from the ingoing signal at port m to the outgoing signal at port j, and where both j and m are permitted to take any port value. The scattering parameter Sⱼₘ is in general a complex number (having real and imaginary components). Thus, the system that is defined by the scattering matrix is one that is capable of amplifying, attenuating or delaying any signal that may pass through a given channel between the ports.

In the device embodiments and methods disclosed herein, we use devices that generate electromagnetic or mechanical wave-based signals at varying frequencies, in order to excite and characterize the response of the material that acts as the medium through which we transmit those signals, or from which those signals are reflected.

### An Example of the 2-Port Scattering System as a Tool for Concrete Measurements

One embodiment may comprise the situation in which an electromagnetic wave transmitter and receiver is placed atop a cubic slab of concrete. In this example, the transmitter is directional, and a beamforming waveguide on the device ensures that the majority of the power from the signal enters into the concrete beneath it, and within a narrow angular field. This embodiment may further comprise an electromagnetic wave receiver on the other side of the concrete slab, directly below the transmitter, with an equivalently narrow receiving field, and which is pointed at the transmitting antenna above it. The receiver in this example does not transmit signals but receives the (generally attenuated) transmission from the other antenna atop the slab.

In this situation, we might model the system as an electromagnetically coupled 2-port network, as illustrated in the diagram above, wherein the antenna that transmits and receives is denoted by port 1, and the antenna that receives the signal that has passed through the concrete is denoted by port 2. In this example, we would represent the complex amplitude of the transmitted signal by a₁, and the received signal at that same transmitter as b₁. The receiving-only antenna on the bottom side of the slab would not have a transmission amplitude, and a₂=0. Thus, all of the complex wave amplitude measured at the receiving-only antenna would be representative of b₂.

The scattering matrix, S, in the above example is representative of the medium from which the waves reflect and through which the signals propagate (e.g. also known as the ‘host material’ or ‘material under consideration’ or ‘material of interest’). In that sense, any information we gain about the scattering parameters, Sim, informs us about the transmission and reflection properties of the material (in this case, of the concrete slab). In general, we expect the scattering parameters to be dependent upon the frequency of the transmitted signal.

The system as described is adequately constrained such that we are able, by varying the amplitude and phase of the transmitting antenna at port 1, to measure the responding amplitude and phase of the received signal at port 2. Given that a₂=0 in this example, we would expect no measurable reflection to occur at the 2nd port, such that the effective reflection coefficient, S₂₂=0. However, we would expect a reflection to occur at port 1, such that the net power, P₁, would be given by a₁a₁*−b₁b₁*. And, given that no power is transmitted by the second antenna, P₂=b₂ in this example.

Thus, in order to fully characterize the material behavior of the transmission medium (i.e. of the concrete), we would need to solve for S₁₁, S₁₂, and S₂₁ as a function of frequency. Solving for these 3 degrees of freedom would require a minimum of 3 independent constraints. Given that we know a₁ (the transmitted complex amplitude, generated by the device we control) and that we know b₂ (the net power measured at the receiving-only antenna), and that we also know P₁=a₁a₁*−b₁b₁* (by measuring the net power at the transmitting antenna), we are in possession of a sufficient amount of information to constrain the 3 necessary degrees of freedom. Thus, in this example, two antennas (one placed above and one below a concrete slab) can be used to fully characterize the scattering parameters that represent the material and device configuration.

### Multi-Port Generalizations of Transmission and Reflectance Measurements

It is also a particularly valuable extension that (via the Mason rules on the signal flow graph) we are able to fully characterize the frequency-dependent scattering transmission and reflectance coefficients from any set of scattering parameters. In this case, the Sⱼⱼ denote the reflectance values, and the Sⱼₘ denote the complex transmission of the system described in the above example. However, in general, for any multi-port multi-celled network, the Mason rules can be used to convert that flow network into a single-celled 2-port equivalent, wherein the same scattering parameters,

$${S}_{jj}^{′} and {S}_{jm}^{′}$$

of the simplified 2-port network would identically represent the reflectance and transmission of the system (and where we have used the prime notation to denote that the new scattering parameters have been derived from the original, multi-port system). Once we know the 2-port scattering parameters (which are unitless quantities), the impedance of the material can be determined by scaling the impedance in a free medium (i.e. in the air outside of the concrete) by a function of those scattering parameters. We will also later discuss how impedance can be solved for directly using the same measurement and mathematical formalism described here.

### Generalizing Scattering Parameters to Nonlinear Systems

When a multi-port linear scattering system has been transformed via Mason rules into a 2-port, single-cell (as described in the above example), the new 2-port scattering parameters

$${S}_{jj}^{′} and {S}_{jm}^{′}$$

become generally nonlinear. This means that the scattering parameters would be complex functions of the original scattering parameters, and the intermediate signals of the signal flow graph. We might represent these new parameters as

$${S}_{jm}^{′} = f ( S , {a}_{kl} , {b}_{kl} ) ∀ k , l ∈ \{ 1 , N \} ,$$

for an N-port system, and where j and m can take any port value.

### The 2-Port Device Configuration as Extendable to any Device Configuration

It is easy to see how a 2-port device configuration can be extended to any device configuration (i.e. multi-port system) wherein the devices need not be exclusively internal or external to the concrete, but can be a mixture of both, and wherein the number of transmitters/receivers has no upper limit.

Examples of Device Configurations that are Representative of 2- or N-Port Systems

### Some Examples of 2-Port Scattering Measurements

Some non-exhaustive instantiations of other 2-port systems (which involve two antennas that generally transmit and receive signals at any set of frequencies, including in one embodiment, from RF to microwave to terahertz) are:
(1) A system for which a transmitting antenna is placed inside a void (or air cavity) within the concrete, and the scattering and reflectance parameters are measured relative to the antenna itself and one other antenna external to the void.
(2) A system for which a transmitting antenna is placed inside the concrete, and the scattering and reflectance parameters are measured relative to another antenna embedded elsewhere within the concrete.
(3) A system for which a transmitting-only antenna (which cannot receive signals) is placed on top of the concrete, and a receiving only antenna (which cannot transmit signals) is placed adjacent to the transmitting antenna, such that port 1 and port 2 are spatially adjacent at the same location atop the concrete element, thus making b₁=0 and a₂=0.

### Some Examples of N-Port Scattering Measurements

A general device configuration can be a system for which any number of transmitting/receiving antennas (for example, able to transmit and/or receive at any set of frequencies over the range from RF to microwave to terahertz) are placed throughout the interior and exterior of the concrete. Depending upon the precise location of those antennas, the directed signal flow graph is constructed (as was illustrated previously) by obtaining precise knowledge of the exact beamforming direction of the transmitted and received signals.

### Time Measurement as a Crucial Factor in Solving Scattering Systems

It is implicit throughout this document that all devices possess an accurate means of associating a timestamp or other measure of time with every sensor measurement that is recorded (including capabilities for time synchronization across devices, as discussed elsewhere already). By virtue of timestamping, all amplitude and power measurements are generally recorded by the system as time-series, and all of those time-series can be aligned such that the response of the material or antenna can be characterized via precise measurements of signal delays and interference phenomena, as well as precise measurements of signal magnitudes.

### The Example of Ground-Penetrating Radar (GPR) as a Scattering Problem

Specific embodiments of GPR wave-based sensor devices as a means of determining material properties is discussed later. Here we discuss the mathematical formalism for it. A 2-port scattering system has also been shown to model a two-antenna system. Let us consider once more a system where one antenna transmits and receives signals at various frequencies, and the other antenna receives (and does not transmit) signals at those same frequencies.

However, unlike the first example (where both antennas were on opposite sides of the concrete slab), another case is now considered for which two antennas exist spatially adjacent to one another, and in which both sit on the surface of a concrete element. In one embodiment, this is exactly the device configuration required by GPR. In most instantiations of this configuration of GPR, the transmitting and receiving antennas would be beamformed such that their angular field would be narrowed (minimizing noise from stray external signals), and each antenna would be pointed into the concrete at an angle wherein the expected reflection of the transmitted signal off of the back of the concrete element would lead to a maximal signal at the receiving antenna.

As has been mentioned previously, the scattering parameters of the matrix, S, are generally complex (real and imaginary) values. Let us rewrite the scattering parameter Sⱼₘ as

$${S}_{j m} = {β}_{j m} exp ( - ikl ) ,$$

where the value βⱼₘ is the attenuation factor for a signal travelling from port m to port j, k is the wavenumber of the of transmitted signal (i.e. the inverse of its wavelength), l is the distance travelled by the wave between port m and port j, and i is the imaginary unit. Using the scattering matrix formalism written previously, it is shown that we obtain two net powers, P₁ and P₂, whereby

$${P}_{1} = {a}_{1} {a}_{1}^{*} - {b}_{1} {b}_{1}^{*} , and$$

$${P}_{2} = {b}_{2} {b}_{2}^{*} .$$

Using the above explicit formalism for S₂₁, and allowing for the reflectance, S₁₁, to be a real quantity (which is reasonable for a linearized medium), we can see that

$${b}_{1} = {S}_{11} {a}_{1} = {β}_{11} {a}_{1} , and$$

$${b}_{2} = {S}_{21} {a}_{2} = {β}_{21} exp ( - ikl ) .$$

Let us now take the power of the signals at each port, where therefore

$${b}_{1} {b}_{1}^{*} = {β}_{11}^{2} {a}_{1} {a}_{1}^{*} , and$$

$${b}_{2} {b}_{2}^{*} = {β}_{21}^{2} {a}_{1} {a}_{1}^{*} .$$

The above two relations thus give the following two simultaneous equations:

$${b}_{1} {b}_{1}^{*} + {b}_{2} {b}_{2}^{*} = ( {β}_{11}^{2} + {β}_{21}^{2} ) {a}_{1} {a}_{1}^{*} ,$$

$${b}_{1} {b}_{1}^{*} - {b}_{2} {b}_{2}^{*} = ( {β}_{11}^{2} - {β}_{21}^{2} ) {a}_{1} {a}_{1}^{*} .$$

By substituting for the value β₁₁, the variables can be rearranged to obtain,

$${β}_{21}^{2} = \frac{{b}_{2} {b}_{2}^{*}}{{a}_{1} {a}_{1}^{*}} .$$

Similarly, by substituting for the value of β₂₁, the variables can be rearranged to give.

$${β}_{11}^{2} = \frac{{b}_{1} {b}_{1}^{*}}{{a}_{1} {a}_{1}^{*}} .$$

We thus demonstrate that the GPR device configuration described herein can be used to calculate the reflectance, β₁₁, and the attenuation, β₂₁, using only the ratios of the powers travelling into and out of the two ports (i.e. at into and out of each antenna).

Thus, the scattering parameters, S₁₁=β₁₁ and S₂₁=β₂₁ exp(−ikl) are solved, and we are able to precisely model the frequency (or identically, the wavenumber) dependent impedance spectrum of the system (which is a function of the scattering parameters).

### Wave Propagation Time-Delay as a Means for Material Characterization

In addition to the power-based scattering parameter determination described above, it is also possible to determine material properties of the medium via measurements of temporal delay between transmitted and received signals (whereby those signals traverse a known distance, l, through the medium).

For example, consider the device configuration in which two antennas (one transmitting antenna and one receiving antenna) is placed atop a concrete element, and a parabolic mirror is embedded below the antenna, within the concrete. The parabolic mirror is designed to optimally reflect the transmitted range of frequencies, and to be minimally lossy.

In this case, the system is represented by 2-port signal flow problem, wherein the mirror sits effectively at a distance of, l/2, from the transmitting and receiving antenna.

The received signal, b, (which is reflected from the parabolic mirror) is given by:

$$b = a β exp [ i ( k l - ω t ) ] ,$$

where k is the wavenumber of a (the transmission signal), ω is the frequency of the transmitted signal, t is the recorded time since an arbitrary time of t=0, and β is the attenuation factor of the concrete element.

We have already shown how the value of β can be found by taking the ratio of the received power, bb*, and transmitted power, aa*, and that the inverse ratio gives us the reflectance parameter. But another quantity that we wish to measure is the velocity of the wave within the concrete. The velocity is given by the relation

$$v = \frac{ω}{k} ,$$

and we can see that the velocity is, in general, a function of the transmission frequency of the signal. Thus, in order to fully characterize the velocity of a wave propagating in the concrete, we must measure the functional relationship between ω and k. In the trivial case, if the two are linearly proportional to one another, the velocity, v, does not change, and is therefore frequency independent. However, most materials experience frequency-dependent wavenumber values that can change depending on various aspects of the medium (from the chemical composition, to the geometric shape and physical boundaries of the element). When a medium imparts a nonlinear dependence between a propagating wave frequency and wavenumber, this is often called dispersion, and the functional relationship(s) of this kind are called dispersion relations. The gradient of a dispersion relation is equivalent to the speed, v, of the wave at that frequency.

Looking at the equation for b shown above, it can be seen that all of the parameters are known quantities in device configuration: wherein we know the transmitted frequency, ω the time, t, of all measured signals, the distance, l, of traverse by the wave, and the attenuation factor, β (through measurements of power ratios at any given time). We also know a, the amplitude of the signal that is generated by the transmitting antenna. Thus, we solve for k, and construct the dispersion relationship of the medium (and hence the speed of the wave in the medium).

Given that the determination of the dispersion relations are dependent upon accurate timing measurements, it is clear that timing (and time delay) is a fundamental measurement mode of material characterization (with reference to the time synchronization section for device arrays). And, by knowing the dispersion relationships of the material, it is possible to determine physico-chemical characteristics of the medium.

### Amplitude/Power Resonance as a Means for Material Characterization

It is also possible to use frames in resonator configurations (e.g. through cavities and/or waveguides and/or other frames) for the purpose of determining material properties, whereby we construct a device configuration that sets up standing waves inside a medium, such that resonant peaks occur for various frequencies across the transmitted spectrum. By measuring the frequencies at which those resonant peaks occur, we are able to determine the speed of sound in the medium. Other vibrational or mechanical resonances can also be exploited to generate resonance modes (which, as already described elsewhere, are not necessarily based on standing waves).

Consider the device configuration in which a single transmitting and receiving antenna is placed on the end of a cylindrical enclosure. The enclosure is filled with concrete, and the antenna transmission signal is directed towards the opposite end of the cylindrical container. The power received from the reflected wave interferes with the power transmitted by the antenna (wherein the reflection occurs at the boundary between the opposite end of the cylinder and the surrounding air). By sweeping the signal over a range of frequencies, w, we are able to characterise the total power spectrum (wherein the total power will be defined by the constructive and destructive interference due to the reflected wave in the medium).

To calculate the n-th resonant frequency, @n, of the cylindrical cavity described above, we execute the following logic.
(1) The Occurrence of Resonance in the Cylindrical Frame (1.1) In the cylindrical frame, resonance occurs when the length of the frame, l, supports standing wave patterns. These standing waves are formed due to the constructive and destructive interference of the waves reflecting back and forth inside the cavity. (1.2) The condition for resonance is that the length of the frame must be an integer multiple of half the wavelength, λ, of the wave. Mathematically, this condition is expressed as: l=nλ/2, where n is an integer (1, 2, 3, . . . ), representing the n-th resonant peak. (2) Relationship Between Frequency, Wavelength, and Speed: The speed, v, of the wave is related to its frequency, ω, and wavelength, λ, by the equation: v=ωλ. (3) Wavenumber: The wavenumber, k, is related to the wavelength by: k=1/λ. Combining these relationships, we find the resonant frequencies, ωₙ, and the corresponding wavenumber, k, for each mode, n: (4) Finding Resonant Frequencies ωₙ Using l=nλ/2 and v=ωλ, we get l=nv/2ω and so ωₙ=nv/2l. Here, ωₙ varies with n, giving the different resonant frequencies for different resonant modes. (5) Finding Wavenumber at Each Resonant Frequency: We know that k=ω/v; Substituting ωᵢ=nv/2l into the above equation gives: kₙ=n/2l. Thus, in order to find the wavenumber at each resonant frequency, we first measure the resonant frequency empirically by analyzing the total power spectrum of the antenna, and by finding the frequencies at which resonant peaks occur. Using the measured w; for different values of n, we then find k for each ωᵢ using kₙ=n/2l. This provides us with the wavenumber, kₙ, of the n-th mode.

Via the device configuration above, and the subsequent measurement procedure, we are able to characterize the dispersion of the material (e.g. concrete) within the frame, for each of the resonant frequency modes.

This example is the case for a frame in the geometry of a hollow cylinder filled with concrete, however it can be generalized to any frame of any geometry, within which, or on the surface of which, resonance can occur.

### Using Measures of Dispersion to Characterize Contextual Material Properties in Real-Time

As concrete cures, many of its material properties change over time (we call these properties contextual material properties). With the methods described above, we are able to characterize the manner in which those material properties change over time; by measuring changes in the functional relationship between frequency and wavenumber. These changes directly inform us about the velocity spectrum of the medium, thus informing us about various other physico-chemical attributes of the material (such as its dielectric constant, in the case of electromagnetic transmission).

In the case of the time-delay based dispersion measures, we will find that the wavenumber mapping to each frequency will change as the contextual material properties change. Likewise, in the case of the resonant frequency-based dispersion measure, we find that, though the wavenumber, kₙ, is a known quantity for each mode (given the length of the resonant cavity), the frequency of the n resonant modes will change over time, thus changing the resonant velocities in the material.

### Other Embodiments for Measuring Dispersion Relations

There are other embodiments through which we can measure the dispersion relation of propagating waves. One non-exhaustive example is the use of pulsed (or chirped) signals, whereby a transmitter sends a periodically modulated wave, such that the signal effectively turns “on and off” at a chosen periodic frequency. This pulse frequency is independent of the frequency of the propagating wave itself (i.e. the two frequencies are independently chosen by the operation of the transmitter).

We thus use these pulsed signals to measure the velocity of waves in media, whereby velocity is determined by timing delays. As opposed to the interferometric methods described above (wherein signal power and constructive/destructive interference was used to determine frequency and wavenumber), pulsed signals are able to measure velocity directly (without the need for determining wavenumber at all). By knowing the distance traversed by the pulsed wave, we measure the precise transmission time, t₀, and arrival time, t₁, of the transmitted and received wavefronts of a pulse. We then calculate the time-of-flight, Δt=t₁−t₀. If the distance traversed by the pulsed wave is δ, then the velocity is thus given by v=δ/Δt.

In the same manner as for other methods by which we determine v, pulsed signals can be used to determine the time-varying velocity of the chosen propagating wave, whereby we can track the change of contextual material properties using only the transmission and reception of electromagnetic, mechanical or acoustic waves. Some non-exhaustive explicit examples of signals used for the purposes of pulsed velocity measures are: Visible light (e.g. in optical waveguides bonded to the concrete); Radar; Microwaves; Mechanical, acoustic or elastic waves; LIDAR; Near- or Far-Infrared; Ultraviolet.

### Arrays of Transmitter and Receivers for Use in Material and Spatial Tomography

In one instantiation of this invention, we are able to place arrays of transmitting and receiving antennas on the surface of a concrete element of arbitrary geometry (distributed in arbitrary ways around the exterior). Or, in another instantiation, we also place transmitters and receivers dispersed throughout the interior of the concrete.

Once these 3-dimensional arrays are placed on top of, and/or are embedded within, the material, we are then able to sweep transmission signals over a broad range of transmission frequencies, and to record the spectra induced by those propagating waves at the receivers throughout the 3D array. By recording those responses, and by using the principles described herein, we are able to calculate the scattering parameters of a general N-port network that describes the response of the system at all relevant transmission frequencies (i.e. we obtain the frequency-dependent scattering coefficients). One might call this initial procedure a “calibration” step, whereby we characterize the transmission and reflectance properties of the material relative to our array.

Once the scattering parameters have been determined, we then generate varying signals or mixed frequency and temporal phase differences, and we record the response of those signals at the receiving antennas. By varying the transmission frequencies and phases through a large enough range of values, we are able to use the scattering parameters to solve for the inverse problem—whereby we calculate the internal signals that must exist within and throughout the 3D concrete element, at each moment in time. By solving this inverse problem, we are able to construct a 3D representation of the internal structure of the concrete, wherein various voids and inclusions can be discovered. Some non-exhaustive aspects of the internal structure that can be determined in this way are: Low or high density cavities; Regions of varying chemical composition; Regions of varying mechanical properties; Regions of varying electro-chemical inductance. In general, this technique is analogous to tomography, and whereby we use the known scattering system to probe the 3D internal structure of the medium via complex, spatially and temporally modulated signals.

### Generalization of Scattering to Transfer, Impedance and Admittance Parameters

The wave-based measurement methods described herein for the characterization of scattering parameters are applicable to all forms of transmission and reflectance coefficients, whether the coefficients have units or are unitless. For illustrative purposes, we will discuss the manner in which scattering parameters (S-Parameters) differ from transfer parameters (T-Parameters), and how coefficients with units can be found which represent the impedance or the admittance of the system.

### Transfer Parameters (T-Parameters)

Transfer parameters are unitless (as are scattering parameters). The only difference between scattering and transfer parameters is that transfer parameters define the transmission from one port to another as opposed to the mapping between ingoing to outgoing waves into a cell (see matrix below):

$$[ \begin{matrix}{a}_{1} \\ {b}_{1}\end{matrix} ] = [ \begin{matrix}{T}_{11} & {T}_{12} \\ {T}_{21} & {T}_{22}\end{matrix} ] [ \begin{matrix}{a}_{2} \\ {b}_{2}\end{matrix} ] .$$

We see that the above equation differs only from the original scattering parameter formalism discussed previously by a reordering of the wave-amplitude parameters between the solved and input vector of the signal flow system.

Due to the fact that transfer coefficients map between ports, and that ports are composed of only two wave amplitudes (one in-going and one out-going), it follows that transfer coefficients are an inherently 2-port mapping. In general, scattering parameters have no such limitation (being able to map any number of ingoing to any number of outgoing wave amplitudes), and are generally preferable representations for multi-port configurations.

### Impedance Parameters

Impedance parameters describe the complex (i.e. real and imaginary) reflectance and transmission coefficients from in-going currents to out-going voltages. There is no distinction in the ordering of the in- and out-going waves when compared with the S-parameter formalism. The only difference is that the impedance values map two wave complex wave amplitudes of differing units, and therefore the impedance values themselves have units (of voltage per unit current).

$$[ \begin{matrix}{V}_{1} \\ {V}_{2}\end{matrix} ] = [ \begin{matrix}{Z}_{11} & {Z}_{12} \\ {Z}_{21} & {Z}_{22}\end{matrix} ] [ \begin{matrix}{I}_{1} \\ {I}_{2}\end{matrix} ]$$

### Admittance Parameters

The same principle applies to admittance parameters, wherein the reflectance and transmission coefficient map in-going voltage to out-going current. The only distinction between admittance and impedance is that the current and voltage have been interchanged as in-going and out-going quantities, and the units of admittance are therefore the inverse of impedance (current per unit voltage).

$$[ \begin{matrix}{I}_{1} \\ {I}_{2}\end{matrix} ] = [ \begin{matrix}{Y}_{11} & {Y}_{12} \\ {Y}_{21} & {Y}_{22}\end{matrix} ] [ \begin{matrix}{V}_{1} \\ {V}_{2}\end{matrix} ]$$

### Other Parameters

From the above, it should be clear that the method described herein for the measurement of scattering parameters applies any and all calculations of generalized complex reflectance or transmission coefficients, with no loss of generality, regardless of the choice of units in the in-going or out-going waves (i.e. the choice of what we choose to measure in going into, or out of, any given system).

Counter-Propagating Waves in 2-Port Systems and the Analogy with a Vector Network Analyzer (VNA)

In what has been discussed thus far, we have emphasized the use of one input wave for the purposes of measuring the properties of a material. Specifically, we have described 2-port or multi-port device configurations, wherein we transmit one propagating wave (over a range of frequencies) and measure the response of the system to that single transmitted wave.

However, a 2-port system permits up to two oppositely propagating waves to be transmitted into the system simultaneously (in the aforementioned signal-flow diagram, these are defined by the a₁ and a₂ wave amplitudes). In the case wherein we are able to choose the frequency, phase and amplitude of the two opposing waves, it is clear that we open up a fundamentally different way in which we can use wave interferometry to measure the impact that the material properties have on the transmission and reflectance coefficients. In other words, the superposition of the oppositely travelling waves (measured at one or both of the ports) also inform us about the scattering parameters of the material.

The use of two oppositely propagating waves (of generally different frequency and phase) in order to characterize the scattering parameters of 2-port or multi-port system is analogous to the manner in which a Vector Network Analyzer (VNA) operates, but innovatively applied to characterizing material properties such as the time-evolution of concrete compressive strength, water to cement ratio and other parameters related to curing. This can be done through various wave-based sensor embodiments. As such, the configuration mentioned above can be referenced as a VNA-type mode of operation, and all of the previously described embodiments of device configurations can be operated as distributed VNA systems whenever two or more input signals are propagated through the material. The term “distributed” is used in this case to reference the fact that the transmitting and receiving antennas need not be spatially near to each other and can even be a mixture of embedded and external to the material being characterized.

The Reduction of the VNA System into an On-Chip VNA Invention

Although the above experiments can be operated as distributed VNA systems (wherein the scattering parameters, amplitudes and phases of multi-propagating waves are measured), we are also able to localize the transmitters and receivers onto a small form-factor embeddable mounted device. Optionally, in another embodiment, the device is surface-mounted, and enables reusability.

Another particularly novel aspect of this invention is the use of CMUT or piezo-electric transducers on small form factor chipsets, wherein those CMUT or piezo-electric transducers are able to convert electric current or potentials into mechanical oscillations (transmission mode), or to convert mechanical oscillations into electric current and/or potentials (receiving mode). By allowing those small piezo-electric transducers to sit either-side, or side-by-side, on a small volume of curing concrete, we are able to create a mechanical, embeddable, low-power VNA—which automatically performs all measurements described herein for the purposes of calculating the scattering parameters of the concrete (or any other material).

By replacing these piezo-electric transducers with small form-factor on-chip electromagnetic transmission and receiving antennas, we are also able to create an on-chip electromagnetic VNA.

These mechanical and electromagnetic on-chip VNA devices are particularly advantageous instantiations of the invention regarding the characterization of material properties from the automated measurement of scattering parameters. In the same manner that our distributed VNA systems are able to act as mechanical and/or electromagnetic 2-port or multi-port systems, these on-chip VNA devices can also be trivially expanded to include multiple CMUT/piezo-electric transducers or electromagnetic antennas, in any configurations (creating multi-port, on-chip VNA systems).

### Physical Embodiment of the On-Chip Electromagnetic and Mechanical VNA Invention

Below we describe some functional components of the physical embodiment of the on-chip VNA invention, along some non-exhaustive applications in material characterization, and some non-exhaustive benefits of those use-cases.

Signal Generation Unit: Generates a range of frequencies suitable for the material or process under test. This unit can adapt to different frequency requirements for diverse materials. Signal Detection and Analysis Unit: Measures the reflected and transmitted signals (e.g. through the zero crossing method). This unit is equipped with advanced signal processing capabilities to accurately determine S-parameters. Interface Ports: Includes multiple ports for connecting to different types of sensor arrays, such as antenna arrays or CMUT transducer arrays. These ports are adaptable to measure S-parameters in different configurations. Sensor Arrays: When connected to an array of antennas or piezoelectric sensors, the device can characterize the array's performance. This is crucial in applications like structural health monitoring, where the integrity of materials is continuously assessed. Portability: The device's compact size, ultra-low-power consumption and battery operation allow for easy transportation and use in various locations, and wireless communication makes data easily available. Precision: Advanced signal processing ensures accurate measurement of S-parameters, essential for reliable material characterization.

Dealing with Concrete Inhomogeneities and On-Chip VNA Devices

Concrete is a fundamentally inhomogeneous material, possessing multiple material irregularities on the small scale. When characterizing the scattering parameters (and hence, the material properties) of concrete via small scale, on-chip VNA devices, it is not generally expected that those parameters will be representative of the material at all locations, or of the material on average. This is particularly true when the wavelengths of the electromagnetic or mechanical waves used to probe the material are on the order of the size of average impurity size (for example, the average particle size of the aggregate).

Various techniques are employed to manage the impact of inhomogeneities (including so called ‘aggregate interference’), which includes the use of advanced signal processing for the purposes of characterizing the impact of aggregates or other impurities on the measured material properties. These techniques typically involve spectral analysis, whereby we use wave-based sensing of a wide-band frequency range in order to detect and remove the effect of inhomogeneities on our measured quantities. Some examples of signal processing techniques are: Fast Fourier Transforms (FFTs); Wavelet analysis; Principal component analysis; 3D tomography, or Machine learning models. Such are used to differentiate signals reflected from either aggregates or from the cement matrix (as well as the influence of the device enclosure and attachment method on the system, and possibly other materials such as rebar). Another way that we mitigate measured inhomogeneity is via embedding multiple on-chip VNA devices throughout a concrete element, and by taking multiple samples, at multiple locations: the results of which may be categorized separately or combined. Methods such as Mix Fingerprinting may also be employed at the aggregate and cement matrix level individually, from which aggregated compositional properties, and static and contextual material conditions may be determined, for the purposes of predicting the expected material properties, and for comparison against what is measured.

At a physical level, sensor or actuation elements may also be bonded to a larger, passive material, to average out the effects of any inhomogeneities. Alternatively, sensor or actuation elements may be moved so that they are directed at different parts of the concrete. Their output excitation signals may also be moved or processed (e.g. beam-steered through adaptive electromagnetic or mechanical wave manipulation and wave control). This may take the form of mechanical or optical (optionally adaptive or tunable) lenses, mirrors, waveguides, prims, gratings, absorbers, phase shifters, polarizers, etc.

### Concluding Remarks of Scattering Methods

The use of wave-based transmission and measurement devices is a new approach to measuring the material properties of concrete and other building materials. Integral to this approach is the characterization of the scattering parameters of the material with respect to our choice of propagating waves (wherein we might choose any wave-type, from electromagnetic to mechanical, and any range of amplitudes, frequencies or phases).

To that end, this aspect of the invention described how time-varying input or output signals (including waves of different frequencies and/or signal oscillations and/or pulses) are used to measure or infer properties of the materials or chemical reactions taking place in construction materials. This includes the characterization of time- and context-dependent contextual material properties.

Waves and oscillations can be of fixed or varying frequencies, as well as single tones, wide-band (frequency range) emissions, or composed of multiple harmonic or non-harmonic frequencies, depending on the needs of the measurement technique and sensor capabilities.

As described herein, we may use device configuration that are representative of 2-port or multi-port systems, and we may choose to excite those systems with single or multiple wave transmissions. Wherein we choose to operate a device configuration with multiple input waves, we reference that system as a generally distributed VNA analogue. Wherein the input waves exist on an on-chip, small form factor device, embedded within the material, or placed on top of the material, we reference that device as an on-chip VNA.

In addition to the frequency band analysis, wave-based sensing devices also perform spatial analysis through the use of spatial tomography. This technique involves producing and sensing signals from various locations in 3D space within, on or outside the materials under consideration and using wave propagation knowledge to infer distance, material shape, composition or all of the above by means of monitoring direct path signal attenuation, phase change, frequency response as well as the same properties in wave reflections cause by impedance mismatches with the boundary conditions of the material.

In general, the operation of on-chip VNA devices presents the possibility of inhomogeneous materials (such as concrete) being misrepresented by the local information gathered at a single localized volume within a concrete element. With that in mind, we describe procedures by which to mitigate these effects, by using multiple on-chip VNA devices throughout an element, or by utilizing various data analysis techniques for the purposes of decoupling any measurement effects due to localized impurities. We also describe the use of Mix Fingerprinting and predictive modeling in order to mitigate these effects, along with techniques that involve the movement of the transmitting and receiving devices throughout the material (or externally to it).

What has not been explicitly mentioned in this section (but will be discussed in detail in the High-Frequency Wave-Based Sensing section herein) is that, as the frequency of the electromagnetic wave transmissions become high enough, we begin to excite the material on the atomic level, causing a highly nonlinear reaction (in which, for example, the material may melt or vaporize). This operational mode is covered later when we discuss the use of spectroscopic techniques such as those related to LIBS, wherein a plasma is created for the purposes of directly measuring the chemical composition of the material. However, S parameter (or non-linear S parameters) sensing may be employed for high frequency scattering-based techniques.

Overall, this invention uses both broad spectrum and narrow spectrum excitation and or sensing according to the material and energy type used (light, mechanical, etc.). Where relevant, we utilize interferometric (constructive/destructive interference) or pulsed-wave analyses (time-of-flight and time-delay measurements) to characterize the contextual material properties of a given material. Embodiments for the devices used to realize this are discussed in more depth herein.

### Summary: Wave-Based Sensing Techniques and Methods

The techniques outlined here underpin the working of wave based sensors. Thus we envision these devices employ actuators to excite a host material, or a second material which is coupled to the host material. The excitation is typically a time varying signal (which may be an oscillatory signal, or a wave). Wave based devices also employ sensors to measure the response of the host material (directly, or indirectly through the response of the second material, or another material coupled to the host material).

Different types of responses can be measured, namely (non-exhaustively): (1) Amplitude/Intensity/Field Strength/Power or Attenuation Response; (2) Polarization Shift or Response: (3) Frequency Shift or Response; (4) Time-based Response: Phase Shift or Response, Absolute Time of Flight, Response Time & Relaxation Time; (5) Spatial Response: Refraction, Dispersion, Diffraction; (6) Any secondary effect wherein energy is transformed into another form and can be measured (e.g. material expansion). These responses can also be measured over: Multiple positions in space (Spatially distributed excitation & spatial response of each of the above); Multiple input frequencies (excitation at a plurality of frequencies, with response of each of the above measured at each frequency)—also known as ‘spectroscopy’; Combinations of the above—E.g. S parameters & T parameters, Tomography. Particular methods are discussed, include MAIS, a multi-coupling advanced impedance spectroscopy technique, which for the first time, extends impedance spectroscopy to other (non-electrochemical) impedance measures (e.g. electromagnetic wave impedance spectroscopy) and to transducers that employ novel field couplings (e.g. opto-mechanical), as well as scattering parameters and VNA sensing for concrete characterization.

Wave-based sensors are principally focused on two forms of wave or oscillations: mechanical-stress based, and electromagnetic-based. In the next section, we provide more detail on each kind, with particular embodiments for different configurations. We also briefly discuss other wave-based sensors (e.g. thermal wave-based sensing), and then finally we provide various embodiments that combine methods and techniques (including the cube, and so called ‘smart elements’ such as smart rebar or aggregate).

### Mechanical Wave-Based Sensing

### Introduction & General Description

Methods, devices and systems have been designed that utilizes mechanical sensors and/or actuators and/or transducers (so called “mechanical elements”, e.g. a piezoelectric or CMUT transducer) to excite and/or sense a host material “e.g. concrete”. The device (which includes the mechanical element) may be surface mounted on, embedded in or directed at a host material. Its mechanical element may be physically bonded (directly or indirectly) to the material or otherwise coupled (e.g. indirectly coupled, or in some cases wirelessly coupled). Other embodiments wherein the sensor device comprises a moving mechanism, including land movement, water/liquid movement and/or air movement, or movement within a medium or host material, and optionally an intelligent movement engine may also be employed, set to configure the movement of the device, or such a device may be user controlled through wired or wireless communications and an associated controller. This may be applicable for any sensor device disclosed herein, across any section, including but not limited to any type of wave-based sensor device,

The principal goal of our mechanical wave-based devices is the determination of compositional properties, contextual material properties & static material properties, device and material contextual conditions or related characteristics of the host material (e.g. the time evolution of concrete strength or workability of a cementitious mixture as it cures). The measured output may include mechanical displacements and deformations, mechanical wave characteristics in the host material (e.g. mechanical impedance frequency response, acoustic or elastic impedance frequency response or for an N-port system, the S-parameters/S-Matrix & T-Matrix).

The invention considers mechanical wave-based elements that leverage a number of different physical force couplings (as further described below). In some cases these are built from smart materials. These couplings enable sensing, actuation, or both (in some cases, but not always, through a reciprocal phenomenon). In the case where the coupling is a reciprocal phenomenon (e.g. piezoelectric materials, CMUT transducers), then a single element may be used for the characterization of materials. The behavior of a single element is akin to a 1-port system, which means that its impedance can be measured (e.g. if an electro-mechanical coupling is employed, the electric impedance of an electromechanically coupled system will be indicative of the mechanical impedance). In the case where the coupling is not reciprocal and there are multiple elements that carry out actuation and sensing, the system can be analyzed as an N-port system. In some embodiments, an element can both actuate and sense. In other embodiments, different elements are used for actuation and for sensing, which may or may not be spatially collocated, or on the same or distributed across different devices. When sensing and actuation are spatially separated, typically the system involves traveling waves, rather than just oscillations. The signal analysis can then be thought of as the determination of the transfer function for the system.

A mechanical excitation is driven through a host material (e.g. concrete) through one or more actuator elements. The response of the material to those mechanical oscillations is then measured using a sensor element. This may take the form of a frequency response analysis (e.g. impedance spectroscopy), intensity response, time response and so on.

The input signal which excites the actuation element (which may be electrical, photonic etc.) can take a variety of forms, including waveforms such as delta functions, square waves, step functions, sinusoids, or a sequence of custom pulses (constructed from one or multiple oscillatory frequencies). Alternatively, the input may be a frequency sweep (e.g. a chirp, which may include up-chirping or down-chirping). The input signals are applied to the actuator, which then produces mechanical displacements or deformations in the actuating element (through the applicable coupling). This in turn, creates a displacement and deformations of the host material (e.g. concrete).

In one embodiment (e.g. a 1 port system), the output is an mechanical impedance spectrum (e.g. an electromechanical spectrum) which can be used to determine the stiffness and damping properties of the host material (which behaves akin to a second-order system). In another embodiment, (e.g. an N-port system of distributed sensor and actuator elements), S and T parameters (and their analogues) can be measured to understand the frequency response of the system. These measurements can then be used to estimate dynamic modulus of the material (e.g. through extraction of the resonance modes in the mechanical impedance frequency spectrum), which can be correlated back to the static modulus of that material (itself closely related to the compressive strength of the material in given contextual conditions).

Material properties can then be determined through various techniques, including through the use of a machine learning model trained on a pre-existing database of mechanical impedance signals obtained from known material samples and associated compressive strength measurements (e.g. from CMUT transducers embedded in concrete cylinders or cubes, and associated cylinder or cube crushes). Alternatively, physico-chemical models can be used to relate the impedance spectrum to known physical quantities (e.g. stiffness and/or dynamic modulus of the material) and so on. Hybrid methods may be employed (which combine physico-chemical models and machine learning models trained on pre-existing data). Training dataset for machine learning models may be based on physical simulations (e.g. finite element models).

This method, and associated devices represents a step-change and a significant advancement for the non-destructive testing and monitoring of materials such as concrete, providing an unprecedented amount of information on material properties (including its fresh properties) and composition at all stages and ages, including during the curing process, and beyond.

### Coupling Types and Reciprocity

Mechanical Wave-based elements (sensors and actuators) employ couplings into the mechanical domain to sense and actuate. These may or may not be reciprocal. For the avoidance of doubt, ‘actuate’ and an “actuator” is taken to mean an element that can be controlled to apply a force or excite a field of any kind (e.g. through a field coupling).

Generally, there are different types of reciprocity to consider across the smart materials-based elements under consideration:
(1) Direct Energy Conversion Reciprocity: a direct and reversible conversion between two forms of energy, which is the most direct form of reciprocity. E.g. piezoelectric materials convert electrical energy to mechanical energy, and vice versa;
(2) Mutual Influence Reciprocity: the presence of one effect influences another property or effect and vice versa, but it may not be a direct or equivalent energy conversion E.g. MMSAs (magnetic shape memory alloys) can cause a mechanical deformation (magnetic energy converting to mechanical energy). At the same time, a mechanical stress will alter magnetic properties of the MMSA (which can then be measured). The latter effect changes the properties of the MMSA, but does not convert mechanical energy into magnetic energy;
(3) No Reciprocity: The relationship is unidirectional. The two phenomena may still be coupled (e.g. one effect depends on the other), but there is no reciprocal action by one on the other. Elements that fall into this category can act as an actuator or as a sensor, but not both.

Reciprocity may also be symmetrical or asymmetrical, linear or non-linear, dissipative (e.g. temperature or thermal effects, so called ‘confounding effects’) which will also impact the design of our systems. If we make use of smart materials that have no reciprocity, a system of sensors & actuators (with feedback loop) may be composed to rebuild some form of reciprocity in the system.

Here is a list of smart materials that exhibit physical coupling phenomena (non-exhaustive) that are considered as part of this invention and that are actuated or used as sensors. Particular methods, which may be described or instantiated for one smart material, may be applied to another smart material.

Electro-Mechanical Couplings: Piezo-Electric Materials (Actuation & Sensing)—Piezo Patch, Piezo geometries to promote resonance (Ring, Tuning fork), Piezo Composites (Piezo's with frames, Piezo's in cavities); Piezo-Resistive Materials (Sensing); Electrostrictive Materials (Actuation & Sensing); Electrorheological Fluids (Actuation); Ionic Polymer-Metal Composites/IPMCs (Actuation); Capacitive Micromachined Ultrasonic Transducers (Actuating & Sensing).

Magneto-Mechanical Couplings: Magnetoelastic & Magnetostrictive Materials (Actuation & Sensing); Magnetic Shape Memory Alloys/MSMAs (Actuation & Sensing); Magnetorheological Fluids (Actuating).

Magneto-Electro-Mechanical Couplings: Loudspeaker (Actuating & Sensing); Electromagnetic-Acoustic Transducers/EMAT (Actuating & Sensing).

Opto-Mechanical Couplings: Piezo-Optical Materials (Sensing); Photo-Mechanical & Photo-strictive Materials (Actuation)—Azobenzene-Functionalized Polymers, Liquid Crystal Elastomers: Mechano-Luminescent Materials (Sensing)—Piezo-luminescent Materials; Laser induced blasts (Actuation); Combinations of the listed items-Modified Liquid Crystal Elastomers e.g. with fluorophores (Actuation & Sensing).

Thermo-Mechanical Couplings: Shape Memory Alloys (SMAs) (Actuating); Self-Sensing Shape Memory Alloys (Actuating & Sensing).

Miscellaneous: combination of couplings: Shape Memory Polymers (Actuating); Combinations of different mechanical actuation & sensing methods or materials.

The smart materials and techniques above have been labeled to indicate whether they can be used as sensors, actuators or both (in the latter case, some level of reciprocity exists in the element). Likewise, various combinations of sensing and actuating devices can be used from the list above to construct a reciprocal system (even if its individual components are not reciprocal).

Whilst all of the above material types have been considered by the inventors, for brevity, device embodiments for a subset are described below. Namely: (1) Electro-Mechanical, with particular reference to Piezoelectric devices, and CMUT devices; (2) Electro-Magneto-Mechanical Devices; and (3) Photo Mechanical Devices.

The disclosed features are however transferable across sensor, actuator and transducer types. Disclosed features for one particular device or technique type may also be transferable to other devices or technique types.

Generally, devices that employ any of these smart materials for sensing and actuation (optionally through an excitation input signal) are considered as part of this invention. These devices may be mobile/battery powered, communicate wirelessly and be activated and/or attached through any of the methods described herein.

### Additional Detail for Generalized Mechanical Sensor & Actuator

### Boundary Conditions:

The interface between the mechanical transducer and the host material, as well as the host material's interaction with air and rebar, are critical. Likewise, the shape of the active area of the element (sensor/actuator/transducer—e.g. piezo/piezo composite), and any frame or enclosure it may be connected or related to is also key. These boundary conditions, combined with the excitation frequency, may generate specific resonant modes (e.g. standing waves, propagating waves, or other displacements/material deformations). The use of coatings, or adhesives may further influence these boundary conditions, which then may be taken into account in the analysis of any measurements received from the device.

Different shapes and configurations of devices and mechanically active elements & sensors (puck, cube, spherical, triangular, polygonal) may be used, each with specific advantages for different applications. The frame and/or container on or within which the mechanically active element is disposed is also key, to stimulate and enhance resonance modes.

Optionally, the mechanical transducer can be adhered to a larger surface/volume that is made up of a material that promotes bonding with the host material, allowing for a broader volume of influence within the concrete.

### Bonding, Adherence & Coatings:

The mechanical elements and devices may be coated to improve adherence to the host material and prevent leakage. Some examples (without loss of generality) include epoxy resins (great adhesion and chemical resistance in concrete environments), polyurethane coatings (particularly durable and flexible, which would help accommodate the movements of the actuator element during operation), silicone-based coatings, and ceramic coatings.

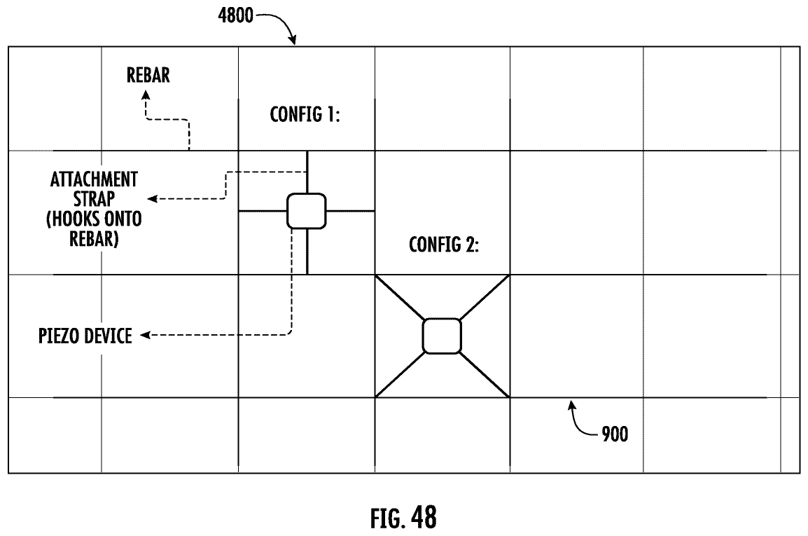

The attachment methodologies described in the general consideration sections may all be employed. Specifically in the context of mechanical wave-based sensing, it is important for the mechanical sensing and actuation elements to not be in contact with rebar, and to ideally be directed away from rebar. With reference to FIG. 48, in one embodiment 4800, the sensing device may be positioned in the center of a rebar grid 900, with a cross-hair like attachment method (so four straps forming a cross that attach the device to the grid formed by perpendicular reinforcement, with the device hanging in the center).

### Considerations for Sensor Installation & Deployment

Several factors are considered here, including: The orientation and position of the sensor, in particular with regards to the concrete's structural features (e.g. position of rebar). In a concrete pour, the sensor device (or at least the volume of consideration for its transducers) needs to be positioned away from any reinforcement, to ensure the concrete is what is being sampled.

Depth of installation: the devices need to be installed deep enough to ensure that there is sufficient volume to sample the material, but not too deep (as there would then be a risk of losing ability to communicate wirelessly over the RF interface with it). In one embodiment, coplanar installation with top rebar is envisaged (through a cross-hair like attachment mechanism described above).

Networked data collection: for tomography applications, the devices would need to be capable of synchronized operation (including time synchronization as described elsewhere in this document), allowing analysis of wave propagation data on a collective basis.

The device would also need knowledge (either preset/pre-determined, or determined by the device itself, for example, through context awareness) of the distance between different sensors/actuators/transducers.

### Excitation Signal:

The host material will be excited at a range of oscillatory frequencies by the actuator, using a number of possible input signals which may take the form of a single sine, a multi-sine sweep, or a pulsed signal etc. In some cases, this will lead to traveling mechanical waves in the medium (in particular at higher frequencies/energy levels). The material properties, frequency range, and the power of the input signal will determine the spatial extent of the sampling volume within the concrete, and ultimately determine which part of the concrete medium most influences the measurements.

### Impedance Sensing & Analysis:

In impedance spectroscopy applications, the real and imaginary parts of mechanical impedance are characterized across the frequency spectrum (amplitude and phase shift) by the sensor element. Once a spectrum, Z, has been built up, key features can be analyzed as the properties of the host material evolves over time (e.g. as concrete cures). Namely, for concrete, these could include:

Changes in the phase (imaginary part of impedance) and magnitude (real part of impedance) as the frequency varies, correlating with the maturing of the concrete.

Resonance frequencies can be identified, which evolve over time as concrete cures, which can be related to physical properties (e.g. the dynamic modulus) and used to determine material characteristics. Machine learning and/or statistical models can also be used to interpret complex patterns in those data, to make determinations about the host material (e.g. composition or property, such as strength or workability of fresh concrete during the curing process). These resonance modes are enhanced in resonator configurations (e.g. waveguides/frames/membranes/cavities etc.).

### S & T Parameters Sensing

In N-port scenarios (where a plurality of actuators and sensor elements are spatially distributed), S and T parameters can be measured (for various frequencies and/or input signal intensities). The frequency response can then be used to determine material characteristics.

### Solutions to Aggregate Interference

Aggregates of larger sizes can lead to inhomogeneity in concrete. This means that a particular mechanical element may be blocked by larger aggregates, which could lead to poor excitation, or inaccurate measurements (reflective of the aggregate properties rather than the concrete composite). Several solutions have been contemplated, including the use of advanced signal processing techniques to differentiate between signals reflected from aggregates and those from the cement matrix.

Another solution includes the use of multiple mechanical elements (e.g. an array), to create a more comprehensive understanding of the concrete's overall properties and mitigating the impact of localized aggregate interference. This may be on a single device, or across multiple devices.

A larger mechanical element or bonding of a mechanical element to a larger passive material (e.g. speaker cone) would ensure a larger area of interest and lower the impact of aggregate size. These could be adapted based on the sizes of aggregates present in a given cementitious mixture.

Particular signal processing and data analysis techniques, such as FFTs or machine learning models may also be employed to mitigate or remove aggregate interference (for example, by classifying signals from an array of mechanical elements).

### Active and Passive Modes of Operation

Wave-based sensing devices under consideration can be used in active mode where the sensor deforms based on input pulses or sweeps and measures the mechanical response of the material. This is key to measure the material property during curing, and deriving insight into the dynamic modulus, static modulus, stiffness, and ultimately measures such as workability or compressive strength.

At the same time, the device can also be used in passive mode. In this case the sensor is listening to capture ambient vibrations/mechanical waves within the material. This mode may be valuable for longer term monitoring of the structural health of the structure or element, to detect changes in material properties over time. The device may, over time, suffer from drift and various other errors, which can be corrected (for example, using a machine learning model). Alternatively, particular element types (e.g., photonic couplings through the photo-elastic effect) exhibit low to no drift and may be employed. The use of a photo-elastic sensing element is a particularly inventive wave-based embodiment which does not suffer from the same shortcomings as traditional electronic methods and can be used for high-precision static deformations over long periods of time. This is a particularly important part of the invention for shrinkage monitoring.

### Frames, Waveguides & Sensor Shape Influence on Resonance

The mechanical element (sensor or actuator or transducer) can act as a waveguide. The shape of the device and its mechanical elements will influence the resonance characteristics. Different shapes (puck, cube, spherical, tubular, polygonal etc.) will have distinct intrinsic resonances, which may affect the impedance measurements.

For data from different mechanical elements or devices to be comparable, the shape (and the boundary conditions) will need to be taken into account as part of our signal processing pipelines. The mechanical elements and devices will have their own resonance frequency, which may shift when interfacing with the host material (e.g. concrete) due to changes in the boundary conditions and the properties of the host material. The host material will also have resonance peaks. Together, they will form a mechanical impedance spectrum for the composite system. By tracking the resonance shifts over time (e.g. the frequency shift of a resonance peak in the impedance spectrum) one can infer changes in the host material property over time (such as curing stage). These can then be related, through theoretical relations, empirical models, a pre-existing database or through models (e.g. machine learning models), to desired measures (such as compressive strength or workability). Other features of the mechanical impedance spectrum may be correlated to various characteristics of the host material.

### Resonance Systems:

Mechanical actuator/transducer elements may be shaped in geometries that resonate (e.g. a ring, or a tuning fork, or various element geometries with holes and substructure that are able to resonate at various frequencies). These will form a resonant system when bonded (directly or indirectly) with the host material.

Piezo element with a frame or fixture, optionally such a frame has holes in it, or various features to push and pull material when the piezo is excited or actuated. For example, a piezo element mechanically coupled to two T-shaped frame/fixtures (at 180 degree to each other). In this embodiment, the piezo-active material is regularly shaped (e.g. patch) and is connected to a passive frame with a well-defined shape.

Piezo elements inside or in proximity of a resonating cavity (e.g. a bowl shape, or helmholz-like resonator), with an open face that allows the host material to flow into it (e.g. a container, which has the added advantage that it can form a ‘mini-environment’ which can be excited and sensed).

Generally, these resonator embodiments will enhance the resonance peaks of the host material in the electromechanical impedance spectrum, improving our ability to measure those, and use them to determine material properties such as the speed of sound in the medium or the dynamic modulus.

### Concrete Containers & Sensor Isolation

In one embodiment, the device is installed within, or in proximity of a concrete container (called, without loss of generality, the “bowl”), to isolate and contain a particular volume of consideration in the concrete from the rest of the host material. This has the advantage of also acoustically/mechanically isolating the host material from external noise, ensuring that stray reflections (e.g. from rebar) can be avoided, and also provides a resonance surface (cf resonance section). This may take the form of any generalized open face chamber (e.g. bowl-shaped).

This bowl ultimately shields the mechanical elements (sensor/actuator/transducer) from coming into direct contact with rebar and other potential obstructions which may be embedded in the concrete. It is also a solution for shielding the system from spurious signals (e.g. unrelated mechanical excitations, from for example, loading of the element, or work on the construction site).

The bowl would be made of a material that is non-reactive with concrete and does not interfere with the mechanical measurements. Suitable materials would include certain plastics or composites known for their durability and inert properties in concrete. The texture (including finish) and material from which the bowl is made needs to promote adherence with the concrete. Difference material will lead to different boundary conditions (and hence different resonance modes). The bowl's open face would face upwards (in situations where concrete is poured from above), to ensure that it is filled with fresh concrete once it is poured. Different configurations may be used for other configurations (e.g. tunnel linings) to avoid voids and ensure adherence. This creates a localized ‘mini-environment’ that is isolated from the rest of the structure. The bowl would be adapted to various different shapes (parabolic, triangular etc.), and also could be adapted to the different embodiments of the sensor/actuator/transducers (puck, cube, spherical, arrays, tomography setups etc.).

Combinations with Other Sensors:

Optionally, the mechanical sensor/actuator is complemented with other sensors/actuators/transducers, such as temperature, humidity or moisture sensor (non-exhaustive list). Temperature may be assessed using a variety of methods, including digital temperature sensors, thermistors and/or thermocouples. Humidity may be assessed using an RH sensor (and in the case of concrete, a permeable membrane surrounding it). Moisture can be sensed using capacitive sensors, microwave sensors, infrared sensors etc. These are particularly important for environmental compensation of any measurement (e.g. temperature or humidity changes, which by the nature of the concrete curing process will happen throughout hydration, could create translation or other non-linear transformations to mechanical measurements such as impedance). The device may also be combined with other wave-based sensors (e.g. E&M-based), to complement its capabilities for host material characterization. In particular, the device may be complemented with E&M wave-based devices, such as the photonic spectroscopy and imaging devices (e.g. LIBS, FTIR, Hyperspectral Camera Embodiments). These are particularly complementary and are a key aspect of the invention. The mechanical device will provide insight on the mechanical properties of the aggregate (which is chemically inert), and on the mechanical aspects of the cement matrix and its bonding to the aggregate. The photonic spectroscopy and imaging systems will provide measures of the compositional properties of the cement matrix, and the aggregate type. Together they can provide an enhanced measurement of the compositional, contextual and static material properties. Another combination of interest is the use of electrochemistry-based devices. Electrochemical impedance spectroscopy characterization will provide insight on the pore size (which influences ionic movement and has been shown to be related to concrete compressive strength), complementing mechanical impedance spectroscopy data.

### Context Awareness:

The device/system and methods may include capabilities for context awareness, including depth of installation detection using time-domain reflectometry, orientation with accelerometers and other inertial sensors, lidar and magnetometers for accurate positioning. Generally, all the methods and devices described in the context awareness section may be employed in conjunction with mechanical wave-based sensors. Context awareness methods that employ measurements from the mechanical sensor/actuator itself are of particular note, as they do not require additional hardware to be mounted on the mechanical wave-based device, keeping device costs low.

Mechanical Tomography with Multiple Mechanical Sensors/Actuators/Transducers

Various spatial configurations of multiple mechanical elements are considered (on one or more devices) to enable mechanical tomography. These include: N sided polygon: elements (sensing and actuating) arranged on the vertices of an n-sided polygon, to provide a multi-dimensional view of the host material. This enables the triangulation of mechanical wave data, to enable a detailed map of the inside of the concrete, or the insite of the N sided polygon. Plate configuration: several elements (sensing and actuating) embedded in a flat plate, placed in contact with the concrete surface. Particularly valuable for scanning large, flat areas and looking at surface properties and anomalies of concrete. The output data can be used to measure the N-port transfer function for mechanical impedance, for electromechanical impedance tomography, or in acoustic mode (traveling acoustic wave tomography).

### EXAMPLE EMBODIMENTS

A few example configurations are described below (with more specific embodiments included further down). (1) The “puck”: Single mechanical transducer (that can sense and actuate) housed in a solid material puck with the vibrating surface of the transducer exposed to the host material (e.g. facing up so concrete is poured into it). (2) The “oreo”: A double-transducer configuration where the circuitry, power source (battery and/or energy harvesting circuits) and wiring are sandwiched between two mechanical transducers (where each transducer can sense and actuate). These transducers can be used independently to work in phase (vibration), in antiphase (compression/displacement) or independently to achieve multiple frequencies and different phases for each frequency independently in order to achieve additive mechanical wave modulation modes. Alternatively, one side may be a sensor, and the other an actuator. (3) Single Device Transducer Arrays: A device comprising a plurality of mechanical transducers (that can sense and actuate), driven (independently or simultaneously) by a single electronics unit so as to centralize control and guarantee excitation and sensing synchronization. These may take the form of an array on a flat, concave (bowl-like) or convex surface, including but not limited to hollow cubic, quasi-spherical and intermediate geometries such as dodecahedron. In these configurations techniques such as geometrical constructive interference, phase beam forming and time division multiplexing spatial tomography via one to one, many to one, one to many and many to many measurements would allow for characterization of the material under test as well as its spatial inhomogeneities (e.g. differentiating between aggregate and cement matrix/mortar in the readings). (4) Multi-Device Systems: Any combination of any plurality of the above (distributed system), wherein each device is able to detect the deformations and mechanical waves generated by surrounding devices. These data are centralized and time-synchronized, and optionally complemented by additional device contextual condition data (e.g. relative distance between devices and position of devices with respect to each other) to determine characteristics of the host material, and to carry out spatial tomography.

### Electro-Mechanically Coupled Sensors & Actuators

In this section, we describe embodiments that make use of electromechanically coupled sensors and actuators. First, we outline how the electromechanical impedance spectrum can be measured through electromechanical actuation and sensing (in the generalized case). Then, we focus on embodiments that make use of the following electro-mechanical elements: Piezoelectric devices (which act as both sensors and actuators); CMUT devices (which act as both sensors and actuators).

### Electromechanical Impedance Signal Excitation & Detection

Electromechanical impedance measurements are carried out by exciting the electromechanical transducers with various input voltages or currents, such as a high frequency oscillating electric potential or current. The system input voltage or current can have different waveforms, such as sinusoidal waves, square waves, sawtooth waves, triangular waves, pulse waves, step functions, delta functions, ramp signals, periodic signals, random signals, frequency sweeps, multi-sine signals, modulated signals, digital signals, analog signals, exponential signals, complex exponential signals, harmonic signals, composite signals, frequency sweeps (chirps), and other custom waveforms. These signals can generally be described in the fourier domain. For periodic signals:

$$V [ k ] = \frac{1}{T} {\int }_{t = 0}^{T} v ( t ) {e}^{- jk {ω}_{0} t} dt$$

Where v(t) is the voltage in the time domain, k is the harmonic number, and ω₀ is the fundamental frequency, and T is the period. For non-periodic signals:

$$V ( ω ) = {\int }_{t = - ∞}^{∞} v ( t ) {e}^{- j ω t} d t$$

Where v(t) is the voltage in the time domain and ω is the frequency. Some complex signals (such as frequency chirps) will have time varying frequency.

The output of the measurement is acquired after the excitation of the electromechanical transducer, and includes its voltage and/or current readings, which reveal the electronic impedance of the transducer and, by extension, the mechanical impedance of the system (made up of the device and the building material volume around it). The mechanical impedance measurement can be related to the dynamic young's modulus of the concrete, which is related to the stiffness of the material.

By measuring the output current or voltage, the amplitude (real part) and phase shift (imaginary part) of the impedance can be determined.

The current readings can be carried out directly using a shunt resistor and measuring its voltage drop over time but can also be derived, knowing the input impedance characteristics of the system and focusing on voltage readings only. All of these techniques will have to be coupled with temperature compensation techniques, in order to take into account all the temperature varying coefficients of interest. Voltage readings would make use of Analog Front End circuits, that treat the intrinsically low voltage signals using low noise amplifiers (LNAs), programmable gain amplifiers (PNAs) and filters in order to condition the received signal. The signals acquired and conditioned by the AFE will then be analyzed with signal processing techniques, able to carry out FFT and other transform types to the acquired signals but also able to carry out digital filtering and conditioning to the datasets. Excitation signals may be generated by the MCU through its pulse width modulation module (these form part of most low cost and low power MCUs). Alternatively, various analogue signal excitation modes may be used.

Frequency measurements and phase shifts can be achieved with various digital or analogue methods. One example includes the zero crossing technique which can be implemented on low-cost modern MCUs.

Analogues of this technique can be applied to other mechanical couplings (e.g. magneto-mechanical, or opto-mechanical) which all ultimately aim to derive the mechanical impedance of the system, and so for brevity are not repeated in those sections.

### Piezoelectric Sensing & Actuation

One implementation of electromechanical sensing and actuation makes use of piezoelectric elements. This is particularly advantageous, in large part because the same element can both act as a sensor and actuator. This is a significant improvement on traditional techniques such as ultrasonic pulse velocity testing, which requires two separate elements (increasing likelihood of aggregate interference, debonding etc). This also allows for a more compact device which is easier to install. Generally, this advantage also applies to CMUT-based approaches (which are described later). The piezoelectric transducer will excite a volume surrounding it (where the size of the volume of influence is related to the size of the piezo element, and the power/energy input and the material properties). Piezoelectric elements can also be stacked for increased effectiveness, and importantly, enabling custom piezo active shapes which can enable various resonance modes (through irregular piezoactive elements). They are low-cost, low power, and can also be micromachined and deposited or constructed using thin-films, enabling miniaturization into a low-cost, mobile, long-lasting embedded or surface mounted device (or a hybrid of the two).

### The Piezoelectric Effect

Piezoelectricity is the ability of some materials (notably crystals and certain ceramics) to generate an electric charge in response to applied mechanical stress. If the material is not short-circuited, the applied charge induces a voltage across the material. The piezoelectric effect is reversible, that is, all piezoelectric materials exhibit two phenomena (a direct energy conversion mutual reciprocity coupling): (1) The direct piezoelectric effect—the production of electricity when stress is applied, (2) The converse piezoelectric effect—the production of stress and/or strain when an electric field is applied.

### The Poling Direction and Electro-Mechanical Effects

Our devices use any number of piezoactive elements. In particular, this may include Lead Zirconate Titanates (PZTs), often doped with other elements to obtain specific properties. These ceramics are manufactured by mixing together proportional amounts of lead, zirconium and titanium oxide powders and heating the mixture to around 800-1000° C. They then react to form the perovskite PZT powder. This powder is mixed with a binder and sintered into the desired shape. During the cooling process, the material undergoes a paraelectric to ferroelectric phase transition and the cubic unit cell becomes tetragonal. As a result, the unit cell becomes elongated in one direction and has a permanent dipole moment oriented along its long axis The unpoled ceramic consists of many randomly oriented domains and thus has no net polarization. Application of a high electric field has the effect of aligning most of the unit cells as closely parallel to the applied field as possible. This process is called poling and it imparts a permanent net polarization to the ceramic. The material in this state exhibits both the direct and converse piezoelectric effects. Various piezo geometries may be constructed for such a process. The geometry may be determinative of the resonance modes, which play a key role in the inventions.

### Piezo Sensor Types

Planar sensors involve a PZT patch (d₃₁ mode). For activation in the transverse direction (as per design) thick film PZT or PZT stacks are typically invoked (d₃₃ mode). The normal displacement of PZT thin films is extremely small due to their small thickness in comparison with that of bulk or thick-film PZT. This displacement is often out of the resolution limit of displacement probes. For bulk PZT or thick-film PZT, piezoelectric coefficient d₃₃ is often measured in two ways. The first way is to apply an electric field and measure the corresponding strain. In this case, displacement of the PZT surface is often measured via a capacitive displacement probe, a laser interferometer or a laser Doppler vibrometer (LDV). Then the normal strain is calculated from the measured displacement. The Young's modulus of the PZT material is comparable to that of concrete, indicative of the usefulness to embedded applications since it is less likely to be overwhelmed by the stiffness of the host structure.

### The Constitutive Equations for Piezoelectric Sensing

The equations for piezo-electricity couple the mechanical and electrical aspects, or specifically elastodynamics and electrostatics, which combine to yield the constitutive relations. Although the mechanical problem is modelled as fully dynamic (inertial contribution is included), its electrical counterpart is quasi-static as the electric field changes in time sufficiently slowly, so that no significant magnetic field is induced, hence this is a purely electrostatic system. A ‘slow’ change in time from the perspective of the quasi-static electrostatic perspective corresponds to time-harmonic variations of up to tens of kilohertz, which is, rather ‘fast’ from the mechanical point of view

Input signals are applied electrically across the piezo-material, which then, as described by the fundamental piezo equations (included below in tensor form), through the electro-mechanical coupling, produce displacements in the piezo, which in turns creates displacements and deformations in the host material. The electromechanical coupling appears in the constitutive equations via piezoelectric coupling:

$$[ \begin{matrix}D \\ e\end{matrix} ] = [ \begin{matrix}ϵ & {d}^{d} \\ {d}^{c} & s\end{matrix} ] [ \begin{matrix}E \\ T\end{matrix} ]$$

where the electric displacement, D, and the strain vector e are related to the applied electric field vector, E and stress tensor, T through the piezoelectric constants: dielectric permittivity ∈, direct and converse piezoelectric coefficients d^{d} and d^{c}, and the elastic compliance s. The piezoelectric coefficient d^{c} defines strain per unit field at constant stress and d^{d} defines electric displacement per unit stress at constant electric field.

The d^{c} matrix can be represented as:

$${d}^{c} = [ \begin{matrix}0 & 0 & {d}_{31} \\ 0 & 0 & {d}_{32} \\ 0 & 0 & {d}_{33} \\ 0 & {d}_{24} & 0 \\ {d}_{15} & 0 & 0 \\ 0 & 0 & 0\end{matrix} ]$$

where the coefficients d₃₁, d₃₂ and d₃₃ relate the normal strain in the 1,2 and 3 directions respectively to a field along the poling direction, E₃. The coefficients d₁₅ and d₂₄ relate the shear strain in the 1-3 plane to the field E₁ and shear strain in the 2-3 plane to the E₂ field, respectively. Note that it is not possible to obtain shear in the 1-2 plane purely by application of an electric field. The permittivity matrix e is a diagonal matrix. The compliance matrix is fully populated in 1, 2, 3 vectors and diagonals in 4, 5 and 6 vectors.

Note that from a sensing perspective: The sensor is exposed to a stress field, and generates a charge in response, which is measured. In the case of a sensor, where the applied external electric field is zero, (1.16) becomes:

$$[ \begin{matrix}{D}_{1} \\ {D}_{2} \\ {D}_{3}\end{matrix} ] = [ \begin{matrix}0 & 0 & 0 & 0 & {d}_{15} & 0 \\ 0 & 0 & 0 & {d}_{24} & 0 & 0 \\ {d}_{31} & {d}_{32} & {d}_{33} & 0 & 0 & 0\end{matrix} ] T$$

This equation represents the principle of operation of piezoelectric sensors. A stress field causes an electric displacement too be generated as a result of the direct piezoelectric effect. The electric displacement D generated by taking the integral of the charge q over the electrode surface. The charge q and the voltage generated across the sensor electrodes Vₚ are related by the capacitance of the sensor, Cₚ as Vₚ=q/Cₚ. By measuring the charge generated by the piezoelectric material, it is possible to calculate the stress in the material. From these values, knowing the compliance of the material, the strain in the material is calculated.

In summary, From the constitutive equations, equations of motion can be derived for time-varying input voltages/currents, with boundary conditions (which will depend on the geometry and bonding of the piezo-active elements, and surrounding materials, such as frames, or the rebar). This leads to a PDE, from which the system's behavior could be simulated (such synthetic data may be an input into machine learning models to analyze the spectrum). The outputs include voltage and/or current readings across the piezo-electric material, which reflect the electric impedance of the piezo element and, by extension, the mechanical impedance of the host material (in the case of concrete, a measure which is related to its dynamic modulus and stiffness).

### Piezo Material Selection

In one embodiment, the element is specifically a PZT (lead zirconate titanate), shaped like a hockey puck to maximize sensing area. In other embodiments, materials such as barium titanate or lead titanate are considered. In further embodiments, custom piezoelectric composite materials are considered, made up of an active piezoceramic material as well as a passive material (e.g. an epoxy or a polymer). These may be arranged in resonator configuration (see applicable section).

Different compositions (described above) have been considered, beyond PZT for the piezo element, including composite piezos. The piezo composition can also be altered to optimize its properties for specific use cases, including by varying the ratio of lead zirconate to lead titanate (in the case of a PZT), through doping with other materials, and by modifying the grain size during manufacturing which would affect sensitivity and stability.

The inventors have considered the use of piezo-electric polymer film technology, and Piezo-MEMS based technology. This is particularly useful to construct piezo-arrays, and/or to miniaturize the overall system.

### Multivariate Environmental Adjustment

A multivariate approach with a device that includes both piezos and temperature sensors is particularly important due to the fact the magnitude of the piezoelectric effect is strongly dependent on temperature. To accurately assess the electromechanical impedance of a material such as concrete (which has a temperature that significantly increases during the curing process) using a piezo, an accurate measure of the temperature profile is required. The temperature data can then be used to apply a correction factor/compensation onto the EMI signal. This makes measurements at different ages of concrete curing comparable and removes the impact of temperature on the signal (e.g. the position of resonance peaks). This is in effect a form of self-detection/context awareness (as described further in that section of the invention).

### Multivariate Static Strain Monitoring

Piezoelectric devices may traditionally struggle to perform accurate static measurements, as they can drift over time due to leakage of electric charge. In one embodiment, a piezo that also includes a high accuracy strain gauge of a form more appropriate for static sensing (e.g. a photoelastic-based strain gauge as described later) would allow not only for the measurement of electromechanical impedance (on a temperature-corrected basis), but also actual displacement in absolute terms of the material. This provides more information that may aid in the determination of parameters such as shrinkage, workability, and compressive strength. Accurate shrinkage measurements in association with compressive strength would be a game changer for the industry (enabling various other methods, such as mix optimization, fingerprinting or pour design and sequencing).

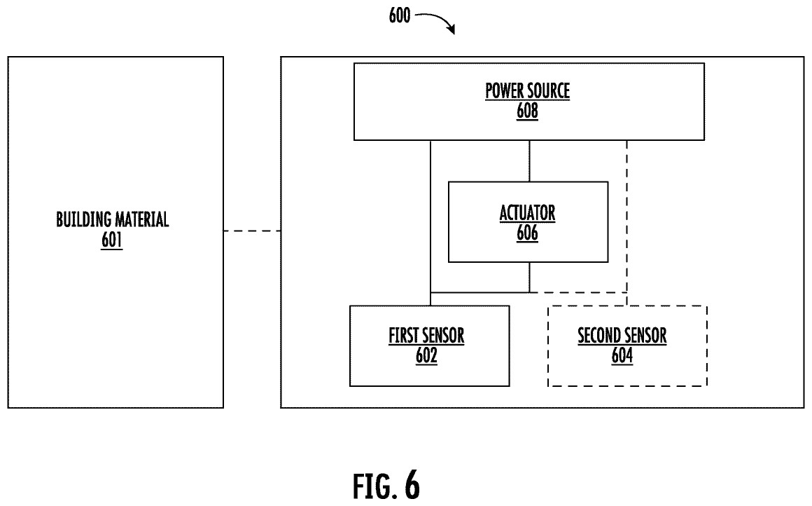

The sensor device embodiments of the present disclosure are described hereinafter with reference to various particular configurations based on the type of sensor(s) leveraged by the sensor device, the measurement data associated with the sensor device, and/or the like. With refence to FIG. 6, however, an example block diagram of a sensor device 600 considering a building material 601 (e.g., a cementitious mixture or concrete) is shown. As illustrated, this example sensor device 600 may include at least a first sensor 602, an actuator 606, and a power source 608. The power source may include a battery or any other device, system, or structure that may supply power (e.g. electrical power or the like) to the first sensor 602, the actuator 606, and/or any other component of the sensor device 600. In some embodiments, a second sensor 604 may be provided, such as in a multivariate sensing implementation. The first sensors 602 and/or second sensor 604 may include any of the sensor types described hereinafter without limitation. In other words, FIG. 6 provides an example structure of components and associated circuitry that may enable any of the sensing systems, techniques, methods, etc. described herein.

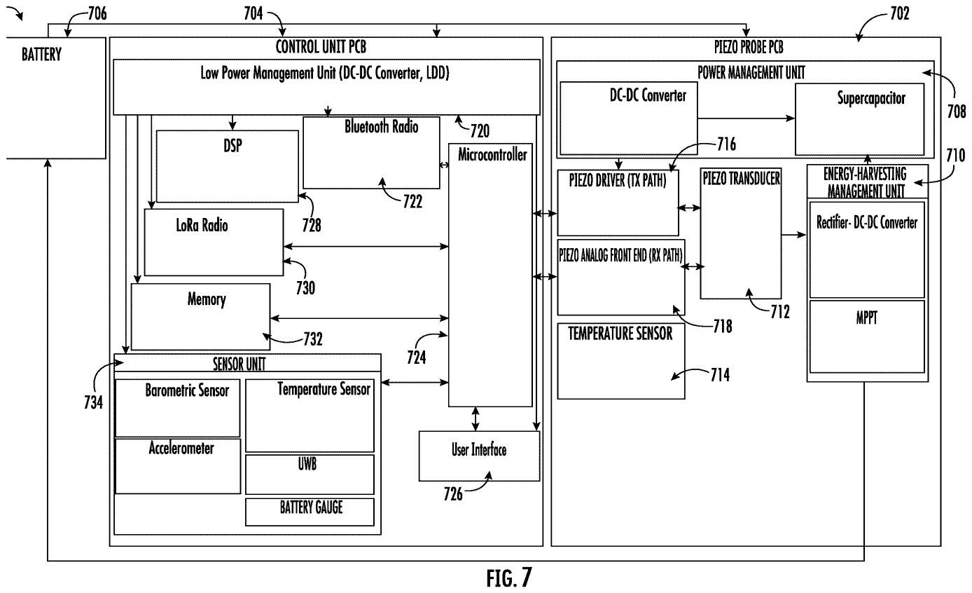

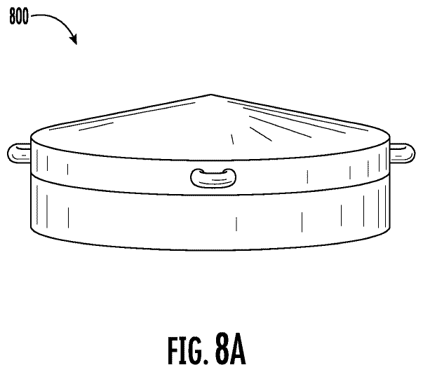

With reference to FIG. 7, another block diagram of a sensor is illustrated for an example piezo sensor 700. As shown, the sensor 700 may include a piezo probe PCB 702, a control unit PCB 704, and a battery 706. The battery 706 may be electrically coupled to each of the components described herein, directly or indirectly, in order to power these components. As shown, the control unit PCB 704 may include a low power monument unit 720 (e.g., a DC-DC converter, LDD, etc.), a Bluetooth radio 722, a DSP 728, a LoRa Radio 730, a microcontroller 724, a memory 732, a sensor unit 734, and a user interface 726. The control unit PCB 704 may include any number of other circuitry components to enable the operations of the piezo-based sensor devices described herein. The example piezo probe PCB 702 may include a power management unit 708, a piezo driver 716, a piezo transducer 712, a piezo analog front end 718, a temperature sensor 714, and/or energy harvesting management unit 710. Similarly, the piezo probe PCB 702 may include any number of circuitry components for enabling the piezo-based sensor device to perform the sensing operations described herein.

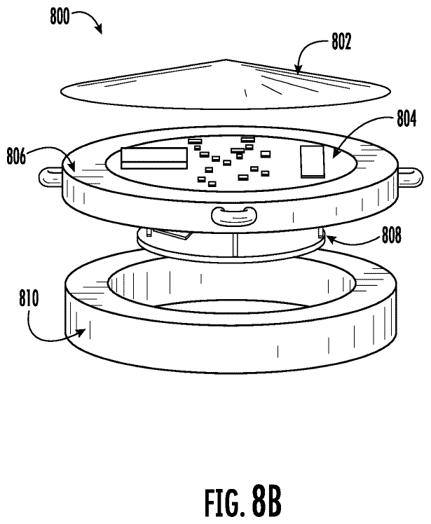

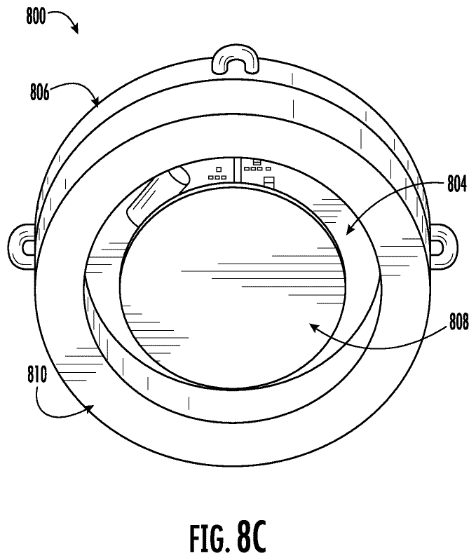

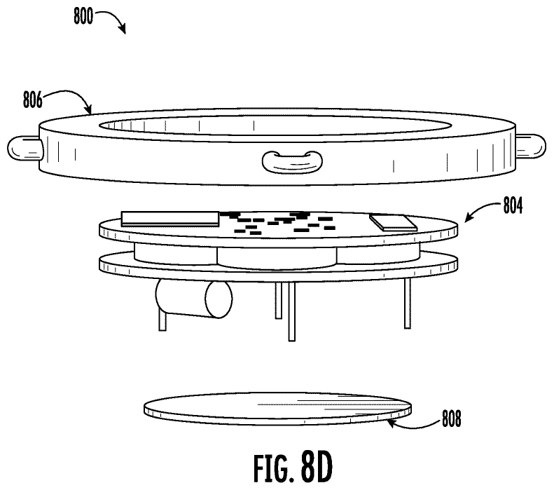

With reference to FIGS. 8A-8D, an example puck-like piezo structure 800 is illustrated. As shown, the piezoelectric element 808 may be mounted in a puck-like enclosure and electrically coupled with a PCB 804. The PCB 804 may include any of the various circuitry components described herein for enabling operation of the piezoelectric element 808. A metal ring structure 806 with attachment hinges may be used as the primary support for the device 800 and may be the most robust part of the enclosure. Tethers may be hooked to the hinges pulling from four directions to keep the device 800 in place. A conical shaped cap 802 and a cylindrical body 810 underneath may complete the enclosure. These two parts 802, 810 may not be required, in some embodiments, to withstand particularly strong mechanical stresses. Thus their material may (but don't need to) cheaper, such as plastics or various passive polymers. The device may be installed with the piezo-transducer 808 facing up or facing down.

When facing down, the conical shaped cap 802 sits on top, resisting and deviating the concrete that will be poured on top of the device 800. In both cases, to ensure adhesion and to avoid air pockets, the piezo 808 may be activated to vibrate the device 800 and to compact the concrete shortly after curing (when it is still workable). In face down mode, wireless antenna and RF circuitry, supported by PCB 840, for communication may be installed underneath the conical shaped cap, which will face up, promoting wireless signal propagating out of the concrete. If the intended use is face down, a ring antenna may be used, within the ring-like enclosure. Alternatively, the device may be connected to a separate antenna, or wireless transceiver/MCU unit (which may itself be embedded or outside the concrete element). As illustrated in the exploded view of FIG. 8B, the electronic assembly may be encapsulated into the metal ring 806, while the cap 802 and cylindrical body 810 have a protection-shielding function. The cylindrical body 810 will also facilitate the pouring of a protective material from the bottom side of the device 800, completing the enclosure assembly. FIG. 8C shows the assembly of the device 800 from the bottom. This configuration may enable an embodiment in which the enclosure is used as a mold to pour an insulating/bonding material. The material could be poured while keeping the device 800 upside down, encapsulating the bottom part of the electronics and the piezoelectric 808 (or other electromechanical) transducer in particular.

In one embodiment (facing down), the electronics of the PCB assembly 804 may be arranged in layers and include one or more RF antennas with radiation pattern in favor of the top direction, a PCB for RF conditioning and processing; coin cell batteries; a PCB for the mechanical transducer conditioning and (if present) energy harvesting; a supercapacitor; mechanical/electric pin shaped connectors (between PCB 804 and piezo ceramic 808); a coin shaped piezo ceramic 808 acting as the acoustic transducer. The coin shaped batteries constitute the principal power supply of the system 800 and are shared between the top and bottom PCBs. Achieving a small, low-power and low-cost form factor is a key part of the present disclosure. This is in part possible due to the small volume of the coin cell batteries. However, small batteries (including coin cells) may not be able to deliver the high current peaks needed by the piezoelectric transducer 808 during the mechanical excitation generation. Hence, the batteries may be doubled by a supercapacitor connected to the bottom PCB in order to provide these current peaks whenever needed (in general, this technique is used across a number of wave-based sensing embodiments and may be used across any embodiment). In order to easily accommodate the coin batteries (e.g., four or more coin cell batteries), the electronic components of the top PCB are surface mounted and lie on the top side while the ones of the bottom PCB are still surface mounted but lie on the bottom side instead. Between the components of the top PCB, two antennas are provided that may be oriented with their radiation patterns in favor of the top side of the device 800, convoying the RF radio towards the sky and away from the concrete pour depths. The RF antennas topology may be ceramic patch because they are the least influenced by the conductive surfaces underneath themselves, constituted by the PCBs ground planes, the enclosure metal ring, the batteries and other components.

The mechanical and electric connection between the electronic body and the piezoelectric transducer 808 may be made with pin-shaped board-to-board connectors, in order to avoid a double structure for a shared problem. The connection pins could be fixed but also spring loaded granting (if needed) some movement freedom to the piezoceramic 808. Any material poured inside the bottom part of the device 800, alongside the electrical insulation of the circuits from the (conductive) wet concrete, must guarantee well-suited mechanical bonding between the electromechanical transducer 808 and the concrete, both in its wet and dry forms. As such, the bonding layer may be configured to maximize the portion of mechanical energy transmitted at the interface of the transducer 808 and the concrete. This may be enabled through mechanical impedance matching of the materials. Poor mechanical impedance matching across the material may cause unwanted reflections at the interface limiting the energy effectively reaching the target of the concrete and of any material to be characterized in the surroundings of the device. In this particular embodiment, because of its shape and geometry, the piezo device 800 is intended to be used to characterize the environment underneath (or in some embodiments directly adjacent) the device whilst transmitting information though one or more radios from the top, towards the sky (assuming it has been installed in a horizontal element such as a slab).

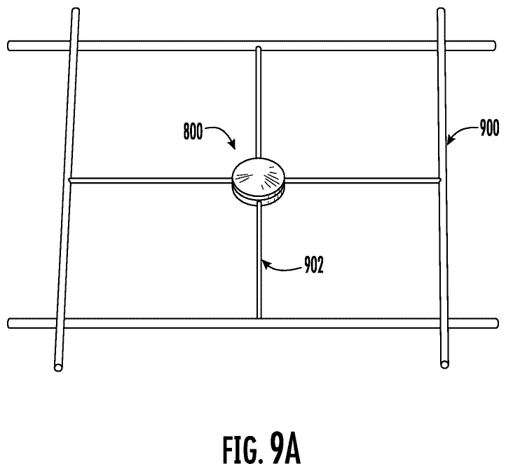

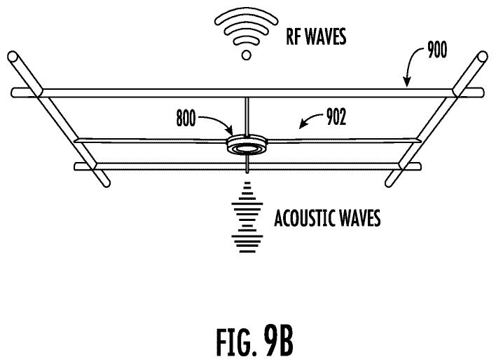

With reference to FIGS. 9A-9B, an installation of the device 800 is shown. As illustrated, the device 800 may suspended in between four rebars 900 through means of four tethers 902 that tie the four sides of the device 800 to the rebars 900. In some embodiments, as shown in FIG. 9B, the mechanical actuation and detection (e.g. electromechanical impedance) may happen in the bottom direction while RF data connection will happen on the top side, making it possible to connect and/or communicate between within the host material (e.g. in the concrete), and the surrounding environment (the outside world). Other configurations (including face-up ones in particular) may also be considered.

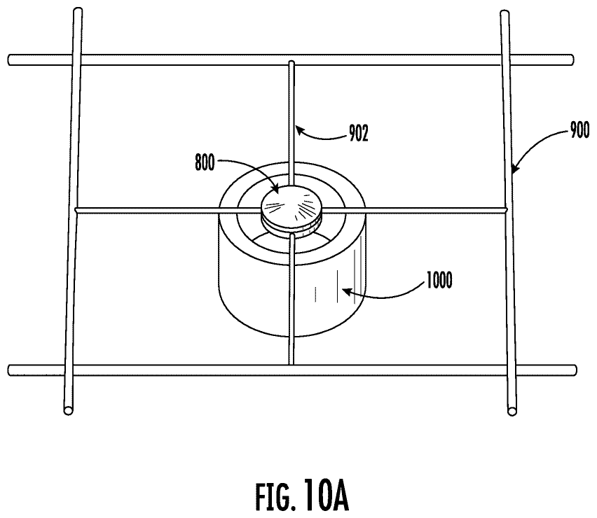

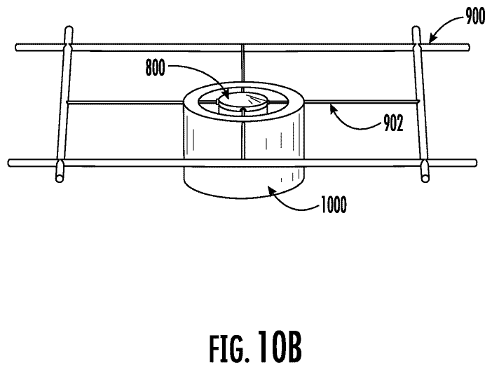

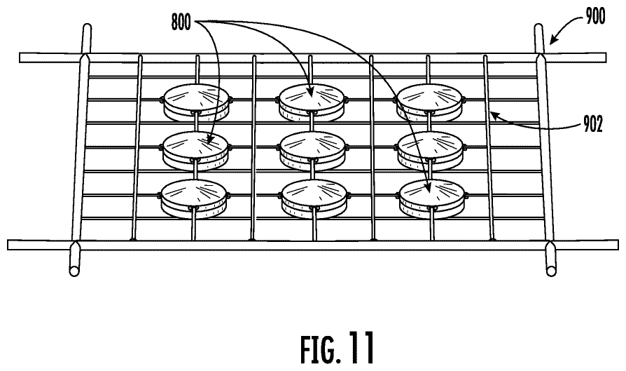

With reference to FIG. 10A-10B, the device 800 is illustrated in conjunction with a pot-like structure 1000 surrounding the sensor 800 and acting as a physical barrier, isolating the sensor 800 from direct contact with rebars 900 or other potential obstructions, but also enhancing resonance modes through the creation of standing waves. This solution is compatible with the tether configuration 902 and limits the uncertainty on the boundary conditions. However, due to an increase in volume occupancy of this solution, the material of the pot-like structure 1000 has to be carefully chosen, in order to not alter the final pour characteristics (i.e., compression strength). To promote resonance modes, various materials are considered (which could either be an acoustic insulator, or an acoustic conductor). One advantage of this solution is that in a repeatable environment like that, the power of transmission to read a successful data set is predictable, meaning that battery life and sizing can be optimized and tailored in order to get the best experience over time. Also, the pot configuration 1000 creates a controlled environment surrounding the piezo device 800, making results more predictable and reliable, and enhancing resonance modes. This means that the field conditions can be recreated in a lab with minimal discrepancies. The field datasets can be seamlessly compared to an archive of datasets gathered in lab conditions and the analysis on the materials is dramatically simplified. Through the addition of environmental sensors (e.g. temperature sensors), device contextual conditions can be measured and used to further enable comparability of measurements.

With reference to FIG. 11, an embodiment is illustrated in which multiple piezo devices 800 are working side by side, envisioning the option for a tomographic scan of the environment that would be very useful in high complexity scenarios. This is akin to an N-port impedance system (where N is the number of piezo devices 800). The excitation modes may be in the X-Y plane, or in Z, or any of their combinations. The multi-piezo system may also further enhance resonance modes, enhancing any electromechanical spectrum data. It is also more resilient to the inhomogeneities present in concrete and allows for removal of any noise generated by the rebar 900. Piezo-arrays (of this embodiment, and other embodiments) may be characterized using T or S parameter techniques (as described herein), or may be used to carry out spatial tomography (by leveraging accurate time synchronization, for example over BLE5).

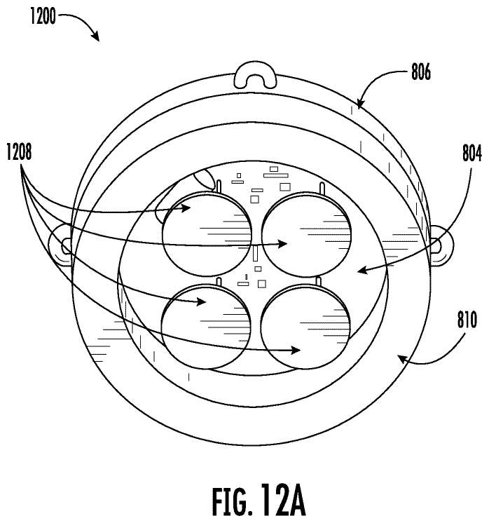

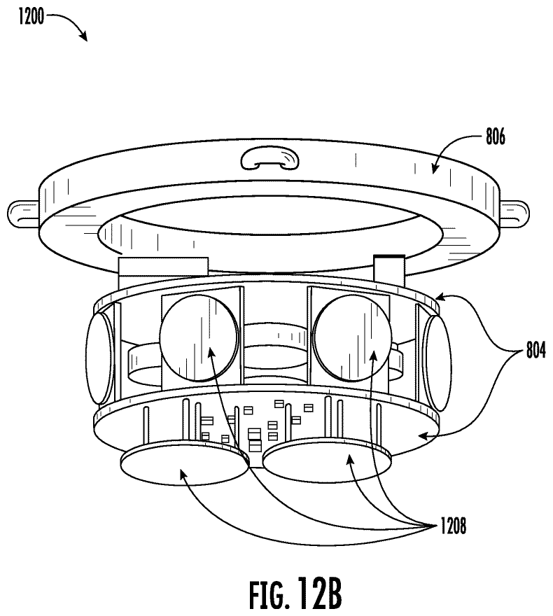

With reference to FIGS. 12A-12B, another array-based embodiment 1200 is illustrated in which the objective may be to gather multiple readings in space within the material-so called tomographic scenarios, or N-port transfer function scenarios). As shown, a single device 1200 may potentially be equipped with multiple piezo transducers 1208. The transducers 1208 may be used sequentially using multiplexing techniques or at the same time by adding one transducer-conditioning-PCB (including the supercapacitor) per sensing unit.

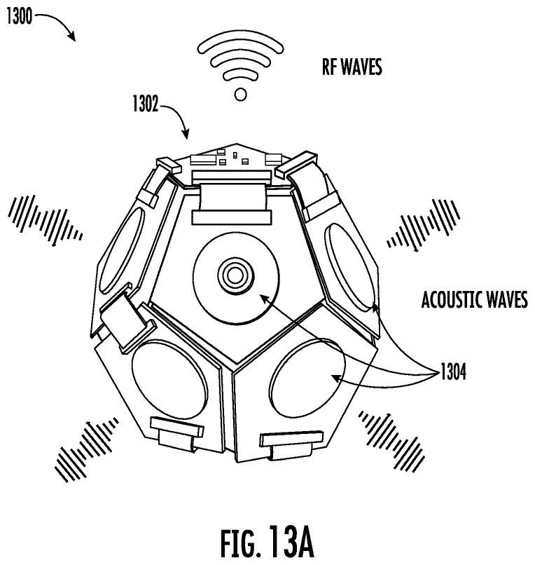

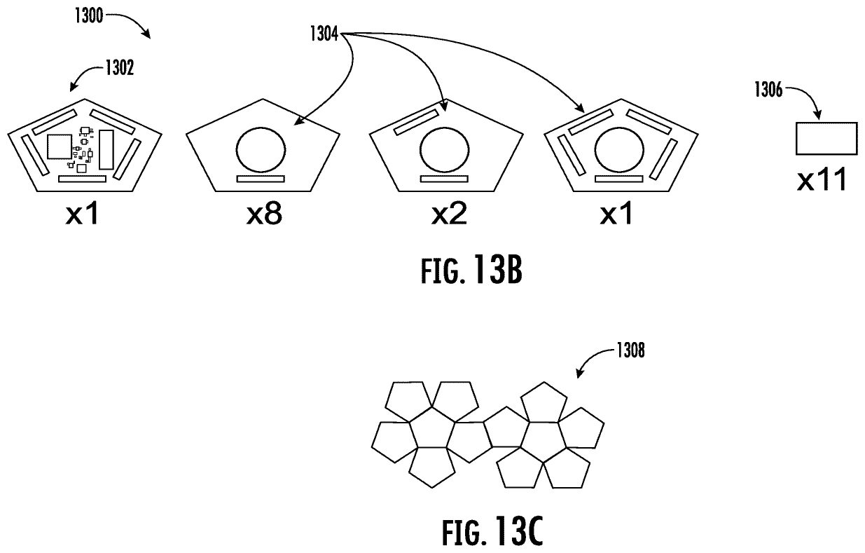

With reference to FIGS. 13A-13C, an extension of the plurality/array of piezoelectric sensors and transducers embodiment is illustrated where wherein the electronic assembly 1300 may include 11 transducers pointing in 11 directions. The overall shape of the device 1300 may be a dodecahedron, counting 12 faces. The top face, pointing to the sky, is dedicated to processing and RF transmission 1302 with the external world. The remaining 11 faces would be equipped with piezo transducers 1304 and individual transducer conditioning PCBs. The goal of this geometry is to analyze the space around the device from all directions creating a 3D map of the surroundings (in spatially traveling wave mode), and/or a spatial distribution of electromechanical impedance (in oscillation mode). The pentagon base dodecahedron shape is a good compromise between number of active sensing directions and feasibility/constructability of the device. Connecting PCB elements 1306 may be configured to connect the various of the assembly 1300 and an example connection representation 1308 of the dodecahedron shape is also illustrated.

In addition, in some embodiments, the device 1300 may be designed to allow concrete to fill the inside of the dodecahedron frame (either by keeping one or more faces empty, or by creating holes for the concrete to flow into the device during pouring). This means that the dodecahedron, similarly to the pot, acts as a container which enhances resonances.

Mechanical enclosures made of insulating material may be used (leaving the piezo element, or a piezo composite exposed) to further isolate the inner environment from the outside, creating a ‘miniature lab’ environment where some of the contextual conditions have been controlled for. In this embodiment, insulation may be installed on the outer surface of the dodecahedron, and the mechanical enclosure designed so as to probe the inner volume with the piezo array.

The sequence of mechanical excitations across each piezo may also be varied to induce various excitation modes. This includes different modes of the piezo (d31, d32, d33, or more generally d_φθ, where φ represents the direction of the induced electric polarization, and θ the direction of the applied stress), with 1/2/3 representing stress across the x/y/z axis respectively, and 4/5/6 share about the x/y/z axes respectively. Ultimately, this will create resonance modes for the overall mechanical system.

The fact that all faces of the polyhedron share the same pentagonal shape makes it possible to simplify the assembly strategy for the product, with advantages in terms of cost and resilience to assembly errors. Each of the 12 faces of the dodecahedron would have a PCB mounted on it. The connections between the 12 PCBs could be achieved using 11 (cheap) flexible FPC/FFT cables 1306, attached to 2 adjacent PCBs by FPC flat connectors. Out of 12 PCBs, 11 would share the same layout, with 1, 2 or 5 connectors along the five edges of the pentagon and one piezo transducer in the middle. Operationally this would tremendously simplify the design and production having three variants of the same PCB (with populated or not-populated connectors). The twelfth PCB would be the only significantly different design and would have all the functions of the Puck design top PCB, already described above. Finally, the set of 12 PCBs, made as just described, could then be mounted as a flat semiflexible assembly, following the origami-like scheme at the bottom left side of [FIG. 13C]. At this stage of assembly firmware/software procurement and production tests could be carried out easily before the final placement in shape. The dodecahedron final arrangement could be achieved with the help of a (optionally sacrificial) support structure, around which unwrap and fix the 12 PCBs. The electronic assembly could then be coated with any adequate material in order to protect the electronics and act as a bonding with the concrete.

Naturally, this will require a punctual mechanical industrial design around the electronic one, able to address problems such as permeability of the structure by concrete and fixing methods to rebars. On the latter two example solutions are set out below:
(1) Permeability of the structure by concrete: the described device occupies a non negligible amount of volume that if empty could be an issue when embedded in concrete. The presence of such a void in the concrete pour may lead to a reduction of the compressive strength. In addition, as mentioned above, it would be advantageous to fill the inside of the dodecahedron with concrete, so as to sense the inner area. To solve this, a system that allows the concrete to permeate into the dodecahedron and fill the void is considered. To achieve this many approaches could be followed. As an example, in one embodiment, cutting the five tips of each pentagon would leave free space at the 12 vertices of the device. These holes/voids would let the concrete inside the dodecahedron and solve the problem. Optionally, the piezo's may be activated during pouring, to enhance compaction and flow into the inner volume:
(2) Fixing methods to rebar: the device would need a way to be attached to the rebar that would leave the RF antenna above it, pointing towards the sky (in the case where it is used in a slab or other horizontal element) and the body of the device (with the 11 sensors) still free to point in all directions and not be obstructed by the rebar itself (or pointing into an unobstructed internal volume of the dodecahedron itself). For outward sensing, one example solution also leverages holes/voids in the PCB, leaving enough space for the rebar to pass through the device from two holes made in the vertices and facing each other in the middle of the assembly. For inner sensing, straps that attach to each face of the rebar grid may be used. Generally, all the attachment methods described in the general section may be employed.

By bonding various non-piezoactive materials onto a piezoelectric device, particular resonance modes of the system can be enhanced. In particular, the innovative use of various frames (which may act as waveguides) is considered, as well as containers (which act as containers for an isolated volume of concrete dV, but also boundaries for resonance modes). Full encapsulation of the piezoactive material in another material, and a resonant shape is also considered (which has the added advantage of promoting bonding).

These form various piezo composite geometries, made of piezoactive material, alongside other materials (which may be mechanically conductive or isolating depending on the desired properties and boundary conditions). These piezo composites, when adhered to the concrete structure, form a system of coupled resonators (and can be modeled as coupled oscillators). The concrete forms part of the resonating system and influences the resonance frequencies and resonance peaks (which will evolve with curing). These piezo-composites can be used to enhance the natural resonance peaks of the concrete in the electromechanical spectrum derived from the piezoelectric device, which enables to determination of the dynamic modulus and stiffness of the host material (and ultimately can be used to correlate back to the static modulus, and the compressive strength, as well as other contextual material properties of interest).

Checking the resonating frequency of a system, offers advantages in terms of resolution and response time to stimulus of the system. Different resonating piezo composite geometries are considered, including:
(1) Cylinder Resonator: The puck device is easily modifiable to include a Helmholtz-like resonator, exploiting the cylindrical shape of the puck tail, where the piezo ceramic is already positioned. The cylinder acts as a container for the concrete under consideration.
(2) Dodecahedron Resonator: the dodecahedron device is in essence a cavity that can be filled with concrete and excited from a neck like structure. The dodecahedron is already designed to be filled in concrete and the piezoceramics can be easily oriented towards the inside of the device. The internal geometry can be easily modified to be used as the resonator cavity and the piezo on each of the faces can be used to excite the structure from different directions.

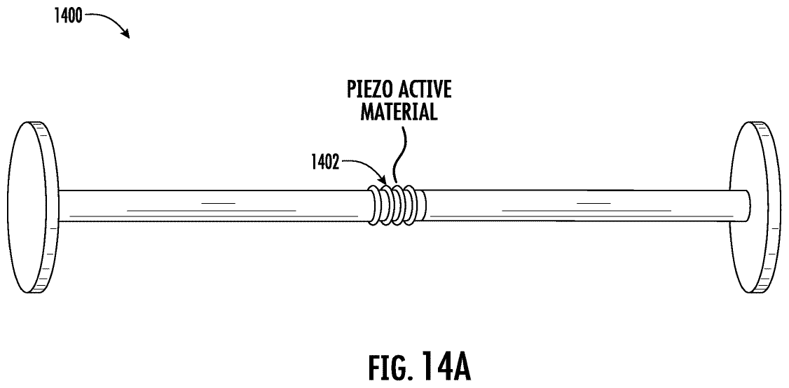

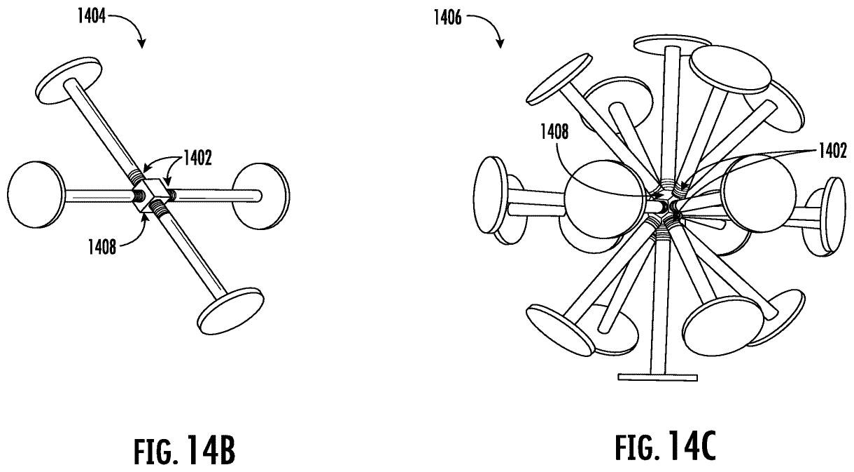

With reference to FIGS. 14A-14C, example T-bar 1400, 1404, and 1406 configurations are illustrated in which one or more T-bars (which may be parallel, perpendicular to each other, extruding circularly or spherically from an origin point) coupled, via attachment 1408 or the like) to one or more piezo elements 1402 (the piezo is coupled to the base of the stem 1402). The end face (crossbar) of the T may be rectangular, circular or ellipsoidal, and may also be curved (e.g. semi-spheres, or various parabolic shape that may sweep the material). In the case where two T bars are mounted at 180 degrees to each other (e.g., FIG. 14B), along the x-axis of the piezo, and the d31 mode is excited with an oscillating AC signal (or for that matter, any of the dxl modes, which create displacement along the x-axis), the T bars will be pulled in and out, which will put the concrete under tension and compression as the signal oscillates. At particular resonance frequencies, standing waves will be induced along the length of the T-bars. In the case where multiple piezoactive ceramics are installed as in FIG. 14C (each of which is bonded to a respective T-bar), then each T-bar may be individually controllable, which enables a plethora of potential vibration modes. This specific embodiment is particularly innovative as it will put the concrete under compression and tension, which most closely resembles the effects experienced under a traditional compressive strength test.
(4) Tuning fork: one or more piezoelectric elements coupled to a tuning-fork geometry is also considered. The piezo can be coupled at the base of the tuning fork, or at the ends (or multiple piezos may be used for excitations at various locations).
(5) Membranes: a resonance membrane is also considered, where the piezo (or array of piezo) forms part of a membrane that has been put under tension, with a frame (e.g. a circular frame). This is akin to a speaker membrane, with a piezo in the middle.
(6) Other: Other geometries that have been considered for the piezo composite include full encapsulation and bonding to a composite shape. These could be any of the shapes mentioned above, or any other geometry.

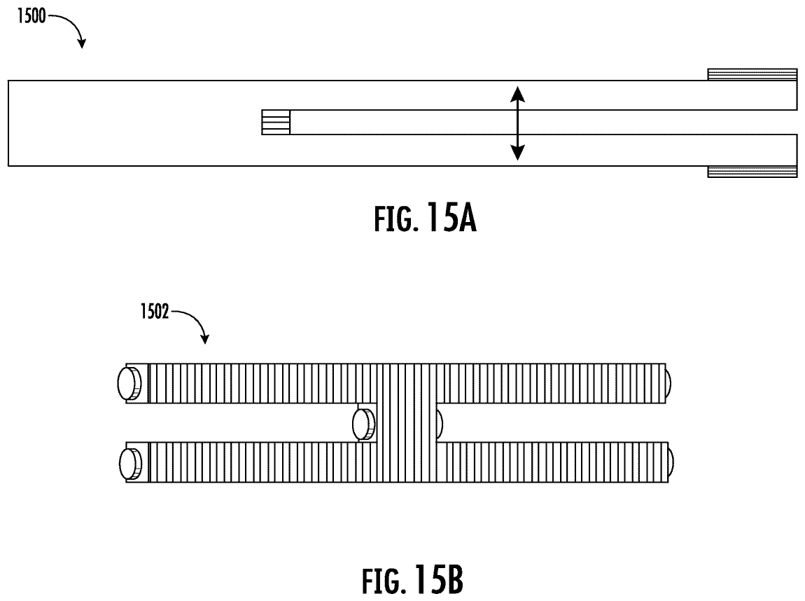

With reference to FIGS. 15A-15B, another way of realizing mechanical resonators is to design a piezoactive element that is itself already geometrically of a resonating shape. Possibilities are endless but in one proposed embodiment as shown in FIG. 15A, the device 1500 may be a tuning fork shaped piezo ceramic with an active area localized in between two parallel arms. The arms get excited by the piezo element around the resonance and start vibrating exactly at their resonance frequency. The concrete in which the arms are submerged determine a resonance frequency shift that stabilizes at the end of the curing period. Other active areas can be added to the ceramic substrate, for example at the ends of the arms, acting as a mass but also as a detector for the concrete dislocation, that gives direct information about compressive strength of the concrete. The ceramic can be used as a substrate for the electronics as well or anyway small PCBs can be overposed on the unused area of the device. In another embodiment 1502 as shown in FIG. 15B, the active area is part of the tuning fork structure and different connection terminals are available in different positions. By selectively applying voltage in different points of the structure it is possible to excite different resonating modes and generate different standing waves. Other geometries are possible, spheric or hemispheric piezo elements can be realized with aperture for the concrete to fill them (so concave piezoactive elements are considered).

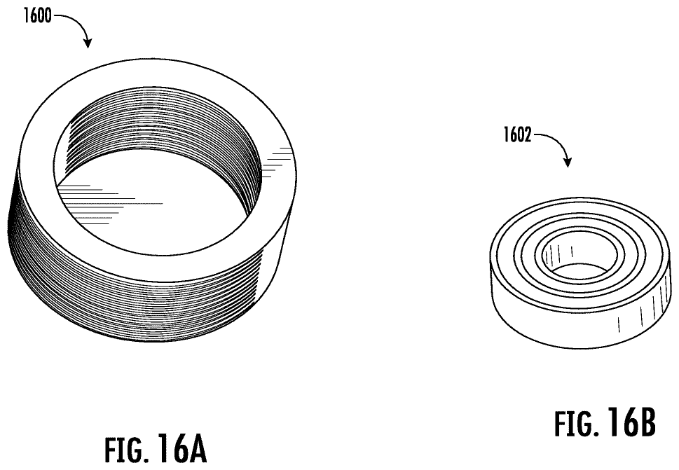

With reference to FIGS. 16A-16B, the piezo active portion 1600 and 1602 of the device may be shaped into the desired geometry through stacking, where multiple piezo active layers are prepared (e.g. PZT films, or films of other piezo ceramics), and each layer may be coated with a conductor. The layers are then aligned (to ensure coherence) and stacked onto each other. The stacking can be done in different configurations (e.g. series or parallel, which will change the current/voltage output of the stacked system). The stacked layers are bonded together, and polarized, before connecting electrodes to the stack, and finally, encapsulating and finishing the stack. Stacking has the added advantage of amplifying the piezoelectric effect, which is particularly useful for higher output power. Alternatively, the custom piezo geometry may be fabricated through mechanical cutting, ultrasonic machining, laser cutting or molding. For piezoceramics, the powder used to make them can be placed in the desired mold before sintering. In another embodiment, miniaturization of the system is also considered, through PiezoMEMS techniques (e.g. integrative, additive or subtractive approaches). Micro-machining of the custom piezoelectric geometry, or the use of thin films is considered

### CMUT Devices

CMUT are a novel type of transducers that generate mechanical deformations and oscillations (typically in the ultrasonic frequency domain) through changes in capacitance (a mechano-capacitance based coupling). They can also act as sensors of mechanical displacement and oscillations (which means this is an example of direct energy conversion reciprocity). They are constructed using silicon micromachining techniques. Given the prevalence of silicon micromachining in chip design and MEMS, this means it is possible to construct various CMUT-active transducers (e.g. including of various transduction arrays and resonant geometries) at a relatively low cost using existing equipment.

The CMUT element is typically made up of a silicon substrate (which can easily be micromachined based on microfabrication techniques). Thin film layers are deposited on the substrate, including conductive layers for electrodes, a sacrificial layer (typically an insulator), and a membrane layer. The sacrificial layer is etched away to form a cavity. The membrane is made of a conductive or semiconductor (e.g. silicon) and is mounted above the sacrificial layer (forming a cavity between the substrate and the membrane). The substrate and the membrane are connected to electrodes (through conductive layers). When a potential is applied across the electrodes, charge build-up leads to an electric field across the electrodes. This field leads to forces which the membrane towards the substrate, decreasing the size of the cavity. The potential across the electrodes can be modulated to generate a mechanical oscillation. Potential frequency sweeps, and various pulses can be used to mechanically excite the transducer.

Conversely, when mechanical displacements are applied onto the membrane (e.g. from incident mechanical waves), they change the distance between the membrane and the substrate, which alters the capacitance of the system. These capacitance changes cause a change in charge accumulation in the substrate and membrane. When the membrane moves closer to the substrate, the capacitance increases and more charge is stored. When it moves away from the substrate, the capacitance decreases and less charge is stored. This change in charge leads to a displacement current, that is proportional to the rate of change of the voltage and the rate of change of the capacitance. This displacement current is small but can be measured through signal processing techniques (including amplification, and conversion into a voltage, e.g. using a transimpedance amplifier). The resulting voltage is processed (optionally using filtering and digitization techniques). Further analysis is then carried out on the processed signal to determine characteristics of the mechanical deformations (e.g. ultrasonic wave intensity, frequency etc.). Generally, this is all based on measurement of changes in capacitance, to derive mechanical behavior.

The inventors contemplate the use of these transducers bonded on (directly or indirectly) to host materials for material characterization (in particular for the time evolving properties of cementitious mixtures such as concrete). Similar configurations to the piezo case are contemplated (including the puck, the puck in a pot, the oreo, the various single-device or multi-device array configurations, the dodecahedron, the composite resonators such as the T-bar's, and the piezoactive resonators). CMUT transducers can be used in the same configurations as those contemplated for piezoelectric transducers and offer advantage over them due to precise control of manufacturing through micromachining.

CMUT transducers may be bonded on to other inactive materials to form resonators (e.g. frames, installation in containers, embedding in/on surfaces, membranes or volumes, or acoustic concentrators). Alternatively, custom CMUT geometries may be constructed (rings, tuning forks) through techniques such as micromachining.

Specifically, CMUT can be produced through advanced micromachining techniques (which are typically used in silicon chip production). This means that they carry a particular advantage when it comes to production of custom geometries or etching on surfaces and array layouts to produce specific custom behavior, through precision micromachining. Generally, this allows for precise control over the shape and size of the transducer element. Detailed etching may be used to modify the membrane thickness, gap size, and other geometrical features to achieve desired frequency responses, sensitivity, and other performance characteristics. Micro-CMUT transducer geometries may also be constructed.

Our devices make use of these CMUT transducers and CMUT-based resonators, bonded to host materials of interest, to determine characteristics of the material. In one embodiment this is done by determining the electrical impedance spectrum of the transducer (which, given it is coupled into a mechanical system, is a measure of the mechanical impedance of the system). Resonator based implementations enhance resonance peaks/resonant frequencies of the host material in the spectrum, which can be extracted. From these, the dynamic modulus can be determined. From the dynamic modulus or the impedance spectrum itself, the static modulus, compressive strength or other compositional property, material property etc can be determined.

The use of a tunable CMUT (where the impedance of the CMUT can be electronically actuated, by changing microproperties of the CMUT itself, such as its cavity gap) also form a feature of the system that give them yet another advantage over traditional mechanical transduction techniques.

Particular advantages of the CMUT-based embodiment include: (1) Higher frequencies and broader bandwidth than piezoelectric transducers (enabling higher resolution characterisation, in the case where they are used for imaging); (2) Micromachining techniques used to make them are particularly suited to making 2D arrays or other custom geometries. This means a variety of array structures can be created, to enable N-port system analysis or tomography. This makes them particularly advantageous for developing miniaturized devices or complex arrays; (3) CMUTs require lower drive voltages than piezoelectric sensors, making them more suited to ultra-low-power devices. They also exhibit better thermal stability, which is particularly important given the exothermicity of the materials and the chemical reactions of interest (e.g. concrete hydration). CMUTs also do not contain lead, which makes them more environmentally friendly; (4) Being silicon based, they can easily be integrated into other electronic components, or even into silicon packages.

### Magneto-Electro-Mechanical Coupled Sensors & Actuators

Mechanical impedance transducers and resonating elements can be created not only using piezo elements but also exploiting magneto electro mechanical techniques. In particular, two techniques are considered here: (1) Electromagnetic Speakers/Microphones; and (2) EMAT (Electromagnetic Acoustic Transducers).

### Electromagnetic Speaker/Microphone

In this embodiment, inductive coils are used to create magnetic fields strong enough to move magnets together with their frame. The approach builds on the traditional electro-acoustic techniques normally used in speakers and microphones, but in a novel application. The movement creates mechanical oscillations, and mechanical oscillations can be detected from the displacement that they generate. In general these devices borrow construction details and geometries from the piezo-based designs described above.

The new approach brings advantages in terms of costs but also of electronic simplification. In fact the proposed embodiment can borrow driving and sensing electronics from audio electronics. The miniaturization of audio amplifiers and new approaches like digital audio sensing (PDM) could be in fact exploited to enhance miniaturization and battery life, reducing costs at the same time. The trade-off of this approach is the range of achieving frequency, definitely smaller than in the piezo case.

### EMAT

An additional embodiment is considered that employs EMAT-based transduction in construction materials such as concrete. EMAT (Electromagnetic Acoustic Transducers) is a non-contact method that is able to generate and receive ultrasonic waves in conductive materials (including dielectrics) without any physical contact, through electromagnetic acoustic wave induction.

A coil within the EMAT transducer is used to induce eddy currents at the surface of the material. At the same time, a constant magnetic field is applied (e.g. by an electromagnet) in proximity to the coil. The interaction between the eddy currents and magnetic field generates a Lorentz force, which generates an ultrasonic pulse in the material. The magneto chemical instantiation of the ‘cube’ described later could be modified to enable EMAT transduction.

EMAT transducers exhibit reciprocal coupling (so can act as both an actuator of mechanical oscillations, as well as a sensor of mechanical oscillations). For example, induced ultrasonic waves within the material will modify the magnetic field near the surface (or interface with the EMAT transducer). These changes in magnetic field will lead to currents in the EMAT coil which can then be measured and recorded by the device.

Adherence and bonding of contact-based electromechanical transducers can be challenging, requiring special materials and coatings (as discussed previously). Bonding can also lead to errors (e.g. due to poor adherence or debonding effects). This means that a non-contact method provides a significant advantage beyond existing techniques.

Furthermore, given the reciprocal coupling, the technique can be used for both sensing and actuation, acting as a 1-port system, which can be used for mechanical impedance measurement and spectroscopy (these would be so called electro-magneto-mechanical impedance spectroscopy).

The various configurations described for the piezo section (including the resonance frames/waveguides and/or cavities) can be ported over to the EMAT case, but with the added advantage that no bonding requirements exist with the material under consideration. A new embodiment including a combination of the two techniques is therefore also included, enhancing ranges and possibilities in respect to the independent approaches.

### EMAT in Concrete

Concrete is a good dielectric when it is fresh, and also has some conductive properties (due to free ions), but its dielectric properties will change over time as it cures (in particular as the hydration reaction progresses). This means that EMAT transducers may become less effective over time (as water is consumed by the hydration reaction). This change in material properties can be measured, which could be used to determine the conductivity, permittivity and permeability of the material (including their frequency responses). From this, various characteristics of the material can be determined. For example, by analyzing the change in ultrasonic wave characterization (amplitude, velocity, attenuation) against a given input, changes in material properties can be inferred. EMAT in conjunction with electromechanical impedance spectroscopy (e.g. from a piezoelectric material) would allow for both mechanical and electromagnetic characterization simultaneously. A piezoresistor, or photo-elastic device may also be used to measure mechanical displacements, instead of a piezo-active material.

### Conductor-enhanced EMAT

EMAT is most effective at inducing eddy currents into good conductors, which may make it difficult to achieve sufficient control over the ultrasonic waves in the prior described embodiments. An additional enhancement considers the addition of a conductive (or semi-conductive) plate, surface or volume with known properties near the EMAT transducer. This plate or surface is fully characterized prior for calibration purposes (which means it can also act as a control reference in our system). The coupling element is bonded to the concrete (directly or indirectly) and serves as a target for the EMAT transducer. Coatings and various geometries may be used to ensure good bonding/adherence. This leads to the generation of ultrasonic waves (the plate acts as an ultrasonic transducer). Ultrasonic reflections and other displacements will influence the magnetic field distribution on the plate, which can ultimately be measured (as the induced current in the EMAT coil will change), so sensing is also possible. This has the added advantage that the known mechanical properties of the plate will create known reflections and transmissions. This can be used as a benchmark or reference point within our system. The element may be made of a number of materials, including metals such as aluminum or brass, and also silicon or metalized films (e.g. polymer foils), or semiconductors such as silicon. The technique can be used to derive the mechanical impedance, from which the dynamic modulus can be derived, and used to get a relation back to the static modulus and/or compressive strength of the material.

### Conductor-Enhanced EMAT Resonators

In a further enhancement, the shape of the conductive plate/area/membrane/volume is designed to maximize resonance modes. This is the EMAT analogue to the various configurations described for piezoactive resonators, and piezo composite resonators.

Different vibration modes can be excited depending on the geometry of the resonator (e.g. for a membrane, these may include the flexural mode, face shear mode and thickness shear modes). These allow for sensing of different characteristics. Eddy currents induced into the resonator will depend on the current flow in the EMAT coil, and the configuration of the coil. This means that different coil layouts can be used to excite different modes (e.g. circular coils, solenoids, toroidal coils, quadratic spiral coils, or helical coils). (1) the conductive surface or volume may take the form of a cavity (e.g. bowl shaped metal conductor), resonant waveguide (e.g. ring), or any other geometry that may promote mechanical resonance modes. (2) a composite material geometry may be created, that bonds the conductive surface or volume to a frame, cavity or membrane, or integrates the conductor into a volume, where such second material is non-conductive and creates boundary conditions for the mechanical excitations. This may take the form of a bowl or other container (where the conductive plate is within the container, which acts like a cavity), a frame (e.g., the conductive plate is connected to one or more T-shapes as with the piezo case), or a conductive plate that is embedded into a stretched membrane. Other configurations are also envisaged.

### Miniaturization of Element

The inventors have also contemplated miniaturization of conductor-enhanced EMAT, through micro-machined elements and/or resonator devices (which become miniaturized acoustic systems). Micromachining can also be used to build various complex resonator geometries and configurations. These may be made of pure metals, coated polymer films, to silicon and semiconductors, or glass elements (or composites of all of the above).

### Electro and Magnetochemistry Through Conductor Enhanced EMAT

An additional particularly advantageous property of this system, is the ability to determine electrochemical and/or magnetochemical properties using this system (in addition to mechanical impedance). In particular, eddy currents will be induced into the plate, which is in contact with the concrete (which acts as an electrolyte). Electrochemical reactions will take place at the plate/concrete boundary as a result of the eddy currents. This in turn will change the induced current in the EMAT coil, which can be measured. The induced current in the EMAT coil would however require very high sensitivity measurements. A further enhancement would be the addition of an electrode or another conductive plate into the system to measure electrochemical parameters (including through electrochemical impedance spectroscopy). With a minor addition, the device has now become a dual mechanical and electrochemical characterization system for concrete property estimation. These data can then be used for material identification, curing evaluation and all the other use cases contemplated in this document.

### Opto-Mechanical Sensors & Actuators

There are a number of materials that exhibit active or passive opto-mechanical couplings, which can be used for mechanical sensing of a host material, or mechanical actuation, or both (depending on the reciprocity of the couplings). These devices are all broadly a subcategory of photonic sensing (and their electromagnetic analogue, including photonic/optoelectronic waveguides, are described in the E&M section). It is worth noting that the delineation between electromagnetic and mechanical sensing begins to break when multiple related couplings are considered. For the purpose of this description, we consider three types of photomechanical devices, and some of their combinations:

Photo-elastic Sensors: Materials that change property based on applied pressure or mechanical displacement (such as piezo-optical devices, where a strain leads to a refractive index change which leads to a change in the polarization of light). These materials typically experience birefringence when deformed, which can be measured.

Photo-Mechanical & Photo-strictive Actuators: Smart material that changes shape when illuminated with light, which ultimately can lead to pressure against or deformation of a host material.

Mechano-Luminescent Sensors: Smart materials that will generate light when forces are applied to them. They can act as strain or force sensors when embedded in host materials.

Laser-induced Mechanical Wave Actuator: Lasers can be used to induce mechanical waves, for example, through laser induced blasts. Lasers induce plasma which generate a blast on de-excitation. This is similar to the LIBS-based mechanism described elsewhere.

Generally, opto-mechanical systems offer several advantages over their electro-mechanical counterparts. They can often offer high resolution and sensitivity, with no drift errors (which makes them good at static and dynamic characterization). They are not prone to EMC interference, and in some cases, they can operate at extreme temperatures. Being non-electric, they are safer in flammable or explosive environments. In addition, they can be sensed and/or actuated at a distance (with no physical contact, when in transparent environments). Being optical in nature, and spanning areas/volumes, in the case of sensors, they can allow for continuous spatially distributed sensing (by illuminating and analyzing different regions of the optical element. In the case of actuators, a single element can be illuminated in different spatial configurations across the area or volume to produce dynamic, tunable mechanical actuation arrays for tomography applications. We designate these modes adaptive spatiotemporal optical sensing, and adaptive spatiotemporal optical actuation.

It has been envisaged by the inventors that opto-mechanical (or photonic devices more broadly) are driven and/or sensed using electronics systems (through an electro-photonic coupling system). However, in an alternative embodiment, a photonic only system may be constructed (which is becoming possible with the advent of photonic computing, and generally optically-based data transmission, sensing, actuation, switching and logic and energy generation). Below we describe each method, followed by some device embodiments that combine the methods for material characterization.

### Photoelastic Sensors

### Introduction

Some transparent optical materials commonly known as photoelastic elements experience a change in their optical properties when mechanically stressed (e.g. through the piezo-optical effect). For example, materials which are isotropic when free of stress can become optically anisotropic when under stress and display characteristics similar to those of crystals. As a result, the transparent optical element being stressed the becomes birefringent. The induced birefringence is proportional to the applied stress.

In construction application, this coupling can be used to produce devices that are able to cheaply and resiliently detect stress and strain, and/or mechanical oscillations applied upon a sacrificial plastic or equivalent photoelastic material. The photoelastic material would be bonded (directly or indirectly) to the construction material (either embedded or surface mounted).

These devices are not only able to measure dynamic mechanical deformations, but also static deformations/stresses and strains as they do not suffer from time drift in the same way as electronics-based approaches. This is particularly advantageous for monitoring shrinkage in concrete, but also the behavior of concrete during or after post-tensioning, and the changes in static stress and strain as the hydration reaction takes place. Coupled with dynamic measurement through mechanical excitation, this becomes a particularly advantageous method for determining the modulus and hence the compressive strength (which would, in addition to offering a direct measurement of the dynamic modulus, also provide a measurement of the static modulus, which is much more closely related to compressive strength).

### Mathematical Formalism

The indices of refraction are linearly proportional to the loads (so for a linear elastic material, proportional to the stresses or strains), and are governed by the following equations:

$${n}_{1} - {n}_{0} = {c}_{1} {σ}_{1} + {c}_{2} ( {σ}_{2} + {σ}_{3} )$$

$${n}_{2} - {n}_{0} = {c}_{1} {σ}_{2} + {c}_{2} ( {σ}_{1} + {σ}_{3} )$$

$${n}_{3} - {n}_{0} = {c}_{1} {σ}_{3} + {c}_{2} ( {σ}_{1} + {σ}_{2} )$$

Where σ₁, σ₂, σ₃=principal stresses at a given point, n₀=index of refraction of unstressed material (isotropic). n₁, n₂, n₃=principal indices of refraction along the principal stress directions. c₁, c₂, c₃=optical stress coefficients. D

We can eliminate n₀ as we are interested in relative changes in the index of refraction, and rewrite the system of equation as follows:

$$Δ {n}_{12} = {n}_{2} - {n}_{1} = c ( {σ}_{1} - {σ}_{2} )$$

$$Δ {n}_{23} = {n}_{3} - {n}_{2} = c ( {σ}_{2} - {σ}_{3} )$$

$$Δ {n}_{31} = {n}_{1} - {n}_{3} = c ( {σ}_{3} - {σ}_{1} )$$

where c=c₂−c₁, the relative stress-optic coefficient (measured in brewsters).

In reality, stress and refractive index are second rank tensors (a force in a material in one direction can change the refractive index of light for a polarization in another direction). This means that the most generalized equation that governs the photoelastic effect takes the following form (in summation notation):

$$Δ {n}_{ij} = {C}_{ijkl} {σ}_{kl}$$

When incident light (preferably uniformly polarized) is applied, it will experience relative retardation (a phase change) in each principal stress axis due to the changes in indices of refraction. If we consider an optical element of thickness h perpendicular to one of the principal stress directions at the point of interest, the relative angular phase shifts will be:

$$Δ {Φ}_{12} = \frac{2 π h c}{λ} ( {σ}_{1} - {σ}_{2} )$$

$$Δ {Φ}_{23} = \frac{2 π h c}{λ} ( {σ}_{2} - {σ}_{3} )$$

$$Δ {Φ}_{31} = \frac{2 π h c}{λ} ( {σ}_{3} - {σ}_{1} )$$

Where Δφ₁₂ is the phase shift for the light beam propagating along σ₃, Δφ₂₃ is the phase shift for the light beam propagating along σ₁, and Δφ₃₁ is the phase shift for the light beam propagating along σ₂.

Where again, this generalizes to:

$$δ Φ = \frac{2 π h c}{λ} δ σ$$

where δσ is the difference in stress between two orthogonal polarisations. From this the difference in the optical path length can be calculated, as ΔL=hCδσ.

Generally, it can be seen that the phase shift is proportional to the difference between the two principal stresses that are perpendicular to the direction of light propagation.

The phase shift can be measured by emitting incident uniformly polarised light onto the optical element (with known polarisation), and measurement of the output polarisation. As a result, the stresses and thus strains can be derived from the change in polarisation between the input and output light.

Incident light can either be linearly polarized, circularly polarized or elliptically polarized. This has various advantages and disadvantages. The optical equipment to produce these includes a linear polariser and for circularly polarized light, wave plates.

If the optical material under consideration is influenced by temperature, it may experience strain as a result of thermal effects. These can be compensated for and corrected (e.g. through the use of a digital temperature sensor measurement positioned nearby).

### Implementation

One proposed embodiment of the technique in construction materials is a low-power, wireless portable polariscope (which may be fully embeddable, or partially embeddable), that projects uniformly polarized light against and through a photoelastic element and measures (through light detectors) the polarized light after the element, in order to measure the mechanical compressive or tension stress that the photoelastic element is stimulated with (or other characteristics of the host material). This method has the advantage of providing very high resolution and sensitivity to strain and is much easier and lower cost to implement than other optical setups (e.g. than say optical fiber based Bragg gratings).

Light Source: The light source can be non-coherent, so low-cost LEDs can be used. It is polarized (either linearly through a linear polarizer, or circularly, through the use of a linear polarizer and wave plates). The input light excitation wavelength distribution may be monochromatic, polychromatic or broadband light.

Geometry: various geometries are contemplated (without loss of generality, this may include including thin strips, rods and films, plates, discs, triangular plates, polygonal plates, cross-like plates, T-bars, custom plate geometries, cuboids, cylinders, spherical or elliptical shapes, polyhedrons). The shape may be based on the desired axis of strain and stress monitoring (and may be symmetric along those axes). Light pipes or fiber optics could be used to detect the stress distribution. In addition to surface tension, light pipes or fiber optics could be used to detect the stress distribution through similar effects. A low cost transparent material may be coated on the surface of formwork and illuminated from within the formwork (see ‘smart formwork’ section).

Output Light Measurement: The output light can be analyzed (using an analyzer, which may be made up of a linear polarizer) and then sensed using simple photo diodes, phototransistors or imaging sensors (e.g. a small CMOS or CCD detector would suit).

Choice of Materials: Photoelastic materials are available in many forms (crystals, elastic polymers, quartz, etc.). Specific examples include glass, plexiglass, celluloid, epoxy, polycarbonates. Selection of the material is based on various parameters, including its susceptibility to temperature-driven deformations (given concrete increases in temperature as it cures, and we want to avoid confounding effects, or at least normalize for them). Some of the materials are cheaper and more importantly are not very susceptible to aging, so they can provide reliable measurements over long periods of time, which would be particularly advantageous for shrinkage monitoring.

High Sensitivity to Static & Dynamic Loads: Our optical strain gauge is highly sensitive, and has the advantage of not suffering from drift, making it ideal not only for measurements of dynamic properties (e.g. dynamic modulus), but also static properties (e.g. static modulus under static load). This makes it an ideal sensor which can be used both during the curing process to infer material and compositional properties and their evolution at early age (including through dynamic mechanical excitations), but also longer term behavior (including shrinkage and cracking), which may be static measurements.

Ultra-Low Power: Furthermore, given that measurements can be implemented on a duty cycle basis, the power consumption of the device is very low, enabling tens of years of battery life (or possibly, energy harvesting).

Smart Device: The polariscope is mounted and connected to an MCU, battery, communication interface and other components of the kind described elsewhere for wave-based sensing devices.

Distributed Sensing: A large concrete unit could be instrumented with multiple plastic/dielectric material samples distributed along the whole surface so as to be able to monitor stress distribution across the whole unit. These could optionally be done from a distance (e.g. from a nearby high-resolution camera and a set of optical analyzers, and illumination source applied onto the concrete surface). The element may be illuminated at night to reduce interference from ambient light. Alternatively, a machine learning model may be trained to interpret multi wavelength monochromatic birefringence (which naturally resembles contours).

Photoelastic Arrays: various array-based embodiments may be conceived (e.g. for tomography purposes, or for positioning, and trilateration of the source of a mechanical wave or stress in the medium). They may also be used for load transfer mapping through the structure during or after construction.

Adaptive spatiotemporal optical sensing: Photoelastic sensors can be used as a continuous spatially distributed sensing technique, over the area or volume of the photoelastic element. Through adaptive illumination of the photoelastic element (e.g. with an array of LEDs), different parts of the sensor can be activated, and localized strain and deformations can be measured. Alternatively, the entire area/volume can be illuminated with a broadband or monochromatic light source, and then the induced birefringence patterns detected from a camera can be analyzed by a model to produce a spatially distributed strain/stress or deformation field.

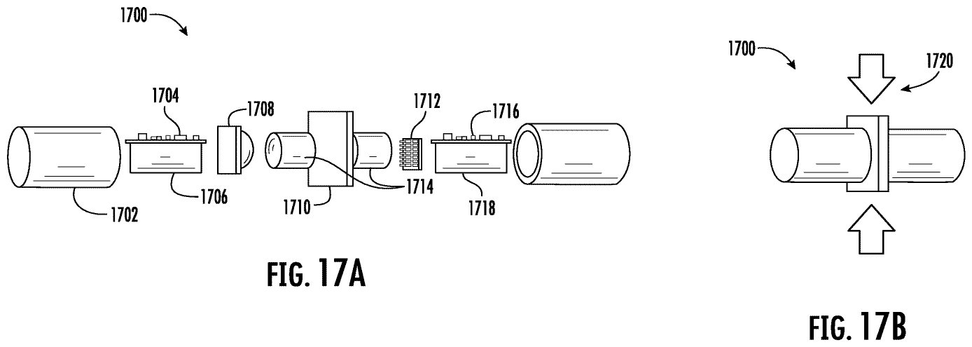

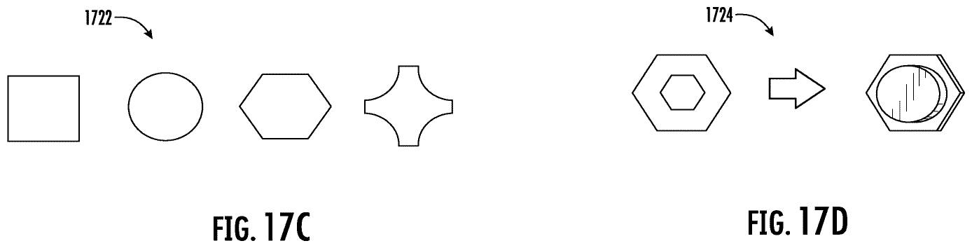

With reference to FIGS. 17A-17D, an example polariscope embodiments 1700 is illustrated. As shown in FIG. 17A the device may include an enclosure 1702, a first PCB 1704, a first battery 1706, a camera 1708, a photoelastic element 1710, optical elements 1714, an LED array 171, a second PCB 1716, and/or a second battery 1718. The device may be used to measure the compressive and stretching forces applied to a photoelastic material 1710. The device includes an RGB LED array 171 used as the light source and a CCD or CMOS camera 1708 used as a light sensor. The path of the light passes through specific optics to be conditioned (polarized) and then through the transparent photoelastic element 1710. After, the light passes through another conditioning/filtering optic element (an analyzer) to finally hit the camera 1708. When mechanical stress is applied to the photoelastic element 1710 the characteristics of the light that pass through it change in terms of polarization and direction. Using the camera sensor 1708 the incident light gets analyzed and the mechanical information retrieved. The shape of the photoelastic element 1710 determines the direction of the readable force 1720 in FIG. 17B. A square photoelastic plate is adapted to measure two orthogonal forces (top-bottom/left-right) while a hexagonal plate allows 3 directions of the force, shifted 120 degrees. Finally a circular plate can be used to analyze forces coming from all directions.

As shown in FIG. 17C, the photoelastic element 1710 may also be shaped with various protrusions 1722 (e.g. a cross-like shape would allow for two axis strain monitoring, and a higher sensitivity to deformation). Finally, to protect the photoelastic element, it may be mechanically bonded to other materials as shown in illustration 1724 in FIG. 17D, which themselves bond with the material under consideration (e.g. concrete). This enables the photoelastic element to be deformed based on the stresses applied to the bonded materials (which can be designed to transfer loads in various configurations). The photoelastic material would be protected within the housing, and the other material would protrude outside of the polariscope enclosure assembly and be subjected to forces by the host material.

The photoelastic element 1710 may also be bonded to mechanical wave concentrators (e.g. parabolic reflectors bonded to the photoelastic element), to enhance sensitivity to various mechanical forces within the host material, or other mechanical cavities, waveguides or resonator configurations. The proposed embodiment 1710 also contains 2 PCBs 1704, 1716 supplied by 2 independent batteries 1706, 1718, one to control the light source 1712 and one to control the light sensor 1708. The PCBs 1704, 1716 may bee separated to avoid the use of cables in the active area of the device 1700. For the same reason, data connections between the 2 entities are wireless and realized through optic data protocols like IRDA (the same as TV remotes) by exploiting the existing emitter/detector infrastructure. The PCB 1704 on the camera side is the one that will gather the information of interest and is equipped with one or more radios to send the information to the outside world. The battery's 1706, 1718 capacity may be chosen in a way that allows the two counterparts of the circuit to perform the same number of measurements.

Generally, the device can be used for measurement of strain and other deformations, of mechanical impedance (including, if the material is driven by another element as described subsequently, the frequency response of impedance), can act as a microphone and sense travelling mechanical waves, detect cracks and other fractures etc.

Photomechanical & Photostrictive Actuators

### Introduction

Photomechanical and photostrictive materials undergo various forms of deformations (e.g. bending, twisting, expanding) in response to incident light. In some materials, this process is reversible, which means that once light is no longer incident on the material, it reverts to its initial state.

This means that these smart materials can act as mechanical actuators. When light of varying intensity is applied to them (e.g. an incident light beam with intensity I(t)=I₀ sin(ωt)+1, where ω is the frequency of oscillation), the photomechanical effect will induce an oscillatory behavior, effectively creating a light-driven mechanical oscillator, which will stimulate the host material. Different oscillation patterns may be used (which may be composed of different wavelengths of light based on the illumination source, chosen based on the response of the target material).

Photomechanical and photostrictive materials work by exploiting a number of different effects, such a photoisomerization (the absorption of light induces a change in the molecular structure, from one isomeric form to another), photogenerated strains etc. There are several types of materials considered by the inventors for photo-mechanical actuation. Particular examples of suitable materials include:

Liquid Crystal Elastomers (LCEs). LCEs exhibit significant mechanical deformation in response to light, and a fast response, as well as tunable properties (mechanical and optical properties can be tuned during synthesis). This makes them a good candidate for photomechanical actuation.

Azobenzene Polymers. A polymer doped with azo dyes is stressed by light. Azobenzene Polymers are known for their ability to undergo rapid reversible isomerization upon exposure to light (with a fast response time), making them good candidates for light-driven actuation.

Piezoelectric Materials. Certain piezoelectric materials also exhibit the photomechanical effect and can be excited with incident light (e.g. Cadmium Sulfide, CdS), through a two-step process (where light induces a surface photovoltage that excites the material).

Photostrictive Ceramics & Ceramic Composites. Certain ceramics are photo mechanically active (photostrictive). They can be bonded with non-active ceramics to create photostrictive ceramic composites. This enhances differential strain. In particular, these materials (or composites made in part of these materials) are used to sense or actuate materials such as concrete, whilst it is curing, or longer term.

### Mathematical Formalism

Generally, the material response to light may be non-linear, and non-local (a delta impulse may generate a response long after the impulse, which may be spatially separated, making the effect in systems non-local).

Borrowing from formalism typically used for nonlinear optics, the change in length of a photomechanical material can be set out as a series in the electric field, with the length along each direction given by the following equation (where n is the order of the length change).

$$l ( t ) = {l}^{( 0 )} + {\sum }_{n = 1}^{∞} {l}^{( n )} ( t )$$

The nth-order strain in the ith direction at time t and at point \vec{r} can be related to the applied electric field as follows:

$${u}_{i}^{( n )} ( t , \vec{r} ) = \frac{Δ {l}_{i}^{( n )}}{{l}_{i}^{( n )}} ( i , \vec{r} ) = {\int }_{- ∞}^{+ ∞} d {τ}_{1} … {\int }_{- ∞}^{+ ∞} d {τ}_{n} {\int }_{- ∞}^{+ ∞} {d}^{{3}_{{\vec{r}}_{1}}} … {\int }_{- ∞}^{+ ∞} {d}^{3} {\vec{r}}_{n} {R}_{ijk…}^{( n )} ( t ; \vec{r} ; {τ}_{1} , … , {τ}_{n} ; {\vec{r}}_{1} , … , {\vec{r}}_{n} ) {E}_{j} ( {τ}_{1} , {\vec{r}}_{1} ) {E}_{k} ( {t}_{2} , {\vec{r}}_{2} ) …$$

where R(n) is the n-th order response function, E is the electric field.

This is a particularly complex equation (especially given that the tensor R must consider non-local effects too), but can be simplified significantly in the linear and local case (where only the R(1) response function matters).

For example, for an isolated infinitesimal volume of photomechanical material that only exhibits a linear response, illuminated with a time varying electric field, the strain can be calculated by:

$${u}^{( 1 )} ( t ) = {\int }_{- ∞}^{t} d τ {R}^{( 1 )} ( t - τ ) E ( τ )$$

If the incident electric field is constantly applied over a time period Δt (an impulse), this reduces to:

$${u}^{( 1 )} ( t ) \approx {R}^{( 1 )} ( t ) {E}_{0} Δ t$$

To consider the impact of a time varying electric field (e.g. oscillating light), it is easier to operate in the frequency domain (through a fourier transform):

$${\overline{u}}^{( 1 )} ( ω ) = {R}^{\sim ( 1 )} ( ω ) \frac{1}{2 π} {\int }_{- ∞}^{+ ∞} d τ exp [ - i ωτ ] E ( τ ) = {R}^{∼ ( 1 )} ( ω ) {E}^{\sim} ( ω )$$

Ultimately, through this formalism, we are able to derive the response of the system to a time varying electric field. This shows that a linear photomechanical material excited by a sinusoidal light input will exhibit the properties of a mechanical actuator. The output mechanical displacement will depend on the response function of the photomechanical material (e.g. its response time).

The above is useful to describe the behavior of infinitesimal volumes. To move from the microscopic domain to bulk behavior of the photomechanical material, it is useful to model photomechanical materials as a system of interconnected microscopic mechanical oscillators, where the equilibrium dimension and complex force constant changes under exposure to incident light. The real component of the force constant represents the elastic properties, and the imaginary component represents the viscosity. This means we can use formalism similar to those of second order systems, and our system reduces to a set of partial differential equations (which codify the couplings under consideration) and the boundary conditions.

### Implementation

Generally, several embodiments of photomechanical actuators (acting as mechanical oscillation actuators) are considered as part of this invention.

Photochemical Element: At the core, our devices make use of photomechanical elements (e.g. LCEs or Azobenzene Polymers) as a mechanical actuator. In the case where the device is to be used within concrete structures, the element material is selected to ensure adequate performance at the range of temperatures experienced in concrete and based on their response time and power output (which will dictate the frequency and power of the mechanical oscillation they are able to drive into the medium).

Geometry: The geometry of the photomechanical element will depend on the particular embodiment and configuration, but may include plates, discs and membranes, spheres, ellipsoids, cuboids, polyhedrons, convex and/or concave surfaces or shapes and more.

Input Photonic Excitation: These photomechanical elements are excited using one or more light sources such as LEDs or lasers, that are able to apply an incident light wave with time varying electric and magnetic field strength (e.g. intensity modulation of the light beam, which might take the form of sine waves, multi-sines, pulses, delta functions, and generally any other input excitation signal). The light sources may be RGB LEDs, or single dye LEDs, lasers, broadband light sources. The light source may be tunable (e.g. through electrically controlled tunable filters, such as large area MOEMS Fabry-Perot filter), to determine the wavelength/frequency spectrum and intensity of the incident light at different times.

The frequency of light intensity modulation may be sweeped (to generate a mechanical sweep). The wavelength of incident light may be sweeped over time (to characterize the wavelength response of the system). Other more advanced techniques may also be employed (e.g. multi-sines or other input signals). These various sweeps may be electrically controlled by an MCU.

Resultant Mechanical Excitation: The input light generates a pressure/deformation of the photomechanical element (the particular mode of deformation may depend on the material chosen, its configuration, and its response function). The element may be configured to generate any number of mechanical deformations based on different types of incident light (e.g. wavelength(s), intensity modulation frequency and shape, beam width etc.).

Host Material Characterization: In the case where the photomechanical element is embedded in another material (e.g. a building material such as concrete—the ‘host material’), it may be bonded (either directly, or through one or more other materials or coatings) to the host material to ensure good adherence.

This host material response to the mechanical excitation will be measured (i.e. with a sensor) at different frequencies, for example to determine the frequency dependence of mechanical impedance of the system (so called ‘photomechanical impedance’ or ‘electrophotomechanical impedance’ spectroscopy). These characteristics can be used to then determine material properties (e.g. the material's dynamic modulus, and from there determine the static modulus or compressive strength).

Photomechanical Resonance: Some photomechanical element geometries may exhibit resonance modes at particular frequencies when excited with incident light (akin to the piezo resonances mentioned earlier).

Photomechanical Composite Resonances: Photomechanical composites are also considered (wherein a photomechanical material is bonded with a passive second material). This imposes boundary conditions on the system, which can be used to enhance resonance peaks. These photomechanical composites include photomechanical elements bonded to waveguides, places in cavities, membranes etc.

Arrays: Photomechanical elements may be disposed in arrays (e.g. in a large area LED light, or with each photomechanical element mounted above its own LED-light source). These can be used to construct beam-forming device, and adaptive directing of mechanical actuation into the material (through various in phase or phase shifted superpositions of actuators). These arrays can be configured in a 2D configuration, or in multiple directions (e.g. dodecahedron geometry, with actuation facing inwards). These arrays may span multiple devices (each with one or more single element), or one or more devices (each with plurality of elements).

Adaptive spatiotemporal optical actuation: One particularly advantageous and inventive embodiment of the photomechanical elements is that they can be spatially adaptively actuated. This means that instead of physical arrays, a body of photomechanical material can be adaptively illuminated at different positions (e.g. placed on an LED plate that is able to adaptively illuminate different regions of the plate with different intensities and wavelengths of light). This allows control of various excitation modes, which may be used for tomography, or to create various resonances, simply through custom light patterns across the element. This can be used to create resonance modes, with no containers, frames or any custom shape required. The shape can be dynamically created, and modified, based on various illumination conditions (which may include a component of continuous illumination-so called ‘dc light’- and an oscillating component, optionally wavelength dependent too). Generally, most of the techniques described for piezo-electric and CMUT devices can also be applied to the photomechanical device.

### Mechano-Luminescent Sensors

### Introduction

A third example of opto-mechanical coupling takes the form of mechanoluminescence. Mechano-luminescent materials emit/generate light based on mechanical forces applied onto them, which means that they can be used as sensors of mechanical deformations.

Types of Mechanoluminescence: Various forms of mechano-luminescent materials exist, including piezo-luminescent materials (which emits light when deformed), and triboluminescent & fractoluminescent materials (which emit light when the material experiences fracture). Piezo-luminescent materials may either undergo plastic or elastic deformation. We are most interested in piezo-luminescent materials with elastic deformations, as the deformations are reversible, making them most promising for sensing purposes. However the description and embodiments in this section should be seen to apply to any mechano-luminescent material.

Luminescence Effects: Generally, luminescence in material occurs when excitons (excited electrons) spontaneously drop from a higher energy band (e.g. the conduction band) to a lower energy band (e.g. the valence band), for non-thermal reasons. This leads to radiative emission of photons. The energy difference between the electron energy levels determines the wavelength of the emitted photon. Materials can luminesce as a result of various initial excitations, including chemiluminescence (caused by a chemical reaction), electroluminescence (caused by electric stimuli), photoluminescence (caused by incident light) and mechanoluminescence (caused by mechanical displacements). We are principally concerned with mechanoluminescence in this section. The present disclosure does, however, note that these other forms of luminescence are contemplated as sensing techniques for our devices too.

Mechanoluminescent Element Material Choice: Materials that exhibit strong elastic piezo-luminescence are of most interest. Particular examples include Zinc Sulfide (ZnS) crystals doped with Copper (Cu) or (Mn), or Strontium Aluminate (SrAl2O4) doped with rare earth elements. They are optionally embedded in a polymer matrix (e.g. Polydimethylsiloxane/PDMS). They can also be dispersed in an elastic matrix, such as a silicone elastomer. Alternatively, they can be doped into Silicones. All of these create flexible, elastic optical elements, which would be particularly suitable for mechanical pressure sensing.

### Theoretical Framework

Physical Mechanism: The mechanism which leads to mechano-luminesence is not fully understood. For example, for ZnS, two theories may exist: (1) electrostatic interactions between dislocation and filled electron traps: the mechanical deformation distorts the defects in the crystal, leading to a change in the recombination band, increasing the likelihood of spontaneous emission; or (2) the piezoelectric effect inducing electron detrapping: ZnS is piezoelectrically active. When it is subject to mechanical stress, the piezoelectric effect will generate an electric field, which can provide enough energy to detrap electrons from trapped states, which leads to light emission. Whilst the fundamental cause of the effect is not yet fully understood, the phenomenon can be used for sensing.

Mathematical Formalism: Mechanoluminescence can be described mathematically using similar non-linear series (in this case, the relationship between the applied mechanical stress or strain and the resulting electric field is expressed in terms of tensors and a series expansion).

### Implementation

System Description: The implementation of our mechano-luminescent sensing device is similar to the prior two examples. A mechano-luminescent (ML) element is produced (using the methods described prior—e.g. a ZnS:Cu embedded into a PDMS), and installed into a device, alongside a photodetector (e.g. a CCD or CMOS camera) and various optical systems and analyzers (to enable analysis of any output light). Other features of the device include an MCU, battery, communication interface, etc. (as described prior).

Geometry & Contact with Host Material: The ML element is designed to be embedded in a host material (e.g. concrete as it cures). It can take various geometries and topologies (such as those described for the photoelastic element). It can also be bonded to another material (for protection, and to magnify the impact of any stress), which itself is then in contact with the host material.

Light measurement: When the ML device, and hence the ML element is loaded/stressed (as a result of strains in the host material, which may occur due to an excitation signal), it generates light. The photodetector and optical systems/analyzers are used to detect one or more of the intensity, spatial distribution (within the element), the wavelength/wavelength distribution and polarization of the light emitted by the element, and any other related parameter. This can be used to determine characteristics of the material.

Advanced Light Analysis: In some embodiments, advanced tunable filters (e.g. MOEMS based Fabry-Perot filters) may be used to determine the wavelength generated. Likewise, the hyperspectral devices described elsewhere may be used to generate a hyperspectral cube of the mechano-luminescent material.

Arrays: ML materials can be disposed of in arrays, which allows for spatially and time dependent distributed strain sensing. As parts of the array are deformed, different light intensities will be distributed across the array.

Adaptive spatiotemporal optical sensing: Likewise, a single ML element may be deformed differently at different locations based on the applied force. Through the use of one or more cameras, the luminescence can be triangulated within the material, which can be used to reconstruct a spatially distributed, time-evolving strain/stress field within the material.

### Laser-Induced Mechanical Waves

Another form of Opto-Mechanical actuation involves the use of a laser (e.g. such as the laser in our LIBS-based device), directed at a surface, to induce a mechanical deformation or wave. The generated wave can be longitudinal, transverse, or surface waves depending on the mode of the laser excitation and the properties of the material. For example, in some cases, a plasma is created, which can lead to a blast wave.

Generally, the same principles and use cases described under the photomechanical actuator are considered for a laser-induced actuator. A particularly advantageous aspect of this method is that in some high frequency E&M spectroscopy techniques, such as LIBS, a laser already forms part of our devices, and can thus be repurposed for mechanical wave generation. This allows characterization of the properties (including compositional properties) of the cement matrix using light-based spectroscopy and of the mechanical properties of the aggregate using mechanical impedance spectroscopy.

### Constructing an Opto-Mechanical Actuator & Sensor

Four opto-mechanical techniques and embodiments related to them have been described. Two of them can be used for mechanical sensing, and the other two for mechanical actuation. Other (non-optical) based mechanical sensing and actuation methods can also be used to complement them. These base components can be used to construct an Opto-Mechanical actuator & sensor (a system, made up of parts which individually may not exhibit reciprocal couplings, but together, do exhibit a reciprocal coupling). Several embodiments of this are described below. This same concept can be applied to any system of sensors & actuators.

This optomechanical actuator and sensor can be used to apply various mechanical and electromagnetic wave-based sensing techniques. In particular, it can be used to implement any of the techniques or devices herein that require both mechanical excitation/actuation, and sensing (such as mechanical impedance spectroscopy characterization, for example, through the use of resonating cavities or waveguides etc.). In addition, some of these embodiments are particularly advantageous in array-based, or ‘pseudo’-array configurations. The latter referencing the unique adaptive spatiotemporal optical sensing and actuation capabilities described above. In an actuator & sensing system, these open up several new groundbreaking use cases.

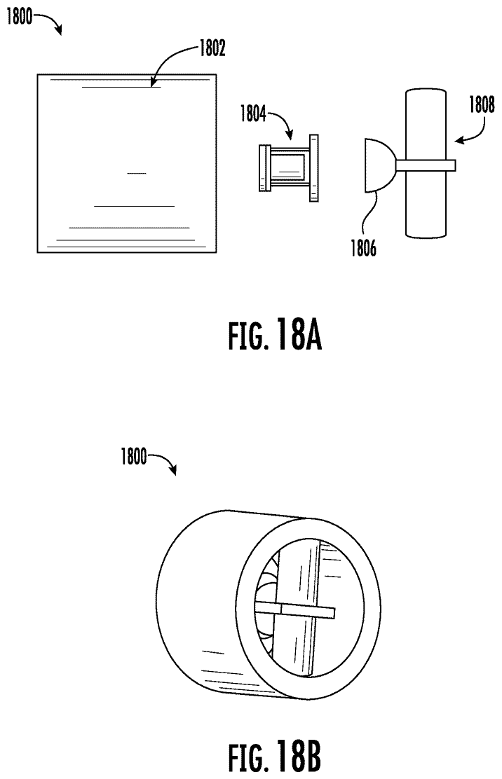

With reference to FIGS. 18A-18B, an example optomechanical sensing and electromechanical actuation device 1800 is illustrated. As shown, the device 1800 may include electromechanical actuator 1804 (e.g. an electromagnetic speaker or piezoelectric material) placed within a resonating cavity 1802 (e.g., with an open face to allow concrete to flow into it). A photoelastic-based polariscope 1808 as described herein may be mechanically coupled with a mechanical wave concentrator 1806. As stresses are experienced by the photoelastic element in the polariscope, they are measured.

By sweeping across excitation frequencies (or driving a series of pulses, multi-sines etc.), the frequency response of the mechanical impedance of the coupled system can be determined (so called Optomechanical impedance, or electro-opto-mechanical impedance).

### Electromechanical Sensing & Optomechanical Actuation

Conversely, the mechanical excitation can be driven by an optomechanical actuator (e.g. through laser induced breakdown, or through a photomechanical material), and then sensed using electromechanical sensing techniques (e.g., through the use of a piezoresistor installed in proximity of the actuator).

For example, a disc-shaped PCB (with a coin cell battery holder on the bottom face, and the MCU etc. on the top face, may then be connected to an LED light disc of the same diameter. A photomechanical disc (again, of the same diameter) may be bonded & stacked onto the LED disc. This assembly is then mounted into the cylindrical resonator. The MCU is able to actuate the light disc (through various modes of light), which excites the photomechanical material, leading to mechanical oscillations. One or more piezoresistors, or foil strain gauges (e.g. interdigitated electrodes) are installed at various locations within the resonator (forming an N-port network), from which the transfer function, and electromechanical impedance spectrum can be measured. The resonance frequencies are identified, which can then be used to determine the dynamic modulus, static modulus, compressive strength of the host material, and other characteristics of the material under consideration.

### Optomechanical Sensing & Optomechanical Actuation

Optomechanical sensing and actuation may be combined, to form one system that is able to mechanically excite the host material, and sense the displacement caused by those excitations purely through optical means. In different configurations this may represent a 1-port, 2-port or N-port system. Impedance spectroscopy, or T, S parameter analysis may be carried out.

### Systems of Distinct Optomechanical Sensors and Actuators

In one embodiment, this is achieved through a system made up of one or more opto-mechanical actuators (as described above) and one or more opto-mechanical sensors (as described above), in spatial proximity to one another (e.g. bonded to a waveguide, or placed within a cavity, to generate resonances). Possible combinations include: a photoelastic sensor and a photomechanical actuator, a mechanoluminescent sensor and a photomechanical actuator, a photoelastic sensor and a laser mechanical actuator, and/or a mechanoluminescence sensor and a laser mechanical actuator. Various configurations of the above exist, and they can be analyzed as an N-port system of mechanical actuators and sensors.

### Optomechanical Composites

A particularly innovative aspect of the invention is the design of optical composites that exhibit a combination of photomechanical activity, and at least one of the photoelastic effect or mechanoluminescence. These may take the form of distinct materials bonded to one another at the macroscopic scale (which may be encapsulated in one another). For example, a photoelastic element of volume V1, which contains a photomechanical element within it of volume V2<V1. The photomechanical element is intrinsically bonded, optionally with an impedance matching layer into the photoelastic element. Incident light on this composite optical element will activate the photomechanical effect in V2, but also experience the photoelastic in the remainder of the volume V1. The same type of system can be implemented but with a mechano-luminescent element rather than a photoelastic element. The specific geometry in this case is only illustrative. Either material may encapsulate the other material, or they may be adjacent to each other (and bonded through a boundary). They may be interlaced etc.

This brings us to another embodiment: the embedding/dispersion (ideally fully isotropically, at the microscopic scale) of an opto-mechanic sensing material (either mechano-luminescent or photo-elastic in nature) in a photomechanical material, or vice versa, or the embedding/dispersion of both into another element (e.g. into a polymer matrix such as PDMS), or another combination of materials that yields a combination of photo-mechanical and mechano-luminescent, or photoelastic properties, to create a resulting smart material that exhibits photomechanical properties, and also acts as an opto-mechanical sensor.

The combination of a photomechanical material with mechano-luminescence would create a reciprocal coupling/transducer (that generates light when mechanically stressed and is mechanically stressed when light is incident on it). This is an example of direct energy conversion reciprocity. The combination of a photomechanical material with a photo-elastic material creates a mutual influence reciprocity (acting as an active transducer in one direction, and a passive sensor in the other).

### Doped Optomechanical Transducers

Finally, doping of photo-mechanical elements with mechano-luminescent or photo-elastic materials is also considered, or doping with an element which may create such properties. Or doping of a semiconductor (or similar) with components of photo-mechanical elements and of mechano-luminescent or photo-elastic materials.

### Implementation of Composite & Doped Optomechanical Transducers

These composite or doped optomechanical transducers can either exhibit positive or negative mechanoluminescence (where positive mechanoluminescence leads to an increase in luminescent properties upon deformation and negative a decrease).

This may, in practice, take the form of integration of mechano-luminescent (ML) materials into the matrix of a liquid crystal elastomer (LCE) or azobenzene polymer (AP). In one embodiment, a mechano-luminescent material that emits light outside of the range of absorption of the liquid crystal elastomer is chosen, so as to avoid negative luminescence feedback loops (where the light created by the ML is absorbed by the LCE or AP).

### Use Cases for Composite & Doped Optomechanical Transducers

These novel composite and doped materials are an entirely new category of photonic smart materials, that have wide-reaching applicability, both for the determination of material properties such as concrete (through sensing/actuation), but also much more broadly in photonics and photonics circuit designs. Their combination with photonic waveguides and other photonic sensing techniques in particular will lead to particularly interesting use cases. They are a new class of components for photonic circuits. In particular, miniaturization (e.g. through thin-films) will form the basis of a number of ‘MOMS’ (Miniaturized Optomechanical Systems) which could pave the way for photonic/optical computing.

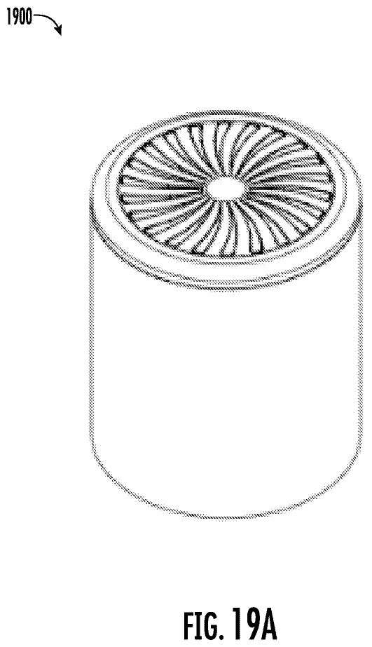

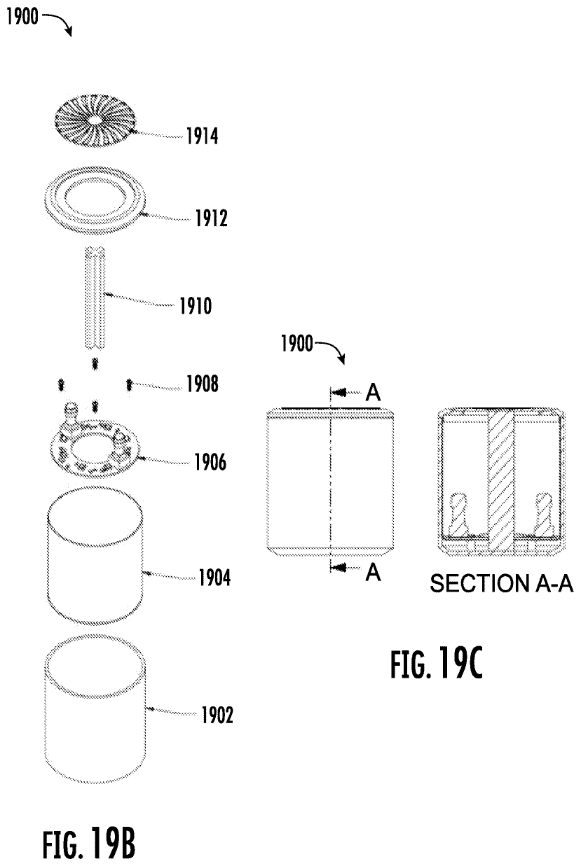

With reference to FIGS. 19A-19C, an example opto-mechanical transducer device 1900 is illustrated. As shown, the device 1900 may include an outer housing 1902, a reflective sheath 1904, a PCB 1906 supporting LEDs and cameras, screws 1908, a photomechanical polymer 1910, a lid 1912, and a diaphragm 1914. The device 1900 may employs combination of opto-mechanical sensing and actuation) and may include photo-mechanical polymer 1910 (e.g., shaped beam) that expands in volume (particularly along its length) when exposed to light, mechanically coupled to a diaphragm 1914 made of a photoelastic material (which may exhibit birefringence when stressed). These components, alongside electronics PCB 1906 (to electro-optically couple the system), a light source on the PCB 1906, optionally, a polarizer or polariscope, and a wireless communication interface are used for mechanical actuation and sensing, and are disposed in a cylindrical enclosure 1902, wherein the diaphragm may be in contact with a material of interest.

When light from the light source is incident on the photomechanical cross-shaped beam 1910, its dimensional increase will push onto the diaphragm 1914 and excite the material on the other side (the host material of interest e.g., concrete). In order to maximize the light energy used to trigger a shape change in the beam 1910, an internal reflective sheath 1904 may be placed on the inside of the device's 900 cavity. When the forces are applied to the host material 1910, this results in stress and strain forces on the diaphragm material 1914 that can be detected by the polariscope cameras. These cameras and filters work alongside light emitting diodes all of which sit atop a printed circuit board 1906.

The PCB 1906 and light source are on the opposite end of the device 1900 (with the light source pointing towards the photomechanical beam 1910 and photoelastic diaphragm 1914). As a result, in addition to shining light on the photomechanical material 1910, light is also incident on the diaphragm 1914. The cameras and polariscope on PCB 1906 can analyze the polarization, color location and intensity of the light reflected back from the diaphragm 1914. By doing so, the system 100 can detect certain mechanical properties of the material on the other side such as viscosity, Young's modulus. This may provide an advantage over electromechanical transducers, in that strain and stress can be mapped spatially. In different embodiments, the photomechanical material may span a larger area, and LEDs may selectively illuminate it to also adaptively excite the system in space.

### Miscellaneous

The embodiments have been focused on electromechanical, electro-magneto-mechanical and opto-mechanical techniques (which enable mechanical actuation and sensing, through those smart materials and their couplings). However, the invention does not limit itself to these techniques, and it should follow to one skilled in the art, that similar embodiments can be derived from magneto-mechanical couplings (e.g. through the use of magnetoelastic and magnetostrictive materials as actuators and/or sensors), thermo-mechanical couplings, or for that matter any other coupling into the mechanical domain. Two more embodiments are provided below.

### Balloon Embodiment

In comparison to solid-state transducers embedded in the materials under test such as concrete this invention allows for mechanically coupled sensing where a bladder or balloon is embedded in the curing concrete and pressure waves are applied to it from within via a sealed tube via either gas (compressible) or liquid (incompressible).

### Gas-Based

In the case of the gas-based mechanical coupling, a medium to high power wave generator would drive an electrical to mechanical transducer such as a speaker, sub-woofer or tweeter which would be connected to the tube or pipe that would sit within or on the surface or the material under test (e.g. such as a stethoscope in both directions where pressure waves from the material would be detected as well as music pushed through the ear pieces would produce a mechanical movement on the semi-liquid material and the energy required to reach a displacement would be measured as well as the displacement itself). A pressure sensor (e.g. microphone) would ascertain the increase in pressure due to the mechanical impedance at the bladder side.

### Incompressible Liquid or Gel-Based

Same as the above however not having to deal with the 2nd order and non-linear effects of a compressible gas within the tube and bladder while having to factor in for mass and viscosity of the liquid or gel. The passive reading of pressure changes within the material can still be achieved as well as the active mechanical impedance be measured by monitoring the achieved driver displacement for the given energy provided. In addition, second order effects of the spring and damper effects of the material surrounding the bladder can be measured by monitoring the phase delay at various frequencies and calculating the underlying transfer function between excitation signal and sensed signal back.

### Ferrofluid Transduction Embodiment

In another embodiment, a mechanical transducer is constructed using ferrofluids (or any magnetically susceptible fluid), and a magnetic actuator and sensor element. The magnetic field can be generated by an electromagnet (e.g. a series of coils, such as those used in the EMAT transducer). And the magnetic field distribution can be sensed by a hall effect sensor. The adaptive spatio-temporal actuation and sensing features of the optomechanical systems apply to this embodiment too (as the ferrofluid can be spatially excited and/or sensed). In this embodiment, adaptive transducer geometries can be constructed using different magnetic field configurations, which will excite the ferrofluid in different modes. This enables different geometries which may experience different resonance modes. The enclosure of the sensor & transducer would be made of a magnetically transparent material, and the ferrofluid would be contained between two windows or in a polymer/flexible pouch that can deform based on applied magnetic fields.

### Conclusion

Above, we have outlined techniques and related embodiments that employ smart materials or elements that enable sensing or actuation through couplings into the mechanical domains. Our methods and devices make use of input excitation signals to generate mechanical excitations (coupled into a host material) and measure the response of host materials (such as construction materials, e.g. concrete).

They then measure the mechanical response of the host material, through smart materials that couple from mechanical to other domains (these sensors may also be the actuators, or they may be distinct. They may be spatially collocated, or in an N-port configuration). This enables the determination, for example, of the mechanical impedance and its frequency response (so called mechanical impedance spectroscopy). From these, resonance peaks can be determined, which can be used to calculate the dynamic modulus of the host material. The impedance spectrum and resonance peaks can be used to further characterize the material (e.g. to assess its compressive strength). Several other parameters can also be sensed, such as S-parameters or T-parameters (for N-port networks), polarization, intensities, wave velocities and time of flight, dispersion relations, refractive indices and so on.

Resonators can be created, which enhance resonance modes of the host structure in our measurements. This can be achieved through composites that bond active mechanical elements to frames, or place them in or near cavities, surfaces or integrate them into volumes made of non-active materials. Resonance modes can also be created or enhanced by shaping mechanically active elements in particular resonant geometries (e.g. ring shapes, tuning forks, or bowls).

The devices include battery-powered, ultra-low-power, wireless embodiments that are able to communicate with personal devices and with the cloud, with sophisticated signal processing on the device, on smartphones, and on the cloud.

And finally, our opto-mechanical techniques and embodiments make use of light in an unprecedented way to characterize building materials, using implementations that in some cases are far easier to implement and lower cost than optical fiber sensing, and have much higher precision to static and dynamic loads than electromechanical methods (with very little drift). Novel smart materials are also conceived, which have far reaching applicability in other fields (e.g. photonic circuit design and photonic computing).

### E&M Wave-Based Sensing Devices

### Intro/Categorization

Materials properties can be characterized based on the impact of time-varying electromagnetic fields on material properties (actuation), and the impact of the material on those electromagnetic fields (sensing). Electromagnetic wave-based sensors are in essence probing a coupling between the material, and the time varying electric or magnetic field.

Materials can be excited, using a variety of electromagnetic input signals, such as time varying electric fields (e.g. alternating currents or voltages), time varying magnetic fields, or of electromagnetic wave propagation. They can also be sensed using similar signals. Some devices are able to act as both excitation sources/actuators, and sensors.

Time-varying magnetic fields induce electric fields. Time-varying electric fields induce magnetic fields. But these oscillations do not always lead to significant wave propagation in a medium (waves may decay), due to the permittivity (ε), permeability (μ) and conductivity (σ) of the medium. In materials with high conductivity, σ, electromagnetic waves are heavily attenuated. The electrical field induces current into the material, which dissipates energy as heat due to resistance. In dielectric materials (low conductivity), E&M waves can propagate with less dissipation at higher frequencies. However, at lower frequencies, even these dielectrics will absorb energy (dielectric losses), for example due to polar molecules which align with the electric field. This means that excitation at different electromagnetic oscillation frequencies leads to different phenomena in the material.

The present disclosure categorizes E&M wave-based sensing techniques along the frequency domain as follows:

Low Frequency Excitation & Sensing: from zero up to the frequencies where time-varying electric and magnetic fields begin to exhibit wave propagation in the medium. The frequency at which this occurs will depend on the material under consideration (including its permittivity, permeabilities and conductivities). For practical purposes, we define this dynamically, as the frequency where electromagnetic waves begin to propagate within the medium with an attenuation of less than 1/e. At these low frequencies, wave propagation is not dominant (due to their interaction with dipole moments etc.). When exciting dielectric materials like concrete, this band can be split into Electrochemical and Magnetochemical depending on whether electrical or magnetic fields are predominantly driven by the actuator or drive the sensor's response. Electro-Magneto-Chemical couplings may also be employed.

Mid Frequency Excitation & Sensing: This is where electric and magnetic fields begin to exhibit a tightly coupling interaction, allowing electromagnetic waves to propagate effectively in the medium. It encompasses frequencies where E&M waves can travel more than a few wavelengths before attenuating by 1/e and extends up to the beginning of the infrared spectrum. As such this band contains what is commonly referred to as Radio Frequency, Microwaves and Terahertz frequencies.

High Frequency Excitation & Sensing: This is where electric and magnetic fields begin to interact with molecules and atoms in the media, which begins to impede wave propagation. Frequency band starts somewhere in the Infrared Spectrum and includes any frequency beyond it (so infrared, visible, ultraviolet, x-rays and gamma rays). At these frequencies, due to the lower wavelength and higher energy, interaction with the material happens at the atomic or particle level, which leads to different techniques.

The categorization above is not strict, and certain sensing or actuation techniques may span more than one category, or the boundaries of each category can in practice be fuzzy. Generally, techniques that have been considered under one category, may be applicable to another category.

Low Frequency (Electrochemical & Magnetochemical): in the low frequency domain (A few Hz, to the few low MHz domain), electrochemical and magnetochemical effects will dominate in materials like concrete. As such, this section focuses on methods and device embodiments that make use of electrochemistry and magnetochemistry and their associated couplings. The principal method disclosed is the characterization of impedance through electrochemical impedance spectroscopy. For example, as concrete cures, there will be less free ions in the medium (as the hydration progresses free ions are used up). Concrete pores will also begin to form, which will impede the flow of ions. Electric potentials and current in concrete are based on the movement of ions, the rotation of dipoles, and of any electrons excited into free states. These different modes of charge transfer will lead to different electrical impedances at different frequencies. The frequency response will vary over time as the concrete cures, which can be used for material characterization. For example, compressive strength is correlated to pore size, which will be one of the determinative factors of the electrochemical potential. In addition, these techniques can be used to probe rebar, and rebar corrosion, to better understand longevity of structures.

Below are described electrochemical wave-based sensing techniques and embodiments, magnetochemical techniques and embodiments, followed by specific example embodiments. It is worth noting that there are also other low-frequency-based wave-based sensors which can be constructed based on other couplings (e.g. thermal excitation and response monitoring).

### Electrochemical

Devices employ several methods to measure electrochemical potential, which are described non-exhaustively below.

Single-plate system. A single electrode, plate or volume disposed within or on the material under consideration is disclosed as a particular inventive embodiment. In particular, a single plate that spans a surface area A or a three-dimensional electrode that spans a volume will develop a charge and current distribution when excited by an AC signal, based on the location of the two contact points on such plate or volume and the properties of the plate material. This can act as an electrochemical cell. Various geometries are contemplated (plates, bars, rods, rods encircled with coils, surface areas or volumes with containers or cavities, as well as extrusions). These are made of various materials (in particular, conductors as described further below, or dielectrics, or semiconductors are considered). Optionally, the single plate/volume may be made of a plurality of materials (e.g. a composite made partially of one or more insulator, or one or more conductors, or one or more dielectrics, or one or more semiconductors, or any of their combinations). The plate or volume may also be machined or micromachined (in the case of a miniaturized system) to generate or sense particular field line patterns (which may constructively or destructively interfere to generate standing wave modes in the electrochemical system). These are ‘ion-movement’ resonators. In a further, advanced embodiment, the single plate or volume is made of individually controllable variable resistors/capacitors/inductors or transistors (or any combination thereof), which allow for the control of the characteristic impedance distribution of the plate or volume (optionally through traces on the plate or volume), so as to promote various chemical excitation pathways within the material. Transistors and semiconductors packages can be used to achieve this (e.g. silicon chips, where each transistor is individually controllable). Patterns may be etched on such semiconductors.

Two electrodes. Two or more electrodes or plates where a differential signal is sent and/or measured across two electrodes. Various configurations exist (e.g. one excited electrode, and one reference electrode which may act as a ground or negative charge accumulator, optionally a third control electrode. Alternatively a floating differential output is used, so as to measure both the common mode (DC) impedance between the two electrodes and ground from two representative locations as well as the differential impedance between the two electrodes.

Single vibrating electrode—In addition to the above, an electrochemical probe can be placed at the surface or tip of a vibrating transducer (e.g. using the mechanical transducers described in that section), to allow the measurement of changes in electrochemical impedance (e.g. the surface impedance of the medium, through scanning vibrating electrode techniques—also known as SVET). The use of SVET techniques to characterize concrete is a particularly inventive electrochemical embodiment.

Interdigitated Sensors. In addition to the above, interdigitated sensors, which can also be used to detect displacement, vibration waves as well as torsion, can also be used as flex electromechanical impedance sensors. In case these have bare conductors exposed to material their interdigitated nature helps to average out any hyper-local artefacts such as the presence of aggregate, air bubbles or more liquid areas.

Magnetically Induced & Detected EIS: In another embodiment, an electromagnet (e.g. a series of coils) is used to induce an alternating current into one or more electrodes or plates (of any of the types described above). This employs a magneto-electric coupling, which enables non-contact plates or volumes/electrodes. The various materials, shapes and volumes described in the sections above and below may be used for the electrodes (including etching or machining to create specific patterns).

Electrochemical Tomography: Another embodiment includes spatially distributed electromechanical tomography devices made up of a plurality of spatially distributed electrodes (distributed across either one or multiple devices), or one ‘etched’ or machined electrode (as described above) where charge distribution is tunable. Electrochemical Impedance Response is characterized across 3D space over time by testing one to one, many to one, one to many and many to many electrode to electrode (or contact point) impedances. Alternatively, the S and T parameters of the system of electrodes (which is an N-port system) can be characterised. All of this is done at a plurality of frequencies.

In one example, this is done through the ‘cube’ embodiment (described in more depth later). Electrodes placed at each vertex of a hollow cube. Impedance is measured across each pair of vertices. One face of the cube may be open, and the other faces cube, acting as a local container for concrete to flow into, which is isolated for electrochemical analysis. More sophisticated configurations can be achieved by combining multiple electrodes to excite and sense in order to achieve a more planar measurement. E.g. between two opposing sides of the ‘cube’ by using the four vertices on each opposing side.

Generally, the devices can carry out electrochemical measurements in various mechanical configurations (all geometries described in this document for any transducer applies—e.g. array planes (discs or patch arrays), concave or convex shapes equipped with a plurality of electrodes, as well as quasi-spherical or cuboid geometrical transducer arrangement structures. Likewise, a string or plate of electrodes can be installed to align the edges of the cube, to provide a 3-dimensional mapping system for electrochemical impedance inside the cube at different frequencies. A 2D array of electrodes that are embedded across one or a larger part of the formwork has also been considered to enable tomography and spatial mapping of electrochemical impedance (see ‘smart formwork’).

In another embodiment, the system uses electrochemical tomography for detailed 3D mapping, imaging and spatial analysis of electrochemical parameters such as impedance. This is realized through spatially distributed networks of electrodes (e.g. electrode arrays). Advanced algorithms process the data to visualize and identify anomalies such as cracks, voids, or corrosion within the structure, and the evolution of the pore structure (which is closely related to ion flow when low frequency oscillating E fields are applied). Advanced algorithms can also be used to reconstruct the aggregate and cement matrix distribution through these advanced tomography techniques. The device can be configured in a modular sensor (e.g. the cube) or actuator array. Arrays may be two or three dimensionals (and generally follow the same principles outlined in the mechanical wave-based sensors).

### Instantiation

Materials and Configuration: The sensors and actuators (probes, plates, volumes) are primarily composed of high conductivity and corrosion resistant, inert materials—e.g. stainless steel, titanium, conductive polymers, gold, platinum, or graphene. This ensures that their reactions with the host material are reversible and linear (e.g. no corrosion). The electrodes are configured in a variety of shapes, including plates, spiral or fractal patterns, to enhance the surface area and improve sensitivity. Finally, in some embodiments where it may be advantageous to induce corrosion, corrosive materials may be used.

Coatings: To enhance performance and durability, the sensors and actuators may be coated, including through, hydrophobic coatings, epoxy resins or polyurethane coatings, nanoscale protective layers such as graphene oxide or a conductive polymer. This enhances durability of electrodes against harsh environmental conditions and prevents fouling.

Microelectromechanical Systems (MEMS) Integration: The device integrates MEMS technology to create miniaturized electrodes and actuators (e.g. through micromachining). This integration allows for precise control of electrode positioning and movement (or in the case of plates/volumes, particular features of the single electrode system). This can enhance the resolution of measurements, especially in spatially resolved tomography.

Ion Species Sorting Embodiments: Custom volumes or surface areas can be used to enable ion sorting (where custom ion wells or grooves are constructed within our plates or volumes of varying geometries). The varying properties of the wells attract different ion species, and allows our devices to carry out ion sorting, as a form of species electrochemical spectroscopy. This concept can also be achieved microscopically or macroscopically (with micromachining, or regular machining or additive manufacturing of electrodes/plates/volumes to probe the material). This heavily leverages semiconductors (e.g. silicon packages, where individual transistors are electrically controllable, in customized geometries).

Multi-Frequency Excitation and Detection: The system can operate in both active and passive modes. The device is capable of operating across a wide range of frequencies, enabling multi-frequency electrochemical impedance spectroscopy. Excitation signals include single sines, multi-sines and others (as described in the general techniques section). Given the low frequencies of electrochemical analysis, the use of multi-sine input excitations, and other multi-frequency pulsed signals is particularly advantageous to reduce measurement time. Detection can occur while or after an excitation has been generated, or passively.

Dynamic Electrode Positioning System: A dynamic electrode positioning system is incorporated, allowing for automated adjustment of the electrodes' positions relative to the material under test. This system can reconfigure the electrodes in real-time to optimize the measurement accuracy and resolution based on the material's response.

Specific Attachment Considerations: The attachment method or enclosure may establish an electrical coupling with rebar to provide common ground/earth for electrochemical devices, or to be used for corrosion estimation (or even to carry signals between devices).

Aggregate Interference: Aggregate materials in concrete can interfere with readings. Averaging methods (e.g. across systems of electrodes or larger individual electrodes) are used to mitigate this and produce representative measurements that are not prone to local inhomogeneities.

Sensor Isolation & Compensation: To ensure accurate readings, sensor isolation (e.g. in pours, in particular away from the rebar to ensure the concrete mix is being considered). This includes physical isolation using materials like rubber or foam and electronic isolation through circuit design. Isolation prevents external vibrations or noise from affecting readings.

Frames and Containers: Concrete may be isolated through concave containers or various open-faced features in our devices (or frames attached to them, made of passive, non-conductive materials). These containers isolate a volume of concrete for analysis and may contain a series of electrodes (possibly an array, or a smart ‘single-electrode’ as described above). The electrodes may be disposed within the concave region, within the container or frame itself, or in proximity of the frame.

Environmental Compensation & Control: To account for environmental factors such as temperature, humidity, and pressure, electrochemical devices include environmental sensors. These algorithms adjust the measurements to eliminate or reduce the impact of external environmental variables on the electrochemical readings. In a further embodiment, the device incorporates a temperature control system, such as a Peltier element or a thermoelectric cooler, to maintain a stable temperature environment around the electrodes. In another embodiment (envisaged for non-embedded devices), integrated pressure sensors allow the device to monitor and adjust the pressure applied by the electrodes to the material under test. This feature is particularly important in applications where contact pressure can influence the electrochemical response, such as concrete when it is still soft. The device includes vibration damping materials and isolation techniques, to enable high precision measurement on construction sites (where mechanical disturbances are significant).

Adaptive Electrode Surface Area: The electrodes are designed with an adaptive surface area, which can be modified in real-time based on the measurement requirements. This adaptation could be achieved through mechanical means, such as expanding meshes, or electrochemical means, such as surface roughening, or electrical actuation and control.

Multi-Modal Sensing Capabilities: The device is equipped with other sensors for measuring additional parameters like pH, and redox potential.

Single-Coil Electrochemical Impedance Spectroscopy System for Monitoring Concrete Properties

### Overview

Traditional electrochemistry set-ups are based on two, three or four electrode set-ups (including a working electrode, a counter, and a reference electrode). The inventors have envisaged a single electrode system that can rapidly determine accumulated change or metal resistance, polarization resistance, capacitance and more generally the real and imaginary components of electrochemical impedance and admittance.

Single-Coil: The invention comprises a single-coil electrochemical impedance spectroscopy (EIS) system designed to monitor the material properties of concrete and its curing process over time. This system is particularly useful in environments where traditional EIS systems, requiring multiple electrodes, are impractical or ineffective. The system's core component is a single coil (or a ‘smart electrode’ as described above). The coil is conductivity and designed to be inserted into concrete.

Electrochemical Impedance Spectrometer: The coil is connected to an ultra-low-power wireless, embedded device capable of applying a range of frequencies to the coil (e.g. through signal excitations methods described elsewhere) and measuring the resulting frequency response of impedance and/or admittance. The impedance spectra is analyzed, and information extracted about host material (e.g. concrete) characteristics (including curing).

Optionally this is done using a machine learning model, based on training data of prior electrochemical signatures for known materials. Resonance peaks in the spectrum may be key features in the analysis (including ratio across peaks, or how they time evolve).

Sensitivity to Concrete Heterogeneity: The single coil design is sensitive to the heterogeneity of the concrete mix, allowing for a nuanced analysis of material properties. This is particularly useful to evaluate the impact of aggregate on readings if multiple single coils are used one at a time or simultaneously to map an N-port network.

Monitoring of Corrosion Processes: The system can detect changes in the electrochemical properties of the embedded coil, indicative of potential corrosion processes within the concrete, and generally enables rapid non-destructive analysis.

Generalized Shape: Other shapes may be used (rather than coils) as contemplated in the “single electrode” section further up. Extrusions and wells within the electrode may be used to create smart electrode behaviors (e.g. ion sorting).

Circuit-Based Adaptive Electrode: traces on PCBs or flexible electronics may be used, with combinations of transistors or variable resistors/capacitors/inductors around them between conductive protrusions or extrusions (e.g. conductive plates on membranes with concave and convex features, and variable LCR components may be used to electronically tune a smart adaptive electrode to create various field patterns). Op-Amp feedback loops may be employed to amplify the signal across aspects of the system.

Semiconductor-Based Adaptive Electrode: Alternatively, semiconductor etching may be employed. E.g. ISFETs may be used, alongside wells of varying geometries and sizes (which might attract or ‘trap’ different types of ion species). Alternatively, silicon wafers may be machined so as to create a particular disposition of P and N junctions, and various traces or tracks may be installed across them.

Coupled Element Sensing: two or more electrode systems may be coupled to an element, which is itself coupled to the concrete. The electrodes are not directly coupled to the concrete. This creates a single composite element that can be used to probe concrete. The shape, geometry and materials that this composite is made of can be controlled to generate various electrochemical behaviors (including so called ‘macroscopic’ ion sorting wells).

### Magnetochemical

Magnetochemical methods are also employed in some of our device embodiments. Key aspects of materials can also be ascertained from the material's magnetochemical properties, namely their permeability as well as conductivity based on energy losses attributed to Eddy currents formed during changing magnetic fields. One example of this would be the energy losses incurred when a changing magnetic field is applied onto the surface of a material instead of free space. The changing magnetic field will generate small Eddy currents as and when the magnetic field changes in magnitude and direction. The energy from these currents dissipates as either direct heat or indirect through the generation of smaller secondary and tertiary magnetic fields and subsequent Eddy currents.

In addition, when a coil is either embedded or applied near or on the surface of the material under test the permeability of the material can be characterised by the mutual inductance (or lack thereof) perceived by the magnetic field driver as and when the coil is approached to the material or as the material changes such as curing and drying concrete. This is observed both in phase delay as well as energy losses. Similarly a two or multi-coil configuration can be used so as to monitor a coil to coil mutual inductance and permeability change due the changes in the materials in between. This can be applied directly from coil to coil or as a combination of magnetic flux guiding coils, e.g. toroidal or more complex loop forms guided to pass through specific sections of interest in the material, e.g. avoiding rebar to only monitor concrete material.

### Device Embodiment

Material Choice: The sensor is made from materials with high magnetic permeability and low electrical resistance, such as ferrite or laminated silicon steel may be used. These materials are chosen for their ability to efficiently conduct magnetic fields and minimize energy loss.

Eddy Current Analysis: Actuators and sensors designed to generate and detect Eddy currents (or Gyrator-like behavior) are placed near or on the surface of the material. The system measures the energy dissipated by these currents, providing insight into the material's conductivity. The device employs a sophisticated system for generating magnetic fields, high-efficiency electromagnets. This system can produce highly controlled and variable magnetic fields, essential for inducing Eddy currents in different types of materials. This includes coils which may be embedded within or placed on the surface of the material. Different coil geometries, such as solenoidal, toroidal, or custom shapes, may create different field patterns. The choice of coil design impacts the mutual inductance measurements and the sensitivity of the system to changes in material properties. Array-like configurations are also contemplated.

Signal Processing & Excitation: The system measures phase delays and energy losses in the magnetic field. This analysis helps in understanding the material's magnetic properties and how they change over time or under different environmental conditions (e.g. its permeability, through mutual inductance in the coils). Magnetic excitations may take the form of frequency sweeps (or any other excitation signal described herein), to identify resonance frequencies

Pressure and Force Sensing: The device incorporates pressure and force sensors to measure the contact force between the coils and the material, to control for contact pressure effects.

Multi-Coil Configurations: Multi-coil configurations can enhance the system's sensitivity and spatial resolution, for improved mutual inductance measurements. An automated mechanism is integrated to precisely position and move the coils relative to the material under test (or adaptively select from a plurality of coils). In some applications, it may be beneficial to guide the magnetic flux through specific sections of the material. This is achieved using specialised coil arrangements, like toroidal coils, to focus the magnetic field on areas of interest while avoiding interference from other components like rebar.

Environmental Compensation & Multi-Model System: Since temperature and humidity can affect magnetic measurements, the device includes environmental sensors, and compensation algorithms to adjust the readings based on environmental conditions. To gain a comprehensive understanding of the material's properties, the magnetochemical sensors can be integrated with other sensors (e.g. wave-based sensors). This multimodal approach allows for cross-validation of data and a more robust analysis.

Material Database and Comparative Analysis: The device is programmed with a comprehensive database of magnetic properties of various materials. This allows for comparative analysis and more accurate identification of material characteristics based on the measured magnetochemical properties. The system includes computational modeling software that simulates magnetic field interactions within different materials. This feature aids in predicting and analyzing the behavior of Eddy currents and the resulting magnetic fields, providing a deeper understanding of the material's properties.

### Underlying Physical Material Property Monitoring

As concrete cures, its magnetic properties change. Various aspects of its magnetic properties may be sensed.

Reluctance and/or Permeability in Different Material States: Using the concept that magnetic flux follows the path of least magnetic reluctance, sensors are designed to detect changes in reluctance and permeability of the embedded materials, thereby monitoring the curing process. Permeability is the inverse of reluctance. Given the nonlinearity of magnetic circuits, observing how the reluctance of the concrete changes non-linearly during curing could provide valuable information about its material properties.

Leakage Flux Sensing: In a magnetic circuit, not all magnetic fields are confined within the circuit, leading to leakage flux. By placing a magnetic circuit within or near the curing concrete, the leakage flux is monitored. Variations in this leakage flux can provide insights into the material properties.

Magnetic Saturation Observation: During the curing process, the point at which the magnetic flux through the concrete no longer increases (magnetic saturation) can be indicative of certain material properties. Monitoring for saturation points and changes therein can be used to assess the curing stage and quality of the concrete.

Hysteresis Curve Analysis: Observing the hysteresis curves of the concrete's magnetic properties during curing can provide insights into material changes. This analysis could be particularly useful in understanding the behavior of concrete that includes ferromagnetic materials (e.g. steel fibers).

### Example Embodiments of Electro-Chemical and Magneto-Chemical Sensing

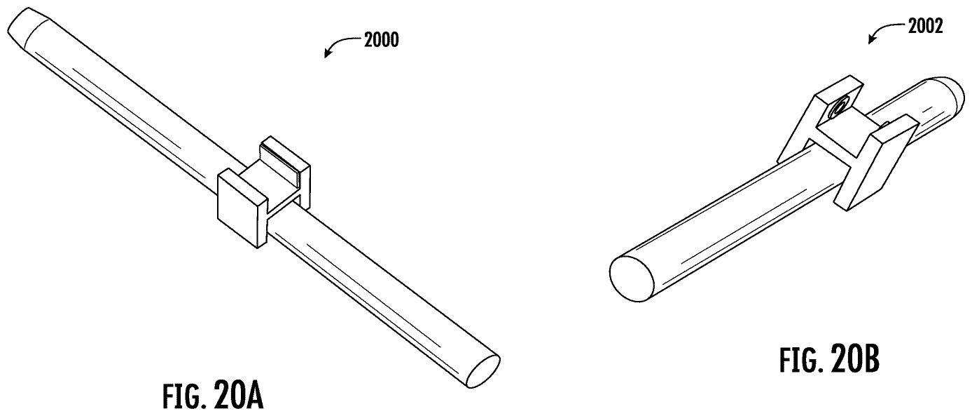

With reference to FIGS. 20A-20B, an example capacitive sensor device 2000 and an example inductive sensor device 2002 are shown. In FIG. 20A, the capacitive sensor 2000 may be connected, within the enclosure of the device, to a known inductor and/or resistor, to form an LC, an RC or an LCR circuit, and characteristics (such as the resonance modes of this circuit) are determined by driving a plurality of signals into it and detecting resonant modes. In yet another embodiment, a coil and/or electromagnet is placed in proximity of the capacitive sensor device. An alternating current is used to excite the coil and generate an alternating magnetic field, which can induce currents and voltages in the electrochemical cell. The induced currents will depend on the impedance of the electrochemical cell. By measuring and analyzing how the induced currents or voltages vary with frequency, the impedance spectrum of the cell can be inferred.

As shown in FIG. 20B, the inductive device 2002 may be mounted on top of a rebar. The device's most important feature is the presence of 2 flat coils facing each other in an area that would be filled with concrete during the pour, to measure the permeability. These can be repurposed from inductive charging systems, making them easily procurable. In this design one coil will be excited by an AC current inducing a secondary current in the second coil. The mutual inductance is related to the permeability of the material in between the 2 coils. Hence the permeability can be derived by measuring the induced secondary current. Alternatively, this inductive system may also be used to determine characteristics of the rebar (including corrosion, which may influence its permeability.

### Spatial Inductive Tomography for Magnetic Permeability Analysis of Concrete

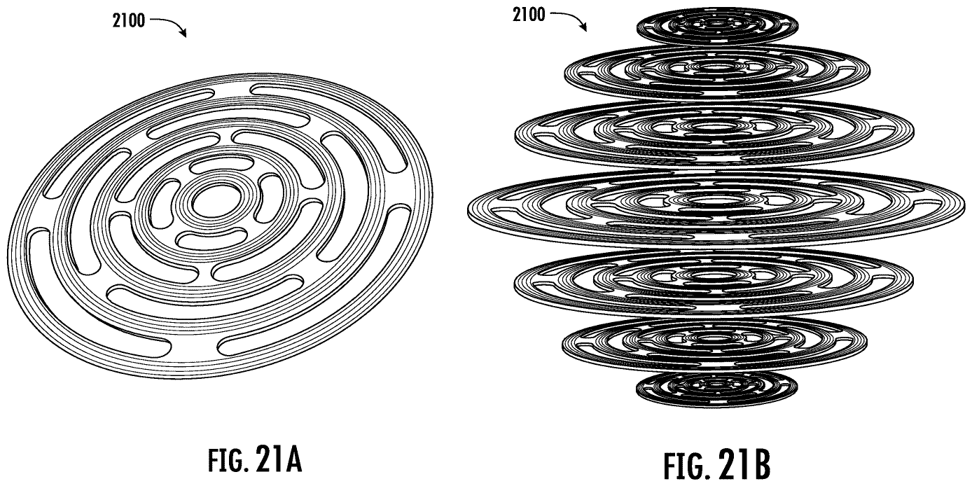

With reference to FIGS. 21A-21B, concentric coil devices 2100 are shown. In FIG. 21A, the circular PCB 2100 may have 5 concentric PCB 4-turns trace coils. The PCB 2100 has holes and gets submerged in the host material (e.g. concrete), which occupies the space in between the trace coils. By selectively exciting one coil and measuring the secondary current on the other coils it is possible to measure the gradient in magnetic permeability of the host material. By disposing a plurality of such PCBs (optionally of different, graduating sizes) in proximity of each other, it becomes possible to achieve the same scanning effect in all 3 directions, performing a 3D permeability tomography measurement, such as illustrated in 2100 of FIG. 21B.

Another way to exploit the structure 2100 is to measure the self-inductance or (the inductance) of each coil. This again gives information on the permeability of the concrete around the selected coil. Electronically the measurement is simple and can be implemented using the microcontroller and a precision capacitor. Other geometries and techniques are possible, like measuring the current passing through a wire immersed in an excited coil. If the coil and the wires are submerged in the concrete, the mutual inductance will be proportional to the permeability. These configurations may be particularly advantageous to characterize rebar configurations and rebar properties (which will exhibit more permeability than concrete) within the element.

### Combination of Inductive and Capacitive Analysis of the Concrete Properties

Combining the inductive and capacitive measuring techniques just described, it becomes possible to achieve a comprehensive analysis of the concrete's and/or rebar's permittivity and permeability. The combination of this information can be used to determine the electric, magnetic or electromagnetic wave impedance of the material, that could give information on how electromagnetic waves behave inside the medium but also offer insights on the composition of the host material. The two device types may be coupled or combined in various ways (forming an RLC circuit where the capacitance, inductance and resistance of the concrete can be determined by measuring the impedance spectrum of the combined device or identifying the resonance modes).

### Electric Impedance Sensor for Analysis of Concrete

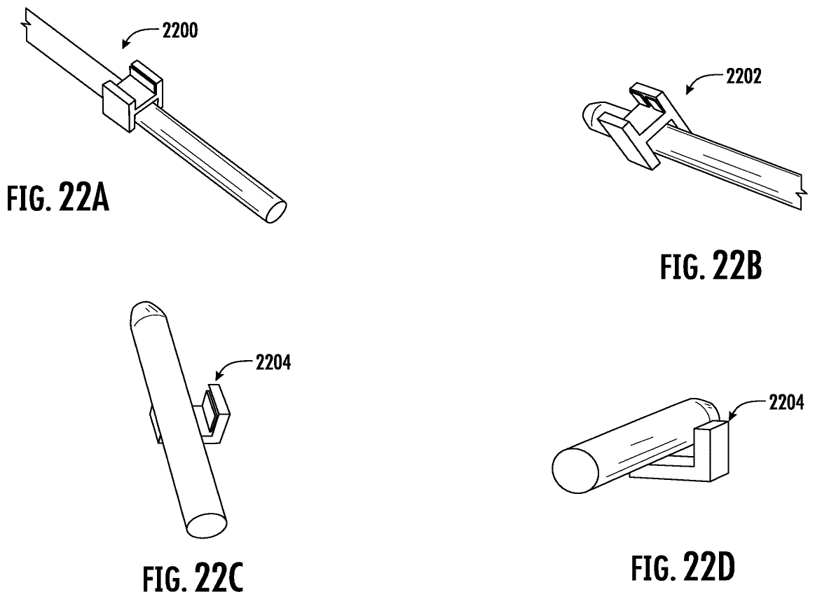

With reference to FIGS. 22A-22D, various electrochemical impedance spectroscopy are provided. FIG. 22A illustrates a device 2200 mounted on top of a rebar. The device may include 2 conductive electrodes facing each other in an area that would be filled with concrete during the pour. Conductivity of concrete can be measured by driving a current flow between the terminals (e.g. an oscillating current or a direct current depending on the embodiment). Generating a current at different frequencies will then enable the measurement of the complex electrochemical impedance spectrum of concrete. Electronically this is achievable with different topologies and with very high precision. FIG. 22B illustrates a device 2202 with 4 electrodes. This version is able to determine impedance spectra, and T or S parameters more accurately using the 4 point technique.

FIGS. 22C-22D illustrates a device 2204 with 1 only electrode, in this case the rebar itself is used as a termination point for the current to flow through, simplifying the construction of the device. The single electrode version 2204 may also be used without a link back into the rebar if the electrode spans a large enough area or volume and offers an impedance gradient in one or more directions. In this scenario, a single electrode or plate is able to apply a potential gradient within the medium, which can stimulate electrochemical reactions. Optionally, the surface of the single electrode may have various features that allow for the control of the electric properties of a sub-area of the single electrode surface (e.g., to selectively increase or decrease the impedance at different locations within the electrode surface). This enables the adaptive creation of various 2 or 3 dimensional charged surfaces that can electrochemically excite the medium (including all the ‘smart’ single electrode embodiments described above).

### Electrical Field or Magnetic Field Probe for Direct Measure of Electrochemical Impedance

In the embodiments illustrated in FIG. 20A-22D, an electrical or magnetic field probe installed between or in proximity of the current path (e.g. perpendicular to the current direction) may be used to measure the electric field around the active area of the concrete. The principle is based on the E-field probes. By measuring the electric field vector, and the input current, it becomes possible to calculate the real and imaginary part of the concrete electrochemical impedance, by exciting the system at many frequencies. A similar approach can be taken with a B-field probe (e.g. hall effect or otherwise based). This opens the opportunity for spatially mapping the electrochemical processes within the concrete (or surface mapping them if mounted on), with a plurality of E or B field probes.

### Electrochemical Impedance Matching Plate

Another embodiment of electrochemical sensing may comprise placing an electrode inside a sensing plate of predetermined impedance within a host material, wherein the sensing plate may in one configuration be expected to match the mid-range/average of the material's expected impedance (or any approximate relative impedance measure). When an electric potential difference is applied across the host material, electrical current may flow through the plate in any direction. The magnitude of the current flowing through the plate may be a function of the impedance of the host material. Mismatches in the impedance of the host material relative to the sensing plate may induce different currents. For example, for a given electrical potential difference, a higher current flowing through the plate may be indicative of an increase in the host material's impedance, and conversely, a lower current may be indicative in a decrease in the host material's impedance.

### Magneto-Electric Sensing-Transformer Embodiment

Note, in some embodiments, the techniques, methods, components, embodiments, and other disclosures herein may be applied in full or in part to other wave-based sensing disclosures herein, including but not limited to mid-frequency wave-based sensing embodiments.

### Transformer Losses

In one embodiment, the electromagnetic losses of a transformer are used to indirectly sense the magnetic and electrical properties of the material that the sensing transformer is embedded in, mounted on or in proximity of. As the properties of the host material surrounding the transformer evolve in time (e.g. concrete curing), trajectories of magnetic field lines may vary (cutting more corners when the transformer core is filled with high magnetic permeability materials). These varying magnetic fields may generate Eddy Currents of varying magnitudes. Their magnitude will be a function of the electrical conductivity of the host material.

For example, if the transformer is submerged under water, the field lines will be configured differently to a transformer surrounded by air. In the water case, the electrical conductivity will depend on the water's compositional properties (e.g. purely distilled, or saturated with electrolytes—the latter may allow for varying levels of conductivity at a plurality of frequencies). As such this embodiment may be configured to sense both magnetic and electrical material properties of the material under consideration. This principle is applied to materials like fresh concrete, to determine their characteristics.

In one embodiment, the transformer is excited at one or more frequencies using an input signal, and the system is configured to measure the portion and/or fraction of energy loss or power loss across a range of frequencies. This produces a magneto-electric spectra which can be analyzed to determine material properties. The input signal power level may be modulated at one or more frequencies. Generally, the excitation signals may be of any of the types already described elsewhere herein, to minimize sampling time (e.g. multi-sine).

Finally the inventors disclose novel and inventive embodiments for transformer geometry designs to maximize sensitivity. For example, these may include a star toroidal transformer design, rather than the more standard round or square toroidal designs. This design may be particularly advantageous thanks to the high number of accentuated jagged angles and locations which may result in more locations where magnetic fields could intersect corners and cross from the high magnetic permeability medium of the transformer core onto the material under consideration.

### Transformer Core Cavity

In a further embodiment, given the diamagnetic properties of material elements such as water, this disclosure may benefit from monitoring the energy losses associated with the magnetic induction of the mechanical movement of water (or other) molecules surrounding the sensing transformer, in particular in the transformer's inner cavity (center) as well as the locations in between jagged edges of the transfer's outer parts where magnetic field lines may cross out of the core (high magnetic permeability material) over into the material of interest (e.g. concrete) in order to take the ‘path of least resistance’. For concrete sensing applications, given that water concentration decreases as concrete cures, this approach may be used to detect the progressive decrease of water in the concrete in the vicinity of the sensing transformer, which may be used for concrete curing monitoring. Water concentration sensing may be enabled via measurement of energy losses from magnetic field to mechanical fluid movement due to water oscillating due to the dipole of its molecules.

### Sensor Cube Instantiation

The two embodiments described directly above may be implemented into the modular Sensing Cube System (described elsewhere herein). This may be achieved by routing the magnetic field from cube plate to cube plate. In one example embodiment, the four horizontal faces of a sensing cube configuration may have its North, South, East and West facing plates carrying a varying magnetic field created by these plates and effectively acting as a square toroid with thinner walls than in traditional power transformer embodiments. In this case the magnetic field may travel along the horizontal plane clockwise and/or anti-clockwise depending on the AC excitation electrical signal in the coils that drive the magnetic field. Any plurality of sensing cube configurations wherein any one or more embodiments herein is implemented may be considered.

### Ferrofluid and Ferrogels

In advanced embodiments, ferrofluids, ferrogels and/or other similar materials with equivalent characteristics and properties may be used to infer mechanical impedance of the material under test. In one instantiation, a ferrofluid may be mixed with fresh concrete inside the cavity of the transformer core to determine the process whereby concrete evolves from a liquid into a stiff solid, through sensing of the magnetic impedance and energy loss evolution which may vary as the concrete cures. Ferrogels may also be used. In one embodiment, a ferrogel may be applied onto the surface of the transformer core used for indirectly measuring the mechanical impedance of the material under consideration as the concrete cures. In this embodiment, the ferrogel may not require to be diluted or contained as opposed to a ferrofluid, and as such, ferrogel coatings may be used to enhance the sensing transformer described above.

### Cavity Magnetron Efficiency

In another advanced embodiment, a cavity magnetron may be used to monitor the electro-magnetic properties of the material under consideration. As cavity magnetrons are excited at specific voltages, the output power and mutual coupling (and/or energy absorption) of the surrounding material may be inferred from the current consumption of the cavity magnetron. This instantiation allows for similar sensing capabilities as the sensing toroid introduced above, but at higher frequencies. Such embodiments or similarly equivalent ones may also be used for mid-frequency wave-based sensing.

### Measurement

This family of transducers measure power—in particular power losses e.g. the milli or micro-Watts in efficiency losses of the sensing transformers, which change in response to changes in the properties of the surrounding material (e.g. concrete). This power loss may be measured by tracking quantities including but not limited to the voltages, currents, frequencies, phase differences between both excitation signals (voltage and current) as well as those of secondary coils in the transformers, and/or other associated quantities and metrics. In terms of characterization and analysis, this power loss ratio may be represented by a Bode plot, wherein the ratio of lost power may be represented as a function of frequency. In addition a plot representing the phase difference as a function of frequency may additionally be used to inform the imaginary aspects of the system properties.

### Non-Linear Effects as a Sensing Method

Non-linear effects will begin to appear as power and frequencies increase. As such, the embodiments described herein may operate both in the linear regimes as well as at the edge and beyond the appearance of non-linear effects, in order to better monitor and track the characteristics of a material and their changes over time.

### Mid Frequency (Radio, Microwave, Terahertz/far-IR)

Mid frequency wave-based sensing techniques broadly include techniques that involve sending and receiving radio waves, microwaves, and the terahertz parts of the E&M spectrum through a material (or an associated medium) to characterize the material.

In particular, they include techniques that involve measuring frequency responses, intensity or amplitude responses, time of flight responses, of electromagnetic waves travelling through a host material of interest, or associated/coupled mediums, to determine a characteristic of a host material.

Specifically, this includes devices configured to measure electromagnetic wave impedance at a range of frequencies (so called ‘electromagnetic wave impedance spectroscopy’), as well as time domain reflectometry or time of flight analysis of RF, Microwave & Terahertz signals, and spatial tomography through such signals.

Devices are designed to be ultra-low-power, lasting for years, and possibly indefinitely through energy harvesting. They are mobile, low-cost (leveraging low-cost MCUs and DSP systems), wireless (through the various protocols already referenced).

Generally, devices are also coupled (e.g., disposed within or in proximity of frames, physically attached to, integrated with a frame), including coupled to frames that can help induce resonant behaviors (e.g. cavities, membranes, waveguides), but also reflectors and signal concentrators, which are used to enhance various signal characteristics of our system.

Reflectors may be disposed separately to the device enclosure. Opportunistic reflectors or frames may be detected within the material and employed to obtain characteristics of the material.

The mid-frequency regime is particularly advantageous for a number of reasons. One principal one, is how readily available wireless interfaces (typically used for communication) are. These wireless interfaces can be repurposed for sophisticated and advanced RF or microwave (or even Terahertz) sensing, to characterize material properties in time and in space. Below we outline several methods, which can be executed on any number of device embodiments (including all those described in the general hardware section).

### Electromagnetic Wave Impedance—General Method

In electromagnetic wave impedance sensing mode, our method makes use of one or more broad spectrum radio frequency sensors/detectors, and one or more antennas. In active monitoring configurations, one or more antennae are used to generate signals at different frequencies and locations within a host material so as to be able to monitor signal attenuation, reflections, electromagnetic wave impedance and general frequency response. These parameters may be monitored over time as the material evolves (e.g. due to concrete curing), but also over space to determine their spatial distribution. The one or more receiving antenna may be the same as the one or more transmitting antenna (e.g. for one antenna, acting as a one port system), or the system may employ distinct receiving and exciting antennas (or a hybrid approach may be employed). Some embodiments employ one single antenna, others employ a plurality of antennas. Spatial separation of antennas, polarization and gain distribution are all key considerations for designing the system.

The devices of the present disclosure can be placed in a multi transducer and multi-sensor configuration (as described previously for other techniques) in order to do spatial tomography and/or time domain reflectometry. Likewise, device output electromagnetic signals can be driven onto waveguides, or from within or into containers that isolate a volume of concrete in the element for analysis or be placed in proximity of such containers. Optionally, these containers may act as cavities (e.g. made of electromagnetically reflective material), so as to generate particular excitation modes of the electromagnetic signal. They may also act as reflectors or concentrators. Generally, any frame and/or fixtures, which may be made of conductive materials (including waveguides) to direct the propagation of electromagnetic waves, and also generate electromagnetic resonances are considered. These may also take the form of dielectric resonators.

### Electromagnetic Wave Impedance Concrete Sensor

Measuring the electromagnetic wave impedance of a host material such as concrete, including its real and imaginary parts, can be achieved using electromagnetic radio waves. In one embodiment, a RADAR system is employed to do so. The radio waves pass through the transmission channel (the concrete, or host material), and get measured while carrying information about it. The system has at least one radio transmitter and at least one receiver (which may be one and the same), but multi-points systems can also be used.

In one example embodiment, a device uses low-cost radio transceivers, which are typically available for communication purposes (e.g. for IoT devices), as radio transmitters. The radio transmitters/actuators are driven across a plurality of frequencies (e.g. through a sweep) and with local tuning capabilities. Some example transmitters that may be used include Bluetooth transceivers (or any 2.4 GHz based technology), sub-GHz (433 MHz or 868 MHz) transceivers, UWB transceivers, etc. The RADAR reception is implemented with a reception RF grade ADC, coupled with RF input conditioning components such as an LNA PGA.

The device embodiment always integrates both transmitters and receivers so that it can be used as a standalone RADAR system but also as a constellation of distributed RADAR systems where incident waves get generated by one or many devices (in different positions) at the same time and get received by one or many different devices in different places. Furthermore, some of the proposed transmission protocols/techniques allow time synchronization between devices in the sub-microsecond and may be used to facilitate the measurements or even to implement beam forming/shaping techniques.

This device embodiment is an N-port network, and so the system can also be characterized through its S parameters (providing invaluable information on characteristics of the concrete, such as its curing rate, water to cement ratio and other parameters).

### Ultra-Low-Cost Ultra Wide Band Concrete Sensor

UWB technology is increasingly used for many electronic and IoT applications. The traditional fields of use are indoor positioning and obstacle detection. Several providers have now made available UWB chips that are able to perform very accurate time difference of arrival (TDoA) measurements and Phase difference of arrival (PDoA) measurements, when using multiple devices. In case of one single device transmitting and receiving, the ICs also provide the channel impulse response (CIR) that is a measure of the difference between the transmitted and received signal and that depends on the channel of the communication.

In this embodiment, an UWB-based device is repurposed in a particularly inventive way, for material characterization (e.g. of cementitious mixtures). An device using one or more UWB transceivers is embedded in, surface mounted or directed at concrete, can collect information about the composition of the material directly (using CIR data) and derive information about the concrete impedance using the TDoA and PDoA data, as well as the signal attenuation of any reflections (e.g. from frames it may be coupled to, or that may be disposed nearby, or opportunistically detected etc.).

In a more advanced embodiment, the one or more UWB transceivers are tunable in the 1 GHz-10 GHz range, enabling measurements at different frequencies giving information on the frequency response of the real and imaginary part of the concrete electromagnetic wave impedance.

The combination of time domain analysis (to look at time of flight, from which the electromagnetic wave velocity in the medium can be characterized), we well as electromagnetic wave impedance spectroscopy, or S parameter spectroscopy for an S port system, provides significant material characterization information. This data can be used using a model (optionally a machine learning based mode), used to determine material properties, including compositional properties, contextual material properties, and/or static material properties, as well as device or material contextual conditions.

### Antenna Detuning Sensing

Another embodiment comprising antenna (e) detuning may be employed. In this embodiment, the sensor device may be configured to monitor the evolution of the electromagnetic properties of a material using the detuning of an antenna. Antenna detuning may be used to determine the increase and/or decrease in permeability and dielectric properties of a surrounding target material. In one embodiment, the sensing system may initially be configured with a perfect tuning of the antenna circuitry, antenna and surrounding material, resulting in no reflections. A material's evolution (e.g. concrete curing) may then drive a progressive increase in reflections that may be detected from the antenna back to the driving circuit. The excitation signals used in this embodiment may include a wide array of frequencies in the form of sinusoids, chirps and/or compound signals, which may be chosen depending on the capabilities of the sensing electronics. Monitoring the impedance matching of the antenna to the surrounding material may therefore constitute an additional independent embodiment for tracking of concrete curing and/or other changes in the material under consideration.

### Pulsed Coherent Radar (PCR) Based Concrete Characterization Device

Other types of RADARs that can be purchased and come as all-in-one ICs are called Pulsed Coherent Radars. In this case the frequency of operation is high, more than 50 GHz and so measurements. The innovation, again, revolves around their repurposing for material characterization and/or identification (a particularly inventive embodiment, as highly sophisticated material sensors can be constructed from off the shelf electronics).

Due to the high frequency, waves permeation in concrete may not be very high. Their typical application is positioning and obstacle detection (which may themselves be valuable for context awareness), but they can be used for material characterization and identification. Pre-processing is minimal and raw data are accessible for custom signal processing, meaning the possibility of using the radar capabilities to study the concrete impedance and its characteristics.

### Concrete Filled Cavity Resonators to Study the Concrete Characteristics (Microwaves)

All the techniques and proposed devices above (and in this section) use mid-frequency electromagnetic waves radio signals. Instead of letting the waves move freely in space, they can be coupled to a frame (e.g. bounded on, placed in or in proximity of such frame). This may take the form of a resonator made up of a waveguide, reflectors or concentrators, or a resonator cavity, created within the material under consideration (e.g., concrete).

Generally, frames, including resonator cavities (which are boxes made of conductive material that resonate at specific frequencies based on the shape of the box, and also the dielectric inside the cavity), can form particularly good sensors. For a concave frame, filling the inside of the frame or cavity with concrete would be particularly advantageous, as the properties of the material (e.g. concrete as it cures) will influence the resonance peaks of the cavity. This means that the electromagnetic wave impedance spectrum within the cavity can be used to characterize the medium (and be related back to the dielectric of the medium).

For example, different types of concrete (or different ages of concrete) will make the frame or cavity resonate at different frequencies and the proposed device can determine the frequency (or frequencies) of resonance to get information about the material.

The device may be implemented without a metallic frame or cavity, by exploiting the principle of dielectric resonance cavities in which materials with high dielectric constant are surrounded by materials with much lower dielectric constants. This could be the case of concrete surrounded by air or by a material with low dielectric constant. Again in this form the concrete characteristics will impact on the resonant frequency of the cavity, that can be measured. So to be clear, resonators may be constructed through the use of various dielectric mediums, which may be encapsulated within one another, or in proximity of one another, and that may form bounded surfaces or volumes. These surfaces or volumes may contain concrete (to be analyzed). They may be coplanar or perpendicular with the one or more antenna of the system.

### Instantiations of Various Device/Sensor Configurations

Broad Spectrum RF Sensor/Antenna Design. The system incorporates broad-spectrum radio frequency (RF) sensors or antennas capable of operating over a wide range of frequencies. These antennas are designed to be sensitive to a variety of electromagnetic signals, allowing for detailed analysis of material properties. Materials like copper or aluminum, known for their excellent conductive properties, or dielectrics are used in antenna construction depending on the frequencies of operation.

Active Configurations. In active monitoring configurations, one or multiple antennas are used to generate and receive electromagnetic signals at different frequencies. This setup allows for the assessment of signal attenuation, reflections, and frequency responses within the material. The configuration and placement of these antennas are critical for achieving optimal spatial coverage and sensitivity.

Signal Attenuation & Reflection Analysis. The system monitors how electromagnetic signals are attenuated and reflected by the material, alongside the electromagnetic wave impedance (which is ultimately an intrinsic characteristic of the material). This analysis provides insights into the material's compressive strength, density, moisture content, and structural integrity. Signal attenuation and reflection patterns change as materials like concrete cure over time, offering a dynamic view of the material's properties.

Frequency Response Monitoring: Monitoring the frequency response of the material to electromagnetic waves (e.g. electromagnetic wave impedance spectroscopy) can reveal valuable information about its material properties. Different materials and structural anomalies within the material will affect the frequency response in unique ways. In addition to curing and fresh properties, these may be used to detect cracks and other spatially distributed anomalies.

Multi-transducer & sensor spatial tomography. The system uses a combination of multiple transducers and sensors for spatial tomography. This approach allows for a three-dimensional representation of the material's properties, enabling detailed analysis of areas of interest within the material.

Multimodal Sensing. To enhance the analysis, the electromagnetic wave impedance sensors can be integrated with other sensing technologies like electrochemical or magnetochemical sensors, or other wave-based sensing techniques. The device may be fitted with a dense array of sensors and/or actuators, including magnetic field sensors, temperature, and humidity sensors. These sensors are embedded in a grid-like pattern across the device's surface. This multimodal approach provides a comprehensive understanding of the material's properties.

Data Processing: Advanced data processing algorithms are employed to differentiate between various types of reflections and attenuations, accounting for factors like background electromagnetic noise and sensor calibration.

Antenna Placement Strategies. In materials like concrete, antennas can be embedded during the pouring process or attached to the surface, or a combination thereof.

### Advanced Instantiation Descriptions

Adaptive Frequency Range Adjustment: The device includes a mechanism for dynamically adjusting its operating frequency range. This allows for precise tuning to specific frequency bands within the mid-frequency range, enhancing the device's sensitivity and specificity to different material properties.

Directional Antenna Systems: The device employs directional antennas, which can focus the electromagnetic waves on specific areas of the material. This targeted approach improves the resolution and accuracy in spatial tomography mode, enabling more detailed analysis of material properties. Optionally, these directional antenna systems may be based on a phased array antenna that is able to beamform in a particular direction.

Phase Shift Analysis: In addition to signal attenuation and reflection, the device analyzes phase shifts in the electromagnetic waves caused by interactions with the material. Phase shift data can provide additional insights into the material's composition and structural characteristics.

Advanced Material Characterization Algorithms: The device uses sophisticated algorithms to interpret the electromagnetic wave data, allowing for detailed material characterization. These algorithms can identify and differentiate various material properties, such as porosity, moisture content, and density, and relate these back to static and/or dynamic modulus, compressive strength, water to cement ratio, workability etc.

Automated Antenna Calibration System: To ensure consistent and accurate measurements, the device includes an automated antenna calibration system. This system regularly calibrates the antennas to account for environmental changes and wear over time (e.g. through the use of S parameter analysis).

High-Speed Data Acquisition and Processing Unit: A high-speed data acquisition and processing unit is integrated into the device, to handle large volumes of data from multiple sensors simultaneously, providing rapid analysis and real-time feedback

Embedded Diagnostic and Maintenance Tools: The device includes embedded diagnostic and maintenance tools that monitor its performance and alert users to potential issues. This feature ensures minimal downtime and maximizes the operational lifespan of the device.

Customizable Sensor/Actuator Networks & Arrays: The system allows for the configuration of customizable sensor & actuator networks. Users can modify the number and arrangement of sensors based on specific application needs, providing flexibility and scalability for various monitoring tasks. This includes arrays (as discussed for other methods). These arrays are particularly useful in that they enable spatial tomography, time of flight analysis across different terminals, time domain reflectometry across different spatial positions, angle of arrival analysis, and may also be used to identify and remove stray electromagnetic signals (by measuring their angle of arrival using the array). These networks of sensors/actuators and/or arrays may also allow the measurement of the polarity of the electromagnetic wave, and the excitation of various polarization modes.

Low Cost Energy-Efficient Design: The device is designed to be low-cost, energy-efficient, with ultra-low power consumption components and power-saving modes, enabling ultra-low-power characterization of the material, and wireless communication (of the kind discussed elsewhere). The RF components may be used for both communication and material characterization (simultaneously, or sequentially). This makes it particularly advantageous for concrete sensing applications.

Electromagnetic Shielding: electromagnetic shielding (from stray signals) may be coupled to the device enclosure, so as to ensure that the area of interest is isolated from external interference.

Environmental Sensors (Temperature and Humidity etc.): The device includes onboard environmental sensors (temp, humidity etc.) to monitor environmental conditions during measurements. This data is used to adjust and compensate for the electromagnetic wave readings for environmental factors.

Antenna Types and Placement: The device includes multiple types of antennas, such as dipole and patch antennas, ring antennas, fractal antennas, strategically placed for optimal signal transmission and reception. The antennas are adjustable for targeting specific areas of the material under analysis. Different antenna geometries (including combinations of different types of antennas) are considered. These may be adaptively selected based on the range of frequency measurements, or the frequency components of any pulse sent through the signal. Antenna elements are made from materials like copper or silver for optimal conductivity. They are coated with a thin layer of protective material to prevent oxidation and wear. Antennas are mounted on adjustable arms, allowing for precise positioning and orientation. This flexibility is crucial for adapting to different testing scenarios and material types. In some cases it may be impossible to move the antenna (for example, if it is exposed to concrete, in an embedded scenario). In these cases, an array of antennas which can adaptively be selected is considered.

Environmental Adaptability: The device is weatherproofed to ensure functionality in various outdoor conditions. This includes water-resistant seals and UV-resistant coatings. Vibration-dampening materials and shock absorbers are incorporated to protect the device during transportation and in high-vibration environments. The device is capable of operating within a wide temperature range, ensuring reliability in both hot and cold environments (especially relevant in concrete applications).

### Refractive Index & Polarization Sensing

Using specialized optics and/or antennas, reflective real and imaginary components of the refractive index (attenuation and speed of light change and in parallel light polarization) and polarization of electromagnetic waves (e.g. described in the form of Jones Matrices or Mueller matrices) can be determined, from both within as well as from the surface of host materials (including the boundary effects of the surface, as well as the impact of the medium itself on wave propagation). Physically, refractive index sensing can be related back to electromagnetic wave impedance.

These methods can be executed on ultra-low power, low-cost and wireless devices, that may be embedded or surface mounted on the concrete and is a particularly innovative embodiment in the case of cementitious material characterization.

Refractive Index Sensing: In one embodiment, E&M waves are directed onto or into a material at one or more angles, and the transmitted wave's intensity and beam deviation is measured to calculate the refractive index. In embedded scenarios, RF or optical waveguides may be used with a direct, angled boundary into the medium, to aid in refractive index characterization. Generally, refractive index sensing involves measuring the intensity and angular deviation of E&M waves as they interact with the material. By analyzing these changes, the system can detect variations in the material's refractive index. Determination of the refractive index would in turn allow for monitoring of the material's relative permittivity and permeability in the chosen frequency range. This can then be related to other material characteristics, such as the water to cement ratio and ultimately its compressive strength or workability.

Polarization Sensing: In another embodiment, multiple polarized antenna, or optical analyzers are used to sense the polarization (or change in polarization) of electromagnetic waves within a medium. In one embodiment, a uniformly polarized excitation signal is generated (e.g. the excitation signal may be circularly, linearly polarized, or elliptically polarized for example). At least two (and optionally three, for three dimensional sensing), perpendicular polarized antennas are disposed in the path of the electromagnetic wave propagation. The two perpendicular antennas are used as an analyzer, to fully characterize the x and y components of the wave's polarization. With three antennas, the direction of propagation, and polarization can all be determined. It is worth noting, that in the mechanical world, an analogue exists for the detection of the mode of the wave (transverse waves, longitudinal waves, surface waves etc.), and in the case where the waves are transverse or surface-based, their polarization can be characterized similarly.

Applicability Across Frequency Ranges: The technology is applicable across various frequency ranges, including mid and high frequencies (such as the visible light spectrum). The mid-frequency electromagnetic regime (RF, Microwave) allows for good wave propagation through the medium, making refractive index and polarization sensing particularly advantageous in this part of the spectrum. In the infrared, optical domain waves will attenuate too fast in the medium. However, waves can propagate in other materials which may be coupled to the host material (e.g. a photonic waveguide, which are discussed in the high frequency section, or photoelastic materials which are discussed in the optomechanical section).

Heterogeneity of Concrete at Micro-Scale: In the case of heterogeneous materials such as concrete using multiple transducers and multiple sensors allows for differentiation between different sub-components such as aggregate, sand and mortar of various water concentrations. This is applicable to both mid and high frequency (e.g. visible light spectrum). Lower frequency will have less resolution and naturally lead to greater averaging effects (e.g. the RF spectrum vs microwaves). Broader beam-widths may also be used to create averaging effects (so that measurements can be spatially averaged across them).

Specialized Optics & Antenna Design: The system employs specialized optics or antennas, including antenna arrays, laser sources, prisms, and sophisticated detectors capable of capturing changes in electromagnetic (E&M) wave propagation (in particular beam direction).

Sensor Arrays: A configuration of multiple sensors and transducers is used for spatial tomography. This setup allows for a comprehensive 3D mapping of the material's refractive index or the polarization of signals travelling through it, providing detailed insights into its internal structure and composition, and fresh properties.

Data Processing: Measurements of the refractive index at different frequencies & polarization response across different incident frequencies and power inputs can be used to characterize the material. Analysis includes the angle of incidence, wavelength of the E&M waves, relative intensities across polarized antennas, and environmental conditions (for compensation or normalization).

### RF-Based Refractive Index & Polarization Sensing Device

RF Signal Generator: The core of the device is an RF signal generator capable of producing electromagnetic waves in the desired frequency range or at the desired polarization. Alternatively an RF pulse is generated, with a specific target shape. The RF signals are modulated in amplitude, frequency, or phase to optimize the measurement sensitivity and to facilitate the distinction between different material characteristics.

Antenna Design and Configuration: The device employs an array of specialized antennas designed for the specific RF frequency range. Generally, any of the advanced RF techniques may be employed. The antennas are capable of directional transmission and reception. Phase-control technology can be employed to steer the beam electronically, offering flexibility in scanning different parts of the material.

Signal Processing and RF Detection High-sensitivity RF receivers are used to detect the reflected signals from the material. In polarization sensing mode, they are coupled to a plurality of perpendicular polarization antennas (ideally at three orthogonal angles). These receivers are tuned to the specific frequencies of the emitted RF signals. An advanced signal processing unit is integrated for real-time analysis of the received signals. This unit deciphers changes in amplitude, phase, and other characteristics, which are indicative of the refractive index properties of the material, or the polarization (at different spatial locations) of electromagnetic waves travelling through it. By employing multi-path signal analysis, the system can differentiate between various layers and components within heterogeneous materials, enhancing its utility in complex environments like concrete structures.

Environmental Compensation: Algorithms for compensating environmental factors such as temperature and humidity (and other context data) are integrated, ensuring accurate measurements under varying conditions.

### Ground Penetrating Radar (GPR)

Ground penetrating radar can be used to infer the thickness, shape and dimensions of a particular material such as a concrete floor after the concrete is poured, before and after the formwork is removed and in the case of piles for example may help to detect not only geometry but also the addition of rebar cages. This technique can also be used to detect non-uniformities such as air pockets or unexpected cavity deformation such as solid falling off the side of a pile drill hole.

The time of arrival, angle and intensity of the reflections would help in ascertaining the structure, shape and material properties of the construction unit under consideration. This can be done both from the surface of the material as well as from within in cases where it is advantageous to embed the excitation energy source. As with other methods and systems this can be configured in a multi-source multi-sensor fashion to allow for higher resolution spatial tomography over time as the material is set and cured.

The inventors have also conceived of the use of GPR sensing techniques to monitor the evolution of the fresh properties of concrete (e.g. curing of concrete) and/or the composition of concrete. This applies to other cementitious materials and general building materials too (in particular materials that evolve over time). The properties may include the water-to-cement ratio and can also be correlated back to the dynamic and/or static modulus and used to estimate compressive strength. This makes Ground Penetrating Radar a particularly effective method that can yield key information for material identification, material property estimation, and for context awareness, all from one device.

Material thickness, shape & dimension. The GPR system is designed to infer the thickness, shape, and dimensions of materials such as concrete floors. It is effective in various stages: after pouring concrete, before and after formwork removal, and in the inspection of structural components like piles. The technology is particularly adept at providing detailed measurements of geometric properties.

Detection of Rebar. GPR can detect the presence and arrangement of rebar cages within concrete structures. This capability is crucial for assessing the structural integrity and compliance with design specifications. It can also identify other embedded structural components, providing a comprehensive view of the construction unit's internal makeup.

Identifying non-uniformities. The system is capable of detecting non-uniformities within materials, such as air pockets or deformations in construction elements like pile drill holes. These anomalies are identified based on variations in the reflected radar signals.

Signal Reflection Analysis. GPR analyses the time of arrival, angle, and intensity of the reflected radar signals to ascertain the structure, shape, and material properties of the construction unit. This analysis allows for a detailed understanding of the material's internal features and conditions.

Embedded Devices. In some applications, it may be advantageous to embed the excitation energy source within the material. This approach can provide more detailed and localized data, especially useful in complex or thick materials where surface-level readings may not be sufficient.

Multi-source, Multi-Sensor Configuration. The GPR system can be configured with multiple sources and sensors (e.g. arrays) to achieve high-resolution spatial tomography. This setup is particularly effective over time as it can monitor the setting and curing processes of materials like concrete, capturing changes in their properties.

Monitoring fresh properties and composition of concrete. The inventors use the application of GPR sensing techniques for monitoring the evolution of fresh properties of concrete, including its curing process. This technology can provide real-time data on the material's hardening stages, moisture content, water to cement ratio, overall quality, shrinkage and cracking, and be correlated back to its static and dynamic modulus, and compressive strength. Specifically, the material's dielectric constant is measured, based on time of reflection, or time of flight (which can be used to determine the speed of the electromagnetic wave in the medium). Signal amplitude attenuation (in reflections, or in transmission over an N-port system) can also be calculated, to infer other material characteristics. A correlation between the evolution of the dielectric constant over time=with the age of the concrete sample and its compressive strength can be established. Water to cement ratio is a particularly important factor (which can either be measured or estimated based on our GPR data, or measured with other sensors, and used to accurately determine compressive strength of our sample from our signal). Generally, correlations (optionally through machine learning models) are established between the time-domain GPR signal or specific features of it (such as the time of flight or reflection, or intensity loss) and the dielectric of the medium, as well as the water to cement ratio and the compressive strength. This can extend further to other material properties, including static and contextual material properties.

General Applicability to Material Characterization. While particularly effective for concrete, the GPR technology is also applicable to a wide range of cementitious materials and general building materials. Its versatility allows it to be used in various construction contexts, monitoring materials that evolve over time and over space.

### Additional Instantiation Description

GPR System Design and Construction: The GPR system employs multi-frequency radar transmitters capable of emitting a wide range of radio frequencies, which are selected based on their penetration depth and resolution capabilities, suitable for detecting various construction materials. The receivers are designed to capture the reflected radar signals with high sensitivity, allowing for precise detection of internal structures and anomalies within materials. The system uses directional antenna arrays that can be oriented to optimize signal penetration and reflection detection. This enhances the system's ability to analyze the structure and composition of construction materials. An integrated signal processing unit performs real-time analysis of the reflected radar signals, using advanced algorithms to interpret signal characteristics like time of arrival, angle, and intensity.

Spatial Tomography Algorithms: For high-resolution spatial tomography (where GPR antenna arrays are used, and/or GPR systems themselves are moved), sophisticated algorithms are employed to construct a detailed 3D image of the internal structure of the material, revealing features such as rebar cages, air pockets, and structural deformities.

Surface-Level Sensing: The primary mode of operation involves surface-level sensing, where the GPR system is placed on or near the material's surface to analyze its internal structure, and the time-evolving material properties.

Embedded Sensing Capabilities: In scenarios where deeper or more localized sensing is required, or fully wireless sensing is preferred, the system can be configured to have embedded excitation energy sources within the material. This enhances the depth and accuracy of the sensing capabilities. This is a particularly innovative aspect of the invention, as GPR sensing capabilities have been miniaturized onto a fully embedded wireless device for spatial and temporal material characterization.

Multi-Source, Multi-Sensor Configuration (arrays) The GPR system can be equipped with a modular array of sensors and transmitters, allowing for flexible configuration based on the specific application needs.

Dynamic Reconfiguration for Spatial or Temporal Monitoring: The system can be dynamically reconfigured between spatial tomography/spatial mapping mode, and temporal material property characterization mode (e.g. determining curing process of concrete, water/cement ratio changes, setting time, moisture content, material consistency etc). This is done by adjusting the frequency and intensity of the radar signals. The system includes specific settings and algorithms for detecting and mapping rebar cages and other structural components within concrete.

Repurposing Existing Bluetooth and/or Other RF Interfaces

Leveraging Bluetooth and other RF technologies offers a novel approach to material analysis. Unlike GPR, which uses specific frequencies for ground penetration, Bluetooth and other RF technologies operate at different energy levels and frequencies that allow signals to travel over the air, as well as through the medium of interest. Through careful analysis (to include the boundary conditions), this becomes particularly powerful. This capability removes the need for material boundary contact, which in other technologies may cause signal reflections and energy losses depending on the quality of the contact as this is user dependent.

Similar principles to those applied in the GPR section can be applied, but within a different part of the electromagnetic wave spectrum. The use and repurposing of existing circuitry (traditionally used for communication) on sensor devices to characterize properties and composition of host materials carried particular advantages.

Devices may be positioned in proximity of, or surface mounted on, or embedded in the material using any of the techniques described herein. By definition, these devices are already low-power, low-cost, and long-lasting. Signal processing algorithms (on devices or in the cloud) can differentiate between various material types and conditions based on signal attenuation, phase shift, and other RF characteristics. BIM models may be employed to infer boundary conditions, which may be fed into a PDE solver, to interpret signals.

Arrays (including phased arrays) of devices may be employed to map the jobsite through tomography applications (e.g. through different devices, or antenna arrays on single devices). Reflectors, frames, cavities and other resonator configurations may be used (as part of the device assembly, or in a separate housing to the device assembly) to enhance resonance modes, from which material characteristics can be derived. Opportunistic reflectors and/or resonators may be detected and used, to enhance resonances, or measure time of flight and attenuation (which inform on the properties of the material).

Devices may be shielded from outside EMC interference using various geometries that isolate a section of the material under consideration. These may take the form of a receptacle within the housing of the device into which concrete can flow, and within which the antenna is disposed (or also scenarios where the antenna is in proximity to such surfaces with concave features). Likewise, for embedded devices, geometries that promote bonding (as described already) are particularly important, to avoid air-gaps and manage reflections

Electromagnetic wave impedance spectroscopy can be carried out (to characterize the E&M wave impedance at a plurality of frequencies). Intensity response, S parameters and T parameter sensing, and generally other wave-based techniques already described elsewhere. Different forms of signal modulation, and polarization may be used, and any of the advanced RF techniques described in the general hardware section. Fractal antennas and other adaptive antennas systems, and antenna tuning systems may be employed to maximize electromagnetic transmission into the medium. Integrated signal processing is able to measure attenuation, phase shift, time delays to determine time evolving material characteristics in real-time. The system can dynamically adjust the sensing range and resolution based on the type of material and the depth of analysis required.

### Terahertz

Terahertz Wave-based Sensor Device: Terahertz wave-based sensing allows for even higher resolution spatial mapping, due to the shorter wavelength/much higher frequency. This is an emerging field and would be particularly novel for high resolution characterization and mapping of concrete. From mid-IR onwards, waves would suffer too much attenuation (at which point optical waveguide sensing, or optical spectroscopy techniques may be employed). Higher resolution Terahertz wave-based sensing enables mapping of inhomogeneities—e.g. the aggregate and cement matrix structure within the concrete. Measurement of the electromagnetic wave impedance, and the reflection and transmission in the terahertz regime is considered, using an ultra-low-power, low-cost, battery or energy harvesting, and wireless device.

Sensing Techniques: The inventors have considered terahertz wave attenuation probing, and terahertz electromagnetic wave impedance spectroscopy. The use of terahertz frames, waveguides, reflectors and/or cavities are also employed to create resonant systems that are able to probe the material around them and enhance resonance modes. The system is able to characterize the time-evolving fresh properties of concrete (e.g. curing and hydration), and the formation of the aggregate and cement matrix. Longer term, detection and mapping of micro-cracks and/or cracks, as well as voids becomes possible. In addition to terahertz electromagnetic wave impedance spectroscopy, terahertz reflection time of flight (with a known or opportunistic reflector, or on a waveguide or in a cavity), and signal amplitude attenuation are used to probe the host material.

Multimodal Device: THz technology can be integrated with other sensing methods (including wave-based sensors, or context awareness), such as RF and Bluetooth, to provide a more comprehensive analysis. This multimodal approach leverages the strengths of each technology for enhanced material characterization.

Practical Challenges: The deployment of THz technology in real-world applications faces practical challenges, including signal attenuation. THz waveguides, reflectors and cavities are used to manage signal attenuation and enhance signals (e.g. through a fabry-perot cavity). These cavities may be micro-machined and made of inert materials, or of silicon substrates, or THz reflective surfaces. The system also includes adaptive signal optimization features that adjust the THz signal's strength and focus.

Terahertz Signal Generation and Emission: The system uses cutting-edge THz transmitters capable of emitting signals at frequencies much higher than traditional RF and

Bluetooth. Techniques employed include: Frequency multiplication (using diodes, transistors and other non-linear electronic components) is achieved; Photomixing: makes use of two lasers with slightly different frequencies. By combining or mixing laser beams on a photodiode, the delta signal generated falls in the terahertz range. Semiconductors like Gallium Arsenide (GaAs) and Indium Phosphide (InP) are used to construct the Terahertz electronics/frontends etc. THz signals are also tuned and modulated to adapt to different material types and desired resolution levels, facilitating detailed material analysis.

Sub-surface Imaging Technique: THz imaging is non-invasive yet capable of penetrating into materials, offering a comprehensive view of internal structures without damaging the material. In particular, a terahertz time-domain spectrometer is included in some of our device embodiments. The system is capable of dynamic range imaging, adjusting the penetration depth and resolution based on the material's characteristics and the imaging requirements.

High-Speed Signal Processing Unit: An advanced, high-speed signal processing unit is integrated for real-time analysis of THz signals, essential for constructing detailed images of material interiors. Sophisticated software algorithms reconstruct detailed 3D images or maps from the THz data, providing insights into material composition and structural integrity.

Environmental Compensation Mechanisms: Built-in mechanisms compensate for environmental factors such as temperature and humidity, ensuring consistent and accurate imaging under various conditions.

NMR, EPR and/or Microwave Spectroscopy

Nuclear Magnetic Resonances, Electron Paramagnetic Resonances, and Microwave spectroscopy techniques can be used in the radio and microwave part of the spectrum to produce a response spectra (in the case of NMR and EPR, related to the spin of their nuclei and electrons respectively). Spectroscopic analysis can then be carried out to determine compositional properties of the sample over time e.g. signals that demonstrate absorption due to water and its decaying influence as the concrete cures and dries. In this section, ultra-low-power, low-cost wireless, miniaturized devices (e.g. designed for embeddability or surface mounting on concrete) are designed with NMR, EPR and Microwave Spectroscopy capability, for field material characterization and identification.

Principle of NMR: When placing nuclei that carry spin in a strong magnetic field, the magnetic moments of those particles align with the applied field, but they also process around the field direction, at a frequency known as the Larmor frequency. This frequency is different for each type of nucleus, and also depends on the applied magnetic field strength. In NMR, samples are placed in a magnetic field, and radiofrequency pulses are used to perturb the magnetic moment alignment and precession frequency. The nuclei absorb energy from these pulses and move into a higher energy state. After the pulse, they return to their initial state and release energy as a result. This energy release is detected and recorded, producing an NMR signal. In NMR the pulse is typically in the radio frequency domain.

Principle of EPR Spectroscopy: When placing unpaired electrons (e.g. in paramagnetic materials) in strong magnetic fields, their magnetic moments also align with the applied fields (due to the electron spin). When placed in a magnetic field, the spin states of the electron split into different levels (governed by Zeeman effect). In EPR spectroscopy, the sample is placed in a magnetic field and subjected to a microwave frequency sweep. Resonance absorption occurs when the microwave energy matches the energy delta between the split levels. This leads to a change in magnetic field at the detector, which can be measured to determine the EPR Spectrum and the g-factor. Species of interest include Fe(III), Fe(II) and Mn(II), and other paramagnetic species.

Material Fingerprinting & Curing Monitoring: NMR, EPR and more broadly, Microwave Spectroscopy are highly effective in monitoring the curing (in particular water changes). As concrete cures, changes in the concrete properties are tracked over time to assess the curing stage and overall quality of the concrete and make determination about the water to cement ratio and the compressive strength of the concrete, as well as its setting time.

NMR, EPR, & Microwave Frequency Generators & Antenna The system houses specialized dual-mode generators capable of emitting both NMR (radio) and EPR/microwave frequencies. Precision control mechanisms are integrated to ensure the stability and accuracy of the frequencies generated. This is crucial for consistent and reliable material analysis. The system includes an array of directional antennas for the emission and reception of NMR and microwave signals. Optionally, the antennas are designed to adaptively focus and steer the emitted signals, enhancing the depth and resolution of material penetration.

Energy Absorption or Emission Detection System The system employs high-sensitivity magnetic field detectors to measure the energy absorption or emission at specific frequencies. In the case of NMR, as the nuclei or electrons relax to their ground state, they realign with the permanent magnetic field, which generates an electromagnetic wave (RF or Microwave respectively), which is detected in a nearby receiver coil. The chemical shift is also measured in association with the NMR spectrum. In the case of EPR, as electrons are excited by incident microwave energy. Parts of the microwave spectrum are absorbed, which leads to a change in the intensity of the wave, which is measured at multiple frequencies to construct a spectra. The g-factor is also measured in association.

Magnetic Field Generation (For NMR and EPR) In the NMR and EPR module, uniform magnetic field coils generate a consistent magnetic field. Control systems are integrated to adjust the magnetic field strength, allowing for customization based on different material characteristics.

Environmental Adaptation Features The hardware is designed to be rugged and portable, making it suitable for use in diverse field conditions (including for embedding in concrete). Other sensors to compensate for environmental factors (like temperature, humidity) are included, ensuring that external conditions do not compromise measurement accuracy.

Combination of EPR & Electrochemistry: Optionally, electrochemistry devices (as described in that section) are combined with EPR spectroscopy-based devices which allows for the detection of the paramagnetic species created during the electrochemical process.

### High-Frequency (Near-IR, Visible, UV, X-Ray+)

### General Introduction

High frequency wave-based sensing techniques involve E&M waves (also sometimes colloquially referred to as “light”) with frequencies at the near-IR band and upwards. At these frequencies, E&M waves carry enough energy to begin exciting atoms and particles. These excitations and interactions are used to characterize the medium under consideration, from its fundamental constituents upwards.

We consider devices in the high-frequency E&M domain across two main categories, indicative of the general sensing techniques these devices use. These are (1) Intensity Spectroscopy & Imaging Sensing (ISI Sensing); and (2) Photonic Sensing.

Without loss of generality, other categories of high frequency wave-based sensing may also comprise high frequency wave based sensing.

Intensity Spectroscopy & Imaging Sensing may refer to a class of sensing technique which comprises analyzing the E&M intensity-frequency spectra of E&M waves emitted, absorbed, reflected, transmitted and/or otherwise interacted with or radiated by a medium. Typically this will involve the actuation of a medium using a high-frequency E&M wave, which will interact with the medium in one of the aforementioned ways and be sensed using a spectrum analyzer to monitor intensity spectra.

Photonic Sensing may refer to a class of sensing techniques which use materials with photonic properties that may control and/or influence E&M waves in or around the IR/Visible/UV spectrum to engineer conditions that are particularly advantageous for sensing the interaction of these E&M waves with the material under consideration (e.g. host medium or material).

As for other types of wave-based sensing devices, the sensor devices disclosed herein may principally be used to measure compositional, contextual and/or static material properties of the host material, as well as material and/or device contextual conditions, and/or any other data type listed in any part of this document. Any part or sub-part of any embodiments, disclosures and/or further descriptions in this section, may be used to enable, in full or in part, any method described herein. Any part or sub-part of any embodiments, disclosures and/or further descriptions in this section may also without loss of generality be used for any other embodiment of any sensor device described herein. Any of the methods described in this section may be used on any hardware embodiment disclosed (for example, low-cost mobile battery powered field devices designed to be embedded and/or attached within concrete, able to communicate wirelessly using any of the communication methods already described, coupled with smartphones and cloud-based machine learning models for analysis).

These low cost devices of the present disclosure present a step-change away from bulky lab-based spectroscopy that are incapable of performance in the field as described herein.

### Intensity Spectroscopy & Imaging Sensing (ISI)

### Introduction

### General Purpose and Differentiation/Motivation

Intensity Spectroscopy & Imaging Techniques may present a particularly inventive way of measuring the data type (e.g. any material property) listed in any section of the document, and in particular for the determination of compositional material properties (atomic elements, compounds, formulations etc.), as well as any contextual and/or static material properties associated with the chemistry, atomic structure, and/or other atomic level properties of the material. Without loss of generality, these sensor devices may also present inventive methods of measuring other types of properties of matter. In this way, the device embodiment listed herein may be particularly useful for intrinsic material identification purposes. Such devices therefore present a highly novel and accurate material monitoring tool based on fundamental, atomic-level chemical and physical material properties, which may self-identify materials. In addition, imaging techniques allow for spectral E&M Wave tomography, as E&M spectra are spatially mapped to different areas of material, which allows for comprehensive characterization of the material. These techniques may be applied to cementitious mixes and/or concrete mixes or any of their raw materials, but also other materials used in construction such as steel beams and/or rebar, timber, coatings such as intumescent paint, and without loss of generality any building materials, composite material, raw material, mined or extracted material and/or other materials.

### Sensing Method Novelty, Inventiveness and Benefits Over Existing Methods

As compared to current methods, these methods provide significant benefits, novelty and improvements. This includes but is not limited to:

Material Identification/Fingerprinting: Current concrete solutions offer no visibility into the identity of the concrete, which often leads to human error when identifying concrete (see more in Mix Fingerprinting section). The techniques herein offer accurate material identification capabilities which may be used for fingerprinting.

Property Monitoring in combination with automatic identification: Using intensity spectroscopy and imaging sensing techniques for material property monitoring may be augmented by automatic, accurate material identification, which may remove the need for calibrations in other methods (e.g. maturity, enabling enhanced maturity).

Fundamental Measurement Method: Intensity Spectroscopy and Imaging sensing methods measure the fundamental chemistry and/or physics of the material and its interaction with E&M Waves at the levels of particle, atomic, and atomic structure. This is particularly novel and inventive for use on active construction sites. In particular for cementitious mixes, the main driver of change in the material is the hydration reaction that occurs between the cement matrix and water in the material. This is a chemical reaction. Tracking the chemistry of materials within the mix over time as they cure may therefore provide a fundamental, direct measure of the concrete curing rate of reaction without the use of proxies.

Tomography: Intensity Spectroscopy and Imaging sensing methods allow for comprehensive, fundamental characterization of the material through spectral tomography. This includes both two-dimensional and three-dimensional images/tomography of materials over time. This temporal aspect is crucial in monitoring changes in material properties during processes like curing, aging, or degradation and/or other evolutions.

Highly Accurate and Granular: Intensity Spectroscopy and Imaging sensing may be used to monitor the material at the atomic level, and hence provide highly accurate and granular material property data.

Complementarity with other sensor devices: given these sensor devices are particularly effective at characterizing chemical and atomic-level material properties, they may be combined with many of the other sensor devices herein which may be more effective at characterizing physical, electrical, magnetic, mechanical and/or other properties, including macro-level properties. See examples elsewhere herein.

Non-Destructive: in most embodiments herein, the techniques described are non-destructive techniques (NDT) whereby material may be sensed without destroying it (or destroying microscopic, negligible amounts of it). Non-Destructive spectral monitoring and material identification techniques are completely novel for concrete and construction applications and highly advantageous.

Device novelty, inventiveness and benefit over existing methods may include:

Device embodiments disclosed herein for intensity spectroscopy and imaging sensing are also novel and inventive in a number of ways. These include but are not limited to the following parts of these embodiments:

Portability of intensity spectroscopy and imaging devices herein for use in the construction project and/or site—the use of Spectroscopy as a portable monitoring method in the field with little to no sample preparation is entirely novel and presents a key innovation that enables these techniques on site.

Embeddability-Intensity Spectroscopy devices may be configured to be embedded or non-embedded/surface mounted devices. These may in some embodiments be ‘smart’ devices that can optionally interface with a mobile phones or other personal devices, which is novel.

Embodiment details—The specifics and details of the embodiments listed herein are particularly novel and inventive, including in particular use of components such a adaptive lenses, MEMS based beam guides and/or optic manipulation such as mirror control, frequency splitting (e.g. spectrograph), filtering based on wavelength, power and/or polarization, and/or others etc.

Beam-guiding in particular will allow spatial sampling, which would allow for sampling of both the active reagents in a cementitious mixture (binder, water, admixture, and how they react) and also the inactive reagents (aggregate). Multiple samples can be clustered and averaged (or otherwise processed to increase quality of measurement). Particular implementations of the spectroscope to reduce cost of the device and make embeddability (in that use-case) a viable option.

### Use Cases May Include

Some use cases for intensity spectroscopy & imaging may include: In one embodiment, the sensor devices herein may be used for provenance and quality control of building material determinations (e.g. for readymix concrete and/or any other types of building materials such as concrete, cementitious mixes, metals, steel beams, steel rebar glass, other composites and/or other raw materials). This technique may be particularly useful for ensuring that materials meet specific composition standards (or for verification of provenance for embodied carbon analysis).

In another embodiment, the devices herein may be used for material identification. In particular, the material's compositional properties may be determined, in conjunction with its static or contextual material property (e.g. to link the strength gain or workability of a mix to its composition, including its formulation, or chemical composition). These identifications may then form a labeled dataset used for training or updating of the models and methods described elsewhere herein (e.g. models and methods described in for mix optimization), increasing their predictive power and/or accuracy.

Compositional property determination for mixes may be carried out in any of its following contextual conditions: Dry cement bag; Readymix bag; Fresh concrete before being poured (e.g. in the drum); Concrete setting in-situ (from fresh to hardened); Nearly mature or mature solid concrete; Existing concrete structures and their degradation, corrosion etc. In general ISI devices may enable the monitoring of compositional material properties over time. In some embodiments, this may be used to monitor changes in the composition of materials in time and/or the degradation of materials over time, including for absolute of perturbative fingerprinting.

In a related use case, the constituent raw materials of a concrete mix formulation may be derived from the measurements of the ISI devices (e.g. by differentiating between different elements and materials in a mixture such as differentiating between the aggregate and the cement matrix which may be done using advanced spectral data processing).

In a further embodiment, ISI devices may be used to determine contextual material properties of concrete to inform construction operations. For example, this may include compressive strength determination over time.

And in another embodiment, ISI devices may be used to determine compositional material properties or static or contextual material properties for raw materials before batching, providing formulation and/or compositional information for the constituent materials of the cementitious mixes, as well as information such as cement reactivity (a contextual material condition).

In a further example embodiment, relative changes in contextual material properties are measured using ISIs, such as the degree of curing against a target design strength, or the evolution of compressive strength over time (e.g. a strength profile), but also the expected activation energy of a given mix. These determinations are used alongside the Mix Optimization, Mix Fingerprinting and other models to make predictions (optionally based on real time ISI data) on future state of contextual material properties, optionally based on additional data from at least one other sensors (e.g. temperature for environmental correction adjustment).

In another embodiment, ISI data is used to create a large labeled dataset of compositional properties (e.g. formulations) which is associated with key contextual material properties (where both are derived from the ISI data). This labeled dataset is used to train any of the models described in this document and may also be used to empirically derive new fundamental physico-chemico principles.

### General Background Information

### Physical Principles and Relevant Technique Embodiments

The Intensity Spectroscopy and Imaging Sensing Techniques and Devices described herein comprise methods and devices that measure the fundamental intensity spectra resulting from the interaction of E&M Waves and matter. E&M waves carry energy. In the high-frequency domain, this energy becomes sufficiently high that E&M waves are able to interact with and excite matter at the level of the atom and/or particles. In these sensing embodiments, the input/actuating and output/sensing type (or coupling) is the same, namely E&M waves are both used to actuate and/or excite the medium under consideration, as well as sensed to characterize the material.

For example, high frequency E&M Waves are able to excite electrons in atoms, which reach a higher energy by being absorbed, typically for a short timespan. Upon de-excitation, the electrons re-emit light and drop back to a lower energy state. The frequencies of light being absorbed and re-emitted will depend upon the chemical composition of the material sample. Each chemical element in the sample material emits light at specific wavelengths. Therefore, by analyzing the complete intensity spectrum (i.e. the intensity of light over a range of E&M wave frequencies), resulting from the interaction of E&M waves, it may be possible to characterize compositional properties of the material including its chemical composition.

There may in general be multiple configurations of interactions between E&M Waves and the material under consideration which may be used to characterized the intensity spectrum of the material, for high-frequency wave-based sensing applications, some of the most relevant types include:
Absorption Spectroscopy—Characterizing the intensity spectrum resulting from the detection of absorption of E&M Waves by a material (i.e. through the lack of intensity at particular frequencies);
Emission Spectroscopy—Characterizing the intensity spectrum resulting from the detection of emitted E&M Waves by a Material. Emission/Radiation may be caused by natural blackbody radiation, or may be induced through for example fluorescence;
Scattering & Reflection Spectroscopy—Characterizing the intensity spectrum resulting from the detection of light being scattered by a medium;
Inelastic Scattering Spectroscopy—Characterizing the intensity spectrum resulting from the detection of E&M Waves being scattered in a way that shifts their frequency;
Some Relevant Embodiments of E&M Wave-Based, High Frequency, Intensity Spectroscopy and Imaging Sensing Techniques described herein include (but are not limited to): Laser Induced Breakdown Spectroscopy (LIBS); Fourier Transform Infrared Spectroscopy (FTIR); Hyperspectral Imaging Spectroscopy; Raman Spectroscopy; X-Ray Diffraction Spectroscopy (XRD); Differential Reflectance Spectroscopy (DRS); and/or Fourier Transform Spectroscopy (FTS).

Others high-frequency spectroscopy techniques (which are not described in detail herein, but for which embodiments described herein may be adapted) include (without limitation) the following. Infrared (IR) Spectroscopy Techniques: Near-Infrared Spectroscopy (NIR); Fourier Transform Infrared (FTIR) Spectroscopy; Attenuated Total Reflectance (ATR) Spectroscopy; Diffuse Reflectance Infrared Fourier Transform (DRIFT) Spectroscopy; Photoacoustic IR Spectroscopy; Microspectroscopy; Time-resolved Spectroscopy. Optical (Visible Light) Spectroscopy Techniques: Ultraviolet-Visible (UV-Vis) Spectroscopy; Colorimetry: Fluorescence Spectroscopy; Differential Optical Absorption Spectroscopy (DOAS); Phosphorescence Spectroscopy; Raman Spectroscopy. Ultraviolet (UV) Spectroscopy Techniques: Vacuum Ultraviolet Spectroscopy; Photoelectron Spectroscopy; Resonance Raman Spectroscopy; Circular Dichroism (CD) Spectroscopy; X-ray Spectroscopy Techniques: X-ray Absorption Spectroscopy (XAS); X-ray Fluorescence (XRF) Spectroscopy; Energy-dispersive X-ray Spectroscopy (EDX); Wavelength Dispersive X-ray Spectroscopy (WDX); X-ray Photoelectron Spectroscopy (XPS); Extended X-Ray Absorption Fine Structure (EXAFS); X-ray Emission Spectroscopy (XES). Gamma Ray Spectroscopy Techniques: Gamma-ray Spectroscopy; Neutron Activation Analysis; Mössbauer Spectroscopy; Positron Annihilation Spectroscopy.

### Intensity Spectroscopy and Imaging for Concrete Applications

Within the context of concrete mixes, the intensity spectroscopy and imaging devices and embodiments described herein may be used for accurate concrete compositional properties determination, contextual material property determination, including early-age compressive strength determination, and chemical properties determination.

In some embodiments, certain compounds of interest may be detected using the device(s). Certain compounds and/or molecules which may be detected in cementitious mixes such as concrete may include but are not limited to: Tricalcium Silicate, Dicalcium Silicate, Tricalcium Aluminate, Tetra-Calcium Aluminoferrite and Water. These molecules and/or compounds may in general be the principal drivers of the hydration behavior of cementitious mixes and therefore may dictate the cementitious curing behavior of mixes. The inventors therefore envision that determination of these compounds may be used for concrete curing monitoring, as well as formulation and/or composition determination. The determination of material water content, as well as moisture content may be of particular interest, as well as the determination of water-to-cement ratio in concrete. In a further embodiment, the device may be used in building materials to detect impurities and/or undesirable materials.

Certain scattering-based spectroscopy techniques may also be used to determine the crystalline atomic structure of cementitious mixes, which may dictate the material's behavior under stress and shear forces or may provide durability information. The inventors also make use of intensity spectroscopy imaging techniques, whereby the spectra associated with the building material under consideration may be spatially characterized, adding another dimension to its characterization. This may allow for the detection of irregularities and inhomogeneity in concrete, as well as for the characterization of the curing behavior of a building element, rather than at individual local points.

### General Considerations

### General Spectroscopy Device & Components Description

The device conceived of by the inventors is an ISI, high frequency wave-based sensing device which may be configured to extract intensity spectra from building materials (e.g. concrete) at all stages of its lifecycle. In some embodiments, the device may be embedded inside a host material e.g. concrete, in which case it would actuate the concrete and sense the concrete spectrum from within. In other embodiments, the sensor device may be positioned on the surface of the concrete (e.g., as a handheld device, or a device mounted on and/or attached to the concrete, or integrated as part of the formwork), or directed at concrete. The general features and/or components of the intensity spectroscopy and imaging devices described herein may include the following:

### Input Light/E&M Wave Source.

Intensity spectrometry techniques are carried out by exciting the target with a light source of high-frequency E&M waves. In some embodiments, this may comprise a monochromatic light source such as a laser that may optionally be configured to pulsate its output intensity. Other examples may include an X-ray laser, generator and/or gamma ray monochromatic source. In other embodiments, this may be a polychromatic light source involving frequency bands of interest, such as a medium width band light source such as a single color LEDs. Other examples may include tunable lasers, multi laser arrays, multi-LED arrays and/or any combination of any light source described herein. In some cases, tungsten halogen lamps, xenon arc lamps, neon lamps, globars, nernst glowers

### Output E&M Wave Sensors—Photodetectors/Spectrometers

The output to be measured is the intensity spectrum of E&M Waves due to the resulting interaction with the target. In the embodiments described herein, they may be detected and/or analyzed using photodetectors and/or spectrometers (optical or lab-on chip). In another embodiment, tunable photodetectors and/or multiple separate photodetectors coupled with optical filters may be used to detect single frequencies or narrow bands of interest.

In one embodiment, the photodetector may be a monochromator device. Such a device may consist of a single detector, narrow slits, and rotating diffraction grating/prism to disperse lights, used to choose required wavelengths

In another embodiment, the photodetector may be a spectrograph configured to analyze wider spectra, select bands of interest, account for background E&M radiation and discard noise bands.

### Filters

In some embodiments, E&M wave frequency filters may be used to separate different frequencies of light/E&M waves (where light and ‘E&M waves’ may be used interchangeably to mean E&M waves across the relevant portion of the spectrum). Certain embodiments herein describe intensity spectroscopy and imaging techniques which sense known target features, such as particular intensity peaks in the spectra (e.g. due to the presence of certain chemical elements in the material). In such cases, filters may be used to isolate these frequency peaks. These filters may be micromachined or constructed with MOEMS components and may include tunable filters such as a MOEMS-based Fabry-Perot Tunable Filter.

In some embodiments, polarizing filters may be used to reduce some of the transmitted incident E&M Waves, and/or only allow certain polarized modes of light through and filter others, and/or twist the waves' polarization (e.g. with systems such as the twisted nematic liquid crystals). Polarizing filters may also be used to control the angle of incidence of light which may be allowed to transmit through. In one embodiment, this may be used to guarantee the polarization of the light source such that it is differentiated from both ambient E&M Waves, and/or E&M waves following an interaction with the material under consideration.

### E&M Wave/Light Manipulation

Light manipulation such as beam steering, dispersing, focusing and/or reflecting techniques are a particularly novel and inventive feature of the devices, especially in the context of cementitious mix compositional and contextual material property determination methods. Cementitious mixes may be composed of inert materials (e.g. aggregate particulates) as well as active materials-reagents in the hydration reaction. Light manipulation techniques alongside for example machine learning methods, may enable the devices to accurately determine which particulates are being spectroscopically sensed, and even choose which ones to sense.

In one embodiment, the intensity spectrometry device may comprise a light manipulation system which allows for beam steering for E&M waves. Some embodiments of light manipulation may include: (1) An adaptive lens used for adaptive focus and/or dispersion of E&M Waves; (2) A MEMS or MOEMS-based beam steering/wave guiding system; (3) A fiber optic multiplexer and/or mixer to allow for the reflected light to be observed from different locations: (4) diffraction gratings to diffract light for further analysis.

In a further embodiment, fiber optic design can also be used as a method of filtering the wavelength domain as the size and refractive indices of the fiber optic materials (core, cladding and buffers) determines the mode or modes in which the light can and can therefore attenuate undesired wavelengths. This can be achieved with single or multi-mode fiber optics. In another embodiment, fiber optic bundles are used to ensure a multiplicity of spatial sampling regions, by guiding light to multiple locations within the host material, and sample at each one of those locations.

### Medium Under Consideration

The device embodiments described above may be used to actuate media by transmitting high frequency E&M waves, and then sense the E&M waves received back after the interaction between the wave and the medium has occurred. The medium under consideration may vary, but may include (non-exhaustive):

A building element e.g. concrete element which may optionally be curing; The surface of a wet material; Dry concrete or dry mix (concrete, sand, aggregate and other materials); Other cementitious mixtures; Any other embodiment of a building material; Extracted materials in the mining industry; materials in other industries (e.g. in other heavy industries). Concrete may be specified when describing a technique, for illustrative purposes only (and all embodiments described herein may be used to evaluate any number of materials).

Cementitious materials, or other curing agents or materials that evolve from a liquid or semi-liquid to a hard state make particularly interesting targets or applications, because our embedded sensors embodiments can be disposed within them when they are still in their liquid or semi-liquid state.

### Post-Processing Software

Data analysis and post processing software may be used on the output data from the ISI devices described herein. Data Analysis and post-processing techniques in some embodiments may include Fourier Transforms & Fourier Analysis (e.g. FTIR). Other techniques may include analysis of ratios of intensities and/or other information indicative of or derived from energy spectra (e.g. ratio of intensity at two separate frequencies in the spectrum). This may be used for perturbative fingerprinting or identification methods (as described in mix fingerprinting). Another embodiment includes, given a known target frequency of interest, the use of holographic mirrors as reflective wavelength filters for the frequency of interest to reach the detector.

### Other Considerations

Materials: Use of glass or other robust transparent materials like crystals for certain components to ensure durability and clear optical pathways.

Shapes: Embodiments may incorporate various geometric forms (including optical ‘frames’, which are the optical embodiment of the frames described in the formalism and techniques section). Example embodiments may include spheres, trapezoid prisms, and semi-parabolic convex domes. These shapes are chosen based on their optical properties and the requirements of the specific spectroscopic or imaging technique. Photonic waveguides and cavities may also be employed (as described in the photonics section).

Note, any combination of embodiments and/or plurality of embodiments described herein may be used, in any configuration and/or association.

### General Device Embodiments

The inventors disclose a number of generalized device embodiments which may be applicable for various ISI technique embodiments. The methods, features, devices, components, techniques and other embodiments described herein may without loss of generality be used for any other specific embodiment associated with intensity spectroscopy and imaging sensing devices, or more generally with wave-based sensing.

### Adaptive Lens Modular ISI Sensing Device

This embodiment describes 2 principal configurations of intensity spectroscopy and imaging devices comprising an adaptive lens for beam steering needs, and modular parts. In a first configuration, the device is designed to be used against the surface of building elements. This may be referred to as one or more of a reusable non-embedded; handheld; surface mounted; formwork mounted intensity spectroscopy and imaging sensor device. In a second configuration, the sensor device is embedded within a host material which may include a cementitious mix.

### Reusable Non-Embedded/Handheld Device/Surface Mounted Device/Formwork Mounted Device:

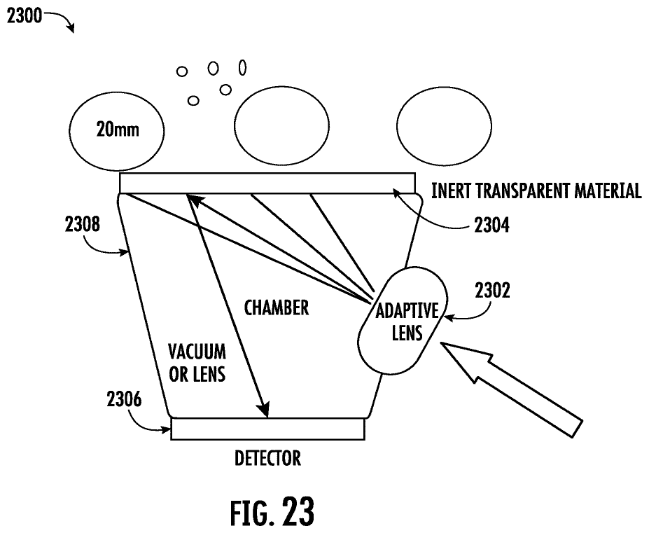

With reference to FIG. 23, a device 2300 is illustrated. As shown, the device 2300 may include an adaptive lens 2302, an inert transparent material 2304 (e.g., adhesive coating), a chamber 2308, and a detector 2306 (e.g., EM wave sensor to detect output waves). In this configuration, the device 2300 may be configured to actuate the surface of a building material with E&M waves, and sense the resulting received waves (which may be reflected, re-emitted by the material, or otherwise radiated). The device 2300 may be mounted upon the surface of the material, handheld against it and/or otherwise configured to be in contact with the surface of the material.

The device may include a modular light source attachment mechanism supplying light to the adaptive lens. This allows for different types of light sources to be slotted in and out of the device 2300, allowing for different spectrometry techniques which employ different light sources to be used. The light source may be configured to emit a high-frequency E&M Wave through an adaptive lens 2302 or deformable mirror (or other adaptive beam steering mechanism). The light source may be configured to emit any type of input signal described in any section herein.

The adaptive lens 2302 or deformable mirror is configured to steer light towards any locations on the surface of the material under consideration and/or disperse the light towards multiple locations on that surface, within the device's range. It may be a liquid crystal lens, or an electrically controlled MOEMS-based adaptive lens system 2302 (or in a further embodiment, a deformable mirror may be used instead, particularly suitable to higher power beams). This is a highly novel and inventive component designed by the inventors to address particular challenges involved with spectrometry based techniques in cementitious materials.

Adaptive lens components 2300 may be modular and different lenses may be slotted into the device housing 2308 which may suit different embodiments of spectroscopy techniques described by the inventors herein. Adaptive lenses 2302 may in general be configured to be transparent to the light source being emitted, and may in some embodiments, be configured to match particular light sources. Adaptive lenses 2302 may generally be tunable, controllable components, which may vary in shape, convexity (and/or concavity), and/or orientation to focus and/or disperse E&M Waves at different points. A similar embodiment may also be achieved with the deformable mirror.

The adaptive lens 2302 may be configured to be integrated into the device's housing 2308. The casing surrounds a chamber through which the light may be configured to travel. In some embodiments, the chamber may be a miniaturized vacuum (or a low matter density) chamber, to allow for minimal E&M wave disruption, and maximal control through the adaptive lens. In other embodiments, the chamber 2308 may consist of further optical media which may allow for further beam steering and/or dispersion of the E&M waves. When the chamber 2308 is not vacuum, post-processing techniques such as those described in context awareness may be used be used to account for the disturbances caused by the chamber's 2308 material (e.g. may further absorb frequencies of light not absorbed by the target material, which may constitute anomalous data). The E&M waves travel through the chamber 2308 towards the face of the device in contact/sharing a boundary (e.g., material 2304) with the surface of the building material.

This face may include an aperture, which in some embodiments may be coated with an adhesive protective layer (which may be referred to as an aperture layer 2304), configured to be inert and transparent to the E&M waves being emitted. In some embodiments, the face of the device casing placed in contact with the building material may be equipped with a suction or positive pressure mechanism to hold the device in place on surfaces such as walls or ceilings.

The E&M Waves/beam travel through the coating and onto/into the surface of the material, exciting it. Once waves make contact with the surface of the material under consideration, the E&M radiation/waves may be reflected, emitted and/or otherwise radiated from the material. These waves may re-enter the coating 2304 and ultimately the chamber 2308. The device geometry is configured such that the angle of incidence of most of the waves reflected, emitted and/or otherwise radiated may reach an E&M wave detector 2306.

The E&M wave detector 2306 may be configured to be a modular component of the system, such that different types of detectors may be attached and/or removed from the device system, depending on the specific sensing technique, frequencies of interest, light source choice and other considerations. Such detectors may include a photodetector, optionally comprising a spectrograph or otherwise connected to one for signal processing and data analysis. Software, either edge based or on the cloud may be used for further signal processing.

In one embodiment, the light source may comprise a laser emitting a beam of a particular beam width. In the case for composite materials, such as cementitious mixes where inhomogeneities of the material need to be accounted for, the adaptive lens feature is crucial for beam steering. This enables spatial sampling.

For example, concrete is comprised of aggregate particulates (for the most part, an inert filler), cement, water and admixtures (the chemically active reagents participating in hydration). In concrete, if the beam width is smaller than the largest aggregate (typically 20 mm), then our device may capture spectra associated with one aggregate particulate rather than the cement matrix. This may offer challenges for material property determinations.

In one embodiment, the laser beam width is electrically configurable to cover a sampling surface area larger than the largest aggregate surface area, to enable averaging effects. In a further embodiment, the laser beam width may be electrically configurable or tuned to cover a larger sampling surface area (which may be at least larger than the largest aggregate present in the mix). This enables a more homogeneous measurement (through averaging effects). Alternatively, the width modulation mechanism is configured for smaller beam width, for more precise spatial sampling, for example, for aiming at specific target locations or raw materials in a composite material.

The inventors further disclose the use of a mechanism which enables the sampling of the target material at two or more spatial locations. Some locations will include aggregate, others cement matrix, or a mix of both. By gathering a plurality of samples, the system is able to construct a representative average spectra and remove the impact of inhomogeneities. A particularly advantageous mechanism used for spatial sampling employs beam steering, using the adaptive lens described above. This allows for precise control of the spatial distribution of measurements.

The beam steering mechanism may be configured to allow for selective aiming at samples comprising the cement matrix or the aggregates, or other types of materials. For example, a plurality of measurements may be taken at random across the surface of the material. A machine learning model may then be employed to differentiate between cement matrix and aggregate measurements and configure the device light source to aim accordingly.

### Embedded Device

The device described above with reference to FIG. 23 may be fully embedded in concrete (as described further in later sections). Alternatively, a further enhancement comprises keeping the same general components, but altering the shape and spatial configuration of the device and its components. The housing of the wave-based sensor may be spherical and transparent, and fully encase the components, with the light source, associated lens, and detector placed at the center of the device. The light source is able to rotate (mechanically, or electronically), such that it may irradiate any point of surrounding material. The aperture in this case may also be spherical in form and cover the entire device. In another embodiment, multiple individual apertures through which the incoming waves can be gathered may be scattered throughout the surface of this device. A spherical embodiment is described in more detail later.

### Further Embodiment—Aperture Retraction

Further device embodiments may include aperture layer unfurling/retraction mechanisms wherein the transparent inert coating material at the aperture may retract itself allowing for E&M waves to reach the surface of the material directly without passing through a coating layer. In this embodiment, the aperture may be opaque, as it dynamically retracts when measurements are taken. It protects the inner electronics from the building material but opens up to create an optical path for measurements to be taken.

In the embodiment wherein the light source is an embedded LIBS-based laser, the lens/transparent material may retract once the concrete has hardened enough, so as to enable a clear path between the light source and the concrete/building material. The lens/transparent material would retract into a chamber. Optionally, the inside of the device (which would now be exposed to concrete) may be filled with an inert gas, optionally, of a similar refractive index to its optical components. To prevent bonding of the unfurling/retracting aperture layer (which in this instance would be acting as a protective window), the protective window is coated (e.g. with a silicone gel) prior to embedding. A further refinement would have the protective window slide in and out as part of a sequence, in synchronization with the laser pulse, so as to protect the inner electronics (e.g. avoid dust), and also retain the gas (which could otherwise begin to evaporate through the pores in concrete).

### Micro-Mirror Optical Beam Steering ISI Sensing Device System

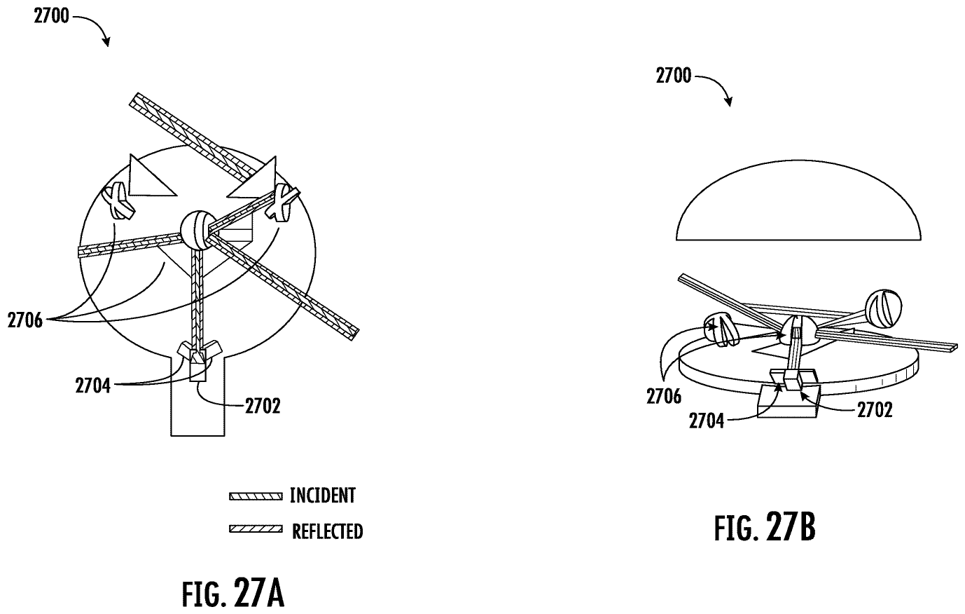

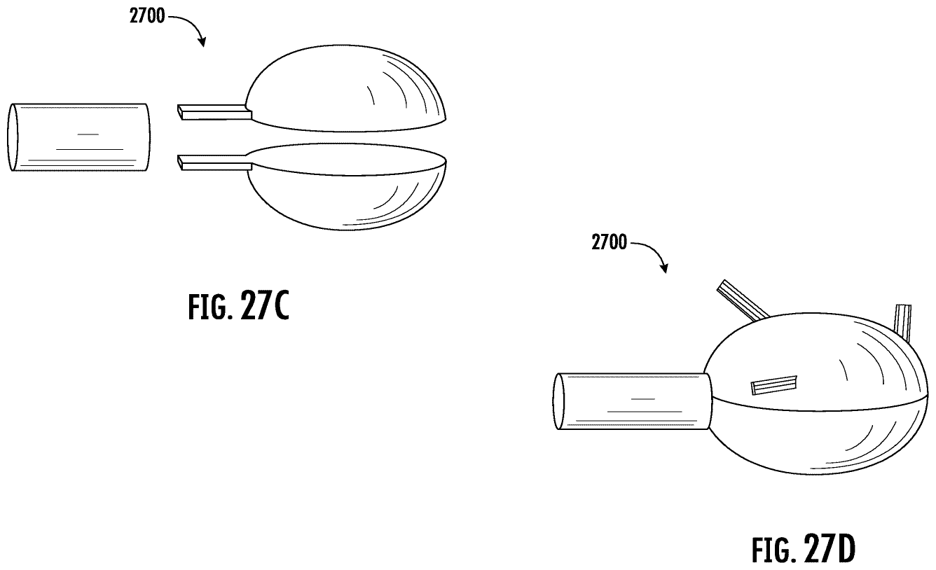

With reference to FIGS. 27A-27D, an ISI sensing device 2700 is provided. As shown, the device 2700 may include a light source 2704, light detectors 2704, and micromirrors (x-y DoM) 2706. In one embodiment, the ISI sensing device system 2700 may be a miniaturized device comprising a micro electromechanical optical beam steering system (MEMS-based) comprising a plurality of micromirrors 2706 arranged to deflect and direct E&M waves, and a spherical or hemispherical transparent, inert casing. In such an embodiment, the light source/emitter 2702 and detector 2704 may remain static whilst a system of tunable micro mirrors 2706 deflect and steer the light towards the target location (e.g. in a first instance from a light source to a building material and in a second instance from a building material to a photodetector). This system 2700 may be used to deflect the beams both when emitted by the light source 2702, and from the material to the light detector 2704. Micro mirrors 2706 may be self-tuning, such that they may self-position, rotate, and/or otherwise vary their configuration through electronic controller setups and software. Optionally, those are controlled by an adaptive machine learning model, which learns the best mirror angles, positions and configurations for given usage modes. This dynamic self-tuning may occur in between excitations and sampling. In one embodiment, the micromirror systems may spatially reconfigure along four degrees of freedom (4DoF ISI devices)—the micro mirrors 2706 may be reconfigured along two planes and may deflect beams ‘left to right’ in the planar direction, ‘up to down’ in the perpendicular/radial direction, and/or in any combination of the two. For example, in a specific micromirror instantiated embodiment illustrated in FIGS. 27A-27B, by using 3 micromirrors, the device 2700 may be configured to steer the emitting and receiving beams (emitting beams may be defined as beams emitted by the device's light source 2702, whilst receiving beams are beams caused by the interaction between emitting beam and the medium under consideration, typically being received by the device's photodetector 2704) along a full 360° angle in the planar direction, and/or 180° in the radial direction (semi-spherical solid angle).

Another embodiment may include an ISI sensing device comprising two such micro-mirror systems, stacked symmetrically against each other, comprising two hemispheres, and configured to together provide a spherical beam-steering solid angle, as illustrated in FIGS. 27C-FIG. 27D. In this embodiment one or a plurality of light sources (e.g. two-one for each sub-micromirror setup) may be utilized. In advanced embodiments, the light sources may be modular, and a plurality of different light sources types may in general be used, typically one on each hemisphere. In this embodiment, this device may become an ISI ‘combo’ sensing device which uses different ISI sensing techniques. This is a particularly novel and inventive embodiment of the invention, which may be particularly pertinent to building material property determinations, wherein the different ISI techniques may be used to determine different, often complementary attributes and/or properties of the building material such as different regimes of material compositional properties determination e.g. raw material formulation determination such as accelerants/decelerants and chemical compound formulation determination. Example embodiments include but are not limited to: a LIBS-FTIR ISI device which may use a LIBS laser sources (e.g. Nd:YAG lasers), and an IR wave source (e.g. heated silicon carbide elements); a LIBS-Raman ISI device, which may use a Raman E&M wave source (e.g. monochromatic laser configured to emit E&M waves in the near-IR, visible, UV range), an FTIR-Raman ISI device, and/or device that combines any plurality of ISI sensing techniques.

### Micro-Opto-Electro-Mechanical, VCSEL-Based, Microchip ISI Sensing Device

In one embodiment, the ISI sensing device may comprise a miniaturized microtechnology-based electronic lab-on-chip system which may comprise the features of the electromechanical optical systems and components described above. In this embodiment, MOEMS (Micro Optic Electro Mechanic System) micro-mirrors may be used to implement a 4DoF configuration. The MOEMS-based micromirrors may be electrically oriented with high accuracy and precision. In further embodiments, the ISI MOEMS-based sensing device further comprises a lab-on-chip/microchip spectrometer system (e.g. that may be based on films of semiconductors), configured to receive and analyze E&M wave spectra. This on-chip spectrometry system may be fully electrically controllable, and may be tuned to detect particular target frequencies. In some embodiments, the light source may comprise a photonic integrated light source such as an integrated laser. This may include tunable integrated lasers and/or externally modulated integrated laser systems. In a further embodiment, the light source may comprise Vertical Cavity Emitting Surface Lasers (VCSEL) and/or VCSEL arrays. In such an embodiment, dedicated micromirrors may be used to deflect the beam sideways due to the vertical nature of VCSELs. The use of VCSEL arrays for building material property determination is particularly novel and may offer advanced power regulation, switchability and beamforming capabilities. The VCSEL arrays may be configured to use constructive and destructive interference between E&M waves generated independently by the elements of the VCSELs array, to shape a resulting light beam in the desired direction. In other embodiments, the technique may also be used to shape the aperture and direction of a single beam. In a further embodiment, the entire MOEMS ISI sensor device system, including the spectrometer, micromirror system, integrated light source and other MOEMS components may be fully controlled using Machine Learning methods and models. This may include dynamic control of the MOEMS micromirror configuration, relative angles and/or positioning, as well as the microchip spectrometer configuration including frequency filtering, and integrated laser tuning or modulation. In one embodiment, the device may be configured for LIBS Spectroscopy.

### LED and Narrow-Band Photodetector ISI Sensing Devices

In one embodiment, the ISI sensing device may comprise a light source comprising one or a plurality of LEDs, configured to emit singular colors. The plurality of LEDs may be configured into LED arrays. In embodiments comprising a plurality of LEDs, these LEDs may be configured to emit E&M waves at particular target frequency bands of interest, and any combination of LEDs emitting the frequency bands of interest may be configured to activate at any given time. In some embodiments, ON and/or OFF switches may be used to activate and deactivate the chosen LEDs. In another embodiment, the spectrometer/light detector in the device system may comprise a digital color sensor, comprising a plurality of individual photodetectors, which may each be configured to detect narrow bands of light, alongside conditioning circuitry and providing a digital output for each electronic integration. This may be particularly pertinent in embodiments wherein the ISI device is configured to detect particular, previously known frequencies of E&M waves associated with a building material under consideration, or a building material property, including contextual properties such as strength estimation, or compositional material properties, including calcium aluminates and silicate content, gypsum and sodium or potassium oxides and/or other atomic elements comprising the material.

Fiber Optic Bundle Device for spectroscopy

Concrete, at the microscopic scale, is inhomogeneous. Various embodiments are considered for spatially directing a spectroscopy illumination beam to different parts of the concrete, or expanding the area of illumination to ensure that inhomogeneities do not bias our measurements (e.g. so called ‘aggregate interference’). Another approach to spatially distributed spectroscopic measurements, is the use of an optic fiber bundle, which may be coupled to the optical path of the spectroscopic light emitter and receiver.

The bundle may be used to redirect light to various locations in space. The ends of the fibers in the bundle may be embedded in concrete, disposed to sample different light paths. Different thickness optic fibers may be employed, based on the aggregate size (so larger fibers for larger aggregate).

The positioning of the optic fibers are used to direct a light beam to the concrete and measure its reflection/transmission/emission. Optionally, in a second embodiment, each fiber in the bundle may contain two sub-fibers, one for light detection, and the other for transmission, which terminate at one optical diffuser). The proposed design will have collimating and forming lenses at the source of the bundle in order to couple the light emitter and receiver to all the fibers (at the same time), or one fiber at a time, based on the application. Selectively coupling the emitter and the photodetector to one fiber at the time is achieved by mechanical movement of the optical head. In an alternative embodiment, micromirrors arrays are used to couple/decouple the head with any particular optic fiber. Finally VCSELs arrays may be used for this implementation, thanks to their ability to be selectively switched On and OFF. In this case, given the dimensions of the optic fibers, discrete VCSEL components would be more suitable, making individual coupling with the many optic fibers much easier. Optionally, the VCSEL's may be on the base of the device (which would be reusable), and the fiber bundles may be detachable and disposable (as their tips would be disposed within the concrete). New fiber bundles could be coupled to the base for new measurements. This embodiment describes the use of fiber bundles for spectroscopy, but all or aspects of the embodiment may be used for photonic or optical sensing more generally across the invention (including for photonic waveguide sensing, or Bragg grating sensing).

### LIBS Spectroscopy Sensing Device

### Description

The LIBS Spectroscopy embodiment of the E&M High-Frequency Wave-based sensing device makes use of LIBS spectroscopy for building material property determination. LIBS Spectroscopy comprises a method using high intensity lasers to transfer energy into and excite a microscopic volume of material into a state of plasma for a very short time interval. Once this ‘micro-plasma’ de-excites, it emits radiation corresponding to the spectral energy levels of its component molecules. This is detected by a spectrometer or other E&M wave detection device. The process, from E&M wave emission to detection may last a few hundred nanoseconds and may be considered a non-destructive or quasi-non-destructive technique in building materials applications, since negligible samples of material are converted into plasma and as such, the structural integrity of the building material is not compromised.

The spectrometer reconstructs the material's intensity-frequency spectrum based on the received E&M waves. Using this spectral data, attributes and/or properties of the material under consideration may be determined. For cementitious mixes, properties of interest for determination may include building material compositional properties, including material formulation and/or raw material concentration within the building material, as well as contextual material properties including compressive strength, and other properties associated with the rate of hydration in early-age cementitious mixes. In one embodiment, the LIBS device may be configured to do spectral analysis for material compressive strength determination in cementitious mixes. One analysis method for execution of this determination includes detecting the intensities of the dominant Calcium I & Calcium II spectral lines, known to exist at 422.6 nm for Ca I, and at 393.3 nm & 396.8 nm for Ca II. Once these are detected, the ratio between the intensity of the Ca I & Ca II (either Ca II lines) may be correlated to the compressive strength of concrete. Calcium compounds comprise many of the reagent compounds in the hydration reaction of cementitious mixes, and may therefore be used for compressive strength determination, which strongly correlates with the hydration reaction. In some embodiments, the relationship between the intensity ratio and the compressive strength of the cementitious mix may be linear. In some embodiments, spectral analysis includes a calibration step. Enhanced LIBS methods may employ double pulse excitation, spatial configuration, magnetic confinement, spark discharge confinement, or DFLS to improve measurement accuracy.

### Device Embodiment Descriptions

The inventors have designed multiple embodiments of LIBS based spectroscopy sensing devices. These may include small portable, low-power and wireless LIBS Spectroscopy devices which may be used for on-site analysis in construction settings (e.g. and may include semi-parabolic convex dome shapes).

### General Considerations

Light Source & Pulse Characteristics: The inventors disclose in some embodiments the use of a Q-switched Nd:YAG laser due to its high-energy, short-pulse capabilities. Beam width and pulse parameters may be tuned using a laser control unit. The laser generates pulses with durations typically in the nanosecond range

E&M Wave Manipulation: Optical elements described elsewhere herein may be used (including the adaptive lens). In the embodiments described herein, the lens may be integrated into the transparent dome casing. Another enhancement may include the application of localized deformations to the transparent sphere casing to create a finite number of lenses on its surface. Selective multilayer stratification may be used to realize the local lens in the transparent casing of the device. Adaptive lenses that use bragg or fresnel effect to condition the light may be used.

Dust Removal for LIBS: In the LIBS case, after the plasma de-excitation, dust may linger. An electrostatic or electromechanic dust removal mechanism may be included in the device to attract and remove the dust (for example, using a piezoelectric sensor).

Light Detection: Spectrometers and advanced detectors such as Charge Coupled Device Cameras (CCD) may be used. A trapezoid prism structure may be employed for the housing of detectors.

### Embedded Hemispherical LIBS Device

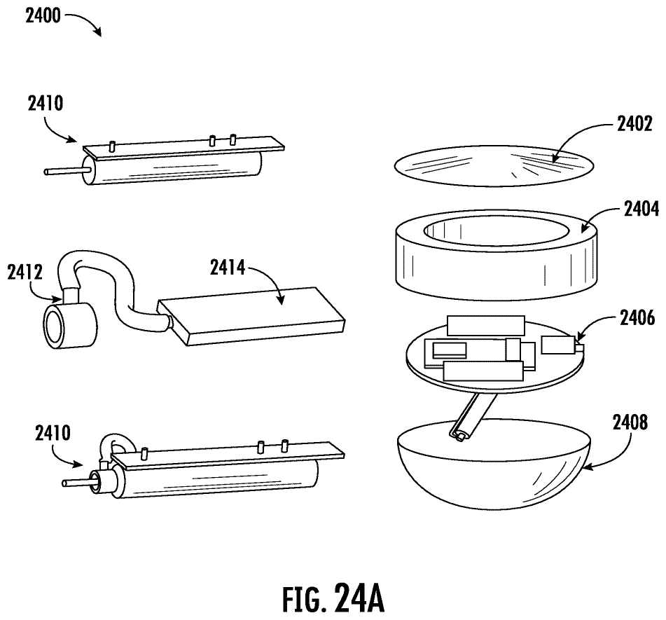

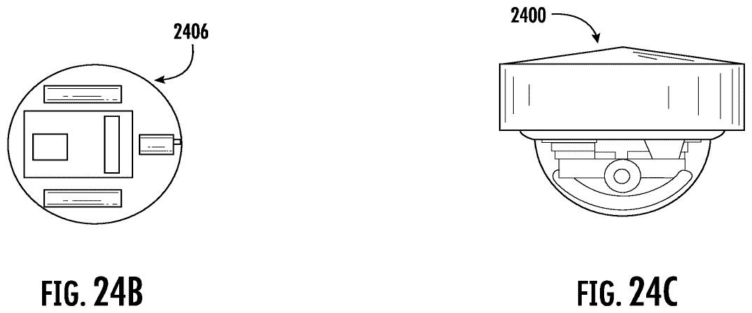

With reference to FIGS. 24A-24C, an example hemispherical LIBS device 2400 is illustrated. As shown, the device 2400 may include LIBS lasers 241, a conditioning PCB 2406, a spectrometer 2414 with optical fiber 2412, an enclosure 2402, 2404, and a bottom housing 2408. The lasers 241 may be configured to convey tens of mJ of energy in a few nanoseconds and may be a Q-switching ND-YAG laser, with wavelengths of 1064 nm, 532 nm or higher harmonics at 355, 266 and 213 nm. In one embodiment the design laser length may be of the order of 100 mm, with a diameter the order of 22 mm. Further embodiments may comprise further miniaturization.

The conditioning PCB 2406 may be able to generate the high voltages and currents to operate the laser and create the LIBS pulses required The PCB 2406 will also carry the batteries, the electromechanical components and the radio circuitry for wireless data transmission.

The spectrometer 2414 comprises required optics to detect the light emitted by the plasma in order to analyze its intensity spectrum. In this embodiment the optical elements comprise a reception ring, placed at the extremity of the laser and around its beam. The light will hit the reception ring and be conveyed to an optic fiber 2412 connected to the spectrometer 2414. This smart configuration allows for advantageous light coupling and for the use of an external spectrometer which sits away from the laser head, for example underneath the conditioning PCB 2406. Further embodiments may include different spectrometer types, which would benefit from the flexibility provided by the optic fiber solution 2412n, meaning that a great variety of spectrometers 2414 may be used. In some embodiments, smaller chip-sized spectrometers could be used and made to fit directly in the reception head. In such an embodiment, a connection cable may still be used for power supply and data transmission, which may still provide a use case for the optic fiber;

An enclosure 2402, 2404 with a pyramidal end 2402, placed at the top of the device 2400 protecting its internals from the host material, and acting as a support and anchor for all the device's internal components. In some embodiments, this enclosure 2402, 2404 accommodates supports for attaching the device 2400 to the rebars and acting as a support and anchor for all the internal moving parts;

The bottom hemispherical 2408 may be a transparent, inert casing/housing used to protect the bottom of the device 2400 from the concrete as well as allow the E&M waves emitted by the lasers 2410 to exit the housing 2408 and contact the host material and allow the E&M waves generated by the plasma to travel back into the housing towards the photodetector for reception. The housing 2408 material may consist of a durable transparent (to the laser as well as emitted light from plasma), and inert material. Note these parts are representative and any combination of any parts described herein may form another embodiment of the device.

In one embodiment, this LIBS device 2400 may be embedded in the concrete and attached to rebar, configured such that the transparent hemisphere is pointing down, and wireless data (e.g. radio or Bluetooth signal) may be transmitted upwards, through and out of the concrete. In some embodiments, the sensor device may be actuated and begin sampling the host material after the concrete has been poured and has settled. In some embodiments, once the device has been actuated, using motors and/or rotation enabling mechanisms, the laser will be pointed in a target direction. The voltage of the battery may be increased up to the high values (~1000V) required to power up the laser. In an advanced embodiment, a bank of capacitors (one hundred 100V 100 uF capacitors arranged in a 10s10p configuration, resulting in a 100 uF 1000V equivalent capacitor) may be charged at high voltage and be ready to deliver the required energy (100 uF at 1000V could store up to 50J of energy, enough to power up the laser for several pulses/samples). Following these steps, the laser may be activated, generating one or more 10 ns light pulses, exciting the host material (e.g. concrete) with the tens of mJ required for a microvolume of it to reach a state of plasma. Once the laser has completed sampling the material, it may be switched off (in some embodiments whilst charging the capacitor bank for the next round of measurements) and the light emitted by the plasma will propagate towards the optic fiber's opening, travel through to fiber spectrometer's sensor, be received and finally analyzed by the spectrometer. This phase may last a few hundred nanoseconds. In some embodiments, the data describing the intensity spectrum of the received light may either be analyzed and processed locally on the device and transmitted or transmitted raw for external analysis (e.g. on the cloud). In some embodiments, the device may be configured to redirect its laser head towards another location in between sample measurements.

Nonlimiting device parts may include PCB: Batteries, RF and processing, 5V to 1000V Step Up Circuit, Capacitors Matrix (100×GRM32EC72A106KE05K (10s10p configuration), equivalent to one 1000V 100 uF capacitor, more than 16J of stored energy), High Voltage Mosfets, 1000V Nmos; Laser Example: MK-367; 25 mJ pulses; 1064 nm (535 nm available); 100 mm×21 mm; Spectrometer Example: C14486GA; 950 nm to 1700 nm; 80 mm×60 mm×12 mm; Glass Dome Example: K9; Diameter: 136 mm; Thickness: 0.15 mm-30 mm; Transmittance: >95%.

### Embedded Spherical LIBS Device

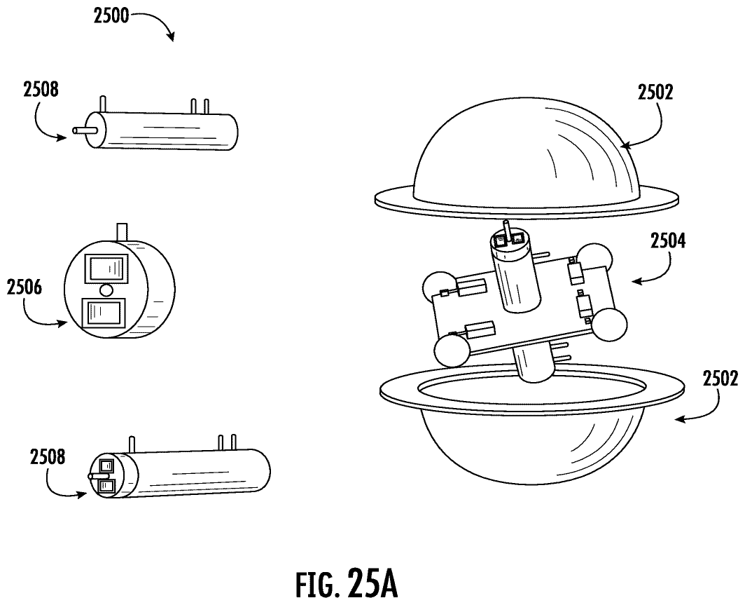

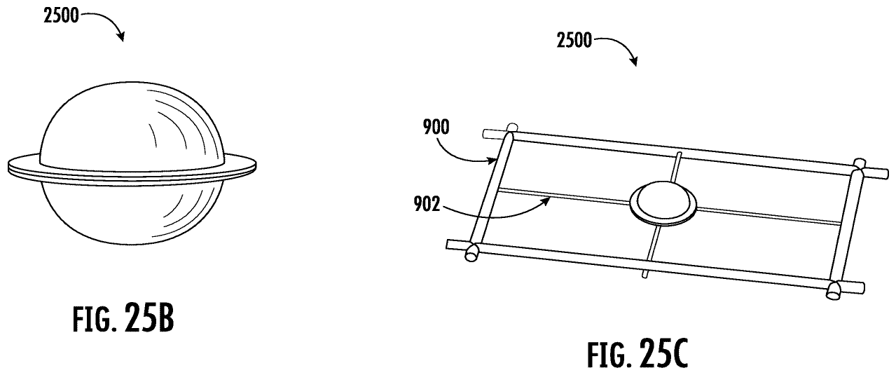

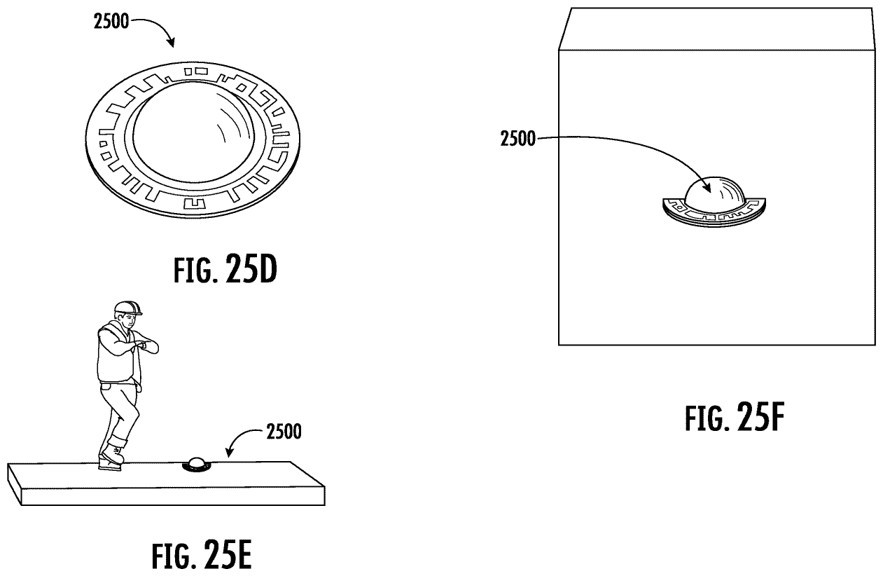

With reference to FIGS. 25A-25C, an embed spherical LIBS device 2500 is illustrated. A shown, the device 2500 may include lasers 2508, receiving head 2506, and a rotatable structure with PCB 2504 within a spherical housing 2502. In this embodiment, the LIBS device 2500 may be configured to be spherical and/or ellipsoidal in shape 2502. This embodiment may be particularly advantageous as it enables the laser to be directed at the host material through a spherical solid angle (i.e., 4π steradians) through rotation mechanisms such as miniaturized motors which may be oriented in different directions optionally using roll bearing-attached balls. In certain embodiments, accelerometers and/or inclinometers may be fixed to the rotating laser mechanism, configured to detect the orientation angle of the lasers 2508. In other embodiments, the device 2500 may additionally be configured for hyperspectral imaging, optionally using a second light source. In which case, the device 2500 may be configured for LIBS analysis at a specific point in concrete, as well as wider hyperspectral imaging over the full spherical solid angle space to characterize the material. The receiving head 2506 may include lab-on-chip spectrometers, optical fibers, and/or multiple spectrometers for different wavelengths. The device enclosure 2502 comprises two transparent hemispheres configured to connect and constitute a spherical shape enclosing the electronic/optical parts of the sensor device. In these embodiments, the internal components are the same as in the hemispherical implementation: laser, spectrometer, PCB and mechanics. This embodiment includes a reception ring attached at the tip of the laser as well as a miniaturized microchip spectrometer for light detection. In further advanced embodiments, other MOEMS components as described previously may be used. Another embodiment may include an optical fiber and external spectrometer system analogous to the configuration described for the hemispherical device embodiment. Other embodiments may include any combinations of any features and/or components described in any of the embodiments herein. The reception ring may also include solid state lasers configured to execute other types of spectroscopy, which may be used for concrete mix property determination.

In one embodiment, this device 2500 may be attached to rebar 900 as shown in FIG. 25C-C]. In another embodiment, wireless external data transfer (e.g. radio transmission) may require the internals to rotate to a specific position such that the antenna points upwards out of the concrete (assuming the device is installed near the top face of the building element). In a further embodiment, this may be enabled using time synchronization and internal scheduling techniques such that a specified time window may be scheduled in the device's internal clock for data transmission.

### Floating Spherical LIBS Device

With reference to FIGS. 255D-F, the device 2500 may be configured to float in fresh concrete, unattached to rebar. In one embodiment, this may be an augmented version of the spherical LIBS device. This example comprises the spherical device embodiment surrounded by and attached to a meshed skirt, which may act as a seal, and may be configured such that the device resists sinking into concrete and providing stability to the device. This embodiment may be used in a variety of contextual conditions and for a variety of use cases relating to fresh building materials. For example this embodiment may be used in the concrete truck in transit and measurements may be carried out at that stage before being poured, or even at the mixer to control for consistency of batching. This may also allow for the LIBS device to be taken out of the concrete after measurement is completed and be reused. Another embodiment may include the use of a small glass test tube shaped container, either placed at the surface or submerged by the concrete, that houses the sensor/detector but which is subsequently removed and replaced with grouting to fill the volume of the cavity left behind when the sensor is removed.

### Surface Mounted LIBS Device

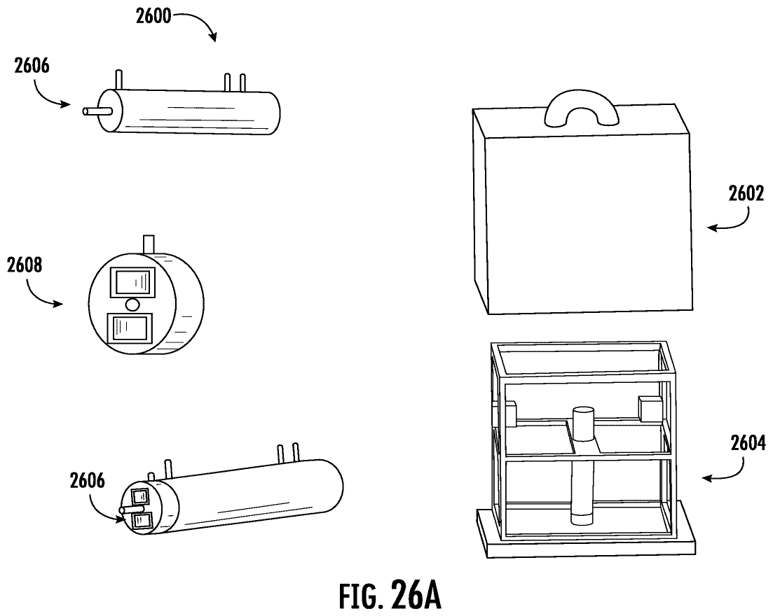

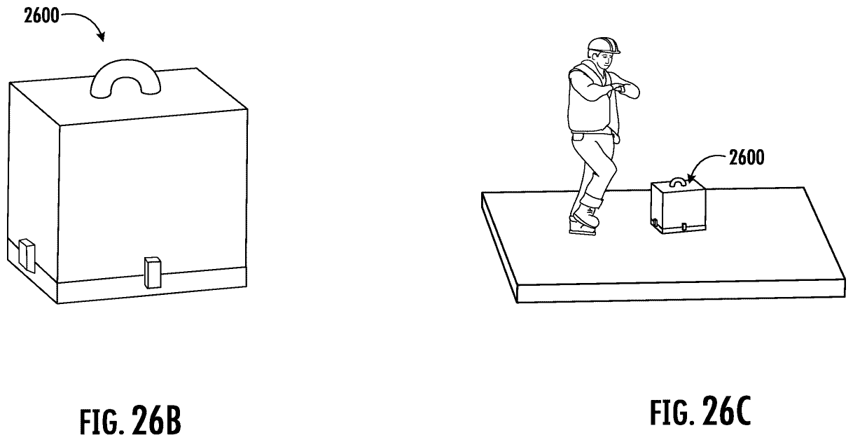

With reference to FIGS. 26A-26C, another LIBS device 2600 is illustrated. As shown, the device 2600 may include lasers 2606 and receiving head 2608 that may include the same or substantially the same components as device 2500 and 2600. As shown, the LIBS device 2600 may be configured to be surface mounted at the boundary with the target building material. This may comprise a plurality of the same components as previous LIBS embodiments. This device 2600 may be placed in contact against an area of interest on the surface of the material. In some embodiments, this device may be placed, attached, latched and/or otherwise mounted onto the surface. As shown, the device 2600 may include a casing 2602, 2604 configured to enclose an area of the surface of the building material under consideration with an aperture on the face to be placed in contact with the building material. In some embodiments, a transparent tile may be present in place of the aperture, for transparent protection at the boundary with the material. A LIBS laser 2606 inside the casing may be configured to emit E&M waves aimed at any point in that area and excite that point of material.

In one embodiment, the laser will always be directed perpendicular to, with the head directed towards the surface of the material. In this embodiment, the laser 2606 and photodetector sensor may be configured to move in the x and y direction in order to cover different targets on the surface of the concrete within a single installation. In one embodiment, the movement mechanism may be based on stepper motors, which enable the receiving head 2608 of the device to be granularly translated towards the target point of interest on the material.

In another embodiment, the device 2600 may be handheld, and may be pointed by a user towards the building material and/or pressed against the building material by a user with a fixed laser head position. The user may keep the device in place, or the device 2600 may be configured to latch on to the material and/or use suction cups to stay static. The device may be activated through an external button press by a user. Alternatively, contact with the target material may trigger activation. In some embodiments, this device 2600 may be shaped as a scanning pistol to allow for convenient handheld use as well as optionally convenient button activation. This device is non embedded. As such, it is reusable. These devices 2600 may also include features such as rechargeable batteries, sacrificial protection films on the transparent head (in case of measurement on wet concrete) and safety features.

### FTIR Spectroscopy Sensing Device

### Description

FTIR measures absorption of infrared light, providing an absorption spectrum displaying the frequencies at which a sample absorbs incident photons. A sample is illuminated with IR light, and absorbed light energy is converted into defined molecular vibrations. FTIR covers a wider spectral range, typically from the near-infrared to the far-infrared region. The technique may be particularly advantageous for material identification, in that it can provide information about molecular vibrations, including functional groups and chemical bonding. This means it can be used to complement other methods such as LIBS that provide elemental data.

Each functional group in a molecule has characteristic unique vibrations that are reflected at different bands in the infrared spectrum. Individual bands in an infrared spectrum can be used to determine what functional groups are present in a sample. The bands of all these different functional groups together result in a Fourier transform infrared (FTIR) spectrum that can be considered a fingerprint of the sample. This technique may be particularly useful for mix fingerprinting applications. The region in which most of the characteristic vibrations are present is called the fingerprint region. The fingerprint region is located at the lower end of the so-called mid-IR region. Infrared spectroscopy requires light from the mid-IR region, which spans from about 4000 to 400 cm⁻¹.

Design Components: Wave-based devices configured in FTIR mode require three basic components: an IR light source that emits the IR light, an interferometer that time-dependently modifies the spectral composition of the IR light, a detector that detects the light intensity.

There are three types of FTIR modes, defined as: (1) Transmission mode, (2) ATR (Attenuated Total Reflectance), (3) DRIFTS (Diffuse Reflectance Infrared Fourier Transform Spectroscopy). Two modes are practical for our use case: ATR, and Diffuse reflectance. Both can be operated without sample preparation, and our devices can be pointed directly at a surface of the curing or hardened concrete (either from within, using an embedded device and some of the embodiments already described), or from outside, using a surface mounted device that is flush with the surface of the concrete element (for example, using a handheld pistol-like device, or the floating embodiment described prior).

Diffuse Reflectance Mode: In one embodiment, FTIR with a diffuse reflectance sampling interface (with different filters) is employed by wave-based sensor devices. The device can be embedded in concrete using one of our wave-based sensor device embodiments. The IR light source illuminates an inner surface of concrete, and an output spectra is determined. The spectra is used to analyze water-cement ratio and the curing state as the concrete hardens (including an estimation of its compressive strength) and characterize compositional properties of the concrete (enabling classification and identification using the fingerprinting models).

Attenuated Total Reflectance Mode: A similar embodiment can be achieved with ATR mode, with the addition of a crystal element at the material to detector interface. IR light travels through the crystal, is internally reflected at the crystal-sample interface, and reflected light travels back to the FTIR detector. During the internal reflection, a part of the IR light travels into the sample, where it can be absorbed. The portion of light that enters the sample is called the evanescent wave. The penetration depth of the evanescent wave into the sample is dependent on the reflective index difference between the ATR crystal and the sample. Therefore, a crystal is chosen to maximize penetration into the material (by impedance matching the crystal and the material as much as possible). Devices may for example employ diamond, zinc selenide or germanium.

Bands of Interest: In particular, some example regions of interest in the spectra include the carbonate region (2500 cm⁻¹ and 1750 cm⁻¹) and the silicate region (1060-1220 cm⁻¹). Some other relevant frequency bands may include the portlandite band at 3640 cm⁻¹ (O—H stretching vibration); the C—S—H band at 1030-970 cm⁻¹ (Si—O asymmetric stretching vibration); the S—O stretching vibration of [SO₄]² band at 1150-1100 cm⁻¹. CaCO₃ may be found in 3 distinct bands at 1410, 870 and 710 cm⁻¹. The detection of CaCO₃ may be associated with the carbonation process or limestone filler when such fillers are used in concrete. Another band of interest includes the anhydrous alite band comprising a double peak at 935-900 cm⁻¹.

Overcoming challenges: Trace chemical compounds can be under-estimated or erased due to the high intensity of certain IR bands, such as those of silica or calcium carbonate. Additionally, the presence of a large amount of capillary water into the hydrated sample can mask certain chemical compounds and disturb the interpretation of the spectra. These challenges entail careful sensor design, calibration and can be addressed using multi-modality analysis techniques. Machine learning models are also used, trained on pre-existing labeled spectra for known materials, to enhance detection and material property estimation capability.

Novel concrete chemistry evaluation: Novel concrete chemistries containing polymer waste recycled as aggregates into a mortar-based or a gypsum-based matrix are increasingly used to improve the thermal and acoustic insulation of construction materials. One example of FTIR is the study of the bulk lightweight mortars for these novel materials. An alternative is to identify the impact of SCMs (supplementary cementitious materials) on compositional properties and contextual material properties.

### Hyperspectral Imaging Sensing Device

### Description

Another significant inventive element considered by the inventors includes the use of hyperspectral imaging to characterize the fresh, hardened and/or other properties of construction materials such as concrete, in both 2D and 3D. Material property determinations may include for example compressive strength, or water to cement ratio. Through the various device features (MCU, smart power management etc.) already described, ultra-low cost hyperspectral devices are built, enabling much wider adoption of embedded, surface mounted or near-pour devices.

By directing a hyperspectral camera at a concrete element (for example, by mounting it near the surface), the full spatially distributed electromagnetic spectrum for each pixel (which represents an area of material dA) may be mapped, providing invaluable information on its chemical composition. Higher resolution hyperspectral imaging is also able to build up a distribution of material within the concrete (aggregate, cement matrix etc.). This allows for clustering of spectra for the different subcomponents of a concrete mix, enabling the characterization of the cement matrix and the aggregate type. This may include the use of magnifying optics for hyperspectral microscopy of concrete.

In addition, the hyperspectral camera may be miniaturized and included on a fully embedded wireless sensor device. The concrete sample will need effective illumination (e.g., from one or more broadband LEDs on the device), and the device includes an optical system so as to sense a particular area of interest within the material.

Beyond material property sensing, this technique involves capturing and processing information across the electromagnetic spectrum, from infrared (detecting heat sources) to ultraviolet, which may be used to detect and characterize other objects on construction sites. Machine learning (or other data analysis techniques) are applied onto the image signal to extract various features.

### Camera Design and Optical System

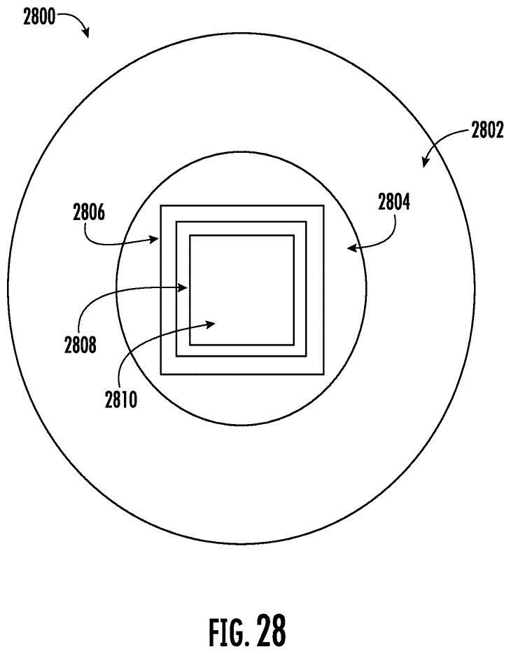

As shown in FIG. 28, the camera 2800 is built with a high-resolution sensor capable of capturing a wide range of wavelengths from infrared (IR) to ultraviolet (UV). The sensor array 2810 may include specialized CCD or CMOS sensor. The device includes a set of lenses 2804 transparent across the IR to UV range. These lenses focus the incoming light onto the sensor array. Interchangeable filters are integrated to selectively focus on different parts of the electromagnetic spectrum. These filters 2806 may be made of materials like sapphire or coated glass, designed to transmit specific wavelengths while blocking others. Alternatively, MOEMS-based tunable filters 2806 are considered. Generally, any number of different optical elements may be placed in the light path, including lenses, objectives, mirrors etc.

For enhanced imaging, the device 2800 includes one or more illumination sources (e.g. UV, IR, VIS) 2802. This is particularly important in the case where a miniaturized hyperspectral camera is embedded into the concrete, or mounted onto the surface, where no natural illumination is available. These become so-called ‘active’ hyperspectral imagers (a particularly valuable embodiment for imaging concrete). An aperture 2808 may also be provided.

Several data and image processing techniques will be applied onto the hyperspectral data (spectral hypercube). The region of interest may be isolated. Dead or hot pixels may be removed, and our models (including machine learning models) will then perform feature extraction and analysis. Optionally, these may be analyzed in time, with multiple hyperspectral images taken at different times. If the hyperspectral image has moved, matching algorithms that ensure that the same pixels can be compared across images may be employed.

Calibration (which is described in more detail above for one of the embodiments) may be required for any of the embodiments. Generally, tunable filters may suffer from vignetting issues (where intensity is not constant throughout the spatial distribution of the filter). Likewise, grating based measurement may have the same issue. The same principles (calibration in controlled environments prior to use) can be used to ensure an accurate hyperspectral cube is produced. These may be calibrated for, or otherwise normalized using context awareness methods for example.

Environmental/Contextual conditions (such as temperature) may have an impact on the measurements. This is an important consideration of the invention, given that curing concrete can often reach 50-80 degrees celsius. The signal output would be temperature-adjusted (and generally corrected for the impact of any other environmental factor) based on data from a colocated temperature sensor (or the temperature may be determined from the hyperspectral imager in IR mode). Signal transformations may be done on the basis, again, of prior calibrations run in controlled environments. Generally, the outputs of context awareness methods may be used to normalize or calibrate our signal.

Data Analysis & Models for enhanced resolution. Models may be used for enhanced spectral and spatial resolution (enhancing output signals of our hyperspectrometers, despite their hardware limitations). This enables lower cost devices that maintain high accuracy measurements. This may take the form of spectral reconstruction, by using images from multiple frequencies (either incident frequencies of the illuminator, or tuning frequencies). For an embodiment with a tunable filter or a variable frequency illuminator, by sweeping across the frequency spectrum, information may be recovered at the boundaries of the frequency response of the chip or illuminator. Alternatively, based on pre-existing knowledge of expected spectroscopic signals, the spectra of the constituent materials may be reconstructed from each pixel (e.g. through sparse unmixing, or super-resolution techniques). Super resolution techniques include multi-frame super-resolution (stacking multiple images), and single image super-resolution. These techniques may be used to improve the spatial resolution (which is applied to traditional image processing). However, a particularly inventive step is the use of these techniques to improve the spectral resolution of our image-so called ‘spectral super resolution’. This can be done on the basis of a training dataset (e.g. of high resolution hyperspectral images of concrete, which have been downsampled algorithmically). This may be done with any of the machine learning methods described herein (e.g. a convolutional neural network may be trained on our dataset).

Models for extracting material properties from hyperspectral cubes. Models (including the various machine learning models described herein) may also be used to classify or characterize the building material under consideration (e.g. concrete, and for example, the evolution of its fresh properties as it cures, or its composition). This may include extraction of chemical composition and/or formulation based on the average spectra, or the spectra distribution across the cement matrix and the aggregate. Alternatively, it also includes the estimation of properties such as compressive strength over time on the basis of particular patterns in the spatial spectra distribution (e.g. the ratio of the calcium I to calcium II line in regular portland cement-based concrete is indicative of the compressive strength).

Hyperspectral Arrays. The invention also includes arrays of hyperspectral sensors (any embodiment of the above, which describes a detector that is able to capture images with multiple frequencies for each pixel, and optionally includes one or more light sources). These may be configured in any number of geometrical configurations, and combined with a number of different optical elements (including tunable filters, diffraction gratings etc), to ensure that either the same area of material is considered, or different areas to build overlap. The hyperspectral cubes from each part of the array may be combined to reduce noise and/or increase resolution (including spatial resolution, or frequency resolution). They may also be averaged over time.

Geometry of Hyperspectral Sensor. One or more hyperspectral sensors or array (including light sources) may be encapsulated in a transparent spherical or semi-spherical device, which optionally may be able to direct the sensor by moving it physically within the spherical device. Alternatively, light paths may be adaptively controlled by various optical systems to detect the hyperspectral cube for different areas of the material. Hyperspectral sensors and/or arrays may be arranged on the faces of an N-polygon (or generally any of the shapes described prior and later in this document) Hyperspectral sensors or arrays may also be installed flush onto a container-like device, which isolates a particular volume of concrete dV, with surface area dA. These containers may include systems of optical waveguides to direct light.

Optical Waveguides. Various optical waveguides (including optic fibers) may be used to direct the light from an area of interest within the concrete. These waveguides include dielectric waveguides, photonic crystals, and may also be based on various metamaterials. Generally, both planar and non-planar optical waveguides are considered. A separate section considers this in more depth.

### Hyperspectral Imagers

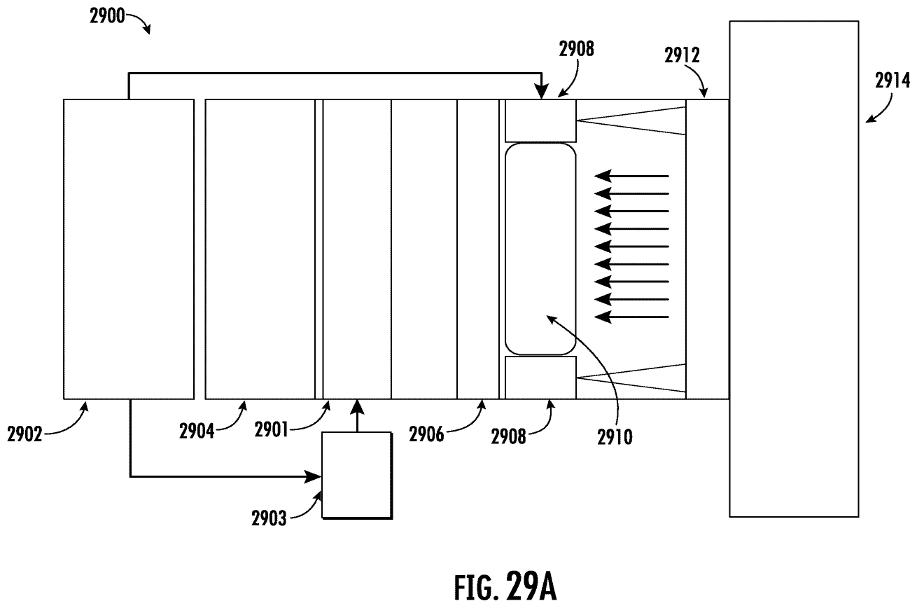

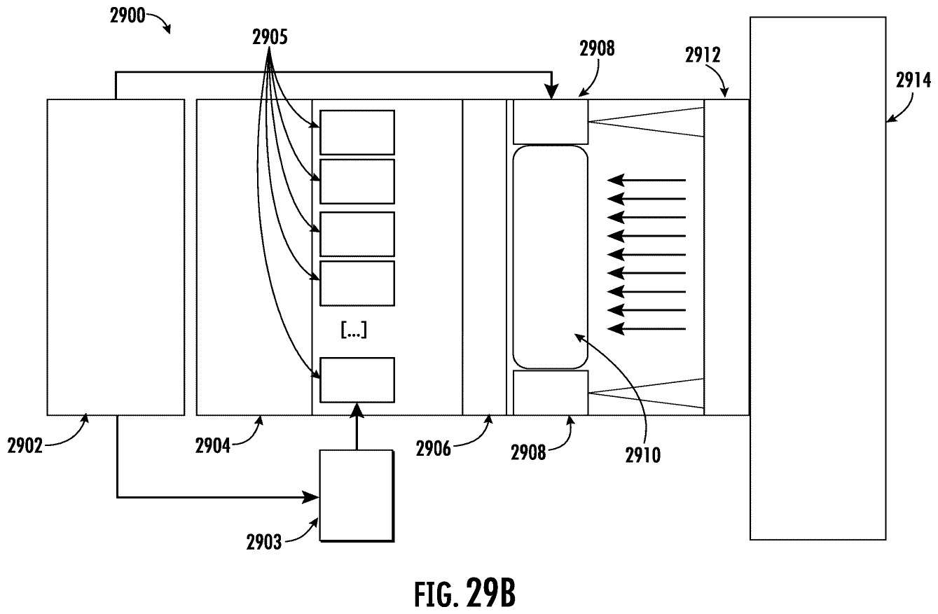

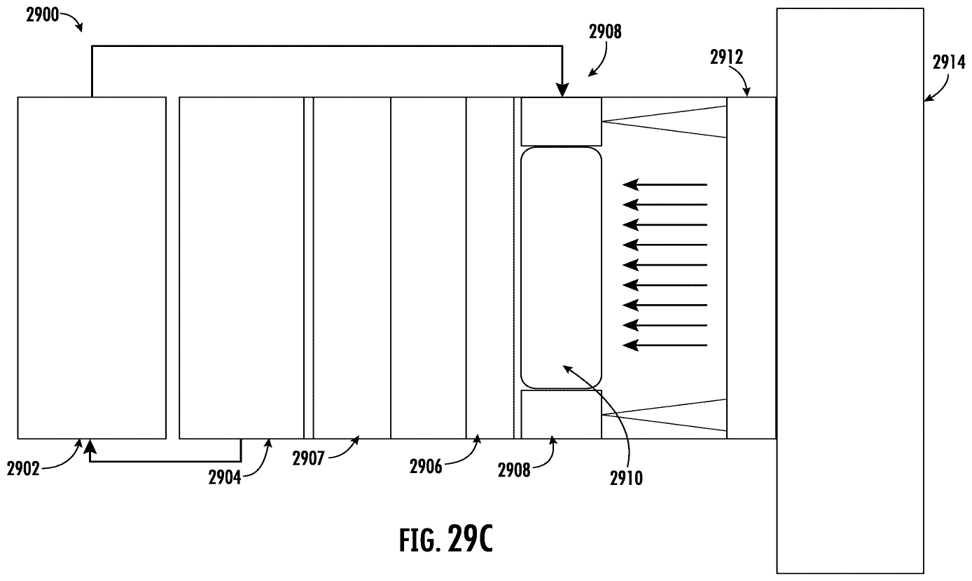

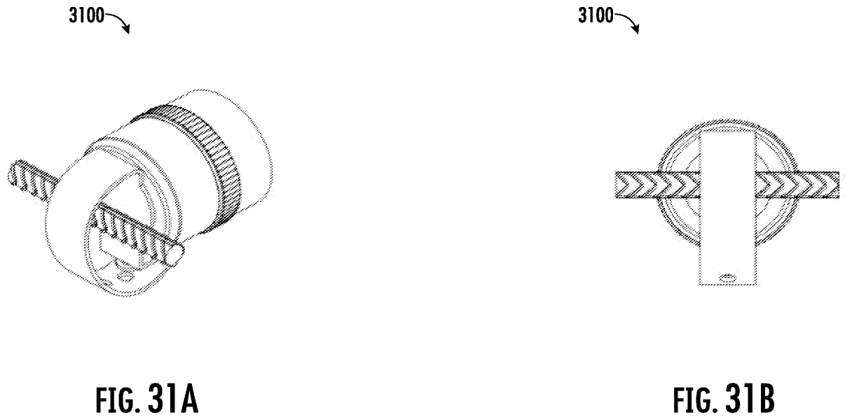

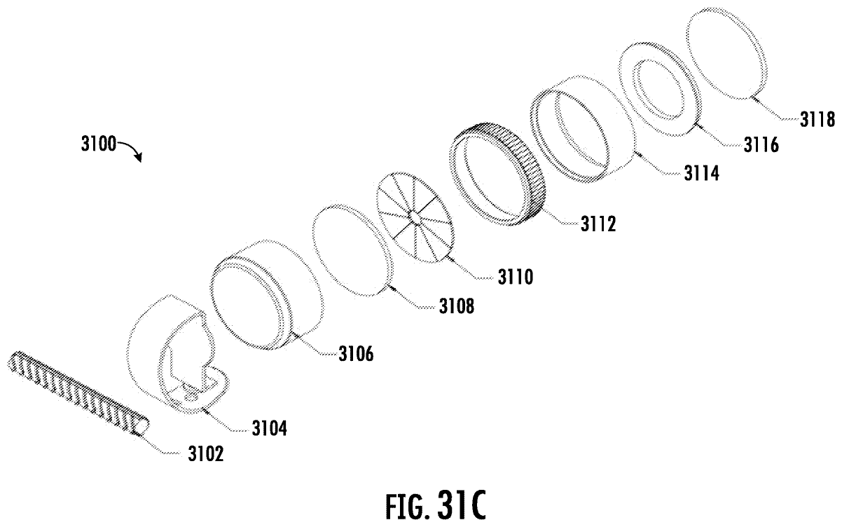

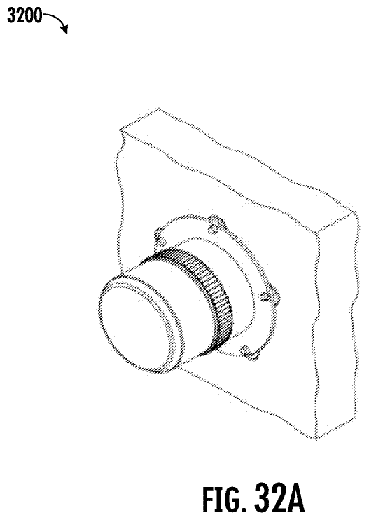

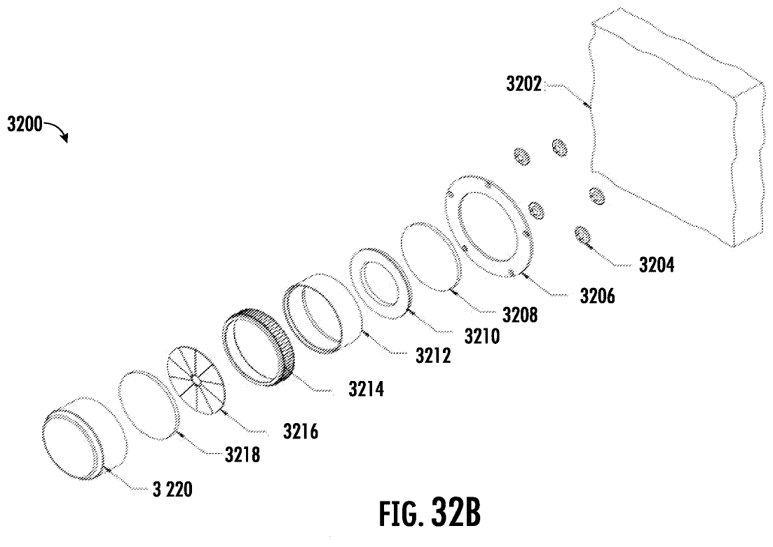

With reference to FIGS. 29A, 31A-31C, 32A-32B, example large Area tunable MOEMS-Filter hyperspectral imaging device 2900, 3100, and 3200 are shown. The device 3100 may be embeddable while the device 3200 is non-embedded. The device 2900 may include electronics 2902 (e.g., microcontroller, battery, wireless interface, etc.), an imaging detector 2904, a large area tunable MOEMS filter 2901, a MOEMS filter control chip 2903, an aperture 2906, a lens 2910, illumination ring 2908, a transparent plane 2912 directed at concrete 2914. The MOEMS filter control chip 2903 may control the tuning of the large area MOEMS filter tuning. A frequency sweep may be carried out (e.g., across possible frequency modes for the filter), and an image may be taken at each frequency. Theis building to a hyperspectral image cube as described herein. The tunable MOEMS filter 2901 may be electrically controller by the chip 2903 and covers all pixels of the imaging detector 2904. The device 3100 may include a lens 3118, an LED array 3116, a LED mount 3114, an aperture housing 3112, an aperture e3110, a filter 31008, a rear housing 3106, and a rebar strap 3104 for connecting with rebar 3102. The device 3200 may include a rear housing 3220, a filter 3218, an aperture 3216, an aperture housing 3214, a Led mount 3212, an LED array 3210, a lens 3208, a section cup anchor 3206, suction cups 3204, and a concrete sample 3202 attached thereto.

In one embodiment, a low-cost camera sensor (e.g. CMOS) is used, alongside optical MEMS-based (also known as MOEMS) tunable filter technology (such as a large area tunable Fabry-Perot filter, e.g. a MEMS-based Fabry-Perot filtering chip), an optical path/system to ensure proper focus of the image, and an (optional) light source (which can provide constant amplitude illumination across the frequency spectrum of the tunable filter). The MEOMS tunable filter is a MEMS-based circuit designed for electrically controlled wavelength division multiplexing. In one embodiment, this includes a piezo-actuated MEMS-FPFC. In another embodiment, silicon-based MEMS-FPFC are contemplated, which may be fabricated using bulk micromachining. Generally, in one embodiment, the electrically tuned filters are made up of two parallel micromechanical plates. The first plate is fixed. The second plate can be actuated up and down (e.g. permanent magnets are placed onto it, which allows for electromagnetic actuation). The plates are made of thin high reflectance mirrors, and separated by a distance d, which forms a cavity (so-called Fabry-Perot Cavity). The distance d can be electronically actuated, which changes the resonance modes of the cavity. Optical waves are able to pass through the cavity when they are in resonance. This is packaged on a chip to form a MEMS-FPFC.

The tunable filter is controlled by a custom microcontroller/chip, and a sweep over the frequency spectrum of the tunable system is carried out. An image (or video) is taken by the low cost camera system as the MOEMS filter is swept across its frequency spectrum, from which the hyperspectral cube is produced, and stored locally or transmitted to the cloud. Different lens systems may allow for images at different spatial resolutions.

The hyperspectral cube is then analyzed, either on the device (optionally with specialist machine learning chips), or on the cloud with machine learning models to extract particular features. The composition, and various material properties (in particular fresh properties of concrete) are determined. With sufficient spatial resolution, the individual components of the concrete can be mapped (e.g. the cement matrix and the aggregate).

### Small Area Tunable MOEMS-Filter Array Hyperspectral Imager

With reference to FIG. 29B, the tunable MOEMS filter 2905 of device 2900 may cover the entire sensor or may be miniaturized such that frequency can be controlled at the pixel level (making the frequency spectrum of each pixel tunable independently). Alternatively multiple distinct imaging sensors 2905 with distinct large area filters are considered. This would enable a one shot spectral image to be produced. The tuning of each filter 2905 may be for a broader band or combination of bands, such that a multiplicity of simultaneous measurements can be taken and decomposed into fundamental frequency components. The light path may be altered (through lenses or mirrors) to ensure that each detector is considering the same area of the element.

### Diffraction Grating Hyperspectral Imager

With reference to FIGS. 29C, an alternative implementation of the low cost hyperspectral sensor 2900 makes use of traditional cameras, macro optical lenses, alongside an aperture and double axis diffraction grating 2907 placed in between the camera and the lens, and a calibration procedure, and a constant intensity broadband light source to illuminate the concrete at the applicable frequencies of interest. A computer implemented algorithm is implemented to analyze the output of the imaging sensor and produce hyperspectral cubes.

Alignment of the diffraction grating and the camera sensor are key. The aperture, and optional light source, allows control of the quantity of light that makes its way into the optical system. In the case of an embedded device, an additional optical path is created (either a vacuum, or inert gas, or air) between the lens and the concrete. The width of the optical path depends on the type of lens used. This is similar to the optical system described for the LIBS-based device. The optional active illumination device may be disposed in a ring configuration 2912, around the lens.

### Narrowband Active Illumination Hyperspectral Imager

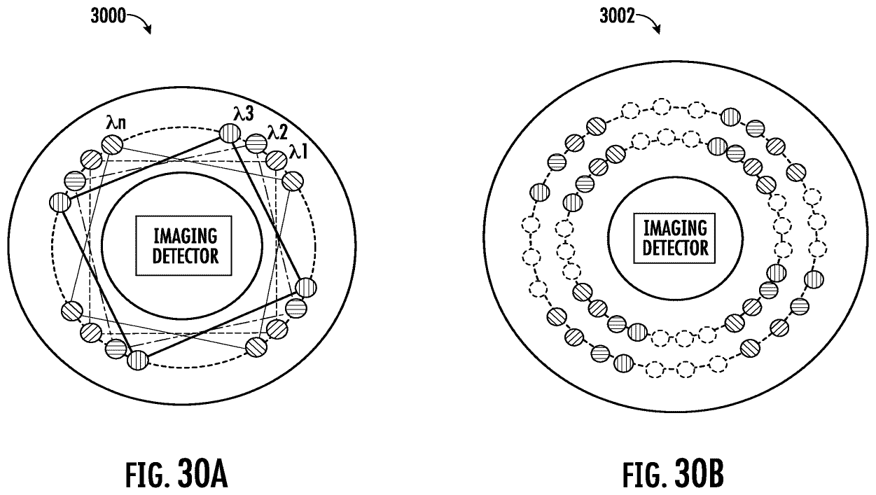

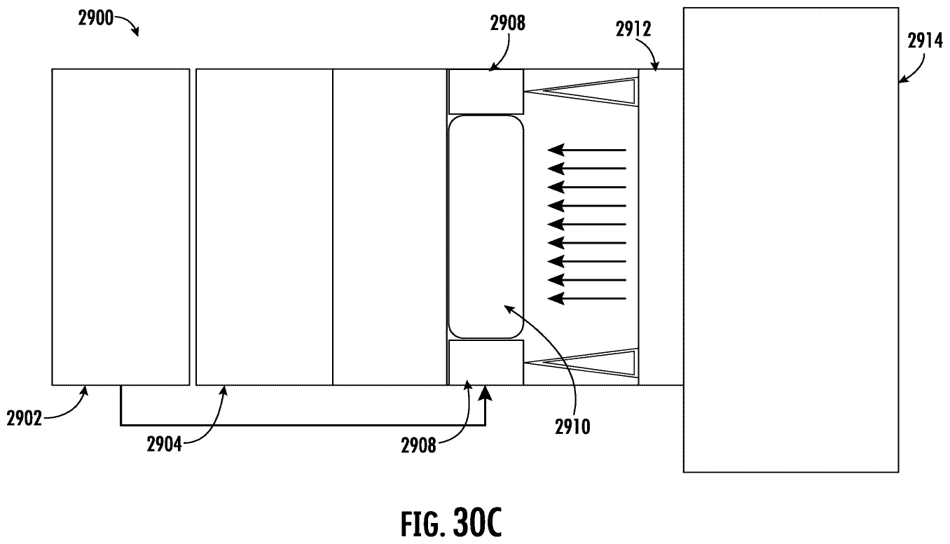

In a further embodiment as shown in FIGS. 30A-30C, an active hyperspectral device 3000, 3002, and 2900 is made up of a plurality of narrow-band illumination sources or one electrically-tunable light source 2908 (the ‘active’ component, which generate light/electromagnetic waves, at one or more wavelengths), and a camera sensor 2904 (and associated optical elements) is designed. The device 3000 can either be surface mounted (with full adherence onto the concrete surface or embedded. In both cases, there is no ambient light in the optical path, which means that the active input light source fully controls the illumination of the building material (including the spectral composition of the input light source). The illumination devices and receivers can optionally be directed (either by moving them physically, or through adaptive optics as described in other sections of this document) to particular areas of the material dA. The sensor/actuator is then connected to an MCU, battery, wireless communication interface etc (as described elsewhere 2902) for signal processing and communication.

The narrow-band illumination devices may, in one embodiment, be made up of narrow-band LEDs/single-wavelength LEDs (e.g. a plurality of single dye diodes). The output wavelength of the LEDs may be distributed across the portion of the electromagnetic spectrum of interest (which may be the visible spectrum, the infrared spectrum, ultraviolet or otherwise). The input current (to drive the LEDs) and number of LEDs, as well as the spacing between LEDs of similar output wavelength is kept constant—e.g. each LED type (by wavelength) may be distributed along an annulus/ring, or in a grid pattern). The input current or voltage is controlled to ensure constant illumination intensity of the target material.

For example, four LEDs that emit at the same principal wavelength (λ₁) may be disposed equidistantly to each other on a PCB (e.g. at the vertices of a square). Another four LEDs with principal wavelength λ₂ may be positioned at an angle δθ (with respect to the center of the square formed by the prior LEDs), and so on up to λn where n is the number of wavelengths, such that the illumination device comprises a full ring of LEDs (with four LEDs of each wavelength type). The minimum diameter of the illumination ring will depend on the number of LED types, the number of LED per type, and the radius of each LED, as well as the minimum spacing required between the LEDs. Optionally, multiple such rings may be constructed with different radii, and spacings between each LEDs, which may be placed concentrically. This can be easily constructed by mounting the LEDs onto a PCB. The FWHM of the monochromatic LED frequency output will ultimately be a key parameter which determines the spectral resolution of our hyperspectral cube. The circular shape, with concentric rings of LEDs is only one example, and other illuminator geometries are also considered. In addition, optical elements may be mounted onto the illuminator which help to direct the light uniformly onto the sample.

Finally, a calibration procedure may be carried out. Two key parameters need to be calibrated for: (1) The relative optical emission intensity of each LED type for a given input power may vary (i.e. given the same input power, an LED with principal wavelength λ₁ may have a different intensity than another LED with principal wavelength λ₂). This can be calibrated in a variety of ways. The input signal intensity can be modulated based on a control measurement, to ensure constant optical emission intensity across each LEDs. Alternatively, the input power intensity can remain constant, but the image is corrected in software based on the variability in output intensity. More advanced calibration mechanisms may take into account the spectral width, or spectral curve of each LED. Each LED emission spectrum may not be of the same shape, and some overlap may exist between different LEDs. This can be corrected using various algorithmic models. (2) The spatial distribution of the emitted light intensity on the surface of material under consideration dA at a distance d from the light source may not be uniform. Pre-existing measurements against backgrounds that are known to be uniform can be used to correct for any spatial distribution of light intensity This calibration however, may be wavelength dependent, making the process more complex. Alternatively, optical elements may be used to flatten the intensity spectrum.

### OTHER EMBODIMENTS

Other Methods: line-scan hyperspectral cameras with adaptive optical elements are also considered. They are able to sweep across a material surface area (either from within the material when embedded, or from the external surface of the material), by electronically (or otherwise) controlling an optical system. In its initial configuration, a light beam is reflected from an area element dAᵢ of a broader area under consideration A. Through the adaptive optics system, a sweep across dAᵢ for all i is carried out, and the spectrum from the line-scan hyperspectral camera (which uses a single slit) is captured and stored.

Combination of features: Aspects of each embodiment above may be combined in different configurations. E.g. adaptive illumination (at different frequencies) may be combined with tunable filters to produce a more accurate hyperspectral picture. Likewise, these are one of a number of methods for hyperspectral imaging, which should not limit the general invention: a mobile, portable, optionally embedded and optionally wireless/cloud connected, general purpose building material sensor that is able to identify characteristics of the building material under consideration (including compositional properties, static material properties, contextual material properties and so on), and which optionally does so with machine learning-based models for further data processing.

### Raman Spectroscopy Sensing Device

### Description

Raman Spectroscopy involves the use of laser light to interact with molecular vibrations, phonons, or other excitations in a material. The technique provides detailed information on molecular composition, crystal structure, and other physical properties. It can be used to study concrete's crystalline and amorphous form.

Raman spectroscopy may be employed to characterize concrete or cement in lab environments, but it requires specialist, costly equipment, and importantly, requires samples to be sent from the field to the lab. In this embodiment, an ultra-low-power, battery powered or energy harvesting device, designed to either be surface mounted, or embedded into concrete, and wirelessly communicate with other devices or the internet/the cloud, is able to carry out Raman Spectroscopy in the field, a feature not found in conventional Rama based systems. Generally, all of the features described in the general hardware section may be incorporated into this device, and spectroscopy techniques described for other embodiments herein may be transferred to this embodiment (including adaptive optics, movement and guiding of beams etc.).

At the core of the device is a monochromatic laser (e.g. a diode laser) which provides a narrow-band light as a specific wavelength. Optical fibers and/or lenses (or other photonic waveguides) guide the laser beam to a surface area of concrete. A trapezoid prism-shaped housing, and/or a semi-parabolic convex dome design may be employed to support precise directing and focusing of the laser beam onto the surface of the material of interest. The device detects Raleigh scattering, Stokes-Raman scattering and anti-stokes Rama scattering to determine vibrational modes of molecules in the material of interest (e.g. concrete), to identify them. The source light would be produced by a single or multiple lasers across one or a wide variety of wavelengths. A high-resolution spectrometer is used to analyze the scattered light, and separate the Raman scattered light into its constituent wavelengths. This may take the form of a CCD or CMOS sensor alongside a Fabry-Perot Tunable Filter (or any other spectroscopy technique described herein).

Optionally, for materials that produce weak Raman signals, the device is able to enhance the spectra by applying SERS (surface enhanced Raman spectroscopy), and SLIPSERS (slippery liquid infused porous SERS) techniques, which makes use of molecule adsorption effects onto specific types of surfaces included in the device (e.g. rough metal plates). Polarization elements may also be included, to enhance Raman signals by aligning the polarization to particular crystal orientations in the sample.

The device includes a number of other sensors (such as temperature sensors) to compensate for any shifts in Raman signals caused by environmental factors (e.g. attributable to the concrete's exothermic hydration reaction).

### XRD Spectroscopy Sensing Device

The X-ray part of the spectrum can be treated as an extension of the visual spectrum and as such X-rays can be used to both excite the unit or material under test as well as monitor its absorption and reflection of said source X-rays. This enables the determination of material composition and other material properties, including their changes over time and space. XRD spectroscopy is employed to characterize concrete or cement in the lab, but it requires specialist, costly equipment, and importantly, requires samples to be sent from the field to the lab.

In this embodiment, an ultra-low-power, battery powered or energy harvesting device, designed to either be surface mounted, or embedded into concrete, and wirelessly communicate with other devices or the internet/the cloud, is able to sample XRD spectra. Generally, all of the features described in the general hardware section may be incorporated into this device, and spectroscopy techniques described for other embodiments herein may be transferred to this embodiment.

XRD spectra are particularly powerful to inform the determination of the crystallographic structure of the material of interest (e.g. concrete). Quality, strength and other material properties can be determined from the spectra.

At the core of the device is an X-ray tube, which is voltage and current controlled by an MCU (e.g. using a PWM module). In one embodiment, supercapacitors are used to manage peak power requirements of the X-ray tube during sampling. Beam focusing optics and collimators are employed to direct the beam at the sample. The detector is mounted on a goniometer, allowing it to move within its housing to precisely measure diffraction angles. Alternatively, similar mechanisms to those described for the embedded spherical LIBS device may be used to move the detector. MEMS based solutions (e.g. micromirrors) may also be employed, or an array of detectors (to remove the need for physical movement).

The device includes a number of other sensors (such as temperature sensors) to compensate for any shifts in XRD signals caused by environmental factors (e.g. attributable to the concrete's exothermic hydration reaction).

### DRS Spectroscopy

In one embodiment, the device may be configured to execute differential reflectance spectroscopy. DRS spectroscopy may involve characterization of the difference in intensity as well reflectance spectra of the surface of the material under consideration with respect to different parameters, for example changing wavelengths. Light may probe the surface of the material and be reflected back towards a photodetector. The reflectance spectrum may comprise values for the surface differential reflectivity for a plurality of frequencies, optionally a continuum of frequencies (frequency band). The surface differential reflectivity may be defined according to a 3-surface model as:

defined according to a 3-surface model as:

$$\frac{Δ R}{R} = 8 π \frac{d}{λ} Im \{ \frac{{ϵ}_{1} - {ϵ}_{2}}{{ϵ}_{1} - {ϵ}_{3}} \}$$

wherein e is the complex dielectric function of each ‘surface’ involved in the process. In some embodiments, ∈₁ may typically be the dielectric constant of vacuum (approximating the dielectric constant of air), ∈₂ may be the dielectric constant of the ‘surface’ of the material under consideration, and ∈₃ may be the dielectric constant of the ‘bulk’ of the material. The surface of the material may be described as the thin layer of thickness d (often of the order of nanometers depending on the optical absorption characteristics of the material), indicative of the depth reached by the incident light into the material. The bulk of the material may be described as the rest of the element. The wavelength of the light emitted by our light source is A.

In one embodiment, this may be used to characterize the dielectric properties of the surface of the material. This device and technique embodiment may use a near-IR, visible and/or UV light source to excite the surface of a material (e.g. concrete). The reflectance of the E&M waves as they bounce off the surface of the material is detected by a spectrometer and used to reconstruct a reflectance and/or intensity spectrum for the material. In some embodiments, this procedure may be carried out multiple times whilst varying a given parameter. For example, this procedure may be carried out whilst varying the wavelength/frequency of the generated E&M wave. In this way a reflectance spectrum showing the reflectance of the material at different wavelengths may be obtained. In addition, intensity spectra may be obtained for each wavelength of input light. This may enable comprehensive characterization of the material, including characterization of the molecular, atomic, and electronic structures including electronic transitions characterization. In one embodiment, the light source may comprise a tunable laser, connected with a MOEMS control system as described above, which can tune the light source's emitted wavelength. In further embodiments, this may be done at multiple discrete locations on the surface of the material, or over larger areas to enable surface tomography of the material. Other variable parameters for differential reflectance spectroscopy may include adjusting the angle of incidence, or temperature (e.g. oven actuation).

In some embodiments, the material under consideration may be a cementitious mix (e.g. concrete). In such embodiments, the device may be configured for curing and hydration monitoring. The device may be configured to continuously sense the concrete throughout curing. This will produce varying spectra over time. These may be classed using clustering methods and/or other methods herein, such that it may be possible to characterize when the concrete is fresh, when it hardens, and when it is hard. Tomography may also be used to spatially characterize the inhomogeneities in the compositional properties of the concrete surface (e.g. characterizing cement-aggregate ratios). The device may also be configured for crack detection during spatial tomography as DRS spectroscopy techniques are particularly sensitive to surface structures and topology. This may be used to identify microcracks in the concrete. Other applications include but are not limited to surface condition and aging determination and moisture content determination.

In some embodiments, this may be combined with FTIR techniques to enable FTIR-DRS techniques.

### Others

Photoelastic Spectroscope. The spectroscopy sensor or hyperspectral cameras mentioned above could be used with a polarized broad or narrow spectrum light to reuse the light excitation and detection capabilities of the photoelastic-based mechanical sensor devices (described in the mechanical wave-based sensor section). This would enable the determination of mechanical properties, and light-based spectra at the same time, from the same hardware.

Slump AI/Auto Slump. In general our systems are composed of automated machine vision models that ingest photonic data, and which use that data to automatically infer certain contextual material properties. There are various embodiments of our machine vision algorithms, all of which receive photonic data of various light frequencies (e.g. visible light, LIDAR, near- or far-Infrared, UV, X-ray and gamma rays). One illustrative use-case for such embodiments can be seen in the situation wherein an on-site Quality Assurance Engineer is tasked with measuring the slump of a newly delivered batch of concrete. That engineer would place the concrete into a standardized conical mold and would use a handheld recording device (such as their mobile phone) in order to take images, or to record a video of the concrete once the cone has been lifted. Our machine vision models would ingest the images/video and would infer the physical dimensions of the resulting slump. Our machine vision models may use a mixture of convolutional neural networks, projective geometry and other computer vision techniques in order to determine those physical dimensions; thereby measuring slump in an automated way, wherein the slump measurement would be the output of an internal function that compares the vertical height of the concrete to the original height of the conical mold. Other non-exhaustive examples of visually-determined contextual material parameters are: the measurement of external concrete temperature via near- or far-infrared imaging; or the determination of structural deformities (such as shrinkage, expansion or crack formation) from camera imaging at various wavelengths of light.

Microscopy: Microscopy techniques may also be integrated onto our devices. In this wave-based sensing technique, the concrete is illuminated (an excitation), and then images (with very high levels of magnification), which can be used to provide a breakdown of the cement matrix structure and aggregate structure. Traditionally, microscopy has been reserved for the lab. Through relatively inexpensive light sources (of the kind already described), camera sensors (CCD, CMOS), and various optical elements, a low-cost, wireless, microscopic wave-based device can be constructed (which may be embeddable or surface mounted). The housing for the hyperspectral imager may be reused for this. Techniques supported by our devices may include petrographic microscopy, fluorescence microscopy. Alternatively, making use of some of the other elements already described in other inventions, fiber optic microscopy may be employed (e.g. coupled to the fiber bundle, or any of the photonic waveguides). Traditional optical microscopy through miniaturized imaging systems may also be employed (in conjunction with our illuminators). Scanning electron microscopy is also considered, which would provide high resolution images of the surface of concrete, to examine its texture and morphology, and potential failure mechanisms. Other electron based techniques include transmission electron microscopy (TEM) or Environmental Scanning Electron Microscopy. Alternatively, Atomic Force Microscopy is able to image matter at the nano scale, to detect the formation of C—S—H structures in the cement paste. Micro-Computed Tomography may also be employed on our devices. Generally, these techniques allow our devices to image microstructure (pores, aggregates, the disposition of the cement matrix, cracks), but also through higher energy methods image the composition of concrete at the atomic level, as well as micro-cracks etc. These techniques span a large range of costs, making it possible to envisage devices that probe at different energy scales, and may offer significant advantages for material characterization and identification, including monitoring of static and contextual material properties (e.g. concrete strength gain).

### Photonic Sensing

### The Index of Refraction

As has been discussed previously, the dispersion of an electromagnetic wave is the functional relationship between its frequency, ω, and its wavenumber, k (where k=1/λ, and where λ is the wavelength). The velocity of a propagating wave in a medium is also given by the ratio v=ω/k.

For a medium wherein the k is linearly proportional to w, we thus find that v is a constant at all frequencies. Generally, k is linearly proportional to w for as long as the propagating wave is unbounded in its transverse axes. If a propagating wave becomes bounded along the axes orthogonal to its propagation direction, we then find that those boundary conditions create non-linear relationships between wavenumber and frequency.

The index of refraction is an alternative variable which can be used to measure this effect, wherein the value of the index of refraction is defined by n=c/v=ck/ω, and where c is the speed of light in a vacuum. We see that n can never be less than 1 (i.e. the velocity of the wave in the medium is never more than the speed of light), and it has no theoretical upper bound (i.e. v is permitted to be much smaller than c). We thus see that n is a direct measure of the dispersion of a propagating wave, where n will be constant for waves that are unbounded by the material in its transverse axes but will be frequency-dependent when transverse boundary conditions exist.

### The Concept of a Waveguide

As has been discussed previously, an electromagnetic wave propagating through a material can be bounded in the axes that are orthogonal to its propagation direction. Such boundaries are defined by a discontinuity in the index of refraction between the propagating material and the external medium (sometimes referred to as an impedance mismatch between the two materials).

If the cross-sectional axes of the medium through which a wave propagates is large with respect to the propagating wavelength, λ, then the wave behaves as though it is effectively unbounded in the transverse direction. In the unbounded case, all transverse excitation modes are freely able to propagate through the medium, at all frequencies of excitation.

However, if the cross-sectional axes of the material are on the order of the propagating wavelength (or smaller), then the boundary conditions dominate, and we find that some of the TE and TM modes become cut off for frequencies below a certain threshold (i.e. the wave can no longer pass through the material via certain modes, if the wave is propagating below their respective cut-off frequencies). There are, in general, an infinite number of possible TE and TM modes, and, as the cross-sectional dimensions of the propagating material reduce, the number of modes that can propagate below a certain frequency will become finite (down to a fixed minimum that can never be cut off). A material which places orthogonal bounds on a propagating wave in the manner described above is called a waveguide (as has been discussed previously).

### Waveguide Boundary Conditions and Evanescent Modes

Electromagnetic waveguides have their transverse boundaries defined by the physical dimensions of the cross-sectional area of the propagating material. If the outer material (outside the bounds of the cross-section) is of a sufficiently different index of refraction, then the waveguide will exhibit a number of cut-off TE and TM modes. The manner in which those cut-off modes manifest (i.e. the precise cut-off frequencies and their wavenumber frequency dependence) will depend upon the index of refraction of the waveguide, n_{w}, the index of refraction of the outer material, nₒ, and the orthogonal dimensions of the waveguide.

In all cases, for any bounded waveguide, the presence of cut-off modes will cause energy transfer to the surrounding environment through evanescent modes. An evanescent mode is a non-propagating, exponentially decaying wave that transmits power near to the boundary between the waveguide and the external material. For visible light, evanescent modes only transfer measurable power over a few nanometers from the surface of the waveguide. However, if any system falls within that range, it will receive photons at the evanescent mode's associated frequencies.

### External Index of Refraction Measured by Waveguide Resonators

The velocity, v=ω/k, of an electromagnetic wave propagating through a waveguide is generally a complex function of the two indexes of refraction, n_{w} and nₒ, and the cross-sectional dimensions. However, consider the case in which the cross-sectional dimensions and n_{w} are fixed, and that we choose a length, l, for the waveguide. Now, let us consider that we place a light source at one end of that waveguide, and a reflective boundary at the other. As has been discussed previously with regards to resonators, we would expect that certain resonances would occur at periodic multiples of a resonant frequency.

The equation for those resonant frequencies will be ωₘ=mv/2l, where m is the index that denotes the m-th resonant frequency. Given that the index of refraction is given by, n_{w}=c/v. Thus, by substitution we find that ωm=mc/2ln_{w}.

In addition to this, we know that the velocity of the wave is both frequency dependent and dependent upon the external index of refraction, nₒ, such that the waveguide index of refraction becomes coupled to the no, by some unknown function, ƒ, and where n_{w}=ƒ(nₒ). Further, by substitution we find:

$${ω}_{m} = \frac{m c}{2 l f ( {n}_{o} )} .$$

We thus find that, in general, as the index of refraction of the external material changes, so too would the resonant frequencies, ωₘ. We would thus be able to measure the change in nₒ indirectly through modification in the resonance properties of the waveguide.

### Using Resonant Waveguides to Measure the Properties of Concrete

Photonic waveguides sensors detect changes in the effective refractive index of the waveguide mode. This change is primarily due to interactions with the surrounding medium, which affects the refractive index or the thickness of a cladding layer.

In one embodiment of the above, we embed this waveguide into an element of concrete as it cures. We record the set of all measurable resonant frequencies, ωₘ, and monitor how those frequencies change during the curing process. We thus (e.g. through an experimental calibration technique) create models that are able to map the resonant frequency of the waveguide resonator to a static, composite or contextual material property of the concrete. We subsequently possess a system that is able to use measured resonances of electromagnetic radiation in order to measure the material properties of concrete (or any other building material).

In another embodiment, the photonic waveguide is encapsulated in a cladding layer which itself is coupled with different physical force fields (e.g. stresses, or temperature changes). Changes in the properties of the cladding lead to changes in the refractive index of the waveguide.

### Using Evanescent Modal Power as Means to Measure Properties of Concrete

As we have already described, the presence of cut-off modes, and the cut-off frequencies of those modes, are determined by the physical dimensions and the index of refraction of the outer material. As such, by placing a waveguide that is embedded inside concrete, but that is also embedded on one side onto a chip, capable of measuring the photonic power transfer from the surface evanescent modes of the waveguide, we gain the ability to measure the change in power transmission from the evanescent modes that are due to any changes in material properties of the concrete. This system thus becomes a lab-on-a-chip, that is able to determine the material properties of the concrete through current, voltage or power measurement of an electrical circuit that is coupled to the waveguide resonator. This may also apply beyond photonics (to waveguides for other parts of the E&M spectrum).

### Using Resonant Cavities to Measure the Properties of Concrete

Similarly to the waveguide resonator, it is possible construct Fabry-Perot or Mach-Zehnder interferometers, wherein the light source can be placed outside of the concrete element, and the light can be transmitted through a waveguide directly into a resonator of the same material, which is embedded inside the concrete. In another instantiation, the light source is also embedded in the concrete along with the interferometers. Both systems are able to also measure the material properties of the concrete via changes in resonant frequency. Other geometries that may employ any bounded optical volume within the concrete, and with any number of geometric resonance structures are used. For example, this may include micromachined structures, such as those that utilize diffraction gratings.

### Power and Frequency Sweeps

In general, we operate all of the above-mentioned photonic sensing devices over a broad range of transmission frequencies, and a broad range of powers. This allows us to properly characterize the frequency-dependent and power-dependent response of the waveguide, in response to the surrounding material properties. As such, we are able to properly separate out any effects that are due to the waveguide itself, selecting for only measured changes due to the external material. In some embodiments, light excitations are confined within the waveguide core through total internal reflection. The guided modes in the waveguide include evanescent fields at the cladding interfaces, which are crucial for sensing applications.

### Engineered Waveguide or Cavity Surfaces

It is generally possible for us to engineer the surface of the waveguides or cavities, so as to apply substances that preferentially bond to certain chemicals, atoms or molecules in the embedded material. As such, we are able to engineer waveguides or cavities that can preferentially measure changes in concrete due to evolutions in the byproducts associated with the concrete hydration process (for example), so as to selectively create a resonator that is able to measure and track the compressive strength of the concrete in real-time, using only the resonant features of the photonic device.

### Exposed and Cladded Waveguides for Measuring Material Properties

In one embodiment, we utilize a fixed-length waveguide wherein parts of the waveguide are covered in cladding and other parts are exposed. We might use the exposed region to measure chemical changes in the surrounding concrete. However, the cladding might be selected so that it too might change under certain selected material properties and/or conditions (e.g. strain). This would influence the refractive index of the cladded sections differing to those of the exposed sections. We may employ various on-chip circuits in order to simultaneously measure the differences due to both of these effects.

### Photonic Crystals as a Means for Measuring Concrete Properties

A number of other photonic sensors are contemplated, including photonic crystals, which are structures with a periodic arrangement of materials with varying refractive indices, and which can be used to control the flow of light (as analogy to a waveguide). The varying refractive indices create photonic band gaps which affect the propagation of light through the crystal, offering another means by which to determine the index of refraction of an external material. Physical properties of the material would change the refractive indices of each material in the crystal, which changes the properties of the photonic band gaps. This is a particularly advantageous embodiment, because the periodic structure of the material enhances the light-matter interaction: which improves their sensitivity to surround changes in material properties (in particular for chemical sensing).

### Light Polarization as a Means to Enhance Sensitivity of Resonators

In optical cavities, certain resonance modes may be polarization dependent. This means that one can design cavities to favor certain polarization states in order to preferentially detect certain ion concentrations in concrete. We utilize polarization as means to enhance our understanding of the surrounding materials.

### Photonic Metamaterial Sensing

The integration of metamaterials and metasurfaces with optical waveguides creates meta-structured waveguides. These structures can be tailored to manipulate light at subwavelength scales, providing enhanced sensitivity and specificity in detecting material changes. These meta-structured materials may exhibit various effects, including the Vavilov-Cherenkov effect, negative refraction, cloaking effects, concentrator effects, perfect lens effects, and negative compressibility. In one particular embodiment, they are used to amplify evanescent waves, which provides further information to determine host material characteristics. Specifically, metamaterials with negative permeability and permittivity are constructed, and mounted between the photonic guiding layer and the host material, or between the photonic guiding layer and the cladding layer. This increases the penetration depth and strength of evanescent waves, increasing the sensitivity of our system to changes in the host material (which, for materials such as concrete, of particular advantage).

### Types of Photonic Waveguides, Tuning & Integration

Several photonic waveguide configurations are considered. Without loss of generality, these include (1) standard waveguides, often made of silicon dioxide (SiO₂) with another material cladding (e.g. fibre optics); (2) Periodic waveguides, that involve structures like sub-wavelength gratings (SWGs) with periodic dielectric structures to allowing for refractive index profiles that vary along the propagation direction; (3) Slab Waveguides, consisting of thin layers of materials with different refractive indices. The refractive index profile in these waveguides is constant along specific directions. Photonic Waveguides may be tuned for sensing by using specific core aspect ratios to enhance field overlap with the cladding, beneficial for fundamental quasi-TM and quasi-TE modes. The photonic waveguides are integrated into other sensor systems through phase-sensitive photonic circuits and core components. These systems are coupled to route and read out optical signals within a defined space on a photonic integrated circuit (PIC).

### Optic Fiber Bragg Grating Sensing

Wave-based photonic devices may also be based on optical fibers with Bragg gratings (FBGs). These sensors exploit the changes in the refractive index of the fiber under different conditions like strain, temperature, and other environmental changes. When these parameters change, they alter the Bragg wavelength of the fiber, which are precisely measured to determine the magnitude of the change. This embodiment is particularly advantageous for spatially distributed sensing applications (as many Bragg gratings can be disposed within the fiber). Measured outputs include but are not limited to strain, temperature, pressure, humidity, and chemical composition changes.

A particularly inventive use of FBG sensors by the inventors is the determination of the evolution of the fresh properties of concrete (e.g. curing, compressive strength development over time). Optionally, these fibers are coupled with one or more mechanical actuators (e.g. any of those described in the mechanical section, such as a CMUT transducer or Piezo), which are used to excite the structure. The impedance response of the structure is then determined, optionally at multiple locations throughout the fiber (which is analogous to an N-port system). This provides a highly accurate measure of EMI and can then be used to determine the acoustic wave velocity, dynamic modulus and as a result compressive strength. In a further enhancement, the optic fiber, or parts of the optic fiber is disposed within a resonator or in proximity or within one or more resonant frames, to enhance particular resonances.

The data from optical fiber sensors are automatically integrated with Building Information Modeling (BIM) systems through the linkage methods.

### Conclusion

To conclude, several high-frequency E&M methods, based on IR or higher frequencies in the electromagnetic spectrum, to probe materials (e.g. such as cementitious mixes). At this frequency, interactions occur at the atomic level, with most methods centered on optical emission or absorption spectroscopy. Novel Spectroscopic techniques suitable for monitoring materials such as concrete (from within the concrete structure, through embedded sensors or externally) have been described. These include techniques to deal with the inhomogeneities of concrete at those wavelength scale. Innovative methods to operate many of these techniques on ultra-low-power, miniaturized electronics devices, that are able to communicate the resulting data wirelessly are also described, offering a step-change from large and bulky lab-based equipment. Low-cost embodiments (such as those for the hyperspectral imager) are also set out, which would completely change the level of quality with which we are able to characterize materials in construction, both during construction (e.g. the fresh properties of concrete), but also during the lifetime of the building.

And finally, going beyond light-based spectroscopy and imaging techniques, highly innovative photonic sensors, such as photonic waveguide-based refractive index sensors are also described, which have the potential to detect mechanical, electrical, chemical and electromagnetic behaviors within concrete at unprecedented levels of precision and accuracy.

### Position & Interaction Sensing

These sensor devices are described within the Logistics section of this document. Please refer to that section for details. Generally, location, position and interaction sensing elements may be integrated onto any of our device embodiments (and/or methods may be executed on them which may employ existing or additional sensors and actuators to measure position).

### Combos & Specific Embodiments

The inventors have considered, without loss of generality, specific device embodiments, including some that employ a combination of multiple sensing and/or actuation techniques described herein for multivariate sensing methods employing a plurality of sensors, of either the same or different kind. This may, for example, take the form of devices that employ both mechanical and electromagnetic wave-based sensing techniques, which are considered particularly advantageous for characterization of materials such as concrete (where an interplay of chemical reactions, and mechanical properties of the composite and its raw components) contribute to the macroscopic bulk behavior.

### Wave-Based Sensor Combinations Examples

### High Frequency E&M-Mechanical Wave Based Combinations

High Frequency E&M devices described above, including ISI methods are particularly useful in monitoring the chemistry of materials. This may include compositional material properties, and also monitoring of chemical processes. Mechanical Wave devices are particularly useful in monitoring the bulk properties of media, including Young's Static Modulus and other properties associated with the ways in which a material may react to various mechanical forces and energies.

For cementitious mix and concrete applications, these materials may in general comprise inert, non-reactive, filler materials e.g. aggregates, as well as reactive materials e.g. cement matrix, water, admixtures. As the cement hydration reaction progresses, a cement matrix forms around the aggregates, and bonds to the aggregate. The chemical composition of the cement matrix, and of the aggregate are one factor which influences bulk properties of the media. Their specific mechanical configuration and the way the components of a concrete mix are disposed (e.g. pore structures, aggregate sizes etc.) are another key factor which may contribute to properties.

Measures of chemical composition (such as high frequency E&M spectroscopy) will inform what chemical reactions are or have happened within the concrete, including which elements and chemicals it contains. This informs an important aspect of the material. Likewise, mechanical wave-based methods will provide information about the disposition and spatial configurations of the chemicals and fillers. This also informs an important aspect of the material. The combination of both methods, however, together, form a particularly advantageous embodiment in that they are able to provide a much more comprehensive characterization, of the chemical composition and the mechanical behavior, from which the emergent bulk properties can be more accurately understood.

In one embodiment, this may be done using a combination of mechanical wave based sensing and high frequency E&M wave based sensing. Mechanical wave based sensing methods using mechanical transducers including electromechanical transducers and others described herein may be used to characterize the bulk properties of cementitious mixes, such as young's static modulus, shear modulus, bulk's modulus and other properties such as the presence, size and frequency of pores in the material which may be characterized using tomography techniques for example. High-Frequency E&M Wave Based sensing methods using light sources such as lasers, LEDs, and/or others may be used to characterize the chemical properties of the material, such as the presence of admixtures, the water to cement ratio, the atomic crystalline structure of the cement matrix, as well as the broader formulation of the concrete, over time as it cures. These two methods are complementary, and allow for more powerful, comprehensive understanding and characterization of the material under consideration.

In some embodiments, non-wave-based sensors, such as point temperature sensors may be used in combinations as well. The temperature sensors may enable temperature correction for the other sensors/transducers and/or actuators in the sensing device. The temperature sensors may further be configured to enable maturity sensing in cementitious mix related applications. Thermal Tails (including MPTTs) may be used for spatial temperature characterization of the concrete. In this combination, it may be possible to map out the temperatures in the regions wherein the waves sent through wave-based sensing may travel, and account for these temperatures/normalize using context awareness methods for example. Note, point sensors such as temperature sensors may be used in combination with any other sensor type described herein. In particular, the combination of a temperature sensor and at least one other sensing or actuation method is considered to form the basis for some embodiments of ‘enhanced maturity’ methods.

Specific embodiments may include:

LIBS-Piezoelectric Combination: This device embodiment integrates Laser-Induced Breakdown Spectroscopy (LIBS) with piezoelectric or CMUT transducers for dual-mode material analysis. In this system, LIBS spectra are analyzed to determine the elemental composition of the material (broken down for the cement matrix and aggregate respectively). The piezoelectric or CMUT transducers, on the other hand, are used to measure the bulk mechanical properties of the material (which not only emerge from the chemistry, but also the mechanical disposition of the aggregate, which acts as a filler, with the cement matrix) through electromechanical impedance measurements (optionally, resonance enhanced through a frame). These data are combined to determine material properties (using physico-chemical models, empirical models, machine learning models, or a hybrid of all of these, optionally in reference to an existing library of labeled data).

FTIR-Piezoelectric Combination: Similar to the LIBS-Piezoelectric combination, but spectroscopy is FTIR based, which allows for bond excitation rather than elemental composition.

### Other Combinations

Electrochemical-Mechanical Wave-based Combination: This combination employs an electrochemical wave-based sensors configured to monitor electrostatic and electrochemical properties of the material, which may include electromechanical impedance spectroscopy characteristics, and a mechanical wave based sensor (e.g. opto-mechanical, electro-mechanical). Electrochemistry may be used for characterizing the ionic charge displacement of the material under potential differences. Electrochemistry may further enable concrete curing monitoring, through manipulation of ionic charges for example associated with the active materials (e.g. cement matrix, water), as well as pore size and density determination.

Mechanical wave-based transducers may monitor bulk material properties of the material such as its behavior under excitation, stress, strain and other types of deformations. Together, they provide a comprehensive insight into the mechanical and chemical properties of the material.

LIBS-FTIR Combination: This combination employs both LIBS and FTIR spectroscopic techniques for a dual spectroscopy, determining elemental composition & bond structure of the material, which enables more accurate identification of the material. The techniques can be cross-checked.

LIBS-Ground Penetrating Radar (GPR) Combination: Combining LIBS spectroscopy with Ground Penetrating Radar (GPR) creates a powerful tool for both material characterization, and geometry mapping. LIBS offers precise chemical composition analysis, and GPR extends the capability to map beneath the surface and determine pour geometry. This is one example amongst a broader set of embodiments that use wave-based sensors to characterize material properties (such as contextual material properties in time), but also the geometry of the pours and spatial configurations within which the sensors are disposed (a combination of mix fingerprinting and context awareness methods).

Hyperspectral-Microscopy: the combination of hyperspectral imaging with microscopy has the potential to provide a highly accurate image of the cement matrix at the level of individual aggregates, pores in the cement matrix and so on. This informs both the spatial distribution, mechanical geometry and disposition of the raw components, as well as their composition, providing for a particularly advantageous combination. This is one example of a broader set of embodiments that combine microscopy with imaging or ISI devices.

This section generalizes to any combinations of one or more electromagnetic, thermal, mechanical wave-based sensors, alongside non wave-based sensors (e.g. for signal correction).

### Sensing Cube System

The sensing cube system is a modular, interlocking card-based design that can be configured in various ways to suit different sensing requirements. The system is not only limited to cube geometries, but can also take other forms, depending on the application (e.g. cylinders, spheres, hexagonal or octagonal prisms, polyhedrons etc.). In the case where the geometry does not have ‘faces’ (e.g. a sphere), it may be subdivided into regions or areas for different sensors or actuators. In this description, the ‘cube’ is meant to understand the generalized embodiment of this device.

Each card or ‘cube face’ can be equipped with different sensors or actuators (e.g. wave-based devices) and can interlock with others to form a device. One or more faces may include the MCU, communication interface (e.g. wireless communication by any of the means described elsewhere) and batteries to enable ultra-low-power operation. The cube's design facilitates multiple configurations, including but not limited to Electrochemical, Magnetochemical, RF/Terahertz, Light-based Sensing through (e.g. spectroscopy, photonic waveguides, cameras), Mechanical Sensing (e.g. electromechanical, or photomechanical), as well as combinations and Cross-Cube Sensing involving multiple devices.

In one use-case, the device is embedded into concrete. It can be placed centrally within rebar grids or at strategic edge positions (or span across rebar grids). When concrete is poured, the cube is fully embedded. Particular faces can be left empty (e.g. the top face), which allows materials like concrete to flow into the inside of the assembly, for sensing and analysis.

Alternatively, one or more faces may have holes, slits or voids in them that allow material to flow into the cube's inner volume. This creates a localized inner volume which can be actuated and sensed. A plurality of cubes that influence each other may be used as a distributed system.

The cube is configured to enable various forms of impedance spectroscopy, S & T parameter analysis, spatial tomography, time of flight analysis etc. (all already described in detail elsewhere in this document). Actuators may be excited simultaneously, or with a phase shift. The one or more frames of the cube may lead to resonance modes or act as cavities for different wave-based scenarios. Spatially diverse measurement techniques are employed, including point-to-point measurements in all directions (including diagonal paths) and face-to-face assessments.

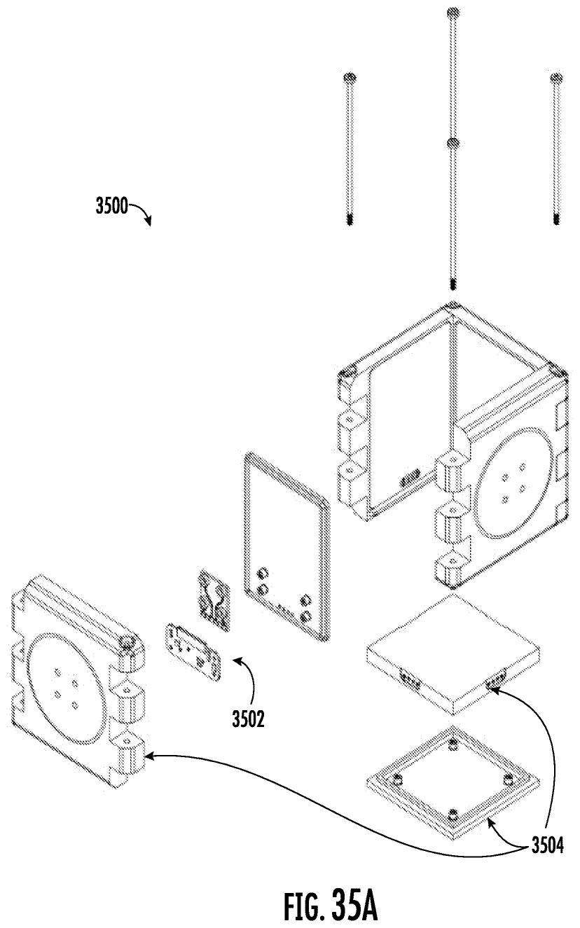

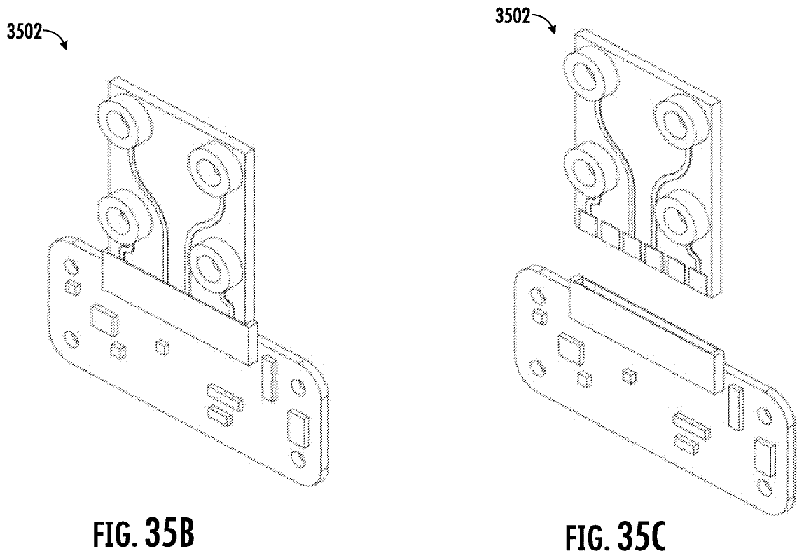

With reference to FIG. 35A-35C, an example electrochemical sensing cube implementation 3500 is provided with an example electrochemical sensor 3502 supported by the cube components 3504. Such an electrochemical sensor 3502 may operate as described herein in which the cube's vertices or faces are adorned with conductive materials, capable of applying a controlled voltage or alternating voltage and/or alternatively, a current for electrochemical techniques.

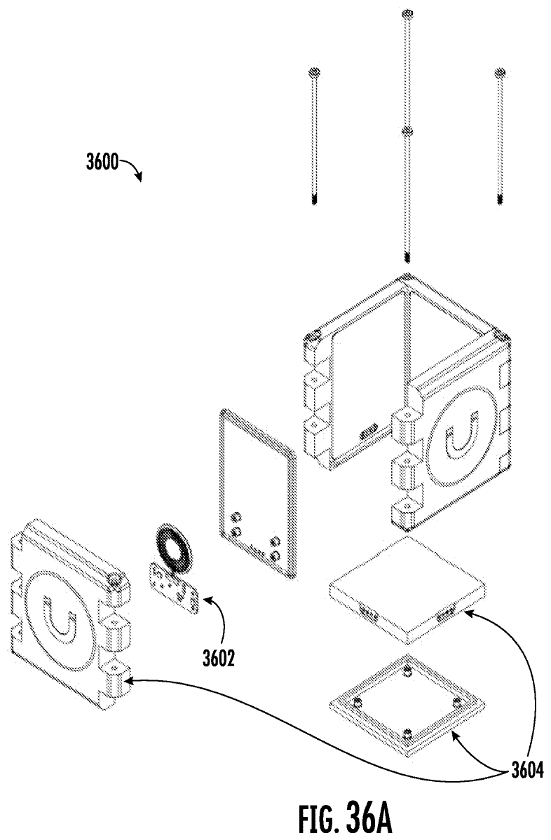

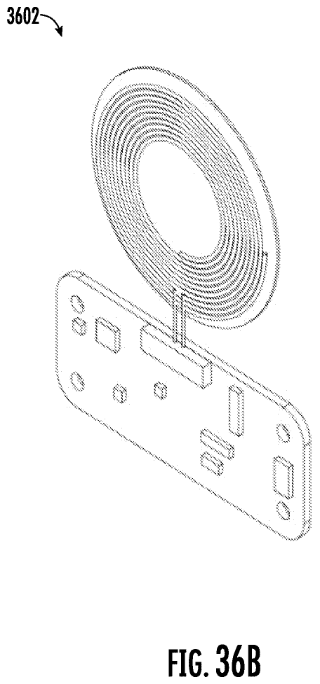

With reference to FIG. 36A-36B, an example magnetochemical sensing cube implementation 3600 is provided with an example magnetochemical sensor 3602 supported by the cube components 3604. Each face of the cube may be equipped with insulated copper wire windings, forming loops for magnetic field generation and magnetic sensing. This may be coupled to conductive plates to form an EMAT transducer resonance system.

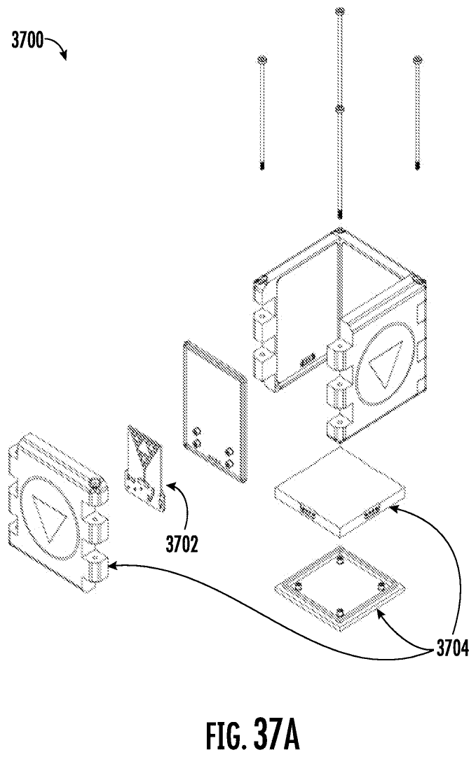

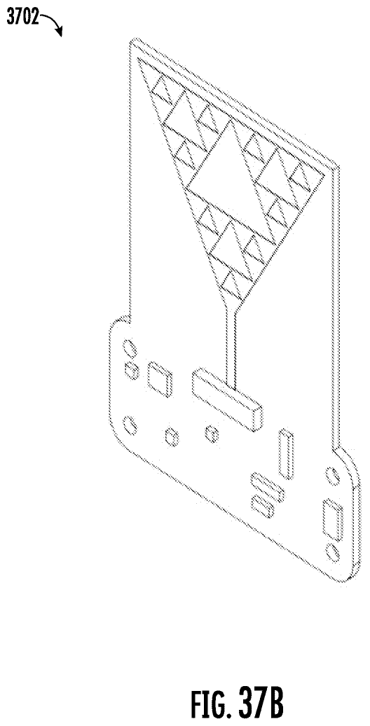

With reference to FIG. 37A-37B, an example microwave, rf, and terahertz, sensing cube implementation 3700 is provided with an example microwave, rf, and terahertz sensor 3702 supported by the cube components 3704. The cube faces or vertices are equipped with sophisticated antennae, such as PCB fractal antenna, and E&M signal generators.

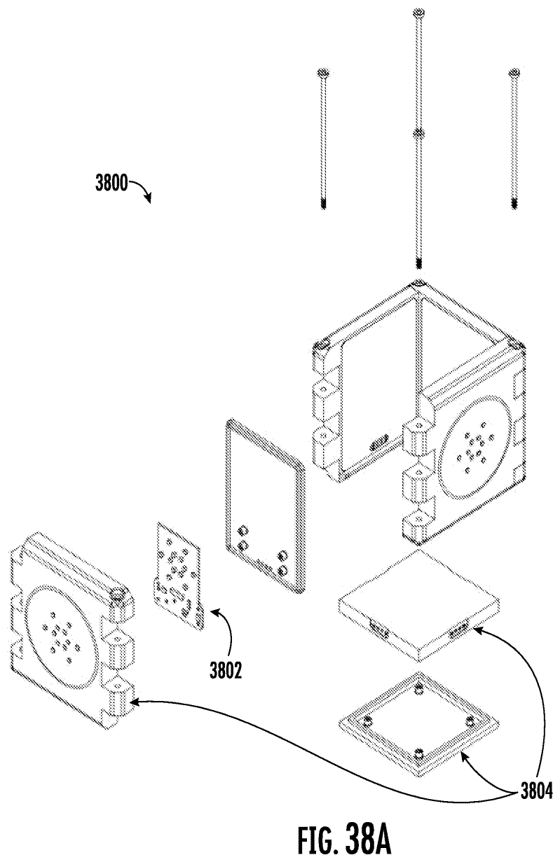

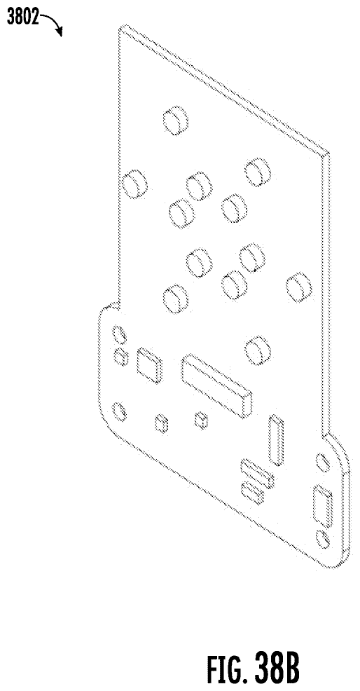

With reference to FIG. 38A-38B, an example photodiode, spectroscopy or hyperspectral sensing cube implementation 3800 is provided with an example photonic/hyperspectral imaging sensor 3802 supported by the cube components 3804. The cube faces or vertices include multiple Light Emitting Diodes (LEDs) in varying colors (e.g., infrared, red, green, blue, ultraviolet), or spectroscopy or hyperspectral camera systems, or photonic waveguide sensing.

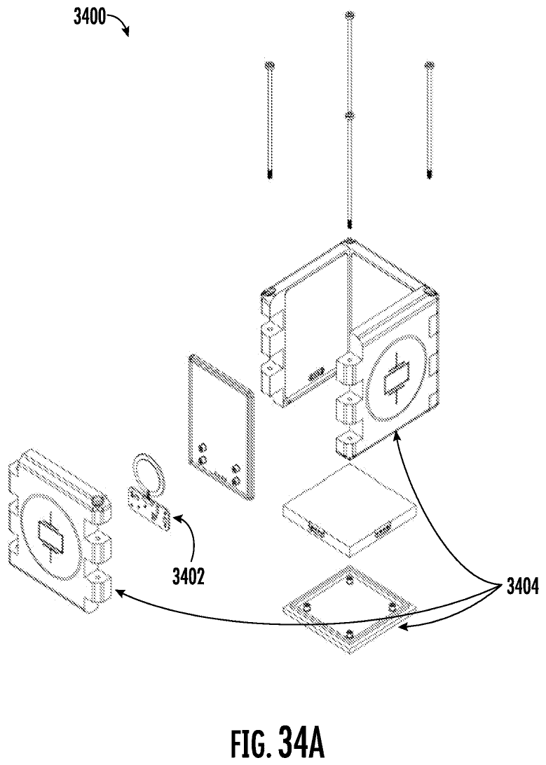

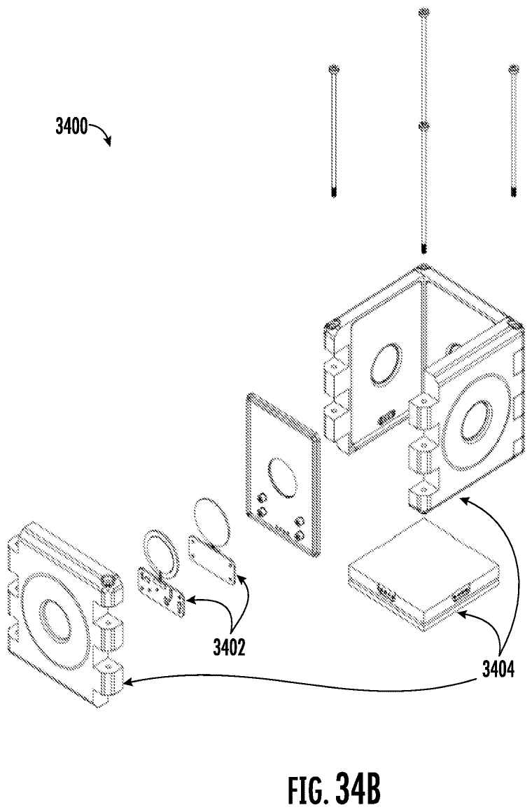

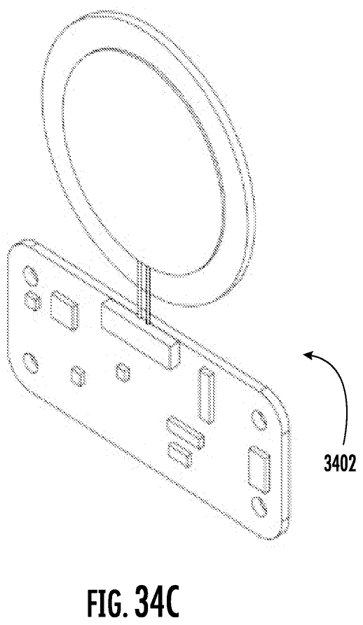

With reference to FIG. 34A-34C, an example mechanical sensing cube implementation 3400 is provided with an example mechanical transducers 3402 supported by the cube components 3404. The cube incorporates mechanical transducers on its faces or vertices. Mechanical oscillations are driven and may be directed inwards or outwards (or both). The cube frame enables and enhances particular resonant modes.

Mixed Cubes: User-defined combinations that fuse different sensing methods (of any type described herein). Different sensing methods on each face, or a plurality of sensing methods per face are contemplated. Generally, any combination of sensors (including different couplings, which may or may not exhibit reciprocity) may be used (e.g. maturity+EMI methods).

In a laboratory context, the devices described herein may be integrated or inserted into concrete cube or cylinder molds (or other shapes of interest), allowing for the collection of lab data for various concrete mixes and allowing comparisons with other lab-based testing methods.

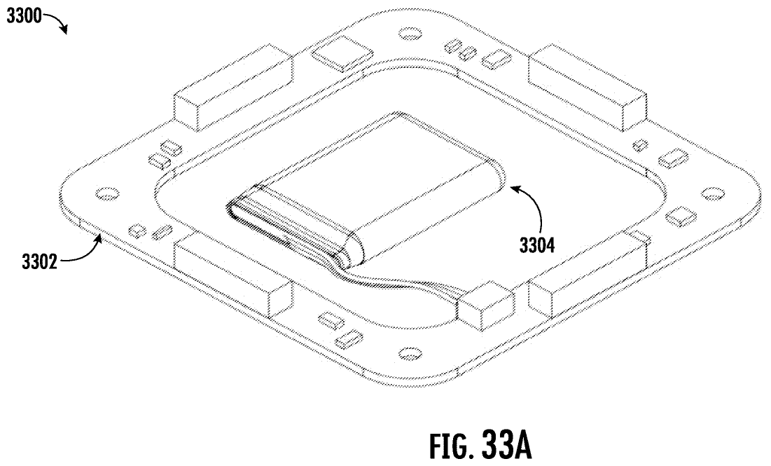

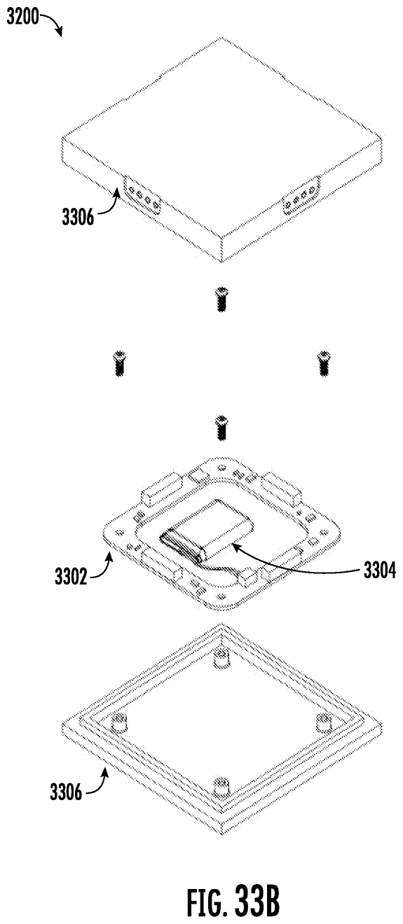

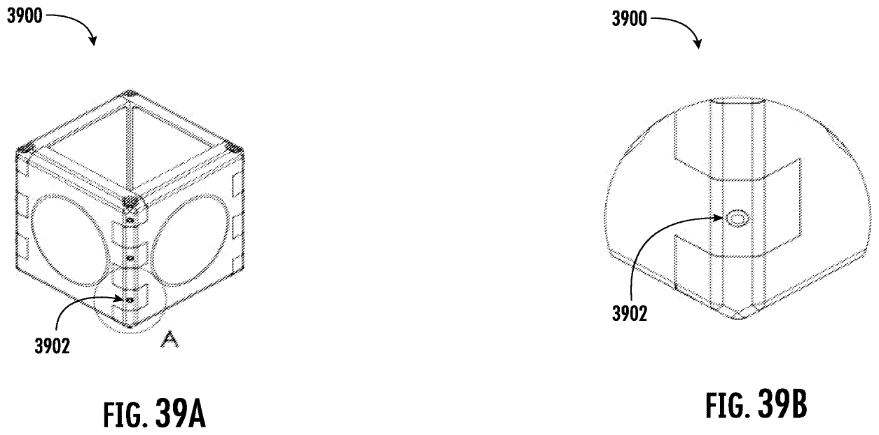

With reference to FIGS. 33A-33B and 39A-39B, a battery portion 3300 with associated PCB 3302 and battery 3404 are provided and a point sensor implementation 3900 with point sensor 3902 are provided, respectively. The devices described herein may makes use of modular PCBs with specially designed slits that allow interlocking at predetermined angles (e.g. right angles for cubes, 60-degree angles for prisms). Ties, straps or magnets may then be employed to strengthen the frame. Coatings (e.g. conformal coatings) or other materials (e.g. high-density polyethylene) may encapsulate the electronics for waterproofing (preserving or even enhancing geometry of voids or slits that support concrete flow). Components are encased in a silicone-based potting compound protecting against immersion in concrete. The cube may attach to rebar or float in concrete (see attachment section). The PCBs serve a dual purpose, acting both as structural elements and as platforms for sensor integration (e.g. cartridges). Replaceable sensors connect through surface-mounted connectors, allowing for easy swapping. Configuration & firmware updates are possible over-the-air firmware. The system supports expansion protocols like 1-wire, RS-232, and USB-OTG, with I2C and SPI interfaces on each module. Each cartridge can operate on its own independently of the cube system. The connectivity & power management methods described in the general section may all be employed by the cube, such as via a card having a battery 3404.

Cubes in lab environments can be linked to cubes in field environments. For example, water bath temperature may be actuated by the lab cube based on temperature measurements from a site cube.

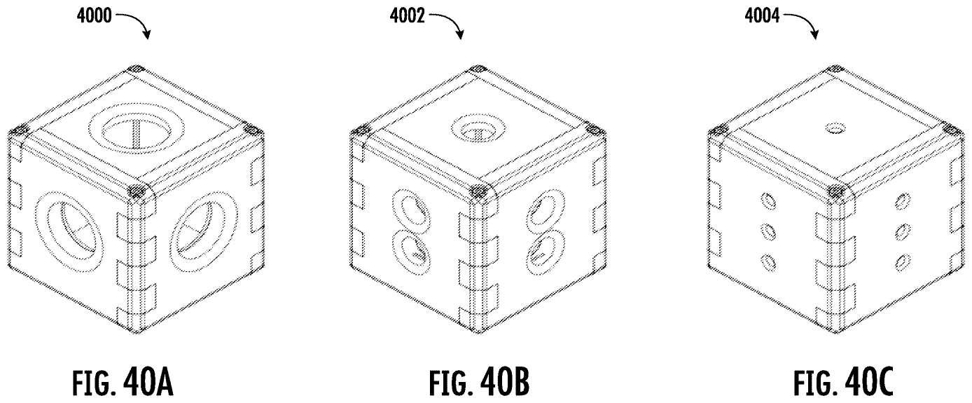

With reference to FIGS. 40A-40C, the cube sensing embodiments of the present disclosure may incorporate a specialized set of high precision sieves 4000, 4002, 4004 designed for effective separation of liquid, sand, and varying sizes of aggregate from concrete samples. These sieves enable detailed analysis of concrete composition, including mortar and concrete with large aggregate pieces (e.g. allowing selective sensing of the cement matrix vs the aggregates in different sections of the cube). The sieve 4000, 4002, 4004 comprises a series of interchangeable, modular sieve panels. Each sieve panel is designed with adjustable apertures, allowing users to customize the size of the aggregates being filtered. To ensure compaction and to avoid air voids, the device may include vibrating elements which ensure that the concrete is fully compacted and activates the sieve. This allows for automated separation and analysis of raw constituents.

### Smart Elements

Smart Elements in this section designate the integration of any of our sensor systems (e.g. wave-based sensors) into other construction resources on the jobsite such as formwork, rebar, tools or into the raw materials of a concrete mix (e.g. so called ‘smart aggregate’). Three embodiments are described in more details.

### Smart Aggregate

Aggregate size varies from 0.063 mm (smallest) to 20 mm (largest). This embodiment contemplates a sensor device that can act as a ‘smart’ aggregate (looks like an aggregate but acts like a sensor device). It may be shaped like an aggregate, and supplied in bags like an aggregate, but is made up of electronics & sensor transducers, optionally with a coating to ensure good adherence. The coating could even be concrete. It may be as small as a few millimeters across or sized closer to a larger aggregate.

Sensors, Power & Communications: Key sensor transducers on or in the smart aggregate may include one or more piezoelectric elements, an RF antenna & signal generator (used for both communication on standard protocols (or custom protocols with advanced RF) for probing electromagnetic wave behavior in concrete and wave impedance, etc.), temperature, pressure (electrostatic pressure to measure depth), inertial sensors (accelerometer, gyroscope, magnetometer), photonic sensors, and other context awareness techniques. The device may be powered by a battery, or an energy harvester. Energy may be harvested from the piezo when it is not in use (including in the truck during transit, as concrete is rotated). A plurality of smart aggregates may form a local network and have the ability to communicate wirelessly (for example in a mesh configuration) but also with a gateway/phone/or even directly with the internet through technologies such as NB-IoT, BLE, LoRa etc. This would allow time synchronization (enabling for example the tomography applications above).

Geometry: The shape of the sensor device would typically be spherical or elliptical, or irregular like an aggregate. It may be coated with a concrete lining (e.g. dipping or spraying). The surface area, shape, particular features, weight, density, center of mass are optimized to ensure homogeneous disposition within the concrete through natural mixing.

Optionally, frames, or irregular aggregate geometries may be designed to enhance E&M or mechanical resonances.

Installation in Concrete: Smart aggregate sensors would be mixed into the concrete at the point of batching (e.g. stored in silo's or thrown into the mixer). Alternatively they may be injected (or sprinkled) into the concrete during or after pouring. The density of the devices would also be carefully considered to ensure that they naturally position themselves in the right part of the pour. A bag might include devices with a varied densities or sizes, to ensure some devices make it close to the surface of a pour, and some sink. Density could also be dynamically adjusted by absorbing free water.

Self-organizing aggregate: Optionally, this system of smart aggregates may have the ability to move & self-organize in the concrete. This could be achieved, for example, through some sort of propulsion system or through electromagnetic fields. Use of the rebar as part of this (e.g. moving away from the rebar) would be one such example.

Distributed Sensing & Heterogeneity Sensing: As a distributed system, spatial tomography & mapping of the spatial distribution of (non-smart) aggregate & cement matrix can be done. At this scale, the inhomogeneity of a concrete mix will become apparent. Data from each smart aggregate device could be aggregated and clustered based on the signal, allowing the separation of mechanical & electromagnetic signatures of the cement matrix and (non-smart) aggregates themselves.

Assembly Configurations: In one potential embodiment is similar to the ‘oreo’ described in the mechanical section, with two piezos sandwiching the electronics. In another embodiment, the antenna might wrap around the cylinder's edges, turning the ‘oreo’ into a coin looking device. Mechanical isolation between the piezo & the electronics may be designed in.

Truck sensing: When used in a truck, this system would allow for monitoring of the workability through the network of smart aggregates. Through the use of the inertial sensors, the movement of the smart aggregate in the drum would relate back to the workability of the concrete.

Location Tracking & Spatial Characterization: Smart aggregate is able to track its location and may act as a traceability monitoring system. For example, the smart aggregate could detect when it was first pumped into the pour. And also which smart aggregate made it out of the truck first. This would allow the detection of which part of the pour was first poured, allowing for context awareness and enabling aspects of status inference. Once the smart aggregate has made it in the pour, provided there is sufficient density of smart aggregate, the mechanical and electromagnetic tomography could be used to produce a full 3 dimensional map of the inside of the pour, informing on rebar content, and even condition of the inner components, void detection etc. The concrete could be fully characterized temporally and spatially, at each stage of curing, becoming a step-change for material characterization.

### Smart Rebar

Smart rebar refers to reinforcement bars that are integrated with sensor devices or communication devices. These sensors are designed to automatically activate upon installation in concrete structures. The activation is typically triggered by conductivity sensors that detect the presence of concrete, thereby ensuring that the sensors begin their monitoring work at the right phase of construction.

Embedded sensors: The smart rebar may include any of the sensors, actuators or transducers mentioned herein, and are primarily focused on: (1) monitoring of fresh properties of concrete and their evolution in time (strength, temperature, etc.); and (2) monitoring longer term structural health, such as stress, strain, shrinkage, corrosion, within the concrete.

Rebar composition The core of the smart rebar may be made of traditional steel reinforcement (so that it can act as structural reinforcement in the usual way). It may also be made of other materials which may or may not play a structural role. In particular, fiberglass is considered, which would have the added advantage of both being able to carry structural load, but not interfere with any wireless communication interfaces on the device.

Automatic Activation through Conductivity Sensors: Optionally, these sensors detect the change in conductivity as the rebar is covered by concrete, automatically activating the other embedded sensors. This feature ensures that the sensors begin functioning precisely when the rebar is placed within the concrete, eliminating the need for manual activation and thereby reducing labor and errors.

Charging Capabilities. To enhance the functionality of smart rebar, an inductive charging system is integrated. This system allows for wireless power transfer to the embedded sensors within the rebar, ensuring continuous operation without the need for direct electrical connections or battery replacements. This includes inductive charging coils (embedded alongside the sensors within the rebar). These coils receive energy from an external charging source, typically installed close to the concrete structures. A charging unit is placed near the concrete structure, which generates an electromagnetic field. This field induces a current in the embedded coils, thereby charging the sensors wirelessly. The system includes power management circuitry to efficiently distribute the received energy to the sensors, maintaining optimal sensor operation. For scenarios where inductive charging is not feasible, an external charging mechanism using exposed contacts is employed. Specific segments of the wiring are designed to remain exposed, serving as charging contacts. A charging device connects to these exposed elements, delivering power directly to the embedded sensors.

Location Tracking: smart rebar is equipped with location tracking capabilities. This feature allows for precise mapping of each smart rebar's position within a structure, facilitating targeted inspections, and providing spatially distributed measurements of material characteristics. This may rely on any of the localization methods described in this document (including those in context awareness). E.g. GPS and RF-based location sensors. Location data are integrated with structural health data, providing a comprehensive overview of the structure's condition in relation to specific rebar locations.

### Smart Formwork

Smart formwork refers to the innovative integration of sensor technology into construction formwork, which is used as a temporary mold for concrete structures. Unlike smart rebar, smart formwork focuses specifically on the early stages of concrete curing (as it is then removed).

Sensor-Embedded Formwork: The formwork is embedded with sensor devices (e.g. maturity, impedance, or of any kind described herein) designed to monitor various aspects of the concrete pouring or curing process and the condition of the formwork itself (including any of the wave-based devices, maturity or enhanced maturity devices described elsewhere). Positioning sensors and techniques are also integrated into the smart formwork (through the various techniques described elsewhere). Sensors are activated by the presence of wet concrete, similar to the conductivity sensors in smart rebar.

Adaptable Charging Solutions: Given the temporary nature of formwork, charging solutions are tailored for short-term use. Both inductive charging and direct charging methods, as described in the smart rebar section, can be adapted for smart formwork.

Alternatively, batteries may be user swappable and rechargeable at a battery station. Special attention is given to power management, ensuring that the sensors operate efficiently during critical curing periods.

Data Use: The data collected by smart formwork sensors is crucial for assessing the quality and characteristics of the concrete at early ages, providing insights that can inform adjustments in the curing process. Data from smart formwork can be correlated with data from smart rebar and/or smart aggregate for a comprehensive understanding of the concrete's fresh properties and long term structural health.

### Conclusion

This invention has outlined the details of multiple innovations in sensing and excitation methods, hardware design, device operational configurations and signal analysis, and has described the manner in which all of these are utilized for the purpose of automatically characterizing the static, contextual and compositional material properties of a given material (e.g. a building material, such as concrete). We have outlined how these innovations can also characterize the contextual conditions of materials, wherein those contextual conditions may be aspects of the environment, or of the devices and sensors themselves, for example.

The embodiments have employed amplitude, phase, frequency, polarization and positional modulations of propagating waves, and we have utilized various spectroscopic techniques to analyze the frequency response of signals that are the result of interferometric, pulsed-wave or high-energy material alterations (such as in small-scale LIBS spectroscopy). All such innovations are valuable and pertinent with respect to the Mix Fingerprinting, Mix Optimization, Sensor Self-Detection/Context Awareness, and Data Linkage inventions discussed elsewhere in this document. The material property data generated by these inventions not only play a vital role in the training and execution of all prediction, evaluation and recommendation models of every invention discussed herein, but also in offering new and innovative ways to describe materials and their associated behaviors and properties.

### Data Linkage

As described herein, construction projects and similar applications are often associated with a myriad of data sources generated by or otherwise associated with various entities, such as the sensor devices 102a-102n described above. The disparate nature of these data sources, however, often results in the fragmentation of data thereby reducing the efficiency of performance of the associated project (e.g., construction of the structure or otherwise). For example, many data sources or associated systems attempt to generate digital twins or other digital representations of physical data. This digital data (e.g., digital twin data), however, is often disparately stored and, in some instances, may simultaneously exist in digital and physical forms (e.g., BIM data and concrete records). This lack of integrations may result in a barrier to the adoption of digital data formats. Furthermore, conventional systems have poor quality assurance due to a lack of traceability between different type of records, a lack of visibility into the actual productivity and sustainability of construction processes due to the isolation or siloing of data, and/or a lack of progress tracking, such as due to the disparate storage of spatial and/or temporal representations of construction projects (e.g., BIMs, floorplans, schedules, and/or the like). Furthermore, the described fragmentation of data also inhibits that ability of users or systems to interrogate historical data. For example, the design or schedule of construction operations is often inaccurate, and the ability to evidence these operations is limited (e.g., as relevant to claims and construction litigation).

Additionally, conventional construction project management systems fail to solve these issues resulting in delay, additional cost, and unnecessary resource expenditure. For example, a granularity problem exists in many conventional systems in which data sources exist at differing granularities resulting in difficulties linking the data sources. Further, a coding problem exists in many conventional systems where data sources are associated with the same underlying information but may be generally conveyed in different ways and represent different aspects of the underlying information. Further still, a completeness problem may exist in conventional systems where some data entities or elements lack data values and require completion before such a data entity or element may be linked. In addition, inconsistent formats are prevalent across the industry due to lack of standardization. Finally, data elements may exist in varying modalities (e.g., text, images, numbers, graphs, diagrams, etc.) that must be reconciled before data may be properly connected. In order to solve these issues and others, the embodiment of the present disclosure may operate to identify an association between disparate data elements and generate a data linkage between the data elements as described herein.

### Linkage Overview

As described herein, BIM models, construction schedules, and sensor devices are three examples of disparate construction data sources representing different aspects of a construction project. BIM models include spatial representations of the project (e.g., structure or the like), construction schedules include temporal representations of the project, and sensor data captured from sensor devices may be indicative of the true, physical state of the project. Currently, no integration exists between the BIM models, construction schedules, and sensor devices, particularly given that the use of sensors in the construction industry, as described herein, is absent in conventional applications. Moreover, construction projects often involve many different data types that capture different aspects of the site (e.g., concrete quality assurance (QA) records, concrete mix data, carbon emissions, etc.). No singular integration mechanism exists to capture all these data sources and determine how these data sources link (e.g., relate) to each other. In conventional systems, the data associated with each data source is segregated and stored in different ways. In other words, there is a digital data standardization issue associated with current construction industry systems, particularly between BIM models, construction schedules, and sensor devices.

As described herein, BIM models may include, but are not limited to, information concerning construction elements and their geometry. The information may exist at different levels of detail and granularity, spanning from a high level design to a detailed design. At the highest level of design, the model (e.g., a BIM model) may contain only the overall geometrical shape of a building (e.g., as one large three dimensional element without segmentation or boundaries, multiple three dimensional elements representing each floor or each column, or the like). At a more granular level (e.g., a detailed design), BIM models may include geometrical and other data about each concrete pour, the layout and type of rebar within the pour, the intended materials to be used, mechanical and electrical assemblies, and/or other fit-out items. Currently, users often work with these BIM models manually. One common example problem that arises from this manual interaction is that columns created in the model created by a human operator may span the entire building structure's height, rather than formed as separate three dimensional columns for each floor. In addition, contractors do not universally adhere to any single standard with their interactions with BIM models and may fail to update the BIM consistently. As such, across the industry, there may exist different, if any, data structures relating to BIM elements, different types of metadata may be associated with these elements, and BIM models representing the site at different times in its lifecycle may be used. Furthermore, the data of these BIM models and elements may be incomplete resulting in, for example, the absence of data values associated with a particular construction site or project.

Construction schedules often include activities, tasks, and/or milestones of the construction project, and they may also represent dependencies between milestones and schedules. Schedules, similar to BIM models, may also exist at different levels of granularity. For example, one construction schedule may have a master schedule or high level schedule that sets out activities such as “floor 1,” “floor 2,” etc., that represent the construction schedule of each floor of a building project. Alternatively, a six-week lookahead (e.g., a more granular schedule used for daily and/or weekly planning and operational delivery) may include tasks such as “setting out for pour 1” or “steel fixing for pour 1” and so on. In addition, different ways of scheduling tasks exist in construction, and each user (e.g., a contractor or the like) may use different scheduling techniques. It is also possible that some processes may be missing from the schedule.

Sensor devices (e.g., smart devices), such as the sensor devices described in the hardware section of the present disclosure, may represent a novel mechanism for enabling the generation of data of any type (e.g., concrete temperature, concrete strength, electromagnetic wave impedance, etc.) associated with a building material. Sensor devices are physical entities (e.g., the device itself) but also digital entities (e.g., a given sensor's representation on a digital platform used to manage sensor devices). Currently, sensor data (e.g., sensor identifiers), as well as any associated metadata, are inconsistent across projects and may often be manually inputted. Sensor devices and their digital representations therefore suffer from having inconsistent format across the industry. Malfunction of the devices may, at times, lead to missing information. Sensors may also measure global (e.g., construction site level) or local (e.g., pour level) phenomena. In other words, sensors may measure different areas, volumes of consideration, and/or the like. Therefore, sensor devices also operate at varying levels of granularity. In addition, sensors may act as the interface between the reality of the project and the digital models or plans of the project. In this way, the sensors may match these models to reality to track the progress of the project in real-time.

To be clear, the systems described herein referencing “linkage” and/or “sensors” may also describe linkage of the digital representation of the sensor to another data entity. Further, they may also describe linkage of a physical sensor to a data entity, including the linkage of the physical sensor to its digital representation, as well as the linkage of the physical sensor to another data value, entity, or the like. BIM models, construction schedules, and sensor devices relate to measurable entities where the measurable entities may include any physical entities on a construction site that may be measured. The BIM model may include actual or expected spatial information about the measurable entity. The construction schedule may include temporal or time evolution data related to the measurable entity. The sensor devices, and their associated data, may include a variety of physical measurements (e.g., indicating time evolution, chemical properties of materials, unit movement, tool movement, etc.).

### Linkage

As used herein, a “data linkage” may refer to a mapping between data entities that may involve creating links between data elements of each entity. A linkage may describe the existence of a relationship between two or more data elements or entities, and the nature of the linkages may vary. Furthermore, there may be different types of relationship for any given linkage. As described hereinafter, the systems of the present disclosure allows for the explainability of links or relationships between data elements and data entities such that users associated with the system are able to understand the relationship between data entities and data elements.

As described herein, a “physical link” may refer to any linkage between a measurable entity (e.g., a physical object) and any data value, element, and/or entity, and/or between two measurable entities. For example, if the total number of data sources in a system is N data sources, the total number of linkages (L_{T}) between the data sources may be represented by be

$${}_{{T}_{{2}_{\overline{2 ! \times ( N - 2 ) !}}}}^{N} {L}_{T} = {C}_{2}^{N} = N ! ( 2 ! ( N - 2 ) ! ) .$$

The number of linkages sufficient (L_{S}) to characterize all linkages between N data entities when transitivity applies may be described as s=N−1. The linkages may take both the commutative property and the transitive property. An example of the commutative property of links is as follows: A→B=B→A=A←→B=B←→A. An example of the transitive property of links is as follows: If A←→B and A←→C are given, then B←→C may be determined.

In some embodiments, the linkage of data entities may include a mapping between sets where elements from one set are mapped to elements from another set based on an internal representation. In this way, data entities may exist at different levels of granularity.

For example, if a BIM model is the data entity, the elements may be grouped into subsets (e.g., all elements on floor 1). In some embodiments, a data entity may be maximally granular when the elements of the set representing it are irreducible. In some embodiments, a data entity may be minimally granular when the elements of the set representing it are maximally reducible. In some embodiments, two data entities may exist at different levels of granularity. The granularity problem associated with conventional systems includes the challenges associated with the difference in granularity between data entities and reconciling them.

In some embodiments, a set in its irreducible representation may be represented by its disjoint subsets to create a less granular representation of the set, known as “downsampling.” In some embodiments, a non-irreducible set may be represented more granularly by decomposing its elements into more granular components, known as “upsampling.” Further, “resampling” may include both upsampling and downsampling. In this way, linking data entities that exist at different levels of granularity may require resampling (e.g., a resampling of the linkage between one BIM element and three schedule lines so that they are one-to-one and not one-to-three).

### Coding

In some embodiments, different data entities may, from time-to-time, relate to the same underlying information. The different aspects of the information may be referred to as “coding.” For example, if a sensor is identified as “Sensor 2” due to its registration, and a pour element is identified as “Pour A1” due to its pour location, a difference arises in how the sensors and elements were coded. By way of continued example, schedules, BIM models, and sensor identifiers, each may be coded differently in that they convey information, often about the same object or process, across different axes. Schedules represent activities and milestones in time, whereas BIM models represent elements in space (e.g., dynamic processes vs. static objects). Meanwhile, sensor identifiers may be defined through elements in space, milestones in time, or neither (e.g., via name or another identifier). There is a link between each of them in that processes will involve existing objects, objects are created through processes, and sensors monitor objects and processes. The difference, however, in coding makes it difficult to identify specific links. There is therefore a coding problem that exists when trying to compare these entities.

### Completeness of Data Entities/Linkages

As used herein, an “information target” may refer to the objective of the description of the data entity. A data entity may be complete if all the information contained by its elements matches (or exceeds) the information target. In some embodiments, the data entity may be sufficiently complete if it matches a confidence threshold. Further, the data entity may be incomplete if it does not match the information target. Similarly, in some embodiments, links may either be complete or incomplete. A complete linkage may include a linkage between two or more data entities in which every data element has all of its possible links realized (which may include links determined by transitivity). Otherwise, the linkage may be incomplete, or a partial linkage.

### Probabilistic Links

As used herein, a “probabilistic link” may refer to the mapping between two or more elements from two or more sets that has an associated probability of being accurate. The probability may also be referred to as the confidence of the link (e.g., an associated confidence value). The probability may be assigned by the systems described herein, by external users, by third party systems, and/or the like. In some embodiments, the probabilities may evolve in time as additional data is gathered during the construction project. Further, in some embodiments, redundant links, as described herein, may be used to increase confidence in a particular link. In addition, the link probability density function may be the probability distribution function of an existing link, across the space of possible data elements in one data entity, to a data element in another data entity.

### Internal and External Linkage

As used herein, an “internal linkage” is to link a particular element of data entity 1 to data entity 2 and is sufficient to use information from either or both entities. As used herein, an “external linkage” is to link a particular element of a data entity 1 to data entity 2 and is necessary to use information from another data entity (e.g., an external data entity).

### Mutual Information

As used herein, “mutual information” may include the information contained inside data entities and/or data links that may overlap (e.g., data that is mutual to both entities). Further, “mutual transitive information” may include a measure of the degree to which a system of N data entities may be characterized solely by the transitivity of links when transitivity applies. A “redundant link” may include a link determined by transitivity alone. As described above, in the transitive case, it is sufficient to complete only L_{S}=N−1 link pairs to completely characterize the system (e.g., where L_{S} is the number sufficient links). In other words, once N−1 links are complete, the rest of the links may be completed by association. Thus, as N increases, a smaller portion of all existing links is sufficient to characterize the whole system. Said differently, the mutual linkage information (and often the mutual information as well) available in the system relative to the size of the system increases with the size of the system.

Links in the real world may be probabilistic entities which evolve in time based on new external information (e.g., generated by sensors or the like). This information may cause certain links to evolve while other links remain static. In the case of transitive links, it may be possible to determine the time-evolution of those links that were not evolved, by association (e.g., by transitivity, by mutual information, etc.). This association may then be corroborated or falsified by further external data at a later time, creating a feedback loop between the external information and the links. For example, information may be gathered that causes the links between data entities A and B and A and C to evolve. This information, however, may not cause the links between data entities B and C to directly evolve. In such a case, if transitivity applies, one can determine the evolution of the links between B and C.

On the other hand, rather than using this association to update links, the information may instead be used to corroborate or falsify links, such as by checking whether the likelihoods associated with links are within or outside the expected range. In reality, most if not all links may have an associated likelihood or probability of being accurate. In such a scenario, even if transitivity would apply in the non-probabilistic system, complete transitivity may only be estimated. The systems of the present disclosure, however, may be able to consider the likelihood of A←→B and A←→C being correct links, and then infer the expected likelihood of B←→C being true due to probabilistic transitivity and/or semi-transitivity. If this matches the likelihood independently computed by an example linkage engine (e.g., the processor 202 of the present disclosure) within a certain threshold then this corroborates this link. This may be generally used across all links to further verify or increase confidence in these links.

In the transitive or semi-transitive case, transitivity may be useful in the context of granularity resampling, downsampling, or upsampling. Resampling may then be used in conjunction with transitivity when linking data entities to increase probabilistic confidence in links. For example, consider data entity A with element A1 and data entity B with element B1. The example linkage engine may upsample A in order to link it to B, such that element A1 becomes elements A11, A12, and A13. In this case, more elements now exist in this upsampled data entity and hence more links. Each one of elements A11, A12, and A13 may have a particular probability of being linked with B1. Summing over these probabilities, the engine may compute the likelihood of the original element A1 being linked with B1. So, using resampling may address granularity in this way.

Additionally or alternatively, the linkage engine may infer a likelihood for both the link of A1 with B1, and the individual sub-links of A11, A12, and A13 with B1. In practice, these are unlikely to perfectly match such that summing over the probabilities assigned to A11, A12, and A13 equals that assigned to A1, but may match within a certain confidence value. Considering a third upsampling A111, A112, A113, A121, A122, A123, A131, A132, and A133 may produce further probabilities. It may thus be possible to cross-correlate all of these independently computed probabilities with each other to make sure they match within a reasonable confidence value. In this way, resampling of data entities may be used to corroborate or falsify attributed links, making the linkage and linkage engine more accurate and robust.

### Data Dependency

In some embodiments, data elements may have dependencies, both amongst data elements from the same data entity, and across data entities. These dependencies may be of different types and/or may be encoded in different ways, however they may be indicative of a relationship and/or a hierarchy between data elements. For example, BIM models and schedules may encode dependency data in different ways. In schedules, dependencies are sometimes made explicit by the users (e.g., task 2 is gated by task 1). Other times, it is implicit in how the human operator has laid out the schedule lines. For BIM models, element dependency is usually implicit and driven by real world constraints and/or physics (e.g., floor 2 cannot be built until floor 1 exists, however, parts of floor 2 could potentially be built on parts of floor 1). In addition, top down construction techniques may be employed. In this way, the dependencies may be based on what is physically possible and probable (e.g., it may technically be possible to build floor 2 before floor 1, with enough props, but it is not probable). Data dependencies may be used for every other technique and/or method in any embodiments of the present disclosure.

### Graphical Structure of Links

In some embodiments, links may be represented as data graphs, where vertices (e.g., nodes or the like) may represent elements within data entities, and edges may represent links between these elements. In this way, multiple sets and/or subsets may exist. For example, the set of vertices may be denoted V, and the set of edges may be denoted E. Within the set of vertices, subsets may exist that group every vertex according to its corresponding data entity: Vᵢ. Within the set of edges, subsets may exist that group every edge according to the two data entities that particular edge links: Eᵢⱼ. There may be an equivalence between Eᵢⱼ and the mapping and/or mapping functions described herein. In some embodiments, the sets described herein may be stored as adjacency lists and/or matrices that represent which data elements are linked to other data elements. With the addition of the subsets of the present disclosure, these adjacency lists and/or matrices may be structured according to data entities and/or data entity pairs. Further, linkages may be represented as undirected graphs (e.g., via the commutative property of linkage). These directed graphs may also be used to denote causal relationships and/or other kinds of relationships between linked data. In some embodiments, a data element may be linked to itself, such as to denote a relationship of an element with itself.

Continuous vs. Discrete Linkage

As used herein, a “hybrid discrete-continuous linkage” may refer to a linkage between discrete and continuous data elements. The linkage engine (e.g., the processor 202 or the like) may operate to link elements in a discrete or continuous fashion. Discrete links may be hard linked, self-contained, discrete bundles of data with each other (e.g., for an example BIM and schedule that would be the element with the schedule line). These may operate as the smallest unit of linkage in the information source of the present disclosure. In some embodiments, these discrete links may also have probabilities associated with them and/or probability density functions across the space of data elements.

In some embodiments, for some data types (e.g., data that represents an underlying continuous phenomena, such as BIMs), the system may take an infinitesimal approach by going from considering a ‘smallest unit of linkage’ Au to an ‘infinitesimal unit of linkage’ du. In this limit, one embodiment may operate to shift from discrete links to continuous links. In this mode, a smallest unit of linkage may not exist in that any fraction or bundle of a BIM element may be linked with any fraction or bundle of schedule line items. This may be represented as a continuous mapping function between the first source of information and the second source of information. Furthermore, these continuous linkages may also be probabilistic. For example, in the case of a linkage between a BIM model and a schedule, there may be a spatial probability density function describing the probability of any one point in space being linked with any given line item (and likewise, a temporal probability distribution function describing the probability of a set of points being linked at a given time. Another embodiment may consider a hybrid continuous to discrete linkages in which one information source may be subdivided into infinitesimals, but the other may not. For example, in the case of linkage between a batching record and a BIM Model. A batching record will typically represent a batch that is 7 cubic meters of concrete and may not be further subdivided (e.g., it is a smallest unit of linkage). The linkage engine may build a probability density function over space (where the probability of that batch existing at a location in space is represented on the BIM Model). The present disclosure contemplates that data entities may include any data sources described herein in the present disclosure. By way of a non-limiting example, data entities may include BIM data, schedules, device data, concrete QA records, concrete mix data, S-Data, M-Data, P-Data, and/or E-data.

### Linkage Examples

Many linkage possibilities exist (e.g., for N data entities to be linked, n (n−1)/2 links would need to be made (assuming symmetric links). In one example, six data entities may be linked including the BIM model, the schedule, the sensor identifiers, the cube data, the mix data, and the delivery tickets. In this example, there are 15 possible links that may be created, with 5 being sufficient to characterize the system if the links are transitive (e.g., N=6, L_{T}=15, and L_{S}=5). Hereinafter, each of the 15 possible links are described in different examples, noting that, in general, these links may be probabilistic, dynamical, and/or created using internal or external linkage. Further, although all 15 links are described by mutual information, it is likely that less than all 15 links are required, even under non-ideal conditions.

### BIM and Schedule

Linking BIM and Schedule may mean creating a correspondence between individual line items in a schedule and BIM elements in a BIM Model. This correspondence may denote different link relationships and/or digitally represented in multiple ways: a digital BIM entity which evolves over time; a digital correspondence between a BIM Model, and a schedule such that a user may (e.g., through a web or local application user interface) select on a schedule line and be redirected to the associated BIM element(s) that are part of the process the schedule line represents; a digital representation illustrating the spatial and/or temporal probability distribution described above with respect to continuous linkage. The above relationships may be extended to any conceivable way to associate one or more piece(s) of information relating the schedule to other pieces of information in the BIM.

Techniques regarding the combination of machine vision for recognizing elements and natural language processing (NLP) for parsing through schedule are described herein. For example, a vision-language model that may comprise image and text encoders and text encoders with transformer machine learning architectures to convert from one to the other may be employed. Techniques may include multimodal fusion, with cross attention or contrastive learning. The above may be further specified to BIM-Schedule models, using analogous learning architectures, with “BIM element encoders” and “schedule element encoders.” Such multimodal techniques may be extended to any conceivable combination of data entities to translate from the elements of one to the other. This acts as a solution to the coding problem as the transformer architecture may provide a mapping from one coding type to another. Further, techniques may include scraping through BIM metadata for element characterization.

As an example, a project may include two towers, a rectangular tower and a cylindrical tower. The engine may link a schedule item line such as “build floor 4 on the rectangular tower” with the corresponding BIM element(s). The NLP will be used to identify the object of the schedule line, namely “floor 4 of the rectangular tower.” The action is “build”, which the NLP will understand to mean “complete”. The vision-language model may have a notion of the visual characteristics of something described as “rectangular.” Computer vision will be used on the BIM Model. It may recognize geometries top down, so first it may recognize a “rectangular” characteristic and recognize the correct tower. It may then recognize the floors of the structure. Once it has been identified, the linking engine (e.g., the processor 202 or the like) may, with some confidence value, link the schedule line item with the correct geometrical structure in the BIM (e.g., floor 4 and every element contained in or making up floor 4). The engine may also alter granularity of either entity. For example, if the multi-modal model (e.g., a language-vision-element-schedule model) recognizes the floor is composed of 6 slabs, 4 facades and 4 columns, the engine may break down the schedule line into a logical sequence of building each individual part. Further, BIM metadata scraping alongside NLP for example may also be used if machine vision is not sufficient. In addition, scenarios with different levels of granularity may exist. For example, instead of a schedule line denoting the above, one may have a schedule line which denotes: “pour the first half of the south-west column connecting floor 4 and 5”. Despite the differing granularity, the systems of the present disclosure may leverage similar techniques to create linkage.

### BIM and Sensor

In some embodiments, creating a correspondence between BIM elements and sensor identifiers may denote different link relationships and/or digitally represented in multiple ways. For example, the representation may place the sensor identifier onto the BIM Model at its present location, may connect the sensor identifier to the elements it is monitoring, or may be extended to any conceivable way to associate one or more piece(s) of information relating to the BIM to other pieces of information relating to the sensor. The techniques may include sensor context awareness and any associated inference methods, including machine vision assisted inference (e.g., based on visuals generated from the BIM model), and/or NLP and language models (e.g., applied to the metadata contained within the BIM model). In a particular example, a sensor device may be mounted on concrete pour, monitoring the concrete's electromagnetic and acoustic spectra as it cures, with context awareness techniques built into the device. All the methods of the sensor context awareness of the present disclosure may be used to infer the element the sensor is monitoring. This applies to the linkage of any sensor with another data entity. Specific methods may include location tracking using satellite (e.g., GPS) to identify position of sensor on/in the building that then implies its location on the BIM Model. It is then likely that the adjacent/nearest element is the element the sensor is tracking. The sensor identifier is then linked to the element. The methods may further include using acoustic vibrations to capture the geometry of the element, which may be helpful to determine the element under consideration. In addition, if information regarding the concrete itself is available, the data gathered by sensors may be used to do mix fingerprinting and match to pre-existing concrete information.

### Sensor and Schedule

In another embodiment, the system may connect the sensor identifier to the relevant schedule line(s) wherein it is involved or associated. Sensor identifiers may include sensor location and any associated sensor data (e.g. power usage, sensor type, etc.). This may be extended to any conceivable way to associate one or more piece(s) of information relating to the schedule to other pieces of information relating to the sensor. The techniques used in this embodiment include sensor context awareness and any associated inference methods, including NLP inference/language models, mix fingerprinting. For example, a camera may be tracking the pouring and curing of the first part of a concrete airport runway. This process will have an associated schedule item. Granularity resampling may also be used. In this way, the sensor context awareness techniques of the present disclosure may be used to infer the element the sensor is monitoring and mix fingerprinting techniques may be able to infer which concrete was poured, when, and at what stage it may be cured.

In some embodiments, machine vision may be applied to the camera feed to recognize the process being carried out, such as the construction of an example airport runway. The system employing machine vision may recognize various parts of the process including temporary works installation, pouring, curing, and completion. For example, completion may be reached once something that looks like a runway is captured on the feed or when the next part of the runway begins construction. Such a system may also recognize from its (e.g., or any other camera's) feed that no other airport runway has been poured yet. It can thus be inferred this is the “first part” of airport runway to be built. Once this has been inferred, the NLP on the schedule line may parse for relevant language to describe the object and the action such as “first” or “first part” or “first part of the airport runway” or the first time “build airport runway” or “pour” is used on the schedule. For example, any language that may be associated with and/or used to denote the first part of the runway being constructed or poured, or curing may be identified. Once one or more matching schedule lines have been identified, the sensor identifier for the camera may be linked to them.

Using sensors embedded, directed at, and/or mounted on the pour, the system may be able to infer the time the concrete was poured, and when it completed curing, which may be related back to the schedule item line. For example, acoustics sensors may be used to infer when concrete was struck and formwork was removed. In addition, if the schedule line item refers to which concrete is being poured, mix fingerprinting techniques as described herein may be used to identify the mix (e.g., mix formulation as denoted by material identifier or the like) and relate it back to the schedule line item.

In some embodiments, the linkage techniques described herein may be completed using the aid of granularity resampling. For example, if the schedule for this project is very high level (e.g. “Pour runway concrete” but not “Pour concrete for part X of runway”), then the linkage engine (e.g., processor 202 or the like) may use information from other data entities to resample the schedule's granularity. For example, the linkage engine may access the BIM, which may break down the runway into individual poured elements and using that information, as well as internal causal logic, generates a breakdown of the schedule, with a line item for each of the elements needing to be poured. These automatically generated sub-elements may then be linked to the sensors. Such resampling, upsampling, downsampling or any similar granularity changing techniques may generally be used to aid in any linkage combination to contribute to any purpose or method described in the present disclosure. In addition, NLP may be used to identify sensors and link the sensors to associated identifiers.

### Cube Data and BIM

In another embodiment, creating a correspondence between BIM element and cube data may denote different link relationships and/or may be digitally represented in multiple ways. For instance, linking cube/cylinder crushing data and BIM may involve the association of such data with BIM elements pertaining to the particular batch from which the sample cubes have been taken. This may be extended to any conceivable way to associate one or more piece(s) of information relating to the BIM to other pieces of information relating to the cube/cylinder data. Such an embodiment may similarly employ the sensor context awareness and mix fingerprinting techniques described herein.

Using machine vision and other machine learning and/or deep learning algorithms to parse all possible element locations and associated element names from a BIM, the system may be able to link location information on a cube crush result to the location in the BIM model. The location information on a cube crush result may be generally extracted using document parsing machine learning technology that, for example, may read scanned handwritten documents containing information about the registered cubes and their cube crush results. Using machine vision and other machine learning algorithms to parse all possible element location and associated element names from a BIM model, the system described herein may create a cube registration system that is native to the system's software platform, and which contractors use to register their compliance cubes. The system may automatically suggest the most probable locations into which the concrete might be poured and allow the site engineer to select the true location (e.g., if ambiguous) from the subset chosen by the system.

In this way, the system may unify the location information across the BIM and concrete data and connect the cube crush results to the appropriate BIM element.

By using document parsing machine learning technology, the system's algorithms may extract the data from concrete delivery tickets and associate that information with the relevant cube crush data, using any linkable data between the two (e.g., such as a recorded delivery ticket). The BIM is then used to link the concrete delivery ticket to a location, making the chosen location connect to the cube crush results via the delivery ticket. A particular scenario may include a batch used for a pour on the first floor of a tower project. Associated cube crush tests may also have been conducted. The mix fingerprinting techniques described herein may also be used to identify the mix being poured and its strength gain profile. This data may be compared against the crush test results, normalizing for the variability between sample cube strength gain versus in-situ pour strength gain. Matching results may allow the engine (e.g., processor 202 or the like) to identify the batch in question (e.g., analyzing results at the 7 and 28 day marks). The sensor context awareness described herein may be used to infer the location of the pour and correct elements on BIM. Thus cube data and BIM elements may be linked.

Sensors throughout the concrete lifecycle i.e. in batching machinery, on the truck/in the drum, on site, in pump, on/in pour. Being able to track the concrete from batching to pouring, alongside pour location, will allow the system to ascertain where each batch has been poured on the BIM model. Using records from batching machinery/computers, the pour may thus be linked to the corresponding batching ID, and in this way, the cube data for the batch may be linked to the corresponding elements on the BIM. Sensors in the concrete truck (e.g., any transportation means) may also be used to detect any modifications made to the batch en route (e.g., adding water). The engine (e.g., processor 202 or the like) may use this information to differentiate between batches and may correlate truck arrival times with pouring times using data from the pump. This allows the system to correlate the pour with the batch. Further, the system may use “smart aggregates” or “smart dust” (i.e., sensing dust and/or miniaturized self-contained wireless sensor devices) that is placed in the concrete at batching. This may also allow the systems described herein to easily track the concrete from batching to pouring.

### Cube Data and Delivery Tickets

In another embodiment, creating a correspondence between cube data and delivery tickets may denote different link relationships and/or digitally represented in multiple ways. For instance, given a batch “B”, creating a correspondence between cube data and delivery tickets may mean associating the cube data relating to “batch B,” and the delivery ticket relating to the truck carrying that batch. This may be extended to any conceivable way to associate one or more piece(s) of information relating to the cube data to other pieces of information relating to the delivery ticket. In an example, NLP or text parser/interpreter or keyword comparison may be used on each of the cube data records and delivery tickets to match between batch IDs on each document and thus link the documents (optionally, after the documents have gone through an OCR process, if they are handwritten). Confidence may be increased by using these techniques to analyze edits to batches recorded on delivery tickets.

An NLP (e.g., a large language model) may be trained to understand statements such as “5% more water has been added to the batch in the truck” or any related statements. The engine (e.g. processor 202 or the like) may then be used to interpret the expectation of such a change on the strength gain profile and hence on the cube crush results (e.g. 5% water may slow down the strength gain). Thus, may be able to use this to increase confidence of the correct delivery ticket and cube data records being a match. Any other relevant keyword matches between the two documents may be used to link between them including date and time matching.

### Mix Data and Sensor

In another embodiment, creating a correspondence between mix data and sensor platform metadata may denote different link relationships and/or digitally represented in multiple ways. For instance, the linkage between mix data and sensors may mean connecting mix data pertaining to a particular mix and sensor identifiers monitoring that particular mix. This may be extended to any conceivable way to associate one or more piece(s) of information relating to the cube data to other pieces of information relating to the delivery ticket. In a particular scenario, two given mixes—Mix A and Mix B—may be used on a project. Mix A may be used for the substructure of the building and Mix B may be used for the superstructure. In this way, the system may use the techniques described herein relating to mix fingerprinting to differentiate between mix A and mix B (e.g., using multivariate analysis of concrete to extract signatures or patterns which map back to specific mixes). In this way, the system may identify which mix a given sensor is monitoring. In parallel, NLP may be used to parse through the mix data records to identify a match between the mix identified through the example mix fingerprinting operation and the mix detailed in records. For example, the parser may look for matches in the expected chemical composition provided by the mix fingerprinting technique and that listed in the records. It may attempt to match strength grading or other associated pieces of information from the mix data records. Once a match has been found which sits within the confidence intervals, the mix data records and the sensor identifier for the sensor monitoring the mix may be linked.

### BIM and Mix Data and Cube Data

In another embodiment, creating a correspondence between mix data records, cube data records, and the BIM model may denote different link relationships and/or digitally represented in multiple ways. For instance, mix data may relate to a particular concrete mix (e.g., mix formulation as denoted by material identifier or the like), cube data relates to a particular concrete batch, and the BIM may relate to particular building elements in space. Thus, elements, batches and mixes may be made to match by the systems described herein. Further, it may take the form of a two way digital connection between every element on the BIM, every mix data record, and every cube data Record. There are three links that may be established (e.g., since this is commutative BIM→Mix Data=Mix Data→BIM). Once these individual links are established, the system may create the complete link between the three data entities. BIM and mix data may be similar to the above explanation. BIM and Cube data may include the BIM element being associated with their corresponding cube data and BIM elements grouped by concrete batch. Mix data and cube data may include batches being associated with their corresponding mixes.

By way of example, batches A, B, C, and D each may have corresponding cube data records. Mixes 1 and Mixes 2 may have corresponding mix data records. A floor on the BIM may be broken up into 4 pours (I, II, III, IV). The system may link each of these data entities and data elements. The BIM and mix data may use mix fingerprinting and associated techniques, such as to identify the mix formulation for each of the pours in question. Using sensor context awareness and associated techniques, the system may identify the location of the pours in the project and map that back to the BIM elements. Further, using NLP, text/data parsing, keyword matching, and associated techniques, the system may determine a match between the identified mix and the mix data records, such as by mix formulation or classification, properties, ID, or other associated identification methods. Once a match has been determined with enough confidence, the system may link the mix data with the corresponding element on the BIM Model

For mix data and cube data, similar techniques used in cube data and delivery tickets may be employed here including parsing and interpreting text through each document to find associations, specifically regarding references, cube identifiers, mix name. In addition, expected strength gain profiles depending on mix data may be compared against cube data to find the cube data to which a mix belongs. Further, the system may parse through batch IDs to find corresponding mix IDs and match the date and time. Once a match has been established with enough confidence, mix data and cube data may be linked.

BIM and Schedule and Mix Data

In another embodiment, creating a correspondence between the BIM model, the schedule, and the mix data may denote different link relationships and/or digital representations in multiple ways. For example, a two way digital connection may exist between every element on the BIM, every item on the schedule, and every mix data entry, or may take the form of a time-evolving BIM in which each element within it has an accessible associated mix data record. The linking of BIM and schedule may include a given element on the BIM being linked to its corresponding action on the schedule line. The linking of BIM and mix data may include a given BIM element being categorized by its mix formulation (e.g., for concrete based elements), and thus linking to its corresponding mix data record. The schedule and mix data may include an event described by a given schedule line, which may be linked to its corresponding mix record, such that it is clear the action in the schedule line involves that mix.

In a particular scenario, there may be 4 pours on floor 2 of a tower (e.g., square cross-sectional shape) in a BIM Model: Pour I, Pour II, Pour III, Pour IV; 2 schedule lines: “pour west side of floor 2” and “pour east side of floor”; and 1 Mix used on this floor: Mix A, with associated mix data. The linking of MIM and schedule and the linking of BIM and mix data are described above. The linking of schedule and mix data may include parsing through pour layout documents using a mix of NLP and/or machine vision. Machine vision may allow the engine to identify each pour's location in the tower. If these operations are insufficient, the engine (e.g., processor 202 or the like) may use the BIM to match elements with pours on the pour layout. NLP may be used to interpret any language in the document. For example, the layout may be labeled by floors such that the system may analyze the document to identify the term “floor”. In these ways the engine may identify the 4 pours on floor 2. Pour layout documents may also include labeled pours by mix type or formulation. The NLP may be trained to identify and interpret such language and match it to the relevant pours. Thus, the NLP may identify the 4 pours on floor 2, and match them all to Mix A.

Further, the NLP may parse through the schedule to find matching schedule lines to the above. Search for relevant keywords, such as “floor 2,” “pour,” “Mix A,” etc., may occur. Once keywords are identified, the NLP may interpret the schedule lines. In this case, the engine may understand what “east side” and “west side” mean to match the schedule lines to the correct pours and hence the correct mixes. Data describing the NWSE orientation of the tower may be present in the BIM, may be collected from sensors on site (e.g., geomagnetic sensors or the like), or may be found using the techniques described in the sensor context awareness of the present disclosure. Once this data is determined and given the engine's understanding of the meaning of “east side” and “west side”, the system may link the schedule lines with their corresponding pours, and hence the corresponding mix data records. The techniques described herein relating to pour design and sequencing may facilitate this process as the generated schedule may already be associated with the pour layout and mix designs for the project.

### BIM and Schedule and Sensor and Cube Data and Mix Data and Delivery Tickets

Creating a correspondence (e.g., one or more links) between the BIM, the schedule, the sensor(s), cube data, mix data, and delivery tickets may denote different link relationships and/or digitally represented in multiple ways. For instance, the correspondence may take the form of a two way digital connection between every element of every data source described herein. In another instance, it may take the form of a time-evolving BIM with sensor identifiers located on the model. Further, BIM elements may be classified by batch (e.g., with associated cube data), mix (e.g., with associated mix data), and/or truck delivery (e.g., with associated delivery tickets). An alternative embodiment may take the form of each individual entity being augmented with a digital connection to any of the other relevant associated entities. One example of a visualization or aggregation of the above data (that is generated by the embodiments described herein) may be the automated generation of a concrete reconciliation report. This report may contain all volumes of concrete that have been poured, and the associated BIM locations into which those pours occurred. Such a visualization may link each of those volumes of pours to all delivery trucks that poured the concrete, and to all compliance cube crush results. Such a visualization also automatically calculates the quality assurance analyses that are based on the associated cube crush results, ensuring the compliance of all aspects of the structure. The linking of BIM and schedule, BIM and sensor, BIM and cube data, BIM and mix data, schedule and sensor, schedule and mix data, sensor and mix data, cube data and mix data, and cube data and delivery tickets are described above.

The BIM and delivery tickets may include any given BIM element that may be connected to the delivery ticket of the truck that brought the raw materials from which the element is made. The schedule and cube data may include the event and/or process described by a given schedule line may be linked to its corresponding cube data record. As such, “corresponding” in this context may be defined as the cube data relating to the batch involved in the event described by the schedule line. The schedule and delivery tickets may include the description of a given schedule line that will be linked to its corresponding delivery ticket. As such “corresponding” in this context may be defined as being the delivery ticket from the truck carrying the material involved in the event described by the schedule line. Alternatively, the delivery ticket may be connected to the schedule by being placed in the schedule at the time of delivery. The sensor and cube data may include the sensor identifier of the sensor monitoring material from a given batch, which will be linked with the cube data for that corresponding batch. The sensor and delivery tickets may include the sensor identifier of the sensor monitoring material from a given truck delivery will be linked with the delivery ticket for that corresponding truck. The mix data and delivery tickets may include a given mix data record, which will be linked with delivery tickets from trucks delivering that particular mix. The above examples are illustrative and these techniques may be extended to any conceivable way to associate one or more piece(s) of information relating the BIM, to other pieces of information relating to the schedule, to other pieces of information relating to the sensor, to other pieces of information relating to cube data, to other pieces of information relating to mix data, to other pieces of information relating to delivery tickets.

By way of non-limiting example, the linking of BIM and delivery tickets may include tracking using sensors, NLP, machine vision, sensor context awareness techniques, mix fingerprinting techniques, and/or the like. The linking of schedule and cube data may include time correlation, NLP/LLM, text/data parsing and interpreting, status inference techniques, event and event sequence analysis, machinery records analysis, and/or keyword matching. The linking of schedule and delivery tickets may include time correlation, NLP/LLM, text/data parsing and interpreting, status inference, event and event sequence analysis, and/or keyword matching. The linking of sensor and cube data may include mix fingerprinting, multivariate sensor tracking, text/data parsing, and/or NLP. The linking of the sensor and delivery tickets may include time correlation, mix fingerprinting, NLP, text/data parsing, sensor tracking. The linking of the mix data and delivery tickets may include NLP, text/data parsing and interpreting, and/or keyword matching.

In a particular example, the BIM may include 4 pours on floor 2 of a tower (e.g., square cross-sectional shape) in a BIM Model-Pour I, Pour II, Pour III, Pour IV. The schedule may include 2 schedule lines: “pour west side of floor 2” and “pour east side of floor 2.” The sensor may include one multivariate sensor installed per pour (e.g., 4 sensors for 4 pours). The cube data may include 4 batches (e.g., A, B, C and D) each have corresponding cube data records each used for one of the pours. The mix data may include 1 mix formulation used on this floor (e.g., Mix M) with associated mix data. The delivery ticket may include data indicating that batches were brought in using 2 trucks (e.g., Truck T and Truck S) each with a corresponding delivery ticket.

The method for the BIM and delivery tickets may include sensor context awareness and associated methods to determine where pours are located, and match that to the relevant BIM elements, and “Smart Aggregate” or “Smart Dust” in the material to track the material from the truck (e.g., such that the system may know the corresponding delivery ticket) to the pour. Tracking may be done using other methods as well, for example using cameras or other sensors that keep monitoring the truck until pouring (e.g., sensors in the pump, sensors in the drum, etc.). Mix fingerprinting techniques may also be used to identify the mix in the truck and the mix in the pour and match the two. NLP or other associated methods on delivery tickets may be used to identify mix ID. Sensor context awareness may be used for location of pour and corresponding BIM element (e.g., to link BIM element to delivery ticket). Further, the system may correlate time on the delivery ticket with pouring time from pump, or other associated sensors. This can then be related back to the BIM element using sensor context awareness. Thus, the system can link delivery ticket with BIM.

The method for linking the schedule and delivery tickets may include NLP on both the schedule and delivery tickets to understand information for both documents. Time correlation between when something is happening on schedule (e.g., when is “pour west side of floor” and “pour east side of floor” happening) and when truck has delivered material, to match event time with time of truck delivery. The system may account for delays from schedule, such as via sensors monitoring the pour, and/or metadata from the pump, and may link the schedule line item to the delivery ticket. Further, the method may use status inference techniques as described herein to track statuses related to the material from the truck to pouring (e.g., the material has been delivered to the material has been poured). Thus, the engine (e.g., the processor 202 or the like) may determine which delivery to match with which pour and may use NLP to analyze the schedule and find the corresponding pour. Once a match has been determined, the system may link the delivery ticket to the schedule line. Further, the method may track concrete from delivery to pouring using the inference engine (e.g., processor 202 or the like) to infer what events have occurred. Then the NLP/LLM Model takes events that have been inferred and parses through the schedule to find schedule lines that describe each event. Once a match has been found with high enough confidence, then the engine may link that schedule line with the delivery ticket.

The method for linking the schedule and the cube data may include delivery tickets and batch ID. If so, the techniques described above may be replicated, followed by parsing delivery tickets to determine batch ID. Then the engine (e.g., processor 202 or the like) may parse the cube data to find the corresponding batch ID so as to link cube data with correct batch ID to schedule line. Further, the method may time correlate expected truck arrival time, actual truck arrival time, and truck departure from factory. The system may use batching machine records to determine which batch has been loaded onto the truck and correlate this data the corresponding schedule line in methods described above to link schedule lines with cube data. The method for linking sensor and cube data may include mix fingerprinting techniques as described herein to identify the material in the pour and compare that against strength profile from parsed cube data (e.g., via NLP or simple parser). If a match is determined, then the sensor may be determined to be monitoring that batch, thereby linking a sensor identifier with cube data. The method may further include tracking throughout the concrete lifecycle using smart dust, a chemical tracer, cameras, or sensor tags/beacons such that the engine can determine which sensor is monitoring which batch, thereby linking a sensor identifier to a corresponding batch.

The method of linking sensor and delivery tickets may include NLP on delivery tickets to search for keywords and interpret which mix and/or batch has been delivered. Sensor mix fingerprinting techniques may be used to identify the mix, and timestamps may be used to time-correlate pour and delivery. Thus, once pour mix and delivery mix, and pour time and delivery time are all matched, the method may link a sensor identifier with a delivery ticket. The methods for linking mix data and delivery tickets may include NLP on delivery tickets to determine mix ID and match that to mix data records with the corresponding mix ID, thereby linking mix data records with corresponding delivery tickets.

### Other Linkage Examples

One example of linkage includes the registration of devices (e.g., sensor devices or the like) so as to create a digital representation of the respective device (e.g., on a server, as part of a database, etc.) and create a link between the device and its newly created digital representation (e.g., also referred to as a physical link). In some embodiments, the system described herein may register devices semi-automatically using a mobile app (e.g., accessed from an internet connected smartphone) or a web-app (e.g., access from a personal device). In some embodiments, the system described herein may register devices fully automatically once the device is activated, based on data available to the device and about the device. In some embodiments, the device may be registered through manual input of an identification (e.g., device identifier or the like), a aa quick response (Q)R code, a radio frequency (RF) based tag (e.g., via BLE, NRF, proximity, etc.), upon device activation through message and prompting a user, and/or the like. In some embodiments, the device registration may be fully automatic which may include device activation triggering device registration on the system and/or various levels of inference from device data and other data to name or link the device to other data elements or data entities known to the system.

Linking a physical device to a digital representation of that device may require a unique way of identifying the physical device. In practice, devices have, are given, or generate unique identifiers. For example, such an identifier may be hardcoded in hardware (e.g., in non-volatile read-only memory (e.g., ROM or EEPROM) or stored in volatile memory such as flash or cache). ROM is often programmed during the manufacturing process and cannot be changed. EEPROM may be changed but is often locked to prevent changes. These unique identifiers may also be embedded into the firmware for the device. Storage in flash memory or cache would make them volatile and prone to erasure (e.g., with possible mitigations, such as backup power sources to ensure uninterrupted power to flash memory).

Unique identifiers may also be generated from one or more physical parameters of the device (e.g., some which may be readable using the electronics and/or sensors onboard). Provided such physical parameters are constant, such a unique identifier may be regenerated dynamically by the device. In such an embodiment, this process may include the use of physical unclonable functions (PUFs) that are circuits designed to make use of the physical variabilities in silicon chips to produce unique responses. Alternatively, the combination of the signature of multiple components may be used to create an identification and/or fingerprint for the device. Such a process also provides the advantage of being resistant to tampering.

Unique IDs may also be laser etched or burned into memory through a burn-in process. The unique device identifiers (Device ID or ID) may have a predefined format and may be generated by a unique ID generation algorithm. These IDs may be locally unique, or globally unique. Generally, longer IDs, or IDs that contain more character types will be more likely to be unique and avoid ID collision. In the case of ID collision, the systems described herein may be able to intelligently deduplicate and route and/or link messages from each device to the correct digital entity, such as based on timestamps, IP addresses, and/or other information. In some embodiments, devices may have a plurality of components, and each of these components may have its own unique ID. These may be searchable (e.g., via query) by a processor of the device so as to provide a potential avenue for dealing with the primary ID collision. Alternatively, device contextual conditions or knowledge about the device's properties may be used.

In some embodiments, registering a device may be functionally equivalent to creating a new entry in the server's device records database and creates a link between the device ID and the device name. Optionally, the server may also create its own unique identifier and associate it to the device ID and device name. Such an implementation may be used when the server receives data from many different types of devices, some of which may have inconsistent device identifier format. This Server-Side Unique Identifier (SSUID) may be generated based on the device ID and its type (e.g. MATURITY-123 for a maturity sensor with unique ID 123). It may also be generated based on the device ID, the date of registration (e.g. 2022 Oct. 10-123, or any equivalent in different representations, such as Hex etc.), and the unique device ID of the sensor to which it is registered. Such an implementation may be useful if devices are to be reused in different contexts, and re-registered (e.g., a node which may be reused with many different sensor probes). In such a context, device registration may be functionally similar to updating the link between the device unique ID from one SSUID to another. Said differently, this process may operate to associate a node or a hub to one sensor, and then disconnect the sensor and connect that node to a second sensor. The SSUID may therefore be updated based on device contextual conditions (e.g., and its peripherals). Tracking the linkages between Device IDs (DID) and SSUIDs provides a full history of the sensor to which the was connected. SSUIDs may be based on any device or material contextual conditions, which may aid in further tasks carried out thereafter.

ID Manually Inputted into Smartphone

In some embodiments, the system described herein may include an embedded concrete sensor (e.g., embedded at least partially within a cementitious mixture). In such an embodiment, the device may include an identifier (ID) visible on its enclosure (e.g., etched, printed, or otherwise). The ID may be alphanumeric or contain any number of other characters or numbers. In such an embodiment, a user may be provided with access to a web or mobile application, and the user may be securely authenticated to its organization's digital environment (e.g., a jobsite owned by its organization). The personal device may be internet connected through cellular (although in other embodiments, alternative backhaul options may be used to connect to the internet, such as satellite or Wi-Fi). In an embodiment in which internet connectivity is absent, the system may rely upon partial access to network connectivity, such as via smart caching and a decentralized management of information. Such a web or mobile application may, for example, allow the user to select the correct jobsite (e.g., a list of job sites that exist within its organization's environment). To deal with instances in which network connectivity is absent or intermittent, these jobsites may be pre-cached.

Within the example jobsite, the user may be able to see a list of pours. These pours may have been created by the user, or they may have been generated (e.g., based on the BIM model, and leveraging pour design and sequencing to slice that BIM at a particular level of granularity). Pours may be imported or created through another user interface. During pour creation, there may be an optional linkage step to generate a link between the pour and the mix identifier (as defined herein with reference to mix fingerprinting and mix optimization). This step may be done by the user, such as by selecting the relevant mix formulation from a list of pre-existing mixes permissioned to their digital environment. This may include a list of maturity calibrations made available for such mixes.

The user may then be able to register a sensor by accessing a flow that allows the user to select the desired pour (e.g., for association purposes) from the pre-existing list of pours, to provide a name for the new sensor, and enter the unique ID of that device. Additionally or alternatively, the flow may also query the user to confirm the mix (e.g., inferred from the pour), the time of sensor installation (e.g., when the sensor was installed on the rebar or in the pour), and the time at which the sensor may have been covered in concrete. These data may also be inferred from the device data or other models described herein (e.g., status inference, sensor context awareness).

Registration may further create the linkage record in the device database server-side (e.g., linking the device ID with the device name and the pour, and optionally a server side ID), but also optionally creates a record device-side and stores relevant information from the service on the device (e.g., the device name, the pour name, security keys or token, etc.). This may involve a device configuration step where other settings are set on the device (e.g. automatically based on any detected contextual conditions). Optionally, the device name or other properties may be updatable over time (e.g., stored server-side and/or device side). The user interface may be enhanced by auto-selecting pours and/or narrowing the pre-existing list of possible pours based on contextual conditions or leveraging the outputs of the sensor context awareness techniques described herein.

### QR-Code Based Device Registration

Additionally or alternatively, in some embodiments, one or more QR codes may be placed on the device to replace the manual ID entry stage. Such a QR code may be produced during manufacturing to match the unique Device ID. In such an embodiment, the linkage operations will occur substantially the same as those above without the need for manual entry of the device ID by an associated user. The use of QR codes to create linkages between devices and the system, and other physical resources on the jobsite, may extend beyond sensor registration. For example, QR codes on a concrete pump and on the formwork would enable linkage between these entities ultimately enabling full traceability and a data passport for the pour.

### Communication-Based Device Registration

In some embodiments, the device's unique ID may be accessed through a communication protocol such as via wireless protocol (e.g., BLE or the like), the use of a camera on the mobile device and LED patterns on the device to create an association, or through the use of sound and a microphone. Some of these techniques would enable device advertisement (e.g. via BLE or the like) and others leverage device proximity (e.g., NFC or the like). Through the use of these communications-based techniques, the device may either be found, or trigger the appearance of a particular user interface on the mobile application and/or web application. Additionally or alternatively the ID entry step may be automated (e.g., without the need for printing a physical QR code). Devices may also communicate with nearby devices to infer further information which may aid in auto-naming them. In an instance in which there are multiple devices in proximity of the personal device used for registration, various algorithms may be employed to select which of the provided devices are to be displayed on the user's device. For example, relative signal strength may be used to determine which of the devices to illustrate (e.g., the device with the higher signal strength may be provided). Additionally or alternatively, a list of devices may appear, and the user may be prompted to select one based on some parameters. In an instance in which the device is embedded in concrete, some of these techniques may also provide the advantage of allowing for registration to happen after embedding (e.g., when the device is no longer visible).

### Auto-Registration on Activation

In the case where the device is able to connect to the internet (e.g. because it has its own network module, or because it can piggy-back off another nearby device's internet connection), device activation may trigger the creation of a new record automatically in the device record database, optionally with an associated SSUID, and a placeholder name and placeholder association and/or linkage into the most likely pour. Additionally or alternatively, this operation may then trigger, on next access of the particular jobsite, a prompt to be displayed that asks the user to confirm the linkage (e.g. ‘please confirm sensor name and pour’-sensor name: Sensor 1; Pour: Pour 1 NE Floor 1).

### Image/Video and Physical Input Based Linkage

In another example, the device may be installed in the pour (e.g. embedded onto the rebar), and a user may take a photo and/or video of the device attached to the rebar or otherwise installed in the pour. The sensor context awareness techniques described herein may be used to infer which pour the device has been installed in, a contextually appropriate name is generated (e.g., using a language model), and the unique ID is linked to the relevant pour and name.

In some embodiments, the device may be configured to receive a physical input, such as via a multi-touch screen or buttons of the device. Additionally or alternatively, the device may include sensors that are able to detect particular user actions. Linkage of the unique device ID may be achieved by actuating the device, such as via pressing a button, shaking the device (e.g., using inertial sensor data), covering the device (e.g., covering a light sensor), rotating the device, and/or removing a magnetic activation card. The present disclosure that any physical action that may be detectable by the device may be used to activate and/or link the device. As would be evident to one of ordinary skill in the art in light of the present disclosure, any of the semi-automated embodiments described herein may be extended to encompass fully automated device registration.

### Internet-Connected and Non-Connected Device Registration

An internet connected device may, upon activation, communicate with the server to create a new record in the device record database, and communicate its DUID. Additionally or alternatively, the user may be notified through a user interface of the automatic registration of that device. In the case of a device that is not directly connected to the internet, the device may be able to make use of a nearby device (e.g. sensor devices to communication devices, or to personal devices). A distributed system of devices may similarly be able to achieve registration and persistent linkage data across the distributed network. As soon as one of the devices in the distributed network is able to access the internet, server side synchronization may occur, ensuring that server side records are updated, and device side records may also be updated based on any changes made by the user that have persisted on the server. If there are conflicting changes, the device may smartly manage these, or alternatively prompt the user to help resolve the conflict. These techniques may be applicable to a network of sensors associated with concrete (e.g., embedded in a pour, in the drum of a concrete truck, etc.) that communicate with any of the communication methods described herein.

### Contextual Auto-Registration

Through the use of the models and methods described in the sensor context awareness of the present disclosure, the system may automatically generate platform-side data for the device. This includes a name for the device, such as by using a language model, prompted on the basis of the device contextual conditions. Through the use of the linkage model and context awareness, the system may infer the pour that the device is considering and establish links between the DUID or SUID, the name of the device, and the pour. For example, by inferring device location, the system may determine the associated pour (e.g., upsampling and/or downsampling the BIM to the appropriate level of granularity), which fully links the device ID to its name and pour. Contextual registration may utilize sensor data or construction data sources (e.g., BIM models, other documents and records as further described herein). Documents more generally may provide other forms of context and may be fed into language models for analysis as described herein.

### Bundles

In some embodiments, multiple devices may be bundled together during registration or activation. As such, the systems described herein may include a modular sensor system formed of a single smart sensing device (e.g., a micro-control unit (MCU), power management device(s), radio, and/or sensor interfaces in a self-contained device), that also has the ability to interface with tails (e.g., a cable assembly made up of multiple sensors or actuators of different types).

In an instance in which the device bundles are registered, each of the devices in the bundle may have its own ID or QR code and in the case of tails, there may be a QR code for the overall tail, or a QR code for each probe on the tail. These QR codes may be scanned by a smartphone or other personal device to create a link or association between each device in the bundle that is then stored server side and/or optionally stored on the device. The unique ID of each device in the bundle is then stored (e.g., as a JSON or XML file describing the bundle) and linked with a device name using any of the techniques or user interface flows described herein. An SSUID may be generated for each device in the bundle, or it may be generated for the overall bundle (or both). The SSUID of the bundle may be associated with the JSON/XML described above.

In the case of a QR code for a tail, such a QR code may include data relating to its constituent probes (e.g., the number of sensors or actuators, their type, their ordering, their distance, etc.). Alternative methods of communication (e.g., those described above) may communicate this bundle, which may be stored in the tail, or on the device or elsewhere. Alternatively, the configuration of the tail may be detected electronically by the sensor body. Various techniques may be employed to detect the ordering and type of probes (e.g., time delays of signals sent through the cable assembly, impedance measurement, and/or signal amplitude attenuation for each probe response). The distance between probes may also be established electronically by the device.

One embodiment of a tail is designated a multi-probe thermal tail which includes multiple temperature probes along a wire (e.g., in a star or daisy chain configuration). In one embodiment these communicate over a single wire and are able to electronically detect ordering. On registration, if a probe is connected, the user interface may prompt the user that a probe has been connected, and automatically provide the relevant number of fields required to name the data streams coming from each probe so as to create a digital representation for each probe. The user may then be prompted to input a name for each probe. A default name may be provided based on the ordering of the probes. In some embodiments, the name may also be autogenerated using the techniques described above. Likewise, the pour(s) in which each of the sensor device and its probes may be inferred using sensor context awareness techniques and the link established and stored. Bundles may be hard-wired (e.g., through a connector) or communicate wirelessly, such as with any other communication technique described herein, including optics and acoustics.

### Linking Multiple Sensor Streams

In some embodiments, multiple sensor streams may also be linked together. These may originate from a bundle as described above or from a plurality of devices. In one embodiment, an embedded concrete sensor device (e.g., to be attached or wrapped onto the rebar) is connected to a multi-probe thermal tail with N temperature tails to create a bundle. That bundle may be registered and create a linkage between each temperature probe, including the temperature sensor on the body. The ordering of the probe may be determined by the platform and/or device. Additionally or alternatively, the distance between each probe may be determined (e.g., through impedance attenuation measurements on the electronic signal to a digital temperature sensor). The probes may be linked to the relevant pours.

Through the linkage of the temperature data streams, a differential may be generated for each pour. A legend may be created for each differential line based on the name of each probe stream. Additionally, the systems of the present disclosure may include this data alongside the models in the mix optimization models described herein to generate a three dimensional thermal prediction for the performance of the pour over time. Alerts may be set based on the temperature difference. Temperature differences may also be predicted, such as via a machine learning model, and alerts may be triggered if the predicted temperature is expected to reach above a certain threshold, where such temperature may, for example, be automatically inferred from a specification. Automated linkage of multiple sensor streams may span a plurality of devices from the same bundle or otherwise. These multiple sensor streams may also be in one or multiple pours, across one or multiple jobsites, batching plants, kilns, and/or the like. These linkages may be dynamically updated as device contextual conditions change, such as if a non-embedded device is moved away from an embedded device.

This linkage may enable computation of various characteristics of materials or the environment that also may depend on the link relationship. Links in this context may, for example, be spatial or temporal. Sensors or devices may be spatially collocated or in proximity of each other, or contemporaneously activated in time, or a combination of both, and any other potential variable output from any of the models of the present disclosure. Another example may include the temperature-correction of an impedance measurement based on a linked temperature measurement. The linkage enables comparability in the data.

### Dynamic Device Reassignment

In some embodiments, device links (e.g. between a communication hub and a sensor device, or between a communication hub and a site, or a communication hub and organization) may be dynamically updated. In particular, the system described herein contemplates that devices may be assigned to jobsites (e.g., a digital environment for a jobsite) and/or organizations (e.g., a digital environment for an organization that may have many jobsites). This assignment may be done through the registration methods described herein, including automatic assignment. The systems described herein may include this assignment and may automatically update as device contextual conditions change. For example, if a signal is moved to a different physical jobsite, based on its GPS location, the system may reassign the device to another jobsite and/or organization (e.g., subject to permissioning and authorization systems that manage access control). In an example in which a device has been registered by a user using a smartphone, that is logged in to their account, which is permissioned to their jobsite and organization, the identifiers for the jobsite and the organization (and optionally security keys) may be stored on the device. Another device in proximity of that device (e.g. a hub installed in proximity of a sensor which was registered using a smartphone) may be able to read those data, and infer its jobsite and organization, ensuring that it updates its links based on nearby physical devices. This may be restricted to a given organization in various ways (e.g., settings communicated by the server). Registration establishes the first link between the DID and its name, jobsite, organization, pour etc. Automated and/or dynamic reassignment updates those links may be required based on device contextual conditions and the use of inference models.

### Smart Device ID Collision Management

In some embodiments, devices may be provided by disparate sources and be of disparate types (e.g., third party devices, devices that leverage third party components, etc.). In addition, device IDs may not be unique, particularly over a sufficiently large sample of devices. This situation results in the possibility of device ID collision that may result in erroneous data linkages. In some embodiments, the system described herein may include a smart collision management system (e.g., operations executed by the processor 202 or the like). The system may have control over the uniqueness of SSUIDs. Through the use of the sensor context awareness models, status inference models, and/or other models described herein, the system is able to deduplicate ID collision. For example, the systems of the present disclosure may include generating a behavioral signature (e.g., device fingerprint) for each device, such as via a machine learning model that considers the device's historical performance and also the environment it is considering. The same principles described in the mix fingerprinting techniques of the present disclosure may also be applied to device identification. Additionally or alternatively, the device may include a PUF as described above. In addition to sensor context awareness insights and behavioral signatures, other data may be used to disaggregate the data (e.g., DID's of subcomponents of the system) and ensure that data packets received from two devices with the same DID are linked to the correct SSUID (or in the more general case, to the correct data entity/data element). Additionally or alternatively, this may require a physical action on at least one of the device to uniquely identify it and differentiate it from the other device.

### Creating and Linking a Pour to a Mix

In some embodiments, pours may be linked to mixes during pour creation. This may be done through a user interface made available to the user on a web application or a mobile application, that allows the user to create or select a pour (e.g., from scratch, from a pre-existing list of pours, etc.). Upon creation of the pour, the user may then be prompted to select the mix name (e.g., from a pre-existing database of mixes) or create a new mix and/or upload mix data (e.g., a mix name and optionally maturity calibration data or enhanced maturity calibration data). In another embodiment, the pour may be created automatically based on sensor data, sensor context awareness outputs, and/or the pour design and sequencing outputs. The mix may be selected manually by the user. A linkage may be established between the pour and the mix formulation. In a further embodiment, the mix may be selected automatically based on sensor data, sensor context awareness outputs, or based on the outputs of the mix fingerprinting model(s). Alternatively, the space of possible mixes may be narrowed (e.g. to a small number of options) based on mix fingerprinting and/or sensor context awareness techniques, and the user is asked to choose. The linkage may be subsequently established. In yet a further embodiment, the user may be asked to upload a mix design. Using the mix optimization models described herein, the material properties of the mix may be predicted, including calibration data for the mix (e.g., strength over 28 days for contextual conditions=cube or cylinder strength kept at twenty degrees). That mix design may then be linked to the pour. In a further embodiment, the mix may be selected or inferred based on prior mixes for similar pours (e.g., similarly named, similar geometries, similar because they were on the same jobsite on the floor below, etc.), and the linkage between the pour and the mix may be established.

In a further embodiment, a pre-existing mix library may be made available by a third party (e.g., who provides access to an access control system or permissioning system). Additionally, the third party may have access to a different view that allows the third party to decide which mixes and associated mix data to make available to the user. The third party may be a ready mixer, concrete supplier, and/or a precast lab. The user may then be able to choose from a predetermined library of mixes that have been made available to it by its supplier (or possibly by multiple suppliers). The user selects the mix, and the linkage is created. In an additional embodiment, the delivery ticket or another similar record may be ingested, and the mix identifier may be derived from the delivery ticket. The mix for that pour is selected based on such records, and the linkage is established. Such a linkage may be valuable in the context of the maturity method, the choice of the relevant calibration may be critical to ensure accurate results.

### Linking a Device to a BIM Element

In some embodiments, the system described herein may consider the linkage of concrete sensors to the BIM model as a way to position and identify the location of a device. In the context of linkage, this determination may refer to a discrete to continuous link that establishes a spatial probability distribution function for the location of the sensor device on or in the element. This link may automatically be established based on the methods described in context awareness.

This link may also be established by a user through a personal device (e.g., a smartphone), by positioning a pin on a BIM element (e.g., on the part of the rebar as detailed in the BIM model on which the sensor has been installed), and/or by creating a link between the BIM and the sensor device by selecting the relevant device's identifier (e.g., name, SSUID, DID or otherwise) and selecting the element. To aid in navigation, this may include grouping of the BIM model into subgroups (e.g., floors) and isolation of particular features of the BIM model, as well as the capability to control the view (move, rotate, zoom etc.) during the linking action. A proposed linkage and/or positioning may also be proposed through the UI for user confirmation based on sensor context awareness data. The upsampling and downsampling methods described herein may also be used to create more granular or less granular views for linkage. The granularity may also be determined based on a pour layout provided to the system (e.g., a pour layout generated from the pour design and sequencing methods described herein). The UI for linkage may allow the user to input a specific location (e.g. gridlines or another spatial reference system, a 3D reference system, etc.) which would then create a marker for the user and optionally isolate the relevant part of the BIM model. Alternatively, linkage may be performed through language-based descriptions. This may include a chat-bot like interface where the user describes where the sensor device was installed, and the relevant linkage is the derived (e.g., and approved by a user). This type of linkage mechanism may be used for data sources beyond a sensor device and a BIM model.

### Frameworks for Linkage

A first framework for linkage may include a standardization step implemented by a standardization engine (SE) followed by a linkage step implemented by a linkage engine (LE). Although described hereinafter with reference to particular engines, the present disclosure contemplates that any of the circuitry components described with reference to FIG. 3 or otherwise (e.g., processor 202 or the like) may perform the operations described herein. Standardization may address the coding problem, granularity problem, inconsistency problem, completeness problem and modality problems by converting any raw data entity into a standardized format. Such a standardized format may then allow for direct linkage by associating the relevant data elements to each other. The techniques and framework described below for standardization and linkage describe the process for BIMs, schedules, and sensor platform meta-data in detail, but may be used for any linkage combination of any other data entities. In some embodiments, standardization inputs may include raw BIM, raw schedule, sensor information, raw miscellaneous construction data. In some embodiments, standardization outputs may include standard BIM, standard schedule, standard sensor data, standard miscellaneous construction data.

In order for the Linkage Engine (LE) to function, the system may ensure all BIMs, schedules, and sensor data read into the LE will be capable of being connected. The linkage is intended to align information coming in regardless of provenance and ensure viability of the two-way transfer of information between one of three types of data (e.g., BIM, Schedule, Sensor), which in an information theory paradigm aims to maximize the mutual information associated with the system. Since there isn't a universally adopted standard for BIM or schedules, the system may identify or define a standard format for all three sources of input. The example standardization engine may therefore ingest any form of BIM, schedule, or sensor.

In some embodiments, a Type I-BIM Standard Engine may check for standards compliance that implies adherence to a data schema that is defined a priori, enabling the linkage engine to parse the first BIM data ingredient. A standards compliant data schema may deliver information with an inheritance structure that reflects the hierarchy to the extent deemed required (e.g., element id, element type, element coordinates in the floor, floor level, building, site, geographical location, etc.). When the incoming data is non-compliant with respect to the standard, a key decision point is to evaluate the level of BIM. For incompatible inputs such as 2D drawings, software and AI-based algorithms may be invoked to extract 3D structure from 2D BIM. For labelled 3D BIMs, pre-existing meta-data, if any, will be mined and, via NLP may be converted to the standard schema. For unlabeled 3D BIM, the atomic level of the drawing may be evaluated against the expected element types. Element identification, and its relative location in the structure may be addressed as a network/graph identification problem, where construction of the adjacency matrix becomes a useful intermediate outcome in this step. On this basis, labels may be interpreted, and the primary outcome of this step may be a labelled 3D BIM that prepares the system for conversion to the standard schema.

For coarse BIM, depending on the extent of detail accessible, computer vision and machine learning algorithms may be used to interpret elements from the coarse structure. A vision based identification tool using a supervised learning model may be deployed to interpret element types within a shaped volume. For very coarse models (e.g., primitives, cube, cuboid, sphere, etc.) the system may use a construction or architecturally relevant generative approach to ingest primitives and essential textual prompts (e.g., basement, floor level, etc.) from a manifest or a schedule. The model will generate element types within the confines of the primitive. Checksums may be used to avoid issues when diffusion models are not confined.

In some embodiments, a Bayesian approach may be appropriate given the finite structures involved, and the connectivity requirements. A quantifiable likelihood measure of design with estimation confidence will enable evaluation and design optimization. A graph of the structure with nodes and edges to depict connectivity and estimate load paths in the generated design may encode details without the overhead and complexity of element level drawings. A physics engine (e.g., the processor 202) may ingest the graph and evaluate load estimates for the Bayesian model to estimate likelihood and confidence in the proposed generated structure. An inner optimization loop may be included with a cost-function to maximize likelihood with confidence in the proposed design.

In some embodiments, the Type II schedule standard engine may check for standards compliance. Compliance may adhere to a data schema that the linkage engine (e.g., the processor 202 described herein) understands. The compliant data schema may deliver information with an expected schedule. When there is non-compliance the decision point may be to evaluate the level of information in the schedule. If the schedule source is a text/meta-data readable source, an NLP parser and standard translator may be used to generate the schedule standard schema. If the schedule source is in an image format (e.g., screenshots of a Gantt chart or the like) then image and text recognition to interpret hierarchical detail may be employed (e.g., with an associated timeline).

After the initial linkage at the linkage engine level, the optimization routine may enable the schedule to access the BIM elements. This will expose structural hierarchy, and levels of granularity to allow the schedule engine (e.g., processor 202) to verify scheduled timelines and provide improved estimates. If the BIM level of granularity exceeds the granular depth of the schedule, a granular schedule for the known BIM elements may be generated. Again, a Bayesian approach may work with standard models used as priors, a dependency graph may be created and schedules for each pour defined allowing for constraints, and estimating tasks that may be parallelized. An inner constrained optimization solution may be sought, if possible, where the cost-function aims to minimize delays to the initial schedule.

In some embodiments, a Type III sensor standard may check for sensor platform metadata standards compliance. Compliance adheres to a data schema that the Linkage engine may understand. An external sensor device may include a translator to enable compatibility with sensors from third-party vendors (e.g., catering to a sensor layout plan allows the system to a priori define the API/schema such that the schedule standard engine is ready to ingest data when it comes online). A sensor device platform metadata integration into the linkage engine may also be provided. At the start of the project, no sensor or device platform metadata may exist to be linked. A sensor layout plan may be provided which may include expected sensor installation locations and associated times, which may be digitized and used as a proxy.

### Linkage Operations

In some embodiments, inputs to the linkage systems and methods may include a standard BIM, a standard schedule, standard sensor data, standard miscellaneous construction data. In some embodiments, outputs to the linkage may include a map of the correspondence and/or linkages between the data elements of any of the data entities chosen as inputs. This mapping may be generated or stored in any number of formats (e.g., a set of key value pairs, two sets that represent a graph of vertices and edges etc.). In the case of BIM, schedule, and sensors, this may be a digital platform (e.g., web portal or mobile app) where any of BIM elements, schedule lines and sensor platform metadata may be connected to any of the other two, such that selecting one would allow a user to be redirected to one of the two. This may be extended to any conceivable way to associate one or more piece(s) of information relating the BIM to other pieces of information relating to the schedule and to other pieces of information relating to the sensor.

Route to deliver improvements through recommendations, such as proposed sensors, human inputs, etc. For dynamic linkage, previously established linkages may have evolved (e.g. a camera that was monitoring a pour on floor 1 may now be used to monitor another pour on floor 2). Loopback will allow the linkage engine to link things dynamically such that these evolutions are captured. Linkage may include automatically integrating or linking disparate construction data entities.

In some embodiments, the linkage engine connects the pieces together with the standardization engine in a seamless manner. In some embodiments, the BIM and schedule provide spatiotemporal design and planning information, and the sensors may deliver verification of the real-time state of construction and adherence to the planning schedule. In linking these disparate objects together, a global optimization routine will seek to identify if the following aspects are operations. Cross-verification may check if BIM elements and schedule elements are identified at the same level of granularity. Population of missing information may occur and, if not verified, cross-check to identify gaps. The standard engines (e.g., as performed by an example processor 202) for BIM and schedule may have local optimization routines that include the logic to impute missing information. This may be done using generative approaches. Cost functions may calculate gaps between schedule and BIM.

An optimizer may propose mappings (or combinations) and gaps in either BIM or schedule. Post-connections, the linkage engine may be in a position to recommend sensors for each element, represented as the ideal sensor plan, which may be served as a recommendation. The extent that the proposal is implemented will be reflected by the data once it starts being ingested. In some embodiments, a global optimality checker (as performed by an example processor 202) may verify if a priori defined conditions have been met. If so, the linkage is either complete or in need of human verification. A human verification step may be included to allow a human in the loop to guide and correct the model so it can learn and adapt.

The linkage engine may connect the three types (or more generally n types for n data entities) of initially possibly orthogonal sources of information from raw BIM, schedule and sensors. The goal may be to identify connections in order to maximize overlap in representation. From a quantitative perspective this may require the maximization of the mutual information encoded by any pair of the trio. In other words, this implies the system may extract as much information as possible, for example about the schedule of an element based on its spatial representation in the BIM.

Thus the linkage engine will have to solve the problem of coping with information at varying levels of abstraction depending on the phase of the project as sensor information becomes available. The standardization engine may import the rough BIM, Schedule and Sensor plan and generate a Standardized BIM, Schedule, Sensor plan (with zero data) with an expected minimal mutual information (MI). The Linkage engine is responsible for creating/inferring/filling in the gaps to maximize MI. As sensors are installed and data comes online, the accuracy of the linkages may be evaluated and potentially modified to improve the quality of the linkage. At this stage, automated estimates may be augmented by expert/human guided intervention to improve the quality of the final model. Once all sensors are installed, the expectation is that the BIM model should not change further or change very minimally. The sensors will provide up to date information that will result in an evolution of the information encoded in the schedule. In this phase, linkages really should not change, even if the data encoded within does keep evolving.

In some embodiments, the above point applies for static sensors. In the case of dynamic sensors (e.g., robots, drones), the entity monitored by the sensor will continuously change as it moves, in which case the sensor may be linked to a different entity every time this changes. It should still be the case though, that generally, as more data is collected from the sensors, a higher degree of certainty is achieved regarding linkages and this should apply to both static and dynamic sensors.

### Multi-Modal Approaches for Unstructured Data Linkage

Rather than explicitly standardizing the raw input data sources according to a predetermined standard, another embodiment of the present disclosure may be to link directly from raw data. This may be done, for example, by using multi-modal AI learning approaches, which allow ML models to combine or operate across multiple data modalities (e.g., text, image, BIM, schedule, etc.). This way the model may build an internal mapping across data sources and types, as it learns to recognize more data and identify more robust patterns in the raw data. This internal mapping may act as a more fluid alternative to standardization. For example, the internal mapping may learn to map a particular type of volume area dV in the BIM Model to a particular type of schedule line dS. This would become a map and translation matrix which may become more robust with each iteration. The techniques and framework described herein are described in detail for BIM Models, Schedules and Sensor Platform Meta-Data, but may be used for any linkage combination of any other data entities.

A multimodal AI system may ingest, interpret, and reason about multi-modal information sources with a goal being to realize human level perception abilities. Multimodal learning (MML) is a general approach to building AI models that may extract and relate information from multimodal data. The input to a transformer may encompass one or multiple sequences of tokens, and each sequence's attribute (e.g., the modality label, the sequential order, etc.), naturally allowing for MML without architectural modification. Further, learning per-modal specificity and inter-modal correlation can be realized by controlling the input pattern of self-attention (e.g., specifically masked self-attention for incomplete modalities/data). Tokenization, semantic and position embeddings may be required for proper ingesting of non-integral data.

Masked self-attention may embed a holistic multimodal representation and handle the absence of modalities by applying a mask on the attention matrix. In practice, modification of self-attention may be needed to help the decoder of the transformer to learn contextual dependence. In both uni-modal and multimodal practices, specific masks may be designed based on domain knowledge and prior knowledge. Essentially, MSA is used to inject additional knowledge to Transformer models. Thereby making MM Transformers more adaptable to deal with modal-incomplete inputs. MM-Transformers process all modalities together in a single model, significantly reducing the training load. A drawback is that Transformer models are susceptible to significant deterioration in performance with model-incomplete inputs, especially in the context of multimodal inference where Transformer models tend to overfit to dominant modalities. Therefore a balance is needed in the training data across modalities.

### An MML-T Structure Embodiment for BIM and Schedule and Sensor Platform Metadata

In some embodiments, a multimodal architecture that uses an additional fusion token to force information among the three core modalities of BIM/Schedule/Sensor may be used (e.g., within each is the ability to absorb multiple sources of information to reconstruct the core information). The tokenized vector streams or embeddings (e.g., the vector of tokens encoding semantic and sequence of data) are passed through using cross-attention with a modality-aware masking mechanism in all attention operations, to isolate the allocation of latent representations of individual modalities, leading to a resultant representation that is partially unimodal (e.g., part of the representation attends to a single modality) and partially multimodal (e.g., part of the representation attends to all modalities), thereby allowing for the use of contrastive learning. Linkage may be associated with an encoder-decoder architecture, parameters of which will be tuned based on the modalities considered within the training. Multimodal configurations may require specific consideration at the ingestion stage as the approach needs to be carefully selected. If the data is schema compliant, then the embedding task is implied, the system may map all atomic entities to a spatial location and sequence (e.g., that embeds coordinates as well as adjacencies and hierarchies) and a role (for e.g., structural/architectural). Otherwise, BIM inputs may involve images, such as 2-dimensional architectural drawings that will be interpreted using a multi-modal translator that involves separate text tokenization, semantic and position encoding and patch embeddings for image based solutions. In another instance, inputs may include 3-dimensional models, wherein the 3-dimensional models are translated to 2D drawings is a clean solution to ensure reliable embeddings. Alternatively, meta-data entities may be needed to convey perspective, orientation, and/or context that drawings inherently provide.

If the data is schema compliant, then the tokenization task may be implied, the system may have mapped all entities, either explicitly or implicitly through hierarchy, to a mapping of events and/or activities and a timeline. The timeline sequence embeds dependencies through adjacencies a and hierarchies and status (e.g., conception/fabrication/shipping/installed). Otherwise, for instance, a schedule's inputs will involve either an explicit project plan, output of which can be textualized into an embedding that is equivalent to the schema as defined above, that provides reference to the entity (e.g., element or at a higher level of abstraction, such as a floor) and its mapping to events/activities and a timeline. The textual tokenization step will yield schedule tokens. In another instance, the input may include an image (e.g., a Gantt chart) that will require a combination of text translation (e.g., OCR problem converted to textual tokenization) and timeline and dependency estimation based on Gantt chart flow (vision approach using patch tokenization).

### Example Use Cases for Data Linkage

In some embodiments, any measurable entity may have an associated data passport that is a linkage and aggregation of key data relating to the entity tracked in real-time throughout its lifetime, from creation to end (e.g., installation), unique to the measurable entity under consideration. This data may be gathered from any data source type and/or data source mentioned herein and may be aggregated together using any method or technique described. The data may also be gathered from other models and/or methods described herein including mix fingerprinting and/or sensor context awareness, to monitor measurable entities in real time. Example information kept on a unit's data passport may include structural data (e.g., metrics for structural health and/or integrity), material properties (e.g., static, contextual, and compositional), material contextual conditions (e.g., location and time), sensor device data (e.g., spectro-acoustic signatures) and any other data type mentioned herein or that would otherwise be obvious to one skilled in the art.

These data may be aggregated and interpreted using any of the models and methods described in any section herein, to provide insights such as a health score for instance which holistically rates the construction object's structural health (through monitoring all the variables outlined in other parts of this disclosure), as well as a risk score, estimating how at risk the object is of falling below standards or of experiencing health deteriorations. Insights regarding standards may also be provided, including for instance statistics regarding standards which have been tested and have yet to be tested or those that are at risk of being unfulfilled. Data passports may be recorded on a decentralized system (such as a blockchain to ensure records are demonstrably verified). Such passports may increase historical visibility, including providing a view into past locations and interactions a given construction object has lived through to answer questions (e.g., Where has this object been in the past and when? how many interactions has it had? What kind of objects?). This may also be used to find the reason quality standards are not being met using similar methods to those described in perturbative mix fingerprinting. In addition, this data passport may be instrumental in enabling the reuse of construction objects (e.g., prefabricated elements could be reused at building end of life, through disassembly and reuse in a new structure). These data passports may also be key for QA and Quality Testing purposes to ensure safety and longevity of the building.

### Example Linkage Flowchart

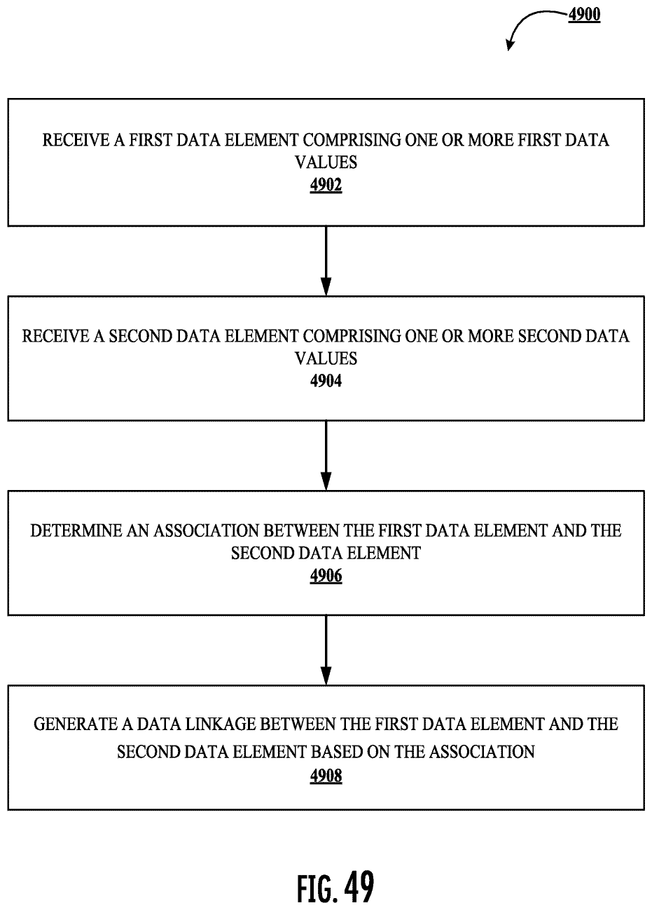

FIG. 49 illustrates a flowchart containing a series of operations for data linkage operations (e.g., method 4900). The operations illustrated in FIG. 49 may, for example, be performed by, with the assistance of, and/or under the control of an apparatus (e.g., server 200), as described above. In this regard, performance of the operations may invoke one or more of processor 202, memory 206, communication interface 204, and/or machine learning (ML) module 208.

As shown in operations 4902 and 4904, the apparatus (e.g., server 200) includes means, such as processor 202, or the like, for receiving a first data element comprising one or more first data values and receiving a second data element comprising one or more second data values, respectively. As described above, a data value may include any piece of information relating to a construction project and a data entity may refer to a data store or equivalent storage structure that holds data values (e.g., a specific BIM model or the like). Furthermore, a data element may include a data value of a certain type stored within a data entity of a certain type (e.g., an element in a BIM model). As such, the server 200 may, at operation 4902, receive a first data element that comprises one or more first data values that are associated with a construction project and of a first type, such as a first data element associated with a BIM. The server 200 may receive the first data element via any of the mechanisms described herein (e.g., via user input, device registration, model inference, and/or the like without limitation).

Similarly, the server 200 may, at operation 4904, receive a second data element that comprises one or more second data values that are associated with a construction project. In some embodiments, the construction project may be the same between the first data element and the second data element (e.g., the same construction project or a common structure). In other embodiments, the construction project of the second data element may be different than that of the first data element but otherwise related or relevant to the first data element. For example, the first data element may include data values that are associated with the construction of a structure that is different from the first data element; however, the data values of each data element may be relevant to one another (e.g. a construction site resource that is applicable to the construction of multiple structures). By way of continued example, the first data element may be associated with a data element of a BIM model, and, in such an example, the second data element may be associated with a schedule. The server 200 may receive the second data element via any of the mechanisms described herein (e.g., via user input, device registration, model inference, and/or the like without limitation). Although described herein with reference to a BIM and schedule as example data elements or entities for linkage operations, the present disclosure contemplates that the example first data element or entity and the second data or entity may be associated with data of any type, configuration, etc. based on the intended application of the system 100.

The present disclosure provides various illustrative example of data value, data elements, and data entities herein (e.g., BIM data, schedules, device data, device properties, cube data, among others) that may, in any combination, be used as the example first and/or second data elements. For example, the first and/or the second data element may be associated with a spatial representation (e.g., a BIM or the like) associated with a structure, a structural progress flow (e.g., a schedule or the like) associated with the structure; one or more data entries associated with at least a first sensor device; (e.g., sensor IDs or the like), one or more data entries associated with a crush test result (e.g., cube data or the like), one or more data entries associated with a mix identifier (e.g., mix data or the like); and/or a status identifier associated with a construction site resource.

Thereafter, as shown in operations 4906 and 4908, the apparatus (e.g., server 200) includes means, such as processor 202, ML module 208, or the like, for determining an association between the first data element and the second data element and generating a data linkage between the first data element and the second data element based on the association, respectively. As described above, the embodiments of the present disclosure may leverage various machine learning (ML) models and associated artificial intelligence (AI) techniques that may operate to determine associations between disparate data values, data sources, and/or the like as related to linking these data values, data sources, etc. By way of a non-limiting example, the server 200 may employ machine visions, NLP inference, data encoders, vision-language models, sensor context awareness, location tracking, among others to determine the existence of an association between the first data element and the second data element. The present disclosure contemplates that any of the systems, techniques, methods, models, etc. described herein may be used to determine the association at operation 4906. Furthermore, the present disclosure contemplates that the linkage generated for the first and the second data element may refer to any mechanism for association these data elements. For example, one or more modifications to a database storing the first and the second data elements may occur in order to represent or otherwise indicate the presence of the linkage (e.g., association or the like) between these data elements.

In some embodiments, the data linkage between the first data element and the second data element may be determined based on the one or more first data values and the one or more second data values (e.g., an internal linkage as described above). In other embodiments, he data linkage between the first data element and the second data element is determined based on one or more data entities other than the first data element and the second data element (e.g., an external linkage as described above). The generated data linkage at operation 4908 between the first data element and the second data element may, for example, be probabilistic and define an associated confidence value. In some embodiments, the data linkage between the first data element and the second data element may define one or more data dependencies between the first data element and the second data element. These data dependencies may operate such that a modification associated with the first data element may result in a dynamic modification to the second data element and/or a modification associated with the second data element may result in a dynamic modification to the first data element. As described herein and would be evident to one of ordinary skill in the art in light of the present disclosure, the first data element and the second data element may be stored by a database comprising a plurality of data elements, one or more of which are associated with material identifiers indicative of respective formulations defining a proportion of constituent components forming the building material. Access to such a database may be permissioned as described herein.

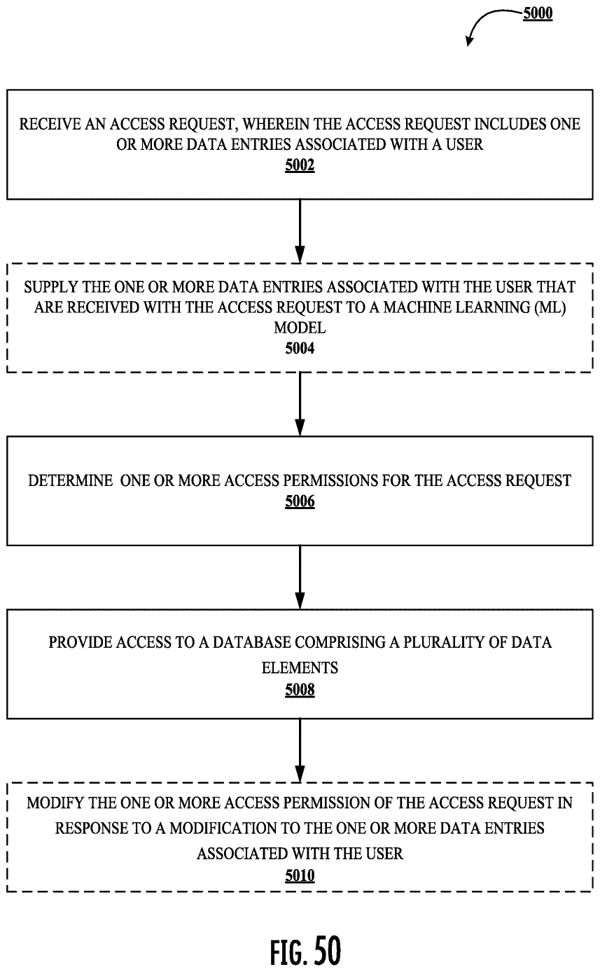

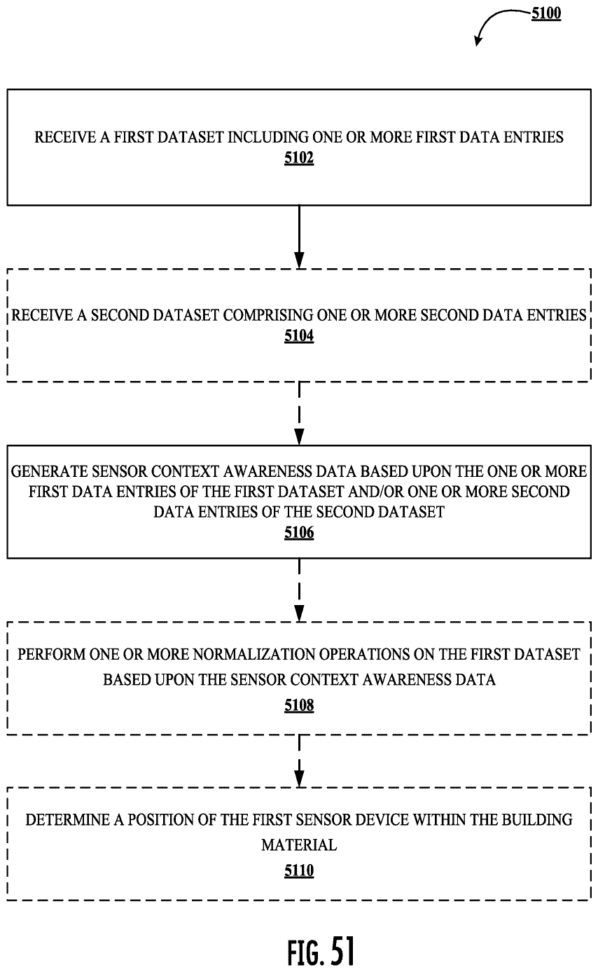

FIG. 50 illustrates a flowchart containing a series of operations for data linkage operations (e.g., method 5000). The operations illustrated in FIG. 50 may, for example, be performed by, with the assistance of, and/or under the control of an apparatus (e.g., server 200), as described above. In this regard, performance of the operations may invoke one or more of processor 202, memory 206, communication interface 204, and/or machine learning (ML) module 208.

### Construction Data Access

As would be evident to one of ordinary skill in the art, the various material constituent elements, components, parts, etc. that form a particular building material may be significant to various stakeholders (e.g., contractors, material suppliers, material consumers, etc.) associated with construction. For example, a particular material formulation (e.g., associated with a material identifier or otherwise) may be associated with various material properties (e.g., static material properties, compositional material properties, contextual material properties, etc.), and these material properties may impact performance of the structure formed by the building material as described herein. A building material may further include various material information requirements.

By way of a nonlimiting example, the building material may be a concrete mix formulation, the supplier may be a readymixer, and the consumer may be a concrete frame subcontractor. In such an example, the supplier may need to know the compositional properties of the material (e.g., a mix formulation) as well as the characteristics of the compressive strength development of the material (e.g., a contextual material property) to ensure that the material fulfills the specification for which it was ordered. The consumer may need to know the same information in order to accurately determine the strength of the material using the maturity method (e.g., or other predictive method of compressive strength determinations). In many cases, material data may be commercially sensitive and, therefore, the material supplier and/or material consumer may want to limit access to this material data. As such, the systems of the present disclosure may operate to determine access permissions associated with particular users attempting to access material data and permission access as to a database (e.g., a material library) based on these access permissions. Further to this a system that can classify the material data by method of origin will inform the choice of data ingestion method and/or permission rules.

### Material Library

In order to provide read and/or write access to material data to any stakeholder (e.g., a user of the system 100 or the like) in such a way that said stakeholder, or another stakeholder, may access this material data at another time, the material data may be stored in a database system (e.g., database 108 or the like), referred to herein as a library and/or material library. By way of a nonlimiting example, the material library may be a relational database management system running on a server (e.g., server 200 or the like), of tables containing the different types of material data relating to each material (e.g., by material identifier, by material formulation, etc.). This library may, for example, be accessible via a program running on the same server or a different server with access to the server associated with the material library. In this way, the server 200 may operate to determine the access to provide to a particular user for a given material.

### Ingesting Material Data

Material data may, for example, be ingested via manual input, semantic parsing of a source document, connection to a source database, and/or connection to a sensor system and/or device, among others. In some embodiments, a graphical user interface (GUI) hosted on the server 200 may present to the user a selection of materials, and allows the user to select a material, select the type of data to add or update, and add the data values (e.g., by typing on a keyboard or selecting values using a pointer device). In some embodiments, a model may be used that translates a photograph of a document that is formed of pixels into a data-structure that represents that document. The model may then select the relevant material data. The data may either be automatically associated with a given material using other data extracted from the document by the model (e.g., a material identifier), or manually associated with a given material by a user (e.g., via a GUI or the like). The present disclosure contemplates that any number of models of any type may be used (e.g., a multi-model, tensor based model, large language model, etc.)

In some embodiments, a first program running on a first server may be used that has a token providing access to a second program running on a second server that contains the material data. The first program, via a network socket or the like, may connect to the second program on the second server and exchanges cryptographic keys to ensure the connection is secure and encrypted, and then send the access token to the second program along with a request for material data for given material (e.g., identified by some material identifier or the like). If the second program determines that the access token is valid for the request, the program encrypts and sends the material data via the network socket back to the first program that subsequently stores the material data in the material library associated with a given material. In some embodiments, a program running on a server may connect, either via a gateway device or a mobile application, or on its own via an internet connection (e.g. cellular), may connect with a sensor system via a network socket in order to upload material data along with identifying information. That sensor system and/or device may be associated with a given material for which it is providing material data to the material library (e.g., a link may be made between the sensor identifier and the material identifier as described above).

### Example Methods for Creating Permission Rules

As described herein, a permission rule may be defined as a function, P (s, a, e), over a set of material data(s) for which an actor (a) may affect an action (e). In some embodiments, s, a, and e may be used as lists (e.g., s becomes [s], a→[a], and e→[e]). These lists may contain references to specific materials, actors, and actions by using the identifiers ascribed to those specific objects within the material library. In other embodiments, sets {s}, {a}, and {e} may be defined using logical rules (e.g., by formal language or the like) to define the membership of these sets. For example, a rule might be that any consumer who has ordered a given material from a supplier may read all the data for that material. A formal language for describing this rule may be as follows: ∇m ∇a·m∈μₐ⇒P({s=Sₘ}, a, {ρ}) which translates as for all materials m and for all actors a, if a material is a member of the set of materials ordered by actor, a (μa), then a permission rule P exists for a to have read access (ρ) to all material data s in the set of material data for the material m (Sm).

To practically implement the example permissions rules, the embodiments of the present disclosure may use Domain Specific Language (DSL) in which certain specific sets, relations, and entities relating to the material library permissions domain are defined in the language. For example, the “(material) ordered by (actor)” relation may be specific to the domain of the material library. In this instance, an actor may refer both to a specific human user and also to the stakeholder organization of which that specific user is a member. This elision of the distinction between the human user and the stakeholder organization is relevant in that the user acts on behalf of the stakeholder organization and may not act outside of the organization with respect to the material library. In an alternative embodiment, a distinction may be made by the system, such as in instances in which different users within one organization have different permission levels to the material library. A DSL for describing permission rules may also contain more complex relations that use the data from sensor systems to determine access to material data. For example, one such rule may be that if a consumer has activated a sensor system which was associated, by the supplier, to a material, then that consumer may be able to use a subset of the material data for that material which pertains to the operation of the sensor.

### Direct User Input

In one embodiment, creating permission rules in the material library may be performed by a user via a GUI program or the like. In such an embodiment, a user may input controls such as dropdown boxes, that allow the user to describe a limited subset of the possible permissions rules. Such an interface may, for example, have a dropdown selecting the material data available (e.g., including the option “all” or “none”), a dropdown of the materials to which the example material data may pertains (e.g., “specific materials with the following identifiers”, “all materials matching the criteria,” “all materials,” etc.), a set of dropdowns describing the material selection criteria (e.g., “materials ordered by the actor,” “materials of a given type,” “materials created since a given date,” and so on), a dropdown describing the criteria for the set of actors under this rule (e.g., “all consumers,” “specific consumers with the following identifiers,” etc.), and/or a dropdown describing the allowed access types (e.g., “read,” “update,” “create,”, “use,” and etc.). Such a GUI may be able to leverage Boolean logic such as to combine components into a complete permission rule.

### Bearer Tokens

Another method may rely on a token already associated with a subset of the material data for a given material to provide the bearer of that token with access to that data. That token may either be used to create a permission rule for the bearer of the token to access the material data on a persistent basis, after which the token would be invalidated or for each request for the material data, such that any actor with the token may access the specific material data at any point. For example, a delivery ticket accompanying a concrete truck may be delivered alongside the concrete. The ticket may have a QR-code that is scanned by a mobile application. The data contained in the QR-code may be sent over an encrypted network connection to a program running on the server 200 which would check if the code has been used previously. If the code has not been used previously, then a permission rule may be created by that program for the material data described in the delivery ticket for the stakeholder organization of which the user who scanned the QR-code is a member. Subsequently, users who are members of that stakeholder organization may be able to access the data described in that specific delivery ticket for the given material.

### Automatic Inference

In some embodiments, a sensor system may observe a set of physical properties of a material over time {φ; t} to determine access. These properties may, for example, be simple observables such as temperature, humidity, electrical conductivity, or pH as well as more complex vector or matrix observables such as frequency response curves for mechanical, electrical or electromagnetic wave impedances, electromagnetic spectra, and/or the like. For any given material, the possible range of these observables forms a volume in the material space (either in sensor signal representation, or in material property representation in which each dimension is a different material property) which itself evolves in time (from the time the material is “created” or “instantiated”). This may be analogous to mix space as defined herein as related to mix fingerprinting and mix optimization.

The system may set that there is a subset of all the points in the material-property-space (MPS) that have a bijective mapping to the set of materials for which that MPS is defined. In this way, the system may know that each material has a set of distinct volumes in the MPS in which only that material is represented. For a sensor system, therefore, whose set of observed properties {; t} is sufficiently large to enable such a bijective mapping, a set of observations over time may identify either a single material or a subset of materials which are represented in the MPS-volume circumscribed by those observations. As described herein, these materials may be “material identifiers” or “material fingerprints.” This process may be further used to generate permission rules for accessing certain material data based on an inference of the identity of the material in which the sensor system is positioned.

In some embodiments, a sensor system observing a set of physical parameters over time {φ; t} and a program running on the server 200 which has access to all the material data in the material library, of which each material has been fully or partially described in the MPS for the parameters {φ; t} may be used. The user, using a mobile app or similar, may associate the sensor system with their stakeholder organization, and the sensor system may be associated, either manually or automatically, with a structural element formed of some material that is not yet specified. The sensor system communicates, either directly, via a gateway device, or via a mobile application, the observations over all the parameters over a window of time to the program running on the server 200. The program uses these observations in time to construct a volume in MPS, and, using common geometrical algorithms, detects whether the points in MPS overlap with known volumes for the materials in the material library. An algorithm then decides whether a single material or set of materials may be identified by the observations. If a set of materials may be identified by the observations, then a permission rule may be created for a defined set of actions and a defined subset of the material properties of the identified material, and the stakeholder organization. Furthermore, any of the example machine learning models described in the mix fingerprinting techniques of the present disclosure may be used to generate an identifier that is then used to determine a permission rule.

### Example Data Access Flowchart

FIG. 50 illustrates a flowchart containing a series of operations for data linkage operations (e.g., method 5000). The operations illustrated in FIG. 50 may, for example, be performed by, with the assistance of, and/or under the control of an apparatus (e.g., server 200), as described above. In this regard, performance of the operations may invoke one or more of processor 202, memory 206, communication interface 204, and/or machine learning (ML) module 208.

As shown in operations 5002, the apparatus (e.g., server 200) includes means, such as processor 202, or the like, for receiving an access request that includes one or more data entries associated with a user. As described above, the access request may occur as part of a user input, sensor device request, model operation, and/or the like. As further described above, the user may refer to any stakeholder associated with the construction of a structure and/or any organization that is formed of members. The present disclosure contemplates that the server 200 may receive the access request from any of the devices described herein and may further provide the request and/or receive the request as related to performance of the one or more machine learning models described herein.

As shown in operations 5004, the apparatus (e.g., server 200) includes means, such as processor 202, or the like, for supplying the one or more data entries associated with the user that are received with the access request to a machine learning model. As described above, in some embodiments, an example sensor system may communicates, data entries associated with material properties to the server 200. The server 200 may use this data to construct a volume in MPS, and, using common geometrical algorithms, detects whether the points in MPS overlap with known volumes for the materials in the material library. The example ML model may then decides whether a single material or set of materials may be identified by the observations. Access permission may, at least in part, be determined based on these operations.

As shown in operations 5006 and 5008, the apparatus (e.g., server 200) includes means, such as processor 202, or the like, for determining one or more access permissions for the access request and providing access to a database comprising the data elements which are associated with material identifiers indicative of respective formulations defining a proportion of constituent components forming the building material, respectively. As described above, in some embodiments, the determination of the access permissions for an access request and associated user may be performed as a comparison between the access granted to the user (e.g., as part of an organization or the like) and the material identifiers that are associated with the granted access. In some embodiments, the server 200 may leverage ML models to determine the access permissions, and granting the access to the database may occur by any of the mechanisms described above.

As shown in operations 5010, the apparatus (e.g., server 200) includes means, such as processor 202, or the like, for modifying the access permission of the access request in response to a modification to the one or more data entries associated with the user. As would be evident to one of ordinary skill in the art, the data associated with the user, organization, or any other stakeholder may dynamically change in time. For example, a particular user may no longer be associated with an organization, an organization may no longer have access to particular mix formulations, and/or the like. As such, the server 200 may operate to dynamically modify user access permissions to any user based on these changes. The present disclosure contemplates that the access permissions described herein may be modified based on any change, update, etc. associated with the user.

### Sensor Context Awareness

The evolution of concrete pours and structures over time is a process that is dependent on the pour's local surroundings, and on the geometry of the pour and/or structure. The embodiments described herein may refer to all such conditions that do not pertain to the material properties of concrete as the “contextual conditions” of the material as defined above. Some examples of contextual conditions may be temperature, humidity, altitude, geographic location, time of year and geometry of the element into which concrete is poured. As an example of contextual condition dependence, the system 100 may consider the temperature of concrete during the curing process. In general, concrete has a 3D temperature profile that is different at each point throughout an element. It is also the case that various contextual material properties of concrete are dependent upon concrete temperature. This means that certain material properties may generally evolve differently over time as a function of the depth or precise 3D location within a given element's volume. Contextual conditions other than temperature may also play a factor in position and time-dependent differences in material properties.

The contextual material properties of concrete may also evolve in differing ways based on a myriad of other contextual considerations. Some non-exhaustive examples are the type of formwork used, the amount of rebar inside of an element, and/or the use of blankets or other insulation (e.g., in winter, the use of active heating or coolant elements, etc.). Having an understanding of the relationship between these kinds of contextual conditions and the material characteristics of concrete would be very useful for a number of different reasons, such as Quality Assurance (QA) for contractors, normalizing algorithms, training models and labelling data, improving the user experience of utilizing concrete sensor systems (finding a sensor, automatically recording where it was placed etc.), actuating devices and/or adaptively changing device behavior based on contextual conditions.

Current concrete (e.g., a cementitious mixture or other building material) monitoring fails to provide adequate visibility regarding how the local and adjacent environment of a concrete element impacts its contextual material properties. The system of the present disclosure solves this problem by gathering data (e.g., via sensor devices) and processing that data in order to build a relevant understanding of the local environment. Local may refer to the regions both within and external to the concrete element during a given concrete curing process. For example, a thin concrete slab with metal formwork on a very high floor that is curing on a cold and windy day is likely to lose heat faster (e.g., cool faster) and, as such, the internal temperature of the curing concrete may not reach the same peak temperature as a similar mix poured into a different geometry with wood formwork (e.g., different heat conductivity) and during different weather conditions (e.g., wind chill and heat differential between the concrete and the formwork). The differences in temperature given these two scenarios may translate to differences in thermal expansion and/or shrinkage over time, differences in the compressive and flexural strength of the concrete, and/or difference in the water content of the cured slab (to name only a few impacted material properties). The system 100 of the present disclosure therefore operates to construct an automated model, or series of models, that encode a detailed understanding of the manner in which such contextual conditions would lead to differences of the aforementioned kind; and to be able to both measure and predict those final material properties, from knowing only the measured contextual conditions of the system (wherein those measurements derive principally from in-situ sensor measurements, but which can be derived from other sources also).

### General Information

The system 100 described herein provides a way for a device (e.g., devices 102a-102n) to be “self-aware” in the sense that it is able to automatically detect various properties regarding its immediate and extended environment. Some non-exhaustive examples of detected environmental properties are described herein. The geometry of the concrete pour or batch within which, or on which the sensor is located, or (if the sensor is external, and at a distance), the geometry of the concrete that lies within its line of sight, or the element that it is considering. The device's location on the globe (e.g., GPS location, date and time) or the geographic location of the pour(s) it is considering. Its location within the overall structure, or the structural element into which a pour has occurred. Or alternatively, its location in any relative positioning system. The present weather conditions, future forecasts, historical measurements, and/or local regulations about the way it should process the information and operate-all of this with the goal of ensuring that the sensor can collect data with context about its local surroundings. Over time, the generated database will allow the system to build a deeper understanding of concrete mix behavior, as well as more powerful engines for use cases such as mix fingerprinting and mix optimization.

There is no existing solution that focuses on automatically understanding the concrete's local and extended environment and the controlled variables which affect it. Furthermore, automating the data collection process around these variables using sensors allows for more efficient and accurate measurements of these variables. For example, pour geometry is typically estimated in a very rough manner for thermodynamic behavior modelling purposes (e.g., by representing the pour as a cubic volume, even though it is of a complex 3D shape), yielding uncertain results. This system 100 of the present disclosure removes the need for such limiting approximations.

### Determination of Scattering Parameters for the Purpose of Sensor Contextual Conditions

As discussed in greater detail below, the system's 100 automated material-characterization models may use wave-based signals in order to determine a representative multi-port signal flow graph representation of a given wave-based device configuration (wherein the material measured by those waves may be an element of concrete). In the hardware description above the system is described as utilizing a combination of interferometric techniques and time-based pulsed wave analysis in order to determine the reflectance and attenuation/transmission profile of a medium. The embodiments described herein may also established how the system 100 may use a combination of amplitude/power measurements and precise timing measurements in order to construct the dispersion relationships of propagating waves within the material where a dispersion relationship may be defined as the functional relationship between wavenumber (or wavelength) against the frequency of a wave, and where the dispersion is a fundamental attribute of both the material and its geometry.

The determination of the above properties constitutes a non-destructive means by which the system 100 may characterize material properties of a material using embedded or external sensors. For example, these methods allow for the measurement of the velocity of a wave within a medium, from which the system 100 may derive the dielectric constant (if the propagating wave is electromagnetic) or the density of the medium (if the propagating wave is acoustic). The determination of scattering parameters is thus not limited to a specific type of wave, and the system may generally utilize both electromagnetic and mechanical waves to determine the electro-chemical and mechanical/acoustic properties of the medium, respectively. Once a device configuration has been used to characterize the scattering parameters (and, by extension, the relevant fundamental material properties of a material) the system 100 may then be able to use that measured material information in order to detect the physical location (or other contextual conditions) of a device sensor that is place within, or external to, an element of the same composition.

As was described by the present discourse with reference to hardware, the following equation characterizes the complex wave-amplitude of a wave that has propagated some distance, l, in a time, t (relative to some arbitrary initial time, t=0): b=aβ exp[i(kl−ωt)], where a is the transmitted complex wave amplitude, b is the received complex wave amplitude, ω is the frequency of the propagating wave, and k is the wavenumber of the attenuated wave. The value defines the attenuation factor over the distance traversed through the material (and may be trivially converted into a rate of attenuation per unit distance, by dividing by the total distance traversed, l). In the scattering-parameter determination described herein, the embodiments described herein the problem in which all parameters were known except for the wavenumber, k. Thus, through measurement of the transmitted and received signals, the system was able to solve for k and measure the dispersion of the medium, as well as the attenuation factor of the material.

However, in such an example embodiment, the system 100 may use the scattering parameters and derived material quantities that have already been measured (in the above-stated manner), and the system may construct a scenario in which the system 100 may have placed sensors within the material, but the system may not know the distance between the wave-based transmitters and receivers, or between the transmitters/receivers and the bounds of a concrete element. However, in this case, the missing parameter is the distance, l (not the wavenumber). It is thus a trivial matter to solve for l, giving the distance traversed by the wave. By deriving the value of l, the system may thus be able to infer the distance between sensors, or the distance between a sensor and the surrounding material.

This example illustrates the modal quality of wave-based measurements, wherein the system 100 may utilize the wave equations of the system to measure whichever quantity one does not possess, and where all other quantities have been derived from other techniques, or from other information. For example, the system 100 may determine the distance of propagation, wavenumber and frequency of the propagating waves, but not the attenuation of the signal. At which point, the system may utilize the sensor data to determine the material attenuation, and (through comparison with a database of material characteristics), infer the likely material in which the sensor is contained. This example may operate as a material-detection context-awareness mode.

In the situation wherein the system 100 may already have determined the orientation of a sensor (e.g., by using information from on-chip gyroscopes or on-chip axial magnetometers) the system may resolve the direction in which the signals were transmitted or received. By knowing this information, and the value of l for all directional transmissions, the system 100 may be able to construct a 3D understanding of the shape of the element within which (or upon which) the transmitters and receivers exist, by decoupling which of those signals were reflected from the bounds of the element, and which of those signals were transmitted in line-of-sight with the receiver (having not been reflected from any bounds).

However, one aspect of the system 100 described herein is its able to automatically determine the geometric shape of the element without the need to know the orientation of the transmitters and receivers. In one embodiment, the manner in which this is done is via the transmission of circularly polarized electromagnetic waves. Using bi-axial antennas (or other multi-axial antenna embodiments), the system 100 may transmit circularly polarized waves. It is a property of circularly polarized waves that, when reflected off of a surface, the polarization is reversed (changing from clockwise to anti-clockwise, or vice versa). Thus, in this situation, the system 100 may not only record the distance traversed by transmitted signals at various frequencies, but the system may also record the transmitted and received polarization directions. Thus, in general, the system 100 may obtain a series of distances, li, wherein the i-th distance possesses a binary value stating whether the polarization has changed or remained the same. Given a multitude of directional transmissions within the material, the system 100 may be thus able to construct all boundary conditions, and all line-of-sight distances between transmitters and receivers.

In the above scenario, the system 100 may employ on-chip phased array antennas, operating them such that they are able to directionally “search” for nearby devices. This may be done by modifying the transmission direction until the received wave signal satisfies the condition of having the highest signal amplitude and having an unchanged polarization direction. Once the above two conditions are met, the system 100 may accept that a line-of-sight propagation has occurred, and the distance the straight-line distance between the two antennas is deemed to be discovered. After constructing all pairwise linear distances between sensors, the system 100 may then utilize a multi-directional transmission mode to explore the boundary conditions of the material via measured wave-reflection events (wherein wave reflections occur for changed polarization directions). Given a sufficient number of directionally reflected transmissions, the relative sensor location and geometric structure can thus be derived in a manner that is entirely agnostic to the orientation of the sensors.

As defined above, the embodiments herein may refer to all measured contextual condition data derived from sensor measurements as “self-detection” data (whether relating to the sensors themselves, or to the material, or to any other system) or interchangeably, “context awareness data”. Self-detection data of the kinds described herein can be generated either by computations that are executed directly on the sensors themselves, or by computations that are executed remotely (for example, on an external server 200). In either case, all raw data and associated self-detection data are stored in the database from which all of the models are trained, and from which all the models derive data for the purposes of various execution modes. The derived scattering parameter of a given material being used to determine the sensor contextual conditions or material contextual conditions (or other contextual conditions) can be used directly for the purposes of “normalization” procedures. These normalization procedures are described hereinafter.

### Model Normalization in Self-Detection and Context Awareness

The term “normalization” as used herein may be used to describe the manner in which the prediction, evaluation and recommendation models (e.g., the processor 202 described herein) account for the context in which the objects of their predicted, evaluated or recommended outputs exist. The total context from which a model's input data derives will have various meanings with respect to each model, and the term “context” may refer to various modalities within an instantiated physical system (for example, a context can refer to the state of a sensor, or it can refer to a state of a material, or it can refer to the state of the environment). All such contexts are generally referred to as “contextual conditions” in the system described herein. However, as described herein, it is important to make a distinction between contextual conditions that inform the system 100 about the state of a sensor, and contextual conditions that inform the system about the state of a material and/or the surrounding environment outside of that material. It is also important to state the interdependence between those categories of data, with respect to any inference made about the physical system in question.

In some embodiments, contextual conditions can be sub-categorized in the following ways. Sensor contextual conditions may include any data describing the contextual physical conditions (e.g., temperature, relative orientation, relative location within a material, relative location on the Earth) or contextual digital conditions (e.g., state of the onboard firmware, leakage currents from onboard circuitry, mismatched internal impedances, specific transistor design) of a sensor. Material contextual conditions may include any data describing the contextual material conditions of an instantiated material (e.g., the geometry of the material, the temperature at a given location or on average, the time at which the material was instantiated, the location of the material within a structure). Environmental contextual conditions may include any data describing the contextual conditions of the environment (e.g., the ambient temperature, humidity, wind speed, intensity of solar radiation). The ultimate purpose of the prediction, evaluation and recommendation models is to infer the material properties or material contextual conditions of an instantiation of some material in a specific use-case (for example, a concrete pour in a structure), whether that use-case be in the past, present or future. However, it is sometimes the case that, in order to infer a static or contextual material property (e.g., the compressive strength at the surface of a concrete pour), the models require knowledge of the contextual conditions of a sensor (e.g., the location of the sensor within a pour—such as its distance from the surface).

In the example of using a temperature sensor to infer the compressive strength of concrete at the surface of a pour, it is vital that the position of the temperature sensor within that body of concrete be known. In general, temperature readings from deeper locations within a concrete pour (i.e., where more concrete stands between the sensor and the ambient atmosphere) are less representative of surface compressive strength. In this instance, it would be the purpose of the models to use measurements taken from any number of devices (whether from the temperature sensor itself, or from other devices), or from any number of external data sources (e.g., human input) to determine the location of the temperature sensor, and to infer the strength at a generally different location within the pour.

Another example may be the inference of compressive strength from the impedance spectrum of a piezo-electric device, where that device is embedded inside the concrete. Generally, the impedance spectrum may inform the system 100 of the compressive strength, under the condition that the system 100 may account for changes in impedance that are due to the temperature of the sensor itself (impedance measurements are inherently temperature-dependent, and the impact of temperature must be “removed” from the inference process). In the above examples, the temperature of the concrete at some location is either the desired measurement (normalized by location within the pour, when using temperature to measure the compressive strength) or the contextual condition with which the system 100 must normalize the output of some measurement (e.g., when using impedance to measure compressive strength, the system 100 may account for temperature). This highlights the pervasiveness of normalization throughout the models, and that the manner in which normalization is implemented inherently depends on the required sensor measurement, and the precise manner in which that measurement relates to the desired material property.

Model normalization may be described as the use of sensor, material, or environmental contextual conditions to infer the material properties of some system if under some other set of contextual conditions (e.g., using impedance measurements from the interior of a concrete pour to infer the elasticity of the concrete on its surface). There are multiple ways in which the models simulate the expected properties of a material in some other set of contextual conditions.

In some embodiments, simulating the expected properties may include inferring underlying physico-chemical equations. Some instantiations of the systems 100 described herein use the data the system 100 may have from historical sensor measurements and historical “ground truth” contextual conditions (e.g., where the “ground truth” is a contextual condition whose veracity has been verified through additional efforts) to build or discover physico-chemical models. The discovery of physico-chemical models consists of inferring the equations that generally describe the relationships between contextual conditions across all previously instantiated contexts.

For example, the system 100 may use verified positional locations of temperature sensors, along with the temperature time-series from those sensors, to compare against ambient temperature. By doing so, the models infer that there is a generally exponential relationship between the temperature (relative to ambient), such that T=T₀ exp(−αx), where T₀ is the ambient temperature and α is an unknown quantity that is specific to some instantiation of a material and set of other contextual conditions, and where x is the depth by which the temperature sensor is embedded in the material. In this example, the model-building systems will test general combinations of functional candidates (e.g., logarithmic, sinusoidal, exponential, hyperbolic) and arrive at a context-independent functional form (such as the exponential form above), that describes the general functional relationship between a contextual condition and a material property, or between a contextual condition and another contextual condition, the models are capable of finding arbitrary mixtures of such functional types and are capable of therefore discovering the optimal context-invariant relationships between measured quantities, such that context is subsequently encoded by learning the relevant parameters (or weightings) within those functions (e.g., by learning the value of a in the exponential above, for specific materials, and for various geometries). Once those parameters are learned for specific instances of a material and geometry etc., those models are then able to apply the learned functions to normalize for the required contextual condition or material property (e.g., once the is learned for a model, it can normalized for the adjusted temperature at any depth, x).

In some embodiments, the simulating the expected properties may include manually defining physico-chemical equations. It is sometimes the case that relevant and well-established physico-chemical theory exists, and that the system may use that theory to normalize an expected material property with respect to a set of contextual conditions. In such a case, the system may skip the process of physico-chemical functional discovery (described in above), and directly encode those functional relationships into the models (subsequently using the machine learning process to learn the appropriate weightings within those physico-chemical functions). In the example given above, this would be equivalent to manually encoding the exponential form of the function into the ensembles of internal functional representations of the models, and subsequently learning the value of a across all categories of material instantiation. Finally, the system 100 may use the depth, x, to implement a normalization calculation.

In some embodiments, simulating the expected properties may include inferring empirically normalized embeddings. It is sometimes the case that the system may use machine learning models to learn encodings (or embeddings) of a set of contextual conditions with respect to a specific prediction, evaluation or recommendation model. These embedding models will receive sensor, material and/or environmental contextual conditions and encode them into an N-dimensional vector-embedding, v, before ingesting that vector as the input to the contextual condition parameters of the chosen prediction, evaluation or recommendation.

The embedding model is an empirically learned set of functional embeddings, that is (in general) an artificial neural network (ANN). The inputs to the ANN are the measured contextual conditions that are required for a specific prediction, evaluation or recommendation model. The outputs of the ANN are a vector of length N, which represents the encoding of the input conditions into the vector, v. The vector, v, is subsequently passed into the prediction, evaluation or recommendation model. The weights of the ANN are learned simultaneously, in the same training procedure and iterations as the weights of the prediction, evaluation and recommendation models.

In some embodiments, simulating the expected properties may include direct contextual normalization. It is sometimes the case that the system does not explicitly encode the internally normalized embedding as a separate model, but where the system may allow the effective internal embedding to be learned in a distributed way across a prediction, evaluation or recommendation model. To do this, the system 100 may simply pass in the contextual conditions directly as inputs to the model, and the system may train that model over the historical data the system may possess (spanning various materials and contextual instantiations). The system 100 may call this method of normalization “direct normalization”, in which the internal weights of the model in question will encode effective normalization calculation in an emergent way, as the model learns to predict, evaluate or recommend over increasing ensembles of data.

As an example, a prediction, evaluation or recommendation model as some function, ƒ, which operates on a vector of input variables, x, and maps those inputs to an m-dimensional vector of output variables, vₘ may be represented. This may be represented in one of these models as follows vₘ=ƒ(x, θ_{S}, θ_{M}, θ_{E}), where the vector, x, will contain any number of measurements or constraints on static or contextual conditions or material properties, and the vectors θ_{S}, θ_{M}, θ_{E} represent the vectors of sensor, material and environmental contextual conditions, respectively, from which the data in x derive. For ease of notation, the system may choose to stack these contextual conditions into a single n-dimensional vector, vₙ, of contextual conditions (in keeping with the notations around contextual embeddings, as described in the previous subsection). In general, the vector vₙ might contain direct measurements of contextual conditions, or it might contain the output of an embedding model (that has been learned in conjunction with the prediction, evaluation or recommendation model, ƒ, as described in the prior subsection).

The function ƒ will generally contain an ensemble of functions derived from all four categories of normalization (where those categories have been described in the previous subsection). It will also, by definition, permit a mapping from any set of θ_{S}, θ_{M}, θ_{E}, to any other set of contextual conditions, such that the system 100 may be able to keep the vector, x, fixed, but modify arbitrary subsets of conditions in vₙ, in order to obtain the vₘ under a different set of contextual conditions.

As described herein, if vector, x, contained temperature time-series measurements for a set of k temperature sensors embedded into a concrete pour. Further, suppose that the vector, x, contained a target 3D location within the body of the concrete pour, and that the model ƒ was trained to output the temperature time-series vector, vₘ, that would be expected at the target location in x, over the same time-window as all input data time series. Further, suppose that the vector vₙ contained the geometry of the concrete, the geographic location of the pour, the date/time at which the pour was made, and the atmospheric weather conditions (e.g., temperature, humidity, wind speed) at that location, and also over the same window of time.

The above example can be used to demonstrate two principal ways in which the models can normalize the output, vₘ, given a set of sensor, material or environmental conditions. In some embodiments, normalizing the output may include direct mapping via the trained model. In the above example, the model, ƒ, has been trained to map the sensor readings from the devices (and associated sensor, material and environmental conditions) to sensor readings at some other set of contextual conditions (in this case, at another location within the pour). Thus, this model “directly” maps the inputs into a “normalized” set of outputs, where the contextual conditions of the normalization are defined by the input vector, x.

In some embodiments, normalizing the output may include multi-dimensional search space over the vector of contextual conditions, vₙ. In the above example, the system 100 may wish to simulate the target temperature time-series, vₙ (defined by the target location in x) but for the situation in which the recorded temperature measurements were taken at different locations in the pour. For example, the system may wish to simulate how a shift in sensor position at some depth would impact the inferred temperature at the surface of the pour. The system 100 may utilize this capability of the model to solve the inverse problem. Namely, the problem in which the system may have measured a temperature time-series at the target location and have found that time-series to differ from a model prediction. A question may arise, such as “what adjustments in contextual conditions would have accounted for this difference?”. This can be solved using all multi-dimensional search techniques described in the mix optimization description. By solving for those adjustments in contextual conditions, the system may be utilizing the inverse-aspect of the normalization process to measure the true contextual conditions, and the system may even use those adjustments to reconcile conflicting information.

As described in detail in the mix optimization description, all the models are generally probabilistic in nature, and are designed to provide insights as to the underlying causal reasons behind an inference (with the aid of causal graph models, built over the space of all trained inputs and outputs for the models).

In general, through use of the generalized differential search mechanisms described with reference to mix optimization, and/or through use of genetic search algorithms described therein, the models described herein are capable of implementing a local or global search over the space of model inputs, so as to gauge the relative sensitivity of the model with respect to any set of modelled outputs. In doing so, the system may construct a sensitivity analysis with respect to a variation over any set of model variables, learning the manner in which a spread on an input will map to a spread in the output of the model. The system may then use that measured model sensitivity to propagate uncertainties on raw sensor measurements into overall probabilistic uncertainties on model outputs (where those raw measurement uncertainties derive from random error and/or from systematic bias).

Through use of the above procedures, the system 100 described herein is able to predict the expected sensor, material or environmental conditions, given some set of sensor measurements and other data, and in a manner that is robust against noisy data. For example, it is possible for the models to predict the “mold type” of a specific concrete pour, using in-situ measurements of contextual conditions (e.g., the model can infer that the concrete pour is a “wall”, by measuring the orientation of the sensor relative to the ground, the physical dimensions of the pour, and the measured temperature fluctuations relative to ambient temperature). It is also possible for the model to be uncertain with respect to contextual conditions (e.g., by not knowing which wall in the structure is being poured, relative to the designed plan). This form of uncertainty constitutes an unconstrained problem set, wherein the information provided is insufficient to solve for the problem of locating a wall element. In this case, the model will output a probability distribution over the set of all possible walls, using the information available to constrain the likelihood over which wall contains the sensors in question.

It is sometimes the case that multiple sources of data can provide conflicting information, the models are operated in a manner such that they flag statistically significant discrepancies of this kind. The primary manner in which discrepancies of this kind are assessed is via execution of the same model multiple times, wherein (for each execution) the system substitutes the variables in question with all possible recorded instances of that measure, taken from all reliable sources.

In this case, if there are y instances of the same measured value, there will be y executions of the model. If there are y₁, y₂, . . , yᵣ instances of r model variables, the model is executed a number of times equal to the product, p, of these counts, such that p=y₁y₂ . . . . yᵣ. Finally, the model assesses the variation in the outputs due to the conflicting information from p executions of the model and estimates the plausibility of those outputs based on their probabilities as assessed at each individual execution of the model. For example, if one vector of conditions, θ has two possible values, θ₁ or θ₂, the model, ƒ, will be executed twice, such that the system may obtain two outputs: v₁=ƒ(x, θ₁), and v₂=ƒ(x, θ₂), wherein the outputs, v₁ and v₂, constitute the assessment of the model, ƒ, at each conflicting value of θ. The probabilistic graph (for details, refer to the Mix Optimization system) over the model, ƒ, is then utilized to obtain a Bayesian conditional probability, P(vᵢ|θᵢ), on the i-th output, given the i-th conflicting variable. Once these probabilities are obtained, the system may use historic measurements of all instances of θ in the dataset, to calculate an empirical quantity for the marginal distribution, P(θᵢ). The system may then use Bayes rule to calculate the ratio of inverse joint probabilities:

$${γ}_{12} = \frac{P ( \begin{matrix}\underline{{θ}_{1}} & \underline{{v}_{1}} )\end{matrix}}{P ( \begin{matrix}\underline{{θ}_{2}} & \underline{{v}_{2}} )\end{matrix}} = \frac{P ( \underline{{v}_{1}} \vert \underline{{θ}_{1}} ) P ( \underline{{θ}_{1}} )}{P ( \underline{{v}_{2}} \vert \underline{{θ}_{2}} ) P ( \underline{{θ}_{2}} )} ,$$

wherein the ratio, γᵢⱼ, denotes the ratio of joint probabilities between the contextual conditions and their associated outputs (for the i-th and the j-th conflicting conditions). The system may thus take the approximation that, as γ₁₂→∞, the first source becomes significantly more reliable than the second, and as γ₁₂→0, the second source becomes significantly more reliable than the first. However, as γ₁₂→1, both sources constitute equal relative reliability.

The automated assessment will then construct a renormalized set of probabilities, P(vᵢ|θᵢ), in which the γ values re-weight the probability distributions. To this end, the model first obtains the weightings βᵢ=Σⱼ γᵢⱼ ∀i≠j, where βᵢ is the sum over all possible pairings for the source, i, and where the system may further construct the value

$${λ}_{i} = \frac{{β}_{i}}{{\sum }_{i} {β}_{i}} ,$$

where the λᵢ are normalized such that they sum to 1 over all possible conflicting sources. The re-weighted probabilities thus map via the following transformation P_{γ}(vᵢ |θᵢ)=λᵢP(vᵢ|θᵢ), and the model uses these reweighted probabilities to determine which value, vᵢ, is more likely, and (by consequence), which conflicting variable is most likely to represent the true state of the system 100.

For example, consider a model that predicts the workability of a concrete mix from the compositional properties of the concrete. The system 100 may supply the compositional properties from the measured batching information, taken from a ready mix supplier at the batching plant. The model then makes a prediction on the workability based on the batching data. However, once the pour is made, the models receive data from an embedded device that is designed to measure the local compositional spectrum of the material (using an embedded LIBS device, for example). The system becomes aware of conflicting information, wherein the batching plant has provided compositional information and the sensors also provide compositional information. The system may execute the model twice, over each possible compositional output. The system may use the probability graph over the model to determine the probability of the outputs given each input. The system may then, as described above, reweight those probabilities based upon the likelihood of the compositional parameters (based on historical data) and the subsequent values. The source with the greatest likelihood is then chosen. However, if the relative likelihoods are sufficiently similar (to within some threshold) the models do not choose until further information is obtained.

In some instances, the models will prioritize conflicting contextual conditions by permitting a user-defined order-of-preference for each possible source of information (i.e., a rule-based hierarchical preference of source). For example, if a model is executing this hierarchical system, the model will encode a ranking over the possible sources of each contextual condition or will encode rules based on the state of those sources. These rankings and rules will cause the relevant source to always override a contextual condition that was obtained from lower ranking information. For example, a model that receives the geometry of a pour as a contextual condition, might initially receive that geometry in a “coarse” or “rough” sense from a BIM, but will later receive in-situ measurements of the geometry from embedded sensors within the relevant pour. In this case, if executing the probabilistic reconciliation described in the prior section, the model will weight the probability of the outcomes based on all information. However, if implementing a rule that states: “Always prioritize an in-situ geometry measurement over a BIM geometry measure”, the model will simply overwrite the BIM-derived data with the relevant in-situ data, as-and-when it becomes available.

Example Contextual Conditions Derived from Sensor Self-Detection and Context Awareness Procedures

There are a multitude of sensor and material contextual conditions that can be measured through sensor self-detection methods described herein. Thus far, the method of using wave-based sensors to infer contextual conditions from sensor data has been described. Further, also described is the concept of normalization, as used by the models. However, there are a plethora of non-wave-based detection methods that the system may also utilize when gathering automated sensor self-detection and context awareness data. Below is a non-exhaustive list of some relevant self-detection data, alongside the methods used for measuring them (which are also non-exhaustive).

In some embodiments, the system may use a pressure sensor to calculate depth/Z. This is a very important coordinate as the various differentials are most sensitive to this axis within concrete elements. The depth of the sensor can also be estimated by analyzing the temperature of the concrete over time. In general, all internal locations within the body of the concrete are at a different temperature than the ambient temperature of the atmosphere. The heat exchange between the outside of the concrete body and the concrete itself leads to a thermal equilibration process, in which the average temperature of the concrete converges towards the average temperature of the local environment. The time for such an equilibration to occur is a function of the mass of concrete that stands between the temperature sensor and the environment. The deeper the sensor, the greater the separating mass, and the longer it takes for the heat to exchange between the environment and the concrete at the sensor's location. Thus, the deeper (conversely, shallower) the sensor, the longer (conversely, shorter) the equilibration time. It is therefore possible to use the measured thermal decay constant from the temperature time-series to measure the depth of the sensor, by measuring the effective thermal mass of concrete between sensor and environment, and by analyzing that thermal mass relative to the geometry of the pour. This is a method of sensor location that therefore uses only temperature over time.

Depth of the sensor can also be estimated based on the time it takes for a mechanical/acoustic, or electromagnetic wave to travel from the sensor to the surface of the concrete and back to the sensor. The impedance mismatch caused by the concrete-air interface would result in some energy passing into the air and most of the energy being reflected back down allowing for the sensor to detect it. The progressive decay of received signal strength of electromagnetic waves such as cellular network signals, nearby Wi-Fᵢ signals and Bluetooth signals would allow to estimate the depth of concrete covering the device, with a larger signal attenuation relative to the baseline before being covered in concrete representing a greater depth. Field data would be used to characterize this to allow for accurate depth estimation. Opportunistic signals may be used.

Relative position may be inferred by using various antennae at both the embedded sensor devices and non-embedded gateways, where each antenna detects the received signal strength and angle of arrival from each other to identify the embedded sensor's relative position with respect to the non-embedded gateway whose position is known from data such as GPS or itself can be inferred using similar trilateration techniques in open air.

In addition but not dependent on, an embedded or non-embedded device including a 360 degree or lower angle camera or LIDAR capable of filming could be used to automatically detect the position of embedded sensors relative to the surface of the poured concrete or other site locations, i.e., sensor depth, distance from formwork, etc. Alternatively, sensor data from the device may be fused with sensor measurements from a mobile phone or personal device (e.g., GPS or camera of the mobile phone). A combination of sensors that can wirelessly synchronize their clocks so as to compare time of arrival of electromagnetic waves, e.g., microwave from Wi-Fi_33 or Bluetooth or longer waves such as cellular network transmissions, so as to ascertain distance between sensors. A similar combination as the above, not requiring clock synchronization but comparing received signal strength of similar external electromagnetic waves so as to ascertain distance between sensors. The system may also use accelerometers, magnetometers and/or gyroscopes to compute orientation of a sensor.

The position of the sensor may have an impact on the measured endogenous data and, as such, the following information may be used. Where the sensor was positioned with regards to rebar-useful if for example the system may be also measuring conductivity or electrical impedance, as rebar can represent the path of least resistance. This can be achieved by doing a multi-input multi-output conductivity or impedance measurement where the conductivity path of many electrodes on the surface of the device are sampled in all permutations so as to know where the conductive material (e.g., rebar) is located relative to the sensor.

The sensor's orientation with regards to magnetic North to make inference of which reinforcement bar the sensor is attached to. This can be achieved with a magnetometer. The sensor's orientation with regards to gravity so as to know if a temperature differential detected within the body of the sensor is due to a horizontal temperature differential or a vertical temperature differential. This can be achieved with an accelerometer that has not had its DC bias filtered out. Generally, any number of inertial sensors may be employed (including gyroscopes, accelerometers, tilt sensors etc.). Similarly, vertical orientation can help to identify the possible causes of a lower radio signal being detected by either the sensor or its corresponding reader device or gateway. In addition, but not dependent on, a non-embedded device including a camera capable of filming and automatically detecting the sensor orientation with respect to other elements in the construction environment and true North either directly or indirectly via other visual references.

Echolocation can be used by devices to detect reflective surfaces such as walls, trees and other objects. This can be the echo of different types of mechanical waves as well as electromagnetic waves. In parallel, principal component analysis of externally induced vibrations can also be used to identify resonant frequencies and as such be able to evaluate pour dimensions (in the same way as the length of a metal bar can be calculated if its material properties are known but not its dimensions). In this way and given the speed of sound in materials such as rebar, liquid concrete and cured concrete, with external sources (whether narrow or broad spectrum), the system may ascertain pour geometry based on propagation time of pulses and/or resulting resonant frequencies (e.g., which frequencies are detected and which ones are not reveal the same of the pour given certain scenarios of its heterogeneous material composition).

Before the concrete is poured, the embedded sensor can emit horizontal beams such as digital laser in order to measure distance in all directions on multiple planes (horizontal, vertical or a rotated version of either). This would provide the sensor detailed information of what surrounds it. In addition, sensors may make themselves detectable to nearby sensors or gateways by ‘blinking’ at a given agreed pseudo-random pattern such that they could ‘know’ their relative positions with respect to each other, allowing therefore to inherit position based from other devices such as the known GPS position of a gateway. Similarly, the above can be combined with camera information captured by cameras on mobile phones using complementary software, e.g., mobile apps used by operatives. Multiple images over time in combination with device accelerometer, magnetometer and/or gyroscope can help to recreate a photo-realistic 3D image of the pour and where sensors are located. In some embodiments, a LIDAR sensor may be added, or replace, the camera.

The sensor itself can be the source of both vibration as well as electromagnetic waves that can be detected both by itself as well as nearby sensors. Each sensor can use a given pseudorandom encoding pattern for both to allow for low energy waves to be detected near the noise floor as well as include a signature to serve as identification of the originating device, e.g., device A (sensor, gateway or other) emitting mechanical or electromagnetic waves, using encoding pattern X and signature A detected by device B (sensor, gateway or other).

In addition, but not dependent on, this could be done using a non-embedded device including a camera capable of filming and automatically detecting the 3D geometry of the slab. In some embodiments, a LIDAR sensor may be added, or replace, the camera.

In some embodiments, a data processor (e.g., the processor described herein) may perform the following processes. Extracting resonant frequencies using fast Fourier transforms. Detecting the presence of particularly short and narrowband pulses using wavelet filters (digital or analogue implementations). Evaluating changes of power distribution across the spectrum as time goes by. Cross-correlation of detected signals with a database of previously characterized signals such as concrete pokers (i.e., metal vibration devices used to remove air in liquid concrete). Auto-correlation of detected signals in order to extract their principal frequency components as well as detecting the presence of delayed and repeated copies of the original signal in the detected signal (e.g., such as how the human brain detects that a person is speaking in a large empty room based on the echo that the room applies to the sound of the speaking person). A neural network implementation of any of the above, either in software or in hardware, itself either in digital circuits or using analogue circuit design.

When either in the drum, inside the concrete pouring duct or once in the concrete, sensors can vibrate, rotate and measure their movement as a result of their mechanical drivers to evaluate viscosity in order to infer workability. Once a sensor is attached to rebar, the vibrating or spinning actuator can be an external device driven by the attached sensor (embedded or not) and the mechanical resistance this actuator encounters by the more or less viscous compound can be measured by measuring the current required to achieve mechanical activation rotations (e.g., stepper motor current consumption) or similar in the case of piston-like mechanisms.

To detect their own position on the site: at a larger scale, sensors could use the received signal strength, time of arrival, and reflection coming from known radio frequency sources such as cellular network antennas, Wi-Fᵢ access points and mobile phone sources, satellite signals (such as satellite constellations) as well as data regarding the known 3D shape of surrounding buildings, to use trilateration and automatically infer where within the building structure the sensor itself is located. (e.g., tri alteration of cellular networks, proximity to other buildings based reflection delays extracted via auto-correlation of raw RF signal received, etc.). Other relevant localization algorithms may include opportunistic navigation and cognitive opportunistic navigation based algorithms and solutions. Optionally, their position on the site can be inferred through comparison to the BIM Model (e.g., the geometry data can be compared to the BIM model, such that the element is matched to the corresponding element in the BIM based on its geometry). More context data/metadata can be used as well to increase the accuracy of the matching. For example, when the sensor was registered & activated, the phone used for registering might have had an altimeter—this altitude data could be used as well. The name of the registered sensor will provide some metadata as well which the system may be able to use, or the time stamp when registered.

Alternatively, the information acquired by all or a subset of the present sensors can be used to generate a BIM model from scratch or from partial information given the information detected such as pour geometry, location, orientation, height given GPS location or trilateration with RF signals, etc. That way, the system 100 may know where the sensor is on the BIM Model/on the construction site as a whole. If a 4D BIM is available, i.e., a 3D model of the building that also includes the time domain schedule of construction, the systems could infer where in the construction schedule the project is at given the concrete pours that are being carried out as well as their location within the 3D structure, e.g., the northwest corner of the 5th floor was poured yesterday, the system may know the process is 25% in building the structure of the 20 story tower. This instantiation could be further augmented using the status inference techniques described herein. In addition but not dependent on, a non-embedded device including a camera capable of filming and automatically identifying construction elements, matching them with BIM model and/or finding the position of the pour in the construction environment.

In some embodiments, a LIDAR sensor may be added in addition to, or in place of, the camera. Any of the following sensing techniques may also be employed for positioning (as described below in greater detail): sensors to gateways that have satellite and radio based positioning systems information (potentially bidirectional), sensors to phones (potentially bidirectional), phones to gateways (bidirectional), sensors to sensors (e.g., one scans while the other broadcasts). Further, in some embodiments, this may include ingestion of floor plan pictures from the field via the app. Further, in some embodiments, sonar sensors may detect 3D space.

In some embodiments, contextualized global location may include how to detect that the global location is on floor X. To detect which floor the pour is located on, the system may use the height (e.g., y-coordinate) of the pour. In addition, if many pours share similar y-coordinates, the model can assume that these pours are likely to be on the same floor. A significant enough change in y-coordinate can thus indicate a change in floor. If this change is followed by more pours with similar y-coordinates to the new one, this increases the likelihood of it being a new floor. Inference may be based on: the surrounding areas detected by cameras, e.g., building across the street; on sound such as loudness and echo of traffic noise; building vibrations e.g., if building happens to be above an underground train, upper floors will vibrate differently to lower floors; Wind differentials across differentials, e.g., higher floors are more exposed; Light differentials, higher floor usually are less likely to be in shadows from other buildings (e.g., time based analysis, sundial of all buildings around w.r.t the camera.)

In order to detect the presence and quantity of rebar (including size of each reinforcement bar) across the concrete pour, the various devices placed within the concrete would each emit a radio frequency signal and would be able to evaluate the presence of rebar based on the comparison of the received signal strength between each other as well as with the external devices such as mobile phones and gateways, e.g., if the signals between embedded devices are more attenuated than usual, given a known distance or relative to the attenuation detected with non-embedded devices such as gateways and mobile phones, then the system would infer larger quantities of RF attenuating material such as rebar or steel fiber mix.

In addition, analysis of the mechanical waves either reflections of the signal's own emissions or detecting those of nearby devices would allow to measure: received signal strength, time of arrival, speed of the various frequency components of said signals, signal reflections and their amplitudes and delays, i.e., detected with signal auto correlations, and/or angle of arrival calculations using multiple piezoelectric or equivalent sensors for mechanical vibrations on each device.

In addition but not dependent on, a non-embedded device including a camera capable of filming and automatically detecting rebar content in the area later covered by the poured concrete. In some embodiments, this may include using a LIDAR sensor added or instead of the camera. A device and loop antenna to measure mutual inductance and/or coupling coefficient in order to detect rebar loops in the pour. Electrical pulses may be propagated throughout the element to measure conducting properties of the rebar. May use expected thermodynamic profile and measured thermodynamic profile to compare and extract rebar thermal properties such as heat dissipation of rebar.

A device and loop antenna to measure mutual inductance in order to detect the reduction in water over time as the change in medium will result in a changing medium electro-magnetic impedance changing the inductance and coupling coefficient. An embeddable or non-embeddable sensor device, cable extension, or both, to measure conductivity of the concrete at both DC voltage, e.g., electrolysis, as well as various frequencies to detect the presence of moving charged particles as well as dielectric constants of electromagnetic waves. A conductivity sensor and signal processing trained on a dataset to correlate conductivity of different material types or mixes with water content (that may optionally leverage mix fingerprinting).

This could be worked out using computer vision from photos and videos from the outside. When setting up, the user can be asked to take a picture of the slab, which would be uploaded and analyzed using computer vision. In addition but not dependent on, there may also be on-site CCTVs, or could install cameras mounted on cranes that overlook the site. Could also be cameras on hard hats/body cams. In some embodiments, a LIDAR sensor may be added, or replace, the camera.

When the system has the geometry of the pour and its position within the environment in memory, it would be able to compare its expected thermodynamic behavior (e.g., heat generation and dissipation rates) and compare it against actual heat characteristics so as to ascertain if insulating, heating or cooling blankets are being used. In some embodiments, this may include embedded sensors using the attenuation of environmental electromagnetic signals when the heating blankets that contain wires are placed on top of the concrete.

In the case of precast concrete units, these are sometimes held in place by large metal structures. The presence of said structures can be detected based on the propagation of electromagnetic and mechanical waves so as to ascertain when they were installed and removed as well as their position relative to the units and in absolute terms within the structure.

In addition but not dependent on, a non-embedded device including a camera capable of filming and automatically detecting backpropping/temporary works related to the pours or precast units relative to the camera position and relative to other construction elements as well as in absolute value in the BIM model. In some embodiments, a LIDAR sensor may be added, or replace, the camera.

The presence of other nearby sensors carrying out self-detection before concrete is poured is likely to give away their position as well as the status of the construction process in their area (which may be augmented using Status Inference system or may be used to make status inferences as part of the system described herein), e.g., sensors installed but concrete not poured yet. This can be detected by non-embedded gateways and devices as well as embedded devices that happen to detect the mechanical and electromagnetic waves generated by other sensors. Overall this approach allows to ascertain both location as well as status in the production process.

In addition but not dependent on, a non-embedded device including a camera capable of filming and automatically detecting adjacent pours relative to the camera position and relative to other pours and in absolute value in the BIM model. In some embodiments, this may include a LIDAR sensor added or instead of the camera. Once the geometry of the pour and the environmental weather are known, it is possible to infer the type of formwork used given the heat conductivity of said formwork. Similarly, metal formwork would result in sharper mechanical/acoustic reflections as well as larger radio frequency reflections meaning that the aforementioned pour geometry inference methods would allow to infer whether the formwork was made out of wood, metal or other material of different mechanical, thermodynamic and electromagnetic properties.

In some embodiments, the formwork material may be determined. For instance, the system may be able to determine which brand of formwork is being used as the systems characterize increasing formwork types in various geometries. As the formwork properties are characterized, these will inform where the largest differentiating characteristics are and therefore guide the choice of excitation frequencies in both mechanical as well as electromagnetic waves. In addition, but not dependent on, a non-embedded device including a camera capable of filming formwork and automatically: label the formwork in the image, ascertain the position in the formwork in 3D space relative to the camera as well as relative to the concrete pour and in absolute value in the BIM model, and/or identify the material of the formwork and brand. In some embodiments, this may include using a LIDAR sensor in addition or instead of the camera. The use of an identifying tag on the formwork (RFID, Bluetooth or otherwise) configured to advertise the formwork type (and reference a 3D model, embedded in the sensor's local memory, or available on the internet). The tag could be detected by the sensor.

The device's awareness of its position in the world, height and location within the building structure would inform its knowledge of how the overall weather, elevation driven wind exposure and orientation (e.g., south facing) would impact the thermal and ambient humidity characteristics, e.g., higher wind chill and greater temperature fluctuations and changes in concrete dehydration process if on a higher floor, south facing part of the building in a location with strong gusts of wind and near the sea with wind coming from the ocean.

The embedded and non-embedded devices can passively detect and keep track of events such as the presence of other electronic devices, e.g., tools, plant machinery and personal devices, based on their electromagnetic (EM) or acoustic signatures, e.g., Wi-Fi, Bluetooth beacons or other EM signature such as wireless controllers or engine vibrations/sounds. These can be used as complementary information to infer the progress and status of the construction process in that area of the construction site. The use of acoustic sensing and the relevant signal processing can be used to infer and classify other types of nearby events (e.g., drilling, striking or other activities that generate a unique acoustic profile).

The system described herein is a collection of sensing devices, with associated data processing, to measure all or a specific combination of the above. These sensing devices could be embedded, surface mounted or even directed at the concrete element from afar (e.g., camera to detect 3D geometry from outside), and data processing will include some computer vision method and/or other data processing techniques for recognition of slab insulation & formwork. Depending on the implementation, and the variables being sensed, the systems described herein could even be limited to a single embedded device, or a single surface mounted device-essentially any combination of these different devices.

In addition, in one instantiation of this system, the sensing devices may also passively detect external signals such as received signal strength from cellular network towers and Wi-Fᵢ access points as well as mechanical vibrations caused by other external factors, as such making them passive sensing devices requiring minimal power to extract more information from its surroundings without having to emit any energy, i.e., sensing only.

The self-detection parameters listed above provide context to a sensor's local surroundings, such that what is being monitored by the sensor can be normalized/controlled for using this data. Furthermore, these parameters can be used to train any model which is trying to understand the behavior of concrete in function to its local and extended surroundings.

In certain cases, the data from some sensors or devices, e.g., gateways or personal devices such as smartphones, can be shared with their neighbors so as for these to do inference in a distributed way, e.g., a gateway or smartphone communicating its GPS location to all the embedded sensors so that the embedded devices keep this in memory even if the gateway is removed later.

Furthermore, knowing the location of a sensor on the construction site is useful in and of itself, as contractors often lose/forget where sensors are located, which slows down data collection if hubs aren't present nearby to transmit data automatically. It is also more convenient for Quality Assurance and record keeping purposes to have a system which self-detects.

### Hardware and Example Relevant Applications

In addition to the customized hardware sensors that have been designed in this system (as described herein), the system may also utilize pre-existing hardware in conjunction with the system's customized embedded and external measurement devices. The following are some examples of pre-existing hardware that is used in conjunction with out customized hardware and models in order to detect sensor depth, orientation and position. A depth detection mechanism that employs one or more of the following techniques is considered. One or more Barometric pressure sensors are used to provide a low power high precision measurement of pressure, both before, during and after the concrete has been poured. Using various signal processing methods, and optionally, a machine learning model, the pressure profile can be used to determine the depth within a concrete element, as well as the rate of pouring. As concrete is poured, and the concrete is in its liquid state, the hydrostatic pressure will increase proportionally to depth (assuming that the concrete behaves like a liquid, P=H*ρ*g, where H is the height of the concrete column above the pressure sensor, p is the density of the concrete (which may be predetermined, or determined by the system itself), and g is the gravitational constant). The speed at which the hydrostatic pressure increases will relate to the rate of pouring and to the geometry of the element (specifically the cross sectional area, in a rectangular element). This means that if the rate of pouring is known, then volume of the element can also be computed. Alternatively, the pressure measurement, coupled with other measurements can be used to derive the full geometry and position. As the concrete begins to cure and gain strength, the hydrostatic pressure will decrease. This will relate to the rate of curing, which can be used to augment measurements related to the curing state (e.g., enhanced maturity). These are illustrative methods, and several other characteristics can be derived from a pressure sensor.

Alternatively, time of flight based measurements may be used to map the depth and/or geometry of the concrete element. This can be done with the BLE radio (which is already onboard for communication purposes). A more precise measurement would make use of ultrawideband, reducing from meters, down to millimeter precision positioning, depth measurement and geometry measurement for a concrete element. Generally, the different localization techniques described elsewhere (such as trilateration and quadrilateration, angle of arrival and time of flight-based methods) may be employed. Radar and other RF wave based techniques may be employed, and time domain reflectometry may be used to measure and map rebar configurations as well as geometry, position and depth within a pour.

Wave echoes (both mechanical and electromagnetic) will depend on the geometry of the concrete element. Reflections happen when two materials present a difference in wave impedance (mechanical, acoustic or electromagnetic wave impedance). So if TX and RX happen in the same device, the portion and amplitude of the reflected wave depends on obstacles and material transitions (concrete/air). Hence orientation will have a massive impact on the quality of the received signal. Rebars and other obstacles will also count. Orientation can thus be measured using inertial sensors. Sensor/actuator arrays and/or adaptive antennas can be used in wave-based sensing applications to direct the signal based on orientation measurements.

The following devices are those that are used to aid in the positional location of a sensor or its local environment. These examples are broken down into devices that measure the altitude and relative positioning within a structure (i.e., the “indoor positioning”). The following provides non-limiting information for example purposes only relating to the accuracy and precision of certain devices. The ICP-10125 may include an altitude relative accuracy of 8.5 cm; resolution of <1 mm; and be 10 atm waterproof. The DPS310 may include an altitude relative accuracy of 50 cm; altitude precision of 2 cm; and resolution of <1 mm. The UWB TRIMENSION™ SR150 AND SR040 may include 10 cm accuracy; LaterationXYZ may include <1 mm accuracy; DW3000 IC or module may include 5-10 cm accuracy; BU01 module may include 10 cm accuracy; Radars: A121—Pulsed Coherent Radar (PCR): mm accuracy; Acoustic: Zerokey solution 1.5 mm accuracy.

### Decision Engines

A system composed of a network of sensors, alongside a computer implemented method, for the determination of the context awareness (e.g., sensor self-detection, sensor situation awareness, and/or the like) of said network of sensors, alongside an associated action. Based on the context awareness generated, a computer implemented method is used to generate action options and recommend the “optimal” action(s) to be taken. The action is then automatically undertaken by the sensor and compute network. Finally, an automatic evaluation of the action's success is generated. In more detail the following describe the various parts of the system.

The various inputs listed above will be ingested by an “inference engine” (e.g., the processor 202 described herein). The role of the inference engine is to generate “context insights”, based on all the data above. In some instantiations there may exist a feedback loop between the inference engine and the context insights using historical context data. The action engine (e.g., the processor 202 described herein) takes context insight & training data as inputs, and recommends an action based upon this insight. The action engine is broken down into two principal parts, the scenario generation engine (e.g., the processor described herein) may, based upon ingested context insight, generate the potential action scenarios which could be taken. The recommendation engine (e.g., processor described herein) may, based upon the context insight and the potential action scenarios, select the “optimal” action, and send it to the relevant entity for execution. Once the action has been executed, the evaluation engine (e.g., the processor described herein) scores the success of the action, and feeds the result back to the action engine, creating a feedback loop until the action has been successfully completed.

In case of action non-completion due to missing information, an information request will be generated and inputted into a query engine (e.g., the processor described herein). This engine will scrape data from site records (photos, documentation, BIM, etc.) and attempt to answer the query. This answer will be fed back into the action engine, such that new scenarios may be created and executed based on the new information.

### Use-Case Summary

Many use cases may exist for Sensor Context Awareness. Below is a list of five major use cases. This list is not exhaustive and is meant to illustrate some key paths of applicability. Specific use cases may take the form of particular instantiations of these or any combination of these categories used in conjunction sequentially or simultaneously or any other conceivable instantiations of other categories. In some embodiments, Static Tuning (e.g., standard normalization) may include, for example, normalizing temperature profile for geometry so the system can identify material effectively. In some embodiments, Dynamic Tuning (e.g., controlling for time-evolving factors) may include, for example, controlling for weather (e.g., normalize for the weather changing), mix optimization (e.g., tuning optimal mix, conditioning for the weather, which could fall under E-Data/E-Insight), mix fingerprinting (e.g., the same “mix” may exhibit different characteristics depending on P-Data or S-Data or E-data, so will need to control for this), positioning, and capturing timing of different events (e.g., ‘start strength’ event for a maturity sensor being covered in concrete).

In some embodiments, the system may automate an end-user action, such as Quality Assurance (QA) & UX-based prompts and alerts, automatically locating a sensor or element (and optionally positioning it on a BIM model or floorplan, accessible through a web platform), and/or automatically generating a QA record. In some embodiments, the system may reconfigure a sensor, connected sensor, or system of sensors. Reconfiguring the RF amplification emitted by a sensor device may be based on, for example, collected data about the material (e.g., water to cement ratio), and RF noise from surrounding people, devices, or the like. Sensor self-actuation may include a propulsion system that is activated based on material characteristics measured by sensor to navigate itself through fresh concrete, and/or sensor device vibrating to ensure concrete is compacted properly around it. A distributed sensor network reconfiguration may include a series of devices reorienting a mechanical or electromagnetic wave towards an element of interest, based on context awareness insights, through adaptive lenses or phased array antennas on each device in the network. Antenna tuning may include a sensor tuning its antenna to optimize connection, or to synchronize itself with a signal live detected in the adjacent pour to optimize energy consumption. In some embodiments, the system may verify an even has occurred according to expectations. For instance, the system may use data about the material and pour to confirm that a pour has indeed happened and/or use cameras to confirm formwork has been installed properly. In some embodiments, the system may correct conflicting information about the same data. For instance, certain elements might not be listed on the BIM Model, and the system may use data about the environment and the pour can add them to the BIM. Further, certain dimensions are conflicting with the measured dimensions from in-situ sensor measurements. The system may reconcile those conflicts using probabilistic reasoning.

### Non-Exhaustive and Illustrative Deployment Modes and Use-Case Decision Categories

Some non-exhaustive examples of sensor types that may be used for context awareness include: cameras only approach, LIDAR only approach, wave-based sensors only approach, embedded sensors only approach, embedded and non-embedded sensors or gateways, personal, device sensors only approach, any permutation of the above.

In the same manner, the following illustrates some general classifications of example sensor context awareness decision systems. These might include monitoring progress of construction based on Materials and/or local events such as presence and activity of tools, plant machinery or operatives; monitoring good placement of sensors; compensating Maturity Method or an enhanced maturity method for pour geometry, exposure to the elements, formwork thermodynamics and other factors; normalizing data that are useful for other methods (as described above); monitoring any combination or permutation of the aforementioned parameters to track progress, quality, improve traceability and/or safety of the structure and operatives; any combination of the above.

### Sensor Context Awareness Flowcharts

As discussed with reference to FIG. 1 above, the system 100 may further the one or more sensor devices 102a-n, which may further be configured to generate data entries indicative of the context of the sensor devices 102a-n or otherwise indicative of one or more conditions of the building material as described hereinafter. As described above, the one or more sensor devices 102a-n may generate data entries (e.g., first data entries, second data entries, nth data entries) associated with respective measurement types of the building material. The system 100, in some embodiments, may use the data generated by these sensor devices 102a-n to normalize the datasets generated by the one or more sensor devices 102a-n. By way of a non-limiting example, the one or more sensor devices 102a-n may generate data entire that are indicative of the relative position of the respective sensor device 102a-n relative the FIG. 51 illustrates a flowchart containing a series of operations for an example method for sensor context awareness (e.g., method 5100). The operations illustrated in FIG. 51 may, for example, be performed by, with the assistance of, and/or under the control of an apparatus (e.g., server 200), as described above. In this regard, performance of the operations may invoke one or more of processor 202, memory 206, communication interface 204, and/or machine learning (ML) module 208.

As shown in operation 5102 and 5104, the apparatus (e.g., server 200) includes means, such as processor 202, or the like, for receiving a first dataset and a second dataset including one or more respective data entries. As would be evident to one of ordinary skill in the art in light of the present disclosure, the server 200 may receive data generated by any of the sensor devices described herein, such as described with reference to system hardware, via any know communication technique. In some instances, the datasets may be iteratively received from the sensor devices 102a-102n.

As shown in operation 5106, the apparatus (e.g., server 200) includes means, such as processor 202, or the like, for generating sensor context awareness data based on the one or more first data entries of the first dataset and/or the one or more data entries of the second dataset. As described above, the sensor-context awareness techniques of the present disclosure may leverage any of the machine learning (ML) models described herein. Furthermore, the sensor context awareness techniques may also leverage various other techniques (e.g., mix fingerprinting, mix optimization, etc.) in order to generate sensor context awareness data. By way of a continued, non-limiting example, the sensor context awareness data may be indicative of the position of the sensor device within, on, or relative to the building material, such as in (x, y, z) coordinates. For example, the system 100 may implemented a pressure sensor configured to generate data indicative of the depth (z coordinate) of the sensor device relative the building material. Additionally or alternatively, in some embodiments, the depth of the sensor device relative the building material may be estimated based on a time required for a mechanical/acoustic wave to travel from the sensor device to the surface of the building material and back to the sensor device. The present disclosure contemplates that the impedance mismatch caused by the concrete-air interface may result in some energy lost into the external environment with the majority of the energy being reflected back down allowing toward the sensor device for detection.

As shown in operation 5108, the apparatus (e.g., server 200) includes means, such as processor 202, or the like, for performing one or more normalization operations on the first dataset based on the sensor context awareness data. By way of another, nonlimiting example, the first data generated by the sensor devices 102a-n may be at least partially impacted by one or more of the various sources of sensor context awareness data. By way of example, the first dataset may comprise one or more first data entries associated with a temperature based first measurement type of the building material. This building material, or a portion thereof, may be, for example, cover with a blanket as described above. As such, the temperature values generated by a sensor device 102a-n associated with such a building material may generate first data entries associated with temperature values that are greater than those of a similar temperature based sensor device associated with a building material that is uncovered. Additionally or alternatively, the sensor device 102a-n may be embedded within the building material such that the relative position of the sensor device 102a-n within the building material impacts or influences the first data generated by the sensor device 102a-n associated with temperature. In order to account for the impact of these factors, conditions, etc. associated with the sensor device 102a-n, the building material, and/or the environment of the building material, the server 200 may normalize the first dataset based upon the self-detection data.

As shown in operation 5110, the apparatus (e.g., server 200) includes means, such as processor 202, or the like, for determining a position of the first sensor device within the building material. As described above, in some instances, the example sensor device that generates the first and/or second dataset may be at least partially embedded in the building material. As such, by way of a non-limiting example, the generation of sensor context awareness data may be indicative of the relative position (e.g., x, y, and z coordinates for example) for the sensor device. The present disclosure contemplates that the sensor context awareness data generated and used in FIG. 51 may be associated with any contextual condition or other self-detection related concept described herein without limitation.

FIG. 52 illustrates a flowchart containing a series of operations for an example method for sensor context awareness (e.g., method 5200). The operations illustrated in FIG. 52 may, for example, be performed by, with the assistance of, and/or under the control of an apparatus (e.g., server 200), as described above. In this regard, performance of the operations may invoke one or more of processor 202, memory 206, communication interface 204, and/or machine learning (ML) module 208.

As shown in operations 5202 and 5204, the apparatus (e.g., server 200) includes means, such as processor 202, or the like, for accessing a spatial representation implicating the building materials and the first sensor device and updating the spatial representation based on the generated sensor context awareness data. For example the sensor context awareness data may be indicative of the three dimensional (3D) geometry of the building material (e.g., the shape of the pour or slab). Additionally or alternatively, the sensor context awareness data generated in FIG. 51 may be used in conjunction with one or more Building Information Modeling (BIM) systems (e.g., an example spatial representation). For example, the self-detection described above with respect to geometry may be compared to an example BIM model, such that the element is matched to the corresponding element in the BIM based on its geometry. As such, the sensor context awareness data may, at operation 5204, operate to update the spatial representation (e.g., a BIM or the like).

### Mix Fingerprinting

As used herein, a “data engine” may refer to a data aggregation system that combines material measurements (including measurements related to material properties sourced from sensor devices), material & device contextual conditions (including those derived from measurements), historical knowledge (including prior knowledge about the material under consideration, and also knowledge and measurements about prior materials), any expectations and requirements for the material under consideration, and user defined parameters about the desired identification representation and classification system, alongside other related data. This data is prepared and aggregated into a unified format, ready for processing.

As used herein, an “AI Engine” may refer to an Artificial Intelligence Engine (made up of one or more models and optionally an orchestration layer) that parses the data from the Data Engine and performs the inference required to deliver an absolute fingerprinting mode and a perturbative fingerprinting mode. In the absolute fingerprinting mode, the goal of the system is to determine a material identifier and to (optionally) classify the material. The absolute identifier determination is made on the basis of measurements of the material & contextual conditions (for the material and sensor devices used). In addition, in absolute fingerprinting mode, the models can generate a representation of mix-space, and a classification system. In the perturbative fingerprinting mode, the goal of the system is to detect relative material changes (so called ‘perturbations’ or ‘perturbative’ changes to materials, or anomalies) against a target or expected material. Optionally, the material expectation or target can also be generated by the system. In addition, perturbative fingerprinting can detect the cause of an anomaly or perturbation (through causal analysis of the data) and can recommend a compensatory action (an action to revert to the expectation/target).

In some embodiments, the system may leverage generative models (e.g., in both example absolute and perturbative modes) in which a generative model is used to determine missing data and/or data gaps. A Generative Model Engine of the present disclosure may be generated over continuous material and mix identification, with the intent to complete missing data or to aid the mix optimization and/or mix fingerprinting operations described herein. The Generative Model Engine may include an ensemble of model types, ranging from probabilistic (which assess the information-theoretic meaning of missing data, based on the available corpus of data), to empirical (which generate empirical mappings between data and mix designs, based on an available corpus of training data).

Embodiments of the present disclosure pertain to an advanced system for monitoring concrete structures, utilizing artificial intelligence (AI) and a network of sensor devices. The system may be designed to analyze and report on various aspects of concrete's physical and temporal material properties throughout its lifecycle.

The core of the present disclosure is an AI Engine (e.g., the processor described herein), which may be trained on a substantial corpus of pre-existing data. This training equips the AI Engine with the capability to analyze and interpret data collected from concrete structures. In this regard, sensor devices may be strategically installed throughout the concrete's physical embodiment and across its temporal lifecycle. This includes, but is not limited to, the concrete pouring stage, where these devices can be embedded in, mounted on, or directed towards the concrete. These sensor devices may be designed to collect comprehensive data on various material properties relevant to the concrete curing process. The types of data gathered may include, but are not limited to, measurements of temperature, ultrasonics, and impedance (including mechanical, electrical, electrochemical, wave-impedance, acoustic, elastic, and magnetic impedance), along with conductivity, pH levels, and various forms of spectroscopy and imaging (including hyperspectral imaging). The device data measurement types, as detailed herein, are applicable here, encompassing outputs from wave-based sensors. In addition to these measurements, the sensor devices may also be also capable of collecting data related to the concrete's position, orientation, geometry, and formwork. This may include employing context awareness models, methods, and devices to understand sensor contextual conditions (pertaining to the sensor itself) and material contextual conditions (related to the local material volume under observation). These measurements may provide a comprehensive overview of the concrete structure's condition and behavior over time.

In some embodiments, the system, in addition to collecting measurements, may gather data from a variety of sources. These sources may include documents such as Building Information Modeling (BIM) data, schedules, quality records, mix designs, batching records, and/or the like. Human-input data (for example, forms) and third-party data sources (such as weather APIs) may also be integrated. Additionally, outputs from other models described herein are considered. The types of data collected may encompass, but are not limited to, location, date and time, details from BIM, pour layout (refer to diagrams provided), and weather conditions including temperature and air's relative humidity.

The multivariate data streams thus collected may then be served to the data engine. The data engine may combine these diverse data types, including measurements, documents, human-input data, third-party data, and model output data. This combination may inform several model inputs: (1) material measurements, (2) contextual conditions (material & device), (3) historical data (including prior knowledge about the material under consideration and historical materials), (4) expectations & requirements, (5) parameters related to the desired identification representation & classification system, and/or (6) other data such as output from other models. In some embodiments, the model inputs are then transformed into a proprietary data schema in preparation to be fed as input to the AI Engine and its models. A key model within this system is the mix identification/perturbation detector.

In some embodiments, the mix identification engine and the mix perturbation detector may be configured to recognize patterns within multivariate data and map these patterns onto material properties that define a concrete mix or material. This process facilitates the determination of the identifier for the likely concrete mix or material. The operation commonly referred to as ‘fingerprinting’ may encompass this methodology. Fingerprinting may encompass a variety of methodologies. For instance, one approach may involve using sensor measurements (e.g., strain gauges, viscosity, acoustic, resistivity, temperature sensors) to report on the physical properties such as fineness, strength, durability, and workability. These properties can then be used to deduce possible material compositions through a supervised machine learning (ML) model that has been trained on example data. The ML model may establish a linkage between the physical properties and corresponding potential candidate compositions. Another approach for fingerprinting may involve using sensor data (such as from spectroscopy, acoustic, resistivity, and temperature sensors) to analyze the chemical composition of the sample material. This chemical composition can then be utilized to infer possible physical properties, again using a supervised ML model trained on example datasets. In this scenario, the ML model may map the material composition to the corresponding candidate compositions. Moreover, a combination of these two methods can be applied to reduce uncertainty and improve the sensitivity and specificity of fingerprinting. These examples are representative of fingerprinting by composition, each illustrating a different basis or representation of composition. In example embodiments, fingerprinting can also be performed in property representation, arbitrary identifier (name) representation space, or an entirely different representation space.

Additionally, the Generative Model may be employed at any stage of this process to augment incomplete or low-quality datasets, thereby enhancing the performance and output of the AI Engine models. Following each successful identification, there may be the possibility of updating or retraining the AI Engine to maintain or improve its efficacy.

### Example System Details, Inputs and Outputs

### Example Inputs

Concrete, being a composite material comprising various constituents, presents complexities in modeling or predicting its behavior. Additionally, the environment of a concrete pour, notably the construction site, constitutes a complex and variable system. Consequently, numerous contextual conditions and diverse types of measured data must be processed by the AI engine (e.g., the processor described herein). This processing is essential for accurately parsing and understanding the identifiable aspects of any given concrete mix design. The AI engine's ability to effectively navigate and interpret this multifaceted data landscape is crucial for reliable and precise identification and analysis of concrete material properties in varying environmental and compositional scenarios.

In some embodiments, the input data for the AI engine may be classified into two primary categories, contextual condition data and measurements. Contextual condition data may encompass information unrelated to the compositional or material properties of the concrete, or the properties of the device itself, thereby characterizing the specific instantiation of its use-case at any given time. In example embodiments, the contextual condition data may include material contextual conditions and device contextual conditions. Material contextual conditions may include the shape of the concrete, its geographic location, the time of year it is poured, or the ambient weather temperature. Device contextual conditions may include the location or orientation of the sensor. Contextual conditions may be derived from various sources, including measurements, documents, human-input data, third-party data, and outputs of other models. Examples of key categories may include location+organization (via GPS or radio frequency signal trilateration), pour (matching location or geometry to pour plans, BIM, or images), batch (from label pictures), date and time (via synchronization with devices like GPS, NTP servers), construction schedule (integration with systems like Primavera P6 or OCR of paper schedules), drawings and specifications (through digital integration, image recognition, OCR), climate (assessed via GPS and sensors for micro-climates), weather status and forecast (via climate data and weather services), temperature (local conditions, swings, shadows, airflow, heat sources), wind chill (via anemometers, humidity sensors), ambient conditions (external vibrations, sunlight exposure), and/or the like.

Measurements may encompass sensor data of various kinds, including measurements from various embodiments and hardware devices described in other sections (including wave-based sensors). For instance, measurements may include sensor measurements based on continuous time or high sampling frequency data, such as composition (via different types of spectroscopy), temperature (via thermocouples, thermistors or high resolution digital temperature sensors), conductivity and electromechanical impedance (via electrodes driving DC or AC voltages and various negative terminals with current meters to evaluate the path resistance for each anode to cathode pair), mutual inductance and coupling index (via RF driver and loop antenna to detect changes in mutual inductance in the presence of rebar and other conducting or ferromagnetic bodies), electromechanical impedance and ultrasonics (via piezoelectric, normal microphone and hydrophone sensors), pH (via digital pH sensors, ion-sensitive field-effect transistor (ISFET), and image processing solution of dipstick pH tests), pressure and mechanical (e.g., acoustic) vibrations (via piezoelectric sensors wireless surface acoustic wave (SAW) sensor), electrochemical impedance, electromagnetic wave impedance, acoustic impedance, elastic impedance, magnetic impedance, hyperspectral imaging, and/or the like form the vector space of time-series data. In another instance, measurements may include sensor measurements based on discrete time or lower sampling frequency data, such as spectroscopy (including LIBS), NMR, Imaging (IR, visual spectrum), colorimetry, and/or the like form the vector space of spatio-temporal data. In yet another instance, measurements may include sensor measurements from context awareness such as position of the device in relation to the concrete pour or truck, whether it is within, on, or nearby, the orientation of the device in similar contexts, element matching with BIM and/or position of the pour, content and properties of rebar within the concrete, the geometry of the pour, the types and properties of insulation or formwork used, the time of the first pour, details about backpropping or temporary works related to the pour, information about adjacent pours or elements (either through BIM matching or other means), and/or the like form of the vector space or scalar data.

Other inputs to the system may include a variety of data types, including historical data, expectations and requirements, identification representation parameters, classification system parameters, and others, such as outputs from other models.

Historical data may be categorized into priors or prior knowledge about the material under consideration, and knowledge about previously identified materials. Prior knowledge may include information on material properties, contextual conditions, and compositional properties, which can range from known facts to probabilistic or low-confidence information. Optionally, priors may be accompanied by a confidence level. These priors can be instrumental in refining the identification process. Knowledge about previously identified materials may be used for training and updating the AI models. The training dataset, which is continuously expanding with every new identification, may include measurements and labeled identifications of prior materials. Additionally, historical data relating to pre-existing materials can be directly inputted into the system, particularly when establishing material identifier expectations for a specific project site.

Expectations and requirements may be useful inputs, especially in perturbative cases. They relate to the anticipated properties of a target material in a given contextual condition. These expectations can cover a range of aspects, including compositional properties, material properties (both static and contextual), identifiers, sensor signals, and contextual conditions, or they may pertain to an arbitrary representation of mix space. Requirements, akin to expectations, may be derived from specifications and other documents.

Identification representation parameters may be used to guide the model to the desired identification representation. These parameters can range from fully specified representations (e.g., identification based on specific material properties) to more flexible criteria, leaving the exact representation to the model's discretion. Parameters may include the type of representation (e.g. by property, sensor signal, composition, and/or the like), desired basis (if known), and level of granularity. The model's output may vary depending on the specificity of the representation parameters provided. For instance, if a fully defined representation (e.g., identification of materials based on their 28-day cylinder strength, workability after 6h, and shrinkage after 28 days) is provided, the output of the model will be provided in that representation. On the other hand, a loosely defined or absent representation may allow the model to determine the most suitable output. For example, if no representation is provided, the model may output a representation. If representation parameters are loosely provided, then the model may be directed towards a particular representation.

Classification system parameters may be analogous to representation parameters but apply to the classification systems defined over these representations. These parameters can be left unspecified, allowing the model to choose the optimal classification system, partially defined to indicate a preference, or fully defined to ensure outputs in a particular classification system. Finally, other inputs include outputs from other models, which may further inform and refine the system's processing and identification capabilities.

Data for the system may be aggregated from a multitude of sources and through various means such as devices, documents, human-input, third party integrations, and other models. Techniques for sensor data collection and transmission, as detailed herein, may be utilized to gather measurements from sensor devices. These devices may be strategically deployed at every stage of the concrete or material value chain, providing a continuous stream of data throughout the process. Documents may be obtained at both the inception and during the course of a project. Methods of retrieval may include document uploads, emailing documents to a server, photographing documents, and scraping servers. Once acquired, these documents may be processed through image processing and Optical Character Recognition (OCR) or interpreted using advanced language models, such as Large Language Models (LLMs). Additionally, documents may be parsed in specific cases, like BIM models, which may include the capability of auto-detecting unit naming conventions. Data may also be collected from human interactions, such as through forms or chat-like interfaces, with the assistance of LLMs and similar technologies. This human-input data provides valuable insights and complements the automated data collection methods. The system may also be integrated with external data systems via APIs (e.g., meteorological data may be retrieved from climate and weather service APIs). This integration ensures that the system has access to real-time and relevant environmental data that might impact the concrete or material properties. Outputs from other models within the system are also incorporated as part of the data collection. These models provide additional layers of analysis and interpretation, enriching the overall data set used for decision-making and predictions.

### Example System and Outputs

In some embodiments, as described herein, the system may include a data engine (for data aggregation and preparation), and an AI engine. The AI Engine may further be divided into two distinct modes: (1) absolute fingerprinting and (2) perturbative fingerprinting. Each mode may incorporate four specialized models. Additionally, an orchestration system may be used to facilitate interaction between these models, and a generative model may be used to address data gaps. In the absolute fingerprinting mode, the models may include (i) the representation generator; (ii) the classification system generator; (iii) the material identification engine; and (iv) the material classification engine. These models may collectively contribute to the comprehensive identification and classification of materials in a non-perturbative context. In the perturbative fingerprinting mode, the models may include (i) the expectation determinator, which establishes the anticipated outcomes or material properties; (ii) the perturbation detector, designed to identify deviations or anomalies; (iii) the perturbation cause analyzer, which delves into the underlying causes of detected perturbations; and (iv) the compensation recommendation engine, which proposes solutions or adjustments to counter the identified perturbations.

### Example Data Engine

The Data Engine may be used to process and prepare data for analysis by the AI Engine. In some embodiments, the scalar data, which may include contextual conditions and related measurements, may be parsed through a data mapper. This data may then be formatted into the converge data schema. Once cast into this schema, the AI Engine may engage in a pre-filtering process, the extent of which depends on the specific use-case requirements of the AI Engine.

The sensor data may be represented as a multivariate N-dimensional vector space of time-series data. Each vector in this space, potentially sampled at varying rates, may correspond to a different type of data (like temperature or ultrasonics) taken at each physical location. The system may handle a multitude of these N-vectors, with M representing the number of spatial locations sampled, either within or outside a concrete pour. This may include the handling of spatio-temporal data (such as from spectroscopy, imaging, or infra-red sensors), impedance data (which are complex numbers), and other irregular data values. These data may be sampled and formatted in a way that the system, using attendant physics models, can interpret to represent conditions. The vector spaces, or signals, are generally not orthogonal, and any correlation between signals may be managed through dimensionality reduction techniques.

In embodiments where further feature engineering is warranted, the signals may undergo transformations as necessary, including normalization, standardization, Fourier transforms, and/or the like. Scalar features may then be extracted and sent to the data parser for interpretation through the internal schema.

An input vector, X, is subsequently composed. This vector may combine the mapped vector of scalar data and the transformed time-series signal vector, readying it to be input into the AI Engine or its constituent models.

### Example AI Engine Models and Outputs

In the Absolute Case of the AI engine, by internalizing multivariate data sources, a virtually complete model of mixes may be constructed. This model may be defined through multiple representations, including a model based on providing a Mix ID, a model based on the Chemical & Material composition of the mix, a model based on the Physical Properties of the mix, and other arbitrary identification bases. The configurations of this model may be versatile, designed to accommodate varied and even incomplete data. In one embodiment, the primary model may be a supervised learning model, which requires labeled information for its operation. To reduce the extent of labeling required, physico-chemistry based equations may be incorporated into these models. This approach integrates the fundamental principles of physico-chemical interactions within the learning process. As the system evolves, unsupervised learning techniques may be employed. These techniques are instrumental in identifying patterns and correlations within the data without the need for labeled datasets, thus enhancing the model's ability to handle diverse and complex data structures.

Additionally, generative model builder tools may be developed for creating mappings between contextual conditions and material properties to their respective material compositions, formulations, and designs. The generative model may be used in instances where there is missing information, invoked to fill these gaps, thereby ensuring the continuity and comprehensiveness of the model.

In the absolute mode of the AI engine, the functionality may be distributed across four distinct models, Representation Generator, Classification System Generator, Material Identification Engine, and (Material Classification Engine, each serving a specific purpose in the process of mix identification and classification.

The Representation Generator may be tasked with generating a desired representation for mix-space. The representation could be based on various criteria such as compressive strength, workability, shrinkage measures, or mix formulation. Once a representation is established, the Classification System Generator may generate a classification system over this chosen representation. This involves segmenting the volume of the mix-space representation into sub-volumes, each representing a specific class or family within the mix space. Material Identification Engine may be responsible for identifying the material within the given representation. This identification can be based on various aspects such as material properties, material composition, name or arbitrary identifier, sensor signals, or an entirely different representation which may have been generated by the model itself. An additional step in this process may involve further processing or combining these representations to generate a unique fingerprint and rebasing of mix-space into fingerprint space. Following the identification of material, Material Classification Engine may classify the identified material within the established classification system and representation. This model takes the identification and places it within the classification of the representation. Geometrically, this classification process can be visualized as follows: the Representation Generator outputs a volume Vₛ, which represents the mix space. Model Classification System Generator then divides this volume Vₛ into multiple smaller volumes V_{C}_{ᵢ}, each representing a different class or category within the mix space. Material Identification Engine may output a volume Vₘ within the overall representation space R, which defines the specific mix that has been identified. Material Classification Engine may then be responsible for determining in which class volumes V_{C}_{ᵢ} the identified mix volume Vₘ is located, or with which it overlaps. If the identified mix volume Vₘ overlaps with more than one class volume V_{C}_{ᵢ} (for example, if Vₘ is disjoint and spans multiple classes, or is contiguous but sits on the boundary between two classes Cᵢ), then the mix may be assigned to both classes, or classified into the class with which it has the highest volume overlap. In cases where there is ambiguity in classification, a new representation, basis, or classification system may be employed to resolve the ambiguity. This new system could either be generated by the models within the AI engine or selected through other means, ensuring a precise and accurate classification of the identified material. Additionally, a generative model may be employed across all these models to manage missing data.

In some embodiments, the representations may include identification by name (arbitrary identifier), identification by compositional properties (what is it?), and identification by properties (how does it behave?). In identification by name, the identifier or fingerprint of the material may be defined as an “ID”—an artificial nametag generated by the engine. This ID may optionally be based on prior mix names that have been fed into the system from historical data. In identification by compositional properties, the identifier or fingerprint of the material may be determined by its mix composition. This may include detailing the chemical constituents of the material, possibly listed through cement chemist notation, as well as its material and mechanical composition. The latter might involve ratios of aggregate to cement to water, presence of admixtures, and the size and type of aggregate among other relevant composition material properties. Similar to identification by name, this identification method may also include an accompanying ID for easy reference. In identification by properties, the identifier/fingerprint may be defined through a physical and mechanical property profile of the material within a specific context. This context characterizes the particular instantiation of the material in a given use case, encompassing the totality of context data. Physical and mechanical properties could include those of the binder, aggregate, admixture, and fiber, among others. These properties may be inferred by assessing relevant data, then matching this data to a particular component of the expected performance of the mix design, based on a corpus of training data. Derived metrics such as the strength, durability, workability, embodied carbon, cost, and time to maturity may be calculated or inferred from these data sources. Like the other representations, the identification by properties may also be accompanied by an ID. In some other embodiments, the output of the material identification engine may include other representations provided or generated by the AI engine.

Once the representation of the material is defined, the AI Engine can generate the output identification of the material by matching to existing database classification, augmenting existing database classifications, or generating a new database classifications. In some embodiments, matching to existing database classifications may involve comparing the output fingerprint of the material to a database of concrete mixes. This database could be based on an existing standard or relate to previous mixes identified by the AI engine. The matching process can be executed through supervised learning techniques. In this context, the AI Engine may be trained using labeled data that matches the categories or classifications in the existing database. Through this training process, the AI engine may “learn” the distinctive material properties of each mix in the database over numerous iterations. As the AI engine processes and assimilates this information, it may gradually gain the ability to accurately output the identification of a material by finding the closest match or the most relevant category within the existing database. This method leverages historical data and established classifications to enhance the accuracy and reliability of material identification.

In some embodiments, augmenting existing database classification may include classifying the output by weighting existing mixes in the database. This method effectively augments the existing database by comparing and relating the new mix to previously identified mixes. Utilizing the engine's database of past identified mixes, or an existing standard database, the new mix is classified based on its similarity to the mixes already cataloged. For instance, a new mix, “New Mix A,” may be analyzed and found to have similarities with “Mix I,” “Mix II,” and “Mix III” from a particular database (referred to as “database D”). These similarities may be assessed along specific metrics, which could be various properties or compositions of the mixes, denoted as “X,” “Y,” and “Z.” In a more quantifiable sense, this classification could involve a percentage breakdown, indicating that “New Mix A” comprises certain proportions of the existing mixes in the database. For example, it might be determined that “New Mix A” is composed of 20% of the material properties of “Mix A,” 50% of “Mix B,” and 30% of “Mix C.”

In some embodiments, generating a new database classification may include classifying the output fingerprint into an entirely new classification, one that is fully generated by the AI engine. To this end, the AI engine may use advanced techniques such as dimensionality reduction and meta-regression models, or the initial layers of a Convolutional Neural Network (CNN). These techniques form the core of the engine's internal classifier. The key advantage of this approach is its ability to optimize continuously across a wide range of variables. It enables the engine to not only classify existing mix compositions but also to provide recommendations for potential new mix compositions that might not currently exist but could be realized based on the engine's recommendations. In example embodiments, a translation layer may be used to bridge the gap between the engine's internal classification system and the known or nearest known mix IDs and their corresponding properties. This translation ensures that the new classifications are not isolated from existing knowledge bases, allowing for a coherent and comprehensive understanding of the material mixes.

The Perturbative Case of the AI Engine may be used to detect anomalies in material identifiers and determine their root causes. In this mode, the AI engine operates as a relative identification system, capable of differentiating between two mixes, but not necessarily equipped to absolutely identify each mix independently. In some embodiments, the AI engine may assess whether the mix under consideration is the same as a reference mix. If a discrepancy or perturbation is detected, indicating that the mix is different, this information is relayed to the user, through a notification system. This capability allows for the identification of deviations from expected material properties. In some other embodiments, the AI engine may not only detect but also report the source of a perturbation throughout the concrete lifecycle. The AI engine can provide automated insights regarding the cause of the anomaly, detailing the ‘when’, ‘what’, and ‘why’ aspects. This feature adds a layer of diagnostic capability, enhancing the utility of the system in practical scenarios. In some other embodiments, the AI engine may suggest compensatory actions to rectify identified perturbations. For example, the AI engine may recommend adding water or admixture to a mix to achieve a desired contextual material property. Additionally, the AI engine may evaluate the expected impact of these recommended actions, allowing for informed decision-making. In still other embodiments, the AI engine may detect early anomalies by utilizing the range of devices and models described herein, including sensor devices and context awareness models. By employing sensors throughout the value chain and construction process, the AI engine can facilitate early detection and reporting on the source of perturbations. This provides users with timely insights regarding the causative factors of anomalies, encompassing the ‘when’, ‘what’, and ‘why’.

The perturbation and/or anomaly identification and determination system within the AI Engine has several use cases, each crucial for ensuring the integrity and consistency of materials throughout their lifecycle. These use cases include ID matching, chain of custody matching, and comparison to related historical or contemporaneous pours. In ID matching, the AI engine may be tasked with verifying whether the material currently under consideration matches a target material. The target material could be specified by a user or suggested by another model. This matching process is vital for confirming that the material being used or analyzed is indeed the one intended or expected. In chain of custody matching, the AI engine may track the continuity of a material over time. The system assesses whether the material identified at a later time T′ is the same as the one identified at an earlier time T. An example in the context of concrete would be to ascertain if the mix identified in the pour is the same physical volume of concrete that was identified back in the batching plant. In comparison to related historical or contemporaneous pours, the AI engine may compare concrete mixes used in different pours at a construction site. It determines whether the mix used in, say, Pour X is the same as that in Pour Y.

In the perturbative mode, the functionality may be distributed across four models, including Expectation Determinator, Perturbation Detector, Perturbation Cause Analyzer, and Compensation Recommendation Engine.

The Expectation Determinator may determine mix identity or mix classification expectations. In the simplest case, the user may input a pre-defined target mix identity or mix class (as defined by its composition, properties, identifier, or other representations), which may become the expected mix or class. In more complex cases, the model may consider the element type and prior similar elements on the same jobsite, to determine expected mix identity or class (by property, composition or otherwise). In general, the model may infer expectations for mix identity and/or class for a given scenario (e.g., for different contextual conditions), and by extension, what mixes or classes not to expect in those scenarios.

The Perturbation Detector may detect or determine mix anomalies or mix perturbations. Perturbation Detector examines if the material currently being evaluated matches the expected mix identity or class. This expectation is set by Expectation Determinator and could be based on various factors such as properties, composition, mix identifier, sensor signals, or any other representation. Perturbation Detector then assesses if the material identity aligns with the expected identity. If there is a discrepancy between the two, it indicates a perturbation or anomaly. This discrepancy could be in terms of composition, properties, or any other defining characteristic of the mix. In determining whether the material identity differs from the expected identity, the model may also take into account the possibility of false positives and false negatives. Upon detecting a perturbation, the model is designed to report this anomaly, providing insights into the nature and extent of the deviation from the expected mix. As described herein, the Perturbation Detector may be used in ID matching, chain of custody matching, and comparison to other pours.

The Perturbation Cause Analyzer may identify not only the occurrence of anomalies in material identification but also in pinpointing their sources and assessing their impacts. When an identification mismatch is detected, such as an unexpected alteration in material composition (e.g., additional water in a concrete mix), the model may analyze a range of data elements to determine the cause of this discrepancy. Key factors under scrutiny include the timing of the perturbation, the material's contextual conditions at that time, and any associated actions taken, like the addition of substances to the mix. Following the identification of the cause, the model proceeds to evaluate the impact of this anomaly on the material. This evaluation may include quantifying the magnitude of the impact on the material's properties and composition, including both compositional and contextual material properties. For instance, in the case of extra water in concrete, the model may assess how this affects the mix's strength, workability, curing time, and overall suitability for its intended application.

The Compensation Recommendation Engine may respond to anomalies or perturbations identified in material batches by recommending compensatory actions aimed at correcting identified anomalies and restoring the target or expected properties of the material. In particular, upon detecting an anomaly or perturbation, the model may propose specific actions that can be taken to counteract the identified issue. The model may also provide predictions about the expected impact of these actions. The output may also include contextual details such as the timing of the recommended compensation action and the associated material contextual conditions during that time. The model may also assess and quantify the magnitude of the expected impact of the recommended actions on the material, covering various properties of the material, including both its compositional and contextual properties.

In some embodiments, the perturbative mode of the AI Engine may include a time-evolving analysis to uncover the origins of anomalies. This approach involves correlation and causation analysis over time, providing insights into the development and emergence of anomalies. In one embodiment, the perturbation detector model not only identifies potential anomalies but also assigns likelihood scores to these predictions. Once an anomaly is identified and scored, the perturbation cause analyzer may analyze the anomaly's likely origin, such as unexpected additions during material processing or transportation. This information is then passed on to the compensation recommendation engine (e.g., the processor described herein), which proposes compensatory actions to mitigate the anomaly, ensuring the material still meets the predefined specifications or expectations. Furthermore, the AI engine may be configured to interact with users for enhanced training and adaptability. Users can accept or reject identified anomalies, contributing to the model's learning process. They also have the capability to input unnoticed anomalies into the detector, enhancing the system's comprehensiveness and accuracy. Throughout these processes, the Generative Model is employed to manage any missing data, filling gaps to ensure continuous and complete data analysis.

### Example Implementation of Identification, Classification & Perturbation Detection

In some embodiments, the machine learning classifier used to detect perturbations may be a supervised learning classifier. Here, the classifier, designated as Fᵢ for identification, F_{c} for classification, and Fₚ for perturbation, may predict the mix type output (Y) from a set of potential multiple identifiers (I), classes (C), or perturbations (P), respectively. Each model, equipped with its internal tunable parameters (ωᵢ for identification, w_{c} for classification, wₚ for perturbation), may receive input data (X), which can come in various forms and combinations, with some inputs possibly missing. In its simplest form, a classifier F(X; w) aims to maximize the probability that its prediction corresponds to a given class label conditioned on input X.

In the standard classification framework functioning within a supervised learning capacity, the learned model (mapping F), necessitates a rich training dataset for the development of a reliable model. This framework may employ both standard statistical techniques and AI methods to reduce dimensionality and manage the complexity of the data. Techniques like PCA (Principal Component Analysis), t-SNE (t-distributed Stochastic Neighbor Embedding), and UMAP (Uniform Manifold Approximation and Projection) may be utilized to transform the data into orthogonal bases, simplifying the multi-dimensional data into formats that are easier to analyze and interpret. In addition to these statistical methods, AI techniques such as encoder-decoder models and autoencoders play a significant role in dimensionality reduction. Furthermore, the AI engine may be capable of extending its applications to an unsupervised classification setting. This extension may be facilitated by coupling the dimensionality reduction with standard clustering techniques like k-means clustering and density-based clustering methods, or with Gaussian mixture models.

Within the framework of the AI engine, multi-class labeling may be extensively utilized in machine learning and neural network applications, guided by two key aspects: the variety of data and the integration of physico-chemical models with advanced AI methods. To handle the diversity of multivariate input data, the AI engine may employ stacking techniques that combine different machine learning (ML) and neural network (NN) tools. For instance, artificial neural networks (ANNs) may be stacked on top of ensemble learners, such as Random Forests, to process inputs and predict mix outputs. Additionally, meta-regression models stacked onto classifiers can categorize mix classes based on human-interpretable material properties. Another approach may involve using convolutional neural networks (CNNs) on wide input vector spaces to develop a fingerprinting model for the concrete mix, capitalizing on the ability of CNNs to handle complex input structures.

Furthermore, the AI engine may incorporate physical principles into neural network models. This approach may be designed to reduce reliance on labeled data by harnessing the knowledge base around physical phenomena and considering boundary and initial conditions. A typical method in this approach may involve augmenting the loss function, traditionally MSE (Mean Squared Error), L1, or L2 norms, used in the optimization step of the training phase. The enhanced loss function includes residual functions of the governing partial differential equations (PDEs) of physical balance equations, such as those related to energy. It may also account for losses due to initial conditions and/or boundary conditions, with specific weights attributed to each loss component.

Mixes in the AI Engine can be identified and classified with varying degrees of granularity. While the material identification engine and the perturbation detection models primarily operate at the level of individual mixes, they may also have the capability to function at broader levels, such as mix types or mix families. The definition of a ‘mix’ can be expanded by applying broader tolerances in the chosen representation of mix-space. For instance, a mix formulation may be defined within certain batching tolerances. Adjusting these tolerances can change the level of granularity at which the mix is identified. Similarly, in classification systems, the size of the classification volumes within mix-space can be varied depending on the desired level of granularity. The concept of a ‘mix’ or a ‘mix family’ may not be strictly defined, allowing for various characterizations and classifications of mixes and mix types. In this instantiation, the AI Engine may provide users with the option to choose from a predefined set of granularities and definitions. These definitions could be based on material properties, characteristics, constraints, or chemical composition, and are applicable for both absolute fingerprinting and perturbation detection. This mode may be particularly useful in situations where batch variability might cause identical mixes to be recognized as different.

These classifications can include multiple levels, such as percentage bands of GGBS content, ranges of aggregate sizes in the mix, or regional and sub-regional origins of the sand. These categories may group mixes along various axes and to different degrees of resolution. This allows for differentiation of mixes without necessitating pinpoint sensitivity and specificity in identifying a unique identifier. Instead, identifying a family or group may be sufficient in many cases, offering a pragmatic approach to mix classification that accommodates a range of specificities and resolutions.

Material Identification can be viewed as the inverse problem of mix recommendations. Essentially, while material identification focuses on determining the composition and material properties of a given mix, the inverse process involves generating a mix that meets specific requirements. This generative model approach aims to identify a mix type that optimizes for certain criteria, such as carbon footprint, time to reach strength milestones under specific contextual conditions, and others. Additionally, constraints can be set based on various factors including the target pour's contextual conditions, intended applications, geometries, location, and/or weather conditions. This approach aligns with models described in the mix optimization section. The relationship between the mix fingerprinting models and the mix optimization models in the AI system may indeed be self-reinforcing. As new mix identifications are made by the fingerprinting models, they may be added as new entries into the database. This expanding database, in turn, may become a more robust resource for the mix selection and recommendation algorithms in the mix optimization models.

In summary, the process of continuous mix fingerprinting may facilitate the development of an internal representation model of mixes. This model, enriched with sufficient data, may allow a generative model to fulfill two key functions: (1) acting as a generator for missing data, and (2) working in tandem with mix optimization to recommend mixes that align with specific constraints and target objectives. The generative model, in its most basic form, can be conceptualized as a lookup table. This table may track mix material properties and their corresponding output properties, serving as a straightforward reference for understanding mix behaviors and outcomes. When it comes to data infilling in fingerprinting mode, the generative model may create a detailed profile. This profile maps various sensor profiles (or other multivariate approaches or data streams) to the relevant mix material properties and identifiers. This mapping is essential for accurately identifying and understanding the properties of different mix compositions.

In the inverse mode, also known as the ‘recommendation’ mode, the model may rely on an internal representation of the system of mixes typically utilized in these applications. This internal model forms the basis for generating mix recommendations. The generative model may operate on probabilistic principles, aiming to provide the most likely data to fill in the gaps of missing information. This probabilistic nature can be visualized, in the context of the simple lookup table, as a system that outputs a list of potential mix designs, each accompanied by a likelihood of being the correct mix design based on the input data. More broadly, the models described herein may be configured to learn a probabilistic internal representation of mix designs relative to a multitude of contextual data about a concrete pour. They may output identified mix design recipes along with an associated probability and confidence level. This output may be based on the combined data from the model's training corpus and physico-chemical modeling derived from prior experimentation and general field knowledge.

The descriptions relating to confidence level and error propagation calculation, and explainability described in the mix optimization section equally apply to the mix fingerprinting models (and all models described herein more generally).

Similarly, the descriptions relating to physio-chemical models, and embedding of physico-chemical principles in the models described in the mix optimization section (either through embedding of the principle, for example to modify weights of a neural network, or generation and/or simulation of training data to be used during training or updating) also translate to the mix fingerprinting models (and all models described herein more generally). Physico-chemical embeddings also have the potential to provide for better explainability.

### Example Maturity Method

### Example Standard Maturity Method

The standard maturity method is a procedure by which a time-series of concrete temperatures are used to measure the compressive strength of that concrete. In order for compressive strength to be measurable via the maturity method, the temperature time-series may be required to meet specific criteria, including spanning completeness, sampling completeness, and adequate sourcing placement. Spanning completeness requires that the temperature samples of the time-series cover the entire period starting from when the concrete was poured until at least the time when the compressive strength is to be calculated. For instance, if the concrete pouring occurs at time t=t₀, then the compressive strength measurement is intended at t=ti, then temperature data must be available for all times within the range t₀≤t≤tᵢ. Sampling completeness requires that the temperature be measured at a sufficiently high frequency. A ‘sufficient sampling frequency’ may be defined as one that allows for the detection of temporally local average shifts in concrete temperature to an accuracy of 0.1° C. or less. The definition of ‘temporal locality’ may vary from case to case but is generally around 30 minutes for a typical curing process. Absolute source placement requires that the temperature sensor used for these measurements is appropriately positioned within the concrete. The sensor should be at a fixed location and in thermal contact with the concrete itself for the entire duration spanning from t₀ to tᵢ.

For the effective mapping of a time-series of concrete temperatures to a corresponding time-series of compressive strengths using the Maturity Method, it is essential that the concrete recipe is calibrated with respect to the maturity functions employed in this method. Calibration entails fitting a set of maturity functions to a series of time-dependent compressive strengths, where each point of compressive strength data in this series is derived from physically testing a concrete sample, typically a cube or cylinder, by crushing it to assess its strength, and each where each cube has been cured in a temperature-controlled water bath (kept in standard conditions of around 20° C., typically). It is to be understood that standard cubes may be substituted for standard cylinders, or for any other standard geometry.

The calibration process for the Maturity Method is initiated by casting several concrete cubes of standardized geometry from a specific batch of mix recipe. This process involves two types of cubes: those destined for compressive strength testing and temperature-control cubes. The cubes for strength testing are systematically crushed at various elapsed times post-casting, allowing for the measurement of the concrete's developing compressive strength over time. Simultaneously, the temperature-control cubes, each embedded with a temperature sensor, play a different yet equally vital role. These cubes are not subjected to crushing; rather, they are used to continually monitor and record the temperature. Placed in the same temperature-controlled water bath as the test cubes, the sensors in these control cubes may track the representative temperature throughout the duration of the calibration process.

Following their creation, each concrete cube is promptly placed into a temperature-controlled water bath. This water bath is maintained at a fixed reference temperature, ensuring that all cubes experience a consistent and controlled curing environment. Then, the temperature time-series from each control cube placed in the temperature-controlled water bath may be recorded. Each concrete cube may then be crushed at various elapsed times following its creation. This crushing is scheduled at typical calibration intervals, which include 6 hours, 12 hours, 1 day, 3 days, 7 days, 14 days, 28 days, and 56 days. To ensure accuracy and account for natural experimental variations, a sufficient number of cubes are cast so that two cubes can be crushed at each of these elapsed times. Crushing two cubes per time interval allows for the calculation of an average compressive strength at each point. This averaging helps mitigate any anomalies that might arise from individual cube variations, thereby providing a more reliable and representative measure of the concrete's strength development. The exact time at which each concrete cube is crushed is recorded accurately to establish a time-dependent compressive strength mapping for the concrete. The specific crush time for each cube is a key data point that correlates the age of the concrete with its compressive strength at that particular moment.

Next, an appropriate maturity function may be selected for use in the calibration process. For purposes of the invention, any standardized maturity functions, including the Nurse-Saul, Sadgrove, Arrhenius functions, and/or the like, or any customized maturity functions may be used. Each of these functions has its own methodology and assumptions for mapping temperature data to concrete strength. To calculate the equivalent age of the concrete, the measured temperatures from the control cubes may be utilized. If there are multiple control cubes, an averaged set of these temperatures may be calculated. These control temperatures are then input into the chosen maturity function. This function maps the elapsed times at which each compressive strength was measured to an equivalent age. The concept of equivalent age refers to the effective elapsed time it would take for an identical cube of concrete to reach the same measured compressive strength but at a different, typically fixed, bath temperature. For instance, if the actual bath temperature varied between 23° C. and 25° C. during the period of the cube crushes, the maturity method might recalibrate these times into an equivalent elapsed time at a standard temperature, such as 20° C. Generally, since 20° C. is cooler than the range of temperatures in this example, all equivalent ages may be adjusted to longer equivalent elapsed times. Conversely, if the reference temperature was higher than the actual bath temperatures, the equivalent ages may be calculated as shorter. The maturity method is adaptable to fluctuations in the bath temperature, allowing it to rise above or fall below the reference temperature at various points in time. It compensates for these variations by lengthening or shortening the equivalent elapsed time as necessary.

Following the allocation of an equivalent age to each recorded compressive strength, the next step may involve establishing a function that effectively represents the correlation between the equivalent age and the compressive strength. The choice of this function hinges on its capability to depict the progression of the concrete's strength with an acceptable level of accuracy. The functions selected for this purpose may include, but is not limited to, exponential, hyperbolic, or logarithmic functions. In the calibration process, the chosen maturity function typically includes free variables whose quantities may not be predefined. These variables may be determined through the same fitting procedure used for identifying the best-fit parameters of the fitting functions. Essentially, if the maturity function contains ‘m’ free variables and the fitting function comprises ‘n’ free variables, then the final fitting procedure is tasked with determining a total of ‘k=m+n’ parameters. These parameters may collectively define the calibrated maturity method tailored to the specific concrete mix recipe in question.

Upon determining the ‘k’ parameters from the cube crush data, the next step may involve utilizing these parameters, along with their corresponding maturity function and fitting function, to ascertain the compressive strength of the now calibrated concrete mix recipe using a measured temperature time-series that adheres to the previously outlined sufficiency criteria. The key advantage of this calibrated model is its versatility. It can be applied to any instance of the concrete mix formulation, regardless of variations in geometry or location.

### Example Mathematical Formulation of the Standard Method

The compositional properties of a concrete mix are characterized by a set of defining parameters, collectively represented as a P-dimensional vector, p. This vector constitutes the identity of a specific mix formulation within the database. The dimensionality, P, corresponds to the number of variables selected to uniquely identify a mix formulation. These variables, constituting a subset of P, encompass both numerical and non-numerical information, which can be discrete or continuous in nature. This includes, but is not limited to, textual data such as the mix's name, quantities or proportions of compositional materials, their sources, and any other pertinent identifiers.

In the case of a specific instance of a concrete mix recipe, namely a particular pour at a distinct location and time, a set of parameters encapsulated in a C-dimensional vector, c may be defined. This vector c may include C variables that describe the contextual application of the concrete pour, as recorded in the database. Similar to the vector p, vector c includes both numerical and non-numerical data, which may be continuous or discrete, and may also encompass textual information. These variables collectively detail the contextual conditions of the material and pour. They can include, but are not limited to, details about the pour's geometry, ambient temperature of the surrounding environment, internal temperature at various points within the concrete, and other relevant sensor data, both internal and external to the concrete.

The maturity function for calculating compressive strength using the maturity method is defined as e=M(t, T; θₘ), where T is a vector containing the measured concrete temperature at each corresponding time t in the time-series. Each temperature measurement in vector T may correspond to a time point in the vector t, and e may represent the equivalent age of the concrete at each recorded time in t. The maturity function may include a vector of functional parameters, θₘ, which define the m fitted parameters of the maturity function. The vectors t, T, and e may all be of equal length. With each new temperature measurement, a new time, temperature, and equivalent age are appended to their respective vectors. The vector m can vary in length, determined by the specific requirements of the maturity function being applied.

The fitting function, also referred to as the “Calibration Curve,” may be applied once the equivalent age, e, is determined. This function, denoted as ƒ, may be used to convert each equivalent age value into a corresponding compressive strength, s, according to the formula s=ƒ(e; θₙ), where θₙ represents the vector of n fitted parameters of the function ƒ.

The standard fitting procedure involves the collection of a vector of measured compressive strengths, ŝ, where each element in the vector represents a compressive strength at a specific time, tᵢ. Corresponding to each time tᵢ, there is a time series of temperatures, T, measured up to and including tᵢ. Both vectors t and T are arranged in chronological order. After collecting these data, the maturity function, M(t, T; θₘ), and the fitting function, ƒ(e; θₙ), may be employed. Initially, the fitted parameters may be assigned arbitrary values. A nonlinear regression may then be iteratively solved over the parameters k=m+n, aiming to find the set of {θₘ,θₙ} that minimize the vector of errors, ∈=s−ŝ. The process may continue until convergence is reached. Upon completion of the fitting procedure, the final set of k fitted parameters may be taken as the calibrated maturity parameters for the specified mix design.

### Example Enhanced Maturity Method

In the Enhanced Maturity Method, a more comprehensive approach to the maturity method is devised. This method extends beyond considering material parameters as functional variables. It also incorporates the specific instantiated conditions of the concrete, such as ambient temperature, geometry, and other relevant environmental factors.

A generalized maturity function may be defined as e=M(t, v₁, v₂, v₃, . . . , v_{D}; θₘ, c, p), where the single time-series of bath temperatures, T, is replaced by a set of D time-series, vᵢ, each of which might be measured over different windows of time (and are therefore of differing length, in general) and each of which can generally constitute a measurement of a different data type over time. In addition, the generalized maturity function may also be dependent upon the context data, c, and the material identifier (for example its compositional properties), p, of a specific instantiation of a concrete formulation. The generalized maturity function, M, need not be a single function (as for the standard case), but can be an arbitrarily complex hierarchy of interconnected functions, which themselves can be an arbitrary mix of continuous or discrete functions over the domain of continuous and/or discrete inputs. In this sense, the generalized maturity function can represent, for example, an artificial neural network, or a decision tree model, or a convolutional network containing transformer architectures, or any other such model or ensemble of models. The model, M, may also crucially contain an arbitrary hierarchy of physico-chemical models, which might derive from theory or from empirical experiment.

Thus, in the special case for which the context data, c, is the same as for the standard maturity method (i.e., a cube of specified geometry in a temperature-controlled bath), and where the only measure, vᵢ, being recorded is the temperature of the mix over time, the generalized maturity function becomes the standard form of the maturity function. In general, however, the above formalism is able to model the equivalent age of the concrete, by taking into account information from an arbitrary set of simultaneous or asynchronous measurements, and for an arbitrary set of contextual conditions (no longer requiring a temperature-controlled bath to create a mapping and superseding the need for calibrating the performance of a mix recipe with cubes and temperature-controlled baths).

The enhanced maturity function may be used to model the performance of mix designs without the need for sampling compressive strengths in “idealized” or “standardized” conditions. In general, if there is a means by which to measure ŝ, a model, M may be identified. The model, M, may map the arbitrary measures, v₁, v₂, . . . , v_{D}, taken over arbitrary instantiated contextual conditions (encoded by c) and even over arbitrary mix recipes (encoded by p), such that all data on the time-based evolution of material properties, for all mixes and in all conditions can be used to train a universal mapping model. The universal mapping model may map the recorded elapsed time since a pour into the “equivalent age” of that mix, where the equivalent age can be chosen to be under an arbitrary and fixed reference context and/or compositional properties. Once the maturity model maps any specific set of times into equivalent age, then a fitting function ƒ, of the same form, is applied (which remains a function of equivalent age, but where the meaning of equivalent age is permitted to shift more generally to a specific set of context conditions and compositional properties). The Enhanced Maturity Method may not then map the temporal material properties of the concrete to the estimated temporal performance at standard temperatures but may maps (more generally) to the estimated temporal performance at arbitrarily standardized contextual conditions and compositional material properties.

In some embodiments, the enhanced maturity may accept the mix identifier as input, allowing the use of the mix fingerprinting models described above to identify a mix, which is then input into the enhanced maturity method. In the case where the mix identifier is a mix formulation (compositional material properties), this may allow the enhanced maturity method to take into account changes in formulation on the strength estimation. The granularity with which the mix identifier is defined (its volume in mix space) may determine the granularity and precision with which the enhanced maturity method is able to make predictions (e.g., changes in mix formulation up to some defined tolerance, changes in mix formulation within that tolerance to represent batch variability, and/or the like).

It is to be understood that the form of the enhanced maturity method may be determined theoretically, empirically, or through the various models described in this document (for example, those described in the mix optimization section, including the generative and the recommendation models).

### Example Enhanced Maturity Method to Determine Compressive Strength of a Mix Formulation

In some embodiments, the enhanced maturity method may be used to determine a compressive strength of a mix formulation by combining a mix formulation and/or identifier with the standard maturity method, thereby enabling practitioners in the field to relate compressive strength estimates back to standardized methods such as standard of maturity (i.e., the calculation of the equivalent age of the concrete under some other standardized conditions).

To determine the compressive strength of a mix formulation, the parameters associated with the identity of the mix formulation, e.g., compositional vector, p (e.g., the fingerprint) may be determined. Then, the system may determine the quantities within the maturity method that are mix-dependent, e.g., the maturity function and the calibration curve of the mix formulation. For each of these quantities, identities of the mix formulation may be matched to existing databases of maturity functions and calibration curves.

In embodiments where both databases include the mix under consideration, the system may match them and subsequently select the appropriate maturity function and calibration curve. The maturity of the mix formulation may then be determined based on temperature measurements from multivariate sensing devices, the selected maturity function, and the elapsed curing time of the mix formulation. The compressive strength of the mix may then be determined using the computed maturity and the identified or selected calibration curve. On the other hand, in embodiments where both one or both databases do not include the mix under consideration, the system may use a recommendation engine (or other models from the mix optimization section) to generate probable calibration curves. This process involves utilizing past data and training to derive a recommended mix calibration and maturity function. Upon determining the maturity function and the calibration curve, the system may determine the maturity based on the maturity function and the temperature. Subsequently, the system may determine the compressive strength based on the maturity and the calibration curve.

In some embodiments, the enhanced maturity method may be implemented in both absolute fingerprinting and perturbative fingerprinting. In the absolute fingerprinting mode, a calibration curve, such as a strength-temperature-time calibration relevant to the maturity method, may be determined based on the associated mix identifier. This could involve selecting a calibration from a pre-existing database, where the selection is guided by the closest matching identifier. Alternatively, the calibration can be generated based on the mix identifier using models described in the mix optimization section. The maturity function, including its type and variable parameters, may then be chosen. This selection process may entail picking from a set of potential maturity method equations, such as Nurse-Saul, Sadgrove, Arrhenius, and/or the like. The parameters of these maturity functions could include variables like the activation energy of the mix, the datum temperature, and others that correlate the rate of hydration reaction with the temperature or the temperature sensitivity of the concrete. In the perturbative fingerprinting mode, a calibration curve may be established and a maturity function may be determined for a specific mix. This calibration and function can be relied upon for future pours using the same mix. If an anomaly, such as an incorrect mix, is detected, the system may adjust the calibration or create a new calibration curve. In example embodiments, the system may also modify the maturity function, which could involve selecting a different function type or altering variables within the maturity function, like the activation energy or datum temperature. Modifications to the calibration and/or maturity functions may include translating the calibration curve or applying non-linear transformations. These transformations are typically best fits to underlying data from cube or cylinder crush tests. New parameters for the best fit function may be introduced, such as those for logarithmic, exponential, or hyperbolic fits, or for a generalized best fit function. In cases of well-behaved functions (differentiable at all points), this could involve coefficients of a Taylor expansion.

In some embodiments, when utilizing enhanced maturity method, the system may also accommodate batch variability-degree of variation between the designed mix formulation and the actual compositional properties of a specific batched sample. Even within what appears to be the “same” batched mix, variances in material properties, such as performance, can occur. These variations often result from natural changes in the quality of raw materials over time, as well as the conditions prevalent during batching. Collectively, these factors contribute to what is termed batch variability. Sources of variance can significantly affect both the maturity function and the calibration curve for given mixes. As such, the system may be capable of detecting and accounting for these variances. The system's capability may extend to inferring, based on historical data, multivariate sensor measurements, and any other relevant identification data (derived from fingerprinting models), the presence of batch variability as compared to a target mix. Once batch variability is identified, adjustments are made to the maturity function and calibration curves. These adjustments can range from simple translations to more complex non-linear transformations.

Data inputs for selecting, adjusting, or generating calibration curves and maturity functions in the enhanced maturity method can originate from a variety of sources, including, measurements, documents, and human-input data. In example embodiments, the measurements may include cube or cylinder crush results, sensor-based measurements, and measurements from other testing methods. Cube or cylinder crush results may often be produced progressively throughout a job site's timespan, such as a 7-day crush test conducted by the material supplier. Each concrete crush test provides vital data, serving as either an absolute or perturbative identifier of the batch(es) under consideration. This crushing data can be used to modify a calibration curve over time, ensuring that it remains current with the actual performance and identity of the mix formulation. Additionally, there's the option to link these crush tests to the specific pour through the features outlined in the linkage section. Sensor-based measurements may be received from instruments such as wave-based sensors that provide essential identifiers of the mix formulation. Calibration and/or maturity functions can be determined based on these mix identifiers. For instance, the Young's modulus might be deduced from mechanical measurements (using electromechanical, magnetomechanical, photomechanical couplings, etc.). These identifiers, combined with temperature data, can be instrumental in detecting changes in mix identity. Furthermore, both destructive and non-destructive testing methods may be employed on the concrete pour under examination or on other elements made from the same batch. These methods provide additional data points that can further refine the calibration and maturity functions.

In addition to sensor-based measurements, documents and human-input data can be used to update calibration data. For instance, mix design records, batching records, and delivery tickets may be used to provide insights into the composition and handling of concrete mixes. For example, if records indicate the addition of water to the mix during transit, this information can lead to necessary adjustments in the calibration curve. Such adjustments may involve translations or transformations of the curve, reflecting the physico-chemical impact of changes in the water to cement ratio on the compressive strength gain of the concrete. Adjustments to the calibration curve based on document and human-input data can also be guided by various models, including those described herein.

In some embodiments, the integration of additional data inputs information may enhance the accuracy of the calibration curve and the maturity function. These inputs can be provided at various stages, potentially in real-time. Prior to the pour, information about batching conditions may be used for setting the initial calibration. During the pour, data regarding workability or slump of the concrete assists in making immediate adjustments to the calibration. After the pour, results from cube or cylinder crushing tests may be used for validating and recalibrating the strength estimates based on the initial calibration curve and maturity function. In cases where information is provided after the pour, the maturity or compressive strength up to a certain time t, may have been computed based on the initial calibration and maturity function. Subsequently, these functions can be updated or newly determined and stored as a revised version, allowing for the recalibration of maturity and compressive strength. Different versions of these recalculations can be made available to users, along with confidence levels, probabilities, or uncertainties, using methods similar to those described herein. The ability to source information in real-time for dynamic updating of the calibration curve may ensure that the assessments remain current and reflect the latest data and conditions, thereby maintaining the precision and relevance of the maturity and strength predictions.

The maturity method, predominantly used as an illustrative example in this context, stands as the most common and widely adopted sensor-based approach for determining concrete strength. However, the potential extends beyond this method to encompass mix fingerprinting outputs utilizing similar logic. In such scenarios, measures other than concrete temperature could be employed to ascertain compressive strength. For instance, electromechanical impedance data, such as resonances evolving over time, could be utilized. This approach would involve an analogous maturity function, but one that is based on resonance frequencies, along with a corresponding set of calibration functions. Furthermore, the use of multivariate data sources and functions presents an opportunity to simultaneously use multiple measures to determine the material's compressive strength. In various other embodiments, a different output property, apart from strength, could be computed using a similar logical framework.

As the fingerprinting model evolves, it may continually gather and store data, which is then used for training and future reference. This process may lead to the development of a comprehensive knowledge base that correlates various mixes with temperature measurements, crush data, and stores strength gain curves derived from the standard maturity method. These may be utilized as reference or calibration data. The calibration curves are maintained either in a functional form, denoted as ƒ(e;θₙ), or as a lookup table, facilitating easy access and application in different scenarios.

In the absolute fingerprinting mode of the enhanced maturity method, the model may use contextual information—such as mix type, location, season, ambient temperature, and environmental conditions—along with the absolute fingerprint to enhance the model that generates the strength gain curves. The functional form of the model, incorporating these factors for EMM, is derived to provide a more accurate and context-specific understanding of concrete strength development. Conversely, in the perturbative fingerprinting mode, the approach involves extracting calibration curves based on similar contextual information. These curves may then be compared against the maturity method outcomes derived from in situ temperature measurements. The calibration curve, fetched from the database, may be juxtaposed with the results from the absolute mode enhanced maturity model. A simplified residual analysis may be used to verify the model's accuracy. However, more intricate methodologies may be employed to assess the extent of perturbation, the timing, and the estimated causation of any detected anomalies.

### Example Advanced Mix Library

In some embodiments, the advanced mix library may include a multitude of mix identifiers in various chosen representations, optionally organized according to one or more classification systems pertaining to those representations. This mix library may be designed for easy accessibility through different mediums, such as a mobile app and a web application. Depending on the implementation, the mix library can be stored in diverse locations for optimal accessibility and usage. For example, the mix library may be hosted on a cloud-based server, offering centralized and remote access; stored locally on personal devices like smartphones, providing immediate and personal access to the data; or integrated within a sensor device, thereby directly linking the material properties, including those under analysis, for immediate and context-specific evaluations.

In some embodiments, the mix library's mix identifiers may be populated through automated processes, involving the ingestion and parsing of relevant documents. This method might utilize aspects of the linkage invention to coherently connect various data elements. In other embodiments, the mix identifiers can be manually entered, offering flexibility and control in the management of the library's content. The mix library may represent an exhaustive array of potential mix designs producible by a specific batching location, or it could act as a historical archive of all mix formulations. This extensive collection facilitates the linking of other relevant data elements to batches of specific mix formulations. The library's utility is further enhanced by its capability to aggregate mix identifiers, mix formulations, and mix property data, both contextual and static, across one or multiple batching plants.

In some embodiments, names, or mix identifiers, are assigned to each mix formulation. These identifiers can be generated automatically by the models, such as through representation generation, or they can be provided by users, or a combination of both methods. Additionally, names or identifiers for each class of mixes, referred to as mix class identifiers, may also be established. These classes can be automatically generated by the models described herein, for instance, through classification system generation, and mixes are then categorized within these classes.

In some embodiments, the mix library may feature a user interface designed to facilitate navigation among different mixes, either by their individual identifiers or by their class and classification system. This interface may include various functionalities such as filters, sorting options, querying capabilities, and other manipulations to alter the display of mix identifiers to the user. The data selection and manipulation processes can be automated and carried out by the models. For example, this might be based on measurements or other device data, enabling intelligent mix filtering or sorting.

In a further enhancement, the mix library itself can be dynamically populated based on device or sensor-based measurements and identifications of materials, such as from an embedded sensor device in a concrete pour. As new identifications are made, they are transmitted (for example, to the cloud) and stored in the mix database, categorized according to their identifiers. These identifications may automatically made accessible to users with the appropriate permissions through the user interface. The process of identifying these mixes can be based on a variety of data sources, including sensor measurements, documents (like delivery tickets, test records from cube or cylinder crushes, mix design specifications, and batching records), human-input data, third-party data, and the outputs of any of the other inventions described herein. Each individual mix identifier, derived from all possible mixes identified across these diverse data sources and model outputs, is then stored in the mix library. These identifiers may be subsequently available as inputs into other components of the invention, such as the maturity method or the enhanced maturity method, as described herein.

The mix library, in some embodiments, effectively utilizes linkage models to connect additional data sources to the mix identifiers. These linkages can be accessed through the user interface or through alternative means, such as an API, enhancing the flexibility and reach of the library. In some embodiments, mix library may be designed to allow users to interact with both collections of mixes and individual mixes. Collections can be grouped together, optionally based on a classification system, while individual mixes can be accessed through their unique identifiers. An individual mix entity within the library may aggregate all datasets linked to it by its mix identifier. This encompasses both processed and raw data related to the mix, contextual conditions observed in the field (through sensors and context awareness), and other relevant records.

In some embodiments, the mix library may be designed to support for mix versioning. This functionality allows for the tracking and management of properties related to different versions of the same mix, as well as multiple mix adjustments, thus establishing a relationship between different mixes. The mix library may also provide flexibility in determining or setting the granularity of each mix and each batch. In specific embodiments, the mix library may be engineered to be multi-tenant, catering to users from various organizations with distinct needs. This design may include a sophisticated permissioning system, which can be applied on a mix-by-mix basis, a mix class basis, or another arbitrary basis. Such a system may enable selective accessibility to the mixes in the library, where some mixes may be available to certain users and not to others. In some embodiments, permissioning or access control within the mix library can be managed manually, for example, by an administrator with the authority to control permissions. Alternatively, it can be automated, based on device data or contextual conditions such as material or device contextual conditions. This automatic permissioning may leverage mix fingerprinting to enable access to specific mix information.

In some embodiments, permissions for accessing mix data can be dynamically updated based on the physical interaction between a sensor device and the mix. For instance, if a sensor device, in possession of a user, identifies that it has been physically embedded in, mounted on, or directed at a specific mix, the permissions for that user to access data related to this mix can be automatically updated. This mix permissioning based on physical access leverages device proximity to verify the user's physical proximity to the mix, enhancing the security and relevance of data access.

In a practical application, such a multi-tenant mix library system may be used by concrete suppliers, such as ready mixers operating concrete batching plants. These suppliers can utilize the system to make all or part of their mix library and associated mix data available to contractors or subcontractors on a job site. This access can be particularly useful for those involved in constructing structures using these mixes. In this way, suppliers may be empowered to manage their mix libraries, including mix identifiers and associated data, and have control over the information made accessible to contractors. Additionally, suppliers can access selected data shared by contractors through the library. This arrangement facilitates the comparison of actual mix performance under various contextual conditions, such as sensor data, across different job sites. On the other hand, contractors also have the capability to manage their mix libraries, encompassing mix identifiers and associated data. They can decide what data to make available to their suppliers, enabling them to aggregate data from multiple sources. Contractors can further enrich this data with their generated information through the use of the mix in their pours or on their job sites. This functionality allows for an effective comparison and benchmarking of mixes and suppliers, offering a comprehensive view of performance across various projects.

### Example Advanced Pre-Calibration

In specific embodiments, maturity calibrations, or enhanced maturity calibrations (which incorporate different measurements and their associated contextual conditions), may be prepared in advance for one or more concrete mix formulations. These calibrations may be stored on a server, for instance, in a mix library. Within this library, the calibration data for each mix are linked to the relevant mix identifiers, creating an organized and accessible structure.

The derivation of these calibrations can be based on data from devices and/or sensor data streams, and this process can optionally occur in real-time. For example, concrete cube crush or cylinder results can be utilized in conjunction with temperature data streams from sensors placed in cylinders within a water tank. The association of these data streams with the cylinders can be managed either manually by a user or automatically through the use of linkage models.

The comprehensive library of mixes and their associated calibrations may then be made accessible to users before any concrete pour takes place. Having these calibrations prepared in advance significantly reduces the lead time traditionally required for employing the maturity method. In conventional scenarios, users might need to wait up to a month for a calibration curve to be created, but this system circumvents such delays. Users of the system can select the appropriate mix and corresponding calibration from the mix library for computing maturity or enhanced maturity. In some embodiments, the selection of the suitable mix calibration can be automated. This auto-selection process can be based on mix fingerprinting or linkage models, as outlined in the linkage section of the system. The automatic selection of the mix calibration could be informed by data obtained from sensor devices, streamlining the process and enhancing the accuracy and relevance of the selected calibration.

Pre-calibrations within the system may be designed to be dynamic and adaptable, allowing for updates as new data becomes available or as conditions change. For instance, updates can occur when data from additional batches of concrete are gathered, or if there are changes in the sources or performance of raw materials. When recalibrations are made, new versions of the calibrations may be created and stored, each linked to the relevant mix identifier in the mix library.

The initiation of recalibration requests can occur through various mechanisms. These include user requests, where one user can request a recalibration and another user receives the alert or notification. Recalibrations can also be based on predefined rules, such as time-based expiration, which might mandate recalibration at regular intervals (e.g., every six months). Additionally, device data, particularly sensor measurements, can trigger recalibration. This could happen due to the detection of a perturbation or anomaly in sensor device measurements, or if an existing calibration is determined to be inaccurate based on material identification. Changing contextual conditions, such as calibration data not adequately covering mix performance in certain temperature domains, can also prompt a recalibration request. Furthermore, in some embodiments, the system may allow for an ongoing analysis of mix performance over time based on calibration data. This analysis might involve examining trends and other patterns in the data, enabling a deeper understanding of how different mixes perform under various conditions.

### Example Advanced Self-Serve Calibration

In some embodiments, an innovative self-serve calibration tool has been developed for both maturity and enhanced maturity methods, representing a significant advancement over traditional calibration tools. Traditional tools typically require manual data input, such as crush results and temperature data, which are then analyzed to fit the relevant parameters for the best fit curve and maturity function. In contrast, the self-serve calibration tool, which can be cloud-based or app-based, may streamline the calibration process by utilizing temperature control data (or equivalent) from smart sensor devices. Users can select from a list of devices that have been registered on the cloud platform, with data being collected from these devices, possibly in real-time, via Bluetooth or a cellular hub. In example embodiments, the temperature control data may be resampled, possibly through various forms of interpolation, to ensure proper association with calibration crushes. Optionally, the control data can be fed in real-time, thereby eliminating the need for manual input of such control data.

Furthermore, in some embodiments, the self-serve calibration tool may involve the automatic ingestion, parsing, and extraction of crush data, which could be facilitated through OCR-based models or multi-model language models. Alternatively, this data might also be derived directly from devices, such as smart sensors, further automating the calibration process for the user.

In some embodiments, the calibration data for the self-serve calibration tool may be generated or adjusted based on one or more mix identifiers and historical data. This process includes generating or adjusting a calibration curve based on a classification system (e.g., a ‘C40/45’ mix) or compositional information, which could include full composition or adjustments like the addition of water to a truck. Models described herein, may be employed to predict properties under standard contextual conditions, forming the basis for a calibration.

In instances where a calibration is generated, whether for a specific classification or a particular composition, the system may be designed to provide an upper and lower bound or confidence interval for different calibrations. This feature may ensure that users have a clear understanding of the potential range or variability in the maturity and compressive strength estimates. In example embodiments, the system may outputting these upper and lower bounds, potentially in real-time, enhancing the utility and applicability of the data provided. In specific embodiments, the upper and lower bounds may be continuously refined as more information about the mix formulation becomes available.

In some embodiments, the self-serve calibration tool may be designed to manage multiple versions of calibrations, similar to the pre-calibration case, allowing users to access and compare different calibration versions, providing flexibility and a comprehensive understanding of how calibrations may have evolved over time. Additionally, the self-serve calibration tool may be integrated with the mix library, allowing for seamless interaction between calibration management and mix data access. Furthermore, the self-serve calibration tool can be used in conjunction with the mix library to identify historical calibrations that may closely match or even exactly correspond to the mix under consideration.

### Example Advanced Multi-Batch Calibration

In some embodiments, the maturity calibrations and enhanced maturity calibrations may be enhanced with a confidence level, reflecting the variability in performance caused by batch variability. The batch variability may be assessed using various data sources. This may include crush results (such as cubes and cylinders) from multiple batches, device data or measurements from smart sensors, historical performance of the mix or other mixes from the same batching plant, the performance of the same raw materials in different mix formulations, and/or the like. These diverse data sources are linked and aggregated using the methods described herein. The data may then be structured, sometimes employing sophisticated models like transformer-based multi-modal models, to extract meaningful insights.

Maturity or enhanced maturity assessments may be conducted for both the ‘top-end’ and ‘low-end’ of batch performance based on the extrema of batch variability, such as a certain confidence level or standard deviation level (e.g., 2 sigma from mean batch performance). Assessments for any intermediate batch performance, falling between the top-end and low-end, are also possible. These determinations can be provided to the user individually or simultaneously, through interfaces like a web or mobile app, and potentially in real-time. This capability is based on batch-dependent calibration and sensor measurements, offering a comprehensive view of the batch's expected performance. In some embodiments, the identification of a batch's specific position or sub-volume within the mix-space can be determined based on sensor or device measurements. This determination may also utilize the identification methods and/or models described herein, or contextual conditions derived from context awareness.

### Example Univariate Identification and Perturbation Detection in Sensor Signal Representations (e.g., Temperature, Mechanical Impedance)

In a specific subcase of the perturbation mode of operation, embodiments of the invention may address the identification or determination of perturbations through univariate sensor data collected during the curing stage of concrete, using regression analysis.

In an example where the univariate sensor data is a temperature time series, the system may track thermal development of a series of concrete pours over time. Ideally, these pours use the same mix design and have consistent dimensions. The placement of sensors within each pour is uniform, or alternatively, device and material contextual conditions is measured in conjunction with the primary sensor feed.

Methods like context awareness may be applied to compensate for variables such as the thermodynamic properties of the pour geometry. For instance, the relative positioning feature of context awareness compensates for thermodynamic properties of the pour geometry (e.g., faster cooling at the edges of the pour). Typically, the hydration reaction in concrete is exothermic. Any variation in the composition of the concrete can lead to changes in the thermal profile once the concrete is poured. Detecting such a variation in a given pour can indicate a change in the concrete's composition, acting as an identifier of the concrete mix formulation, albeit with low granularity in the case of temperature data.

In the perturbative case, for each temperature profile, key features indicative of the mix design may be established. These features might include peak temperature, the time difference between concrete placement and when peak temperature is reached, and the time taken to return to ambient temperature conditions from the peak. The dimensions and position of the sensor, along with the initial temperature of the pour, may also be considered as they vary according to environmental conditions.

Next, to identify anomalous pours, the system may implement a statistical analysis, which could suggest issues with the concrete. In specific embodiments, a regression analysis may be used to establish a relationship between the initial temperature of each pour and its respective features. Prediction bands may be constructed around each regression line to identify outliers. These bands may encapsulate a certain confidence level (e.g., 90%), meaning that if data points fall outside these bands, it indicates an unexpected result and potential issues with the concrete.

In some embodiments, this process, applicable in both absolute and perturbative modes, may not be confined to temperature data but encompasses any univariate sensor-based approach. This includes the use of various sensors or devices as described herein, allowing for a broad spectrum of applications and adaptability across different scenarios. Examples of such scenarios may include extraction of resonance peaks from an electromechanical spectrum that may act as an identifier or fingerprint for a concrete mix. This approach may include the comparison of specific features of the electromechanical spectrum between different materials. One such feature may be the peak frequency, or the maxima of the impedance spectrum, where comparing the peak frequency of one material to another may reveal differences or similarities in their compositions. Another feature is the width of the resonance peak, such as the full width at half maximum (FWHM), which may provide insights into the material's characteristics and its conformity to the expected profile for a given mix. Additionally, the amplitude of the frequency maxima may be considered, where it, in conjunction with peak frequency and resonance peak width, may form a comprehensive fingerprint in the sensor signal space. Establishing predefined thresholds for changes in these features may enable effective anomaly detection.

### Example Multivariate Identification and Perturbation Detection in Sensor Signal Representations

In some embodiments, the method of univariate identification and perturbation detection, as previously described, can be expanded to a multivariate approach. This extension may involve utilizing features from at least one additional sensor stream alongside the initial sensor stream to create a more comprehensive identification or fingerprint. An illustrative example of this may be combining the three features of the temperature stream with the three features of the mechanical impedance spectrum. This combination may result in a multivariate fingerprint within the sensor signal space.

An additional enhancement to this method, applicable in both univariate and multivariate cases, may involve the integration of material and device contextual condition data. This data, optionally derived from sensor devices, may be used to normalize, correct, or compensate the measurement data. For instance, environmental conditions recorded by a sensor could be utilized to apply a linear or non-linear transformation to the desired measurement streams. Following this transformation, features may then be extracted for analysis. The objective of this enhancement is to isolate the effects or impacts of material composition in the extracted identification features, thereby ensuring that the identification is invariant to contextual conditions.

### Example Identification & Perturbation Detection in Material Property Representations

In an example embodiment, an identifier for a concrete mix may be constructed using specific material properties, which can be either static or contextual in nature. These material properties could be time-invariant, or they might evolve over time. In cases where they evolve over time, the identifier could consist of one or more profiles representing these changes. Additionally, various features may be extracted from these time-evolving signals, similar to the methods described earlier for sensor signal-based representations. Furthermore, material properties might not only vary over time but also across different spatial locations within a concrete pour. The spatial distribution of these material properties can be integral to the identification process. For instance, the strength of the concrete at different locations within a pour could be mapped and utilized as part of the identifier. Time-evolving spatial distributions of these properties can also be considered, and specific features of these distributions may be particularly informative.

An additional enhancement may involve the application of context-awareness-based methods to derive material and device contextual conditions, potentially through sensor data. Moreover, another enhancement foresees the use of contextual condition data to transform material property data. This transformation could involve translating material properties measured under various contextual conditions to a standard contextual condition frame. An example of this would be translating the properties of a concrete cube cured in a water tank at a variable temperature to what they would be at a fixed, standard temperature.

In one example, a particularly effective identifier for concrete mixes is conceptualized, comprising time-evolving, spatially distributed properties of a concrete pour. Such a representation may be uniquely suited for identifying concrete mixes due to its comprehensive and dynamic nature. The identifier may include compressive strength of the mix, workability of the mix, shrinkage of the mix, and/or temperature of the mix. The compressive strength of the mix may be measured in megapascals (MPa), newtons per square millimeter (N/mm²), or pounds per square inch (PSI). This property is not static but varies both spatially within the pour and over time as the concrete cures. The workability of the mix may be assessed in millimeters or equivalent units, typically derived from a slump or flow test for a given volume of concrete. Like compressive strength, workability may also be spatially distributed and evolves over time, reflecting the changing consistency of the mix. Shrinkage of the mix may be quantified as a percentage or as shrinkage distance per unit length. Shrinkage may be a critical factor in concrete integrity and may be measured spatially across different parts of the pour and monitored as it changes over time. The temperature of the mix may be recorded in Celsius, Fahrenheit, or Kelvin, or alternatively as a temperature differential (such as between ambient and concrete temperature, or between starting temperature and current temperature), spatially distributed and/or time evolving. In specific embodiments, these properties can be measured directly or inferred using various devices and methods described herein, including maturity or enhanced maturity methods, wave-based sensor devices, and context awareness techniques.

In an additional embodiment of the invention, the previously described material properties of a concrete mix may be further transformed to standardize them to a common set of contextual conditions. This transformation may employ a mapping function that utilizes context awareness outputs. The transformation process may normalize the spatially distributed material property distribution profiles to a standard reference frame, accounting for varying environmental and situational factors that might influence these properties in their original state. Once transformed, the set of standardized spatial material property distribution profiles forms the identifier for that particular concrete mix.

Optionally, in another aspect of the invention, the time-evolving measures of the concrete mix are processed into a score or other scalar metric (or a plurality of metrics). This processing results in the generation of a fingerprint for the concrete mix, which acts as an arbitrary identifier as defined by the model. The scalar metrics might also take the form of coefficients to a best fit function that describes the behavior of the measure over time.

In a natural extension of the previously described example, the method can be adapted to the perturbative case, focusing on the detection of relative changes in property profiles or scores derived from these properties. This adaptation is particularly relevant for identifying perturbations or anomalies in the mix. Once a perturbation is detected, the next step involves quantifying the extent or nature of this deviation. This quantification may be achieved using the causal perturbation analyzer, a tool or model within the system that assesses the impact and causality of the detected perturbation.

### Example Identification & Perturbation Detection in Milestone Representation

In another embodiment of the invention, concrete mixes may be identified based on the time required to reach certain property milestones. This may include determining the milestone itself, and determining the time taken for a time-evolving property to reach it (e.g., time taken to reach 10, 20 and 30 MPa).

### Example Mix Fingerprint Flowcharts

The flowcharts shown in FIGS. 53-58 may be used to perform various material related determinations. To this end, temperature may be used as an example measurement type of the building material for illustrative purposes. The present disclosure, however, contemplates that the embodiments of the following flowcharts may be equally applicable to data entries associated with any measurement type, such as those described above with reference to the one or more sensors devices 102a-n of FIG. 1.

FIG. 53 illustrates a flowchart containing a series of operations for material identifier determinations (e.g., method 5300). The operations illustrated in FIG. 53 may, for example, be performed by, with the assistance of, and/or under the control of an apparatus (e.g., server 200), as described above. In this regard, performance of the operations may invoke one or more of processor 202, memory 206, communication interface 204, and/or machine learning (ML) module 208.

As shown in operation 5302, the apparatus (e.g., server 200) includes means, such as processor 202, or the like, for receiving a first dataset comprising one or more first data entries associated with a first measurement type of a building material. As described above, the system 100 of the present disclosure may include one or more sensor devices 102a-n that may be, for example, configured to generate first data entries associated with a first measurement type of a building material. This first measurement type may vary based upon the particular sensor device type and may, for example, be received at operation 5302 in response to a request transmitted by the server 200 to the one or more sensors devices 102a-n. In some embodiments, the one or more sensor devices 102a-n may periodically (e.g., at some sampling frequency) transmit the one or more first data entries forming the first dataset to the server 200. Regardless of the material identifier operations described hereafter, the first dataset comprising the one or first data entries associated with the first measurement type may be stored by the server 200 for use in other system 100 determinations (e.g., material monitoring, ML model improvement, etc.)

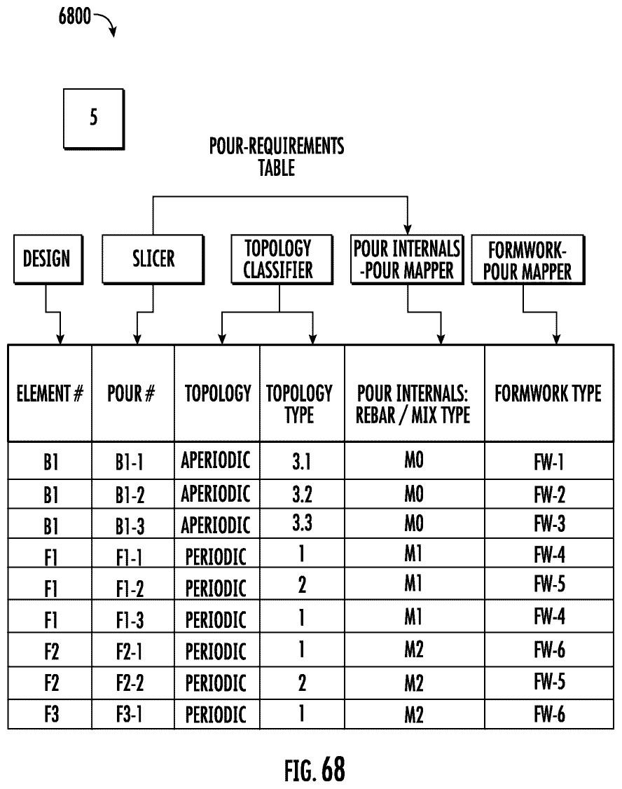

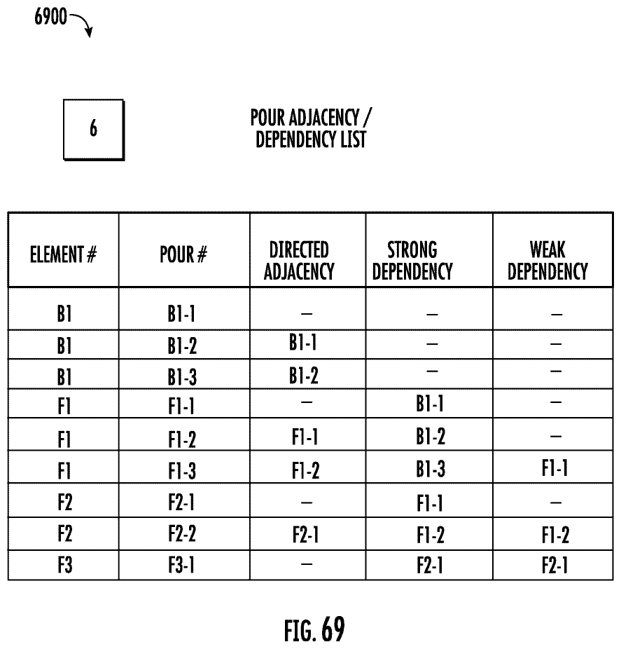

Thereafter, as shown in operation 5304, the apparatus (e.g., server 200) includes means, such as processor 202, or the like, for generating a material identifier associated with the building material based upon the first dataset. In some embodiments, as described hereafter with reference to FIG. 68 the server 200 may access one or more databases storing material identification data associated with a plurality of building material identifiers. Additionally or alternatively, as described hereafter with reference to FIG. 55, the server 200 may deploy one or more machine learning models on the first dataset in order to generate the material identifier. In any embodiments, the generation of the material identifier of the present disclosure may operate as a classifier of the building material.

In some embodiments, the material identifier may refer to a classification or assignment of the building material without reference to a particular unique mixture related classification. For example, the server 200 may receive a first dataset comprising one or more first data entries associated with a temperature of the building material. These first data entries may not, without further comparison or processing, be indicative of the particular chemical or mechanical composition of the building material. The material identifier, therefore, may refer to the classification of the building material for further absolute or relative comparisons against other material identifiers. By way of example, the server 200 may, based upon the first dataset, assign a “Material A” classification to the building material. Upon performance of the operations of FIG. 7 for another building material, a comparison between the data generated for this building material may be compared against “Material A” to determine if the subject building material is substantially similar to “Material A.”

In other embodiments, the material identifier associated with the building material may be indicative of a unique mixture related classifier of the building material. In such an embodiment, the first dataset that comprises first data entries associated with a first measurement type may be compared against a plurality of first data entries of the first measurement type for building materials that have unique mixture related classifiers. By way of a non-limiting example, the first dataset may comprises temperature values that may be compared against temperature values for C80 concrete, C60 concrete, C40 concrete, etc., and this comparison may be used to assign a unique mixture related classifier to the building material based upon any similarity between the data entries.

In other embodiments, the material identifier associated with the building material may be indicative of a chemical and/or mechanical composition of the building material. Similar to the unique mixture related classifier, the first dataset may comprises temperature values that may be compared against temperature values indicative or particular chemical compositions (e.g., the chemical formula defining a particular building material mix) and/or mechanical compositions (e.g., the particular combination of raw materials defining a particular building material) and this comparison may be used to assign a composition (e.g., chemical and/or mechanical) to building material based upon any similarity between the data entries.

In other embodiments, the material identifier associated with the building material may be based upon one or more material properties of the building material. As described above, the first data entries associated with the first measurement type may, for example, be indicative of or otherwise sufficient to generate the material identifier (e.g., temperature data may be sufficient). In other embodiments, the measurement type may serve as the basis for generating, deriving, or otherwise determining applicable material properties for generating the material identifier. By way of example, the first data entries of the first dataset may be associated with a wave-based sensor device (e.g., spectroscopy device) where the spectrum produced during operation of such a sensor device are used to derive various material properties (e.g., compressive strength or the like) of the building material. In such an example, the comparison between these derived material properties and one or more material properties of other building materials may be used to generate the material identifier.

Thereafter, as shown in operation 5306, the apparatus (e.g., server 200) includes means, such as processor 202, or the like, for outputting the material identifier of the building material. In some embodiments, the output may refer to an output to the user, such as via a user interface or other visual representation. In other embodiments, the output of the material identifier may refer to an internal output for further processing steps, such as to determine material anomalies, to further determine material properties, and/or the like.

In some embodiments, as shown in operation 5308, the apparatus (e.g., server 200) includes means, such as processor 202, or the like, for determining one or more material properties of the building material. In instances in which the material identifier of the building material is not indicative of one or more material properties of the building material, the server 200 may determine these one or more material properties at operation 5308 by retrieving the material properties associated with the determined composition (e.g., chemical and/or mechanical) or the unique mixture related classifier. For example, the server 200 may access one or more databases 108 that store material properties that may be searched, sorted, etc. based upon composition and/or unique mixture related classifier.

In some embodiments, as shown in operation 5310, the apparatus (e.g., server 200) includes means, such as processor 202, communication interface 204 or the like, for generating a visual representation of the material identifier for view by a user. By way of example, the server 200 may generate a user interface (UI) that displays material identifier, the first dataset, one or more first data entries, one or more material properties, etc. determined by method 700. The visual representation may include one or more actionable inputs configured to receive one or more user inputs in response to the visually presented information. In some embodiments, the server 200 may leverage natural language processing, interactive, AI-based chat bots, and/or the like to improve user interaction with the system 100. Furthermore, interaction by the user with the system 100 via the user interface may operate as a form of semi-supervised learning in which further performance of the methods herein are impacted by user inputs confirming or rejecting the generated material identifier.

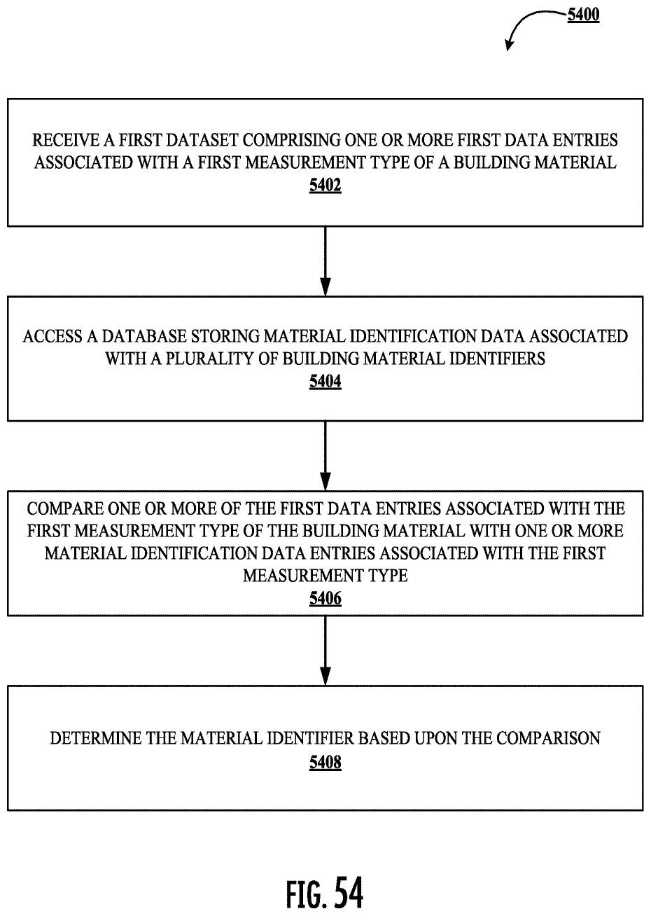

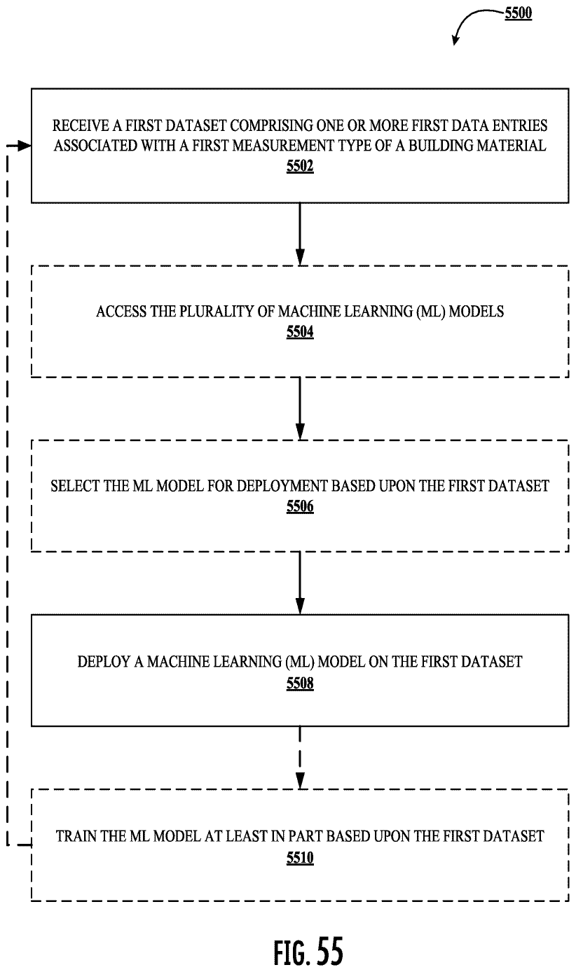

FIG. 54 illustrates a flowchart containing a series of operations for an example method for database based material identifier determinations (e.g., method 800). The operations illustrated in FIG. 8 may, for example, be performed by, with the assistance of, and/or under the control of an apparatus (e.g., server 200), as described above. In this regard, performance of the operations may invoke one or more of processor 202, memory 206, communication interface 204, and/or machine learning (ML) module 208.

As shown in operation 5402, the apparatus (e.g., server 200) includes means, such as processor 202, or the like, for receiving a first dataset comprising one or more first data entries associated with a first measurement type of a building material. Such a receipt of the first dataset may occur substantially the same as described above with reference to operation 5302.

Thereafter, as shown in operations 5404 and 5406, the apparatus (e.g., server 200) includes means, such as processor 202, or the like, for accessing a database storing material identification data associated with a plurality of building material identifiers and compare one or more of the first data entries associated with the first measurement type of the building material with one or more material identification data entries associated with the first measurement type, respectively. As described above, the server 200 may perform material identifier determinations on a plurality of building materials and/or may access databases or repositories that store the same. As the volume of data stored by these databases or repositories increases, the ability of the server 200 to accurately generate material identifiers for subject building material similarly increases. The server 200 may, therefore, access these databases 108 and retrieve material identification data for various predetermined building materials and compare the associated first type measurement data from these predetermined building materials with the one or more first data entries associated with the first type measurement data for the subject building material.

Thereafter, as shown in operation 5408, apparatus (e.g., server 200) includes means, such as processor 202, or the like, for determining the material identifier based upon the comparison. As would be evident to one of ordinary skill in the art, in some instances, the first data entries associated with the first measurement type of the subject building material may be sufficiently similar (e.g., within a defined tolerance or threshold) to the one or more material identification data entries associated with a first measurement type of a particular material identifier stored by the database. In such an embodiment, the server 200 may select this material identifier for the subject building material based upon the similarity. In other embodiments, the first data entries associated with the first measurement type of the subject building material may not be sufficiently similar (e.g., within a defined tolerance or threshold) to the one or more material identification data entries associated with a first measurement type of a particular material identifier stored by the database and/or may lie between (e.g., in gaps) particular material identifiers. In such an embodiment, the server 200 may leverage one or more estimations, interpolation operations, etc. in order to generate the material identifier based upon a plurality of similar material identifiers stored by the database 108. In some embodiments, as described hereafter with reference to FIG. 55, one or more ML models and/or AI techniques may be used.

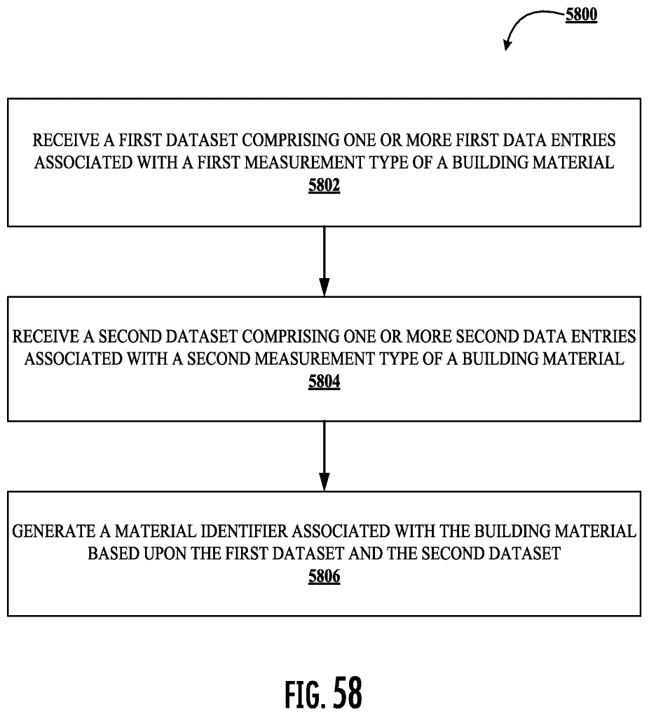

FIG. 58 illustrates a flowchart containing a series of operations for an example method multivariate based material identifier determinations (e.g., method 5800). The operations illustrated in FIG. 58 may, for example, be performed by, with the assistance of, and/or under the control of an apparatus (e.g., server 200), as described above. In this regard, performance of the operations may invoke one or more of processor 202, memory 206, communication interface 204, and/or machine learning (ML) module 208.

As shown in operation 5802, the apparatus (e.g., server 200) includes means, such as processor 202, or the like, for receiving a first dataset comprising one or more first data entries associated with a first measurement type of a building material. Such a receipt of the first dataset may occur substantially the same as described above with reference to operations 5302.

In some embodiments, the system 100 of the present application may leverage a plurality of sensor devices 102a-n and/or a plurality of measurement types by the same sensor device or the plurality of sensor devices 102a-n in order to improve the material identification operations described herein. As such, and as shown in operation 5804, the apparatus (e.g., server 200) includes means, such as processor 202, or the like, for receiving a second dataset comprising one or more second data entries associated with a second measurement type of a building material. As described above, the system 100 of the present disclosure may include one or more sensor devices 102a-n that may be, for example, configured to generate second data entries associated with a second measurement type of a building material that is different from the first measurement type. This second measurement type may vary based upon the particular sensor device type and may, for example, be received at operation 5804 in response to a request transmitted by the server 200 to the one or more sensors devices 102a-n. In some embodiments, the one or more sensor devices 102a-n may periodically (e.g., at some sampling frequency) transmit the one or more second data entries forming the second dataset to the server 200. Regardless of the material identifier operations described hereafter, the second dataset comprising the one or second data entries associated with the first measurement type may be stored by the server 200 for use in other system 100 determinations (e.g., material monitoring, ML model improvement, etc.).

In some embodiments, one or more of the first dataset and the second dataset comprise first data and second data, respectively, generated by a first sensor device. Said differently, in some instances, the first sensor device may be capable of generating data that is indicative of multiple types of measurements (e.g., spectroscopy based and acoustic based). In other embodiments, the first dataset may include first data generated by a first sensor device, and the second dataset may include second data generated by a second sensor device. In other words, in some instances a plurality of different sensor devices 102a-n may be used to generate particular types of measurement data based upon the nature of the sensor device 102a-n. As described above, one or more of such a first sensor device and a second sensor device may be embedded in, disposed on, or directed at the building material. Although described herein with reference to a first sensor device 102a and a second sensor device 102b, the present disclosure contemplates that any number of sensor devices 102a-n may be used.

Thereafter, as shown in operation 5806, the apparatus (e.g., server 200) includes means, such as processor 202, or the like, for generating a material identifier associated with the building material based upon the first dataset and the second dataset. As described above with reference to operation 5304 in FIG. 53 and method 5400 in FIG. 54, the server 200 may access a database storing material identification data associated with a plurality of building material identifiers. The server may therefore compare one or more of the second data entries associated with the second measurement type of the building material with one or more material identification data entries associated with the second measurement type. Additionally or alternatively, the server 200 may deploy one or more machine learning models on the second dataset as described above with reference to operation 5304 and hereafter with reference to method 5400. In doing so, the systems of the present disclosure may leverage a plurality of different measurement types to improve the material identification process. Although described herein with reference to a first and second type measurement data, the present disclosure contemplates that any number of measurement types may be used based upon the intended application of the system 100.

### Selective Machine Learning Based Mix Fingerprinting

FIG. 55 illustrates a flowchart containing a series of operations for an example method for selective (e.g., toggled) machine learning based material identifier determinations (e.g., method 5500). The operations illustrated in FIG. 5 may, for example, be performed by, with the assistance of, and/or under the control of an apparatus (e.g., server 200), as described above. In this regard, performance of the operations may invoke one or more of processor 202, memory 206, communication interface 204, and/or machine learning (ML) module 208.

As shown in operation 5502, the apparatus (e.g., server 200) includes means, such as processor 202, or the like, for receiving a first dataset comprising one or more first data entries associated with a first measurement type of a building material. Such a receipt of the first dataset may occur substantially the same as described above with reference to operations 5302 and 5402.

In some embodiments, as shown in operations 5504 and 5506, apparatus (e.g., server 200) includes means, such as processor 202, or the like, for accessing the plurality of machine learning (ML) models applicable to the building materials described herein and selecting the ML model for deployment based upon the first dataset, respectively. As would be evident to one of ordinary skill in the art in light of the present disclosure, the particular ML model that is applicable to a particular building material, set of conditions, context, etc. may vary. For example, if the server 200 is attempting to generate a material identifier associated with a first curing time, ML models that were trained on data entries associated with such a first curing time may be more accurate than those associated with a second curing time. Various machine learning models are defined herein for mix fingerprinting operations.

In some embodiments, as shown in operation 5508, the apparatus (e.g., server 200) includes means, such as processor 202, ML module 208, or the like, for deploy a trained machine learning (ML) model on the first dataset to generate the material identifier as described hereafter. The trained ML model may also refer to a mathematical model generated by machine learning algorithms based on training data (e.g., various feature sets of building material related data), to make predictions or decisions without being explicitly programmed to do so. The trained ML model may similarly represent what was learned by the selected machine learning algorithm and represent the rules, numbers, and any other algorithm-specific data structures required for decision-making. Selecting the right machine learning algorithm may depend on a number of different factors, such as the problem statement and the kind of output needed, type and size of the data, the available computational time, number of features and observations in the data, and/or the like. The trained ML model or algorithm may also refer to programs that are configured to self-adjust and perform better as they are exposed to more data. To this extent, the trained ML model or algorithm is also capable of adjusting its own parameters, based on previous performance in making prediction about a dataset.

The present disclosure provides various example ML models for performing mix fingerprint operations. For the sake of completeness, the present disclosure further notes that the ML algorithms contemplated, described, and/or used herein (e.g., the trained ML model) may include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

The ML models may be trained using repeated execution cycles of experimentation, testing, and tuning to modify the performance of the ML algorithm and refine the results in preparation for deployment of those results for consumption or decision making. The ML models may be tuned by dynamically varying hyperparameters in each iteration (e.g., number of trees in a tree-based algorithm or the value of alpha in a linear algorithm), running the algorithm on the data again, and then comparing its performance on a validation set to determine which set of hyperparameters results in the most accurate model. The accuracy of the model is the measurement used to determine which set of hyperparameters is best at identifying relationships and patterns between variables in a dataset based on the input, or training data. A fully trained ML model is one whose hyperparameters are tuned and model accuracy maximized. In some embodiments, as shown in operation 710, the apparatus (e.g., server 200) includes means, such as processor 202, ML module 208, or the like, for training the ML model at least in part based upon the first dataset. In other words, performance of the operations described herein regarding generating a material identifier for the subject building material based upon the first dataset may be used to improve subsequent iterations of the methods described herein.

### Perturbative Mix Fingerprinting

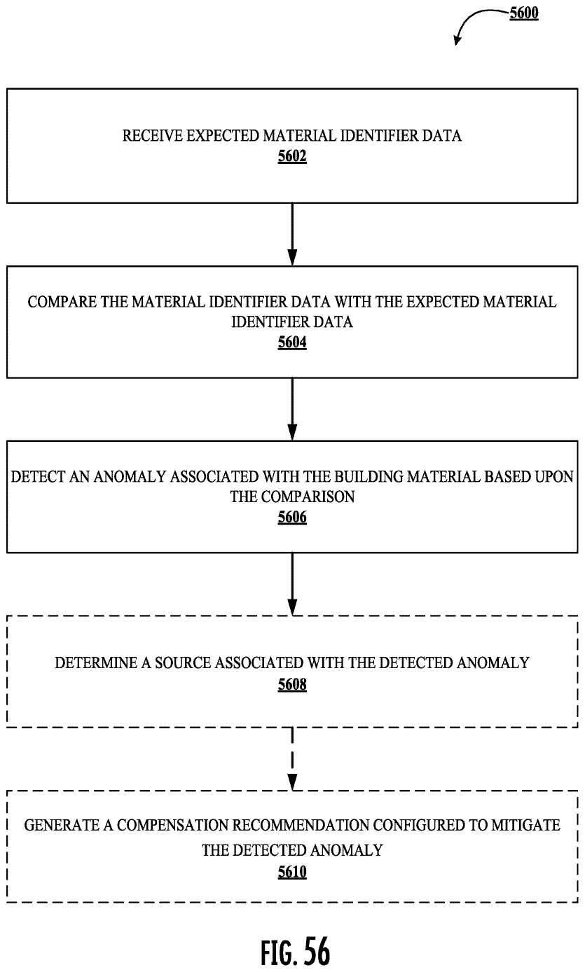

FIG. 56 illustrates a flowchart containing a series of operations for an example method for anomaly detection (e.g., method 5600). The operations illustrated in FIG. 56 may, for example, be performed by, with the assistance of, and/or under the control of an apparatus (e.g., server 200), as described above. In this regard, performance of the operations may invoke one or more of processor 202, memory 206, communication interface 204, and/or machine learning (ML) module 208.

As shown in operation 5602, the apparatus (e.g., server 200) includes means, such as processor 202, or the like, for receiving expected material identifier data. In some embodiments, the system may receive data, information, user inputs, etc. that indicate an expected material identifier associated with a particular portion of a building material. For example, a user may input the particular unique mixture related classifier of the building material. By way of an additional example, the server 200 may generate the expected material identifier based upon one or more material identification operations, such as those described above with reference to FIGS. 53-55 and 58, associated with the same building material. In particular, the server 200 may perform the operations of FIG. 53 for the building material at a first location (e.g., the batching plant) to generate a material identifier for the building material. The operations of FIG. 56 may occur at a second location (e.g., during pour) later in time. By way of another example, the server 200 may receive the expected material identifier data from a related portion of the building material (e.g., an earlier pour in the same location, another pour using the same building material (mix). In any embodiment, the server 200 may access data that is indicative of the material identifier the server expects to determine during a subsequent performance of the material identification operations (e.g., performance of method 5300) described herein.

As shown in operations 5604 and 5606, the apparatus (e.g., server 200) includes means, such as processor 202, or the like, for comparing the material identifier data with the expected material identifier data and detecting an anomaly associated with the building material based upon the comparison, respectively. By way of example with reference to data entries associated with temperature, the server 200 may track the thermal development of a series of concrete pours (e.g., building materials) over time. As would be evident in light of the present disclosure, these concrete pours may use the same mix design and also be of consistent dimensions with sensor device 102a-n located in substantially the same location within each pour. The hydration reaction which takes place in concrete is exothermic, and variation in concrete composition may result in a change in the thermal profile of the concrete once poured into a form. If such variation is detected in a given pour, the server 200 may determine that the composition of the concrete (e.g., building material) has changed.

As shown in operations 5608 and 5610, the apparatus (e.g., server 200) includes means, such as processor 202, or the like, for determining a source associated with the detected anomaly and/or generating a compensation recommendation configured to mitigate the detected anomaly. As described above, the system 100 of the present disclosure may receive data from sensor device 102a-n and/or users at various stages of the building material's lifespan at various locations. As such, the server 200 may operate to analyze the data associated with a particular building material (e.g., a particular pour or portion of a pour) at these various stages in order to determine any particular influences that may have resulted in the anomaly described herein (e.g., a change in the mechanical composition of the building material, a change in environmental conditions, a change in sensor position, etc.). As would be evident to one of ordinary skill in the art in light of the present disclosure, the anomaly detected above may result in a change in the performance characteristics of the particular building material (e.g., insufficient compressive strength, a longer curing time, etc.) In order to address this change in performance, the system 100 may, for example, modify a building plan or schedule (e.g., to account for increased curing time). Additionally or alternatively, the system 100 may add additional support structures, increase the compressive strength of related building materials, etc. (e.g., to account for insufficient compressive strength). The server 200 may leverage one or more machine learning models and/or artificial intelligence techniques to determine a source of the anomaly and/or generate a compensation recommendation. The present disclosure contemplates that the server 200 may be configured to detect anomalies of any type and may generate compensation recommendations of any type.

### Enhanced Maturity Operations

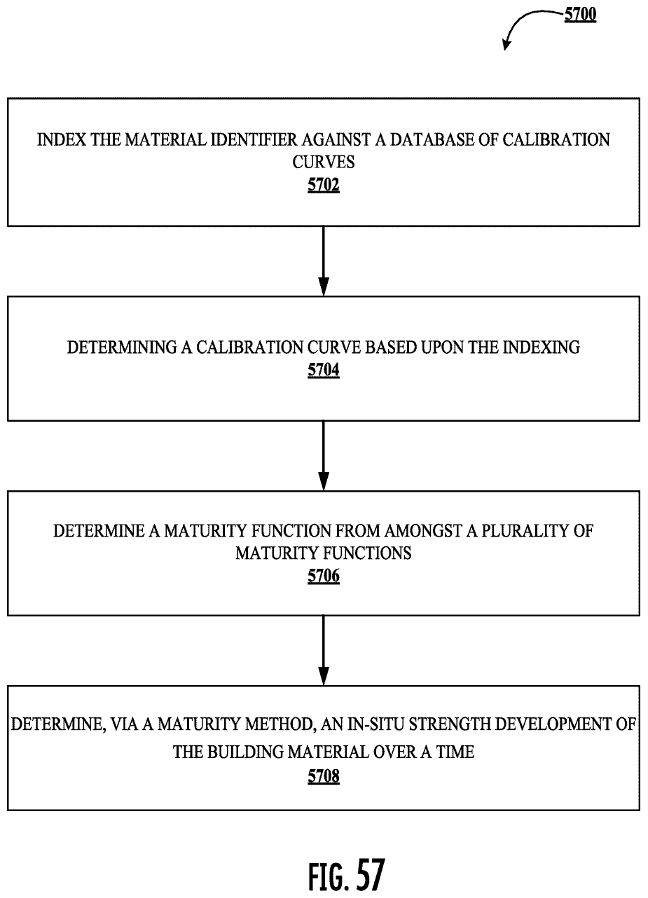

FIG. 57 illustrates a flowchart containing a series of operations for an example method for enhanced maturity determinations (e.g., method 5700). The operations illustrated in FIG. 57 may, for example, be performed by, with the assistance of, and/or under the control of an apparatus (e.g., server 200), as described above. In this regard, performance of the operations may invoke one or more of processor 202, memory 206, communication interface 204, and/or machine learning (ML) module 208.

As shown in operation 5702, the apparatus (e.g., server 200) includes means, such as processor 202, or the like, for indexing the material identifier against a database of calibration curves. For example, the server 200 may access one or more databases 108 storing various calibration curves that may be applicable to the particular material identifier associated with the building material.

Thereafter, as shown in operation 5704 and 5706, the apparatus (e.g., server 200) includes means, such as processor 202, or the like, for determining a calibration curve based upon the indexing and determining a maturity function from amongst a plurality of maturity functions, respectively. As would be evident to one of ordinary skill in the art in light of the present disclosure, the identity of the concrete (building material) may be indexed against a database of strength gain curves (e.g., calibration curves in the context of the maturity method) and the correct curve is either selected or generated. The appropriate maturity function (e.g., correlation between rate of hydration reaction and temperature/temperature sensitivity of the concrete) is chosen from a set of potential equations (e.g., Nurse-Saul, Arrhenius, and/or Sadgrove).

Thereafter, as shown in operation 5708, the apparatus (e.g., server 200) includes means, such as processor 202, or the like, for determining, via a maturity method, an in-situ strength development of the building material over a time in accordance with various standardized methods.

### Pour Design and Sequencing

Pour design and sequencing may be described as a sensor-based, computer implemented method that generates the design and/or pour sequencing for one or more aspects of a structure, or an entire structure, for a construction project. The method may then be used to produce a pour schedule and/or concrete cycle based upon this design and sequencing i.e., generating an actionable plan to realize the design and sequencing. This constitutes the planning phase.

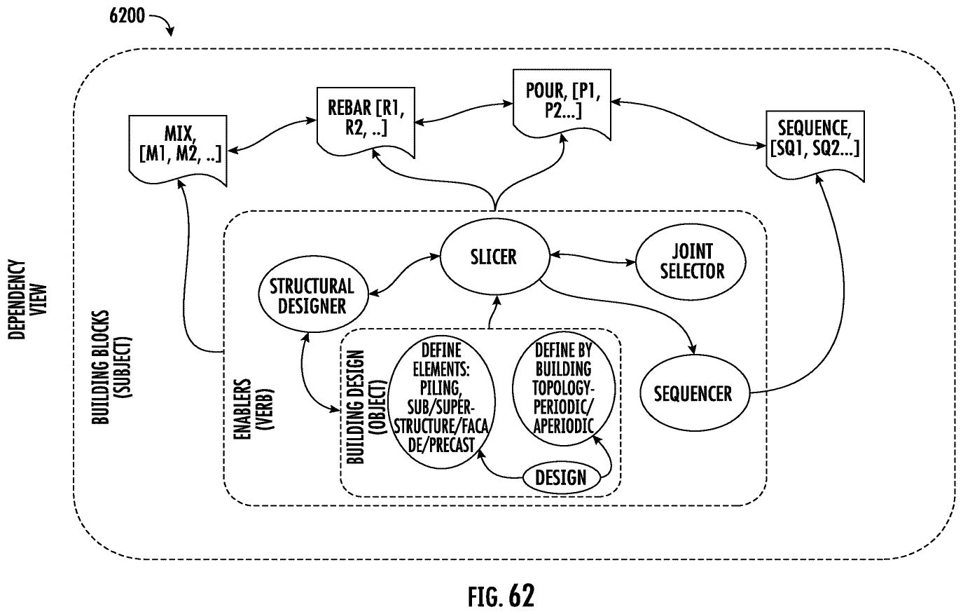

The method may also be used in real-time, as the project is taking place, to compare and update the generated design with the reality of the project iteratively. Every new updated version of the design may be referred to as iteration i, with iteration 0 referring to the initial design generated in the planning phase. This constitutes the dynamical phase. As illustrated in the interaction view 6100 and dependency view 6200 of FIGS. 61 and 62, respectively, the construction design and sequencing process may be described from a top down, high-level approach as follows.

The process begins by setting out a high-level building design (note, a building design refers to any structure to be built and may apply to structures not traditionally thought of as buildings e.g., bridges, roads, tunnels etc.). The building design answers the high-level aspects of: what is the end goal of the project? What is the structure to be constructed? Note, this design may in general exist at any level of granularity, and may be formulated in various ways (e.g., “A building that is at least 200m tall” may constitute an extremely coarse/low granularity building design, A specification, alongside aesthetic requirements, building code requirements, and a BIM Model may constitute a higher granularity building design).

The process ends once a final structure is constructed which meets a specific building design. The elements required to construct this final entity alongside the sequencing of these elements are the final structure's building blocks. These must be identified in order to construct the final entity. Thus, the building blocks answer-what are the constituents required to build the final entity? (e.g., these constituents need not be physical entities, and can be pour sequences). This is the key output of the methods.

The system 100 may include building design to building blocks using enablers. Enablers by definition then, answer-how to move from a high-level building design to specific, optimal building blocks and building designs. These may typically be aspects of the methods and techniques described herein. Once specific design has been reached, a global loop evaluating the generated building design allows for improvements/optimization of any part of the design and/or the method used to generate the design.

This approach allows the system to characterize the problem space for pour design & sequencing. In this formulation, the problem statement may be defined as: “Given a high-level building design, determine a set of optimal building blocks which satisfy the design”. Enablers and the iterative loop, then become example embodiments through which this problem may be solved.

In general, many building blocks may exist within the space of design & sequencing. Any of these may be specified as part of the building design (which defines the granularity of the design), or not be specified, in which case it may be generated, optimized and/or otherwise determined (if this is the case, the building blocks may be varied). The system may focus on 5 building blocks which may in some embodiments sufficiently characterize the design & sequencing space-note, the techniques and methods described herein may be applied for the determination of any building block not provided as part of the building design input.

The 5 building blocks the system may focus on here are: Mix Design—This refers to the mix design (which may be a concrete mix) used in every pour. Varying this means allowing for the concrete used in pour(s) to vary; Rebar Design—This refers to the identity, layout/distribution, dimension, and any other information relating to the rebar used in pour(s). Varying this means allowing for the type of rebar used and/or its distribution within concrete to vary.

Pour Sequencing—This refers to the order in which pours are to be poured. Varying this means allowing for this ordering to vary. Pour Layout/Slicing—This refers to the way in which the predefined geometry of a building design is sliced into pours. Varying this means allowing for the way in which the underlying geometry of the building is subdivided into pours to vary. Geometry and Overall Design—This refers to the general design of the overall structure of the building and includes the geometry of any part of the structure. Varying this parameter means allowing for the geometry and structure of the building to change. This inherently changes the volume which is to be sliced and sequenced. In the precast case, or in non-concrete structure cases, rather than the building blocks referring to pours, they may refer to other types of structure compositional elements (e.g., units).

Additional examples of building blocks may include but are not limited to: MEP ducts; electrical conduits; cables; cable trays; facade panels; facade mullions; facade transoms; dry wall; internal fittings such as doors, architraves, carpet, ceiling tile, floor tile; beams; columns; trusses (fancy beams); frames, elastomeric bearings, seismic isolators, balustrades, planters, joints such as expansion joints; concrete cycles; construction schedules; formwork; falsework; and/or props.

In some embodiments, the above 5 building blocks of focus, also known as parameters, may contain inter-dependencies. These dependencies may be characterized as rules. In one embodiment, these rules may be the following: Varying parameter 4 must lead to varying parameters 3 & 2; Varying parameter 5 must lead to varying parameter 4 (and hence 3 & 2).

These rules may be deduced as follows. In the following embodiment, consideration of each parameter explains why varying parameter 4 must or must not generally lead to its variation as well in this embodiment: Parameter 5: Varying Layout is a subset of varying Geometry, therefore this is N/A→not varied; Parameter 3: If Pour Layout varies, then the Pour Sequence must be edited accordingly (since the thing you are sequencing has changed)→varied; Parameter 2: If Pour Layout varies, then the rebar layout must be edited accordingly (since the way rebar is installed in a pour inherently depends on the shape of the pour)→varied; Parameter 1: As long as the mix design(s) used fits the given rules of the game (e.g., adheres to thermal constraints), then there is no reason it/they must generally always change given a change in Pour Layout→not varied.

Let us consider each parameters and explain why varying parameter 5 must or must not generally lead to its variation as well in this embodiment: Parameter 4: If Geometry varies, the Pour Layout/Slicing must inherently change since the underlying geometry that is being sliced is different→varied; Parameter 3: If Geometry varies then the Pour Sequence must change accordingly (since the thing you are sequencing has changed).→varied; Parameter 2: Varying Geometry will change the shapes of pours. Rebar layout is dependent on pour shape. Thus, varying the geometry will vary the rebar.→varied; Parameter 1: As long as the mix design(s) used fits the given rules of the game (e.g., adheres to thermal constraints), then there is no reason it/they must generally always change given a change in Geometry.→not varied.

Mapping out the Pour Design & Sequencing space may be done by finding all the combinations in which you either vary or keep constant (i.e., given) the above 5 building blocks. In general, the number of possible combinations would be 32 (i.e., 25) for the building blocks laid out above. Given the above rules as constraints, there may be 11 possible instantiations of Pour Design & Sequencing in this embodiment.
Varying 1 parameter: The Optimized Mix Designer includes Vary MIX while fixing all else. The Optimized Rebar Designer includes Vary REBAR while fixing all else. The Optimized Pour Sequence Designer includes Vary SEQUENCE while fixing all else.
Varying 2 parameters: The Optimized Mix & Pour Sequence Designer includes Vary MIX & SEQUENCE while fixing all else. The Optimized Rebar & Pour Sequence Designer includes Vary REBAR & SEQUENCE while fixing all else. The Optimized, Mix & Rebar Designer includes Vary MIX & REBAR while fixing all else.
Varying 3 parameters: The Optimized Mix, Rebar & Pour Sequence Designer includes Vary MIX, REBAR & SEQUENCE while fixing all else. The Optimized, Mix-Controlled, Pour Slicer includes Vary REBAR, SEQUENCE & LAYOUT while fixing all else.
Varying 4 parameters: The Optimized Pour Slicer includes Vary MIX, REBAR, SEQUENCE & LAYOUT while fixing DESIGN. The Optimized, Mix-Controlled, Architect includes Vary REBAR, SEQUENCE & LAYOUT & DESIGN while fixing MIX.
VARYING 5 PARAMETERS: The Optimized Architect includes Vary EVERYTHING.

These eleven modes represent one embodiment of the invention. In other embodiments, any combination of the 5 building blocks may be different modes of the invention. It will be clear to one skilled in the art that other design considerations may in certain embodiments also be considered building blocks. Such embodiments also may fall under the scope of Pour Design & Sequencing. Any parameters associated with the generation of a structure design may be used to achieve the structure design and may be generated as part of the structure design.

### Data, Inputs & Outputs

The following are sources from which data used by the models may be collected. This list is only representative and non-exhaustive.

Data sources may include measurements, which may include sensor device measurements, wherein sensor device measurements may include wave-based sensor device measurements; temperature sensors (point-based and distributed, including differentials from single or multiprobe thermal tails), maturity sensors and enhanced maturity sensor device measurements; Positioning and Interaction sensor device measurements; Other sensor measurements. Particular sensor measurements of interest are those that relate to the time and spatial evolution of (1) compressive strength of concrete, (2) temperature of concrete, (3) workability of concrete, and (4) shrinkage of concrete. Further, measurements may include machine measurements (e.g., batching machine data), and other measurements.

Further, data sources may include documents (e.g., ground survey reports) may include digital documentation, and physical documentation; human input; Third Party Services; and Other Methods described in other sections of this document (e.g., Mix Optimization, Mix Fingerprinting, Context Awareness, Status Inference, Mix Fingerprinting, Data Linkage, Others).

### Inputs

Generally, any data type extracted from any data source mentioned in any part of this document may be used as an input for the pour design and sequencing models. The inputs listed below are particularly relevant instantiations in one embodiment but are representative and not exhaustive. The categories are also non-rigid (e.g., in some embodiments, some training input data may be used and/or categorized as inputs for the eleven modes and vice-versa).

The pour design and sequencing process in its most generalized form (e.g., mode 11), is a highly complex process with many interdependencies. At a high level, the methods and techniques may be used to generate an optimal physical structure to be built, and an optimal schedule outlining steps to build it. Both these steps are highly multivariate and complex and are also interdependent. The methods described herein consider the complexity within each step, as well as the complexity in their interdependencies. There will therefore be many considerations the models will have to take into account. These may be partitioned Training Data Inputs, Core PDS Models Inputs, and Dynamical Modes Data Input.

Training Data Inputs may include historical data associated with previous projects that may be used to train the models to reason about generating the pour design and sequence. This may include contextual conditions about the data, such as Sensor Contextual Conditions (as described elsewhere in this document), Material Contextual Conditions (as described in other parts of the document, which may include Casting Conditions, for example), and Structure Contextual Conditions which may be an imposed state or attribute that partially or wholly defines the instantiated context in which a structure exists (e.g., time, temperature, geometry, atmospheric humidity, location, altitude etc.). A contextual condition can be an aspect of the structure itself, the project within which the structure is being constructed, or of the environment.

This may include the same data types as material contextual conditions, however, the data types relate to the instantiated context of the structure under construction, rather than the material itself. Some particularly relevant ones include: Environmental Data; Meteorological Data; Geological Data; Terrain Data (E.g., 3D map of the terrain upon which the construction happens such as a nearby hill, flat, mountain, water); Surroundings Data (E.g., nearby buildings, roads, rivers and/or others which may restrict building operations); Oven Data; Altitude Data (Altitude with respect to sea level); Environmental Phenomena Data (Earthquake Data, Hurricane Data, Etc.); Temporal Data i.e., temporal data associated with any other data, process and/or schedule.

### Further Property Data.

Compositional Structure Properties Data including Structure Material Composition Data—i.e., any data associated with the materials that constitute the structure such as a list of materials/elements which constitute the building, optionally alongside its location(s) on the building or the compositional proportion of each (Concrete; Steel; Glass; Screeds & flooring materials; Wood; Plaster; Tiling; MEP (MEP Data refers to data associated with any mechanical, electrical and/or plumbing materials which are part of the project)). Compositional Structure Properties Data may also include Structure Count Composition Data—i.e., any data associated with the number or proportions of a particular construction resource as part of the structure. Compositional Structure Properties Data may also include Structure Element Composition Data—i.e., any data associated with any elements that constitute the structure. These elements may be at any level of granularity. For example, for tower this may include Section composition (Piles Data, Substructure Data, Superstructure Data); Granular element Composition (where an element may represent a pour, a precast element, or even a BIM element for e.g.).

Structure Physical Property Data includes an attribute or state of the physical structure which may be associated with its behavior and/or properties. Any such data may be associated with any section, subsection, element, and/or location point of the structure under consideration, at any granularity level. Structural Physical Configuration Property Data includes data pertaining to geometry, physical form, structure, layout, arrangement, configuration and/or content (e.g., rebar) of a structure (Element type data; Geometry/dimensional data; Exposure data; Reinforcement geometry data; Information about general surroundings). Structural Physical Material Property Data includes data associated with properties of the materials and/or elements and/or groups of elements constituting the building (Load Data; Stress Data; Strain Data; Joint Data; Shrinkage & Material Displacement Data; Thermal Data; Crack Data & Crack Risk Data; Dimensional Stability Data; Durability Data; Shear Data; Embodied Carbon Data). Structural Physical Damage Data includes associated with the damage of part of a building (such as the breaking of part of the structure). Structural Physical Operational Data i.e., any data relating to the building whilst in operation/use (Insulation Data; Energy Consumption Data).

Further, Adjacency and Dependency Data (and optionally linkage data) may include data associated with the relationship between different elements which constitute the structure and/or construction resources. For example, Adjacency may include Element A is directly adjacent to Element B on Floor X. A Dependency Example may include Formwork 1 is used to pour Pour 1 and Pour 2.

Further, Constraints Data may include hard requirements on the value of any other data type and/or category listed herein. For instance, Spatial Requirements may include hard requirements on 3D space e.g., requirements on the allowable construction zone within which the structure may be built-including height and depth and dimensions of the area relating to the terrain. Further, Structural Requirements may include Load Requirements, Strength Requirements, Joint Requirements, etc. Physics Requirements may include requirements derived from laws of physics such as an element cannot float in the air.

Scheduling requirements may include the structure must be built by Date X. Supply Chain and Resource Availability Data and Requirements includes data associated with the supply chain and availability of any construction resource may include Material Availability (e.g., Concrete formulations available to select from); Formwork Availability (E.g., total number of formwork available to be used on site over the lifetime of the project); Blankets Availability (E.g., number of available blankets at any given time t); Workforce Availability (E.g., number of staff on site); Fleet Data (Number of trucks available for concrete delivery, Location of trucks & ETA, Rate at which concrete may be delivered to site, Rate at which rebar may be delivered to site); Forms Availability Data; Fixtures Availability data; Backprops Availability data; Price Lists & Material Costs Data; Construction Project Process Map.

Additional examples of relevant sources of constraints include BIM Models, floorplans, and other spatial representations (e.g., geometrical requirements), Specifications (e.g., compressive strength requirements), Building Codes (e.g., fire safety requirements), Laws of Physics, Schedules (e.g., temporal requirements), Building Design Documentation (e.g., aesthetic requirements, building block requirements), Environmental Product Declarations (e.g., carbon requirements), etc.

Other Data may include Source/Supplier Data such as Material Sourcing Data (How, where and by whom a material was gathered, processed or manufactured), Quantitative Data regarding a supplier (e.g., Organization size, Reputation score).

Before construction begins, the methods and techniques described herein may be used to generate a building design which includes any of the 5 building blocks mentioned above, a concrete cycle, a construction schedule, joints identifiers and/or others. The following list is a representative list of inputs that may be ingested by the models to generate the above. Note, this is not exhaustive, and represents one embodiment of these methods.

Mode Identifier may include data that will instruct the methods on what needs to be output/generated. For example, in one mode/embodiment, a list of mixes with associated elements may be generated. In another mode, mixes, rebar identifiers, a pour sequence, a concrete cycle and a schedule may be generated. In another mode, all the above may be generated as well as a list of joints to be used, a pour layout and structure geometry.

An identifier will allow the systems to understand which embodiment needs to be used. These may be inputted by the user, inferred by the engines (based on other input data for e.g.), or otherwise ingested by the models.

Initial Structure Design/Prior knowledge regarding the structure to be built and may include any known and/or planned information regarding the structure to be build. This may include information associated with: The type of structure being built (e.g., tower, road, bridge, tunnel), Aesthetics of the structure (e.g., the structure should have a modern style with many square edges and also may include aesthetic acceptable crack size), and a pour adjacency/dependency list.

Building Blocks Priors may include known information associated with any building block and/or milestones, such as joint information, mix choice, rebar choice, pour sequence, pour layout, geometry of pour and/or structure.

Constraints Priors may include known information associated with constraints relating to the structure planned to be built, which must be met. In some embodiments these may be handled through the use of an objective and/or utility function. In some embodiments this may also be part of the Initial Structure Design. This in general may include any known constraint placed on any data type herein and may commonly include the Constraints Data listed above e.g., timeline constraints, material constraints, specification constraints.

Supply Chain and Resource Availability Data and Requirements may include data associated with the project's supply chain (which may include quarry, raw materials production plant, batching plant, precast factory and the site) and the availability of any construction resources throughout the supply chain. This may also include constraints and requirements upon these data such as Fleet data (X trucks are available which can carry Y volume of concrete to site. The duration of each trip from factory to site is T), Crane availability and scheduling data, Forklift availability and scheduling data.

Adjacency and Dependency Priors Data (as described above) may include Adjacency (Floor 2 is above Floor 1) and Dependency (Floor 2 may not be built before Floor 1).

Contextual Conditions includes any contextual conditions associated with the structure under consideration and may include any contextual condition listed in any part of this document, including those above. Some examples may include Planned Location of project (e.g., absolute position, latitude longitude, continent, country, region, city, town etc. . . . ), Planned timeline (e.g., start date and end data, season), Environmental Data (e.g., average ambient temperature, humidity and precipitation in given geography).

Optimization Objectives may represent certain objectives and/or preferences associated with the structure design and/or scheduling. These inputs will inform the models to prioritize one objective over others. In some embodiments these may be handled through the use of an objective and/or utility function such as minimizing the embodied carbon in the structure, minimizing the time required to build the structure, minimizing material wastage associated with building the structure, minimizing cost.

As the structure is under construction, deviations (also called ‘perturbations’) from the initially generated building blocks, design and schedules may occur. This mode identifies these perturbations, updates the outputs generated in the planning mode accordingly and may generate improvements and recommendations. This may be done iteratively, where the outputs generated in the planned mode may be regarded as iteration 0, and every subsequent iteration generated in dynamical mode may be iteration i. The following is a representative list of the inputs which may be ingested by the models to execute the above. Note, this is not exhaustive, and represents one embodiment of these methods.

All data types included in the Planning mode inputs should be included here as well. All data types mentioned in any part of this document may also be included. The following is a representative list of data ingested beyond what is ingested in the planning phase.

Real Time Status of Construction Data includes any real time data associated with the construction project. This may include data of any type above e.g., Real Time Contextual Conditions such as Real Time Ambient Temperature (This may be accessed by querying APIs into third party data systems. E.g., meteorological data can be retrieved from external climate/weather service APIs), Real Time Property (e.g., Real Time Shrinkage as measured by a wave-based sensor device), Real Time Supply Chain and resource availability data (e.g., Real Time shortage of concrete delivery trucks, Real Time formwork availability data (e.g., no formwork is currently available), Lorry schedules (daily material availability), Resource schedule (cranes, fork-lift trucks), Piling rig availability schedule), Real Time Progress i.e., any data associated with the current progress of construction (e.g., Floor 1 is 75% complete).

Sensor Device Measurement Data (Sensor Device Data) may be an important source of real time data. Indeed, as more sensor devices are installed throughout the lifetime of the project, more real time monitoring data becomes available. Any sensor measurement data listed in other sections of this document may be an input here.

Data Sourced from Progress Reports may present an important source of real time information associated with the progress of the project.

Outputs from Status Inference may provide real-time insights and inferences relating to the state of the project, in particular using sensor device measurements. Progress Statuses may be particularly relevant here.

Outputs from Context Awareness may provide real-time data such as structural data and/or sensor contextual conditions, which may be relevant here (for e.g., to inform contextual conditions data, or normalize training data) such as Sensor Location, Rebar configuration, Formwork and Formwork Type, Steel Fixing.

### Human Input Data May Relate to the Real-Time State of the Site.

Perturbation tolerances include conditions placed upon the outputs of the previous iteration of Pour Design and sequencing, which may define what is and is not considered a perturbation.

Outputs from iteration (i−1) may include the outputs generated by the previous iteration of the Pour Design and Sequencing models may act as inputs to generate this iteration. This may include any of the following, individually, or in any combination. Note the list below may not be comprehensive. This may also refer to any other data required to execute on any part of a building's design (Mix & Pour Identifiers/Mix & Precast Element Identifiers, Rebar & Pour Identifiers/Rebar & Element Identifiers, Pour Sequence, Pour Layout, Design & Geometry, Schedule, Concrete Cycle, Joint identifiers, Formwork identifiers, Topology identifiers).

### Outputs

The outputs in planning mode are the same as those outlined above for “iteration i−1”, including any of the following, individually, or in any combination. Note the list below is representative and may not be comprehensive. Other outputs may also refer to any other data required to execute a structure's design into reality.

Building Block Outputs refers to any building block that may be outputted, including Mix & Pour Identifiers/Mix & Precast Element Identifiers, Rebar & Pour Identifiers/Rebar & Element Identifiers, Pour Sequence, Pour Layout, and Geometry/Design.

Milestone Outputs refers to any milestone that may be outputted. This may be any data type generated through any milestone including Schedule, Concrete Cycle, Pour Requirements Table, Pour Adjacency/Dependency List.

Ancillary Outputs refers to any data generated as a consequence of generating the building design, which is not a building block output, milestone output and/or documentation output, including Joint identifiers, Formwork identifiers, Topology identifiers.

Documentation Outputs may include any documentation type, listed in any section herein, which is not an output of the above, for example. Documentation may be outputted using generative techniques, as well as LLM techniques where the documents are text files, and/or multimodal techniques when documents combine data modalities (e.g., text and images). Documentation Outputs may include, for example, BIM Model, compliant to generated design, Specification for the generated design, EPDs, any other documentation associated with the generated design. The specific outputs may differ on which mode of the invention is being used, especially the building blocks outputs may differ significantly.

The outputs in dynamical mode may include the following (note, in dynamical mode, a perturbation is defined as a deviation, within a certain tolerance, between the real state of the construction site and the output of the PDS-X Model's last iteration.

PDS Perturbation Inference may include Boolean yes/no (e.g., indicating whether a perturbation has occurred), and Anomalous Data (e.g., data showing the perturbation such as showing the deviation from the expected pour layout).

PDS Perturbation Impact may be defined as the impact the perturbation will have on the project schedule (e.g., how is the perturbation reflected in the schedule, including how knock-on and dependency effects may affect the schedule).

PDS Perturbation Dynamical Analytics may include Dynamical Analytics and Inferred Perturbation Cause. Dynamical Analytics may include insights, analytics relating to the execution of the generated structure design so far and predictions relating to the future such as Causal analysis (e.g., process X led to the creation of structure Y), Bottleneck analysis (e.g., formwork for element E is bottleneck in concrete cycle), Critical Path Analysis, Productivity Analysis, Expected timeline predictions, Expected future causes of perturbation. Inferred Perturbation Cause includes most likely in human readable text format, explaining the cause of the perturbation (e.g., no formwork was available which has delayed the concrete cycle).

PDS Dynamical Recommendation/Iteration i generation may include any of the following, individually, or in any combination, in light of the new perturbation that has occurred. This may constitute iteration i of the pour design & sequencing output. Note the list below may not be comprehensive. This may also refer to any other data required to execute a structure's design. Building Block Outputs refers to any building block that may outputted such as: Mix & Pour Identifiers/Mix & Precast Element Identifiers, Rebar & Pour Identifiers/Rebar & Element Identifiers, Pour Sequence, Pour Layout, Geometry/Design. Milestone Outputs refers to any milestone that may be outputted. This may be any data type generated through any milestone (e.g., Schedule, Concrete Cycle, Pour Requirements Table, Pour Adjacency/Dependency List). Ancillary Outputs refers to any data generated as a consequence of generating the building design, which is not a building block output, milestone output and/or documentation output such as Joint identifiers, Formwork identifiers, Topology identifiers.

Documentation Outputs may include any documentation type, listed in any section herein, which is not an output of the above, for example: BIM Model, compliant to generated design, Specification for the generated design, Environmental Product Declarations (EPDs), any other documentation associated with the generated design. Note, this may output a selection of recommendations for the user to choose from.

### The Core Models

The Core PDS Models, also known as PDS-X (where X specifies the particular mode), are the models and techniques that generate the desired designs and sequences. They may be used both during the planning phase and the dynamical/execution phase and are therefore referred to as the ‘core’ PDS Models.

### Generalized Model Framework-Milestones

It is possible to characterize essential milestones for Pour Design & Sequence (PDS) which may provide the basic parts of the invention, these may be referred to as PDS Milestones. These milestones are core aspects of construction that may generally apply to most construction projects. PDS Milestones may be defined as key stages, events and/or outputs in the lifecycle of a project, which may sit on the critical path of the project. These form the essential framework on the basis of which the system may construct the modes of operation of the invention. Note, the eight milestones outlined herein represent one embodiment of the invention. In general, any milestone and any milestone combination may be used in other embodiments. The eight milestones outlined herein are also representative milestones, and it would be clear to one skilled in the art that the techniques and methods described herein may be used to reach other milestones as well as any combination of construction milestones not explicitly listed herein.

For automated PD&S, the start and end points are as follows: Design is the progenitor to any construction project, and Specific Design generation, Schedule generation and building block generation (including pour layout generation) are the processes that plan the execution phase of the project. These are the pieces that enable a physical realization of the building design.

Some essential milestones need to be checked off for the PD&S process. In this embodiment, the system may outline eight milestones. These act as some of the principal outputs-intermediary or final-produced by the models. They may be identified as: Building Design, topology, pour, geometry: Physical Characteristics, Concrete cycle: Generalized/Isolated, Orchestration Chain: Interactive concrete cycle, Pour Internals: Mix/Rebar Sources, Pour requirements: Geometry, topology, mix, formwork, rebar, Pour adjacency & pour dependency, Pour sequence, and Pour schedule.

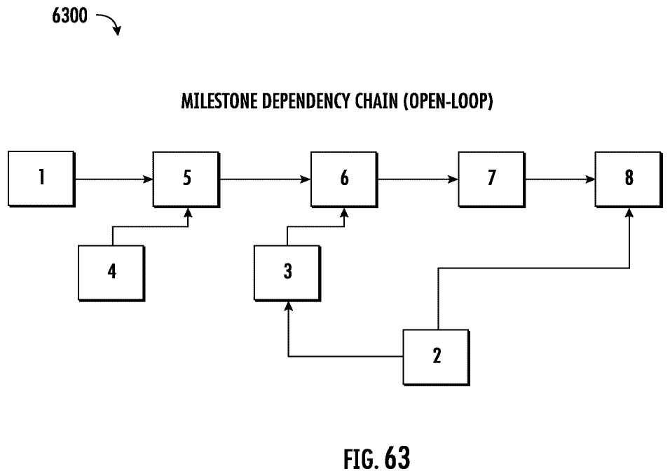

For an essential understanding, these milestones connect together in a principally linear fashion (although there are some interconnections). These are outlined in the milestone dependency chain 6300 of FIG. 63. In general, the methods described herein may be used to reach milestones individually, reach all milestones, or any milestone combination.

The figure indicates how the milestones in the PD&S process connect indicating the associated chain. The building design (1) directly feeds the Pour requirements (5), which is also informed by the Pour internal sources (mix/rebar) (4), and it tabulates the design pour-wise. The Concrete cycle (2) defines the key processes to be executed for a pour and the Orchestration chain (3) uses this information to define the sequence within a pour and identifies how pours impact each other. The orchestration chain (3) and Pour requirements table (5) feeds the Pour dependency table (6) which enables the Pour sequencing (7) to be defined. Combining information from the concrete cycle (2) for each pour which includes times and the sequencing graph (7) together deliver the ability to generate a Pour schedule (8).

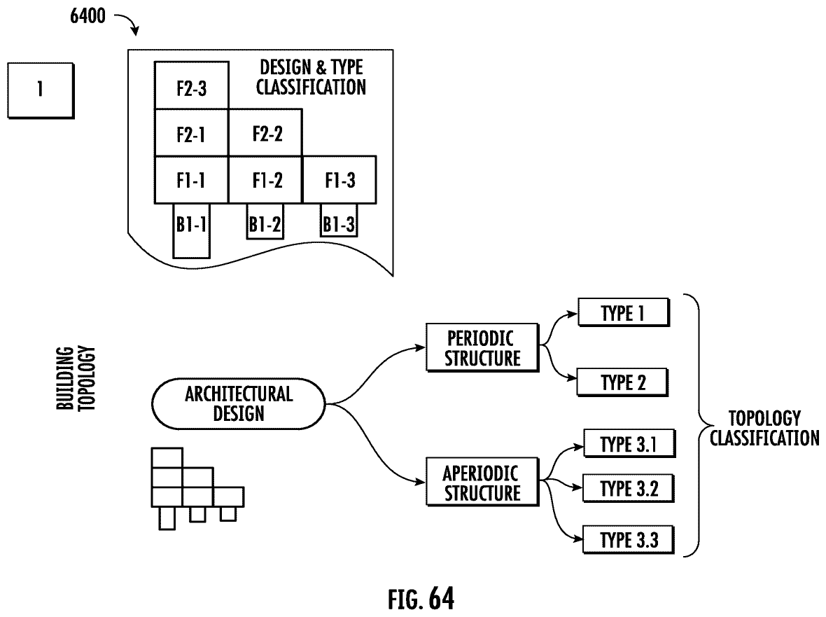

These 8 milestones are manifest through an illustrative example loop portions 6400, 6500, and/or in FIGS. 64-66. Note, in general, a general optimization loop may iteratively loop over the milestones to find the most optimal solution.

### Building Design & Topology

The Building Design & Topology milestone is reached upon determination of the underlying physical shape/geometry of the structure, overall design of the structure and the periodicity of its substructures. The physical shape includes its external shape (low granularity) as well as the shape of its individual pours (high granularity). The periodicity may be extracted from its physical shape, where one period may be defined as a concrete cycle (hence part of a building is periodic, if it may be built by repeating a given concrete cycle). Therefore, this milestone is where Pour Layout/Slicing and Geometry are first determined as building blocks—either trivially as givens, or as building blocks to be generated.

Once the architectural design, or even preliminary, low granularity design of the structure is in place (this may be an input, or may be generated as an output), the system may categorize the structure by topology. One example of a critical structure category may be substructure/superstructure/piling etc. Topological categorization identifies the periodic/aperiodic aspect of structures, and aids the sequencing of the PDS processes. Periodicity in a structure introduces similarity and therefore overlap in construction of structures that can be cast into operations to be parallelized. In this way, concrete cycles across multiple work fronts may be serialized or parallelized, for example depending on the topology and/or geometry of the building, as well as on resource availability and other variables.

These also enable the system to determine how sequencing operations may be carried out. For example in the illustration 6400 of FIG. 64, the design identifies 2 types of periodic structures and 3 sub-types of aperiodic structures. Subsequent consequences are that the concrete cycle of pour construction overlaps between multiple pours and has a consequential impact on sequencing and scheduling.

### The Concrete Cycle

The Concrete Cycle milestone is reached upon determination of the concrete cycle in pseudo-time. The Concrete Cycle may refer to the sequence of core processes involved with an individual pour from start to completion. In this embodiment of the invention, the system may consider a representative concrete cycle and label each of these steps with indices CC1-CC6 (CC1: Formwork Installation, CC2: Rebar Installation, CC3: Pouring of Concrete, CC4: Curing of Concrete, CC5: Removal/Striking of Formwork, and CC6: Pour is Complete (i.e., Concrete has reach target design strength).

It would be clear to one skilled in the art that the techniques and methods described may be applied to any unique concrete cycle which may vary from CC1-CC6 (e.g., in the case of post-tensioned concrete, there is an additional intermediate step between CC4 and CC5—the tensioning of the concrete. In foundations/piles, formwork may not be installed, but holes drilled. In precast concrete, rebar cages may be prefabricated, which would be a step in the cycle, and units may be lifted, which would be another step).

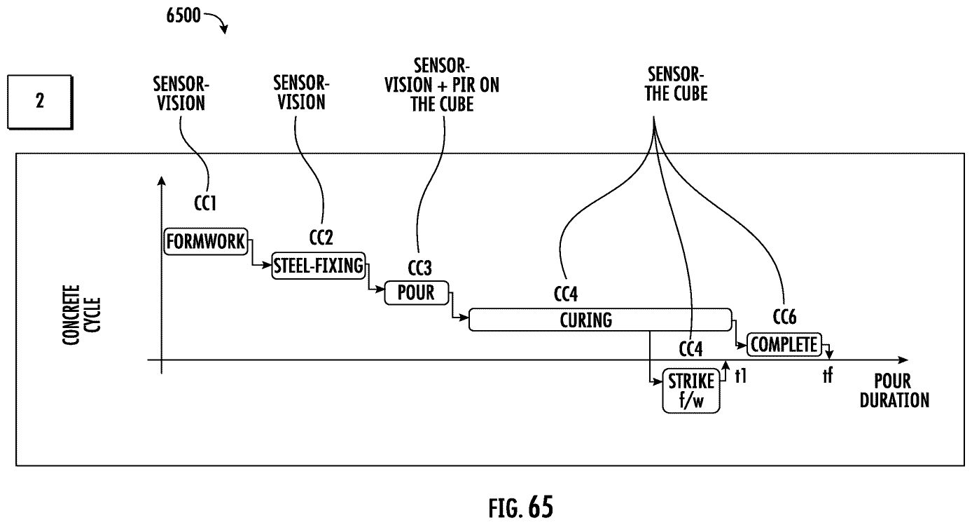

The concrete cycle may in general include steps to be carried out serially or in parallel. The process CC1-CC7 may typically be a serialized process and illustration 6500 of FIG. 65, the cycle steps are framed in pseudo-time with arrows indicating the dependency chain. This is akin to a Gantt chart but in the timescale of start and end of a pour. In this way, in the embodiment illustrated in FIG. 65, the form-work installation step (CC1) must be complete prior to steel-fixing (or rebar installation, CC2). This is followed by the actual pour of the concrete mix (CC3). Once the pour is complete curing commences (CC4) and is often the rate limiting step in this cycle. Once the concrete has achieved the initial recommended strength, to support the self-weight and any imposed loads, the formwork is removed (CC5) for further curing. At time t1, the form-work is available for subsequent use. Finally at time tf, the concrete will have reached its target strength, sufficient to proceed with further aspects in construction.

### The Pour Orchestration Chain

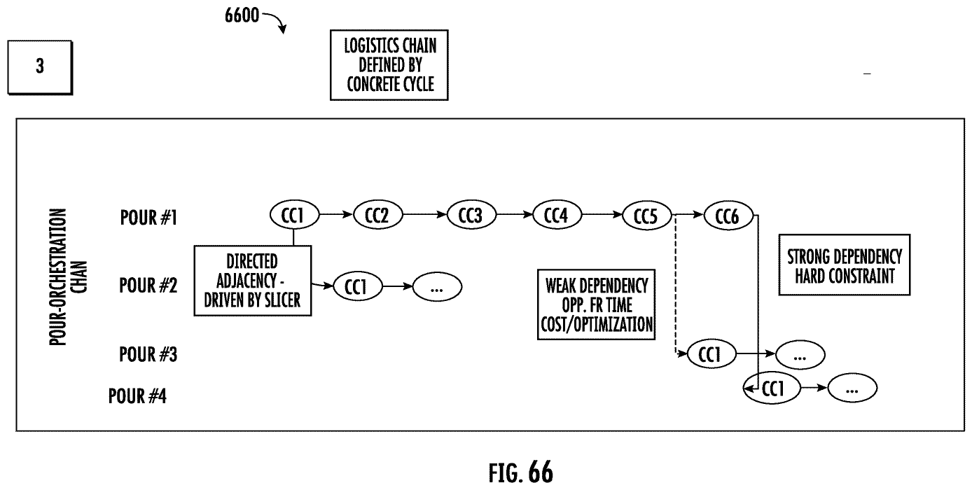

The Pour Orchestration Chain refers to the dependency chain of events that may occur across pours, from one concrete cycle to another. The Pour Orchestration Chain Milestone is reached upon determination of the Pour Orchestration Chain. The Pour Orchestration Chain combines the concrete cycle for each pour to infer the key connections between pours. These key connections indicate the relationship between critical events in a cycle across pours. The illustration 6600 of FIG. 66 shows an example that identifies some of the inter-pour events. Of these, in this embodiment, there are three principal relationships or inter-pour events identified, these are either manifest as a dependency or an adjacency.

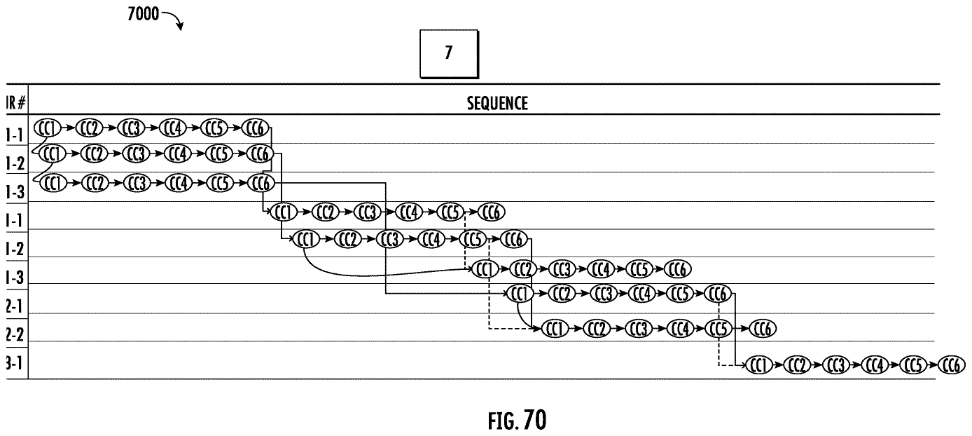

An adjacency event between pours is defined as a physically adjacent pour which will have an impact by sheer proximity (e.g., pile driving, shoring, formwork placement etc.). Dependencies are further drawn out as strong and weak dependencies. Strong dependencies act as hard constraints between pours and identify where the limiting events lie. Weak dependencies are softer dependencies that introduce opportunities for optimization (where cost functions can include time/economic metrics). The orchestration chain aims to extract the essential connections between pours, on the basis of which the pour dependency list can be drawn up illustration 7000 in FIG. 70.

### Pour Internals

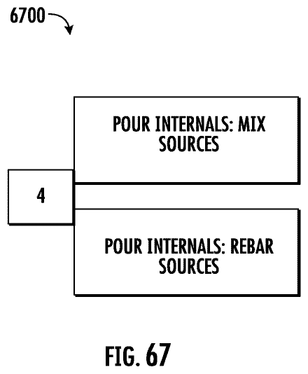

With reference to illustration 6700 of FIG. 67, Pour Internals may refer to the identity and/or configuration of materials which constitute a pour. This typically involves two types of materials which together may form a composite material the Mix (as defined elsewhere) which may be a concrete mix and the Rebar which typically refers to reinforced steel bars placed inside the concrete. Pour Internals may then refer to information about the mix, and information about the rebar including a Rebar Identifier (may be for e.g., compositional properties of the rebar for), Rebar Configuration/Layout within the pour (i.e., the spatial distribution of layout within the pour). The Pour Internals milestone is reached upon determination of the pour internals.

Pour Internals, specifically mix and rebar design sources, consist of various options that may range from a library or a database, or may be subject to a more novel generative solution. Typical constraints that would govern the selection of these sources are based on managing constraints such as those described in the Mix Optimization section of this document. This may include structural, environmental, thermal and/or aesthetic requirements. For example, a conventional implementation would invoke a selection of mix and rebar from a look-up table or catalogue. In addition, the PDS Models may also be able to consider the case where the specification of a mix itself varies since the models vary the design. A novel generative implementation in alignment with the solutions offered herein, would invoke for example solutions developed by the mix optimization sub-section for mix selection. Where on-demand rebar design and manufacture is possible a similar generative approach could be applied in rebar definition and selection.

### Pour Requirements Table

With reference to illustration 6800 of FIG. 68, the Pour Requirements Table aggregates information generated in previous milestones and organized it by element and pour. The milestone is hit once the pour requirements table is determined. Note, this table does not necessarily refer to a tabular format in which to store the data, but rather to the associations between relevant data.

The Pour Requirements Table is the first information aggregation step where details from the Design, Slicer, and Pour internals are organized by element and pour. The principal categorization is by element which is subdivided by the Slicer into one or more The pours are then organized by the corresponding Pour Internals, these are, Mix and (or) Rebar. The Design module also establishes the topological classification (as per 1) which in turn provides directives on form-work requirements. For a finite set of pour configurations the system may expect a finite set of form-work categories, periodic topologies will typically (although not exclusively) involve repetitions of form-work types, which are an opportunity for reuse and hence create a weak dependency that may be exploited in seeking an optimal solution.

### The Pour Adjacency/Dependency List

With reference to illustration 6900 of FIG. 69, the Pour Adjacency/Dependency List refers to the aggregation of associations between pours and their adjacencies and/or dependencies. The milestone refers to the determination of the list. The Pour adjacency/dependency list is the second information aggregating step where the pour details are organized at Milestone 5, in the Pour Requirements Table that combines the rules devised in Milestone (3) with the Pour orchestration chain, as devised for the overall building structure. This Pour adj/dep list forms the crux of the sequencing operations. This is essentially a catalogue of adjacent/dependent pours. For more complex pours it may also contain details about the sub-processes in each concrete cycle associated with a pair of pours. Note an example of the Pour adj/dep ‘list’, is depicted in.

### The Pour Sequence

With reference to illustration 7000 of FIG. 70, Pour Sequence: The ordered chain of events required to occur for all pours to be complete. At low granularity, this is the ordered sequence of pours (order in which all pours on site are poured). At high granularity, this may be the ordered sequence of necessary events for all pours (order of all events required for all pours to be complete). The pour sequence milestone is reached once the pour sequence is determined.

The Pour Sequence uses the catalogued information in Milestone 6 and uses the pour adjacency list and the concrete cycle for each pour to devise the pour sequence as a directed graph. Each step in the concrete cycle of a pour is a node in the graph, a given pour (referenced by Pour ID) will consist of a chain of nodes where the directed edges or connections indicate progress in a single direction from first (CC1) to the last (CC6), working sequentially as a chain of nodes. The Pour adj/dep list then indicates where cross-pour edge will emanate from. This then constitutes the pour sequence. In a prescriptive mode, the information in the Pour adjacency list would be supplemented by sequencing instructions provided by an overseeing body (such as the general contractor). In a generative mode an optimization engine would be deployed to devise the optimal sequence that minimizes a chosen cost function (where the system would aim to minimize typical time, carbon and economic metrics).

Effectively the method solves a constrained optimization problem, strong dependencies introduce hard constraints, weak dependencies are tuned around adjacencies, which in turn deploy guides based on contextual information (such as geology, environment or substructure vs facade). Conditional preferences would be incorporated such as the lag between adjacent pours to be minimized without marginalizing adjacent operations. Figure C.2 Subfig-6 serves as an example of such a sequential construct.

### The Pour Schedule

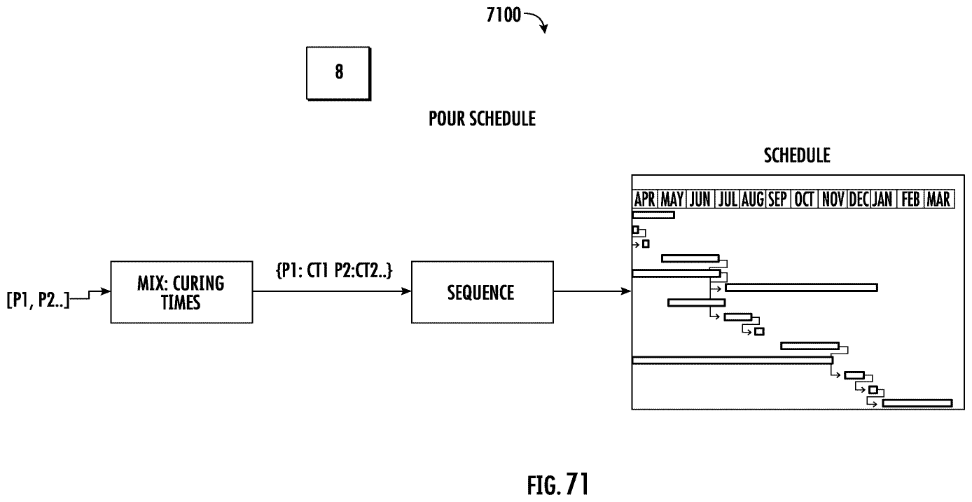

With reference to illustration 7100 of FIG. 71, Pour Schedule may include the ordered, dated, and timed chain of events, required to occur for all pours to be complete. The Pour Schedule is the final milestone in this PD&S process. The schedule essentially combines Pour sequence (7) with the timelines encoded in the concrete cycles for each pour. Thus whereas the sequence is time invariant, the schedule now imposes a timeline and time constraints on all operations. It is worth noting that in the concrete cycle typically the curing time is the rate limiting step, nonetheless every step in the process will be associated with an estimated start and end time. A typical output of this step is for example a Gantt chart indicating when each step in the pour operations will start and end. This step could be a straightforward application of adding time to the Pour sequence, but more likely may involve a level of optimization given various sources of known and even unknown delays and lags. The Schedule may be generated at varying levels of granularity.

### Data-Structures

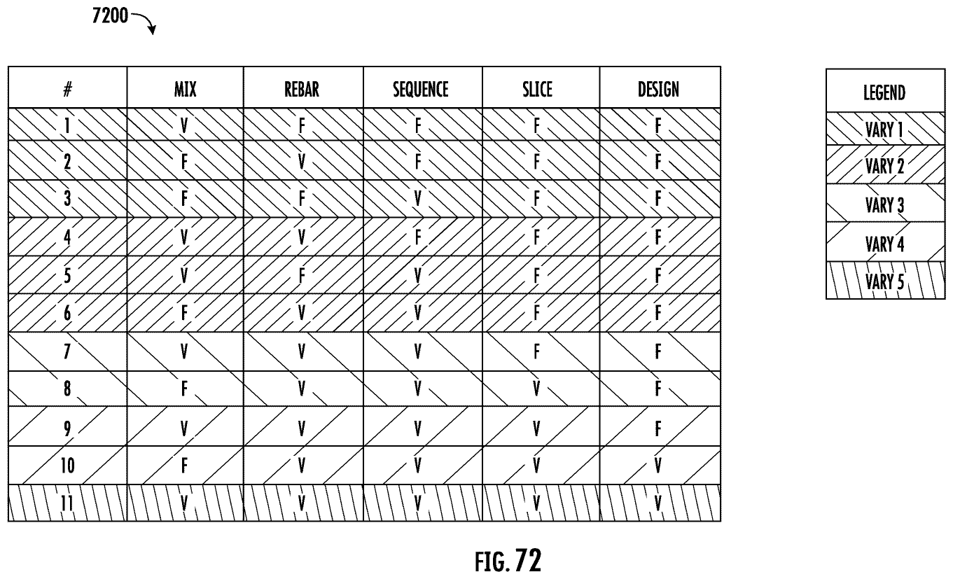

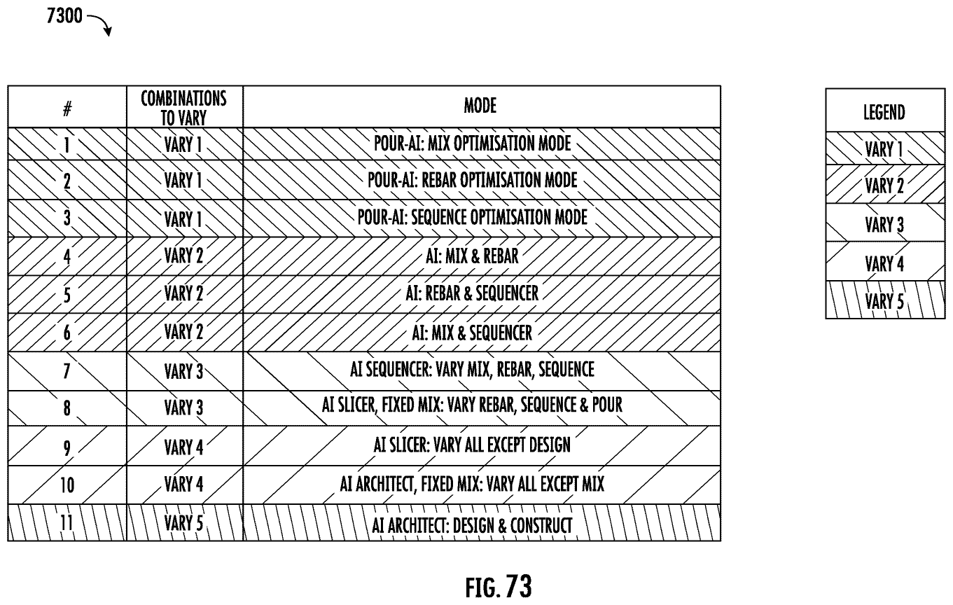

The tables and lists discussed here are a notional construct. Any data structure (such as a method in an object-oriented programming (OOP) framework or tables in a relational database) may be deployed to define the fields and establish the relationship between pours. Furthermore, as shown in tables 7200 and 7300 of FIGS. 72-73, the PDS models described herein may user varying combinations of the modes described herein in various combinations.

Directed Graphs are one data-structure of choice for pour sequence modelling, largely due to the need to enable as much parallelization as possible across sequential processes. These are powerful structures that can be used to design as well as optimize operations. Nodes reflect the property of the entity represented—such as the pour, Node properties or embeddings, encode geometry, rebar, formwork etc. Edges would reflect the connectivity (and can encode interfacial details such as joint type). As an example, graphs operations may allow us to classify overall as well community properties, clustering measures indicate connectivity, centrality measures allow us to understand where bottlenecks arise. As shown in illustration 7600 of FIG. 76, edge properties can be used to investigate shortest paths. Graph level properties can be used to devise graphically equivalent topologies, yielding various combinations which the optimizations methodologies may use to constrain and solve to determine the optimal solution. These span classical graph based methods as well as methods such as graph neural networks and graph transformers.

### Objectives & Optimization

The designs generated by the models may be designed with certain objectives in mind, depending on the use-case and end-goals. The methods herein make use of optimization techniques, including constrained optimization techniques to create designs that maximize the given objectives. A given optimization objective can be configured to maximize or minimize various parameters. Examples of these objectives might include: Minimize net embodied carbon (includes concrete, steel and any other materials used), Maximize speed of construction (or minimize duration of construction), Minimize number of construction joints, Minimize risk of cracks forming, and/or Maximize utilization of labor or equipment utilization.

In practice, a more complex utility function may be configured to balance any combination of parameters. To illustrate, one of the operation modes is used to adjust both the concrete mix design and the rebar reinforcement design, while fixing other parameters. A custom utility function can be specified to adjust the model's behavior. For example, the utility function could be configured to minimize embodied carbon whilst maintaining the risk of cracking below a given threshold.

Portland cement typically contributes the majority of embodied carbon for a given mix. As Portland cement cures, an exothermic reaction occurs, and the concrete's temperature begins to rise. This causes expansion/contraction which can lead to cracks developing. Steel reinforcement is typically the second largest contributor to embodied carbon in a concrete structure. It is used to provide tensile and flexural strength. A proportion of the reinforcement, referred to as thermal-crack-control steel, is present to reduce the risk of cracking due to thermal expansion & contraction. Reducing the Portland cement content in the mix lowers the concrete's heat of hydration. This also enables a reduction in thermal-crack-control steel which further lowers the embodied carbon. Portland cement can be substituted with lower carbon alternatives such as GGBS or PFA.

Principal levers for reducing embodied carbon include reducing the amount of Portland cement in the mix design, and/or increasing the proportion of GGBS &/or PFA in the mix design, and/or reducing the quantity of steel reinforcement required, and/or reducing the volume of concrete used in the building (through varying the geometry/design).

The following sequence represents one embodiment of optimization relevant to Mode 6, for example: candidate mix design generated, embodied carbon of mix calculated, heat of hydration, shrinkage and coefficient of thermal expansion predicted for mix, generate steel reinforcement design, risk of cracks forming in each pour predicted, embodied carbon of reinforcement calculated, evaluate embodied carbon and risk of cracking using custom utility function. This sequence is then repeated multiple times to generate and evaluate new parameters until an optimal solution is selected based on its utility score.

Another optimization example may include time minimization. A number of levers exist to minimize time. These may include: designing a mix with more Portland cement to reduce curing time, designing regular and easily repeatable rebar configurations, designing a pour layout with larger pours where formwork is scarce (if formwork is scarce, it may become a major bottleneck across concrete cycles), designing for larger pours may reduce the total number of pours, and the total number of formworks needed, designing an efficient pour sequence with respect to dependencies and adjacencies, designing efficient spatial geometry and design configurations.

### Structural Properties & Design Considerations

There are a number of structural physical properties that the models will consider and be able to reason about whilst generating their designs. Below is an exploration of some of these considerations. Note, this is a representative list of some considerations which will have to be considered by the models—other design related considerations may in general be considered as well. It is also possible that the models may discover previously unknown considerations through training.

### Forms of Displacement

Displacement to restrained concrete elements can be caused by a number of factors, many of which described herein. In practice, these displacements can occur in any direction, as a result of internal factors (such as thermal expansion/contraction, or various forms of shrinkage) or external factors such as loads applied from adjacent elements or movement of the ground. The consequence of such displacements is a resulting stress in the element (where it is subject to restraint) and often leads to cracking, which if too large may lead to structural issue, the models are able to predict expected displacements and design suitable strategies to mitigate the risk of excessive crack formation. Example strategies the models could employ may include appropriate design of steel reinforcement and joints to either prevent or resist the buildup of stresses exceeding the capacity of the element. Any such design decisions must also balance the speed and practicality of construction.

### Thermal Crack Control Management

As concrete cures, the hydration reaction between cement and water generates heat. Consequently, the element gets warmer. This heat is slowly lost to the element's environment from its exposed surfaces. The resulting temperature differentials cause expansion/contraction and create a thermal strain within the element. If not effectively managed, the thermal strain causes stresses that can lead to cracks forming, particularly if the element is subject to external restraint. The models may predict thermal properties, and evolving spatial thermal distributions for a given structure, which would enable the prediction of temperature rise along with the associated risk of cracking. The factors with the greatest influence on the concrete's exothermicity are the following, which offer optimization parameters for the models: binder type (in particular the proportion of Portland cement in the binder), binder content (kg/m3), concrete's coefficient of thermal expansion influences the degree of expansion/contraction as a result of temperature variations. The tensile strain capacity of concrete indicates the strain limit above which cracking may be expected. This may constitute a physics constraint on the building design the model generates.

Methods the models may recommend reducing the risk of cracking in the designs they output include: lowering the heat of hydration by adjusting the mix, managing the size of individual pours, adjusting the temperature of the environment to reduce temperature difference between the concrete and its surroundings, increasing the amount of thermal-crack-control steel in the reinforcement design, and increase insulation between the concrete and its environment.

### Types of Joints

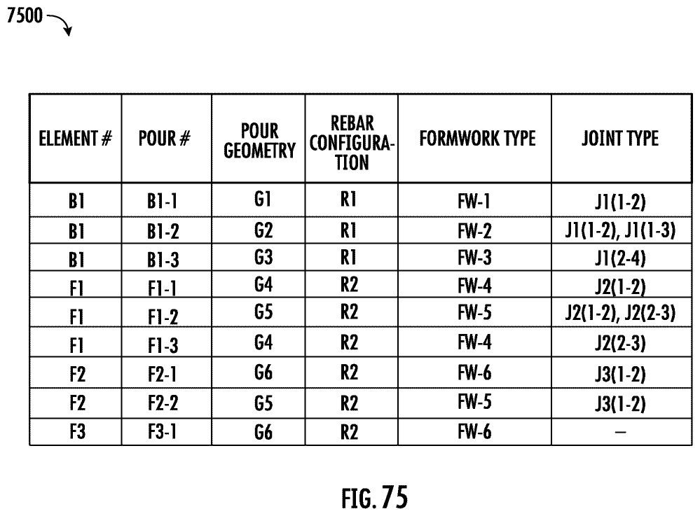

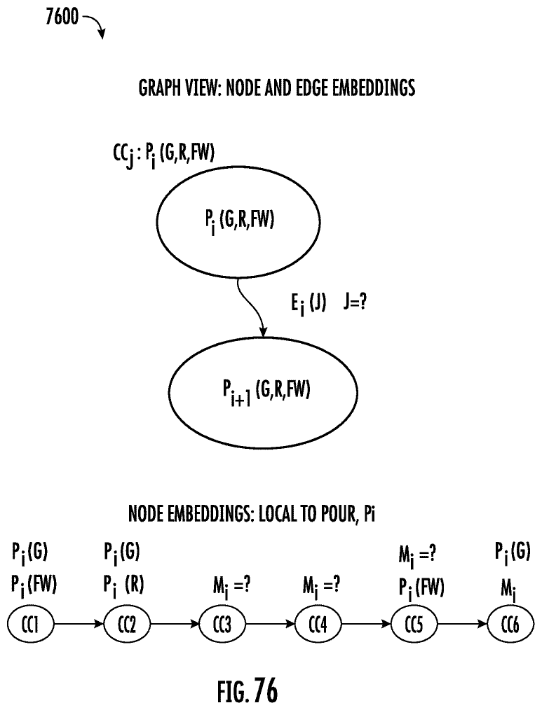

As shown in illustration 7500 of FIG. 75, Joints constitute the interface between construction elements/concrete pours. The interface between adjacent pours represents discontinuities in the overall structure. These discontinuities may cause structural loads, stresses and other types of burden which may cause structural damage to the building. Joints are used to mitigate the effect of these discontinuities/interfaces, the models may include joint designs in their generated outputs. Types of joints outputted by the models may include various types of joints to handle different scenarios which may arise.

For example, construction joints may be used to prevent issues resulting from the concrete's dimensional stability or other displacements to restrained elements as listed above. They may be designed to transfer any required forces between adjoining elements. In some cases, these joints might be necessary due to other factors, such as insufficient time or materials to complete the previous pour (in these cases, these are often referred to as ‘day-joints’), or to prevent the formation of ‘cold-joints’. Cold joints describe a phenomenon which occurs where there is too much time between placement of the previous delivery of concrete and the next, causing the previously concrete to harden as a result. This creates a seam within the pour itself which can lead to structural issues. These are considerations the models will take into account, whilst designing the pours and their sequencing.

Further, movement joints (sometimes called expansion joints) may be used in bridge deck construction (although can be used elsewhere), to accommodate movements between adjacent spans or between spans and the adjoining support structures. These displacements typically result from temperature changes (but these are typically distinct from joints which accommodate thermal expansion/contraction due to the exothermic buildup during construction).

In addition, contraction joints (sometimes referred to as control joints) may often be used in road construction, or cases where large areas of ground bearing slabs are being cast). Rather than preventing cracking altogether, these joints induce cracking in desired locations. This can be achieved by intentionally creating a weak point in the plane transverse to the stress being generated and resulting in cracks forming along this line in response to the stress. An aesthetic preference may be input into the models that stipulates a preference for visible cracks in certain locations of the building. The models may generate multiple design embodiments where contraction joints are predicted to induce constraint compliant, “aesthetic cracks” in key locations, and allow the user to choose the most desirable.

### Locating Joints

Depending on the structural requirements, expected loading and resulting bending moments of a given element, the placement of joints can be essential for structural integrity. In addition, certain requirements & constraints may be stipulated by building codes & relevant standards. In particular, for suspended beams and slabs subjected to high loads, the models may recommend joints to be placed where the bending moment is not too great. Typically, the bending moment of the span approaches zero at ⅓rd the span length. Coupled with aforementioned factors, a suitable location is selected.

### Waterproofing and Water-Retaining Structures

Many substructure designs are required to create a waterproof envelope to prevent ingress of water or moisture into the structure itself. This is particularly important for structures near or underneath the water table, such as deep basements. Equally, some structures such as water tanks, dams & reservoirs are required to be ‘water-retaining’ in order to prevent unintended egress of water. Any construction joints included in the design considerably increase the risk of ingress/egress of water from outside-to-in, or vice versa. As such, the models may apply special consideration in these cases such as the inclusion of membranes, integral waterproofing products and other waterproofing solutions such as waterbar systems to prevent leaks.

### Preparing a Construction Joint

The exposed surface of the hardened concrete is generally prepared so that it is clean, and the aggregates are exposed. This ensures the bond to the newly placed fresh concrete is sufficient. The models may generate a design recommending this be achieved using one or more of several methods including removing the laitance with a power hose or using a mechanical solution such as wire brushing/scabbling. In some cases, a retarder can be applied to the exposed surface which slows down the hydration reaction of the cement and enables the preparation of the joint surface with greater ease.

### Buildings-Considerations by Structural Element

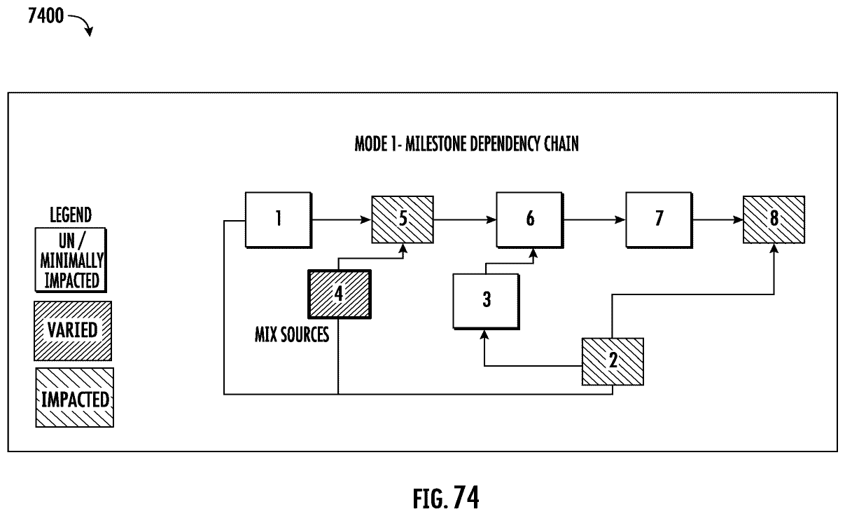

With reference to illustration 7400 of FIG. 74, in Milestone 1 (Building Design) the categorization by element structure type was mentioned: typical large buildings are usually classed as substructure, superstructure and piling. Different considerations will exist for the design of the category.

Typically, foundation/substructure designs should transfer the load of the building (/superstructure) into the ground and have a sufficient safety margin to minimize the risk of structural failure. In this way, the design should have acceptable displacements under the applied loads (accounting for any likely uncertainty) and should be durable for the stated design life.

Substructures will be subjected to internal and external restraint identification, thermal design, strain calculations and crack risk analysis. Some examples of substructure elements, such as the raft foundation, involve casting massive elements of concrete which can generate considerable heat during the curing process. These pours will lose heat to their environment at each surface (even those encased in formwork), where they lose heat to their surroundings leading to temperature differentials arising between the core of the element and its surface. In particular the surface exposed to the air. The system described herein may be able to predict this heat loss and will manage and control the heat of these pours.

At any given location, concrete which exceeds a certain temperature (often around 70° C.-80° C.) can suffer from quality issues such as delayed ettringite formation (DEF) which can lead to cracking and displacement. The exact temperature this occurs at can depend on the concrete (particularly its chemistry). This is generally controlled for by careful selection of the mix and limiting the size of individual pours to ensure the absolute temperature at any given location does not become too great.

If the difference in temperature between the surface of the concrete and its center becomes too great (often around 20° C.-30° C.), this causes more expansion at the center than at the surface. In turn this can lead to cracking. Again, this can be controlled for by the models through careful selection of the mix and limiting the size of individual pours to ensure the difference between the maximum temperature generated in the pour and the environmental temperatures is not too great. Further mitigations could include the use of additional insulation, controlling the temperature of the environment by adding heat, or by cooling the element itself (for example by designing in custom circulation systems to pump cool water through the element). Since steel is more conductive than concrete, the dissipation of heat through steel reinforcement can also be considered.

Certain substructure elements have a requirement to be water tight to prevent ingress or egress of water. For example, in basement constructions underneath the water table, or when constructing water retaining structures such as tanks. Additional consideration must be paid to the number, and placement, of joints in these cases since each joint poses additional risk for movement of water. Furthermore, even if membranes are adopted, the acceptable crack widths for concrete in water retaining structures is generally much lower (0.2 mm or 0.3 mm) which must be taken into account during the selection of mixes, determination of the maximum pour size, and reinforcement design.

A further risk can occur when the formwork for a fresh concrete pour (particularly walls) is removed while the air temperature is low, and the concrete is still warm. If the difference between the air temperature and newly exposed concrete is too great it can lead to a phenomenon known as thermal shock, which causes cracking as the concrete at the exposed surface rapidly cools and shrinks. Other considerations include dimensional stability of the concrete (e.g., various forms of shrinkage, creep, thermal expansion/contraction), the dimensions and aspect ratios of the overall pour, the potential for relative shrinkage at joints between pours, due to differences in the age of the concrete in each element, or in cases where the mix is not the same across each element, relative shrinkage attributable to that difference in mix and its curing rate. Differential shortening between vertical elements (e.g., columns and core walls) also need consideration (otherwise differential shortening could lead to slab deflections, which may exceed allowable tolerances, leading to the need for rework). Axial shortening in high-rises is for example an important consideration.

The initial pour layout design of superstructures entails showing how each element should be laid out, however they may need to be subdivided into discrete pours (by adding in construction joints). The considerations for subdividing pours are in some respects similar to the substructure case (internal and external restraint identification, thermal design, strain calculations and crack risk analysis). In practice, these will be the main factors influencing the maximum pour size, although the contractor may be constrained by other factors such as availability of materials, formwork or labor, resulting in placing additional construction joints, which may be accounted for by the models.

In superstructures, most vertical elements such as columns or walls are poured to the height of the floor and do not require any subdividing on their vertical axis. In some cases, wall pours may need to be divided along their length to ensure they fall within certain aspect ratio limits or length limits (this should factor in the restraint of the wall, expected shrinkage and reinforcement present). In rare cases, elements such as cores are not always cast to the height of a single floor. When employing construction methods such as jump-form construction, this requires complex (and often custom) climbing formwork systems, and the height of each pour may be determined by other factors.

Design of deep pile foundations entails providing the following to support the superstructure load without excessive settlement and bearing capacity failure. There are four main pile types: Driven Piles, Bored Piles (CFA Piles, Rotary Bored Piles), Driven and cast in-situ Piles, and Aggregate Piles. Further, the pile size, pile depth, pile number, and pile layout/distribution should also be considered. The structural design to support the superstructure and definition of the load bearing members in order to define the load paths.

Piling design (i.e., selection of the above) typically includes undertaking a Site Investigation (SI) combined with a Ground Investigation (GI) prior to beginning the construction process. Though this is strictly a pre-pour step, it is included as part of the pour design process for the piling elements. The GI should take into account appropriate geotechnical and geo-environmental fieldwork & laboratory testing. It is helpful to understand the ground conditions and perform these ground surveys/investigations to establish the condition of the ground at different depths. This heavily influences the pile design and the construction methodology. There are several methodologies for installing piles, with numerous considerations (such as the availability of piling rigs; maximum depth and diameter of piles; etc.). These include rotary bored piles and CFA (continuous flight auger) piles which each have numerous merits and limitations in terms of productivity and efficiency.

When tunnels and shafts it is often necessary to consider additional factors such construction access constraints, and procurement of complex custom equipment. When pouring fresh concrete, the length of individual pours tends to be subject to the same considerations and constraints listed previously. Additionally, the concrete can have additional requirements such as the ability to pump it considerable distances under high pressures.

Highway construction and bridge construction are subject to similar considerations as tunnels and shafts, such as access constraints and bespoke formwork systems. The introduction of movement joints is common in this type of construction, since larger displacements are expected in operation of the road or bridge (as well as during construction).

A number of specific examples are given below, each providing a high-level overview of the relevant parameters and the parameters taken into account by the loss function which might be applied. Note these are representative and not exhaustive.

The substructure design may include a loss function (e.g., design and risk considerations) which may be a function of restraint identification, thermal design, strain calculations, and crack risk analysis. Further, tunable parameters may include Concrete Mix, Rebar content, Weather conditions, geometry and/or design and/or Thickness, Restraint and/or Construction Joint.

With regard to piling design, the loss function includes design and risk considerations, which may be a function of Geotechnical Ground Investigation results, and load bearing structural requirements. Tunable parameters include risk factors (Building Settlement Within Margin, Load Path/Bearing Member Margins), Optimization Variables (Number of piles, Pile type, and Pile size, depth), and constraints (e.g., cost, rig availability, max depth, min/max pile diameter) and piling installation methods, such as rotary bore piles, CFA piles.

For superstructure design, the loss function includes design and risk considerations, which may be a function of Internal and External Restraint Identification, Thermal Design, Strain Calculations, and Crack Risk Analysis, Dimensional Stability of the Concrete, Geometry/Dimensions and Aspect Ratios of the Overall Pour, Weather Conditions. Tunable parameters include Concrete Mix, Rebar content, pour layout, pour sequence, geometry and/or design and/or Thickness, Restraint and/or Construction Joint.

### Precast Considerations

This system 100 could also be used to create a pour sequence at the precast factory. The logic, and models used will be mostly similar. Some details regarding variables, inputs and outputs may be specific to precast. The information below captures some of those differences.

The parameters affecting efficient manufacture of precast concrete elements are similar to those relevant when casting in-situ units on a construction site. In particular the overall productivity of the precast factory is dependent on the concrete mix, strength requirements to release the mold (formwork), availability of molds, availability of labor, complexity of reinforcement cage and time to assemble and temperature of the environment as the concrete cures, as well as the geometry & dimensions of the elements.

In many cases, the precast manufacturer will mix their own concrete at the factory, and therefore the availability of raw materials is another factor. Another consideration specific to the precast factory is the availability of space in factory and laydown yard (where units are stored after they are cast, and until they are delivered to the customer's site). Managing available space can be complex since they may be manufacturing units for different projects concurrently, and units have a variety of shapes and sizes. The manufacturer is generally provided a schedule containing contractual requirements and deadlines for the delivery of the finished products as the supply contract is agreed. This model also considers space availability and delivery schedule as a constraint, and management of storage space as an output.

Precast factories will often have steam curing chambers, or other methods of heating the environment to maintain a desirable temperature. The model outputs an optimal curing profile and this data is used for the actuation of the target temperature and relative humidity within the factory or curing chamber (or other related environmental parameters that can be controlled).

The embodied carbon attributable to heating or cooling an element (or otherwise controlling some environmental parameter) will have to be evaluated against the embodied carbon of a mix. Depending on the energy source of the factory, and the embodied carbon of the binder, it may be the case for example, that it is actually more carbon efficient to use a higher cement content in a mix and lower amounts of heating (and vice versa).

One important difference worth noting between the in-situ pour and precast unit cases includes typically in pour layout design (assuming geometry and design are fixed), the thickness of a slab is kept constant. But for the most part, pour design reduces to a 2D problem with fixed slab width. For precast, unit design turns into the ‘slicing’ of a 3D structure into smaller 3D elements, and so there are additional degrees of freedom to consider in how a structure is subdivided.

Relevant Sensor Input data in the precast case will include (in addition to all the sensors mentioned in the in-situ case), location tracking technology such as Bluetooth beacons and cellular gateways, or RFID, or GPS to track the location of a unit from its production, to transit to its delivery, lift by the crane and installation on the structure, and other techniques described in the logistics section.

The following may delineate the analogous aspects between in-situ and precast equipment conditions: units in the precast world would replace pours, precast molds may replace formwork used on site, these will impact restraint considerations during design, recast mix optimization may be subjected to similar strength and carbon cost considerations, whereas concurrent production schedules would constrain the numbers of mixes based on similar criterion that make up the Ensemble Mix Utility cost. For precast schedule planning, the production schedule, laydown yard capacity, the outbound schedule to enable seamless flow of units would replace building design, adjacency and structural criterion that will feed the on-site precast scheduling engine.

### The Core Modes

Note, eleven modes/embodiments of the present disclosure are described herein. These eleven modes represent different modes of the invention which output different combinations of building block outputs. In general, the invention may be used in any other embodiment which generates any individual output type listed herein, and any combination of these outputs, as well as other outputs clear to one skilled in the art to qualify as an output to building design & sequencing. Note, in the latter modes, the input information the models are given to generate their designs may become less granular. In this case, methods and techniques outlined in data linkage and/or other sections of this document may be used to increase the granularity of the data, including using generative model techniques to generate missing data.

### The Mix Designer

With referent to illustration 7400 of FIG. 74, Mode 1 fixes 4 of the 5 parameters that form the basis set that defines the Pour design and sequencing configuration. The variable parameter under consideration is the mix design. In this mode, the method may generate and/or select the most optimal mix design for every single pour. The other four parameters (Pour design & geometry, layout, rebar and sequence) are prescribed a priori.

Mix Designer establishes Block 4 as the milestone that includes a key variable. The dependency loop shows that this will principally have an impact on Block 2 (concrete cycle), specifically the curing step CC4 with respect to the time for curing, and Block 5 (Pour Reqts List) where the entries in the Pour internal column refer to the mix type. Additionally Block 8 (Pour Schedule) is impacted by the curing time and mix type. The essentials encoded in the other blocks will remain principally unimpacted by this variable.

The Key Inputs in every mode will be the constant building blocks. The following may be included as Mode-1 Inputs. Building Block Inputs for Mode-1: Rebar Design for every pour, Pour Sequence, Pour Layout, and Geometry and/or Design. Other inputs may include any of the input types listed above and/or any data types listed in any part of this document, including for example: Mode Identifier, Initial Structure Design/Prior knowledge regarding the structure to be built, Building Blocks Priors, Constraints Priors, Supply Chain and Resource Availability Data and Requirements, Adjacency and Dependency Priors Data, Contextual Conditions, Optimization Objectives.

In some embodiments, other inputs may include any other data type and/or requirement on data types listed in any section of this document, gathered from any data source. The system may expect a complete BIM model (or equivalent) as an important data source from which design data and other data types may be gathered. Sensors installed for each block in the concrete cycle may serve as the principal inputs for further design iterations. Furthermore, the four fixed parameters from the PD&S basis set serve as important inputs in this mode of the invention. The building geometry includes details that serve as inputs to Milestone/Block 1 (Building topology), the concrete cycle as a construct is relatively independent of choice of mix selection. However, the durations of each step in the cycle will be affected by the choice of mix and geometry. The slicer prescribed pours serve as inputs to the orchestration-chain (Block 3). The pour sequence will be prescribed which will completely define Block 7. Finally, the geometry will also dictate formwork size and/or type and rebar configuration (all of which is prescribed) and feed the Pour Requirement Table (Block 5). This is outlined in (Figure C.M1.1).

In some embodiments, the key outputs include building block outputs (in Mode-1, this includes Mix Design). In some embodiments, other outputs may include milestone outputs, ancillary outputs, and documentation outputs. The variable building blocks become the key output for each mode, therefore for Mode 1 the system may should expect as output the optimal list of mixes for each pour/element (i.e., mix design). Since every parameter will impact the schedule, an additional output is the Pour schedule. Other outputs may include other milestone outputs, ancillary outputs and documentation outputs.

With reference to illustration 7500 of FIG. 75, the method has a prior organization step where the system may build the Mix Designer Mode-1 Table, where the system may categorize by element, pour, geometry and/or design type, rebar type, formwork type and Joint type. The geometry and/or design type may involve common categories shared across pours, this has a direct impact on the formwork. Rebar will be prescribed as well as per this mode. The key detail that needs to be determined is the joint type. In the table illustrated below as an example the system may outline these as three joint types. Joints connect adjacent pours and therefore the adjacency is critical to this aspect.

A note on construction of the constituents of the graph data-structure: the node and edge embeddings use the information listed in the illustration 7500 and update the node embeddings, specifically related to geometry (G), rebar (R) and formwork (FW) for a pour (Pᵢ)—the mix for that pour (Mᵢ) being the parameter to be determined. The edge embeddings related to adjacent pours encode interfacial details, specifically the joint type (J). This joint encoding is dependent on not just the structural considerations (building geometry) but also on mix type. For example in (Fig C.M1.3) shows an illustration of a pair of adjacent nodes CCᵢ:(Pⱼ,Pⱼ₊₁) with edge (Eⱼ) encoding the adjacency details that represent the relationship between adjacent pours and how they manifest topologically in the graph structure.

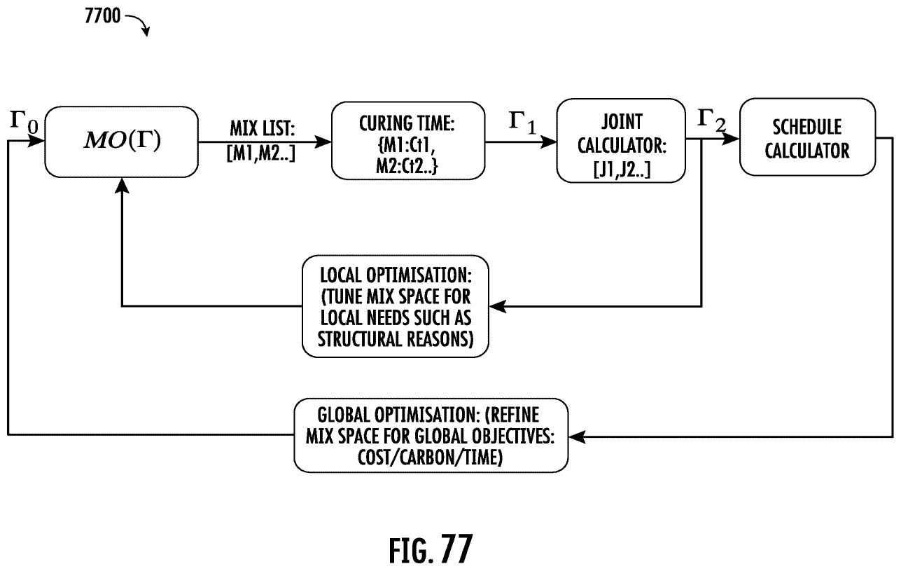

With reference to illustration 7700 of FIG. 77, the following steps allow us to build the Mode-1 Mix Designer Solver (Figure C.M1.4). step 1 includes using known information to construct an initial Graph (To) with known node and edge embeddings. This graph is defined by the following: construct for each pour: the orchestration chain that defines the steps (nodes) and in a specific operational order (sequence, directed edge), link chains for all pairs via adjacencies/dependencies, the principal unknowns to be solve for by this method: are the (i) Mix type (Mᵢ) which is associated to a single pour (node), and (ii) joint type (Jᵢ) which is associated to an adjacent pour (undirected edge).

In step 2, the Mix Optimizer (MO module, as described in Mix Optimization) is used as a black box that ingests a graph (Γ) served as an input, the graph's node embeddings, containing known parameters (essentially providing for state and contextual information the MO requires) and with the unknowns to be determined, specifically a list of mixes for each pour.

In step 3 the output of the MO module is the list of mixes for each pour (Mᵢ), from which the curing time map is produced (by look-uptable/determined/estimated/predicted). The mix details populate the pour requirements table and the graph: specifically the CC_4(Pⱼ) node for each pour (Pⱼ). Thus evolving the graph to new state Γ₁ with new input indicating the mix type and curing times.

In step 4 Graph Γ₁ is an input to the Joint determiner, which infers joint types based on adjacent mixes, and computed shrinkage. This also potentially serves up information that will inform ancillary methods (such as insulation blankets depending upon weather conditions, curing durations, curing start times etc.). The joint determiner updates the edge embeddings in the graph, providing a further evolution Γ₂.

In step 5, since the sequence has been provided a priori as input, therefore, Gamma_2 becomes the starting point to estimate the schedule. This is a straightforward application of the method outlined in Block/Milestone 8 for the Pour scheduler.

In some embodiments, there are two further steps pertaining to optimizations: step 6 includes the local or inner-optimization loop tunes the mix space to improve local cost function (e.g., structural reasons such as joint types). Step 7 includes the global or outer-optimization loop seeks optimal in the utility function space. The utility functions defined elsewhere typically encode global targets such as time and carbon, and/or any other targets described in any other section herein e.g., as described in Mix Optimization.

### The Optimized Rebar Designer

Mode 2 (not shown) fixes 4 of the 5 parameters that form the basis set that defines the Pour design and sequencing configuration. The variable parameter under consideration is the rebar design parameter. In essence, in this mode, the method may generate and/or select the most optimal rebar design for every single pour. The other four parameters (Pour design & geometry, layout, mix design and sequence) are prescribed a priori.

The Key Inputs in every mode will be the constant building blocks. Mode-2 Inputs may include Building Block Inputs for Mode-2 (e.g., Mix Design for every pour, Pour Sequence, Pour Layout, Geometry and/or Design) and other inputs may include any of the input types listed above and/or any data types listed in any part of this document. For example, a Mode Identifier, Initial Structure Design/Prior knowledge regarding the structure to be built, Building Blocks Priors, Constraints Priors, Supply Chain and Resource Availability Data and Requirements, Adjacency and Dependency Priors Data, Contextual Conditions, and Optimization Objectives. In some embodiments, other inputs may include any other data type and/or requirement on data types listed in any section of this document, gathered from any data source.

The key outputs for Mode-2 include building block outputs (e.g., rebar design). Further, other outputs may include milestone outputs, ancillary outputs, and documentation outputs. The variable building blocks become the key output for each mode. The key output for Mode-2 should therefore be the rebar design for every pour. The Schedule and Concrete cycle may also be outputs. Other outputs may include other milestone outputs, ancillary outputs and documentation outputs.

The techniques and methods for enabling Mode 2 reduce from Mode 8, and may be described as the methods in Mode 8, wherein the mix design, pour sequence, and pour layout are known a priori/constant. Similarly, this may reduce from Mode 11. Alternatively, this may be seen as naturally adjacent to Mode 2. The main change here will be that the material design under consideration will be rebar design rather than mix designs. The same heuristic logics and flows may be used in Mode 2 as in Mode 1, whilst shifting the considerations to rebar centric considerations e.g., considering tensile strength, thermal rebar, rebar fixing during concrete cycle and other rebar considerations.

### The Optimized Pour Sequence Designer

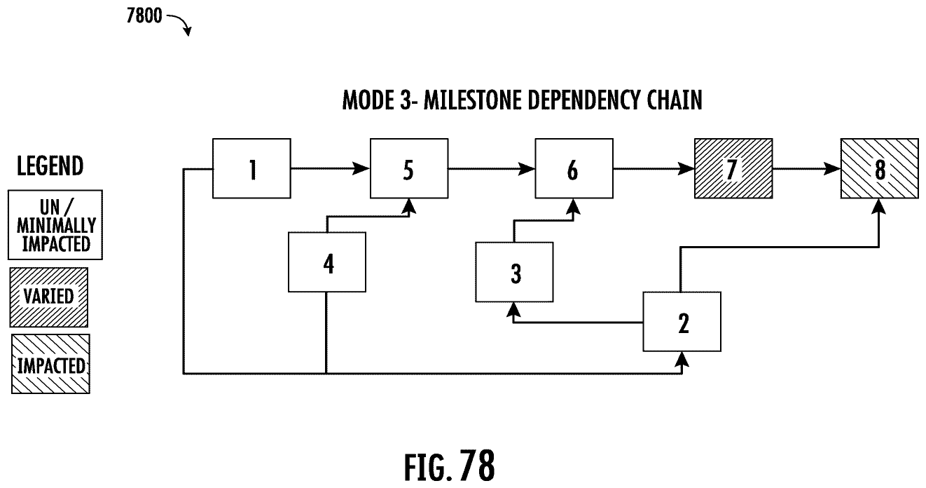

With reference to illustration 7800 of FIG. 78, Mode 3 fixes 4 of the 5 parameters that form the basis set that defines the Pour design and sequencing configuration. The variable parameter under consideration is the sequence parameter. The four parameters that are fixed are the geometry and/or design, layout, mix and rebar, which are prescribed a priori. In this mode, the method will generate and/or select the most optimal pour sequence.

The Key Inputs in every mode will be the constant building blocks. Mode-2 Inputs may include Building Block Inputs for Mode-3 (e.g., Mix Design for every pour, Pour Sequence, Pour Layout, geometry and/or design), and other inputs may include any of the input types listed above and/or any data types listed in any part of this document. For example, this may include a Mode Identifier, Initial Structure Design/Prior knowledge regarding the structure to be built, Building Blocks Priors, Constraints Priors, Supply Chain and Resource Availability Data and Requirements, Adjacency and Dependency Priors Data, Contextual Conditions, Optimization Objectives. In some embodiments, other inputs may include any other data type and/or requirement on data types listed in any section of this document, gathered from any data source.

One specific key input to this model may be the Pour adj/dep list (Block 6). The BIM model may be another key source of data from which inputs may be derived (including adjacencies for example). The four fixed parameters from the PD&S basis set will act as specific inputs: these include the building geometry (Milestone/Block 1, Building topology), the mix and rebar types which will populate the Pour requirements table (Block 5). The slicer will define the pour and mix type will specify the durations of each step in a concrete cycle (Block 2) and the essential relationships in the Pour orchestration-chain (Block 3). The geometry will define the formwork type which is an entry in the Pour Requirements Table (Block 5). The slicer will then encode the adjacencies and strong and weak dependencies that populate the Pour adj/dep list (Block 6) that will then be fed into the Pour Sequence generator. This Mode 3 milestone dependency chain is outlined in Figure C.M3.1.

The Key Outputs are Building Block Outputs. In Mode-3, this includes Pour Sequence. Other outputs may include Milestone Outputs, Ancillary Outputs, and Documentation Outputs. The variable parameter(s) become the key output for each mode, therefore for Mode 3 the system should expect as output the optimal sequence of pours and the Pour schedule as well. Other outputs include other ancillary outputs, milestone outputs and/or documentation outputs.

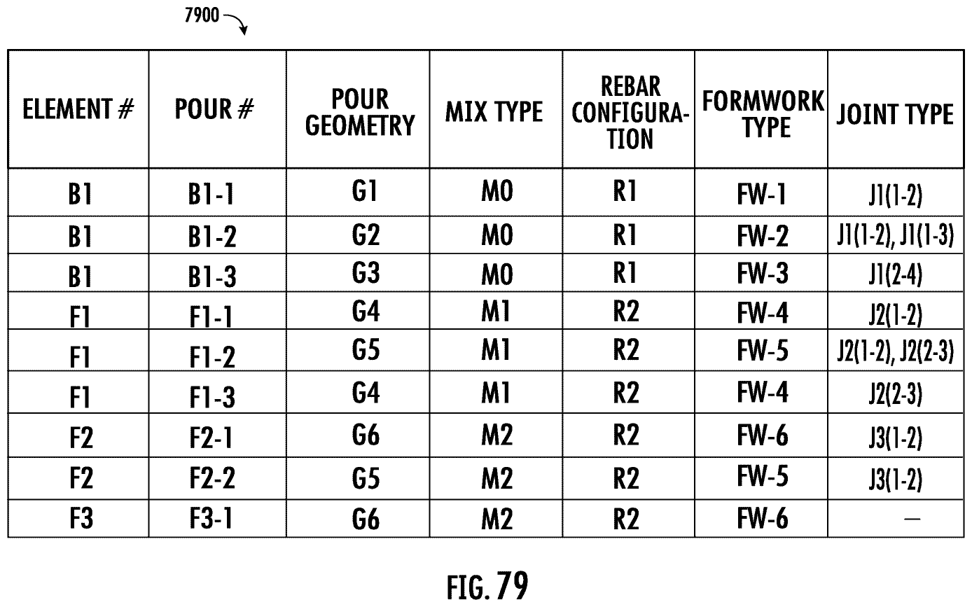

With reference to FIG. 79, the method has a prior organization step where the system may build the Pour Sequencer Mode-3 Table 7900, where the system may categorize by element, pour and specifically the geometry and/or design type, mix type, rebar type, formwork type and joint type. The Mode-3 table is similar to the Modes 1 and 2 tables, with an extra column for Mix *and* rebar as both of these are now known a priori.

The problem then boils down to generating a sequence of pours with an optimal combination of serialization and parallelization that meets the optimization criterion prescribed, (essentially encoding time/economics/carbon tradeoffs) as well as other constraints and solving the sequencing problem by managing cross-pour dependencies. The essential construction retains the intra-pour concrete cycles (represented as Block2) for each pour with the sequencing of pours managed by retaining strong (cross-pour) dependencies as constraints, and weak (also cross-pour) dependencies as elastic edges that can be leveraged for adjustment, serialization and/or parallelization. For example, in the most naive graph, a serialization of pours akin to a long-chain dependency graph can be defined, representing a system where economic resources are scarce and time is abundant. In a maximally parallelized case where time is scarce and resources are abundant the only constraints may be of a physico-chemical nature (e.g., a physical constraint, gravity points downwards, a chemical constraint: concrete cures in finite time) the system may see many pours being initiated and managed in parallel. In a real world where the system may aim to minimize time, economic costs and carbon in a weighted manner, an appropriate compromise would be struck.

This problem may be solved as a generate and search technique that consists of searching the sequence space from all candidate combinations and selecting the best. In terms of solution finding, the approach of trying all permutations may be solved in parallel (efficient algorithm). Each permutation can be tested in parallel, and the models may generate all permutations in parallel. However as an NP hard problem (N possible parallel sequences have N! possible combinations). For small problems, NP hardness is tractable, however this approach does not scale well with size and blows up very quickly as N increases.

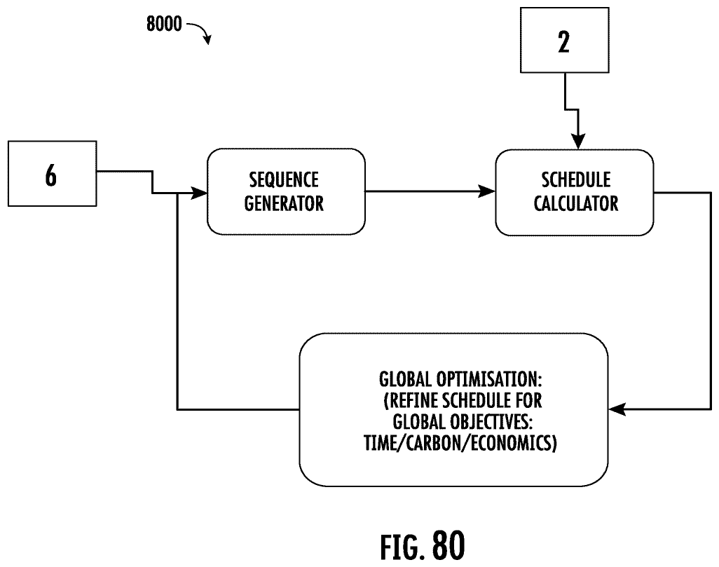

With reference to illustration 8000 of FIG. 80, graph reduction techniques may be used. In this case a modification of the Asymmetric Travelling Salesman Problem (ATSP) where the need is to find the shortest path from a starting node in a weighted directed graph, by visiting all nodes exactly once until the final node. Induction techniques such as greedy (locally optimal solutions) or divide and conquer (where independent subgraphs are solved) algorithms are typical approaches to consider.

These problems may also be solved using more novel techniques in neural networks, specifically graph neural networks (GNN) that are especially well served and introduce permutation invariance that caters to the critical property of topological equivalence in graphs. A GNN is composed of successive layers, where each layer represents a node as an aggregation of the representations of its neighbors and itself from the previous layer, encoding message passing, and including an activation to add nonlinearity. Graph attention networks are specifically appropriate for aggregation in this application where like transformers the GNN ‘learns’ to weigh the different neighbors based on their importance, noting that over-smoothing as the number of layers increase may be avoided by adding skip-connections or non-message passing layers.

These sequence generators encode the local optimization targets prescribed (duly constrained) thereby generating a graph I′, which is then fed into the schedule determiner (Block 8) along with the concrete cycle times for each pour (Block 2) to generator a complete schedule. The output schedule may then be evaluated and subject to a global optimization loop. The global optimization engine would aim to devise the optimal sequence that minimizes a chosen cost function.

Other techniques that may be considered are based on tools developed for pattern or sequence identification, that are well handled by Deep learning techniques such as LSTM (Long short-term memory). A drawback is the amount of prior labelled data required for such models to function well. The generative model approach aims to identify features that distinguish patterns and reduce the burden on prior labels and develop a loss function to represent the structure. Recently, reinforcement learning (RL) techniques have been developed to address this aspect. RL techniques use prior labels, to identify the underlying policies associated with a class of designs and calculate the corresponding reward. RL models are associated with states (all possible sequences), actions (manifestation of the state), state transitions (maps states and actions to outcome states) and reward (0 for no action, maps to cost function for each action). The aim of the RL is to find the sequence that maximizes the reward.

### The Optimized Mix & Pour Sequence Designer

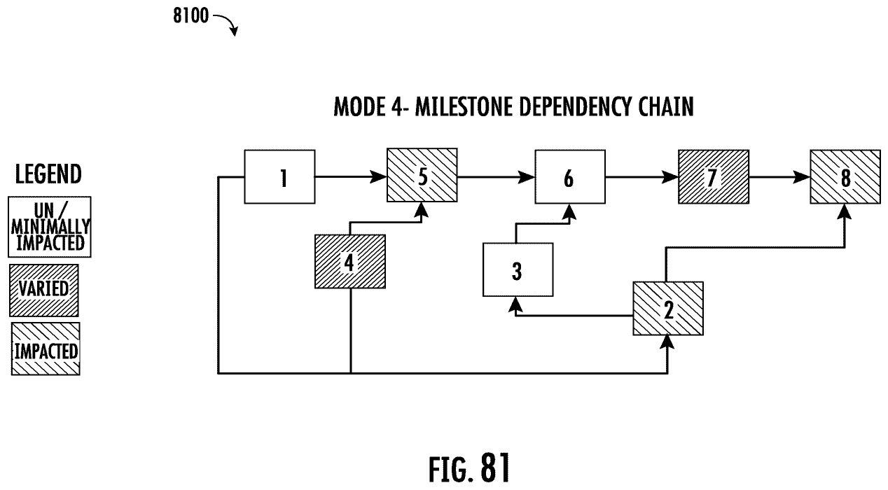

With reference to illustration 8100 of FIG. 81, Mode 4 fixes 3 of the 5 parameters that form the basis set that defines the Pour design and sequencing configuration. The variable parameters under consideration are the mix design and the pour sequence parameters. The three fixed parameters are the geometry and/or design, layout and rebar, which are prescribed a priori. In this mode, the method will generate and/or select the optimal mix design for every single pour, as well as the pour sequence.

The Key Inputs in every mode will be the constant building blocks. Mode-2 Inputs may include Building Block Inputs for Mode-4 (e.g., Rebar Design for every pour, Pour Layout, Geometry and/or Design), and other inputs may include any of the input types listed above and/or any data types listed in any part of this document. For example, this may include Mode Identifier, Initial Structure Design/Prior knowledge regarding the structure to be built, Building Blocks Priors, Constraints Priors, Supply Chain and Resource Availability Data and Requirements, Adjacency and Dependency Priors Data, Contextual Conditions, Optimization Objectives. In some embodiments, other inputs may include any other data type and/or requirement on data types listed in any section of this document, gathered from any data source.

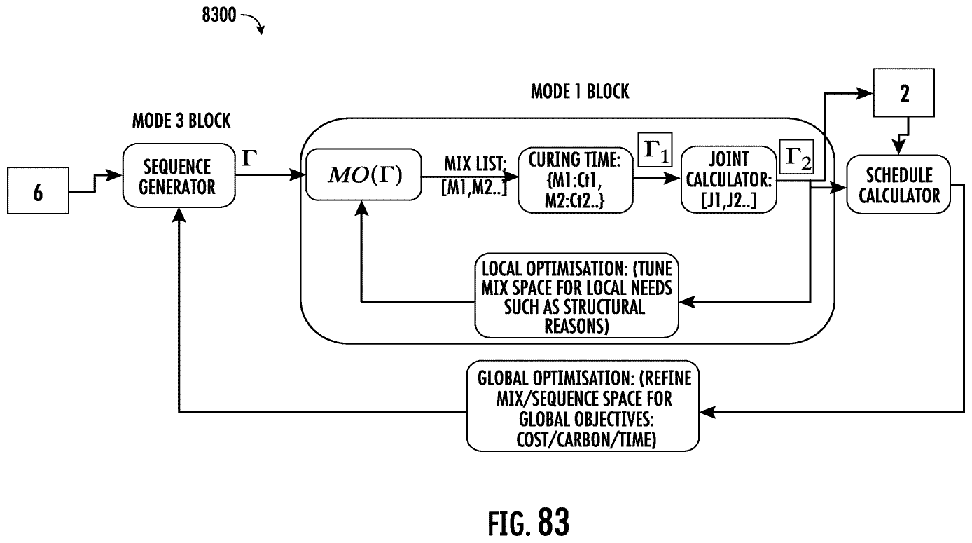

A key input to this model may be the Pour adj/dep list (Block 6). The BIM model may be another key source of data from which inputs may be derived (including adjacencies for example). The three fixed parameters from the PD&S basis set will act as specific inputs: these include the building geometry (Milestone/Block 1, Building topology), the rebar types will populate the Pour requirements table (Block 5). Akin to Mode 3 the slicer defines the pour and geometry and/or design, the formwork type and all entries in Pour Requirements Table (Block 5), and adjacencies and dependencies in the Pour adj/dep list (Block 6). The known information is fed into the Optimized Mix & Pour Sequence Designer 8300 of FIG. 83. This Mode 4 milestone dependency chain is outlined in Figure C.M4.1.

The Key Outputs are Building Block Outputs. In Mode-4, this may include Mix Design and Pour Sequence. Other outputs may include Milestone Outputs, Ancillary Outputs, and Documentation Outputs. The variable parameter(s)/building blocks are the key output for each mode. These include the mix design and pour sequence. From the optimal sequence of pours the Pour Schedule may be defined as well. Other outputs may include other Milestone Outputs, Ancillary Outputs, Documentation Outputs.

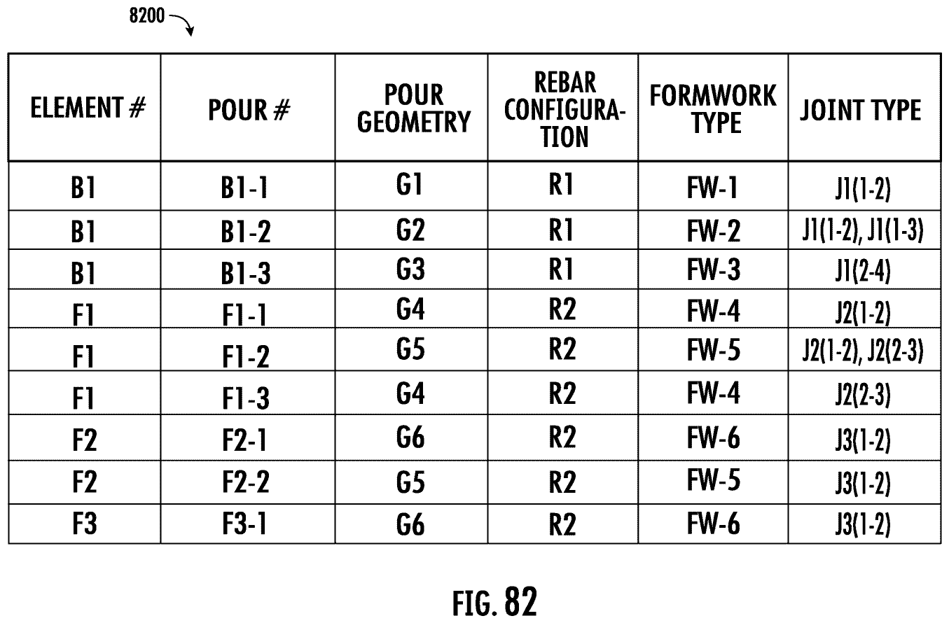

As shown in FIG. 82, the known information is populated in the Mode-4 Information Table 8200, whereas in prior modes the system may categorize by element, pour and geometry and/or design type, rebar type, formwork type and joint type. The Mode-4 table is identical to the Modes 1 information table.

With reference to illustration 8300 in FIG. 83, the problem for Mode 4 is an amalgamation of modes 1 and 3. The system may first feed in the details from Block 6 (Pour adj/dep list) to generate a sequence of pours with an optimal combination of serial and parallelization subject to initial conditions. The graph produced by the Mode 3 block sequence generator is fed to the Mode 1 block. The node and edge embeddings will be similar to the initial embeddings in Mode 1. These are solved almost identically as in mode 1 with updates to node with mix types and edges with joint types. The populated graph is then fed to the schedule determiner along with curing times to the concrete cycle, combined these allow the schedule determiner to produce a schedule. The schedule may be reviewed and through the global optimization cycle. This structure being reminiscent of the process followed in Modes 1 and 3.

### The Optimized Rebar & Pour Sequence Designer

Mode 5 (not shown) fixes 3 of the 5 parameters that form the basis set that defines the Pour design and sequencing configuration. The variable parameters under consideration are the rebar design and the pour sequence parameters. The three fixed parameters are the geometry and/or design, pour layout and mix, which are prescribed a priori. In this mode, the method will generate and/or select the optimal rebar design for every single pour, as well as the pour sequence.

The Key Inputs in every mode will be the constant building blocks. Mode-2 Inputs may include Building Block Inputs for Mode-5 (e.g., Rebar Design for every pour, Pour Layout, Geometry and/or Design). Other inputs may include any of the input types listed above and/or any data types listed in any part of this document, including for example: Mode Identifier, Initial Structure Design/Prior knowledge regarding the structure to be built, Building Blocks Priors, Constraints Priors, Supply Chain and Resource Availability Data and Requirements, Adjacency and Dependency Priors Data, Contextual Conditions, Optimization Objectives. In some embodiments, other inputs may include any other data type and/or requirement on data types listed in any section of this document, gathered from any data source.

The Key Outputs are Building Block Outputs. In Mode-5, this may include Rebar Design and Pour Sequence. Other outputs may include Milestone Outputs, Ancillary Outputs, and Documentation Outputs. The variable parameter(s)/building blocks are the key output for each mode. These include the rebar design and pour sequence and from the optimal sequence of pours the Pour Schedule may be defined as well. Other outputs may include other Milestone Outputs, Ancillary Outputs, Documentation Outputs.

The techniques and methods for enabling Mode 6 reduce from Mode 8 and may be described as the methods in Mode 8, wherein the mix design and pour layout are known a priori/constant. Alternatively, this may be seen as naturally adjacent to Mode 4. The main change here will be that the material design under consideration will be rebar design rather than mix designs. The same heuristic logics and flows may be used in Mode 5 as in Mode 4, whilst shifting the considerations to rebar centric considerations e.g., considering tensile strength, thermal rebar, rebar fixing during concrete cycle and other rebar considerations.

### The Optimized, Mix & Rebar Designer

Mode 6 (not shown) fixes 3 of the 5 parameters that form the basis set that defines the Pour design and sequencing configuration. The variable parameters under consideration are the mix design and the rebar design parameters. The three fixed parameters are the geometry and/or design, layout and sequence, which are prescribed a priori. In this mode, the method will generate and/or select the optimal mix and rebar designs for every single pour.

The Key Inputs in every mode will be the constant building blocks. Mode-2 Inputs may include Building Block Inputs for Mode-6 (e.g., Mix Design, Rebar Design). Other inputs may include any of the input types listed above and/or any data types listed in any part of this document, including for example: Mode Identifier, Initial Structure Design/Prior knowledge regarding the structure to be built, Building Blocks Priors, Constraints Priors, Supply Chain and Resource Availability Data and Requirements, Adjacency and Dependency Priors Data, Contextual Conditions, Optimization Objectives. In some embodiments, other inputs may include any other data type and/or requirement on data types listed in any section of this document, gathered from any data source.

The Key Outputs are Building Block Outputs. In Mode-6, this includes Mix Design and Rebar Design. Other outputs may include Milestone Outputs, Ancillary Outputs, Documentation Outputs. The variable parameter(s)/building blocks are the key output for each mode. These include the mix and rebar design, and the pour schedule may be defined as well. Other outputs may include other Milestone Outputs, Ancillary Outputs, Documentation Outputs.

The techniques and methods for enabling Mode 6 reduce from Mode 8 and may be described as the methods in Mode 8, wherein the pour layout and pour sequence are known a priori/constant. Alternatively, this may be seen as the natural extension to Mode 1. The main change here will be the inclusion of a design feedback loop between mix design generation and rebar design generation. Varying rebar allows to increase the durability and tensile strength of the concrete, therefore Structural Physical Material Property Data considerations may be iteratively solved by varying both. In addition, thermal rebar may be used to regulate exothermicity of concrete—this may also be iteratively solved. Another consideration may be embodied carbon minimization considerations-rebar and concrete are both high embodied carbon materials.

The Optimized Mix. Rebar & Pour Sequence Designer

Mode 7 (not shown) fixes 2 of the 5 parameters that form the basis set that defines the Pour design and sequencing configuration. The three variable parameters under consideration are the mix type, rebar type, and the sequence parameters. The two fixed parameters are the Pour layout & geometry and/or design, which are prescribed a priori. In this mode, the method will generate and/or select the optimal mix design and rebar design for every single pour, as well as the pour sequence.

The Key Inputs in every mode will be the constant building blocks. Mode-2 Inputs may include Building Block Inputs for Mode-7 (e.g., Mix Design for every pour, Rebar Design for every pour, Pour Sequence). Other inputs may include any of the input types listed above and/or any data types listed in any part of this document, including for example: Mode Identifier, Initial Structure Design/Prior knowledge regarding the structure to be built, Building Blocks Priors, Constraints Priors, Supply Chain and Resource Availability Data and Requirements, Adjacency and Dependency Priors Data, Contextual Conditions, Optimization Objectives. In some embodiments, other inputs may include any other data type and/or requirement on data types listed in any section of this document, gathered from any data source.

The Key Outputs are Building Block Outputs. In Mode-7, this may include Mix Design, Rebar Design, Pour Sequence. Other outputs may include Milestone Outputs, Ancillary Outputs, Documentation Outputs. The variable parameter(s)/building blocks are the key output for each mode. These include the mix and rebar design and pour sequence, and from the optimal sequence of pours the Pour Schedule may be defined as well. Other outputs may include other Milestone Outputs, Ancillary Outputs, Documentation Outputs. The techniques and methods for enabling Mode 7 reduce from Mode 8, and may be described as the methods in Mode 8, wherein the pour layout is kept constant.

### The Optimized, Mix-Controlled, Pour Slicer

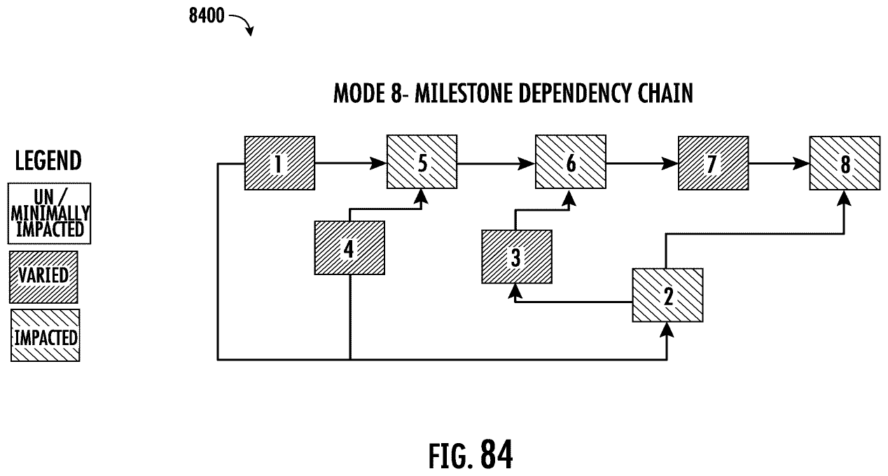

With reference to illustration 8400 of FIG. 84, Mode 8 fixes 2 of the 5 parameters that form the basis set that defines the Pour design and sequencing configuration. The variable parameters under consideration are the pour layout, rebar type and the sequence parameters. The two fixed parameters are the Pour design and mix, which are prescribed a priori. In this mode, the method will generate and/or select the optimal pour layout (and as a consequence touches virtually all blocks for the pour geometries, rebar type, joints and formwork) as well as sequence and schedule.

The Key Inputs in every mode will be the constant building blocks. Mode-2 Inputs may include Building Block Inputs for Mode-8 (e.g., Mix Design for every pour, geometry and/or design). Other inputs may include any of the input types listed above and/or any data types listed in any part of this document, including for example: Mode Identifier, Initial Structure Design/Prior knowledge regarding the structure to be built, Building Blocks Priors, Constraints Priors, Supply Chain and Resource Availability Data and Requirements, Adjacency and Dependency Priors Data, Contextual Conditions, Optimization Objectives. In some embodiments, other inputs may include any other data type and/or requirement on data types listed in any section of this document, gathered from any data source.

The inputs to this model may include building design data which may include specifications, for example provided by the architect/contractor. As in prior modes, the BIM model may be another key source of data from which inputs may be derived (including adjacencies for example). The two fixed parameters from the PD&S basis set will act as specific inputs: the building design (part of Milestone/Block 1-1a), and the mix type for each element (part of Pour Internals Block 4). The known information may be of low granularity and is fed into the Optimized Mix-Controlled Pour Slicer. This Mode 8 milestone dependency chain is outlined in FIG. 84.

The Key Outputs are Building Block Outputs. In Mode-8, this may include Rebar Design, Pour Sequence, Pour Layout. Other outputs may include, Milestone Outputs, Ancillary Outputs, and Documentation Outputs. The variable parameter(s) are the key output for each mode. These include the pour layout, rebar design and pour sequence and from the optimal sequence of pours the Pour Schedule is defined as well. The pour layout also may result in details around formwork and joint type as well which are intrinsically associated to the geometry and/or design. Other outputs may include other ancillary outputs, milestone outputs and/or documentation outputs. The known information is populated in the Mode-8 Information Table, which is quite sparse. In addition, the system may outline the method blocks and the outputs that they will generate.

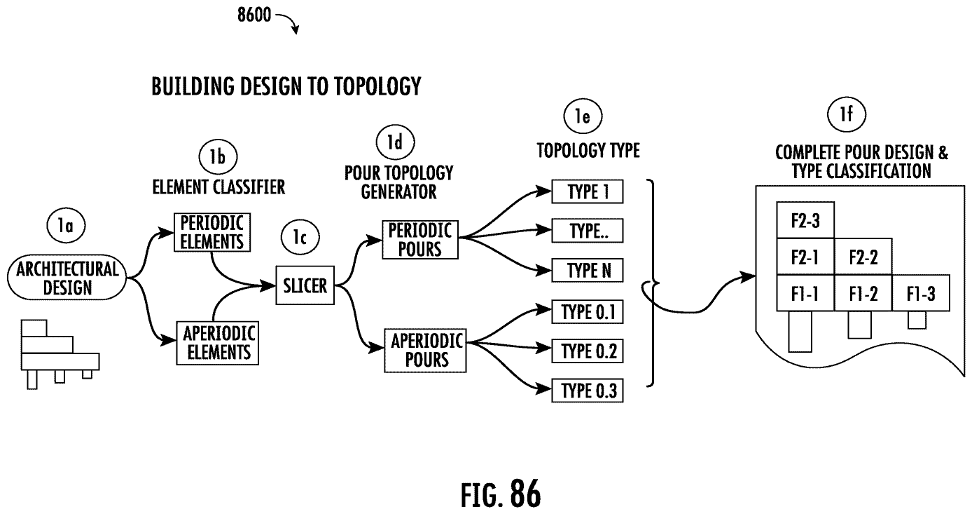

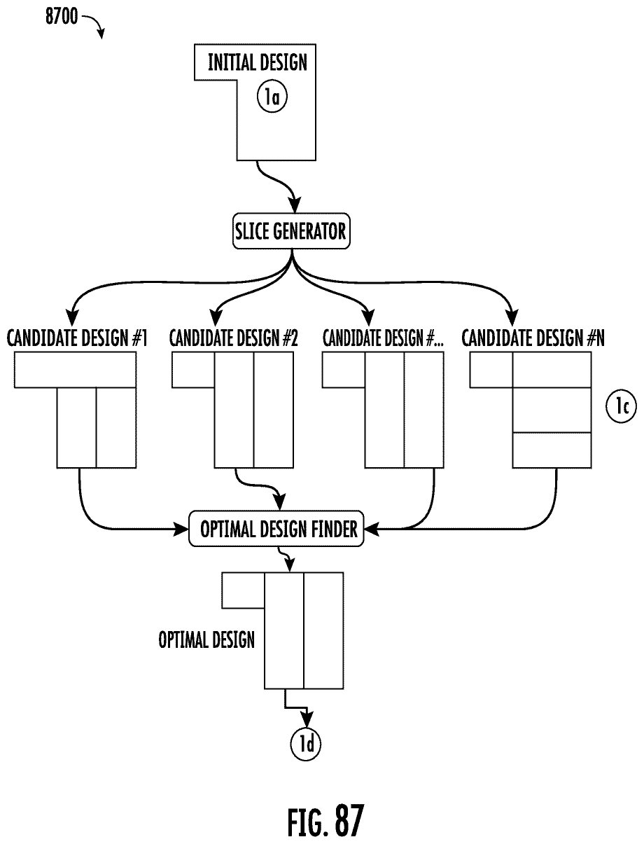

It is worth noting that Block 1 (Building Geometry & Design) encodes both design as well as geometry and/or design. Therefore in illustration 8600 and 8700 FIGS. 86-87 the system may expand on the process from the input design (1a) to estimated element classification (1b) that produces the topological classification. These elements are fed to the Slicer (1c) which will produce an optimal configuration of pour geometries, that may then be further classified into the topology types. On that basis the complete pour design and type classification for the structure may be derived.

The Slicer block labelled Block 1c has the responsibility to find the optimal pour layout given some essential design constraints and specifications (e.g., as provided by the architect/contractor). The initial design is used as the bounds to generate candidate designs with pours of optimal sizes (duly constrained by some essential trade criterion). The various candidate designs are then reviewed by the optimizer to find the optimal design. Key considerations factored into optimal geometry and/or design are thermal in nature, specifically expansion/contraction due to temperature rise and shrinkage of material with time. The optimal design is then subject to Pour topology classifications (Block 1d).

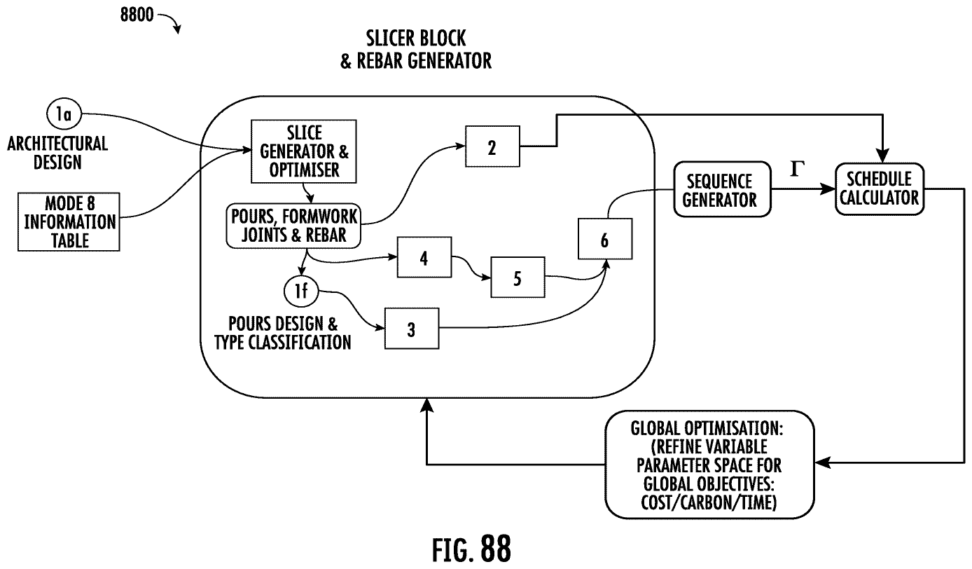

The Mode 8 method splits out into two main blocks: Slicer Block and rebar generator 800 in FIG. 88 which is critical to feeding Block 6 (Pour Adj/Dep list) from which the pour sequence can be devised using the Sequence Generator Block (as outlined in detail in Mode 3). The Slicer Block has some critical elements in it: The slice generator which produces the specific details around internals such as rebar type and external geometry and/or design related to formwork and joints. They will produce Pour design and type classification that will feed Block 3 (orchestration chain), Block 4 (specifically rebar) and Block 5—where the pour requirement table may be populated. These all combine to produce the Block 6 list that allows us to generate the pour sequence. Additionally, the durations in concrete cycle can be completely defined for Block 2 and this along with the graph Gamma will allow us to generate the schedule. The schedule may be reviewed and modified using the global optimization cycle.

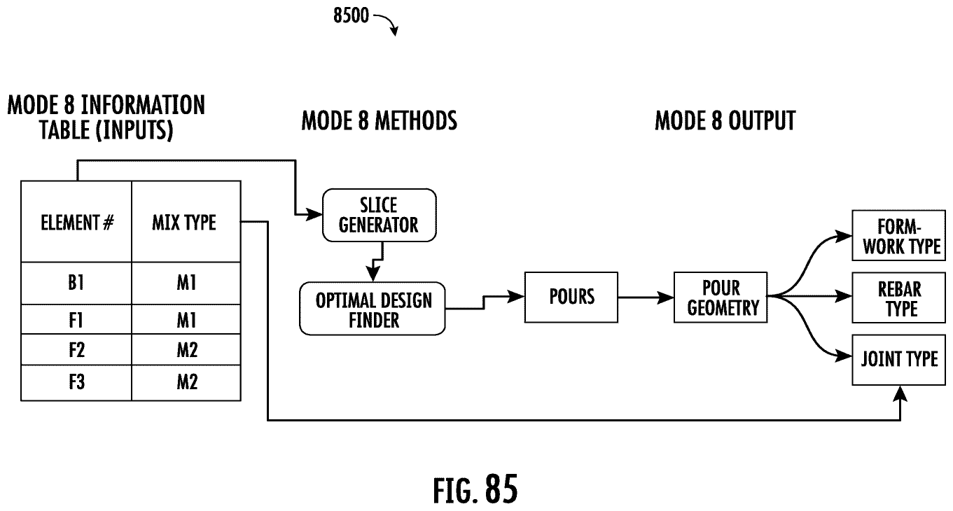

As shown in FIG. 85, the Slice Generator in particular ingests the Architectural design (1a) and inputs from the Mode 8 Information Table 8500. This block is a progenitor to the eventual directed graph Gamma and is initiated as an undirected subgraph within an element or a set of connected (adjacent) elements. These subgraphs would specifically embed known (such as mix) or assumed details (rebar) to estimate the edges, and consequently the thermal calculations that allow joint estimations to be conducted. The optimal undirected subgraphs will then be connected to the progressively evolving large-graph where the dependencies structure can be defined (Block 3) at which point the directionality of the graphs is also updated. This graph building process is highly iterative, and potentially involves evaluations of several combinations. The conventional/novel methods discussed in Mode 3 become even pertinent here where there are fewer constraints, hence further scope for variation and optimization.

### The Optimized Pour Slicer

Mode 9 (not shown) fixes 1 of the 5 parameters in the basis set that defines the Pour design and sequencing configuration. The variable parameter under consideration is the geometry and/or design. The four fixed parameters are the mix design, rebar design, pour sequence, and pour layout, which are prescribed a priori. In this mode, the method will generate and/or select the optimal pour layout (and as a consequence touches virtually all blocks for the pour geometries, mix design, rebar design, joints and formwork) as well as sequence and schedule.

The Key Inputs in every mode will be the constant building blocks. Mode-1 Inputs may include Building Block Inputs for Mode-9 (e.g., geometry and/or design). Other inputs may include any of the input types listed above and/or any data types listed in any part of this document, including for example: Mode Identifier, Initial Structure Design/Prior knowledge regarding the structure to be built, Building Blocks Priors, Constraints Priors, Supply Chain and Resource Availability Data and Requirements, Adjacency and Dependency Priors Data, Contextual Conditions, Optimization Objectives. In some embodiments, other inputs may include any other data type and/or requirement on data types listed in any section of this document, gathered from any data source.

The Key Outputs are Building Block Outputs. In Mode-9, this may include Mix Design, Rebar Design, Pour Sequence, Pour Layout. Other outputs may include Milestone Outputs, Ancillary Output, and Documentation Outputs. The variable parameter(s) are the key output for each mode. These include the pour layout, mix and rebar design and pour sequence and from the optimal sequence of pours the Pour Schedule is defined as well. The pour layout may also result in details around formwork and joint type as well which are intrinsically associated to the geometry and/or design. Other outputs may include other ancillary outputs, milestone outputs and/or documentation outputs.

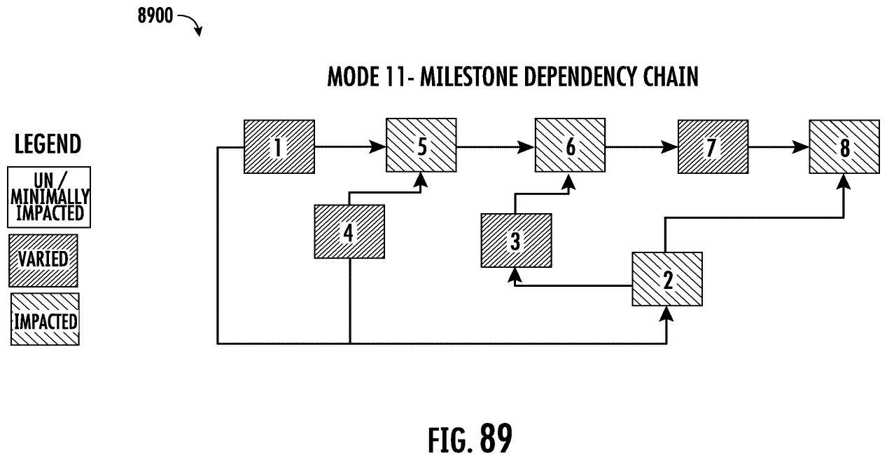

The techniques and methods for enabling Mode 9 may extend from Mode 8 and/or reduce from Mode 11 illustrated as 8900 in FIG. 89. Mode 9 may be achieved using the same methods as in Mode 8, wherein the mix design is allowed to vary. Equivalently, it may be described as a subset of the methods in Mode 11, wherein the mix type and geometry and/or design is kept constant.

The same techniques as in Mode 8 may be used, whilst taking into account that there will be a strong feedback loop between pour layout design and mix design choice, since the geometry and identity of a mix are both variables which affect its strength profile, curing time, thermal behavior and more. An iterative loop between the two may thus have to be part of the methods of Mode-9. Furthermore, mix type may also impact the curing time section of the concrete cycle which is another consideration. These considerations are addressed in mode 11.

### The Optimized, Mix-Controlled, Architect

Mode 10 (now shown) fixes 1 of the 5 parameters in the basis set that defines the Pour design and sequencing configuration. The variable parameter under consideration is the mix design. The four fixed parameters are the rebar design, pour sequence, pour layout and geometry and/or design, which are prescribed a priori. In this mode the system may be allowed to tune the geometry and/or design, which may affect every element in the structure. It also impacts the pour layout, pour internals (that includes mix and rebar type) and the pour sequence. The expectation is that a priori input information may include rough designs, specifications, user requirements, location and environmental considerations amongst other data types mentioned above. In this mode, the method will generate the optimal design, optimal geometry and/or design and layout, the rebar design, joints and formwork, as well as sequence and schedule, whilst being given mix design.

The Key Inputs in every mode will be the constant building blocks. Mode-1 Inputs may include Building Block Inputs for Mode-10 (e.g., Mix Design). Other inputs may include any of the input types listed above and/or any data types listed in any part of this document, including for example: Mode Identifier, Initial Structure Design/Prior knowledge regarding the structure to be built, Building Blocks Priors, Constraints Priors, Supply Chain and Resource Availability Data and Requirements, Adjacency and Dependency Priors Data, Contextual Conditions, Optimization Objectives. In some embodiments, other inputs may include any other data type and/or requirement on data types listed in any section of this document, gathered from any data source.

The Key Outputs are Building Block Outputs. In Mode-2, this may include Rebar Design, Pour Sequence, Pour Layout, geometry and/or design. Other outputs may include Milestone Outputs, Ancillary Outputs, and Documentation Outputs.

The variable parameter(s) are the key output for each mode. These include the geometry and/or design, pour layout, rebar design and pour sequence and from the optimal sequence of pours the Pour Schedule is defined as well. The building design may also result in the generation of a 3D-BIM that is adherent to standard/local (environmental, code) and novel/global (carbon/economic/time) considerations. As in prior modes, the pour layout may provide details associated with formwork and joint type as well which are intrinsically associated to the geometry and/or design. Other outputs may include other milestone outputs, ancillary outputs, and documentation outputs. The techniques and methods for enabling Mode 10 reduce from Mode 11, and may be described as the methods in Mode 11, wherein the mix type is kept constant.

### The Optimized Architect

With reference to illustration 8900 in FIG. 89, Mode 11 fixes none of the 5 parameters in the basis set that defines the Pour design and sequencing configuration. Therefore, all five parameters are variables, noting that design as a parameter affects virtually all the other parameters. In this mode the system may be allowed to tune the design, which affects every element in the 3D BIM. It also impacts the pour layout, pour internals (that includes mix and rebar type) and the pour sequence. The expectation is that a priori input information may include rough designs, specifications, user requirements, location and environmental considerations amongst other data types mentioned above. In this mode, the method will generate the optimal design, optimal geometry and/or design and layout, the rebar type, mix type, joints and formwork, as well as sequence and schedule.

The impact of these 5 parameters and how they interact with the other milestones can be viewed in the Mode 11 milestone dependency chain outlined in FIG. 89.

The Key Inputs in every mode will be the constant building blocks. Mode-1 Inputs may include Building Block Inputs for Mode-9. Other inputs may include any of the input types listed above and/or any data types listed in any part of this document, including for example: Mode Identifier, Initial Structure Design/Prior knowledge regarding the structure to be built, Building Blocks Priors, Constraints Priors, Supply Chain and Resource Availability Data and Requirements, Adjacency and Dependency Priors Data, Contextual Conditions, Optimization Objectives. In some embodiments, other inputs may include any other data type and/or requirement on data types listed in any section of this document, gathered from any data source.

The initial structure design/priors, constraint priors, supply chain data, and other inputs listed herein may be of particular use. For instance Contextual Conditions at the level of location and site will allow us to pin down environmental data and address adverse weather conditions. Similarly geographical location data, geological data, surroundings data and terrain data, will provide us information from a seismic perspective/underground water conditions/flood risks etc., often encoded in building codes (in terms of durability and shear), these are also specific data. Other input data may be more qualitative and can be related to the specifics of the priors know of the design, such as purpose (building/bridge/amphitheater), capacity (people or traffic throughput), supply chain data (lorries/freight trains/high speed trains etc.). The Designer and Structural inputs are closer to the definition of an element, and in this mode are likely to be more fuzzy as they will exist as guidelines/preferences/suggestions rather than precise information. The less precision, the less detail the system may use for example a floor-plan is most likely an output rather than an input of the Milestone 1/Design block. Aesthetics are likely to manifest as optimization variables rather than hard constraints. The structural constraints (e.g., load bearing structure) are likely to entail fewer options as they are typically physics/engineering based. Techniques for increasing granularity and improving causal reasoning of the models may be used in light of the expected sparse and low-granularity input data.

The Key Outputs are Building Block Outputs. In Mode-11, this may include all building blocks: Mix Design, Rebar Design, Pour Sequence, Pour Layout, Geometry and/or Design. Other outputs may include Milestone Outputs, Ancillary Outputs, Documentation Outputs. The variable parameter(s) are the key output for each mode. These include the geometry and/or design, pour layout, mix and rebar designs and pour sequence and from the optimal sequence of pours the Pour Schedule is defined as well. The building design may also result in the generation of a 3D-BIM that is adherent to standard/local (environmental, code) and novel/global (carbon/economic/time) considerations, and any other constraints and/or requirements. As in prior modes, the pour layout may provide details associated with formwork and joint type as well which are intrinsically associated to the geometry and/or design. Other outputs may include other milestone outputs, ancillary outputs, and documentation outputs.

The AI Architect is an inherently complex embodiment of Pour Design & Sequencing, specifically the Building Design mode has multiple aspects to it, the system may break this section down further into two parts (A) AI Building Designer and (B) AI Architect, where in (A) the system may focus on the intent of the designer, how the system may define the methodology, and the tools the system may intend to use. In (B) the system may will focus on how the Design block will integrate with components developed in prior modes in order to form the Mode 11 logic block. The system may thus show how the various components interact in order to hit all 8 milestones.

Let us consider the starting point of Pour Design & Sequencing: this is a collection of multiple documents that will encode the design specifications, requirements, preferences, guidelines (Model 1 inputs). The end-point of this block is a fully fledged building design, which may be visualized as a 3D-BIM model that can be fed further to generate information to populate other blocks. Figure C.M11.2 draws out the progression of BIM Design from essentially textual (and possibly visual) information represented as Level 0, which through successive evolutionary cycles progresses into a structure that starts to resemble a BIM (e.g., Level 1 Coarse BIM) and at the final point, the final level is a granular 3D BIM that includes a detailed list of building elements, on which basis the system may derive a basic information table from which the other variables may be evolved using techniques now familiar to us from the prior modes.

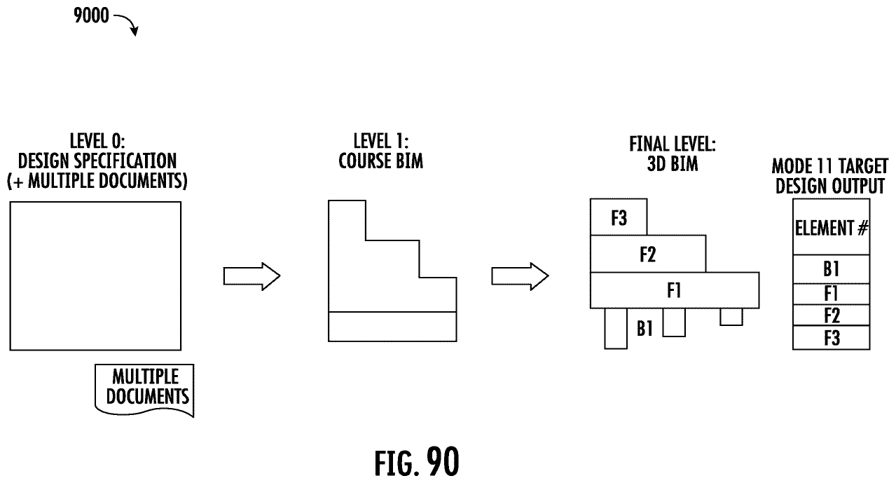

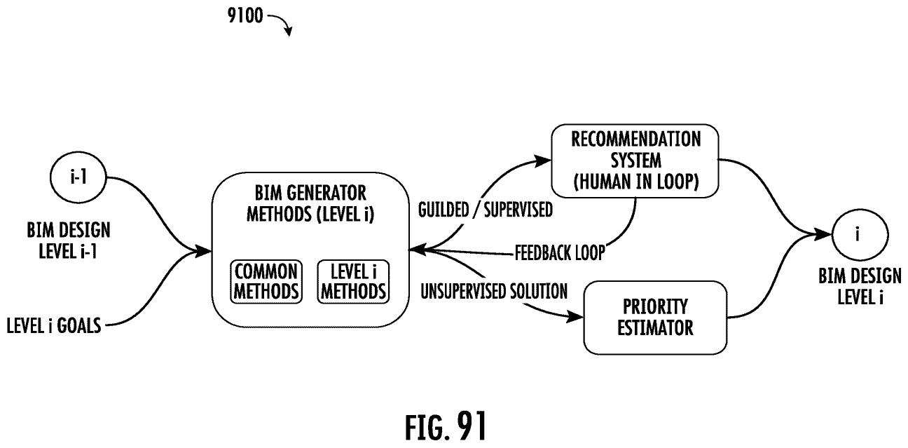

The system may envision the evolution of the BIM as an iterative process. The methods are essentially of a generative nature, where based on prior level of BIM design and goals for the next level, the next level may focus on specific parts of the structure. For example, load bearing structures may be the focus of the early evolutionary levels, after which aesthetic considerations may be left to the later levels. In the simplest realization the system may assume a 3D polyhedron-basically a convex structure within which confines the building design must fit. There may be a plan drawing as well, however the details are likely to be very rough. The level 1 BIM Generator will import these details with some essential requirements (such as floor-wise outer structure) as indicated as the Level 1 (Coarse) BIM example in illustration 9000 in FIG. 90. The system may outline an iterative methodology that will encode this evolutionary logic to progressively take in the prior design level BIM, the next level goals and generate a next level BIM design (See illustration 9100 in FIG. 91). The ith Level generator will use methods that may be common to every level or may be level specific. Generators typically use the input information, apply trade-offs to propose specific designs. Building structures are complex in nature and at the early stages of development would be well served by at least some human-in-the-loop guidance. However, as these systems become more sophisticated and the generators ‘learn’ how to interpret inputs the system may anticipate BIM designs will require little to no prompts to generate the next level BIM designs. These are both potential routes that are encoded into the evolutionary BIM design logic loop. An example of the supervised/guided route would be a recommendation system where the BIM generator would produce a selection of designs to an expert (architect for example) to select, the feedback loop would ingest the selected design and related meta-data to enable the generator to ‘learn’ from the expert, such that subsequent unsupervised designs would potentially pass an ‘architect in the loop’ test. Either way both routes would propose a next level BIM Design.

The BIM Generator Methods block alludes to two categories of methods that may be leveraged. The (A) The Common Block Methods-allude to methods that would be required for virtually any embodiment of the PDS evolutionary level generators. Here methods and techniques used in Linkage may be especially useful. Note that the linkage engine may make use of a preferred schema that leverages the built-in inheritance logic. In this case The AI Designer will be self-consistent and will naturally follow the BIM's standard schema.

For textual inputs or meta-data (if any) information will be mined using a Natural Language Processing (NLP—this also includes NLU i.e., understanding) engine and translator converted to the standard schema.

Computer vision & machine learning algorithms may be deployed to interpret elements from the coarse structure. A vision-based identification tool (well served by a principally supervised learning model) may be deployed to interpret element types within a shaped volume or primitive.

From early stages an undirected graphical representation of the building is desirable. The graph of the structure with nodes and edges to depict connectivity informs adjacencies (and enables dependency estimates) allows us to estimate load paths in the generated design and to encode details without the overhead and complexity of element level drawings.

A Bayesian approach may be appropriate here given the finite structures involved, the connectivity requirements, with appropriate priors (such as higher floors will not have elements like basement slabs). A quantifiable likelihood measure (of design) with estimation confidence will enable evaluation and design optimization.

A Physics engine will ingest the graph and evaluate load estimates for the Bayesian model to estimate likelihood and confidence in the proposed generated structure.

An inner optimization loop will be included with a cost-function to maximize likelihood (with confidence) in the proposed design. Checksums will be used consistently to verify proposed designs and to correct for mismatch.

As every level has specific requirements, specific methods may apply based on specific requirements or levels. The system described herein may consider some of these details, how they would be used and consider some of the pertinent methods.

For very coarse models (assume primitives-cube, cuboid, sphere) the system described herein may use a construction/architecturally relevant generative approach. The method will ingest primitives and essential textual prompts (basement, floor level etc.) from inputs such as a manifest, schedule, human. The model will ‘generate’ element types within the confines of the primitive.

At more evolved levels the atomic level of the drawing will be predicted against the expected element types, which may be level specific. The tools described in linkage for element identification and labeling become pertinent at this stage. For example, element identification, and its relative location in the structure can be addressed as a network/graph identification problem, the adjacency matrix is a useful tool to label structures. A labeled 3D BIM would be in the standard BIM schema.

The classification of elements into piling, sub- and superstructures introduces a fork in the design module. At these levels there are 3 key modules, the data engine that ensures all inputs are readable by the model by casting into a subgraph for the BIM level in question, the structure level design consideration (sub-, super- and piling design) and finally the optimization engines.

The Data Engine (e.g., the processor described herein) may include of a data parser that reviews the ingested design, structural, code, contextual, sensor and material property inputs defined at the specification stage and maps data inputs to an internal data schema. The structural elements representation (drawings etc.) are cast into an internal design schema, which uses a graphical system of representation with elements mapped to nodes, adjacency of elements represented as edges between nodes. The graph with associated meta-data allows us to define a graph representation in a low-dimensional space using embedding techniques. The graph reinterprets the structure and design into a convenient topological format that allows us to analyze the design in the correct sequence. For piling design the structural load path will also be mapped by including edge embeddings.

The Element-wise Design Generator may include rules for each module, which will be different, due to the different design and risk considerations associated with each part of construction. The substructure design requires specific thermal management due to the thickness of the as-cast slabs and typically requires careful analysis and re-tuning of the design to meet crack risk requirements. The superstructure design involves thinner slabs, and although subject to similar crack risk considerations, tends to be less complex due to geometric requirements. The piling design includes estimation of pile type, size, depth, numbers and the pile element design construction methods, as well as the results of the ground investigation/survey will influence the eventual design considerations, modulated by constraints such as cost and piling rig availability. From a design generation perspective the method may be (1) conventional or (2) more generative in nature.

A graph representation allows us to define constraints and bounds with relative ease. A key aspect of the problem is introducing new nodes as the element structure evolves. The node-embeddings can encode the structural and aesthetic details. Constraints will limit the possibilities, graphs can also be geometrically confined, and as the system described herein applies more structure, the system described herein approaches a finite model of the structure in question. Thus graphical and structural tools may be leveraged to iteratively generate and assess the quality of the proposed structure, discarding any configurations that fail standard requirements (such as load capacity) and non-standard targets (such as aesthetic requirements).

AI based methods include Graph neural networks that can handle much higher capacities, several iterations and generate several combinations of designs that may be evaluated. Multi-modal Transformers (as described in Linkage) could work well in this context as well where the objective would be the ingestion of various sources of BIM inputs that are transformed into a vector of tokens that encode the semantic and sequence of textual or image data. A fusion layer can ingest multiple sources, passed through encoder-decoder modules to propose a set of possible designs for the layer in question.

The Optimization Engine (the processor described herein) is invoked when element design analysis indicates unacceptable risk (crack risk for sub/super structure, excess load bearing demands of piling elements). Although the analysis is done element-by-element, redesign for example for thermal management in substructure elements or restraint redesigns will impact adjacent elements as well. Therefore, the optimizer will tune parameters, feed these to the data engine to enable reformulation of the graph structure prior to reassessment for crack width. The graph embeddings are intended to enable the optimization block to optimize the cost function. The design cost function is mapped to crack risk across all members.

With the outline and methods developed in the AI Building Designer the system described herein can now start to put together the structure for the complete AI Architect. Here the system may see the high level conceptual progression from basic inputs passed through the BIM Generator which includes the whole progression from basic inputs to a fully-fledged 3D BIM as defined in the AI Building Designer module above. Block 1 also includes the Pour Slicer module (also discussed in detail in Mode 8, Figure C.M8.4). This figure shows how the progression goes from Design to the pour Layout from which Milestones/Blocks 2, 3, 5 can be iterated upon. The pour internals represented by Block 4 includes Mix and Rebar types. Here the focus is on rebar types of the pour internals. The Pour requirements table is complete and is ready to generate the Milestone 6 Pour adjacency/dependency table. This part is now familiar as the Mode 4 type problem.

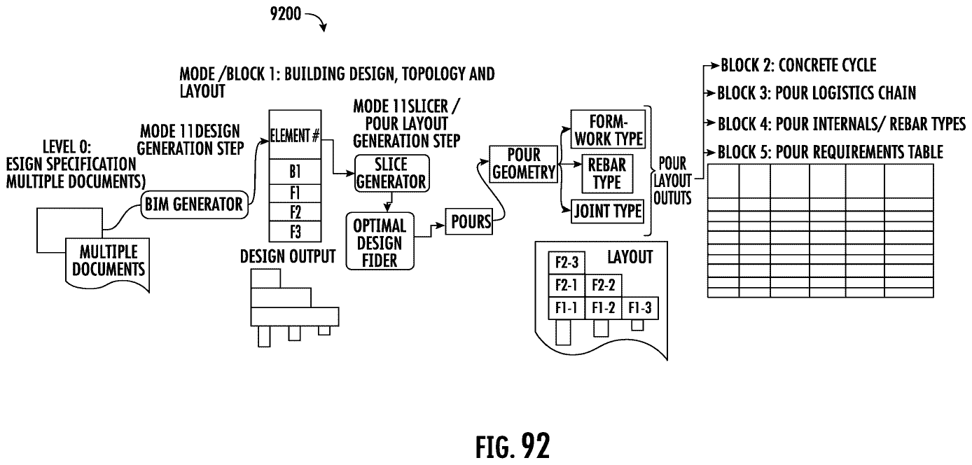

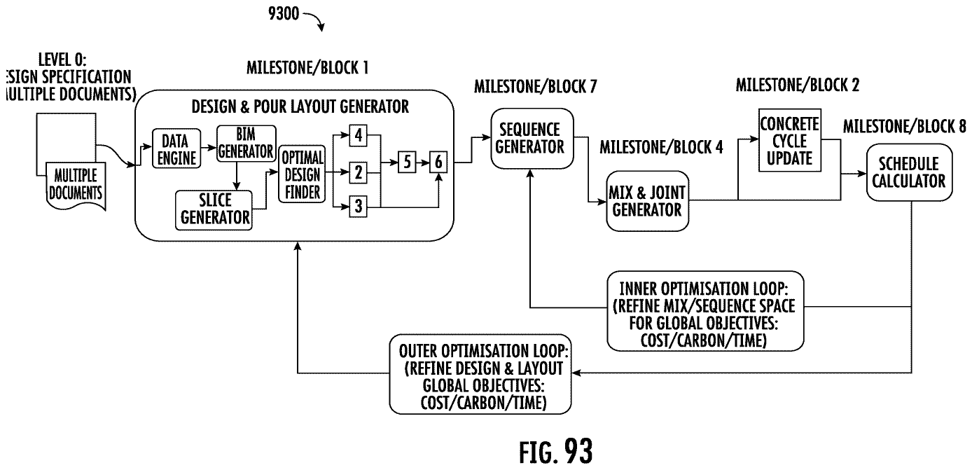

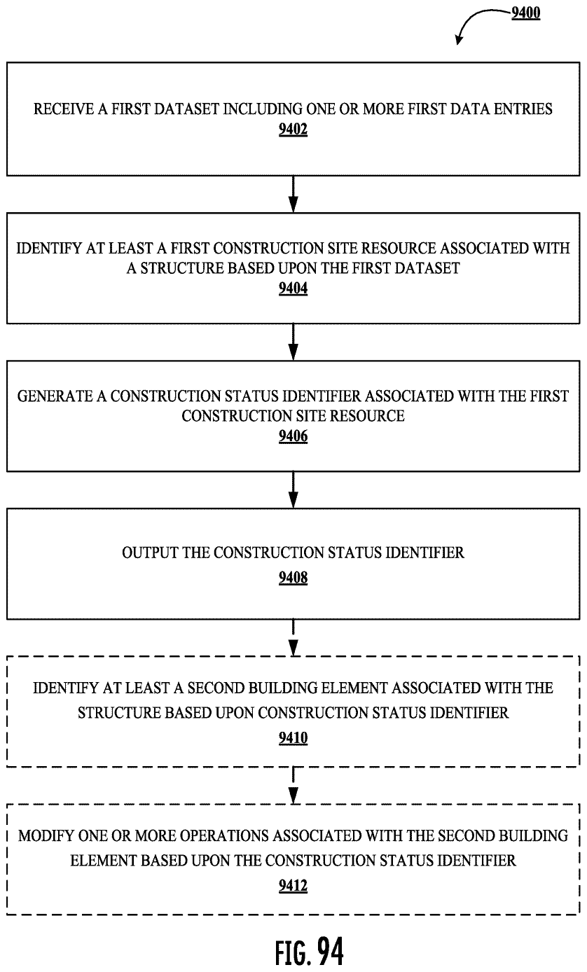

The system may now combine all the prior steps to define the Mode 11 logic. As shown in illustration 9300 of FIG. 93, where the system defines the logical steps in the AI Architect Mode 11 configuration. The process outlined in illustration 9200 of FIG. 92 form the internals of the Block 1 generator logic, on the basis of which the Block 6 Pour adjacency/dependency table can be derived. Note the commonality with the latter part of the Mode 8 logic block (Fig C.M4.5) where the Block 7 Sequence generator, which produces a fully populated directed graph, and is ingested by the Mix & Joint optimizer (Block 4). The specific mix types selected require the concrete cycles (Block 2) to be updated, the combination of which produces a Pour schedule. There are two optimization loops: an inner loop where the sequence, mix and joint types may be reconfigured based on carbon/cost/time (CCT) targets. The outer loop includes the design block as well.

Model Types and Techniques & their Use for PDS

In addition to the graph-based algorithms described in the description of the 11 modes of operation for generating a pour design or sequence, the system utilizes (at nodes within those graph algorithms) models that can, in and of themselves be graph-based, or can otherwise be any other kind of functional mapping. The following are some examples of models, algorithms and/or techniques that the system may use, which may be embedded in the graph networks. In some embodiments, physical and/or chemical models may be used.

In some embodiments, tree-based methods (e.g., decision trees, bagging trees, random forests, gradient boosted trees) may be used. In some embodiments, Bayesian probability theory may be used. In some embodiments, artificial neural networks (e.g., Convolutional networks, Recurrent neural networks, Transformers, Generative Adversarial Networks, Diffusion Systems) may be used. In some embodiments, clustering algorithms (e.g., K-means clustering, Hierarchical clustering, Density based spatial clustering, Spectral clustering, Affinity propagation, Gaussian mixture models) may be used.

In some embodiments embedding/dimensionality reduction methods (e.g., Principal component analysis (PCA), Independent component analysis (ICA), Multi-dimensional compression methods) may be used. In some embodiments, Bayesian networks, causal graphs, Ensemble Models, Generative Models, Parametric Design Models, Evolutionary and/or Genetic Algorithms, Multi-Modal Models, LLM Models, NLP Techniques, Machine Vision Techniques, Deep Learning & ML Techniques, Hyperparameter Optimization Techniques, and others described in any section herein may be used.

### Genetic Algorithms

Genetic algorithms are a class of optimization algorithm based on evolutionary methods that are designed to solve problems that, in general, do not have a single, unique solution, and are subject to a wide variety of complex constraints.

Genetic algorithms therefore constitute a novel approach well suited for the pour design and sequencing problems described herein. Using genetic algorithms, an initial building design with specific building blocks may be generated. This building design and the individual building blocks may be iteratively mutated to search through the building design space, sifting through many evolutionary generations of building designs, until an optimal generation is reached.

The system may utilize genetic algorithms, in conjunction with the graph-type embeddings described for Modes 1 to 11, in order to solve for a design and construction schedule that satisfies all constraints, for example defined by: i) a human designer and ii) physical/chemical/engineering/resource constraints defined by the context within which a structure will be built and/or other constraints.

Our genetic algorithms also solve for an additional class of constraint, which are encoded within each model's utility function (which constrains, for example, the total embodied carbon for a project, or the total duration of the project from start to finish).

The use of a genetic algorithm involves principally five components. First, a model that receives inputs and generates outputs, wherein those outputs constitute the values that are to be optimized. In this instance, the models used are each of the 11 modes of usage. Second An embedding procedure is one in which an array of data (of mixed type, such as numbers and text), can be encoded into a vector of digits, wherein those digits are either integers or binary values. The vector can be of arbitrary length, and the digits can be of arbitrary magnitude. The embedding procedure involves the use of an encoder, which maps the original data into the embedded vector form. The encoder must be reversible in nature, such that the embedding can always be mapped back to the original data.

Third, a genetic inheritance procedure is a method by which two vectors of equal length can be combined, such that the contents are mixed according to a user-defined ruleset. Some examples of mixing rules utilized in this invention are averaging, random selection, arbitrary function, and deletion and random replacement. Using one or more of the above mixing rules, a genetic inheritance procedure will combine two equal-length vectors, v₁ and v₂, and will output two new vectors, v′₁ and v′₂ (both also of equal length). The inheritance procedure also requires a choice of what percentage of elements in v₁ and v₂ are to be combined using the chosen rule or rules. For example, if 5% of elements are to be combined, then 5% of pairwise digits will be randomly chosen between v₁ and v₂ (where a pairing is taken from the same index-position in each vector). Those will be mixed, and the new digit will replace the original position in both vectors. All other positions are kept the same. Thus obtaining the new vectors, v′₁ and v′₂. In general, an inheritance procedure will receive n vectors and output n vectors, in the manner described above.

Fourth a dataset that constitutes the input data to be passed through the model (or models). The dataset can be taken from real-world historic examples or can be simulated from a generative procedure that is designed to emulate real-world examples.

Fifth, a goodness criterion is used to assess the quality of an instantiation of a model for a given set of inputs. The criterion is a measure performed on the outputs in order to assess whether the required constraints are satisfied. Typically, the goodness criterion is analogous to a score, wherein the score can be improved by either increasing or decreasing the value.

The process by which the system uses genetic algorithms, via the five components above, is illustrated as follows. The problem is defined by choosing one of the operational modes (between 1 and 11 in this embodiment) and by defining all user-based constraints on the design of the building (such as the overall geometric shape, any constraints on concrete mixes that are to be chosen, the time period and location of the structure etc.). The permissible constraints are determined by the specific mode of operation (refer to the sections on each mode for further details as to which parameters can be defined). Utility function constraints can also be optionally defined, wherein one example of a utility function constraint might be a preference for the design and schedule to lower the total embodied carbon of the project.

The system may utilize the chosen mode of operation (including the graph parameters that define their interconnected dependencies) in order to execute an initial guess at the solution to the chosen problem. The initial guess will either begin with, for example, a pour sequence, mix choice, rebar content (or other aspects). These initial values are either chosen from historical projects, or are chosen at random from a plausible range of instantiations (such plausibly random instantiations are taken from the system's building and scheduling simulation software). The system may generate multiple possible initial inputs, wherein these initial inputs are a mixture of historic and random structural designs and schedules.

The system may execute all of the above random and/or historic initializations of the chosen model and assess the goodness of the outputs using the system's goodness criterion. The system may define a threshold of goodness, such that if the score fails to meet the desired threshold, the input is discarded. In general, it may be the case that the first set of randomly initialized states do not meet the minimum goodness criterion. In this case, the system may regenerate a new set of random initial states. The system may continue this process until the system may have a sufficient number of minimally adequate initialized inputs.

The system may then go through the genetic refinement process, whereby for n initial inputs, defined by a list, pᵢ, of input parameters and constraints, and where i denotes the i-th set of initial parameters from the total set of n inputs, the system may execute the following genetic algorithm.

Use an embedding procedure to encode pᵢ into a vector of digits, vᵢ. Select the top m % of initial parameter vectors, whereby the m vectors are chosen by selecting the top m outputs, as ranked by the goodness criterion. Take all pairwise combinations from the set of m vectors. There are

$$k = \frac{m !}{( m - 2 ) ! 2}$$

possible unique pairings from the set of m inputs, the system may typically define a threshold on the value of k, in order to not exceed computational limits. In such cases where k exceeds that threshold, the system may choose a random subset, k′, of the possible pairings, where k′ is at or below the threshold number. The system may then calculate the rk′ mixes of input vectors, where r is the number of random mixes to execute for each of the k′ pairings, the system may then assess the goodness of the rk′ number of newly generated inputs, by running through the same modal usage models as executed previously, the system may again extract the top m % of input vectors, of the set that exceed the minimum goodness criterion. If insufficient input meets the goodness criterion, the system may re-run step (iv) until the system may achieve the minimum number of good outputs, the system may then repeat the procedure from step (i) to step (vi), and halt once the goodness criterion reaches a threshold that defines a solution has been found.

It is important to note that the goodness criterion assesses a goodness score (which can vary with respect to relative closeness of outputs to desired output) but will also assess whether an input will satisfy the necessary constraints on the problem. If an input does not satisfy at least one necessary constraint, the goodness criterion will output the lowest-valued score, and that choice of input will be discarded.

Some constraints set out by the problem are boundary-type constraints on inputs (for example, that a physical dimension can only be designed in the range between 5m and 7m). Given such boundary-type constraints, the genetic algorithm will not permit an input vector to ever contain a value outside of the permissible range.

Other constraints are constraints on the outcome of the calculated pour designs and/or sequencing. In these instances, the decision as to whether a chosen input violates that constraint is known only after the model is executed and the goodness criterion is applied.

### Physico-Chemical Models

It is important to highlight the system's specialized use of hybridized machine learning/physico-chemical models, which constitute machine learning methods but which contain within them functional representations of real-world physical or chemical relationships; whereby those physical or chemical relationships can exist between arbitrary subsets of input and output parameters within a model.

For example, the system may possess knowledge of a functional relationship between the depth of a temperature sensor and the predicted temperature of the concrete after a pour has occurred. In that instance, the system may embed that functional relationship into the system's machine learning models via ensemble techniques, whereby the physico-chemical equation contributes as a weighted component of the internal structure-representation which maps the inputs to the outputs. For more information on this aspect, refer to the description of “normalization” elsewhere in this document.

As has also been previously described elsewhere within this document, the models are able to learn physico-chemical relationships that may otherwise have been unknown in the public literature. The manner in which such learning occurs is through the model training process, whereby the system may use a set of physically-plausible functional forms (such as exponentials, logarithms, sinusoids etc.) which are initialized with randomized functional coefficients, the system may also use these functions in a basis-set type form, whereby the system may use a power series of weighted logarithms (for example), or of any other mixture of functions. During the model training process, the system may use historical data (i.e., historic inputs and expected outputs) in order to numerically constrain the functional coefficients of the physico-chemical models. For more detail on training methods, please see section C.9 in the Mix Optimization section of this document. Crucially, via this empirical physico-chemical functional discovery process, the system may be able to obtain real-world functional relationships that map various physical quantities to others, and whereby those functional relationships are in the form of analytical equations.

### Finite Element Analysis

Physico-Chemical models may be based on finite element analysis models. Alternatively, training data may be produced synthetically using finite element models that encode known physical principals. This allows us to embed physico-chemical understanding into the models. In addition, parametric design techniques, as well as generative design techniques may be employed by the models. Various hybrid architectures, which adaptively employ a combination of FEM and Machine Learning models, parametric design and generative models are contemplated.

### Training the Models

The training methods used to construct the models are discussed at length in subsection C.9 of the Mix Optimization section. The manner by which certain data sources are ingested into those same training methods, for the purposes of constructing pour design and scheduling models that are representative of real-world physical systems.

Information Derived from Multiple Data Sources

In general, all models that are described in the 11 modal usage herein receive data that is categorized under 5 parameter types. These parameter types may be categorized as Mix design, Pour design and layout, Geometry of pour, Rebar design, and Sequencing.

The information constituting the above 5 categories can derive from any set of sources. It might be the case that a human defines the above data for a given instantiation of a structural design (e.g., in the form of a BIM, or a document, or set of documents). However, it might also be the case that the system may possess in-situ data from a variety of devices with sensors that have been used on past projects, and which provide either the sole understanding of the design and on-site evolution of a structure or define additional information (surplus to the human design and scheduling data the system may possess).

### Probabilistic Reconciliation of Conflicting or Uncertain Information

In general, the same data that is required by one of the models may be derived from multiple data sources. For example, the geometry of an element within a structure might be derived from a BIM, or it might be derived from a document. However, once construction begins, that geometry might also be measured by the plethora of devices on-site (e.g., the external camera equipment, or the embedded piezo-acoustic/impedance devices). The measurements that derive from these devices would constitute an additional source of information on the geometry of a pour, in this example.

In general, information derived from multiple sources (or multiple device measurements) will not be identical, even if that data pertains to the same information (such as the length, width and breadth of the same cubic element of concrete). In this case, the systems are able to deal with variations (or uncertainty) due to conflicting information in a probabilistic way, utilizing Bayesian inference (conditioned upon the prior data the system may possess) and generalized uncertainty propagation.

### Device Sensor Data as Training Data for the Models

There are two principal embodiments in which sensor data are used to construct the models. In some embodiments, supervised training data may be used. Wherein all relevant sensor data pertaining to all 5 types of parameter category are used as the “ground truth” values in a supervised training procedure, for the purposes of training prediction, evaluation and recommendation models. Training the models with sensor information of this kind requires the structure of the model to be fixed (i.e., the set of internal models for a given modal usage would have been chosen beforehand) and for the internal weights of a model (or models) to be learned by enforcing that the sensor data use as inputs would always map to the sensor data used as outputs. For example, when training a forecasting model based on historic sensor data, the system may use the sensor measurements from the past 3 hours as an input, and the sensor data for the next 7 days as an output. The system would then create an objective function that compares the output of the model with the true data over the next 7 days and would utilize various optimization techniques to modify the internal weights of the model to minimize any difference between predicted and measured values.

In some embodiments, unsupervised training data may be used. Unsupervised training involves the use of historic data to learn representational mappings that do not involve categorizing any of that data as true or false, or as representative of reality in any way. Using unsupervised training techniques, the system may implement a training procedure that learns that some data that has been gathered is unrepresentative of the other data. One example of an unsupervised training technique is the process of generating a dimensional reduction or encoding of the data (e.g., using Principal Component Analysis). In that example, the system may take all data from a pour, or from a layout of pours, or from a schedule of pours (where that data spans multiple device sensor types) and train a dimensional embedding that maximizes the cross-entropy between the distributions of the data along all projected vector dimensions. The model might then converge on a set of vector axes (encoded along directions in the multi-dimensional space of the data) that compress the measured data into a simplified, lower-dimensional representation. By doing so, the final model might be able to inform us about the real-world relationships (or lack thereof) between various measurements, and whether any such measurements are correlated (thereby representing the same effective information). Unsupervised training is discussed in further detail in subsection C.9 of the Mix Optimization section. Using unsupervised techniques, the system may be able to discover models (whether for the purpose of vectorized embeddings, such as for a genetic algorithm search, or for the purpose of discovering physico-chemical relationships), and the system may also be able to cluster the data into pertinent and poorly descriptive quantities, with respect to any use-case the system may desire. Unsupervised methods also allow us to create generative models, wherein randomized outputs can be generated that are representative of historically measured data (these models are used in simulating real-world data, for example).

Sensor data may be derived from a multitude of devices and sensor combinations (see Hardware section of this document for more detail on device instantiations. Device sensor data is recorded in an example database in real-time and is used to inform historical construction design or scheduling, or to update current design and schedule plans, in response to in-situ events that may interfere with the expected or possible sequences of events.

There are two aspects in which sensor data is used by the models. The first is the inference aspect, which involves the ingestion of raw sensor data into the models, and (in conjunction with other non-sensor data, such as human design information) the creation of inferred metrics about the physical system (e.g., concrete mix recipe and geometry) or temporal system (e.g., time of concrete pour). Inferred metrics need not require non-sensor data, but any pertinent information from other data sources is used wherever possible.

Some non-exhaustive examples of sensor-based measurement inferences discussed herein. For example, non-destructive measurements of compressive/flexural loads may be used. Through use of mechanical wave-base sensor devices such as piezoelectric devices, loudspeakers and pressure-based embedded sensors, the compressive and flexural tension with a concrete element can be directly measured or can be measured parallel or transverse to the rebar structure. These measurements are non-destructive and permit the continuous monitoring of the mechanical stresses within the structure being built.

In another example, information regarding the workability or elasticity of the material may be derived from sensors that are embedded in the concrete delivery truck, which measure the viscous flow in real-time. Viscous flow may be derived from pressure sensor devices, piezo-electric motion sensor devices, piezo-acoustic density and sound speed measurements, and other temperature and humidity-based measurements. The system may also use embedded sensors to measure the workability of the concrete as it is being placed (whilst it is still in liquid form) via embedded devices within the formwork and rebar structure.

In another example, thermal cracking and shrinkage is primarily due to thermal gradients throughout a concrete element. The thermal expansion or contraction of the concrete is a direct function of the temperature difference between adjacent local sections of a concrete element. As such, embedded temperature sensors, in conjunction with external temperature sensors (for the purposes of measuring ambient temperature) are used to infer the 3D temperature profile at all internal locations within the concrete. The inference of the 3D temperature profile requires knowledge of the concrete element's 3D geometry, which may be derived using wave-based sensor devices and associated context awareness techniques for example, and is based upon a hybrid machine learning model, partly comprised of physico-chemical equations and partly comprised of probabilistic and empirical inferences on the interpolated temperatures between sensor locations. In addition to thermal cracking and shrinkage measurements based on temperature, the system may also utilize embedded mechanical measurements from piezo-acoustic, piezo-electric and impedance or pressure-based sensor devices; all of which to gain an understanding of the small-scale deformations within the material.

Measurements of the occurrence of thermal cracking may also require knowledge of boundary-based loading constraints on the 3D geometry of the element in question. As such, the system may use hybridized modelling that incorporates physico-chemical equations based on loading constraints, as well as empirical sensor measurements of historic pressure and loading values.

There are a multitude of ways in which the sensors measure the geometry of the material. Some devices are external to the element (such as E&M Wave-Based sensing devices e.g., element-facing cameras, or element-facing LIDAR/microwave antennas), and directly measure the geometry through automated visual inspection, via computer vision algorithms. Other devices are embedded within the material itself, and may measure piezo-electric, piezo-acoustic, acoustic, radio wave/microwave antennas, in order to take measurements of physical dimensions (see the Sensor Self-Detection/Self-Awareness section of this document for more detailed information). Direct measurements of physical dimensions (such as from external sensors) are straightforward and use projective geometry and signal-timing based techniques to measure the shape and structure of a concrete element. However, embedded (indirect) geometric measurements may or may not require further contextual understanding, such as the exact placement and orientation of the sensor (see Mix Fingerprinting and Sensor Self-Detection/Self Awareness section of this document, in particular the subsections on “normalization”).

All the measurement-recording devices contain integrated clock systems that allow every measurement (and respective inference) to be catalogued with respect to the time at which they occur. In some cases those clock systems are relative to internal workings, and in others they are synchronized with global atomic timing systems via network connections to the internet. In all cases, the measurement timings are reconciled, such that they are either corrected by temporal inference models or are retrieved from external 3rd party timing systems. Temporal synchronicity is a vital component of the measurement inventions and involves probabilistic inferences wherever temporal data may be insufficient for the inference in question.

In a similar manner as for the detection of concrete geometry, the detection of rebar configuration may involve the use of external sensors (e.g., element-facing cameras, or element-facing LIDAR/microwave antennas) or embedded sensors (e.g., piezo-electric, piezo-acoustic, acoustic, radio wave/microwave antennas). Where external sensors are used, a direct and automated visual measurement of the rebar configuration is made via computer vision models. Where embedded sensors are used, the presence, number, dimensions and orientation of the rebar is inferred from measurements of acoustic and electromagnetic transmissions, and the manner in which those transmissions reflect and refract off of the nearby structure. Quintessentially, the inference of complex rebar orientations via embedded sensors requires accurate signal-timing measurements, and the relative delay between transmitted and received signals allows for a real-time mapping of the 3D environment in the local region (analogous to echo-location, but which may or may not involve the use of electromagnetic radiation in lieu of acoustic waves).

Having outlined the above examples of how raw device sensor data may be used to infer various temporal or physical aspects of a structure under construction, it is important to explain the mapping procedure, which converts the above-mentioned inferences into parameters (categorized under the 5 parameter types, listed in subsection C.3 and C.5.1 herein), and whereby those parameters constitute the state of the building design and schedule being measured. This allows the models to reason about the parameters when generating new building designs.

The 5 parameter types that are ingested by the models are a unified format, created for the purposes of permitting multiple data sources, with multiple data types, to be ingested by the same model. For example, using the above-mentioned sensor measurements, a 3D spatio-temporal distribution of temperature within a concrete element may be generated. That distribution might be represented initially as a 3D grid of 1-dimensional temperature time-series. Using that information, an empirical or hybridized model may infer the likelihood of thermal cracking to occur at various positions throughout the concrete element. The likelihood of thermal cracking might also be stored as a 3D grid of time-series, with each time-series spatially located at the same positions as the temperature time-series from which those inferences derive. However, instead of temperature, these inferred time-series would be of probability, wherein they would track the predicted likelihood of a crack occurring at that location (between 0 and 100%) over time.

In the above example, the system may convert a binarized measurement at a single location (i.e., a measurement that a crack has or has not occurred) into a continuous probability measure over time. This illustrates the conversion of an insight (the binarized statement of crack occurrence) into a useful parameter for spatio-temporal modelling, and for the purposes of spatio-temporal mapping between other spatio-temporal measurements.

As such, it is important to note that all inferences stated previously are modified into their model-relevant form, wherein the example stated above with respect to thermal cracking illustrates the case where the ingestion parameters needed for a model that receives a grid of spatio-temporal 1-dimensional temperature time-series, and outputs a grid of spatio-temporal 1-dimensional probability time-series.

Consider the above-mentioned example, which involves the conversion of a 3D grid of temperature time-series into a 3D grid of thermal cracking probabilities. The creation of that conversion model involves first obtaining a dataset of temperature time-series, physical locations from which those time-series derived (from within the elements in question), and times and location at which any cracks occurred.

Once the above data has been received, it is possible to convert the binary thermal cracking measurement into a time-series of binary (i.e., 0 or 1) values over time: wherein the value of 0 is chosen at all times for which a crack did not occur at a given location, and the values of 1 is chosen at all times after which the crack occurs at that location.

The system may then utilize a machine learning model that is trained on the above time-series, such that the model is designed to generate a one-to-one mapping between the temperature time-series and the corresponding binary cracking time-series (stating when or where a crack may occur). The model would also ingest the spatial-location information of each temperature time-series, and may or may not ingest the geometric boundary conditions of the elements.

The output of this model may be direct (in that the output is not probabilistic). However, the models the system may use are often probabilistic in nature, wherein the system may use hybridized mixtures of artificial neural networks, Bayesian inference and Principal Component Analysis (for example), and where the objective functions would be of both “supervised” and “unsupervised” kinds, in this case.

Once the training procedure is complete, the system may obtain a model that is able to map a series of temperature measurements into a series probabilities, wherein those probabilities are of the likelihood that a crack will occur at any given time, conditioned upon temperatures, times and spatial locations. A conversion of this kind can be made to be temporally one-to-one (i.e., mapping temperature to probability at the same timestamps in the measured data) or may temporally asymmetric (i.e., mapping temperature at one set of times to probability at other, future times), such as in predictive models.

The above illustration of the manner by which the system may train inference conversion models, that map measured inference into model-ingestible parameter types, is extendable to all other forms of spatio-temporal measurements, and which derive from spatio-temporal device sensor measurements. The system may replace temperature and thermal cracking in the example above for other measures, such as impedance and measures of thermal expansion, or acoustic impedance and measures of material viscosity. This illustrative parameter-conversion method need not be constrained to temporal measurements but can also hold for measurements that are fixed over time, wherein the system may wish to generate mappings between spatio-temporal time-series and fixed geometric quantities, for example.

Each of the modes of usage for the pour design and sequencing models described herein are trained using data from multiple sources. However, each of those modes may be composed of multiple models within, wherein those models are connected by graph networks that encode the relative causal and probabilistic relationships between various input and output parameters. These modes can be described as automated decision systems.

In generating any of those automated decisions systems, the system may use historic device sensor data for two purposes: in order to characterize the expected pour design, layout and schedule for historical construction projects, and in order to classify the current state of a system (if sensor data is being received dynamically during construction) so as to modify any design, layout or schedule that has already been chosen.

There are various methods by which sensor data is used to generate pour designs and/or layouts and/or sequences (as described in detail in the 11 modes of usage). However, principally, the system may utilize unsupervised training methods and models in order to create real-world physico-chemical and causal understandings, and the system may utilize supervised training methods in order to create models that can predict, evaluate and recommend the design, layout and sequence of a future or ongoing construction.

Unsupervised methods are only one method by which the system may create generative models that are able to simulate random, but physically plausible iterations of structures and their respective sequences. As described previously, this involves using a large dataset of designs, measurements, and sequences, in order to discover the meaningful relationships between those multi-dimensional data points. For example, via the training of dimensional embeddings, the models can discover which events can never occur after another, and can represent that learned causality via its internal structural representation of the 5 parameter types.

However, it is not only unsupervised models that allow for the learning of real-world functional representations. Generative Adversarial Networks (GANs) are one example of a supervised learning technique that the system may also use to create meaningful, randomized structural designs of certain types and with causally valid schedules. In the example of training a GAN, the only supervised categories required are whether the pour design and/or layout and/schedule are real (i.e., from true historic data) or generated (i.e., from the GAN output itself). As the model is trained, it learns to better generate “real-world” examples of pour designs, layouts and schedules: whereby the meaning of “real-world” is dictated by the data the system may possess.

Through ingestion of the mode of usage and the relevant model parameters at input, the systems are able to receive relevant information from multiple sources, mixing together data from human data (e.g., documents) and non-human data (e.g., device sensor measurements).

Sensor data is converted into meaningful insights and are converted into the 5 modal input/output parameter types. Once those data are ingested, the system may train the individual models that comprise the nodes of the complex graph networks described herein. Those trained models are then reinserted into the graph network, and the graph connections are subsequently also trained, but on the end-to-end information from all inputs and outputs relevant to the entirety of a construction project taken from the training set. The learned model weights (at the graph nodes) and the learned graph weights, together define the system that can be executed to generate a pour design, layout and/or sequence.

Once these modes have been trained, the system may use the generative models (e.g., from learned GANs, or from learned randomized decision trees, or from learned randomized transformer networks) in order to produce representative data of the design-type or layout-type or schedule-type the system may desire. These generative models are typically built in a chain-based manner, such that the output from one model might be the input to another generative model.

For example, the system may have a generative model that is designed to generate a building design, wherein the model itself was trained to only output skyscrapers of certain heights and dimensions. The output parameters (which are the parameters that define the building design), are then fed into another generative model, that receives building design parameters as inputs, and outputs a pour layout and schedule (this second generative model having been trained to output typical pour layouts and schedules from historic data). The pour layout and schedule parameters may then be fed into a Mix Optimization system, wherein that system is trained to receive pour layouts and schedules and define the concrete mix designs that can achieve the required structural and temporal constraints (and any other constraints define by utility functions, such as a constraint on embodied carbon).

In general, the chain-like decision system described above is analogous in every sense to the chain-like decision systems described herein. However, in this case, the system is “randomly” generating structures. This means that, in this embodiment of the chain-like graph systems described above, the system may be able to randomly define some initial parameters (that are enforced to meet meaningful physico-chemical constraints) in order to obtain some structure, layout and schedule that satisfies those random parameters-generating a “random” building of a certain type, with a meaningful pour layout, sequence and schedule.

In another embodiment of the generative aspect of this invention, the system may not input random parameters, but input parameters that are predefined. However, the system may then adjust some subset, or all of those parameters in directions and manners dictated by either a human or an automated procedure, so as to investigate (again, by human perception or by an automated goodness criterion) the manner in which any such adjustment would improve the design, layout or schedule with respect to some concerns.

In the same manner that the modes of usage are defined by models that fix certain parameters and solve for others, the system may be able to define the usage of the randomized-generative and adjustment-generative for the purposes of creating automated decisions and recommendations about various aspects of the design, layout and schedule. Some non-exhaustive examples of modal decision categories are discussed herein.

For instance, pour scheduling may include a series of schedules are randomly generated for fixed concrete recipes, structural designs, pour layouts, and schedules, such that the goodness criterion is optimized against necessary constraints (e.g., minimizing heat generation due to concrete exothermicity and maximizing element volume).

In another instance, pour slicing may include a series of pour slices are randomly generated for fixed concrete recipes, structural designs, pour layouts and schedules, such that the goodness criterion is optimized against necessary constraints (e.g., minimizing load forces, structural failure and thermal expansion/shrinkage via joint placement).

In yet another instance, thermal management may include a series of concrete recipes, structural designs and pour layouts are generated for fixed schedules, optimizing for the thermal properties of the system, and solving for various constraints (e.g., minimizing thermal differentials for the purposes of minimizing risk of thermal cracking and expansion).

In yet another instance, rebar management may include a series of rebar configurations are chosen for a fixed structural design, pour layout and schedule, optimizing for thermal transport out of the element, and maximizing tensile strength.

Thus, in general, the system may possess multiple generative-type models that are able to fix subsets of parameters for the purposes of creating random structures and schedules and/or applying small adjustments to previously designed structures and schedules.

For those models that possess fixed parameters, and where those fixed parameters derive from device sensor data, the system may use device measurements as inputs to those fixed quantities. Those device measurements may be historic (in which the system would be generating representative structures, layouts and schedules that would be equivalent to a past construction project, but different in some ways). Or, those device measurements may be live (in which the system would be constantly updating the generative structure, layout and schedule as new sensor information arrives).

Training data may be synthetically simulated, for example using physico-chemical models (which may be empirical, or theoretical in nature). Training data may also be generated using a GAN, or network of GANs, or other generative models. These data can then be used to train the models, in which case the system may refer to this as simulation training. In particular, the use of a physico-chemical model to create synthetic training data allows us to infuse physical understanding into the models (which will lead to the adjustments of weights based on physico-chemical rules). Multiple versions of models may be trained based on different physico-chemical models, which may then be adaptively toggled by the model orchestrator.

Generative models (similar to those already comprehensively described herein and in the mix optimization and mix fingerprinting sections) may be employed to fill in missing data.

### Model Features

The various models described herein can take a combination of input parameters, depending on the mode in question. These input parameters may represent known values to be used directly by the model or may require further transformation to predict meaningful values (or ranges or values) which can be used to generate the output. For example, Mode 1, the Optimized Mix Designer, may rely on the ability to predict shrinkage (e.g., predicting the shrinkage of a mix with a given composition, predicting mix compositions whose shrinkage is below a certain threshold value, etc.), heat of hydration (e.g., predicting the heat of hydration for a mix with a given composition, predicting mix compositions whose heat of hydration is below a certain threshold value, etc.), coefficient of thermal expansion (e.g., predicting the coefficient of thermal expansion for a mix with a given composition, predicting mix compositions whose coefficient of thermal expansion is below a certain threshold value, etc.), tensile capacity (e.g., predicting the tensile capacity for a mix with a given composition, predicting mix compositions whose tensile capacity is above a certain threshold value, etc.).

In another example, Mode 2, the Optimized Rebar Designer, may rely on the ability to predict heat of hydration for a mix with a given composition, coefficient of thermal expansion for a mix with a given composition, tensile capacity for a mix with a given composition, quantity and layout of steel reinforcement required to limit crack widths below acceptable limits, and risk of cracking given the parameters above.

In another example, Mode 3, the Optimized Pour Sequence Designer, may rely on the ability to predict time required to complete each activity, labor and equipment required to complete each activity, shrinkage, heat of hydration, coefficient of thermal expansion & tensile capacity of concrete (as per Mode 1), rate of cooling/heat loss of each pour to its environment, in cases where the temperature of adjoining pours is critical (e.g., construction of raft slab foundations), thermal interactions between adjoining pours will be considered, and restraint from adjoining pours. Various risks may include equipment failure, supplier issues, labor availability, and weather (temperature and wind can both be limiting factors on executing a concrete pour).

In another example, Mode 4, the Optimized Mix & Pour Sequence Designer, may rely on the ability to predict, shrinkage, heat of hydration, coefficient of thermal expansion & tensile capacity of concrete (as per Mode 1), labor, equipment, time required to complete each activity, etc. (as per Mode 3), rate of cooling/heat loss of each pour to its environment, thermal interactions and restraint between adjoining pours.

In another example, Mode 5, the Optimized Rebar & Pour Sequence Designer, may rely on the ability to predict shrinkage, heat of hydration, coefficient of thermal expansion & tensile capacity of concrete with a given composition (as per Mode 1), quantity and layout of steel reinforcement required to limit crack widths below acceptable limits (as per Mode 2), and risk of cracking given the parameters above (as per Mode 3).

The models described herein may have the ability to evaluate structure designs/pour designs and sequences against a set of criteria and or requirements. For example, the models may be able to evaluate multiple structure designs relating to the same underlying project, on a criteria of embodied carbon, to determine which design contains the least embodied carbon, and select it as a suggestion to the user.

The models described herein may have the ability to recommend adjustments to given structure designs/pour designs and sequences, for the purpose of achieving a certain objective, for example in the form of one or more target structure properties e.g., targets on allowable cracks.

The models described herein may have the ability to generate one or more structure designs/pour designs and sequences as described herein.

The models described herein may consider whether the optimal design and/or sequencing can be generated through use of, or actuation of, available construction resources e.g., equipment during construction for example. This can include recommending the use of frost blankets or other insulating materials to retain heat within the curing element, or actuation of heaters (or steam curing chambers in precast facilities) to maintain an optimal temperature and relative humidity within the environment to achieve the required rate of strength gain. The cost of heating and embodied carbon can also be calculated and controlled. The equipment selection is defined as a part of the pour sequence operational space or a constraint such that the sequencing and timing contributes as output to the equipment scheduling.

Different versions of the models may exist, specialized for particular design use cases. For example, models may be specialized to specific structure/building types (e.g., different versions of the same models may be respectively specialized to design such as skyscrapers mid-size buildings, bridges, tunnels, roads, and/or other structure types).

### The Dynamical Phase PDS Models

In general, the methods described in Pour Design & Sequencing may be used before the project (also known as the ‘planning phase’), and whilst the project is in progress (also known as the ‘dynamical phase’ or the ‘execution phase’). During the planning phase, the models, including any of the PDS-X Models above, may use the techniques described herein to generate a recommended design for any output or combination of outputs listed herein. During the execution/dynamical phase, as construction progresses, real time data associated with the project's progress flow may be ingested by the dynamical phase models. This data may be collected from any of the data sources listed herein. One important source of data will be data from sensor device measurements-especially when used in tandem techniques described in the Status Inference and Context Awareness sections. Using this data, the dynamical phase PDS Models may be used to determine perturbations (to be defined within certain tolerances) from the initially generated design, determine the impact of said perturbations, generate insights and analytics, and/or recommend a new, optimized design (or adjust the existing one).

For every newly recommended design, the same procedure may be applied. In other words, if perturbations are determined with respect to this newly recommended design, another, newer design may be generated. This dynamical phase may therefore be iterative. The initially generated design in the planning phase may be referred to as iteration 0, whilst any subsequent design may be referred to as iteration i, where ‘i’ is the number of new iterations since the planning phase. In one embodiment, the following 4 models may be used for the dynamical phase: the PDS Perturbation Determination Engine (the processor described herein), the PDS Impact Engine (the processor described herein), the PDS Analytics Engine (the processor described herein), the PDS Recommendation Engine (the processor described herein). Inputs may include all input types outlined for the PDS-X Models, alongside any real-time data associated with the project, iteration i−1's outputs and perturbation tolerances. Outputs may include the following any output outlined above.

### The PDS Perturbation Determination Engine

The Perturbation Determination Engine (e.g., the processor described herein) may be used to determine the presence of a perturbation, where a perturbation may be described as any deviation from the design set out by the last iteration of the PDS-X Models. In general deviations may be defined within a perturbation tolerance (e.g., a change in 5% in the cross-sectional area of a given pour layout element may be chosen as the tolerance limit defining a perturbation in pour layout). The user may define their own perturbation tolerances. Inputs may include any inputs described above. Outputs may include Boolean yes/no (e.g., indicating whether a perturbation has occurred), and anomalous data (e.g., data showing the perturbation such as showing the deviation from the expected pour layout for).

### PDS Dynamical Analytics Engine

The Dynamical Analytics Engine (e.g., the processor described herein) may be used to generate insights and analytics for the user based on the real time state of the site. This includes analytics associated with the cause of the perturbation. In some embodiments, the inference engine from status inference may be used herein. Inputs may include any input described above as well as the outputs from the perturbation determination engine. Outputs may include the following as described above: dynamical analytics and inferred perturbation cause.

### PDS Perturbation Impact Engine (PDS-X)

The Perturbation Impact Engine (e.g., the processor described herein) may be used to determine the impact of the perturbation on the schedule and/or concrete cycle. In some embodiments, it may be possible to use the PDS-X models to determine this. Inputs may include any input described above as well as the outputs from the perturbation determination engine & outputs from the Dynamical Analytics Engine. Outputs may include the impact the perturbation will have on the project schedule (e.g., how is the perturbation reflected in the schedule, including how knock-on and dependency effects may affect the schedule).

### PDS Dynamical Recommendation Engine

The Recommendation Engine (e.g., the processor described herein) may be used to generate a recommendation of the i'th design iteration. In other embodiments, this may be newly generated, in others this may be an adjustment based on iteration i-1. In some embodiments, this recommendation engine may be equivalent to rerunning the PDS-X models, using the new real-time data collected. Inputs may include any input described above as well as the outputs from the perturbation determination engine, outputs from the Dynamical Analytics Engine and outputs from the dynamical analytics engine. Outputs may include the i'th iteration design, as described above.

### OTHER EMBODIMENTS

In one embodiment, the concrete cycle may be visualized spatially, as one or more side-views of the building structure, with different symbols representing key components or parts of the cycle (e.g., steelfixing, installation of formwork, falsework etc.).

In another embodiment, the models are used to slice a building design into constituent elements based on predetermined kits of parts (standardized 3d elements from a preexisting library e.g., standard column, standard raft). Optionally, the model may create a new element to be added to the library too. The sequence for the installation of the kit of parts is then determined. Generally, all models described herein can be generalized to structural progress flow of a precast concrete design.

In one embodiment, to achieve the design & sequencing methods described herein, one approach would be to use a “game and rules” based Machine Learning approach. In such an approach, one would define a “game” with certain tunable parameters and objectives. This game will have rules i.e., constraints which must be followed. One may then be able to unleash a Machine Learning algorithm, thoughtfully constructed for the purposes of the particular game, to find the most optimal solution to the game. In this paradigm, broadly speaking the game may include designing a construction project and sequence its pours, objectives (i.e., optimization objectives) that may include minimizing carbon emissions, tunable parameters (i.e., building blocks) that may include concrete mix, and rules (i.e., constraints) that may include, for example, if the building collapses, the game is lost.

It is possible to map out the specific implementations of Pour Design and Sequencing by considering the tunable parameters. Any such parameter may be an input, or an output of this method. As inputs, these parameters stay constant (e.g., concrete mix(es) are known/predefined, and the method designs and sequences the project on that basis). As outputs, these parameters are unknowns that need to be solved for. They are variable and their optimal value is sought and outputted by the method. The general inputs and data types listed herein may be fed to these ‘game solver’ models to achieve this approach. The outputs described herein may also be the outputs of these models.

### Pour Design And Sequencing Flowcharts

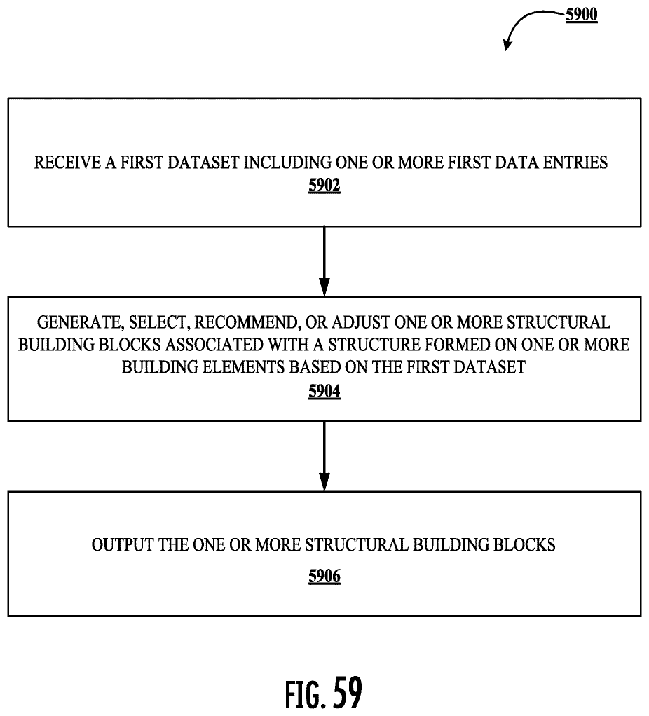

FIG. 59 illustrates a flowchart containing a series of operations for an example method for pour design and sequencing operations (e.g., method 5900). The operations illustrated in FIG. 59 may, for example, be performed by, with the assistance of, and/or under the control of an apparatus (e.g., server 200), as described above. In this regard, performance of the operations may invoke one or more of processor 202, memory 206, communication interface 204, and/or machine learning (ML) module 208.

As shown in operation 5902, the apparatus (e.g., server 200) includes means, such as processor 202, or the like, for receiving a first dataset including one or more first data entries. As described herein, the first dataset may include data associated with any of the data types described herein. By way of a non-limiting example, the first dataset received at operation 5902 may include various data entries associated with the planning and/or scheduling or pour designs that form a structure. The present disclosure contemplates that the first dataset may be received from a user, a sensor device, and/or any of the devices, models etc. described herein without limitation.

As shown in operation 5902, the apparatus (e.g., server 200) includes means, such as processor 202, or the like, for generating, selecting, recommending, or adjusting one or more structural building blocks associated with a structure formed on one or more building elements based on the first dataset. As described above, the pour design and sequencing techniques described herein may leverage various modes in order to provide an optimized layout of concrete pours to form a structure (e.g., structural building blocks) that may account for the various variables implicating concrete pours. Furthermore, operation 5902 may leverage any of the modes or models described above with reference to Pour Design and Sequencing (PDS) in order to generate, select, recommend, and/or adjust these structural building blocks. At operation 5906, the apparatus (e.g., server 200) includes means, such as processor 202, or the like, for outputting the one or more structural building blocks, such as via presenting the blocks to a user, supplying the blocks to a further machine learning model, and/or the like.

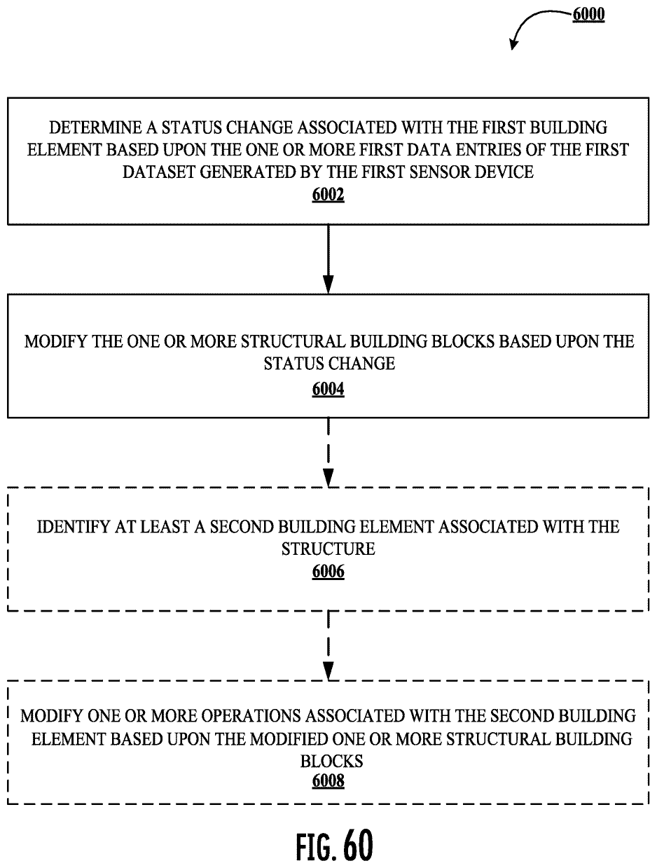

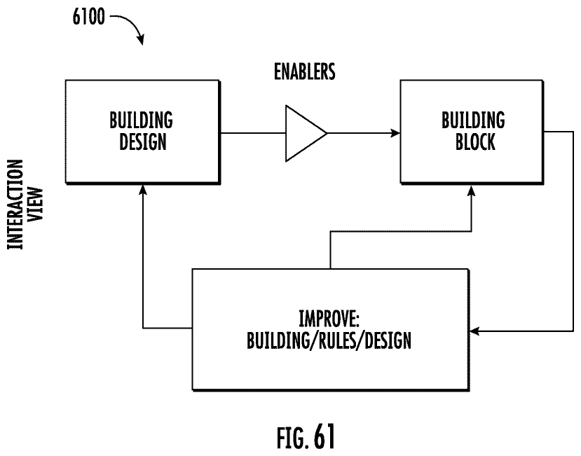

FIG. 60 illustrates a flowchart containing a series of operations for modifying structural building blocks (e.g., method 6000). The operations illustrated in FIG. 60 may, for example, be performed by, with the assistance of, and/or under the control of an apparatus (e.g., server 200), as described above. In this regard, performance of the operations may invoke one or more of processor 202, memory 206, communication interface 204, and/or machine learning (ML) module 208.

As shown in operations 6002 and 6004, the apparatus (e.g., server 200) includes means, such as processor 202, or the like, for determining a status change associated with the first building elements based on the first data entries of the first dataset generated by a first sensor device and modifying the one or more structural building blocks based on the status change. As would be evident to one of ordinary skill in the art in light of the present disclosure, the status (see status inference described herein) for various construction site resources may change in time. As such, the system 100 may, via an analysis of sensor data for example, determine a status change that implicates a building element that forms a structure. For example, a change in environmental conditions may be determined based on the sensor data. As such, the system 100 may operate to accommodate this change in contextual conditions by modifying the structural building blocks used to design the pour layout of the structure. The present disclosure contemplates that any change in material property may result in a modification to the structural building blocks described herein without limitation.

As shown in operations 6006 and 6008, the apparatus (e.g., server 200) includes means, such as processor 202, or the like, for identifying at least a second building element associated with the structure and modifying operations associated with the second building elements based on the modified one or more structural building blocks. As would be evident to one of ordinary skill in the art in light of the present disclosure, a change in contextual condition or material property for one building element (e.g., a first building element) may impact the performance (e.g., contextual material property or the like) for other building elements (e.g., a second building element). As such, various operations (e.g., pour design, pour time, pour geometry, etc.) that are associated with the dependent building elements (e.g. an example second building element) may be modified to account for these changes associated with the first building element. The present disclosure contemplates that any relationship between building elements may be accounted for by the systems and methods of the present disclosure such that the pour design and sequencing operations described herein may be applicable to structure of any configuration, pour layout, etc. without limitation.

### Status Inference

Construction is a complex process involving many interdependent parties, elements, and systems; all interacting within a dynamic environment, and for the purpose of completing a given project. This high level of complexity makes it difficult to track the progress (e.g., construction status) of a project across a construction site. Executives, management staff and field operatives/engineers often forget and/or omit status progress reports and, even when such reports are created, they are often incomplete. Project cycle times are thus hard to accurately track, given typically poor data collection and/or linkage procedures. As a result, operational and/or scheduling improvements (e.g., structural progress flow), whether pre-planned, before construction, or dynamic, at the construction stage, cannot be optimized with current manual systems. As such, the system described herein outlines a system to automatically detect the status (e.g., construction status) of different temporal stages and physical locations within the construction process; automatically placing them within the context of the broader project schedule and/or process and providing actionable insights to both HQ-level executives, management staff and/or field operatives/engineers.

The system 100 described herein solves the problem of tracking the progress of a construction project. Currently, progress-tracking relies on data gathered through manual human input. It is assumed that those inputs are logged correctly (without any error), promptly and consistently over time. In practice, this is not the case, and construction sites struggle to create an accurate, holistic and complete data representation of a project as it evolves over time. By implementing automated data gathering systems and algorithmic analysis into the project pipeline, the system described herein may execute the above progress-tracking intelligence automatically: providing immediate value to multiple stakeholders within the construction industry.

This value is delivered as actionable insights at different levels of abstraction across a construction project. For example, a proposed level-structure, may include Level 5—Higher level procedure (e.g. the work for the 3rd floor is complete); Level 4—Procedure, or the set of exhaustive actions that constitute a procedure (e.g. unit 12345 was installed); Level 3—Sets of discrete actions that constitute a partial description of a wider procedure, e.g. part of procedure X has been carried out (e.g. unit was picked up/landed, unit spent X minutes on the crane hook, unit was relocated by crane at Y time); Level 2—Uniform step of procedure/Discrete Action (e.g. unit is being lifted, or lowered); Level 1—Time series features (e.g. variance of signal over time); Level 0—Raw data samples (e.g. acceleration, RSSI, etc.). Each level may constitute a hierarchical representation of the project progress.

The system described herein then leverages a database of sensor data and ingests that data into the status inference model in order to predict the progress and/or completion of future statuses (e.g., for the same project, or a future project given a set of inputs/constraints). These predictions can be composed to output recommendations and forecasts, and the causal dependencies and critical paths across the project can be extracted by the system.

Human input can be unreliable, costly, or altogether non-existent. This is why an automated system has been devised in order to inform the project-planning process, and in order to verify relevant information with provably accurate and up-to-date data, acquired via minimal cost and delay.

The system described herein may include an artificial intelligence (AI) model (trained on vast amounts of that data) will supplement the automated data-gathering process with automated causal and logical insights by utilizing simulated predictions on project progress, and by providing accurate insights about the cause of any current or predicted delays. The construction industry is notoriously inefficient at planning, and a large majority of projects are late. This innovation has the potential to help significantly with that systemic industry issue.

The system described herein aims to augment or replace the current human data-input procedures on a construction site and/or throughout a construction project for construction status identifiers determination. Further, the system aims to automate the generation of project progress reports & infer analytics/insights.

When considering augmenting human data-gathering processing for status determination, the system described herein may operate to partially or entirely replace human input for determination of construction statuses. In the case of partial replacement, the system described herein may suggest data to be added to the project database; where that suggestion is made to a field operative via a pre-approved digital interface/platform. The suggested updates would be approved by the operative, if correct. If approved, they would be added to the database. Once data has been added, the system described herein may automatically reschedule activities in response to any inferred actions and/or procedures and their progress. Over time, when enough historical data is gathered, this target instantiation of the system described herein will be an AI engine (e.g., the processor described herein) that is trained to generate relevant status queries for a given project (e.g. based on the type of project), and automatically generate the answers to those statuses.

When considering automating the generation of progress reports and inferring analytics and/or insights, the AI model will use the bottom level-statuses to infer higher-level status progression and will eventually build an understanding of the causal links between statuses in the project. Ultimately, this model may be able to undertake productivity analysis, and generate tentative schedules for the construction site based on status data and predictions. The model will also automatically generate progress reports based on the insights inferred by the model. The automatic and immediate nature of the construction status inference system saves time and effort, speeding up the process of getting vital project insights.

### Detailed Status Inference

Statuses on site may in one embodiment be considered as a tree diagram with different levels. A status at one level of the tree can be assessed as an aggregation of the statuses of the lower levels of the tree (e.g. are floors 1 through N complete?→can be used to determine the percentage of the tower that is complete). In general, statuses may be considered as a graph structure which may or may not have layers to represent hierarchies, where edges may denote dependency. This graph may in general be unique for a given project.

Statuses can be inferred for any construction site resource, which may include materials (e.g. concrete pour), people, tools (from small tools such as drills to large tools such as the crane or other plant/machinery), and the environment the site is embedded in. Finally a status may relate to a composition of those core constituents (e.g., a floor, which is physically made and delineated by building material in space, with involvement of people and tools and embedded in a particular environment).

Status inference can be done on the basis of a variety of input data (described further herein) including sensor data (which includes any of the sensor embodiments described in the system described herein), and/or generally any data type described gathered from any data source described herein. Different models (which may be based on machine learning or AI, or regression or otherwise) may be developed or trained for different status types (on the basis of the expected features and signals that would allow detection of such a status). Toggling across models will be done automatically by the system (depending on data volume, status type, sensor data type). The model may output a confidence interval or uncertainty in its determination of the status, which can be confirmed or rejected by a user.

In one embodiment, the system may define the entire building project into 4 levels (these are illustrative and chosen for clarity. Generally this may be project specific). The Top-most (or 3rd level) is the Project Type (e.g. High Rise Buildings, Bridge, Railway station, Area Development projects), the 2nd level splits the project into sections, phases or individual towers (in this case, the project is for multiple tower blocks). The 1st level is associated with the subsection (e.g. floors, car park levels, chainage for bridges/railways). The “atomic unit” is the zeroth level, which consists of the elements that compose the subsection: columns, pillars, walls, slabs etc.

The zeroth-level element status check is an ordered list of status checks, where the status IDs are as listed. The element is ‘complete’ only when the last status is complete (implicitly since all prior status must be complete for the last status to be assessed). The subsection is complete when all elements are deemed ‘complete’. The section is complete when all subsections are checked. The project is complete when all sections are complete.

Thus status checks proceed element-wise. The completion status delivers stage-wise checks where every level is composed of all entities associated with the prior level.

The logical progression for construction evolution is bottom-up (elements completed before floors, before buildings before project). The logical progression for troubleshooting is top-down. The Planning/Scheduling phase of the project will deliver timelines, each status will have a completion time. The reference against the plan can be used to interrogate where the delays originated.

This system can be used to track the embodied carbon across the different levels of the tree (i.e. embodied carbon in pour→sum that to get embodied carbon in floor→sum that to get embodied carbon in building; with offsite manufacturing it is very likely that some carbon overhead in moving from one part of the tree to another (i.e. logistical carbon overhead).

In addition, the same grouping can be enhanced by highlighting the presence or absence of hard or soft dependencies, which present as an obstacle for beginning the next phase of construction (e.g. electrical and plumbing usually takes place after the floor above has been started, meaning that electrical and plumbing tasks do not block structural construction to progress).

One embodiment of this idea will match these statuses to the schedule of the construction project, such that users are able to assess their progress over different parts of the project as well as the entire project. Statuses can be used to compute productivity rates, which provide an automated retrospective analysis of how long different activities take. Such productivity insights can aid in planning future projects. These status inferences may also feed into S curves/progress curves, and project management dashboards to augment planning and execution of projects.

Given the known relationship between statuses (e.g. floor 1 comes before floor 2, or chainage), one may even generate a construction schedule/status schedule. Stress tests and scenario analyses may be conducted on such a schedule to account for variance in schedule. Such an instantiation of the idea would most likely include two way integration with a scheduling tool. Further, the system may be able to generate action recommendations on the basis of the critical path chains in the set of statuses.

This could be done prior to project start (as a planning tool), and may be used by contractors to generate a potential schedule and generate productivity analyses for these schedules at the tendering phase. This could also be done mid-project (perturbative status prediction, based on changes in the real world).

It is useful to note that many statuses will be interdependent on each other, or will require one to be completed before the other. Therefore, one embodiment of this system would perform critical path analysis on the space of statuses, to determine which statuses fall on the critical path. Based on this, the causal relationships between various statuses can be extracted, and an AI model can be trained to understand these. This can be used in the description of scheduling above, to generate pour schedules. Status inferences could therefore also be integrated as an augmentation for the Pour Design & Sequencing System.

There are a plurality of possible user interfaces to interact with this status inference system. In one embodiment, notifications are sent to a user's personal device. In another, a status is communicated through a large language model (or other) via a conversational interface. Status predictions may be visualized in any number of days (including as an expected schedule in time, or as a video with a spatial visualization of progress and so on).

Below is an illustrative list of relevant statuses, alongside details surrounding how to infer those statuses and signal processing. The following statuses are illustrative only, and not exhaustive. They are at the level of abstraction of a concrete pour. Similar constructs can be put together for higher levels of abstraction (which are described herein) or for other types of materials/objects/resources on the basis of the same disclosed concepts & system (e.g., status inference of floor completion, rather than pour completion).

In situ construction depends on the timely arrival of materials such as fresh concrete (e.g., construction site resource). In order for teams to be alerted when fresh concrete is about to arrive, or has arrived, the status (e.g., construction status) can be inferred or otherwise determined using one or more of the approaches below.

GPS-enabled tracker on the concrete delivery truck (e.g., construction site resource), wirelessly connected to the sensors on, or in, the concrete drum of the truck. A routing algorithm calculates the expected arrival time, and the window of time remaining until the concrete is no longer workable. The algorithm triggers an alert system, informing the relevant operatives to be ready, so as to minimize risk of missing that time window.

From a hardware point of view, the sensors in and/or on the drum and/or chassis will contain triaxial accelerometers, magnetometers and gyroscopes, in order to measure relative movements between the drum and truck chassis, as well as relative movements between concrete and the drum (in order to ascertain the viscosity of the concrete given the drum rotation).

Additional sensor to monitor the power or current driving the rotation of the drum motor. The power/current acts as a proxy measure for the viscosity and mass of the concrete, where increased power/current is proportional to increased viscosity or loads. Power/current measurements allow the system to ascertain the load and viscosity of concrete, even as the concrete moves within the drum, and as the truck goes over road bumps or takes turns.

Given the above information, the site team will be given an estimate of workability and expected time after which the workability will be degraded, so as to allow for informed planning of site activities and resourcing trade-offs.

The above system can be complemented with cameras and/or LIDAR; directed both at the drum from the outside of the truck (e.g., at the site entrance) so as to detect the truck's arrival.

Given BIM information, the system will be able to account for the time required to carry out preparation of the piping and pumping of concrete, depending on the distance and elevation of the pour relative to the truck pit lane.

If the truck's position on arrival is not at the expected location, this anomaly will be flagged, so as to minimize inefficient working methods. The system will generate multiple timestamps, along with labels describing both the expected and actual events (e.g. truck arrives, workability degradation below required specifications, operative presented with the scheduled and actual start and end times for truck discharge, allowing project manager to evaluate performance against the planned work).

Information and signals will be evaluated in a coherent way within the time-domain, meaning that simultaneous events will be made available to the inference algorithm, so as to feed it with all relevant complementary information in order to achieve the highest possible sensitivity and specificity. Signal processing methods would include: Denoising via oversampling for super-resolution; Low-pass, High-pass, notch and/or band-pass filtering so as to retain the frequency components (in time domain for time series data and in 2D space for images) so as to keep the information while attenuating noise and artefacts; Principal Component Analysis and extraction; and/or voltage-current phase analysis against drum rotations to monitor torque required, drum inertia and momentum. The same is done at various levels of drum fullness so as to extract the baseline of an empty drum and the ceiling of a drum at full capacity given that the contents will have an impact on driving energy required.

Additional localization techniques such as electromagnetic trilateration with nearby sources such as cellular network towers, Wi-Fᵢ access points as well as personal devices.

The ability to communicate to an internet connected device so as to be able to upload the data to other systems for further processing or insight communication. This can be achieved by various cellular connectivity standards, LoRa, SigFox, Wi-Fi, Bluetooth (Low Energy or classic) and more.

In some embodiments, the system may determine the concrete (e.g., construction site resource) was within its specified time window between batching and deliver or placement. Concrete will remain in its fresh state for a period of time, before it sets into its hardened state and begins developing compressive strength. The concrete specification will stipulate an upper limit on the time between mixing and delivery and/or placement of the material to site (or precast factory where appropriate). As such, concrete will lose workability with time and become stiffer and harder to place & compact. Placing the fresh concrete too late can lead to inadequate compaction and compromise the quality of the finished unit. Inputs include GPS on trucks, and/or batching records from supplier, and/or delivery note, and/or sensor data gathered at the plant or within the pour itself, and/or other event timestamp and labels on sensors' time-series data, and/or cameras/LIDAR. Outputs may include: Complete: Y/N, On Time: Y/N and time delta vs. schedule; Event labels obtained from ID1 analysis of status the status of the above insight; Arrival status: Binary, On time status: Compare with Schedule as well as time drift to forecast overall project delivery.

In some embodiments, the concrete may be delivered and placed within specified temperatures limits (between 5 and 40 degrees Celsius). Placement temperature limits are often specified in the concrete specification (or by local standards or building codes). Quality issues can occur when the material is too cool or warm during placement. This can apply to the ambient air temperature or the temperature of the material at time of delivery or placement. Such limits also apply to the use of concrete in a precast factory. In warm countries the use of ice is common during the batching of the material to keep the temperature of the material below the upper limit. Conversely, in cool countries the water used to batch the material is heated. Inputs include data from temperature sensors in the pour (and/or situated in open air at the site) or from a weather service API, specifications (which may be parsed using NLP to extract features of interest). Sensors can also be used at the point of concrete production (i.e. batching plant or precast factory) to trace the temperature of materials prior to delivery.

In some embodiments, outputs may include: Is within specified temperature limits: Y/N (derived from comparison of Temp. range with specification); delivery timestamp; Identifying information regarding the specific delivery and unit(s) to be cast with that material. De-noise the signal by removing any undesired frequency bands, spurious response, saturation events and using the know mechanical or chemical origin of the signal, being able to ascertain what would be caused by the material, chemistry or reaction that we're looking to track, Temperature range (min/max levels extracted), location inferred from local specification.

In some embodiments, the system may determine that the concrete satisfies the on-site tests. Tests are performed on fresh concrete deliveries (using random samples) to ensure that its properties are in-line with the concrete specification and local standards. Specifically, the specification will stipulate the required workability of the material before placement, which is tested using a slump or flow-table test on site (or in the precast factory). These tests are broadly referred to as on-site identity tests and are contractually required for acceptance of the material. If the material conforms to the expected workability range (as per the specified test method) the delivery is accepted, and this information is recorded in the site's QA documentation. Sensor measurements from within the truck itself can also be used to infer the workability of the material over time during transit. For example, by measuring the shear resistance of the fresh material in relation to the rotational speed of the drum. Once denoised, this data can be referenced to a calibration model mapping viscosity (or shear resistance) to workability. Analysis of sensor based measurements, as well as ingesting the results of manually performed tests will allow real-time assessment of the material during the production, transit and placement.

In some embodiments, outputs may include: Is within specified limits of the workability range as per agreed test method: Y/N (derived from comparison of the slump or flow-table result against the specification); delivery timestamp; and identifying information regarding the specific delivery and unit(s) to be cast with that material.

In some embodiments, the system may determine that fresh concrete has been placed in the formwork. As stated, the specification places limits on the time between batching and placement of the material. The concrete has sufficient workability to be effectively compacted within the formwork. This applies to the use of concrete on-site or in a precast factory. External camera(s), and/or LIDAR and/or sensor(s) embedded within the formwork can be used to detect whether the concrete has been placed and sufficiently compacted. Various techniques process and interpret the data; such as image denoising and subsequent classification using a CNN. The model can be trained for the specific mix of concrete; mix design parameters such as cement type influence the exothermicity of the concrete, which the model can use to verify the correct material has been used, and the properties are within specified limits. Other methods, such as formwork detection and/or any solution proposed in the ‘sensor self-awareness’ section, can also be applied to detect and verify conditions at the time of the pour. Contextual data (such as timings, drawings, dimensions, etc.) can be obtained from the BIM model and schedule. Concrete placement is not instantaneous and pouring takes time. Measurements are all recorded as time series to track the development of the pour over time, allowing inferences such as the percentage completion of the pour. Where multiple concrete deliveries are used in the construction of a single element, the time of each delivery is recorded so measurements taken within the element can be associated with the specific delivery.

In some embodiments, outputs may include: Concrete placement start time & end time: duration of pour; complete (Y/N); on time (Y/N); Progression of the pour (derived from time series data for sensors); and identifying information regarding the unit(s) being poured and the individual deliveries used to construct it.

In addition to the above items, further status questions (e.g., construction status) can have their answers inferred using similar techniques and sensors: Has the pouring process been completed? Has the concrete been covered with thermal blankets or a curing membrane (if appropriate)? Has the concrete gained sufficient strength for formwork removal? Has the formwork been removed? Has the concrete gained sufficient strength for any other strength-related activities (may include application of tensioning/stressing; or other temporary works activities such as lifting a jump formwork, or removing backpropping)? Has concrete attained its design strength?

The concrete sensor's automatic evaluation of its location, and of the maturity progress, assists in identifying the status of the concreting cycle at the pour level. In addition, the embedded and non-embedded sensors and/or gateways are able to detect the presence, or lack thereof, of tools, plant machinery and people (e.g. via their portable electronic devices). As such, it is possible to know when the concrete was ready to strike, when it was struck and how long it took for the next team to begin working on the next phase of construction. In addition, comparing differences between the time at which a status was met (e.g. concrete is ready to strike) and the time at which an action was taken (e.g. concrete has been struck) is in itself useful data to be tracked and/or used as part of an automated inference. This is highly valuable as a measure on how effective or actionable the provided insight/status was, which will allow for the generation of more relevant insight.

### Hierarchy of Status Inference

At the highest level of the hierarchy, one can infer a status across a portfolio of projects—each project being associated with a status of “is the project complete or not?” Productivity rates can be averaged across many project statuses, normalized for various contexts and then used for planning future projects. This allows the contractor to track progress across their numerous projects. In addition, given the tree-like structure of this hierarchy, higher level inferences can be represented as sums of the lower level inferences (e.g. if 8 floors out of 12 are ready, the tower is approximately 67% ready). This can also be applied at the level of the project portfolio, such that each project has an associated “completion percentage”. This will allow contractors to plan, not only within a project, but across the portfolio. It is important to note that this percentage/fractional element-wise framework is, in all likelihood, a simplification-a construction project's progress is not linear in time (e.g., the same type of status may take a different amount of time to complete). This will be reflected in scheduling. Therefore, one may be able to use schedule data to provide a more accurate “percentage completion” metric than the more simplistic, linear metric described above. Going one step further, this assumes that percentage is a reflection of progress with respect to time to completion. One may envisage an instantiation where the status progress reflects something other than completion time (e.g., volume of project which has been completed, or the embodied carbon). Some projects have multiple discrete units. These may be concurrent or sequential. It is possible to divide the project up into different logical sections. For example, high-rise project with Tower 1 & Tower 2; Civils project with multiple concurrent areas or workfronts (Section 1A & Section 1B); Development project with multiple phases (Phase 1 & Phase 2).

Within a single section, there may be ways to further subdivide the structure. For example, by floor numbers on a building (Level 4 & Level 5; by chainage in a road or rail project (can be expressed as numbers, e.g., 44-48). This can then generally be subdivided further into elements, such as cores (North core & South core), Slabs (North slab & South slab), Walls (Wall F & Wall G), Columns (Column R & Column S), or the like.

These elements can then be subdivided into activities (activities should be reasonably repeatable between each element of the same type, forming a cycle in many cases), such as prepare formwork, assemble/fix steel reinforcement, pre-inspection, pour concrete into formwork, compact concrete, wait for sufficient strength gain to strike formwork, remove formwork.

The above examples focus on in-situ concrete usage, but in many cases a structure can be built using other construction methods (pre-cast; timber; brick & mortar; etc.).

In any case there should still be logical ‘Sections’, or collections of structural elements, and activities required to construct each section. It is possible to infer the completion of a ‘Section’ or collection of elements when each individual activity is complete.

The system described herein may infer or find out something outside of the regular “Not started”, “In progress”, “Complete” statuses. In particular highlighting any issues with a given element, section, activity, process, etc. For example, a “missing” status may be inferred with a certain degree of likelihood based on related statuses (for example, if floor 2 is complete, but no status is registered for floor 1, it is most certain that floor 1 is also complete but just missing a status inference). Expanding upon this, a user feedback loop can be implemented, in which, if a status has been initially missed, and later manually reported by a user, a retrospective analysis of the data would refine the model's representation of the project progress. This user feedback loop may be from a planner in a scheduling tool that is linked into the status inference engine (e.g., the processor described herein). The system may predict statuses altogether. This may be implemented using an AI engine that predicts statuses based on prior status data, and target context (e.g. including BIM model).

### Status Prediction and Composition

A model based or trained on pre-existing data, optionally where that data is sensor data (including from sensor devices that meet all of the embodiments described herein) collected from sites alongside labels for statuses, and any data type (e.g. context awareness data), extracted from any data source listed herein (such as geometry data extracted from BIM models) may be used to predict statuses. The input data would require associated data type or context awareness data (related to the specifics of the construction project). Different models may be trained to predict different statuses, and the system may toggle across them.

This model may be trained to predict the completion of an activity once that activity has already begun (so with initial ‘live’ data from that activity. This model may also be trained on historical data, and used prior to the commencement of the activity to which a status relates. The hierarchy of statuses, and the causal links between them, will be determined by this model (determination may be manual or input by a user, or automated through for example a machine learning algorithm). Multiple instantiations of the model (specific to different types of statuses) may be composed to generate a series of milestones/a composition of statuses that build up a predicted construction schedule. Adjustments to an existing construction schedule (optionally through an integration) may be proposed or generated automatically by the model and its status predictions, in effect detecting the impact of a real-world change on the construction schedule. Optimization functions may be applied to this space to come up with different scenarios and for the system to ultimately make recommendations about specific actions to be taken by the user/contractor.

### Example Status Inferences

In some embodiments, the status description may be associated with the delivery of the fresh concrete (e.g., a cementitious mixture) to a delivery site or other location. In such an embodiment, one or more sensor devices (e.g., accelerometer(s) on the truck and/or drum, a self-aware or location sensor, cameras, LIDAR sensors, etc.) may be used to determine if the delivery has occurred. An inference status for such a status identifier may provide an event timestamp and label (e.g., a yes/no designator), and various signal process techniques (e.g., denoising, PCA on Accelerometer, dominant principal component (PC) selected for analysis, Location sensor (GPS) based path, and/or location inference using techniques such as RF trilateration) may be used to determine the inferred status. Various algorithms (e.g., movement start/end pattern identification (classifier), location confirmation with self-aware and location sensor & BIM, project level location data, etc.) may also be in the generation of this status identifier.

In some embodiments, the status description may be associated with ensuring that concrete is delivered within a specified time window between batching and delivery or placement. In such embodiments, one or more sensor devices (e.g., timestamp and label sensors on time-series data, cameras, LIDAR sensors, etc.) may be employed. The inference status may indicate completion and timeliness (e.g., a yes/no designator, time delta vs. schedule). Various signal processing techniques (e.g., analysis of status ID1 data) and algorithms (e.g., arrival status binary analysis, schedule comparison) may be used in the generation of this status identifier.

In some embodiments, the status description is related to monitoring concrete temperature during delivery and placement, ensuring it remains within specified limits (e.g., greater than 5 degrees Celsius or less than 30 degrees Celsius). Sensor devices such as temperature sensors and weather service APIs may be used. The inference status may indicate whether the concrete is within specification (e.g., yes/no, temperature range analysis). Signal processing may include techniques like denoising and temperature range extraction, while the algorithm may involve comparing the temperature range against local specifications.

In some embodiments, the status description may concern on-site identity tests of concrete, like slump or flow-table tests, which may involve the use of viscosity sensors. The inference status could provide data on whether the concrete meets specifications (e.g., yes/no, mean slump comparison). Signal processing may include denoising and reference calibration models, with algorithms comparing viscosity-related data against local acceptable limits.

In some embodiments, this status description may track whether fresh concrete (e.g., construction site resource) has been placed in the formwork. Sensor devices such as external cameras, LIDAR, or embedded sensors may be used. The inference status could indicate completion and timeliness (e.g., yes/no, comparison with schedule), using signal processing techniques like image denoising and CNN image classifiers trained for detecting cement and formwork.

In some embodiments, the status description may be linked to the completion of the concrete pouring process. This may involve the use of cameras, LIDAR, and self-detection sensors (e.g., pressure/load cells). The inference status might provide data on completion and timeliness (e.g., yes/no, schedule comparison), with signal processing including image and video denoising and classifier training for pour detection.

In some embodiments, the status description may focus on whether concrete has been covered with thermal blankets or curing membranes. Sensor devices like cameras, LIDAR, and self-detection sensors could be employed. The inference status might indicate completion (e.g., yes/no, spec/schedule comparison), using signal processing techniques like denoising and signal level analysis.

In some embodiments, the status description may relate to assessing if the concrete has gained sufficient strength for formwork removal, which may involve multivariate sensing techniques. The inference status could provide data on whether the concrete meets required strength specifications (e.g., yes/no, strength comparison), with signal processing using mix fingerprinting and enhanced material method-based tools.

In some embodiments, this status description may be used to confirm if formwork has been removed. Sensor devices might include cameras, LIDAR, and self-detection sensors. The inference status could indicate completion (e.g., yes/no), using signal processing like image denoising and CNN image classifiers trained for formwork removal detection.

In some embodiments, the status description may determine if concrete has gained sufficient strength for various construction activities, which may involve multivariate sensing. The inference status may provide data on completion (e.g., yes/no, strength estimate comparison with specifications), using signal processing techniques like mix fingerprinting and enhanced material methods.

In some embodiments, the status description may focus on whether the concrete has reached its design strength using multivariate sensing. The inference status could indicate completion (e.g., yes/no), with signal processing using mix fingerprinting and enhanced material method-based tools, and algorithms for strength achievement classification.

In some embodiments, the status description may verify if the correct concrete recipe has been employed, applying multivariate sensing. The inference status might provide data on whether the concrete is within specifications (e.g., yes/no, recipe comparison), using signal processing techniques like mix fingerprinting and enhanced material methods.

In some embodiments, the status description may relate to confirming if concrete has been adequately compacted. In such an embodiment, sensor devices may include multivariate sensing tools. The inference status could indicate completion (e.g., yes/no, density and surface finish comparison), with signal processing using mix fingerprinting, wave-based sensing, and context awareness.

In some embodiments, the status description may be concerned with confirming if rebar has been fixed. Sensor devices may include cameras, LIDAR, and various hardware devices. The inference status might provide data on completion (e.g., yes/no), using signal processing techniques like context-aware processing and CNN image classifiers trained for rebar fixing detection.

In some embodiments, the status description may involve determining if the concrete pour is complete. Sensor devices such as multivariate sensor devices, which could be embedded, directed at, or mounted on the site (using techniques like fingerprinting and context awareness), are employed. Reference documents like specifications, BIM, and schedules are considered. The inference status indicates completion (e.g., yes/no, timestamp). Signal processing might include mix fingerprinting, enhanced material method-based signal processing, context awareness, and image denoising with CNN image classifiers. The algorithms check if rebar has been fixed, formwork and props removed, and if the concrete has reached design strength.

In some embodiments, the status description may focus on the completion of a floor. This could involve multivariate sensor devices with similar deployment as mentioned above. The system aggregates lower-level statuses to determine floor completion (e.g., yes/no, timestamp). The algorithm performs an element-wise check to confirm that every pour on the floor is complete, resulting in a binary output.

In some embodiments, this status description could be associated with the completion of piles. In such an embodiment, the system may use multivariate sensor devices, and consider the specification, BIM, and schedule documents. The inference status indicates whether the piles are complete (e.g., yes/no, timestamp). The signal processing aggregates lower-level statuses, and the algorithm checks if piles have been installed and reached design strength, providing a binary output.

In some embodiments, the status description may include the completion of the substructure. In such an embodiment, the system may use multivariate sensor devices and considers reference documents for guidance. The inference status provides a completion indicator (e.g., yes/no, timestamp). The process involves aggregating lower-level statuses and performing an element-wise check to ensure every pour in the substructure is complete, leading to a binary output.

In some embodiments, the status description might relate to the completion of the superstructure. This may involve the use of multivariate sensor devices. The inference status, considering specification, BIM, and schedule, indicates completion (e.g., yes/no, timestamp). The process aggregates lower-level statuses and performs checks on every pour and every floor in the superstructure for completion, resulting in a binary output.

In some embodiments, this status description may be used to confirm the completion of a specific section of the project. Such an embodiment may use multivariate sensor devices. The inference status could be based on either any of the signal processing methods described previously or an aggregation of lower-level statuses (e.g., yes/no, timestamp). The algorithm may conduct an element-wise check to ensure every subsection within the section has been completed, providing a binary output.

In some embodiments, the status description may relate to determining whether a device, including any sensor device mentioned herein, has been activated. This could involve any device or sensor on the Sensor Digital Platform. The inference status indicates whether the device is active (e.g., yes/no, timestamp). The logic here refers to the Sensor Digital Platform, where a timestamp and digital identifier reveal the device's activation status. This applies to all activation types (e.g., via mobile device or sensor device). A binary classification may be used.

In some embodiments, the status description may be concerned with confirming if a device, including any sensor device, has been installed. This may involve checking the Sensor Digital Platform and schedule documents. The inference status provides installation confirmation (e.g., yes/no, timestamp). Signal processing techniques like wave-based sensing, context awareness, and image denoising with CNN classifiers are used. The algorithm uses context awareness to sense contextual conditions and determine if the device is embedded, mounted, or fixed, implying installation. Binary classification may be used.

In some embodiments, the status description might focus on whether a device, including sensor devices, has been covered in concrete. The inference status indicates this condition (e.g., yes/no, timestamp). Context awareness techniques are employed to determine if the sensor is surrounded by air, concrete, or other materials. For instance, a wave-based sensing device configured for tomography might detect its waves being impeded by concrete characteristics, indicating coverage. The output may include a binary output.

In some embodiments, this status description may be used to detect if a device, including sensor devices, has failed. The Sensor Digital Platform provides failure data (e.g., yes/no, time interval, type of failure). Context-aware signal processing and sensor self-diagnostic techniques are used. The system automatically detects if the sensor device stops sending measurements or shows anomalous data/perturbations, indicating a failure. The output includes a binary indicator of failure and the type of failure.

In some embodiments, the status description may be associated with detecting movement of a device, including sensor devices. This involves the Sensor Digital Platform and schedule. The inference status provides data on movement (e.g., yes/no, time interval, initial & final locations). Techniques like wave-based sensing, context awareness, image denoising with CNN classifiers, and logistics signal processing are used. The algorithm detects intentional or unintentional movement using trilateration, accelerometers, and context awareness, monitoring changes in the device's surroundings. The output includes a binary indicator of movement, the time interval, and start and end locations.

In some embodiments, the status description may concern whether materials like concrete meet specific requirements. Multivariate sensor devices, wave-based sensor devices, temperature sensors, and others mentioned in this document are utilized. The reference document is the Specification, and the inference status indicates a pass or fail (e.g., yes/no) against these specifications. Signal processing might include mix fingerprinting, enhanced material method-based signal processing, context awareness, and wave-based sensing techniques. The inference logic varies depending on the specification requirement, such as using spectroscopy for strength determination, piezoelectric sensors for workability, or temperature sensing devices for temperature differentials. A binary output compares the determined property against the specification.

In some embodiments, this status description may relate to whether materials meet Quality Assurance (QA) requirements. It employs multivariate sensor devices, wave-based sensor devices, and any other sensor device mentioned. QA records serve as the reference document. The inference status indicates a pass or fail (e.g., yes/no) against QA requirements. Signal processing techniques include mix fingerprinting, context awareness, and wave-based sensing. The logic involves comparing determined properties with QA requirements, such as using Ultrasonic Pulse Velocity testing for concrete quality, resulting in a binary output.

In some embodiments, the status description might focus on whether an element meets embodied carbon, environmental, or Environmental Product Declarations (EPD) requirements. It uses multivariate sensor devices, wave-based sensors, especially spectroscopy-based sensing devices. EPDs may include reference documents. The inference status indicates compliance (e.g., yes/no) with carbon requirements. Signal processing involves mix fingerprinting and batching machine data ingestion. The algorithm identifies compositional properties of materials and calculates embodied carbon density and volume to determine the specific instantiation's embodied carbon, resulting in a binary output.

In some embodiments, the status description may determine if the entire construction project meets embodied carbon requirements. This process involves multivariate sensor devices and spectroscopy-based sensing devices, with EPDs as the reference. The inference status indicates compliance (e.g., yes/no) with carbon requirements. Signal processing includes mix fingerprinting, data aggregation, and context awareness. The logic aggregates individual element carbon statuses and compares them to EPD requirements. A binary output is provided, along with predictions based on BIM models or estimates of the total volume of material used, to forecast the project's embodied carbon.

Any of the statuses above may be queried in prediction mode. Instead of the status query being formulated in present tense, it may be formulated in future tense. In this mode, similar broad logic as the above may apply. However, multiple methods such as statistical machine learning methods applied onto historical data, or physico-chemical methods, or simply plans provided by humans regarding the future of the project, may allow the inference engine to make likely predictions regarding the future real state of the project. As more information is collected about the project under consideration, the likelihood of these predictions increases.

### Status Inference Flowcharts

FIG. 94 illustrates a flowchart containing a series of operations for an example method for construction status inference and sequencing operations (e.g., method 9400). The operations illustrated in FIG. 94 may, for example, be performed by, with the assistance of, and/or under the control of an apparatus (e.g., server 200), as described above. In this regard, performance of the operations may invoke one or more of processor 202, memory 206, communication interface 204, and/or machine learning (ML) module 208.

As shown in operation 9402 and 9404, the apparatus (e.g., server 200) includes means, such as processor 202, or the like, for receiving a first dataset that includes one or more first data entries as described above and identifying a first construction site resource associated with a structure based on the first dataset. As described above, a construction site resource may be used to refer to any asset, device, system, etc. that may be used in the construction of a structure. By way of a non-limiting example, a construction site resource may refer to raw materials, composite materials, support structure or formwork, etc. used in the formation of structures. Additionally, a construction stie resource may refer to transportation devices or systems (e.g., trucks, cranes, etc.), harvesting devices or systems (e.g., raw material related devices located at quarries or the like), and/or the personnel that operates these devices and systems. Furthermore, a construction site resource may refer to the sensors and sensor devices used, in some embodiments, to perform the operations of the present disclosure. As such, the present disclosure contemplates that any of the assets described herein as associated with or otherwise related to the use of building materials to construct structures may be considered a construction site resource, without limitation.

Thereafter, as shown in operations 9406 and 9408, the apparatus (e.g., server 200) includes means, such as processor 202, or the like, for generating a construction status identifier associated with the first construction site resource and outputting the construction status identifier. As described above, a construction status may indicate the state of any measurable entity (e.g., a construction site resource or the like) associated with a construction site. In some embodiments, the statuses described herein may further be associated with status types, such as concrete statuses, completion statuses, sensor device status, and/or requirement statuses. For example, a concrete status may refer to status queries associated with mixtures (e.g., cementitious mixes or the like), completion statuses may refer to status queries associated with the completion of a process or subprocess associated with a construction project through time (e.g., as defined by the structural progress flow or otherwise), sensor device statuses may refer to status queries associated with sensor devices, and/or requirement statuses may refer to status queries associated with whether a measurable entity (e.g., construction site resource or the like) has met a requirement. The present disclosure contemplates that the statuses described herein may be associated with any construction site resource as defined above without limitation. The output of the construction status identifier may be, for example, provided to a user, provided as an input to a machine learning model, and/or the like.

In some embodiments, as shown in operations 9406 and 9408, the apparatus (e.g., server 200) includes means, such as processor 202, or the like, for identifying a second building element associated with the structure based on the construction status identifier and modifying operations associated with the second building element based on the construction status identifier. By way of a non-limiting example, the second building element may be dependent upon or otherwise associated with the first building element, such as an instance in which completion of the first building element is required for construction of the second building element. The example construction status identifier may, for example, be associated with a crane or other equipment (e.g. a construction site resource) that is required for completion of the first building element. IN an instance in which the construction status identifier is, for example, indicative of the lack of availability of the example crane or other equipment, operations associated with the second building element may be required to be delayed. As above, the present disclosure contemplates that any dependency between building elements may exist and that the systems and methods of the present disclosure may account for the interdependencies associated with construction site resources associated with these building elements.

### Mix Optimization

As described herein and would be evident to one of ordinary skill in the art, as concrete (e.g., a cementitious mixture) cures, its compressive strength increases. The rate of that increase varies during the curing process: beginning with an initial rapid strength gain, followed by a convergence towards some maximum (or “long-term”) strength and hardness. It is worth noting that in most cases, the materials which will be optimized by the methods described above are mixes or mix formulations. Mixes in the broadest sense of the term may be defined as materials that are either composite or mixtures in the physical, material senses of the words. Typically these may be used for construction purposes (e.g. construct a building, construct a bridge, etc.) Typically, these mixes will be materials that include cementitious materials, or materials with cementitious properties as components. Mix Optimization as described herein may mean the optimization of the ratios of these components to fit certain use case(s) and/or objective(s).

### Steps of Mix Optimization

In one embodiment, mix optimization may be formed of any of the following steps in any order. For example mix optimization may include measurement (of a mix property/identity), prediction (of a mix property/identity), evaluation (of a mix formulation against predefined performance requirements, contextual material properties, etc.), selection (of a mix formulation against performance requirements and/or a utility function and/or constraints, from a given list), recommendation (of a mix formulation based on performance requirements & a utility function/ranking), adjustment (of a mix formulation, given contextual material properties and/or a utility function and/or constraints), generation (of a mix formulation, contextual material properties and/or a utility function and/or constraints). Prediction, evaluation, and recommendation may require one or more mix formulations and/or mix identifiers as inputs. These may either be provided as a list, or they may be generated by the system.

As described herein, a utility function might also define the marginal costs and benefits that are to be optimized against and may automatically calculate tradeoffs between different decisions. It is also useful to note that a mix formulation defines a target set of proportions of other materials, from which an instance of that mix should be composed. In reality, a specific instantiation of a mix formulation may naturally deviate to some extent with respect to that recipe (i.e., concrete mixes that are batched in a batching facility will vary in composition from one batch to another).

### Timescale Modes of Optimization

The system may consider the models herein to be able to act in two principal modes or configurations, designated mainly by the time domain in which they act including a planning mode and an execution mode. The planning mode—also known as static mode optimizes mixes prior to the project having begun and prior to having generated any sensor data. Some features of this mode include that the mix properties can be predicted, mixes can be evaluated against performance requirements or target contextual material properties, mixes can be recommended based on a ranking derived from a utility function (e.g., lowest carbon mix), and/or mix formulations may be adjusted or generated in line with performance requirements/target contextual material properties and a utility function/ranking. These models are continuously learning and improving from the execution phase (as more data is gathered, predictive power increases).

Once the construction project has begun, the execution mode is also known as ‘dynamic’ mode is another mode of operation. This mode optimizes mixes once the project has begun taking place, and once it has possibly generated measurements (e.g., from sensors or the like). Some features of this mode include recommending adjustments (e.g., from a winter to a summer mix) mid-project, and dynamic batching optimization (e.g., treating the concrete journey from batching plant to truck to site as a dynamic control system with feedback loop at different timescales). The dynamic operations in the execution mode may happen at different timescales, such as pour to pour adjustment or optimization (e.g., iteration on formulation from one pour to the next based on batch/truck/pour sensor data). Batch to batch adjustment or optimization (e.g., iteration on formulation from one batch to the next based on batch/truck/pour sensor data) is another example. This data may be gathered through methods described with reference to any other embodiment described herein, for example through methods described in mix fingerprinting, especially as used in perturbation mode. In such a mode, sensor information may be gathered from any batch and/or pour and inform adjustments to later batches and/or pours within a given timescale (e.g. a day), even if the later batch and/or pours relate to different mix formulations.

Operations may also happen in real time, such as in reaction to a measurement of properties of the raw materials (e.g., influence formulation during batching based on measured cement reactivity). For example, if the same mix is being produced for different jobsites, then there would be value in multiple jobsites using sensor devices, all feeding data to the models described herein, for more comprehensive characterization. There will typically be more variation in a mix's contextual conditions inter-jobsite than intra-jobsite, which would allow the models to use more varied data in their analysis. Making changes to the mix in transit is also an important evaluation tool. For example, the addition of water in transit to compensate for some incoming measurements. This may be an adjustment recommended by the models.

Each of these modes (e.g., static and dynamic mix optimization) will lead to optimization for different use cases. The static case may optimize based on predictions which are based on statistical performance of particular properties (ideally with known standard deviations/confidences) or physico-chemical knowledge of the principles which underpins them. These predictions may be based on historical measurements (e.g., the system may know the supplier of a cement, but not its reactivity in that particular batch, however, these predictions will lack data regarding the specific project for which the models may be optimizing).

For the dynamic case, optimization is based on real-time (or near-real-time) measurements from batch/truck/pour sensors. This is a continuous control optimization system. The models may use the live/near-real time data to make iterative adjustments to the formulation based on the sensor measurements which detect variability in raw materials. In this way, drift on batching equipment can be compensated for. By way of another example, a readymixer may have 100 plants. The model for the planning mode (e.g., ensemble model) may be used to generate proto-formulations for all plants (e.g., a trial mix). Then plant-specific models (that include the use of the dynamic algorithms/control system optimization) make refinements to that proto-formulation, adapted to the needs of each plant based on that plant's conditions and environment (e.g., contextual conditions). For example, a plant may be in a more humid location, its equipment may have more randomness or drift, the source of its aggregates may have more variance, etc.

By way of a particular example for ready mixers a planning case may include a determination as to how to make adjustments to a mix to reduce cost or carbon. Additionally, if material prices have changed, how to make the mixes optimize cost or carbon. An example execution case may be real-time formulation swap recommendations to optimize day to day production (to reduce cost or carbon).

### Measurement and Data Sources

All measurement data described herein may be stored in a database 108 that is formed of historic and/or live data, and which includes, but is not limited to, all data types described above. The sources of this data, for example may be recorded values from measurement devices, documents (e.g., digital or handwritten), human input (e.g. via forms, surveys, filling out data fields on a digital platform etc.), insights derived from the execution of any models stored on the digital platform, and/or data and insights accessed via external organizations or services (e.g. a weather forecasting service accessed via API). As described above in the hardware section, the present disclosure may leverage sensor devices 102a-102n of any type, configuration, orientation, etc. based on the intended application of the system 100. Similarly, the mix optimization techniques described herein may leverage the sensor device and/or data types described herein without limitation. Furthermore, the mix optimization operations described hereinafter may leverage sensor devices at any stage in the construction process, such as in a kiln, quarry, batching plant, transit, pump, pour site, and/or the like as described above with reference to FIG. 2.

### Optimization Throughout Material Life Cycle

Sensor Devices are paramount to Mix Optimization. Sensors allow the models to generate feedback loops between the real, in-situ behavior of mixes, and the mix design process. In essence, given comprehensive historical data about the material behavior/attributes of mixes in the field, alongside any relevant mix formulation information (though this is not a requirement), it is possible to design mixes which will behave within chosen bounds on target contextual material properties, and within chosen bounds on contextual conditions (e.g., time of year, location etc.). Essentially, historical data collected by sensors allows us to create a large database of mixes and their associated material behavior/attributes. Wherever the system is in possession of an associated mix formulation, the systems link those formulations to the associated sensor data and historical measurements. Wherever the system is not in possession of a mix formulation, the systems link measured data to a chosen mix identifier, and (where the models are able) will infer the properties or type of mix from the data measured. The above data is used to train the models to optimize mix designs based on user requirements.

Methods for Extracting and/or Inferring Data from Data Sources

All methods described in Linkage may be used here to extract data from various data sources (e.g. BIM & Schedules). This data may be extracted as any data type, and/or data type category (e.g. contextual condition, contextual material property etc.) described above. One example includes extracting and/or inferring constraints from BIM and/or schedule information. The present disclosure contemplates their use in one embodiment, for example, that breaks down BIM & schedule into pours, and key target milestones, which are then used to define the target contextual material properties in the models described herein. Another example includes extracting embodied carbon constraints and/or targets from EPDs. This could be done using text parsing methods such as NLP or LLMs. EPD generation may also be done. Environmental Product Declarations (EPDs) are documents that state the environmental impacts associated with a given product. This includes impacts generated due to the manufacturing, shipping, and any other aspects of the product's lifecycle (cradle-to-gate). The present disclosure contemplates that the system 100 may ingest EPDs to increase the accuracy of any optimizations or recommendations, and also the generation of EPDs when they are not available, significantly reducing the overhead required in producing EPDs. EPDs may be generated using generative algorithms and possibly LLM methods.

### Data Linkage

Data linkage in the context of any training dataset for the model is needed to harmonize disparate testing records (e.g. crush data) forms a key part of preprocessing the pre-existing dataset through which the models are trained. All the techniques described in Linkage may be used in mix optimization. Data sources may also exist at different granularities. Further, these may also be coded differently. All the techniques described in linkage may be used to address these issues.

### Data Format Conversion

In general incoming data may be converted by the models from one format, standard, system, notation, classification or unit type into another through any of the techniques described herein or other techniques that would be clear to one skilled in the art. Some format examples include PDF, Word, PNG, JPEG, BIM (e.g. IFC), CAD (e.g. STEP), Revit (e.g. RVT), Floorplan data (e.g. as pdf or image). The system 100 may be configured to perform any necessary conversion operations, such as converting from a BIM to a floorplan.

### Data Classification, Clustering and Selection Techniques

Data Classification algorithms in mix optimization may include K-nearest neighbors classifier/k-clustering using distance metric and/or Linear Classifiers, among others. For an example in mix space as described above, considering perturbations in the spaces of parameters, the system may leverage work that is already done (e.g. on quadtrees or other spatial computations) to efficiently select mixes which fall in the right volumes in N-space. The system 100 may leverage efficient indexing and search technology designed for geofencing as applied to parameter-space. When dealing with missing data or gaps, the use of hybrid AI and physical/chemical models as described herein (where different models are adaptively selected based on availability of prior training data) is a particularly innovative aspect of the present disclosure.

### Predictive and Evaluation Model Overview

Predictive models may include one or more of a model that identifies a raw material from partial knowledge of its static material properties, a model that predicts the remaining static material properties of a raw material from partial knowledge of its static material properties, a model that identifies a composite material from partial knowledge of one or more of its compositional and/or static material properties, a model that predicts the remaining compositional and/or static material properties of a composite material from partial knowledge of one or more of its compositional and/or static material properties, and/or a model that predicts the contextual material properties of a material from complete or partial knowledge of its static material properties and/or compositional material properties and/or contextual conditions.

Evaluation models may include one or more of a model that evaluate the degree to which a static material property matches a target static material property for a specified composite material and set of contextual conditions, evaluates the degree to which a predicted contextual material property matches a target contextual material property for a specified composite material and set of contextual conditions, and/or evaluates which composite material—from a chosen set of pre-existing composite materials—are predicted to most closely achieve one or more target contextual material properties for a specified set of contextual conditions.

### Recommendation Model Overview

Recommendation type models may operate to suggest an adjustment to one or more sets of static material properties, compositional properties and/or contextual conditions, for the purposes of achieving a target contextual material property, or other material or non-material attribute of some system. For example, the recommendation model may include a model which recommends a mix from a given list, without adjustments. A material adjustment model is designed to recommend a set of changes to the static material properties and/or compositional properties of a composite material (such as a cementitious mix) in order to meet a target set of contextual material properties under specific contextual conditions. For example, the model will suggest changes to the proportion of cement in a cementitious mix in order to meet a 28 day compressive strength requirement. A context adjustment model is designed to recommend a set of changes to the contextual conditions of a composite material (such as a cementitious mix) in order to meet a target set of contextual material properties. For example, the model might suggest a change in the geometry of a cementitious mix so as to reach a 28 day compressive strength requirement. A material and context adjustment model may recommend a set of changes to the static material properties and/or contextual conditions of a composite material (such as a cementitious mix) in order to meet a target set of contextual material properties. For example, the model will suggest a change in the date at which a cementitious mix is poured (so as to modify the environmental temperature) and a change in the proportion of cement (in order to affect the early-age strength gain), so as to push the system towards a target 7-hour compressive strength requirement.

### Generative Model Overview

Mix Optimization uses generative models that generate the compositional properties of one or more composite materials, where those composite materials are chosen by the model on the basis of their ability to match one or more target contextual material properties, within a specific set of contextual conditions. In some versions of the generative models, the generated compositional properties may include raw materials that may not exist in the database of raw materials, or those raw materials may otherwise exist but in an incomplete form (where not all static material properties are known). If the raw materials proposed by the generative models do not exist (or their information partially exists), the model will also generate the static material properties of those raw materials or will fill in the expected static material properties that are absent (e.g. a generative model may suggest a raw material with a specific density, pH, grain size that a human would then have to create and/or discover in the real world).

### Model Orchestration System

Given the multitude of models described herein, the method may include an orchestration system which is able to orchestrate across the various models. This would orchestrate the use of different models based on different information. In some embodiments, this system would have a notion of the use case for which the method herein is used and would be able to route the input data to the correct model. In general, the system may orchestrate a sequence and/or parallel combination of use of each model (e.g. use a first and second model in parallel, feed the output data to another model). This system would allow the method to act as a distributed system of models that fulfill different purposes and can be used multiple times in parallel or in sequence.

### Multi-Version Distributed Feed Models

For each one of the models described above the system may have different versions of the model, which may be trained in different ways to create intentional biases and/or specialize the models towards outperforming in a particular field. For example, one version of a model may be trained on a large portion of incomplete data (which would allow it to become robust towards incomplete data) whereas another may be trained on predominantly complete data, which might be more accurate than the models trained on partial data, and would be used whenever additional data is available. Another example might be a model trained predominantly on mixes composed of SCMs (supplementary cementing materials), and would therefore be particularly effective at predicting, evaluating or generating SCM-based mix designs. This latter example could be generalized as training models to effectively work in different volumes or parts of mix space (e.g. model for C80 and above, model for mixes below C50 etc.) This may be described as an Adaptive Model. One instantiation of the distributed model system may be a distributed system of GANs (generative adversarial network), wherein a system of distributed GANs, configured with different biases may act as an ensemble which is intentionally skewed towards certain types of mixes over others.

Utility Functions. Objective Functions, Hard Constraints and Preferential Constraints

The models are optionally constrained by utility functions during both training and execution. Utility functions apply additional constraints that are outside the scope of constraints placed on contextual material properties described in the Evaluation, Recommendation and Generation models above. However, utility functions may still constrain contextual conditions; for example, they may require that the temperature of the material never exceed 70 degrees Celsius. Explicitly, utility functions apply constraints that are outside of the constraints applied by the objective function and which are not required in order for the model to be created. However, if a utility function is applied (either during training or at execution) the model will solve for its trained purpose with additional constraints. As an illustration of the use of a utility function, consider a situation in which an Evaluation model is used to determine which material (e.g., out of a set of specified composite materials) are best suited to achieve a target contextual material property. For the purpose of this example, the system may determine that target to be a compressive strength of 25 MPa that is achieved no more than 3 days after the material is poured. In addition to this target, a utility function can be used to prioritize solutions that might, for example, preferentially lower the carbon footprint of the material. In the above scenario, if the utility function were not used, a cementitious mix (Mix A) might be chosen by the Evaluation model, where Mix A would be deemed as the mix that reaches 25 MPa in the fastest time (e.g., in 6 hours), and hence would be optimized for speed. However, if a carbon-minimizing utility function were added as a constraint, then the model might choose a different cementitious mix (Mix B), where Mix B might reach 25 MPa in 40 hours, for example (as opposed to the 6 hours of Mix A), and where Mix B might have half the carbon footprint of Mix A. In this example, although both Mix A and Mix B satisfy the constraint on the contextual material property (i.e. both reach a strength within a certain timeframe), only Mix B additionally satisfies the constraint defined by the utility function.

Thus, the optional utility functions of the models have the purpose of applying a multitude of additional constraints on the solved output. These utility functions can be used in the training stage (in order to build models that always adhere to the chosen utility constraints) or they can be applied at execution (in order to allow an otherwise more general model to adhere to more specific constraints during a specific use-case). A utility function will broadly apply two categories of constraint in hard constraints and preferential constraints.

Hard constraints are True/False constraints that place absolute limits on whether a control parameter can be adjusted, or whether a material can be chosen. Non-exhaustive examples of hard constraints include the availability of a certain raw material is not available, and therefore a composite material composed of that raw material cannot be evaluated, recommended or generated. Another hard constraint may be that a pour cannot occur on a specific date (or range of dates) and, therefore, a composite material that would have reached a target during those dates cannot be chosen, because it would otherwise not reach that target on other dates (perhaps because the atmospheric temperature would be much lower). An upper limit on the volume of a material in a specific use case may be hard constraint, perhaps leading to certain materials being non-viable (e.g. due to inadequate thermal properties of the volume).

A preferential constraint places a systematic bias towards a user-defined consideration. That bias does not generally lead to a hard limit on the use (or inability to use) a given material or set of contextual conditions. Non-exhaustive examples of preferential constraints may be preferring a material with a minimal carbon footprint, preferring to pour a cementitious mix in the summer, and/or preferring a context in which the material has a maximal volume. Unlike the hard constraints above, these constraints do not rule out the use or adjustment of any control parameter or material, but rather lead to a biasing of evaluations, recommendations and/or generated materials, so as to incline the relevant outputs towards the stated preferences. For example, a preferential constraint may state that the volume of a cementitious pour should be maximized. However, the model may still choose small volumes if other preferential constraints conflict with necessary consequences of the maximal volume criteria, such as constraints on the temperature of the material.

Objective Functions, Objectives. Utility Functions & Constraints

Constrained optimization problems typically require one or more objectives to be optimized for, whilst satisfying a number of constraints. In this second embodiment, where relevant, instead of using the framework described above wherein the utility function holds both hard and preferential constraints, the following framework may also be used. Any preference relating to any of the data types, or combination of the data types listed above, including those not explicitly mentioned herein, may constitute possible objectives to be optimized for by any of the models where relevant, depending on the specific use case. The objectives may be accounted for through the objective function. Example objectives may include a preference for minimizing embodied carbon of a mix, a preference for minimizing curing time of a mix, and/or a preference for maximizing the durability of a mix. Any condition upon any of the data types listed above, or combination of the data types listed above, including those not explicitly mentioned herein, may constitute possible constraints to be satisfied by any of the models where relevant, depending on the specific use case.

The conditions can typically be defined by equalities and/or inequalities which may generally involve any of the data types listed above. Note, conditions may be qualitative/non-numerical. The constraints may be accounted for through the utility function. Example constraints may include conditions on Temperature (e.g., temperature may be considered to be a contextual material property or a contextual condition depending on the embodiment), the temperature inside of the pour may not exceed 80° C. at any time during the element's lifetime, and/or the difference in temperature between any two locations inside the pour may not exceed 20° C. at any time during the element's lifetime. Conditions on contextual material properties, also known as target contextual material properties, may include examples such as 60 MPa>Cube Compressive Strength>40 MPa, at 28 days in standard conditions. A change in length of pour due to shrinkage<0.05% of total initial material length at 28 days may be a constraint, among others. Conditions on static material properties, such as homogeneity=HIGH and/or 2.6 g/cm\hat{ }3>Density>2.2 g/cm\hat{ }3 may be example constraints. Conditions on contextual conditions may, in some embodiments, be considered as given input information to the models relating to the reality of the use case, or constraints that sit in the utility function (e.g. design a best mix, given it will be poured on April 2nd vs. design a best mix, and constrain it such that the mix must be poured on April 2nd). For all intents and purposes, these two embodiments may be considered interchangeably. conditions on compositional properties, condition on supply chain & material availability, and/or condition on source/supplier constraint may be constraints.

### Example Utility Function Implementation Strategy—CO2 Reduction

One strategy is cement reduction (e.g. reduction of ordinary Portland cement) within a mix. Cement production is a highly carbon emissive process (accountable for approximately 8% of global CO2 emission given current estimates). Concrete is notoriously over-designed with respect to its cement content (i.e. more cement is often placed in concrete than is necessary). Therefore, by reducing cement overdesign, it is possible to reduce cement requirements and therefore the embodied carbon of the target concrete formulation. Another strategy involves substituting cement with other materials altogether (often called “supplementary cementitious materials”). Typically, supplementary cementitious materials which are chosen such that they are not as carbon intensive as ordinary Portland Cement. This will require that the models herein have an understanding of the behavior of these materials. This may be done by training AI algorithms on large amounts of data, or potentially by using physico-chemical models.

### Model Details

Models may be defined as in a training stage and an execution stage. The training stage is the process by which a model is either created, finalized or updated (where updating only occurs if the model has been trained previously), and where the procedure is designed to ensure the model outputs some minimal requirement of accuracy (where “accuracy” is defined by the details of the training procedure). One example of the training stage may be instantiated using simulations as follows: Using differential procedures, the simulations are run to assess the sensitivity of changes in certain outputs due to complex changes in input parameters and discover through the simulations which inputs have been learned in the training stage to influence the outputs and to what extent they influence the output.

The execution stage is the process by which a pre-trained model is used for its intended purpose, where its intended purpose is defined by the goals of the training procedure. When explaining the methods used by a model, the system will either describe the form and scope of the functions used in the execution stage, or the algorithmic choices by which the system trains a model in the training stage. The distinction between training and execution is an important one, as it is generally possible for two models to execute the same function types, but to have been trained via different training procedures. Generally, two identical sets of functions trained via different procedures will possess a different degree of accuracy, precision and/or scope; even if trained on the same data. Furthermore, it is generally true that the same training procedure will produce models of a different accuracy when trained on the same data, whenever the training procedure contains an element of randomness (which may or may not be the case for any given instantiation of a training model). Where randomness is an aspect in the model training method, various techniques are used to overcome this training-based variability. A non-exhaustive list of the methods used herein are bootstrapping, usage of ensembles of models, dropout methods, and probabilistic inference on the inputs/outputs of the models.

### Types of Training Algorithms

When a model is created at the training stage, its internal mapping between input and output variables is altered (typically in an iterative process). The internal representation is often represented by a set of numbers that are referred to as “weights”, and which define both the weighted combination of internal computations, and/or the functional computations themselves. In general, the training stage is the process by which the weights of a model are modified so as to minimize or maximize an “objective function”. The objective function is defined such that it receives an input/output pair (where the output is derived from executing the model in its current state, for the given input), and will calculate the “error” between the current output and the desired output of the model.

In some cases, the desired output of the model might be provided to the objective function via historical instances of input-output pairs. In this case, the system would state that the training method is supervised, and the objective function directly compares the output of the model with the desired output. In other cases, the objective function calculates a derived quantity of the input and/or output and will measure the deviation of that derived quantity from the desired derived quantity. These algorithms are typically called unsupervised algorithms and can create useful models without the need for having prior examples of desired outputs that pair with the inputs. One example of an unsupervised objective function is a function that minimizes the cross-entropy between sets of calculated distributions on the outputs of the model (creating a maximally informative classification system, relative to the data and the internal model representation).

The following are the broad categories of training procedures that are used to train the models (i.e. to modify the internal weights relative to an objective function). They do not imply any specific choice of objective function, and the specific choice is not an integral aspect of any of these training algorithms. These training algorithms do not require the objective function to be specifically minimized (i. e. they are also valid for choices of objective that are maximization at convergence), nor do they require the objective functions to characterize a supervised or unsupervised error calculation (they are valid for either case).

Human choice training is the use of human understanding/intuition to create analytical models from a priori knowledge of the world. This might be a physical or chemical model that was obtained through experimentation, or through logical reasoning on the outside world, or via prior literature in the field. Gradient descent is a procedure by which a set of (generally) non-linear and/or linear functions, over (generally) discrete and/or continuous data (of arbitrary scope) have their functional parameters (i.e. weights) modified in an iterative manner. Each iteration is broadly defined by executing the model in its current state, comparing the desired output with the executed output, assessing the degree to which the desired output can be reached by modifying the functional parameters, updating the internal parameters in the direction of those updates, and halting the procedure when the desired output has been sufficiently found.

Reinforcement learning is a method by which a model learns how to make decisions by performing actions in an environment (whether physical or virtual) and receiving feedback in the form of rewards and/or penalties. The model is defined in such a way so as to choose from a set of restricted actions in its environment. The reinforcement learning process iteratively maps situations (inputs) to actions (outputs) in a way that maximizes cumulative rewards over time. The decision as to how the rewards/penalties are quantified in the feedback process is defined by the meaning of “accuracy” within the context of the model's purpose. Like gradient descent, reinforcement learning is iterative-gradually improving its decision-making strategy based on the consequences of its actions. However, unlike gradient descent, reinforcement learning focuses on finding an optimal policy for action selection, rather than directly minimizing the difference between a desired outcome and a model outcome. The permissible actions that the model can affect, and the internal functional parameters that determine the policy regarding which action to choose, are all specified by the person that defines the training process. In addition, unlike gradient descent, the feedback does not occur immediately at each iteration, and a “poor decision” can impact a reward or penalty in a temporally or spatially non-local way. For example, the consequences of a poor decision may manifest hundreds of iterations (and actions) after that decision was made, at which point the associated reward/penalty may occur. Generally, reinforcement learning involves a random search over the space of possible actions at each iteration, optimizing for the set of actions that maximize cumulative rewards and/or minimize cumulative penalties. There are some modifications to reinforcement learning that permit non-random searches over the permissible range of policies. Generally all such forms of reinforcement learning are used.

Reinforcement Learning with Human Feedback (RLHF) is a means of modifying the standard reinforcement learning approach to include human feedback into the iterative optimization procedure. In RLHF, a feedback loop is set up between both the natural environment of the model and its internal representation of that environment, but also between a set of human users, who are providing constant feedback in some form, where that feedback is translated into numerical reward or penalty values. The search procedure still optimizes for the optimal action policy, but now it is the one that considers the totality of all rewards and penalties, including those provided through human feedback. The system may use all types of RLHF, and RLHF is especially useful when creating models that encode the preferences of one or more human users.

A genetic search involves taking the functional parameters of a model and encoding them in a vectorized form. That vector might be used as is or may be further operated on to create a continuous or discrete embedding, or to compress the vector. The procedure is broadly as follows: the vector/s of functional parameters are randomized, the procedure is executed a number of times (denoting a single epoch in the genetic process), where an ensemble of randomized (i.e. “mutated”) models and outputs is obtained, the outputs from all models in the ensemble are assessed against the desired output, and the models that improve on performance to within a specific threshold are chosen and ranked by their degree of improvement, out of the set of all sufficiently improved models, a randomized “inter-mixing” between functional parameters is executed, whereby the vector of parameters between a chosen pair will partially inherit parameters from one another, or combine the parameters in some way (e.g. averaging), and the ensemble of new models (generated through the inheritance step above) are then executed and assessed against the desired outputs, the best performing model or models are chosen for the next randomization step, and the procedure is restarted from the beginning. The procedure ends when a sufficient degree of model accuracy is reached. The models described herein may use discrete or continuous data as defined above and described herein.

### Generic Functional Forms

All models, no matter, and no matter the input/output data type, can be expressed as some generally non-linear, generally discontinuous function over a set of arbitrary variable inputs. That function can be written in the form, y=ƒ(x₁, x₂ . . . , xₙ), where the value xᵢ denotes the i-th input variable to the function, ƒ, and where the function ƒ denotes any arbitrary model, composed of an arbitrary number of functions over the space of input variables, and where y is the model output at the specific instance of inputs, (x₁, x₂ . . . , xₙ). In general, the function, ƒ, may not be analytically differentiable, but it may be able to compute a first-order linearized local differential over some input domain. The analytic equation for calculating the first order differential of a model, y=ƒ(x₁, x₂ . . . , xₙ), is:

$$Δ y = \frac{\partial y}{\partial {x}_{1}} Δ {x}_{1} + \frac{\partial y}{\partial {x}_{2}} Δ {x}_{2} + … + \frac{\partial y}{\partial {x}_{n}} Δ {x}_{n} ,$$

wherever ƒ is continuous and locally differentiable over the chosen domain. The above equation is capable of propagating a shift, Δxᵢ, of the i-th input variable into a shift, Δy, in the output.

If the function, ƒ, is not analytically differentiable, it is possible to calculate the first order partial differentials empirically, by shifting the i-th input by some computationally small value, δxᵢ, and measuring the incremental shift, δy, of the output. The approximation,

$$\frac{\partial y}{\partial {x}_{i}} \approx \frac{δ y}{δ {x}_{i}} ,$$

is then used as a substitution into the above differential equation. However, if the function is both non-differentiable and discrete in some subset, {x}_{d}, of the set of input variables, then it can replace the partial differential with respect to some variable, xᵢ, by a set of n fixed alternatives in the discrete value, where those n alternatives are taken from a pre-chosen set of all possible discrete values within the domain of xᵢ. In this instance, the partial differential term is substituted with a set of conditional mappings, the system would determine that,

$${( \frac{\partial y}{\partial {x}_{i}} )}_{j} \to δ y \vert {( {x}_{i} )}_{j} ∀ {x}_{i} ∈ {\{ x \}}_{d} ,$$

and where the term on the right denotes a change in y given a choice of the j-th permissible discrete value of xᵢ: chosen from the set of permitted values that xᵢ can take, and where the variable xᵢ must belong to the set of all discrete variables {x}_{d}. In general, the system is able to obtain a set of n values of δy|(xᵢ)ⱼ. This conditional approach allows the system to assess the n independent contributions towards a shift in y.

Thus, in the presence of discrete values, it generally obtains a conditional form of the difference, Δy, such that, Δy→Δy(x₁, x₂, . . . , xₖ)|Δ{x}_{d} a where the shift Δy is now calculated based on a local incremental shift over a set of k continuous variables, (x₁, x₂, . . . , xₖ), and where that shift is only valid for a fixed set of alternative discrete values over the set of discrete variables, {x}_{d} (which does not belong to the set of k continuous variables). The system thus, in general, obtains a method by which to construct a multi-dimensional characterization of the conditional dependencies on Δy due to fixed alternative values of discrete variables in the input space to the model function, ƒ. Using the above, it is generally possible to obtain a value for Δy that is irrespective of whether the set of inputs, xᵢ, are a mix of continuous or discrete variables for any given model, ƒ(x₁, . . . , xₙ), where k of those n values might be continuous and (n−k) will be discrete.

One particularly innovative aspect of this system is that it is capable of performing arbitrary local adjustments to a given input space, (x₁, x₂, . . . , xₙ), in order to achieve some desired output(s) provided by the function y=ƒ(x₁, x₂, . . . , xₙ), where the function, ƒ, denotes a model of arbitrary non-linearity and discreteness, operating on inputs of arbitrary continuity or discreteness. In contrast with the gradient descent methods described above—which are used to alter the internal parameters of model functions during training—this procedure applies a “gradient-like” descent method on the space of input variables (not model parameters), and during the execution stage (not the training stage) of the algorithm. The term “gradient-like” descent is used because the concept of a gradient is generalized by the above stated approach to the discrete dimensions of an arbitrarily discrete function, ƒ (where gradients do not technically exist).

### Generalized Uncertainty Propagation

The conditional form of the differential expression permits the system to obtain a general form of error propagation over the space of all input variables, (x₁, x₂, . . . , xₙ), where the following function denotes the magnitude of the random error expected over an ensemble of instantiations of the system:

$${\vert Δ y \vert}_{c} = {\sum }_{i = 1}^{k} \vert \frac{\partial y}{\partial {x}_{i}} Δ {x}_{i} \vert ,$$

where the k input variables in the of instantiations of the system: above expression are all continuous variables, and the |Δy|_{c} value denotes the contribution to the total error that is due to variations in continuous inputs only. The possible deviations of discrete variables can be defined by a conditional form (in a similar way as for the generalized case), where |Δy|(xᵢ)ⱼ|=δy|(xᵢ)ⱼ∀xᵢ ∈{x}_{d}, where the error is conditioned on the j-th choice for the discrete variable xᵢ.

Thus, the generalized uncertainty is given by the set of all possible conditionals: Σᵢⱼ|Δy(x₁, x₂, . . . , xₖ)|(xᵢ)ⱼ|, where the sum is taken over all values that define the set of all possible discrete values over the i-th discrete variable, and a sum over all i accounts for the contribution from all possible discrete variables. It is also generally possible to obtain a probabilistic value for the variation, Δy|(xᵢ)ⱼ|∀i, j, where it can weight the above sum over the discrete variables and their possible values with a probability density function, ρᵢⱼ, which accounts for the probability that the i-th discrete variable be chosen at random from an instantiation of the system, and that the j-th value be its instantiated value. The function form of this equation is as follows, P(Δy)=Σᵢⱼ ρᵢⱼ|Δy(x₁, x₂, . . . , xₖ)|(xᵢ)ⱼ|, where P(Δy) is the probability of obtaining the absolute shift, |Δy|.

### Probabilistic Outputs and Insights

In general, the output of the models described here are multi-dimensional tensors of point values, where those point values define the evaluation, adjustment or recommendation of a single variable. However, all models are placed within an additional probabilistic modelling procedure, which characterizes the probability density function over all possible outcomes for a point value, where that probability density is taken over some subset of the totality of the data on which the model was trained, or some ensemble of subsets of the totality of data, or some other representative dataset. The probability density functions obtained over the space of outputs for each model are generally calculated as the multivariate joint distributions over some set of outputs. The joint distributions are used in the Bayesian sense, to estimate any marginalized distribution the system may require for any given purpose. Some non-exhaustive examples of the use of the calculated multivariate joint distributions are to calculate the expected uncertainty on a predicted/evaluated outcome, to within a specified confidence interval, to calculate the information gained (in a formal information-theoretic sense) by obtaining knowledge through a given measurement of the system, to calculate the degree to which outputs are statistically independent of one another, with respect to the model and the data, and/or to calculate the logical correlation between any two output variables. In general, the use of probabilistic models over a set of point values allows the system to convert any point value into one or more range values associated with that model output. For example, the point value for a predicted temperature may be 24.3 C, but the probabilistic uncertainty on that output may provide the range of values (23.8 C, 25.2 C), where the first and last temperature in the range denotes the lower and upper bound on the uncertainty to within a 99.9% confidence level, respectively.

### Bayesian Networks and Causal Graphs

In addition to the above utilization of Bayesian inference, the system also utilizes various probabilistic and causal graph theoretic models. Graph models establish a set of weighted and directional connections between nodes, where those weighted connections represent a multiplicative modification to the node values, and where that multiplicative modification is applied by traversing the graph between nodes. The graphs are generally directed, and are permitted to contain cycles of arbitrary number or degree (including self-connections at nodes). The weights used in the graph models are either measures of probability (for the Bayesian networks) or measures of causal direction/causal impact (for the causal graphs). The system also use hybridized graphs, where some weights are measures of probability and some are measured of causal impact.

The nodes of the graphs contain the measured input and output values of a given system (along with any hidden values at intermediate node calculations). Those inputs/outputs can constitute the inputs and outputs of a single model or of a multitude of models. Wherever the node values are outputs from multiple models, the graph is used to determine the probabilistic relationship between those models (for Bayesian networks) or the causal connection between those models (for causal graphs). The weights of the Bayesian networks are solved to obtain the Bayesian probabilities that connect each node with the network, as evaluated over some subset of the totality of all data upon which the node values derive. The weights of the causal graphs are solved to obtain the meaningful causal impact and causal direction between node values. This typically involves iterative modification of the causal graph, such that certain causal connections are systematically removed, and the impact on the node values are assessed against expected real-world experimental outcomes, or against expected theoretical outcomes or bounds. Once a probabilistic or causal graph is solved for a given network of node values, various insights can be obtained by calculating properties of walks along those graphs, or of correlations between the nodes of the graphs, or of dimensional embeddings over the weights or node values of the graphs. In general, all the models are ingested into one or more Bayesian inference models, Bayesian networks or causal graphs; where these techniques are used for the purpose of obtaining various probabilistic and causal insights about the underlying systems from which all the data are derived.

Recommendation and Generative Models with Complex Non-Differential and Genetic Search

With regards to the recommendation and generative models (where the system recommend adjustments to material properties or conditions to match constraints, or the system generates material properties to match constraints), the system utilizes both complex non-differential approaches and genetic search algorithms in order to obtain the relevant adjustment values or generated material properties or conditions. In the manner described above, the system obtains a “differential” adjustment to the input parameter space of any of the execution models, where the input parameter space is defined generally by the set of all continuous and discrete values that constitute the executed inputs to a model. The adjustments at each iteration are taken in the direction that optimizes against the desired contextual material properties, conditions and utility function constraints. The system eventually converges on a threshold set of input values that match the constraint criteria, and report this as the set of recommended adjustments or the set of generated values.

In the manner described above for the training stage, where example genetic search algorithm used to train some of the models, the same genetic search procedures are used to iterate over the space of input values in order to optimize for the desired contextual material properties, conditions and utility function constraints. By using either the generally non-differential method, or the genetic search algorithm, or both in conjunction (within a single search instantiation), the system is able to traverse any space of input values to solve for any set of constraints on the output space of the models.

### Explainability of Models

A crucial innovation is the explainability of the models' predictions, evaluations, recommendations and/or generations. In general, a combination of models is trained in section B.98.2 to solve for the problems outlined above. However, this system also utilizes a combination of probabilistic inference on uncertainty and probabilistic/causal graph algorithms on the space of all inputs/outputs from the models to trace the causal and logical reasons for model predictions, evaluations, recommendations and/or generations. In general, the methods described herein do not only provide a set of output values and probabilistic uncertainty on those values, but also provide a model-based reason for those outputs and probabilities. Depending on the specific model, those automated explanatory outputs can range from physical/chemical insights (wherever physical/chemical models are utilized) to internal “representational” understandings, that derive from the internal component dynamics of the computation models that have been numerically derived from the data and the training procedures. The models described herein may be iteratively trained and/or updated.

### Meaningful Information—Theoretic Model Evaluations

The models are designed to be probabilistic in their outputs. To this end, the models are capable of generating meaningful probabilistic outputs even in the absence of complete information. For example, a model that requires knowledge of compositional properties, and which only receives some of those values (or even none of them) will provide a probabilistic prediction on how the “average” material (from a set of meaningful materials and/or material properties) will behave, along with an estimated uncertainty on that behavior. In this sense, the models are correct from an information-theoretic perspective, capable of reasoning based on partial information.

In this sense, the execution stage of the models are continuously able to receive updated information that modify prior predictions, evaluations and/or recommendations and, in general, will continuously improve in accuracy, and reduce uncertainty, as additional relevant information is provided.

### Normalization and Self-Detection

A given mix will behave differently in different contextual conditions-its contextual material properties will be different (e.g. Strength, Durability, Shrinkage, Strain, Workability, will evolve differently in environments with different temperatures). Therefore, in order to understand the material properties of different mixes, it is vital to account for differences in contextual conditions. One way to overcome this challenge is therefore to create a “baseline” across which mixes within different contextual conditions will be comparable. This concept is denoted as “normalization”. This is only one form of normalization, and in the general sense, the term normalization is used to refer to the operation that enables the models to effectively compare mixes under different material contextual conditions and/or sensor contextual conditions (in the case where the data used by the model has been collected by sensors).

For example, let's consider the effect of pour geometry upon the behavior of a pour. It is true that a given mix will behave differently when poured in differing geometries. For example, a mix poured into a cube of sides 10 cm, will cure very differently when compared to the same mix poured into a cubical slab of sides 3m. The latter has a much greater thermal mass. Thus its strength gain curves will be sharply different. By “normalizing” across these two sets of contextual conditions to a common baseline (e.g. behavior of cube in standard conditions), it is possible to identify that these are the same underlying mixes.

The Mix Optimization models described herein may apply these kinds of normalization to understand the underlying behavior of a mix for a target contextual condition.

This may be done for example in the training stage by feeding the models large quantities of curing data for pours of the same mix with different geometries. The model may then gain an understanding of the relationship between geometry and of thermal behavior (including temporal evolution and spatial distribution), which could translate into an understanding of the relationship between geometry and the strength curve. This training may also be done using large numbers of simulations which simulate concrete's real thermal evolution. Another approach may include using physico-chemical models which understand heat diffusion in physical systems.

Another example of the above, includes the effect of the location within the pour upon its perceived contextual material properties. For a given mix in a given pour, a thermal sensor placed in the center of the pour and another placed at one of the edges will capture significantly different thermal curves. For physical measurements therefore, it is important to know the location the measurement is being taken from, to be able to apply the same kind of normalization as described above.

The geometry of the pour and/or the location of the sensor with respect to the pour are examples of Self-Detection Data/Sensor Context Awareness Data. This kind of data may be collected by the techniques outlined within the “self-detection” or “context awareness” sections of the description. Capturing this kind of data allows the training or imbuing of the models herein with an understanding of those contextual conditions which need to be normalized for a particular baseline. Another example might be the size and shape of an acoustic transducer influencing the measured resonance peaks.

### Spatially and Temporally Normalized Models

In general, a contextual material property is defined at a certain time and at a certain location within the instantiated use-case of the material in question. For example, a contextual material property might include the compressive and flexural strength of the material at a specific location on the surface of one of its faces, and at a specific time. It is also generally the case that a contextual material property will change with both time and spatial position within an instantiated material. In general, the models output contextual material properties that belong to a certain position and/or time, or that are spatially distributed in the instantiated material as a field of values throughout its body and/or surface, or that are temporally distributed (as a time series). In the case where values are not spatially or temporally dependent (such as the average workability of a batched cementitious mix), the models account for the contextual material property as a “bulk” value (independent of spatial position) and/or a “constant” value (independent of time).

Many of the models described in this document relate to optimizing for target contextual material properties. These models are trained in such a way as to be “normalized” with respect to spatial and/or temporal constraints (provided they depend on location or time, respectively). The term “normalization” is used to define the ability of a model to account for the functional variation in spatial and/or temporal location; where that model is able to modify the contextual material properties in its outputs based on information about the location and/or time of contextual conditions.

One case is an example of the kind described-, where the inputs to the model are: compositional material properties of a cementitious mix, temperature of the material at specified locations, where the temperature are received as time-series (obtained by temperature sensors embedded inside an instantiated cementitious material), geometry of the cementitious material, radial distance of the sensor to the surface of the geometry (giving the location of the temperature within the material), and where the radial distance lies along the line that intersects the sensor and the center of mass of the material, geographic location of the cementitious material. The output of the model is the temperature of the material (in the form of predicted future time-series) at multiple locations within the material. For example, the model may receive the temperature time-series from one temperature sensor, its radial distance, the geometry of the cementitious mix and the geographic location, and output a mesh of temperature time-series, equi-spaced throughout the 3D geometry of the material.

The example model described above is trained on a hybrid model that utilizes functions that are inspired by physical thermal models, artificial neural networks (trained on data of the four types described above, and for a variety of different cementitious mix formulations and geometries) and Bayesian inference. That model is then embedded inside a “fingerprinting” model, that will use the predictions of the contextual material properties (in conjunction with an empirically solved physical model) to obtain an assessment of which material is being used. The physical model module utilizes the physical principle (based on physical assumptions) that the heat within a material dissipates as the inverse exponential of its distance from the heat source, T=w₀exp (−w₁d), where T denotes the temperature of a material at the radial location, d, within the instantiation of that material, and where w₀ and w₁ denote the weights that represent the temperature at (d=0), and the decay constant, respectively. The weights are solved by training against the sensor data time-series values (giving a T over time) for all positions, d, and across all measured instantiation of cementitious mixes (where each mix is identified by its compositional material properties).

The weights, w₀ and w₁ are trained under the assumption that they are constants at a given time and for a given material composition (in general, the temperature of the surface of the material will vary with time as the ambient temperature varies). The system then obtains a set of weights on a per-material basis, that characterizes the thermal properties of a given cementitious mix composition. An artificial neural network is used, whose inputs are the temperature time-series at a location, and whose outputs are the future temperature time-series at that location (i.e. a forecasting model). The system trains that forecasting model on the temperature dataset (which is the same temperature data obtained from the sensors that have been used to train the physical component model). The artificial neural network will predict the future temperature of any given time series based on past time-series.

The model then merges the physical and neural network models into one pipeline of logic. That logic is as follows obtain the recorded temperature time-series from within the given instantiation of the material, input this into the artificial neural network to obtain a forecasted time-series, use the total time-series and the radial location of the sensor from which the temperature data came (which can be provided by a human being, or provided by a position-detecting sensor), and input those data into the physical model, obtain the geographic location of the material and use that to obtain the ambient temperature (e.g. from a weather service or from a set of on-site thermometers), use the time-series of ambient temperatures (historic and forecast) to estimate a w₀ value for a given measured (and predicted) temperature time-series forecasts within the material at the sensor location, d, sample all possible weight values, w₁, that were found during the physical model training, and use the outputs of those functions to assess which weight will best normalize the surface ambient temperature to the recorded (and predicted) embedded temperatures, assess the goodness between all mappings from ambient-to-embedded concrete temperatures and the true recorded (and predicted) embedded temperature time-series, goodness is assessed by a simple n-dimensional vector Euclidean distance between mapped and recorded temperature time-series, find the nearest mapping on the basis of the above-mentioned goodness criterion, and the subsequent w₁ that belongs to that nearest mapping, if the nearest mapping meets a sufficient closeness criteria (i.e. a normed error that falls below a minimum threshold of sufficiency), and then the corresponding cementitious material is chosen as the candidate material from within which the sensor data derives.

### Combination of Physico-Chemical Model and AI Data-Driven Model

One particularly useful and innovative type of model would be a hybrid physico-chemical and AI Model. In such a model, knowledge of the laws of nature may be embedded in the algorithms and used in conjunction with AI algorithms, allowing the model to physically and chemically reason about the systems it is treating and therefore provide explainability for the solutions it reaches, whilst also learning from the provided data using deep learning approaches. The scientific principles of nature may thus be used to augment these deep learning models, which may in turn, use the historical data they gather to refine their understanding. This may also be described as the model being infused and/or embedded with physico-chemical knowledge, which is particularly useful for treating complex problems especially with ill-labelled or incomplete data.

To describe these types of models in more detail, the physico-chemical and empirical AI components work together to provide a solution that may be based on a multi-modal internal representation (in which some aspects of the internal solver are based on physical and/or chemical principles, and other aspects on learned representations from empirical data). One instantiation of such a model would be a Convolutional Neural Network (CNN), which is used as a means to construct an ensemble model, such that the weights of the convolutional networks bias the outputs of several sets of physical or chemical equations, each of which contributing to various aspects of the final model output. The weights of the convolutional neural networks might be learned over the set of empirical data available, whereas the physico-chemical equations that are being weighted by the neural network may have been derived from pre-existing theory. For example, one such physico-chemical component might encode a functional representation of how insulation affects heat transfer in a material, such that modifications to insulation will have a heavily weighted influence on outputs from those functions. Such an internal representation can allow for an accurate prediction or identification of the compositional material properties of a mix which has been covered with a blanket and would allow for an automated physico-chemical explanation of those results. The inclusion of physical or chemical understanding can also allow for a model to be more robust against missing or partially informative data. For example, a CNN which also has an internal functional representation of the mechanics of acoustic wave propagation within concrete, may be able to take as input an incomplete or noisy set of acoustic wave measurements from a mechanical wave based sensor within a particular mix, and output a sufficiently accurate prediction, evaluation or recommendation. In contrast, a traditional CNN model may have difficulty learning useful embeddings that are representative of the system with incomplete data.

Another way of infusing physico-chemical understanding into the model involves the use of physico-chemical models to simulate data which is then used for training machine learning models. This may be particularly valuable for cases where the system is dealing with data gaps or has minimal knowledge on the performance of parts of mix-space. In a different mode of the invention, the models can also be configured to output physico-chemical models (in essence coming up with new solutions to real-world physics & chemistry). This would enable explainability of model outputs.

### Generative Model for Novel SCMs

Another model type instantiation may use a generative (or other) model trained to understand the chemistry of concrete, as modified by the presence of novel cementitious materials, in order to design entirely novel SCMs which may not currently exist (e.g. designing new SCMs or new materials which may be used for construction, and which may be very low in carbon intensity). This model could generate several candidate SCMs that are predicted to achieve the desired result, and may evaluate those SCMs based on their ease of production for example (would be able to take the output of this generative model and input it into one of the evaluation models). This would help us narrow down to raw materials that are feasible for manufacture.

### Model Using Maturity Method

One instantiation of a predictive model is using maturity data to characterize the strength. Maturity uses temperature time-series data (measured over the entire curing process) to determine the compressive strength of the concrete at each point in time. There are multiple types of input and output data that are required by the maturity method. These vary depending on the specific maturity function employed, but can include the following: input of the Temperature (or average temperature), θᵢ, recorded at a specific time, tᵢ, and where the time, tᵢ, meets the condition that tᵢ≥t₀, where t₀, is the time at which the concrete began curing. The time-series of temperature measurements, θ(t), must be sampled at a sufficiently high sampling rate over the range of times tᵢ≥t₀, up to and including the time, tᵢ (which is the time at which the system wishes to measure the compressive strength). This can be recorded using sensors. An input reference temperature, θ₀, that will typically be provided by a user and depend on the temperature at which calibration was carried out, the Time Elapsed (δt), that can be tracked as the concrete cures, and the Activation Energy (AE) that can be computed by doing a series of calibration crushes, at different temperatures, to better characterize the temperature sensitivity of a mix at different temperature ranges. Intermediary inputs/outputs may include maturity

$$M ∼ {\int }_{{t}_{0}}^{{t}_{1}} EA ,$$

and Equivalent Age, EA=ƒ(θ,θ₀,AE,δt). Final output data may include compressive strength, S.

Instantiations of the maturity method for mix optimization may include cases in which optimization is being done for the particular strength target. For example, minimizing embodied carbon in a given mix, whilst staying above a particular strength target. For example, this could be implemented using a statistical approach, or a physical approach. The statistical approach would ingest a large dataset of mixes with associated strength profiles and thermal profiles. By calculating correlations between the two, those correlations might be used to predict the material properties required to match a desired strength. The physical model might have an explicit internal representation of the exothermic hydration reaction of a given concrete (via internal physico-chemical equations) and would use that representation to predict associated material properties. In addition, a utility function designed to minimize carbon might further optimize the choice of mix formulation.

### Mix Optimization Via Electro-Chemical and Electro-Mechanical Measurements of a Material

One particularly innovative aspect of the mix optimization procedures is the use of electro-chemical or electro-mechanical measurement devices for the purposes of characterizing static, compositional or contextual material properties of a material, such as concrete. In general, the electrical impedance (derived from electro-chemical measurements of the material) or the mechanical impedance (derived from electro-mechanical measurements of the material) are both functions of the material properties. One instantiation of this invention is illustrated by the use of piezo-electric sensors attached to devices that are embedded or external to a concrete element, and which measure the electromechanical impedance and admittance of that concrete medium. The device in general will record the electrical impedance/admittance over a broad range of frequencies, creating an impedance and/or admittance spectrum (in this case, representative of the mechanical impedance of the medium, due to the electromechanical coupling of the piezoelectric sensor). Through use of historic in-situ and laboratory data, the machine learning models are able to learn the mapping that exists between these electric properties and physical or chemical attributes of the concrete. For example, the system may possess concrete mix formulation information for a range of concrete cubes cast in a laboratory, each of which containing one of the piezo-electric devices. The system might then measure the frequency-dependent impedance or admittance parameters of those cubes over time (including their amplitude and/or their phase shift). The system, or person, might then crush those cubes (in order to measure their compressive strength directly) or extract samples for the purposes of assessing the exact chemical and material composition. The system would then train models on the recorded impedance/transmission spectra, so as to use those spectra in order to infer the compressive strength or the chemical composition of the concrete. Alternatively, in another embodiment, a physico-chemical model is used, or a hybrid model (which employs both machine learning and physico-chemical principles and/or empirical data), for example, to extract the resonance peaks in an electromechanical impedance spectrum.

Other non-exhaustive electrical measurements and/or couplings that might be used for the determination of concrete material properties in the above example are one or more electrochemical impedance measurements, or an electrochemical impedance spectrum derived from one or more electrodes in the concrete, one or more electromagnetic wave impedance measurements, or an electromagnetic wave impedance spectrum, derived from one or more antennas or other sensor/actuators in the concrete, the dielectric constant of the concrete at one or multiple frequencies, the modal electromagnetic dispersion relationships of the concrete element, the permittivity of the concrete at one or multiple frequencies, the magnetic permeability of the concrete at one or multiple frequencies, the current density flowing through the concrete or along its surface.

In another illustrative instantiation of this invention, the system might use an ultrasonic transducer/receiver system, where the ultrasonic transmitter and receiver are attached to devices that are embedded or external to a concrete element, and which measure the acoustic impedance and acoustic admittance of the concrete medium. In the same manner as described above, the system would use a combination of in-situ and laboratory ultrasonic sensor data in order to train the machine learning models (or physico-chemical or hybrid models) to predict other material data derived from other measurement techniques (such as destructive compressive strength measurements, or destructive chemical composition measurements). Some non-exhaustive acoustic measurements that might be used for the determination of concrete material properties are the average speed of sound in the concrete, the modal acoustic dispersion relationship of the concrete element, the acoustic impedance of the concrete, the small scale (e.g. micro- or nano-scale) principle vibrational modes of the embedded device, the pressure generated by controlled sounds played into, or from within the concrete, the current response of the piezo-acoustic device when the concrete is vibrated at certain frequencies.

In the case of spatially separated ultrasonic transducers, S or T parameters can also be characterized and used in the analysis. Through use of the above-mentioned techniques, the system is able to create mix optimization models that can predict, evaluate or recommend based on measurements from piezo-electric and ultrasonic device sensors. Those predictions, evaluations or recommendations may involve characterizing the precise chemical composition of the concrete via electromechanical impedance or electroacoustic impedance measurements (for example), wherein the models would subsequently provide insights about the detected concrete composition with respect to any desired contextual material properties. An analogous embodiment can be constructed on the basis of one or more electrodes used to measure electrochemical impedance or admittance and used for electrochemical impedance spectroscopy. The electric measurements of impedance in that case are reflective of the chemical properties of the medium, which will evolve over time as the concrete cures and hydrates. These will reflect the changing properties which influence ion movement, dipole moments, and electron movement in concrete as it cures. Specific parameters or features used may include the real or imaginary parts of the electrochemical impedance, the inductance, capacitance and resistance, the conductivity, and/or resonances or other features in the electrochemical impedance spectrum.

The systems generally make use of parameters related to impedance (of all kinds disclosed), measured through electrical or other couplings, at multiple frequencies, with any excitation signal, to inform any of the models described herein. Use by the models of these data or related characteristics may take place during training or updating, or as historical inputs, or as live inputs. Impedance parameters may be used to inform predictions, evaluations, recommendations. Mix formulations may also be generated or adjusted, on the basis of such impedance data.

Adjustments to Mixes Through Time e.g. In Transit

One particularly notable feature of the models designed by the inventors is the ability for the models to deal with changes to mixes throughout time. Batched mixes are time-evolving but target mix designs may also evolve in time. In fact it is quite common for a batched mix to be altered in transit, where water is added to the mix to maintain workability. The models would be able to account and simulate the consequences any change might have on the final behavior of the mix within its final contextual conditions. The models also recommend changes to the mix formulation given inferences based on the sensor data from a mix in transit, and from its final contextual conditions and targets/utility function. In this way, mixes and mix formulations go from being static descriptions, to descriptions that evolve over time.

### Mix Optimization for Every Element in a Building

The models designed in this system may be generalized and used to optimize mixes for many pours across a building. For example, the models may ingest geometrical/structural data regarding the project (e.g. BIM, CAD, Floorplans, etc.), and understand the geometrical distribution of the building. This may then be augmented with physical understanding (in one instantiation from the techniques in Pour Design & Sequencing), to recommend mix designs for each pour/element in the building. For example, if the building is highly regular and includes many repeated elements, the models may recommend “Column Mix”, “Slab Mix” etc. This might also be done individually, without consideration from Pour Design and Sequencing to optimize the mix for each pour, one at a time.

Optimization Using Novel Materials (e.g. Green Concrete)

Ability to recommend materials based on chemistries other than Portland cement (which is generally the most carbon-intensive constituent of traditional concrete). Reason for using green concrete (i.e. lower-carbon cementitious materials): Carbon savings are expected to be more significant than approaches involving partial replacement of Portland cement. Traditional mix design methods may be inappropriate for materials based on novel chemistries. The mix optimization algorithm described does not rely on traditional methods and can be useful to achieve optimal mix formulations to satisfy a given set of requirements, while minimizing CO2. Furthermore, the ability to recommend from existing, known materials can be used to identify cases where a novel material can be used in place of traditional materials while satisfying the requirements and minimizing CO2.

### Pointing a User to Historically Successful Mixes

Another feature of the models might be to point users to historically successful mixes that were used for similar use cases. As the models are used to predict, evaluate or recommend in an increasing number of contextual conditions, and for an increasing number of mix designs, those contextual conditions and mix designs will enter the database, and will become training data for future training iterations. The models therefore keep growing their databases of mix designs, and may be augmented with a feature that allows them to rank mixes based on historical success criteria. Users may then be provided with recommendations of mixes which have been historically successful. By leveraging historical performance data, the predictive accuracy of the models improve in a provable way, providing empirical evidence as causal explanations for its predictions, evaluations and recommendations. In addition, recommending mixes that have been empirically proven to be successful in the past is another way in which the models may be demonstrably reliable and trustworthy for the end user.

### Model Recommending Actuation

Models may be able to recommend the actuation of a particular entity to optimize a mix. (e.g. a precast mix in a concrete oven). Models may know the identity of the mix, geometry of the mix element and the temperature of the oven. They may realize that the oven must be turned to a greater heat to optimize the mix for the given use case. Engine may recommend to the user to actuate the oven in this way. Or, in a fully automated distributed system, the engine may be able to automatically actuate the oven.

### Human Feedback

One feature of the models is that they may take in human feedback. One notable instantiation of these would be through an interactive user interface. The user would input feedback, the interface may prompt for clarification in an interactive way (using for example the language model information parser of the utility function being interfaced), and the final feedback will be ingested by the utility functions of the relevant model. One instantiation of this might be through a chat-style interface (e.g. using LLM).

### Lookaheads

Another feature would be to construct intelligent alerts, which might inform the user about any predicted future weather aspect (or other simulated contextual condition) that might adversely impact a required material property or other contextual condition. These predictive alerts are called “lookaheads”. For example, weather will impact curing time, which will therefore impact any lookahead that is aimed at informing the user about contextual conditions that might alter the curing time of some material. This smart lookahead feature is generally able to alert users to real-time changes in weather patterns (or other contextual conditions). The scope of this invention applies broadly to any time of supply & project set-up, including those described above (which are non-exhaustive).

### Mix Designs in Advance

Using the prediction and evaluation models, developers, designers, and contractors are able to assess the probable total time for all concrete to be delivered and poured. This in turn allows developers and contractors to gauge the cost and embodied carbon of the project far in advance of the project start date. By giving this tool to developers, designers and contractors, they become able to modify their plans and/or structural designs in order to account for the specific in-situ contextual conditions of the proposal.

For example, a contractor provides a BIM model, pour layout schedule, project location and series of mix designs. The models then output a projected schedule, based on the contextual condition at that location and at the specified times. The model finds a significant discrepancy between the predicted timespan of each pour and the desired scheduling.

The system uses Bayesian Networks and Causal Graph analyses (over the space of the model outputs) in order to discover the likely causes of this discrepancy. Spectral decomposition of the Bayesian and Causal graphs inform the user that the top-ranked explanatory reasons for the projected delay in scheduling are the size of elements (which are too large) and the effects due to time of year (the ambient temperature is too low). The developer, designer and contractor decide that they are unable to alter the time of year over which the project occurs but choose to alter the size of the elements in the building design. After altering the design, a new BIM is created and passed into the models, where the output shows that the project is now predicted to be completed within 1 month of the scheduled completion date, and to a 92% confidence.

Generating Mix Designs that Meet True In-Situ Conditions

The readymix supplier designs their concrete mixes based on the standardized performance of cubes (or cylinders) in a water bath kept at a fixed temperature. However, that standardized performance does not accurately represent the performance of the mix when instantiated by a specific set of in-situ contextual conditions. The present models help the readymix supplier gain insight into the true in-situ performance of the mix, and, with the help of models these models provide mix-designs that aid the contractor in meeting project requirements whilst minimizing cost and embodied carbon.

For example, a contractor requires a pour to reach 40 MPa of strength within 28 days of curing time. The readymix supplier designs a mix formulation that meets that criteria for a 100 mm×100 mm×100 mm cube placed in a 20 C temperature-controlled water bath. When the contractor receives the batched mix, the temperature on-site is 10 C. The predictive models estimate that the pour will reach 40 MPa of strength in 40 days, based on contextual conditions. The causal inference graph models infer that the primary cause of this delay is due to the ambient temperature being forecasted as too cold on-site. The models subsequently recommend an increase in the cement-to-binder ratio of the mix by 50%, in order to correct for the predicted on-site ambient conditions.

### Readymix Suppliers No Longer Waste Resources on Trial Mixes

The readymix supplier typically receives a request from a contractor to create a mix that has certain contextual material properties under specific contextual conditions. In order to meet those criteria, readymix suppliers typically go through iterations of formulations, creating and testing sets of “trial mixes”. In contrast, the AI will generate the mixes that meet all requirements (taking into account any additional constraints imposed by any utility functions) without the need for any trial mixes or iterative batching processes. This saves the readymix supplier the time and resources associated with creating various trial mixes of different designs, making the mix design process more efficient and reliable.

For example, a readymix supplier receives a request from a contractor to create a mix that reaches 40 MPa of compressive strength within 28 days. The readymix supplier will want to ensure that the concrete will achieve that contextual material property in standardized contextual conditions (e.g. for a 100 mm×100 mm×100 mm cube in a 20 C water bath). The readymix supplier places the geometry and bath temperature into the models, along with the target strength and curing time window. The models then output a generated mix formulation that is predicted to meet those specifications. The Bayesian network estimates a probabilistic distribution over the compositional material properties, along with a confidence level that the optimal mix will exist in that range. The utility function defined by the readymix supplier sets a preferential constraint that will lower the embodied carbon of the mix. After supplying an initial mix formulation, the model will be iteratively operated on by a genetic search algorithm over its inputs. If the genetic search procedure finds a mix formulation that performs within the bounds of the target contextual material properties, and which has a lower embodied carbon, it will update its recommended formulation to the readymix supplier. The readymix supplier will regularly receive design updates as and when the system determines that an improved mix exists; where the optimal mix design that meets all utility function specifications will eventually be found.

### Predicting In-Situ Performance for the Purpose of Updating Mix Designs

The contractor pours mixes on different days with varying ambient conditions. The rate at which those mixes cure depends upon a complex interplay between ambient weather conditions, pour geometry, the precise timing of those pours, and other contextual conditions. The AI tools allow for the contractor to monitor the performance of their mixes under continuously changing contextual conditions, and to adjust the composition of those mix designs (in order to keep the project within the threshold of desired contextual material properties and contextual conditions).

For example, the contractor pours on a particularly hot day. They have specified a utility function that preferentially optimizes for minimizing the embodied carbon of a mix. The models receive the ambient weather conditions and element dimensions (e.g. via a BIM model) and output a predicted time to reach a compressive strength of 25 MPa within 6 hours on average (and giving a range of time values to within a 99% confidence level). A Bayesian network analysis solves to find the probabilistic connections between all inputs and outputs of the predictive model (or models) being used. A spectral decomposition on the Bayesian graph reveals that the cement content and the ambient temperature are the dominant input variables that correlate with the total time-to-strength. The model subsequently iterates over the cement content, using the generalized adjustment procedures described herein, and converges upon a recommended reduction in cement-to-binder ratio of 80%-providing a reduction in carbon of 50 kg per tons of concrete, and increasing the curing time to 12 hours.

### Predicting In-Situ Performance for the Purpose of Efficient On-Site Resourcing

The contractor pours mixes on different days with varying ambient conditions. The rate at which those pours cure depends upon a complex interplay between ambient weather conditions, pour geometry and the precise timing of those pours. The AI allows for the contractor to monitor the performance of their mixes under continuously changing conditions, and to efficiently resource their project on a day-to-day basis-accounting for the time at which certain strength milestones will be met. These predictions inform contractors in advance about the future date that certain actions will be required and (by extension) certain workers will be needed.

For example, a contractor pours a given concrete mix into an element on a specified day. As data is received from the in-situ sensors, the models adjust the predicted time to reach 25 MPa of compressive strength; updating the time to a period between 2 μm to 5 μm the next day. The contractor is then able to ensure that they have the correct number and role of personnel on-site the next day, in order to strike the formwork on the element in the predicted time-window.

### Allowing Readymixers to Adjust In-Situ Concrete Properties Based on Changes Made to Mix Composition During Batching and Delivery

When mixes are delivered to a contractor by a readymix supplier, they are sometimes modified en-route to the construction site. One such example of a modification might be the addition of water on a hot day, for the purposes of ensuring that the mix remains within a range of specific workability (e.g. within a range of slump values). However, the addition of water might present a significant alteration in the performance of a mix. To this end, an instantiation of a mix formulation inside a delivery truck is expected to vary in compositional properties from one truck to the next.

The models generally receive live sensor and batching information from the readymix supplier, the batching plant and any delivery trucks; using up-to-date estimates of true mix composition to predict the actual performance of an instantiated mix design. In this way, the evaluation, recommendation and generation models are able to provide readymix suppliers with up-to-date knowledge on the in-situ performance of their concrete.

These models give readymix suppliers the ability to accurately assess whether a given truck should pour the concrete, and (if not) to update the compositional properties of the mix within the truck in order to compensate for any projected difference in contextual material properties. For example, the models may receive sensor information from within the truck that informs about the slump of the concrete. When the estimated slump drops below a certain value, the model will recommend an adjustment of water content to the mix; where the driver would add some water to increase the workability of the concrete. In general, adjustments to mix designs need not only occur due to intentional changes (such as the intentional addition of water) but can occur due to natural variations in batching at the batching plant. The models also allow for the mitigation of natural variation by readymixer suppliers; even during a live construction project. A feedback loop may also be provided to the contractors—where, within permissible limits, they are able to adjust the mix design live on-site in order to compensate for any given variation in the mix formulation due to natural variation at the batching plant or purposeful variation by the delivery driver.

Allowing Readymix Suppliers to Monitor and Adjust the Properties of their Mixes at the Batching Plant, in Order to Improve Compositional Consistency Between Batches

Any given instantiation of a mix formulation will initially occur at a batching plant, and that instantiation will have natural variation relative to the specified static material and compositional material properties in the readymix supplier's design formulation. In general, these variations continue to change, even inside the delivery truck en-route to the site.

One use case for the models are to estimate the true contextual material properties (such as slump or other workability metrics) based on real-time sensor feedback from within the batching plant facility. For example, the sensors might measure the composition of the batched concrete directly (from measurements made within the concrete itself), or they may measure the slump, or both. Once this additional information is provided for the models, the model outputs will be updated; creating a live feedback between the designed and true workability of a mix that is currently being batched. Through feedback of this kind, the readymix supplier can use the recommendation models to update the contextual conditions and/or compositional material parameters of the mix, in order to maintain a target workability criterion.

### Creating a Customized Model Based on Human Feedback

The models are all able to be trained and/or execute with respect to constraints provided by a utility function.

During the continuous update process, it is possible for a prediction, evaluation or recommendation to be adjusted by human feedback. Human feedback can either come in the form of dedicated feedback channels (designed to parse codified feedback data directly into a utility function) or can otherwise come in less structured forms (such a freehand note written in text, or in the form of an email sent to a dedicated email address). When human feedback arrives in free-text form, the utility functions contain integrated language model parsers that are able to translate text into applied constraints on the adjustment of bounds in the input space, or in the internal functional parameters of a model. When incorporating human feedback into the models, Reinforcement Learning with Human Feedback (RLHF) is typically used, although in some cases the system uses other training methods. The end result of allowing utility functions to be continuously updated via a human feedback process is to customize algorithms that are designed to provide predictions, evaluations or recommendations with preferential or hard constraints that might change with time.

For example, a user may define the contextual conditions of a concrete pour by giving its geometry, location and date. The user may also specify the compositional properties of the composite material being used (which in this case may be a cementitious mix) and a set of target contextual material properties (e.g. slump of 200 mm and a compressive strength of 25 MPa in no more than 24 hours). A prediction model will estimate that the provided mix will reach strength in 40 hours, violating a target contextual material property. A recommendation model may recommend an increase in cement content. However, the user does not want to increase their embodied carbon footprint. They may then interface with the online platform to state that they dislike changing the cement content, or they may write a free-hand note saying either that “they dislike changing the cement content” or that “they want to keep carbon footprint low” (not necessarily in these exact words). They may alternatively send an email to a dedicated email address stating their preference. The utility functions will then update the model, such that it preferentially suggests adjustments in water content, matching the specified time-window of performance, and keeping within slump conditions. This model iteratively updates its utility functions as the user regularly provides feedback with regards to any recommendations. Eventually, the model becomes tailored to the user's preferences.

### Estimating Missing Contextual Material Properties

It is sometimes the case that data arriving from sensors can be corrupted, can go missing, or can be otherwise not collected. In instances where a measurement data stream contains gaps, the models are able to complete that data using probabilistic reasoning, providing a mix of point values and range values, constituting the predicted values and their uncertainties, respectively.

For example, a contractor is pouring a mix into a large element. They have placed embedded temperature sensors at different levels of the element, in order to monitor temperature differences between different depths. Each sensor records a time-series of temperature values. A worker on-site accidentally removes one of the connected sensors from the receiver hub that collects the data. They realize their error some hours later and reconnect the sensor. There is a resultant gap in the time series, representing a gap in knowledge regarding the temperature differential over that window of time. The models receive all information regarding the static material properties (density of raw materials etc.) and/or contextual conditions (e.g. ambient temperatures and geometry) and/or compositional material properties (e.g. cementitious mix formulation) and/or target material properties (e.g. all sensor data and derived material measurements) and uses that information to predict the missing values in the time-series data. The prediction is in a Bayesian sense and is assessed on the basis of the history of all data that is relevant under the given contextual conditions and for the given material category. An uncertainty bound is placed each datum, and a probability of the pour having exceeded certain temperature differential thresholds is provided.

### Complex Database/Material Search

A user might possess only partial information about a raw or composite material. That user may then wish to discover which set of raw or composite materials are most likely to match the one they possess. The user would input the partial material properties of the material into a model and would either receive an output of all nearest matching materials in the database that possess those criteria, or would otherwise receive a set of material properties for a new material that is not in the database. The system would then automatically apply the evaluation model to determine which, of the chosen set of materials (whether pre-existing or novel), represents the most likely candidate; where a model utilizes a Bayesian inference model to assess the likelihood that a chosen material would match the partial information provided. Each inferred static and/or compositional material property would be provided with a probabilistic uncertainty and a confidence estimate, where confidence is derived from all historic data the system possesses on the platform.

Automated Probabilistic Error Propagation from Uncertainties in Measurement Devices and the Improvement of Predictions, Evaluations

All measurement devices possess an inherent uncertainty on their measurements. Using the generalized uncertainty propagation procedures described herein the models are able to propagate the random error of any arbitrary set of measurement devices (and any other input information) into a total random error on the model outputs. To that end, the generalized error propagation method is an algorithmic method that is used to estimate the optimal configuration of sensors, so as to minimize uncertainty on any given prediction, evaluation or recommendation provided by the models.

For example, a contractor might like to pour concrete into a deep element, and might also like to predict the future temperature differentials between various depths of the pour. They provide the contextual conditions (e.g. sensor types, sensor placements, sensor data, geometry of the element and element location), the compositional material properties (e.g. the formulation of a cementitious mix) and a set of utility function constraints (e.g. a temperature differential that does not exceed 5 Celsius between any two specified locations in the element). The model will output a predicted temperature time-series for each specified location inside the element, and will output a probabilistic spread on the estimated temperature profile. The probability of a maximum temperature differential exceeding the defined threshold is given by a Bayesian inference on the model outputs and the range of historic data on which they were trained. The probability of a given prediction is derived from uncertainties on all inputs. The user is able to specify alternative arrangements of sensors and locations, and to compare newly calculated uncertainties with those of the previous configuration. This process allows for a feedback loop between a chosen configuration of sensors and the uncertainty on the model outputs. In doing so, a user can intelligently design a sensor configuration that minimizes uncertainty.

### Adjusting the Contextual Conditions of a Cementitious Pour

It is sometimes the case that the contextual conditions of a cementitious pour are incompatible with a target contextual material property. In this case, the context adjustment models are able to recommend an update to those contextual material properties, so as to optimize for the desired contextual material performance.

For example, a contractor might place multiple temperature sensors at varying positions within an element. They may also define a utility function that constrains the maximum temperature difference between any two sensors to not exceed 5 C. The contractor will then pour a cementitious mix into that element. The models receive the contextual conditions of the pour (e.g. sensor type, position of sensors, sensor data, geometry of element, ambient weather conditions) and output the predicted maximum temperature difference over time. The maximum temperature difference might be predicted to reach 8 C, due to the surface of the pour being too cold. The model with then recommend several possible adjustments to the contextual conditions of the pour, such as pouring the concrete on a different day of the year (when the ambient temperature is warmer) or placing a heating element on the surface of the element as it cures, in order to heat the surface by at least 3 C.

Creating New Composite Materials that are Comprised of New Raw Materials

Some of the generative models are able to generate compositional material properties of composite materials, where the raw material constituents do not exist inside the database. In these instances, a composite material might be generated to match a target contextual material property, where the one or more of its raw material components have not been previously seen, and may have to be sourced or created for the first time. In this sense, the generative models described herein are capable of optimizing for required contextual performance and utility function constraints by generating completely new composite and/or raw materials.

For example, a readymix supplier states that they require a mix with an embodied carbon of 100 kg per ton, and which reaches a compressive strength of 25 MPa in no more than 6 hours, when placed in an ambient temperature of 10 C. Optimizing for those constraints, the generative models create a mix formulation that contains a raw material with a density, pH, grain size, solubility and chemical reactivity that does not match any known material (where that check is performed by the models described herein). The readymix supplier must then investigate as to what raw material may exist with those properties, and how they might be able to source such a material.

### Improved Prediction Due to a Gain in Information

It is often the case that the complexity of a construction project leads to the scattering of information across various locations and mediums and, as a result, pertinent information can sometimes become lost. The models are able to predict the most likely outputs (in the Bayesian sense), wherever their inputs constitute partial information about raw material properties, compositional material properties, contextual conditions and/or contextual material properties. However, if missing information is subsequently provided, then that information will be taken into account.

For example, a contractor is unable to source information about the exact geometry of a concrete pour. However, the contractor does know the element type (which is a slab) and the total volume of concrete that a pour contains. The predictive models will calculate the expected temperature profile and compressive strength at various times and locations within an average pour geometry of the given volume (for example, assuming a cuboid, if the element type is a slab). At a later date, the contractor sources the precise element dimensions from a BIM model and provides the BIM and element location to The predictive models. The models then update their predictions and relative uncertainties, becoming more certain about the outcome, and updating the temperature time-series for each location within the pour (accounting for the differing thermal properties that are caused by the change in modelled element shape).

Adjustments to Compositional Material Properties Based on Information about Target Contextual Conditions

In the context of a cementitious pour, it is sometimes necessary for the concrete to contain internal reinforcement (typically in the form of steel bars). Steel bars (for example) will play a role in the thermal characteristics of the block. The predictive, evaluation, recommendation and generative models are able to receive information about structure constraints as data about contextual conditions.

The contextual conditions in this example may constitute the density of the reinforcement bars, their material type, their exact number, their location, their orientation within the concrete block, and their thickness and length. Given this information (coupled with other contextual conditions and the compositional material parameters of the concrete being poured) the models will predict the performance of various contextual material parameters (such as temperature and compressive strength). A target contextual material parameter might then be predicted as violating the constraints given by a utility function (e.g. violating a temperature difference between two locations within the pour).

A Bayesian network analysis on the model outputs may then find the probability of that deviation to be significantly correlated with the information provided about the reinforcement bars. A spectral decomposition on a causal graph of the inputs and outputs of the models may then find that the reinforcement bars are indeed the dominant factor affecting the temperature differentials. The models then make an automated report about this finding, and send them to the contractor. The model may then make a suggestion to adjust the compositional material properties of the concrete, by lowering the cement content. The overall outcome is an adjustment that was causally determined as being due to the precise type and configuration of reinforcement bars within the pour.

Concrete Marketplace In some embodiments, a centralized database of concrete producers, their batching plants, the raw materials stocked at each batching plant, and known mix designs produced at each batching plant. Purchasers/consumers of concrete specify their exact requirements, and the system utilizes its database to identify suitable candidate mixes which satisfy their requirements using models described herein. These requirements may include standard properties (e.g. workability or strength grade) and in-situ requirements (e.g. achieving certain in-situ strength targets within a given amount of time), which can both be predicted using the algorithms and models described. Furthermore, in addition to existing mix designs, the system can generate new mix formulations using the mix generation technique described. Generated mixes can also be evaluated and included in the candidate mixes if appropriate.

Candidate mixes can be ranked according to a utility function-certain parameters of the utility function can be configured by the user to adjust the rankings in accordance with their preferences/requirements/priorities (e.g. carbon savings vs. productivity improvements). Users can select a mix design from the candidate mixes, and then agree a commercial supply contract with the corresponding supplier.

### Example Mix Optimization Flowcharts

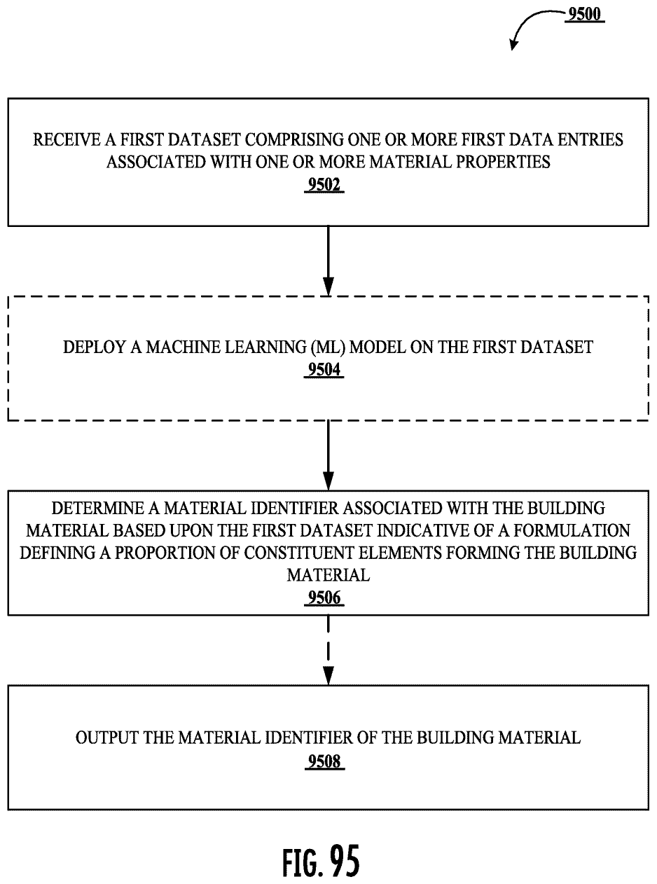

FIG. 95 illustrates a flowchart containing a series of operations for mix optimization (e.g., method 9500). The operations illustrated in FIG. 95 may, for example, be performed by, with the assistance of, and/or under the control of an apparatus (e.g., server 200), as described above. In this regard, performance of the operations may invoke one or more of processor 202, memory 206, communication interface 204, and/or machine learning (ML) module 208.

As shown in operation 9502, the apparatus (e.g., server 200) includes means, such as processor 202, or the like, for receiving a first dataset including one or more first data entries associated with one or more material properties. As described above, the first dataset may be received via a user input, via generation of data by a sensor, via an output of the various machine learning (ML) models described herein, and/or the like. The present disclosure contemplates that the server 200 may receive the first dataset by any mechanism described herein.

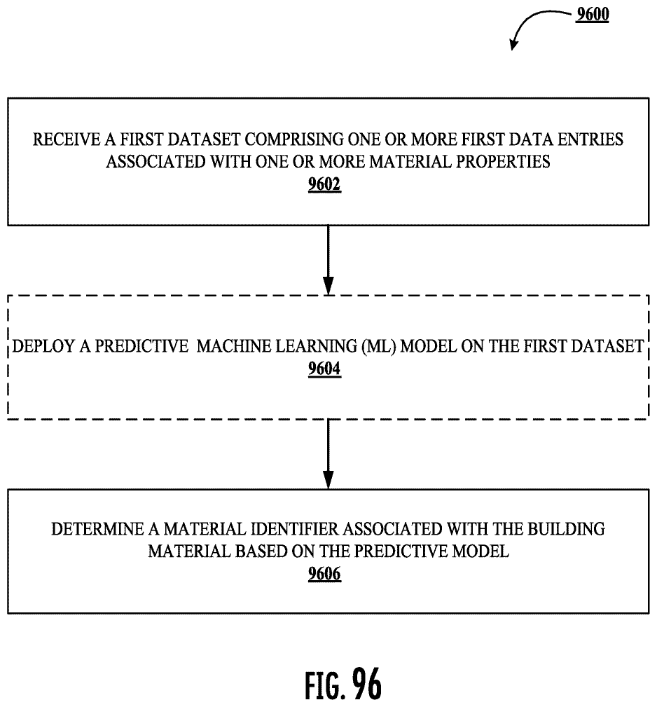

Thereafter, as shown in operations 9504 and 9506 the apparatus (e.g., server 200) includes means, such as processor 202, machine learning (ML) module 208, or the like, for deploying a machine learning model on the first dataset to determine a material identifier associated with the building material. As described above, the material identifier for a mix optimization operation may refer to a formulation defining a proportion of constituent elements forming a building material (e.g., a mix formulation). The various example models (e.g., predictive, evaluation, recommendation, and generative) of the present disclosure are described hereinafter with reference to FIGS. 96-99.

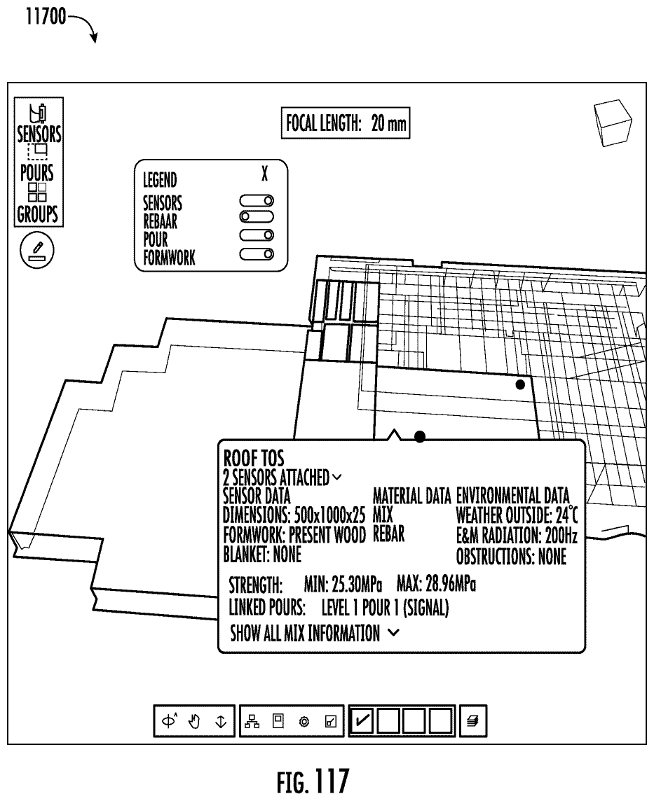

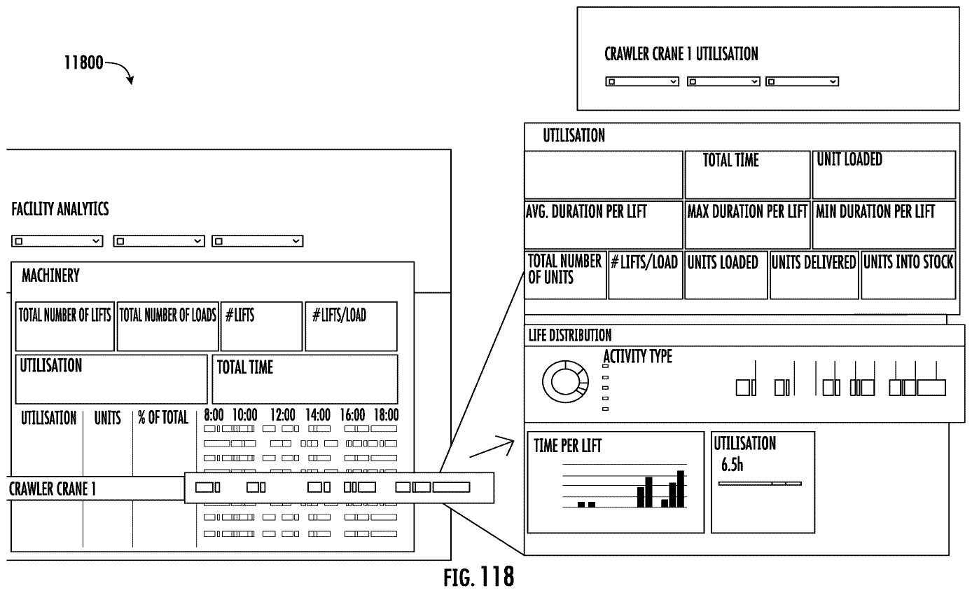

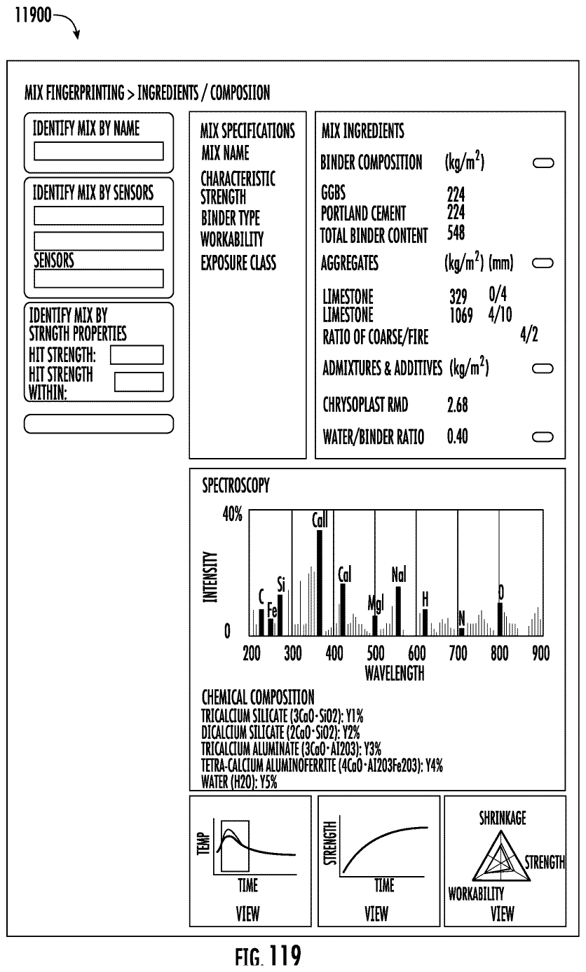

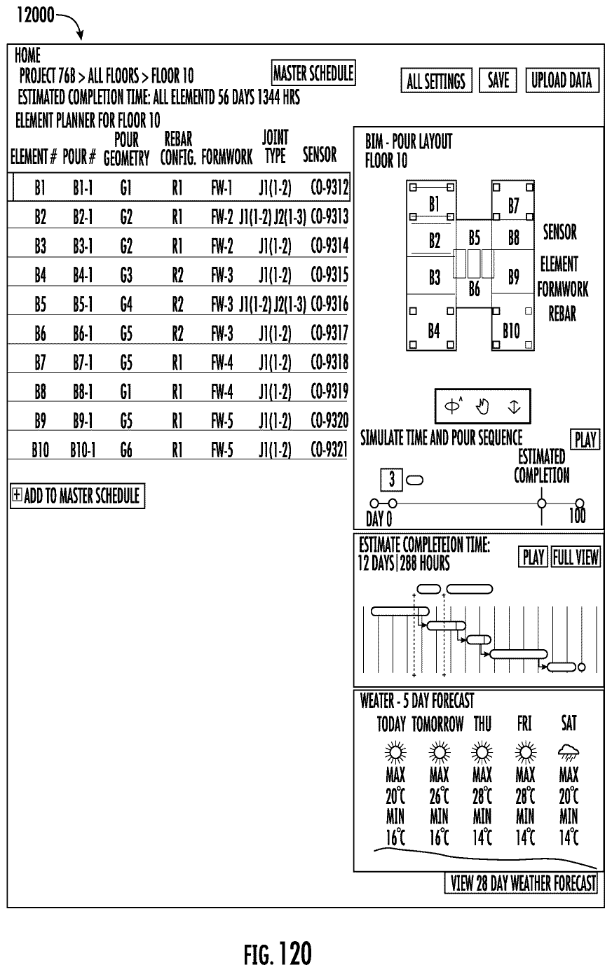

Thereinafter, as shown in operation 9508, the apparatus (e.g., server 200) includes means, such as processor 202, machine learning (ML) module 208, or the like, for outputting the material identifier (e.g., mix formulation) of the building material. As described herein, the system 100 may operate to, in some embodiments, present the mix formulation to a user associated with the system. In other embodiments, the output at operation 9508 may be supplied to any other ML models described herein. For example, an output of an evaluation model may be supplied as an input to an example generative model. In some embodiments, the system may generate a user interface for displaying data entries associated with the material identifier, such as those illustrated in FIGS. 116-120

FIG. 96 illustrates a flowchart containing a series of operations for mix optimization using predictive ML (e.g., method 9600). The operations illustrated in FIG. 96 may, for example, be performed by, with the assistance of, and/or under the control of an apparatus (e.g., server 200), as described above. In this regard, performance of the operations may invoke one or more of processor 202, memory 206, communication interface 204, and/or machine learning (ML) module 208.

As shown in operation 9602, the apparatus (e.g., server 200) includes means, such as processor 202, or the like, for receiving a first dataset including one or more first data entries associated with one or more material properties. Such operation may occur substantially the same as described above with reference to operation 9502.

Thereafter, as shown in operations 9604 and 9606 the apparatus (e.g., server 200) includes means, such as processor 202, machine learning (ML) module 208, or the like, for deploying a predictive machine learning model on the first dataset to determine a material identifier associated with the building material. As described above, predictive models may include one or more of a model that identifies a raw material from partial knowledge of its static material properties, a model that predicts the remaining static material properties of a raw material from partial knowledge of its static material properties, a model that identifies a composite material from partial knowledge of one or more of its compositional and/or static material properties, a model that predicts the remaining compositional and/or static material properties of a composite material from partial knowledge of one or more of its compositional and/or static material properties, and/or a model that predicts the contextual material properties of a material from complete or partial knowledge of its static material properties and/or compositional material properties and/or contextual conditions. The present disclosure contemplates that any of the predictive models described above may be leveraged by the operations described herein.

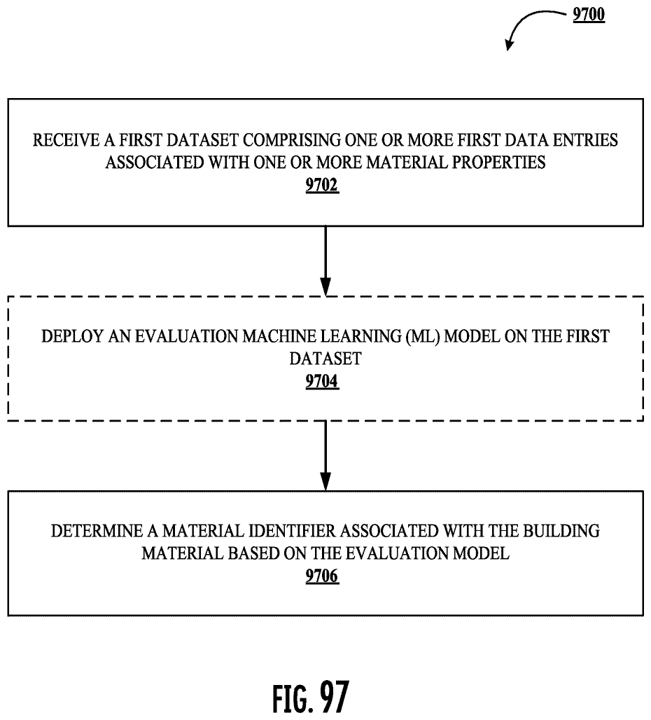

FIG. 97 illustrates a flowchart containing a series of operations for mix optimization using evaluation ML (e.g., method 9700). The operations illustrated in FIG. 97 may, for example, be performed by, with the assistance of, and/or under the control of an apparatus (e.g., server 200), as described above. In this regard, performance of the operations may invoke one or more of processor 202, memory 206, communication interface 204, and/or machine learning (ML) module 208.

As shown in operation 9702, the apparatus (e.g., server 200) includes means, such as processor 202, or the like, for receiving a first dataset including one or more first data entries associated with one or more material properties. Such operation may occur substantially the same as described above with reference to operation 9502 and 9602.

Thereafter, as shown in operations 9704 and 9706 the apparatus (e.g., server 200) includes means, such as processor 202, machine learning (ML) module 208, or the like, for deploying an evaluation machine learning model on the first dataset to determine a material identifier associated with the building material. As described above, evaluation models may include one or more of a model that evaluate the degree to which a static material property matches a target static material property for a specified composite material and set of contextual conditions, evaluates the degree to which a predicted contextual material property matches a target contextual material property for a specified composite material and set of contextual conditions, and/or evaluates which composite material—from a chosen set of pre-existing composite materials—are predicted to most closely achieve one or more target contextual material properties for a specified set of contextual conditions. The present disclosure contemplates that any of the evaluation models described above may be leveraged by the operations described herein.

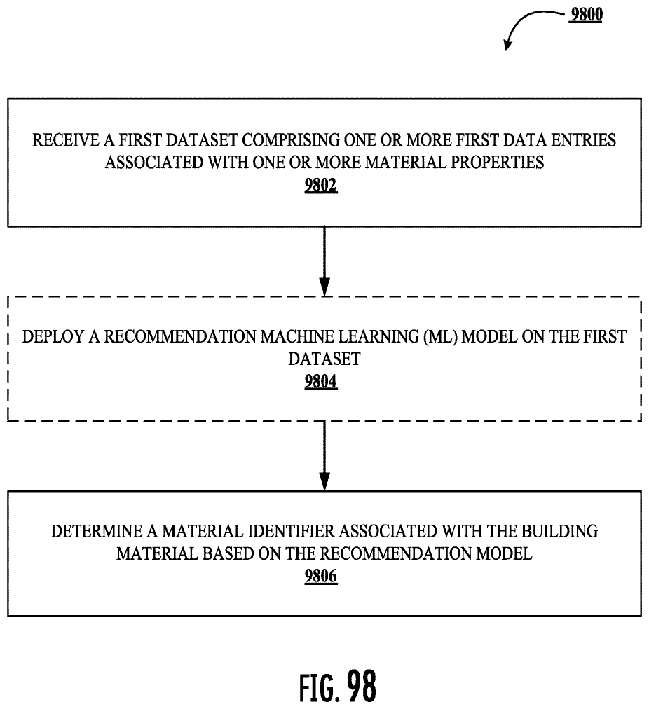

FIG. 98 illustrates a flowchart containing a series of operations for mix optimization using recommendation ML (e.g., method 9800). The operations illustrated in FIG. 98 may, for example, be performed by, with the assistance of, and/or under the control of an apparatus (e.g., server 200), as described above. In this regard, performance of the operations may invoke one or more of processor 202, memory 206, communication interface 204, and/or machine learning (ML) module 208.

As shown in operation 9802, the apparatus (e.g., server 200) includes means, such as processor 202, or the like, for receiving a first dataset including one or more first data entries associated with one or more material properties. Such operation may occur substantially the same as described above with reference to operation 9502, 9602, 9702.

Thereafter, as shown in operations 9804 and 9806 the apparatus (e.g., server 200) includes means, such as processor 202, machine learning (ML) module 208, or the like, for deploying a recommendation machine learning model on the first dataset to determine a material identifier associated with the building material. As described above, recommendation type models may operate to suggest an adjustment to one or more sets of static material properties, compositional properties and/or contextual conditions, for the purposes of achieving a target contextual material property, or other material or non-material attribute of some system. For example, a recommendation model may include a model which recommends a mix from a given list, without adjustments. A material adjustment model is designed to recommend a set of changes to the static material properties and/or compositional properties of a composite material (such as a cementitious mix) in order to meet a target set of contextual material properties under specific contextual conditions. For example, the model will suggest changes to the proportion of cement in a cementitious mix in order to meet a 28 day compressive strength requirement. A context adjustment model is designed to recommend a set of changes to the contextual conditions of a composite material (such as a cementitious mix) in order to meet a target set of contextual material properties. For example, the model might suggest a change in the geometry of a cementitious mix so as to reach a 28 day compressive strength requirement. A material and context adjustment model may recommend a set of changes to the static material properties and/or contextual conditions of a composite material (such as a cementitious mix) in order to meet a target set of contextual material properties. For example, the model will suggest a change in the date at which a cementitious mix is poured (so as to modify the environmental temperature) and a change in the proportion of cement (in order to affect the early-age strength gain), so as to push the system towards a target 7-hour compressive strength requirement. The present disclosure contemplates that any of the recommendation models described above may be leveraged by the operations described herein.

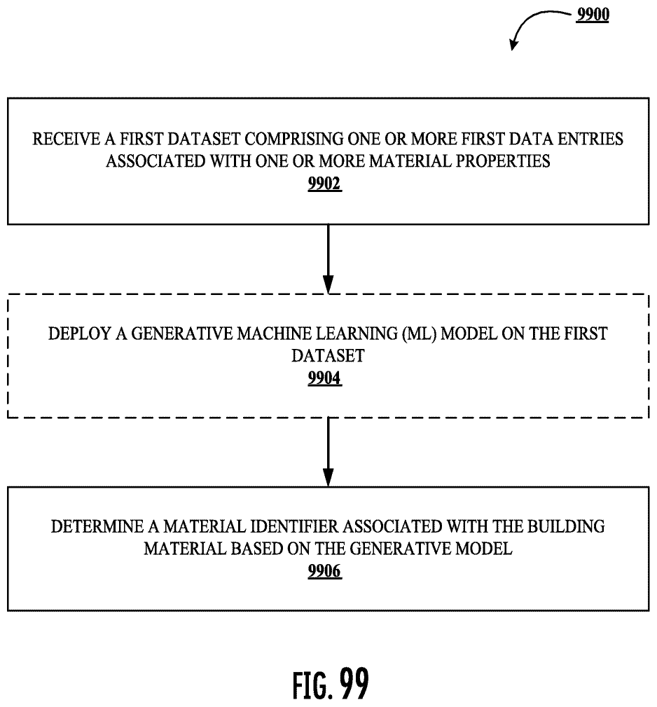

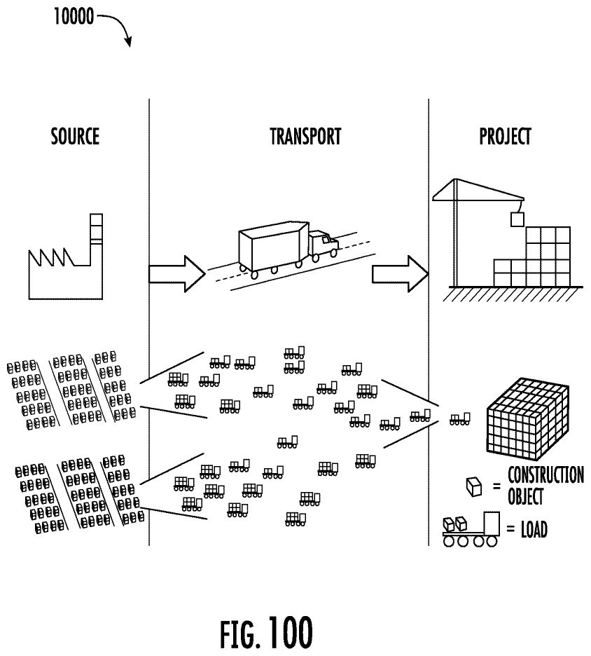

FIG. 99 illustrates a flowchart containing a series of operations for mix optimization using evaluation ML (e.g., method 9900). The operations illustrated in FIG. 99 may, for example, be performed by, with the assistance of, and/or under the control of an apparatus (e.g., server 200), as described above. In this regard, performance of the operations may invoke one or more of processor 202, memory 206, communication interface 204, and/or machine learning (ML) module 208.

As shown in operation 9902, the apparatus (e.g., server 200) includes means, such as processor 202, or the like, for receiving a first dataset including one or more first data entries associated with one or more material properties. Such operation may occur substantially the same as described above with reference to operation 9502, 9602, 9702, and 9802.

Thereafter, as shown in operations 9904 and 9906 the apparatus (e.g., server 200) includes means, such as processor 202, machine learning (ML) module 208, or the like, for deploying a recommendation machine learning model on the first dataset to determine a material identifier associated with the building material. As described above, generative models may generate the compositional properties of one or more composite materials, where those composite materials are chosen by the model on the basis of their ability to match one or more target contextual material properties, within a specific set of contextual conditions. In some versions of the generative models, the generated compositional properties may include raw materials that may not exist in the database of raw materials, or those raw materials may otherwise exist but in an incomplete form (where not all static material properties are known).

If the raw materials proposed by the generative models do not exist (or their information partially exists), the model will also generate the static material properties of those raw materials or will fill in the expected static material properties that are absent (e.g. a generative model may suggest a raw material with a specific density, pH, grain size that a human would then have to create and/or discover in the real world). The present disclosure contemplates that any of the generative models described above may be leveraged by the operations described herein.

### Electrochemistry Impedance

In one embodiment, the material properties of a cementitious mixture may be characterized using data generated by electrochemical sensors configured to use electrochemical techniques. Electrochemical techniques employ electric potentials to determine electrochemical properties of materials, associated with the displacement of charged ions in the medium. Wherein the material is a cementitious mix such as concrete, as the hydration reaction progresses, less ions may be free to move in the medium. This therefore provides a way of monitoring the curing of mixes. Measurable material properties using electrochemistry applications may include properties such as electrochemical impedance, admittance, conductivity, resistivity, all of which may be determined at different AC voltages. Electrochemical impedances may be measured as

$$Z ( ω ) = \frac{V ( ω )}{I ( ω )} ,$$

wherein V(ω), denotes the applied input potential difference as a function of frequency, and I(ω) denotes the induced current. Z(ω) is in general a complex function, and as such comprises a phase and magnitude component, which may individually be characterized. Input signal configurations may include but are not limited to pure sinusoids, any superposition of sinusoids, sweeps, chirps and pulses.

Wherein the electrochemical impedance is characterized over a frequency range, this may be referred to as Electrochemical Impedance Spectroscopy (EIS). EIS allows for more comprehensive characterization of the material and its properties. These properties may be related back to the compressive strength, and curing rate of the mix, as well as for porosity determination application. In one embodiment, the electrochemical sensor used herein may be an embedded sensor comprising one or more electrochemical probes, optionally configured for electrochemical tomography. In such embodiments, electrochemical data generated by these sensors may be stored in our database and used by the models for training purposes, as well as mix property prediction determination. For example, this may be used to train the models to predict electrochemical impedance spectra for given concrete identifiers. In further embodiments, this data may be used for mix selection, evaluation, adjustment and/or generation purposes. For example, a mix may be selected based on certain criteria relating to the porosity of concrete, which may be predicted by the models using embeddings learnt from electrochemical training data. In another example, mixes may be evaluated by the models based off of electrochemical properties such electrochemical impedance experienced by ionic charges. Mixes may also be adjusted based on preferences for example relating to conductivity of the material. The models herein may construct an internal representation of mix space from the mixes in their database, wherein mixes are placed in that space based on their conductive characteristics. This mix space may be labelled with mix composition and/or mix identifier data. The models herein may adjust a mix from one part of mix space to another using this internal representation. Finally, mixes may be generated which satisfy certain behavioral constraints related to ionic conductivity of the material.

### Electromechanical Impedance

In one embodiment, the material properties of a mix may be characterized using data generated by electromechanical sensors, such as piezoelectric transducers, configured to act as sensors and actuators and use electromechanical techniques. Such techniques employ couplings between electric and mechanical energy to input signals and excite materials through mechanical deformations e.g. stress, strain. Input signal configurations may include but are not limited to pure sinusoids, any superposition of sinusoids, sweeps, chirps and pulses. Wherein the material under consideration is a cementitious mix e.g. concrete, a particularly notable technique for characterization of the material includes Electromechanical Impedance Spectroscopy (EMI). EMI may be used to construct electromechanical impedance, admittance, reactance, and phase spectra, characterizing the mix over a wide range of frequencies (typically in the 1 kHz to 1 MHz range). This may be used to characterize the bulk properties of the mix, including but not limited to its young's static modulus and modulus of elasticity. As a mix cures, it transitions from fresh to hardened. As such, its bulk mechanical properties also evolve. Therefore, EMI methods may be particularly advantageous for concrete curing monitoring and compressive strength determination. Specifically, in these applications, resonance peak frequency shifts, as well as amplitude shifts in the characteristic impedance spectra may be features of interest.

In some embodiments, the inventors disclose the use of an embedded, ultra-low power electromechanical sensor, configured for EMI Spectroscopy, used to produce EMI data, which may be further employed by the models, methods, and systems herein. In one embodiment, this data comprises the system database, and is ingested by the models herein for training. Using EMI data for training allows the models to predict bulk mechanical properties of cementitious mixes, as well as compressive strength, porosity, mechanical properties of the aggregate/filler for given mix identifiers in given contexts, over time. In embodiments wherein EMI data comprises EMI tomography data, these properties may be predicted as a function of spatial coordinates of the material. In further embodiments, this data may be used for mix selection, evaluation, adjustment and/or generation purposes. For example, the models herein may be configured to select a mix based on a criteria of its young's modulus (e.g. select the mix with the highest young's modulus from a given list). The models herein may also use predictions based on EMI data to evaluate cementitious mixes with respect to their mechanical properties, including bulk properties, strain, stresses, mechanical resonance modes, compressive strength and more e.g. by ranking mixes from a given list against each other on any of the aforementioned predicted properties. The models herein may be configured to adjust a given mix based on its predicted electromechanical properties, for instance its EMI spectra. A behavioral constraint may be placed upon the impedance peak shift over time (e.g. peak must shift by at least 5% over a predetermined time interval), which the models herein may use to adjust an existing mix which doesn't meet the criterion. Gradient descent may be used to search mix space for an optimum, using the initial mix as an ansatz. Mixes may also be generated by the models, configured to for example, satisfy behavioral constraints related to their mechanical properties. In one embodiment, genetic and/or evolutionary models may be used to search mix space, iterating through generations of mix designs until a fitness requirement is met (e.g. requirement upon the bulk mechanical properties of the mix).

### Maturity and Temperature

In one embodiment, material property determination may be characterized on the basis of temperature, maturity and calibration data. Using temperature sensors, including multi-probe thermal tails embedded in the material, which may be a cementitious mix such as concrete, enables thermal characterization of the material at multiple locations within the sample. Wherein the material is a cementitious mix, and especially when it is concrete, it is possible to characterize the compressive strength of the material using thermal data in conjunction with the maturity method, wherein concrete maturity refers to concrete maturity as defined in ASTM C1074. This includes the use of temperature data captured through sensor measurements, maturity data comprising maturity function related information associated with the mix identifier, and calibration data comprising calibration/fitting function information associated with the mix identifier. A pre-existing database of thermal material measurements, alongside material identifiers, as well as maturity and calibration data for a plurality of respective mixes and/or associated pours, may be used for training the models herein. This may enable the models herein to predict thermal properties of cementitious mixes given for example, meteorological data and a mix identifier/mix library. If this data comprises temperature data collected from multiple points within a material, spatial thermal distribution may be predicted. This may be done using purely statistical, and machine learning based methods, may be done using physico-chemical modelling, or a combination of both.

In further embodiments, temperature, maturity and/or compressive strength predictions may for example further be based on predicted exothermicity and geometry data for a concrete pour. Activation Energy data may also either be ingested by the models herein as inputs or predicted as a material property. Using calibration data and maturity data, the models herein may be configured to predict the compressive strength of cementitious mixes based on temperature data. In further embodiments, given historical mix library data, including calibration data, thermal data and maturity data, the models herein may be configured to predict appropriate calibrations for given mixes. In the case where the mix exists in the library, this may be done using lookup table methods. In cases where the mix is not in the library, interpolation from existing mixes may for example be employed. Thermal properties of mixes such as but not limited to temperature at a point, spatial temperature distribution, exothermicity, activation energy (as relating to the exothermic hydration reaction), may in general be sensed using thermal sensors, and included in the mix database. The models herein may be trained upon these parameters and therefore be able to predict these properties for a given mix in a given environment/context and comprising a certain geometry.

Mixes may be selected based on behavioral constraints imposed upon one or a combination of these parameters. For example, it may be advantageous in some instances, to select a mix with low activation energy, for example in situations where low barriers to hydration is desirable. Mixes may be evaluated on the basis of predicted in-situ strength for in given contexts (e.g. the closer a mix is to 30 MPa on day 28, the higher the mix is evaluated). Mixes may be adjusted on the basis of predicted calibration data. Constraints/bounds placed on the calibration curve of a concrete element may be used to adjust a mix such that it meets the desired calibration. Mixes comprising a given exothermicity may be generated by the models herein.

### Temperature & Impedance

In some embodiments of the present disclosure, multivariate data may be ingested by the models for more comprehensive, orthogonal characterization of the material under consideration (e.g. mix). One such class of embodiments comprises the combination of temperature and impedance measurements, wherein impedance may refer to electrochemical impedance, electromechanical impedance, electromagnetic wave impedance, and any other impedance measurement type mentioned herein. Thermal data may provide temperature, maturity and compressive strength characterization of the material, which may enable the models to predict such measurements for a given mix identifier in a given context. Impedance measurements, depending on the type, may provide various properties and measurements, typically characterizing the material's resonance responses over frequency intervals. For example, in the example wherein the impedance measurement comprises electrochemical impedance as measured using EIS, the electrical and thermal properties of the material may be characterized. The correlation and/or couplings of these two types of properties may also be characterized, and in some embodiments normalized for and/or otherwise corrected.

For example, when both thermal and electrochemical data comprises the database, the models herein may be configured to predict the EIS of a particular mix composition, in given ambient (and/or other) temperature environments, which may be particularly advantageous since meteorological weather conditions may significantly alter the properties of mixes. In further embodiments, this data may be used for mix selection, evaluation, adjustment and/or generation purposes based on behavioral constraints comprising multivariate impedo-thermal constraints on materials. In further embodiments, sensor position data in the pour and/or relative to the pour, as well as sensor orientation data, and geometry data may be collected by sensor measurements and ingested by the models. This may enable the models to normalize for varying sensor configurations, in order to predict properties of the underlying material (on a context condition independent basis, or for standard context conditions). In one embodiment, wherein the sensor is embedded, thermal data may be used to calculate the approximate depth of a sensor, based on the thermal diffusion lag between the exothermic reaction of the cementitious mix and the ambient temperature of the surroundings. In another embodiment, mechanical methods (e.g. ultrasound) may be used to propagate pulses through the medium and characterize the edges of the shape using pulse-echo techniques for example. Orientation in some embodiments may be determined using accelerometers.

### Construction Resource Positioning

As used herein, a project may include a physical construction forming part of the built environment at any stage of its existence, including but not limited to its conception, design, construction, and operation. Examples of a project include but are not limited to a bridge project, building project, tunnel project or other commercial or infrastructure project. As used herein, a “Project” may include a physical construction forming part of the built environment at any stage of its existence, including but not limited to its conception, design, construction, and operation. Examples of a project include but are not limited to a bridge project, building project, tunnel project, or other commercial or infrastructure project. As used herein, a “Site” refers to any self-contained location associated with the construction project. This could be the jobsite, the precast factory, the batching plant, etc. As used herein, a “Construction Resource (CR)” is any physical item associated with the project. As used herein, a “Construction Process” encompasses processes that evolve construction resources in some way, shape, or form. As used herein, a “Passive/Inactive Resource” is a construction resource which is unable to drive forward an interaction. As used herein, an “Active Resource” is a construction resource which may be able to drive forward an interaction, but which may not necessarily always do so-Active resources can be used passively, depending on the interaction.

As used herein, an “Interaction” is a discrete instance of a construction process occurring within a continuous time interval, between two or more construction resources, oftentimes evolving location, and oftentimes with one resource being active and the other passive. Examples of interactions include but are not limited to an operative driving a nail with a hammer, a tower crane lifting a precast concrete unit, an excavator lifting a bucket of soil, a robot painting a wall, etc. As used herein, a “Subject” is a specific instance of an active resource during an interaction. An interaction can take in as an input multiple subjects. As used herein, an “Object” is a specific instance of an inactive resource during an interaction. An interaction can take in as an input multiple objects. As used herein, a “Construction Object (CO)” is any construction resource in the context of a project supply chain being used as a passive resource during the time period of a given interaction in which it is the object of the interaction. Examples of construction objects include, but are not limited to, precast concrete units, facade elements, bundles of rebar, buckets of wet concrete, bags of cement, hammers, and other tools, etc. As used herein, a “Construction Asset (CA)” is any construction resource in the context of a project supply chain being used as an active resource during the time period of a given interaction in which it is acting as the subject of the interaction. Examples of assets include, but are not limited to, forklift trucks, human operatives, robots, tower cranes, lorries, barges, excavators, piling rigs, etc.

As used herein, a “Factory” is a type of Source of Construction Objects which creates CO's on its campus (namely construction precast elements) before delivering one or more CO's at a time in loads. Examples of this include but are not limited to precast factories, steel fabrication yards, MEP and facade module factories, etc. As used herein, a “Prefabricated Element” or “Unit” is a discrete prefabricated volume, oftentimes concrete, produced at a factory, with the eventual goal of comprising a structure to be constructed. As used herein, “Transportation” refers to the movement of construction objects and assets from any part of the construction value chain to another. As used herein, a “Load” is a collection of construction objects grouped together in such a way that they are able to be transported from their source (factory or supply source) to the project site. As used herein, a “Source” is a Source of Construction Objects which delivers one or more CO's at a time in loads to another location in the supply chain, but can also be the destination of a CO's delivery (i.e., when a CO is rejected from a project site and returns to the Source for remedial works). Examples of this include but are not limited to staging yards, fly factories, factories, foundries, batching plants, construction sites, etc.

As used herein, “Construction Logistics” refers to the coordination of the chain of inter-dependent interactions that constitute the project. As used herein, a “Logistics Tracking Solution Stack (LSS)” is a family of algorithms that stack on top of each other with the aim of tracking Construction Logistics, including locations and interactions of construction resources.

As used herein, “Tracking” refers to the determination of the real-time state of any physical or digital entity.

### Introduction

Tracking construction resources position and interactions, progress of processes and providing tracking insights to various stakeholders—also referred to as construction logistics tracking. There currently exists a tremendous lack of relevant objective data in the construction industry when making logistical decisions. This has direct consequences on the logistics of construction operations. Construction operations planners are unable to make the optimal decisions when it comes to the coordination of their operations, operatives in the field must carry out these plans with incomplete, often incorrect information, and stakeholders are extremely limited in the way of tracking quality standards, and confirming these are being met.

Furthermore, the logistics of construction operations involve navigating a complex intersection of space, time, and materials which is so complicated it exceeds the limit of human comprehension. Facing this complexity, human error and incorrect judgement are inevitable. Also, construction sites often suffer from slip in delays from continuous inefficiencies over time.

For instance, take an example of a truck arriving on site with precast concrete elements or modular facade units. If a truck of these construction objects arrives 30 minutes late on site, there would be simplistically 2 crews of humans and tools affected. One unloads the truck objects to a construction asset such as a crane, and the other removes the object from the crane for installation. These crews are generally not aware of the greater picture of the project, but rather, are told by a manager with more information at their disposal where and what their next task is. As such, in the case of a late truck arrival, if the crews' manager doesn't know this is going to happen, the crews will be in place at the scheduled time of arrival, only to find by observation that the load has been delayed. In any case, the crew is not being fully utilized from this point onwards. They will only start being well-utilized if their manager sees the situation unfolding and delegates them to another task or if the load arrives. In both cases, this will result in a lack of productivity for about 5 people and their associated tools for a non-trivial part of an hour.

When a deviation from the plan occurs, field managers are generally responsible to solve the issues caused. This is often done inefficiently due to lack of data tracking construction resources and processes.

A key aspect of this invention is therefore to leverage device measurement data and AI to track construction resources and processes-tracking their locations, interactions, and wider progress statuses. Access to this data will allow construction operatives to execute more efficiently.

There is one major problem to solve towards this end which includes the tremendous lack of data relating to construction logistical operations, in particular, the location of construction objects in space and time.

The previous sections in this description have attempted to address these problems by tackling certain aspects of construction and construction materials. This section continues this and deepens upon the previous sections by attempting to now address this problem, from the lens of construction resource and process tracking holistically through the lens of the entire supply chain of raw materials, component fabrication, transportation, and installation.

The principal purpose of the techniques and methods described herein therefore may be described as providing data, visibility, and insights into the logistics of construction operations (i.e. construction resources and construction processes) through the use of logistics devices sensing & AI-based data processing techniques.

Current Methodologies Available and their Shortcomings

For the most part, currently little data is gathered in a way that would make it usable for future decisions or even understand present construction logistics operations. When data is collected, it is generally subject to human error and subjectivity, meaning it cannot be relied upon to make decisions. The following are examples of current methods and their shortcomings to monitor construction resources for a project.

In some embodiments, Quality Assurance includes handwritten forms (e.g., these are ripe with human error/bias and hard to query en-masse), visual Inspections by operatives (e.g., these are often stored as image files in an unstructured fashion, leaving little context as to where the picture was taken or allowing for any other metadata to be attached), and other shortcomings (e.g., these are often not digitally recorded, or recorded at all, QA data cannot be used to inform and improve operations, often inaccurate due to human error, lack of visibility for auditing purposes, high cost of acquiring data as all datapoints involve human labor).

In some embodiments, allocation of construction resources may include an overall view of all the site's interactions does not exist, project sites are usually so large that not all interactions can be seen by a human. Therefore, decisions are made based on what can be seen only, meaning the vast majority of the larger picture of the project is disregarded when decisions related to where to invest resources (energy) on the project. Shortcomings are associated with a non-optimal use of energy and resources.

The location of construction objects may include scanning QR Codes, manually typing updated locations into the database, or manually defining the element type. The problem with conventional methods of resource tracking is that they heavily rely on manual human input, which increases the risk of human error. For example, in precast factories, every time a unit is moved, an operative must correctly update the location of the element manually based on paper labels with barcodes. These labels are prone to damage, often fall off, and in practice are not scanned. As a result, the overall error rate for the location of inventory in the factory ERP can be as high as 20%. This lack of clarity around knowing foundational information of their product (it's location) means factories must divert resources towards re-locating or re-making these elements. Equally, this method of tracking does only allow managers visibility of a snapshot in time, making optimization of operations difficult.

With reference to the illustration 10000 in FIG. 100, benefits of the system can be found in all levels of the supply chain. Whilst all projects will have a unique supply chain, nearly all will have some aspect of the three parts shown in this schematic, with an ideal linear flow of material from Source to Site (although this may not always be the case, as in the case of rejected construction objects on Site due to quality issues).

Overall, the invention has many benefits across the construction supply chain, including: Reduction/Elimination of Delayed Deliveries, Reduction/Elimination of late Delivery, charges from the transportation and site parties, reduction of Factory Overheads, more efficient use of resources, less time spent in unload/loading bays, automated and unbiased records of delivery timeliness and performance, on-time deliveries, transparency of what will arrive on site (i.e. what is on the back of the lorry), and reduced site delay.

### Description

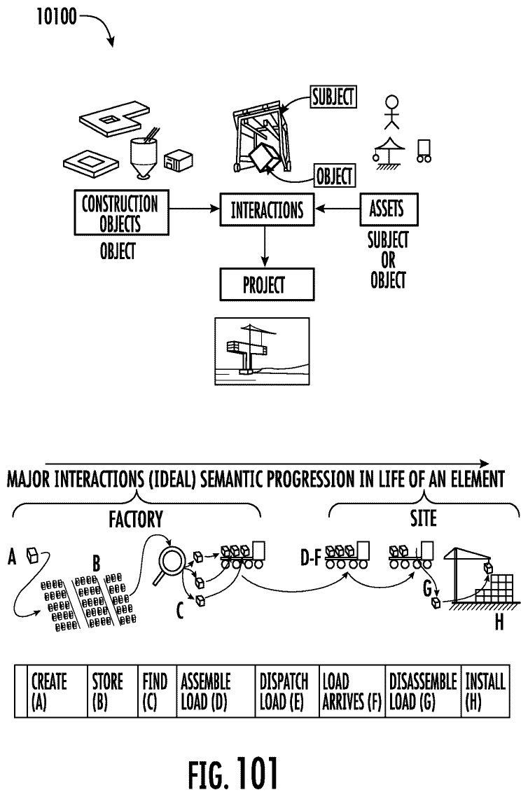

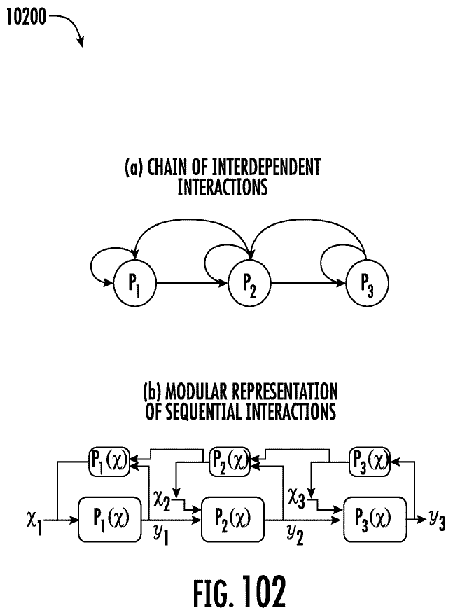

With reference to illustration 10100 in FIG. 101, the driver behind all construction operations is interactions. Interactions are the processes by which smaller/simpler construction objects come together to create larger/complex construction projects. Construction can be seen as a series of interdependent interactions, each of which could be represented as a mathematical function that takes in a certain input and gives out a certain output which gets fed into the next function. For instance, interaction ‘f’ can be represented mathematically as f(x), in which the interaction needs “x” as an input to generate the output ‘y’. A following Interaction ‘g’ can be represented mathematically as g(y) and depends semantically on process ‘f’ because ‘g’ cannot start without the result ‘y’. Once ‘y’ is available, g(y) can be executed. Construction Logistics may be defined as the coordination of the chain of inter-dependent interactions that constitute the project.

A practical example of f(x) and g(y) can be seen in the simple act of painting a wall—the wall must first be primed (f(x)) and before it can be painted (g(y)). To prime a wall needs certain inputs-priming paint, tools (COs), and a painter operative (CA)—to interact in order to arrive at the desired outcome state of a primed wall. Subsequently, to paint a wall involves an interaction of a primed wall, painting tools (COs) and painter operative (CA) to arrive at the desired outcome of a painted wall.

These examples are to stress the importance of interactions to the overall logistics of a construction project and the need for these interactions to be tracked/recorded. However, given the frequency of these interactions, they are currently rarely recorded. Even if they were, the number of interactions on a construction site would rapidly exceed the capacity of the human mind to efficiently comprehend.

Considering a construction element as the atomic unit of a structure, then the interactions that demarcate the life of all such elements become the enabling steps that will define the logistics of a construction project. The key milestones in the element's lifecycle are illustrated in table in FIG. 101. Traversing the path from left to right, the element becomes increasingly valuable as construction resources are utilized to move the element through its journey. This is the element value-chain that the system described herein will aim to track with the solutions developed here.

If as defined above, logistics is about the coordination of a chain of inter-dependent interactions, the failure in any link in the chain of interactions causes inefficiencies. Interaction tracking may allow operatives to prevent these failures.

With reference to illustration 10200 of FIG. 102, Construction Interactions may be represented as a graph, such as in FIG. 102 which depicts a graph chain where the nodes are the processes and the edges are the interactions, arrows indicate the direction of the dependency. These node-edge interactions may also be represented as nested functions which are pictorially depicted as a block diagram where each block represents a model of an interaction, incoming arrows indicate inputs, outgoing arrows are the outputs.

Based on the above, a valid logistics solution therefore needs to (1) track construction resources and (2) track interactions between construction resources. Therefore, the system's approach will aim to adopt the following: measure information about Construction Resources (instrumented at inception) over the duration of the Construction Project, and report this data in to project stakeholders. The above framework will be noted throughout the document where the input, output and methods will be specific to the tool being developed.

### Logistics Solution: High Level Description

Here the system may identify a system comprising a Logistics Solution Stack (LSS), which refers to a family of algorithms that stack on top of each other. The LSS is a system composed of connected sensor device(s) (as described herein prior), alongside AI and computer implemented methods (such as those described herein prior), for tracking the logistics of a construction project (or any similar environment such as a mining jobsite). To do so, the system tracks the location of construction resources and processes (and timing) and their interactions (e.g., a crane lift picking up a precast unit would be an interaction of two construction objects).

The analytics on the above are exposed to supply chain stakeholders. Tracking of the representation of construction objects in various information systems objects is also may also be leveraged to further enhance the system performance of use (e.g., tracking digital logs for QA, construction schedules, or integration with BIM models, this may be done using techniques described in linkage) or schedule data.

The proposed system will have the capacity to record various types of interactions between construction resources as they happen in real time. This will result in benefits related to allowing operatives to take decisions based on live information which otherwise would be inaccessible and invisible. Such an example of this would be a classic problem of quantifying “percentage complete” of a certain type of construction object in a certain part of a project at a certain time (i.e., MEP is 25% completed on Level 2 of the project on day 45 of the project).

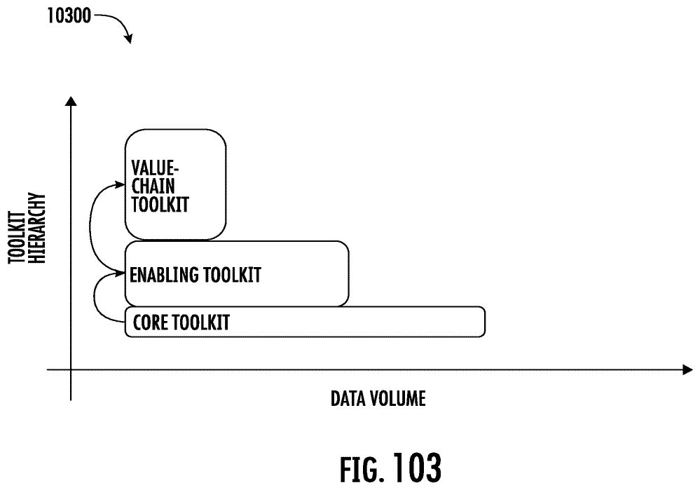

With reference to illustration 10300 in FIG. 103, the Logistics tracking solution stack is shown. The system may split the solutions defined here into three key families ordered by hierarchy (or equivalently the realizable impact of the solutions) in the context of construction. The data feeds are in the order from bottom (Core) to top (Value-chain). The horizontal axis provides a notional view of the data volumes, where the core tools deal with sensor level data, whereas the enabling tools will use the processes to inform the essential technologies. Appropriate combinations of these technologies will then feed the value-chain toolkit which directly maps to the element requirements at various stages in its lifecycle outlined in the table in FIG. 101, and directly impacts the construction space. The height of the boxes is illustrative of the value/impact embodied by the respective families to construction supply chain stakeholders' decision making.

The first step is to instrument construction resources and measure essential information. In this section, the system may consider the constituents of the core technology toolkit, including, a device (e.g., including communication between multiple devices), location (& time) tracking (e.g., of a construction resource), and interaction tracking (e.g., between construction resources).

Devices communicate information, which provide location and interaction monitoring tools. These tools form the basis on which the enabling toolkit is built. Hence the system may treat all three as foundational. It is worth noting that in other embodiments where the location tracking is an aspect of the device firmware rather than a separate logic. Other embodiments may also allow information flows and hence interactions to occur across device types (as it exists today) as well as within device types. Application of which may involve self-healing.

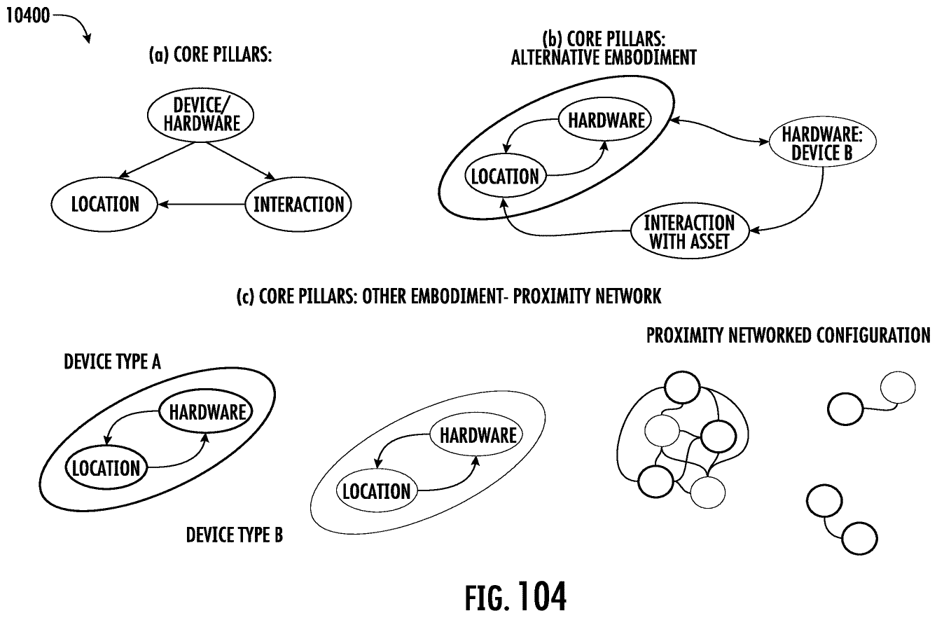

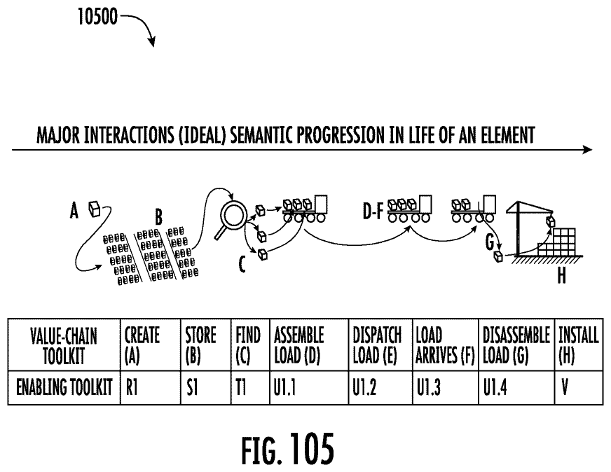

This data will be gathered by sensor systems or distributed sensor systems. These sensors may generally take the form of any hardware described in any of the sections herein. One instantiation of this sensor system takes the form of a battery powered Bluetooth low energy beacon (which can be embedded or surface mounted in building materials) and a battery powered Bluetooth & cellular gateway pair (which can be mounted onto construction plant or machinery). In this example, the beacon may contain an accelerometer & onboard temperature sensor. This system is particularly well suited towards 4D Location tracking (i.e. location & associated time tracking). FIG. 104 outlines the structure the present manifestation as well as subsequent ones.

With reference to the illustration 10400 of FIG. 104, the core pillars of Logistics in (a) its Core pillars where the device is distinct from core algorithms that deliver location and tracking inferences. In (b) an alternative embodiment where location estimation migrates to the device itself whilst determining interactions via current communication channels. In (c) networked embodiments each device can self-locate and interact in order to get a complete understanding of its location in the world as well as its neighboring devices, of similar and distinct types.

The enabling toolkit is the family of algorithms, with further sub-families organized according to functionality. These functions form a basis set of operations that in various combinations, will feed the Value-chain toolkit. In some instantiations, linkage techniques may be used to enable these functions. These functions are defined as: registration (R) of an element to a tagging device, its storage location(S), and its tracking (T) in the factory. Once an element forms part of a collection then the loads (L) tools will be used to track various stages and status of the toolkit. Finally installation (I) related tools will provide the right level of information regarding the building status. With respect to the value chain, this system involves the accurate, real-time and historical tracking and/or interactions of Construction Resources and Processes. The process and corresponding algorithms are split along the vector of key interactions in the life of a unit (See table in FIG. 101). As shown in the illustration 10500 in FIG. 105, the value-chain toolkit essentially maps the key milestones in the life of an element as outlined in the table in FIG. 101 to the tools developed in the enabling toolkit.

### Detailed Description: Core Toolkit

The logistics solution hinges on the real-time and historical tracking of construction resources and their associated interactions, as identified as the core toolkit. The rest of the system may be realized using these fundamental elements, including other data gathered or related to systems described herein such as Mix Fingerprinting, Self-Detection/Context Awareness, Status Inference, Pour Design and Sequencing, Construction Data Linkage, and any other information/data and information/data sources and/or entities mentioned within this description such as construction plans and schedules, specifications, machine records and more.

A detailed description of three pillars in the current embodiment is provided with other possible embodiments outlined as sub-sections. The problem was posed and the detailed description described the core algorithms for location and tracking. The three pillars include: Hardware and Physical System Implementation, 4D-Location (time+3D location) Tracking Algorithms, and Interaction Tracking Algorithms. The latter two together may be referred to as the Core Toolkit Algorithms. Tracking construction resources involves instrumenting them using devices. This further enables tracking construction processes associated with those resources. The way in which construction resources are instrumented is referred to as the logistics physical system implementation. This constitutes the Core Toolkit's first pillar.

Construction processes typically involve two, and often a plurality, construction resources (construction objects or assets) interacting. Typically, these construction resources may be characterized as objects of the process or subjects of the process. The object in this case would be the construction resource driving an interaction. The subject would be the resource being acted upon (operator-function type relationship in mathematics). In the world of processes which evolve the location of construction resources, these may be characterized as movers and entities being moved—the system may characterize the former as assets and the latter as construction objects.

Logistics Devices may refer to any device, device type, device embodiment, or system of devices configured to measure data that would enable location and/or interaction tracking associated with construction resources and/or construction processes. This may include wave-based sensors, and non-wave based sensors, and/or any of the devices and techniques mentioned herein.

One core device and system embodiment is described herein. System comprised two types of devices: beacons and gateways. Beacons transmit advertisement packets over a Bluetooth antenna (BLE protocol) in an isotropic, undirected manner at regular intervals. Gateways have BT receivers that at specified intervals scan and process received BT packets, extracting the device identifier (the header in the BT packet) and storing as an attribute the RSSI (received signal strength indicator) of the BT packet received from the beacon. The gateway has a real-time clock so the beacon's data is imprinted with a timestamp. The gateway has a GNSS (global navigation satellite system) antenna to obtain GPS coordinates (longitude, latitude), and an orthogonal data-stream records the GPS location of the gateways duly timestamped. Both data-streams are stored in a repository that serve as inputs to the algorithms to be analyzed. In this form, gateways store absolute location information vis-a-vis. GPS; the beacons' signal strength provides relative location information, relative to a gateway at a given time. In summary, beacons are physically attached on or within construction resources. Beacons emit signals to be received by gateways or other beacons. Gateways then pick up on neighboring beacon signals & beacon sensor measurements.

In one embodiment, the system may consider construction elements prefabricated in a factory as the construction resource of interest. These may weigh several tons and are hence immobile until lifted by an asset (for example, forklift truck). Beacons may be mounted/installed on, or embedded in an element, and hence are associated with that element. Gateways are installed on an asset. If the beacons are within range of the gateways, then the gateway will receive the beacons data BT packets and will store the data in this packet along with the time-stamped GPS coordinates. This association may be enabled by linkage.

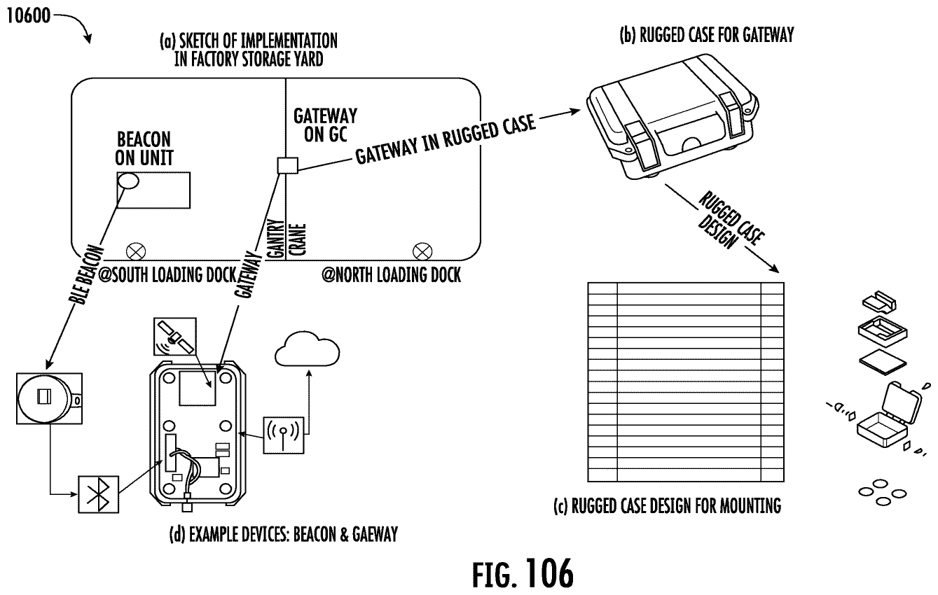

With reference to illustration 10600 in FIG. 106, indicating an example of devices, their configuration to construction resources and a sample implementation on site in a storage yard. The current implementation of the enclosing weather-proof box enclosing the gateway and a sketch of the mechanical structure designed for lifting at heights, suitable to withstand design loads by mounting them on, directing them at, or embedding them in any construction resource. This may include resources such as construction assets or also directly onto construction elements.

Similarly, beacons are physically attached to construction resources. These resources may be construction elements, in which case beacons may be attached on or inside elements. Installation methods may vary but may include using a strap (rubber or steel) attached to reinforcement cage, a curved device with a grip that fits different rebar configurations or other embedded element for “mounted on” type installations (screwed in, glued on, tied to a protruding bar, magnetically attached). This includes any installation method described in any section of this document.

Construction projects are complex dynamic environments, comprising many continuously moving and evolving resources and processes. This means that logistics devices (i.e., beacons and gateways in this embodiments) associated with construction resources may in general be dynamic (e.g., cranes, forklifts, trucks & shunters move in space) and may need to track other logistics devices/construction resources which may also be dynamic. The inventors have therefore developed novel dynamic localization and interaction tracking techniques to overcome this challenge. The case of a static logistics device/construction resource (i.e., fixed in place), reduces from the dynamic case.

As mentioned herein, logistics devices may be embedded inside of construction resources. In one specific embodiment, this may include a beacon device embedded inside of a construction element (e.g., precast concrete element, where the device uses any of the attachment methods for embedded devices described in this document). The system's methods allow for localization and interaction tracking using a system of embedded beacon devices. In such embodiments, the core algorithm toolkits are able to compensate for the effect of the host material on the signal generated by the device. For example, for a beacon embedded in a concrete element, the concrete (and any reinforcement) will attenuate the signal generated by the beacon by a characteristic factor based on the properties of the host material/concrete. This attenuation factor may be characteristic of the material properties of the host-material/concrete and may be adjusted/normalized/accounted for using context awareness techniques. Mix Fingerprinting techniques may further be used to allow characteristic attenuations to be recorded for certain mix identities, accounting for material contextual conditions.

In another embodiment, logistics devices may be “daisy chained”, or installed in a distributed configuration within range of each other. This may increase the tracking range of the entire logistics system. In one embodiment, this includes daisy chaining beacon devices around gateway devices. Using a single gateway and a distributed network array of beacons may allow for distributed, parallelized tracking of a multitude of construction resources. In this embodiment, each daisy chained beacon may achieve the same functionality as a gateway, wherein other beacons may be tracked and/or localized relative to this first beacon. Down the chain, all beacons may be localized/tracked relative to the gateway device. This includes, ‘non-selective’ and ‘selective’ daisy chaining where respectively all devices within ‘listening’ range may be routed on to the gateway and alternatively employs selective conditional logic, such as an enumerated information source like a white list or threshold on continuous data such as signal strength, to chain only a ‘select’ set of devices. One instantiation of this embodiment is advantageous for the tracking of embedded beacons, and for tracking stacking order of a plurality of prefabricated units and, by extension, can be used for load tracking.

Further Embodiments of Gateways and Beacons may also include embodiments comprised of any device type, sensor and actuator type, and/or device configuration listed herein such as mechanical wave-based devices, E&M wave-based devices, point devices or others, configured to track construction resources and/or processes. For example, an advanced embodiment may include the device described above, with the above system configuration, and which may additionally onboard other sensors and/or actuators such as accelerometers, gyroscopes, other inertial sensing systems, temperature sensors, and/or the like, as further described in other sections.

Beacons emit signals to be received by gateways. These signals may be E&M signals e.g. frequency bands of UV, visible spectrum, IR, RF for example Wi-Fi, Bluetooth, AM, FM, shortwave and/or others. Signals may also be mechanical waves for example ultrasonic waves, acoustic waves and/or others (as described in other sections). Signals may be generated by any sensor and/or actuator type including but not limited to those listed herein, for example this may apply to signals generated by wave-based sensing device and/or point sensing devices Embodiments may also take the form of arrays, including for spatial tomography processes. Time-domain reflectometry (e.g. through GPR techniques within construction elements, or more generally through E&M waves on the jobsite) may be employed to spatially map and position construction resources.

Beacons and gateways may become unified, miniaturized into a single device capable of detection and/or communication with all other devices with registration information providing the system full context. Further embodiments may also use context awareness techniques for positioning, interaction determination and any other technique listed herein, in any capacity (in particular, the use of structural and temporal data, such as BIM and construction schedules, may be used to refine positioning, by utilizing such resources as a priori knowledge, with an associated confidence bound).

The core toolkit algorithms are the location tracking algorithm and the interaction tracking algorithms. The problem definition outlines the following three key aspects: (a) statement with context and information around tracking and interactions, (b) based on received inputs, and (c) subject to the required outputs. The primary inputs to the algorithms may be any measurement (including RSSI signals) generated by any logistics device (including a beacon), which may include wave-based and non wave-based devices described herein, as well as any logistics device embodiment described above. The desired output should be (1) the determination of an interaction alongside relocation information (2) a precise location and timestamp coordinate for a construction resource.

Based on the signals received by gateways from nearby beacons attached to construction objects, there are three ways to estimate the location of the object, listed here in order of decreasing confidence of the prediction provided from interactions with a construction asset, from close proximity to a construction asset, and from trilateration.

Each of these methods will determine an interaction fingerprint using two independent sources of input: I=signal strength fingerprint indicating proximity between the asset and element, and A the correlated movement profile of the gateway relative to the beacon. Fundamental to all of these methods is inferring from the raw RSSI signals the following: Z=Proximity of Beacons and Gateways and Θ=Movement of Gateways.

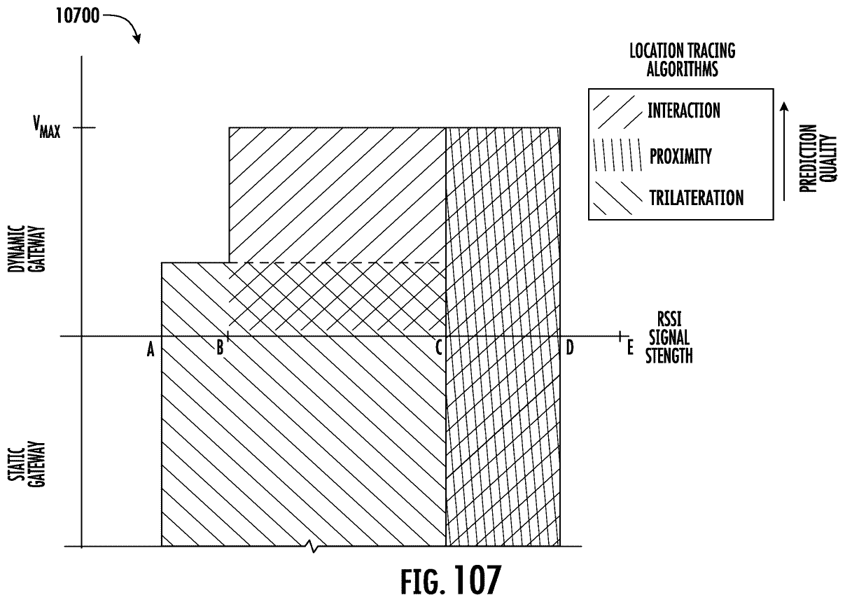

Both Z and Θ of these operate on a discrete spectrum, which if shown on a 2-axis plot, such as shown in illustration 10700 in FIG. 107, summarizes the domains in which each of the proposed methods are valid.

The problem statement includes detecting and/or determining and tracking (in space and time) an interaction between construction resources has occurred. A specific problem statement includes determining whether the system can identify when (in time interval [T1, T2]) an asset (A) has relocated an element (B), from a location (L1) to a new location (L2).

In some embodiments, the input may include the raw streaming data from the devices described herein. These are the (1) received signal strength indicator (RSSI) signals transmitted at prescribed intervals by a beacon and received by a gateway, and (2) the GPS coordinates referencing the location of a gateway at prescribed intervals.

In some embodiments, the output may include Construction Resources involved in the interaction, Timing of the interaction, and relocation coordinates of the element by the asset caused by the interaction.

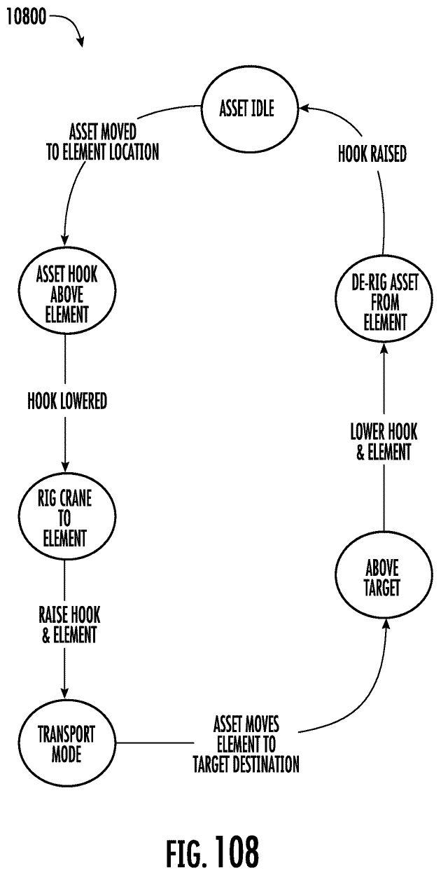

With reference to illustration 10800 in FIG. 108, a lift interaction state machine, between element and asset (focus on crane based lifting) is shown. Query 1 requires the system=to identify when an asset A has relocated an element B. An interaction state machine that highlights the essential tasks, outlined in the figure below breaks down the core states of such an interaction.

In terms of attributes, the interaction logic seeks an interaction fingerprint using two independent checks: Check 1—signal strength fingerprint indicating proximity between the asset and element. If Check 1 proves to be true, then Check 2 will determine if these fingerprints are correlated to a movement profile of the asset to the element and together to the destination.

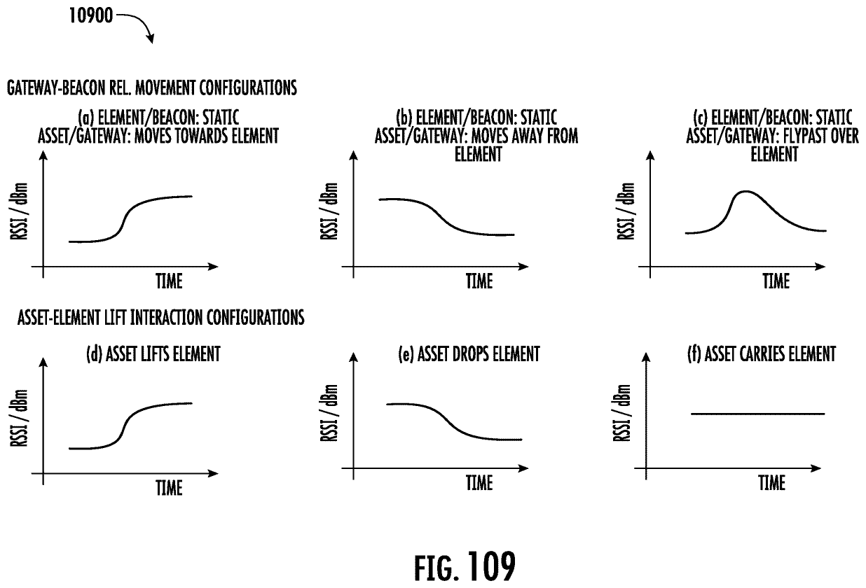

On a high level, Check 1 the fingerprint will have the following characteristics show in illustration 10900 in FIG. 109 compared to the state machine previously described:

Check 2 will then consider the gateway's GPS sensor data during the time range of the fingerprints above. If the change in position over this time range fits within a prescribed velocity range, the algorithm then can infer with high confidence that the beacon and gateway are together in this time period and it is highly likely that an interaction in which the construction object is a an object of an interaction is being executed by the construction asset.

An additional verification step that provides confirmation is that an estimated lift combines with the location estimation logic via another means to verify that the locations prior and post a detected lift are measurably different.

Interactions may be described as events which occur between two or more entities where these entities influence each other in some capacity—examples include but are not limited to evolving location, communicating, physically changing one entity. Using the location and timing data gathered by the above techniques, it is possible to determine whether an interaction has occurred between two (or more) entities and track the interaction.

In the most general case gateways and beacons can communicate as long as they are within range, the beacons transmit information and gateways act as receivers. The gateways may be mounted on construction assets or at static locations in strategic areas. In general there may be 4 possible scenarios: Static Gateway/Static Beacon; Static Gateway/Dynamic Beacon; Dynamic Gateway/Static Beacon; and Dynamic Gateway/Dynamic Beacon.

The specific subtleties of the algorithms for interaction detection may be different for each scenario, but the general logic of using signal strength correlation remains the same. The beacons or gateways may collect timestamps alongside each signal or sensor measurement point, in this way this becomes 4D Location Tracking. The system may synchronize & manage time drift through various network topologies.

Algorithmic specifics may vary depending on the particular configuration of beacons and gateway, as well as the type of interaction being captured. For example, one instantiation may involve the use of two gateways—one dynamic on an asset, and another fiducial (i.e. placed at a known, static location, not involved with the interaction)—and a dynamic beacon (i.e. beacon made dynamic by being placed on a dynamic object). In this instantiation, it may be possible to compare the signatures gathered by each gateway and determine an interaction. Another instantiation may involve a single gateway and beacon. In this case, comparison is impossible so the signature gathered by the singular gateway must be used in absolute terms to infer an interaction. Any conceivable combination of beacon and gateway configurations may be used here, alongside techniques such as self-detection mentioned prior. However, the broad algorithm logic and techniques retain similarity in each case. Interactions may allude to different types of activities involving beacon-gateway/entity-asset pairs and need not be limited to movement (or location alone). Therefore, certain signatures in gateway and beacon tracking data (including those based on the signal & sensor data, and a multivariate combination of both) may indicate these different types of interactions between the entities each sensor is linked to. One may therefore use these signatures to infer whether interactions have happened. Once this has been confirmed within a certain likelihood threshold, it is possible to classify these interactions by activity type and infer the nature of the interactions having occurred.

Interactions which evolve properties other than location (e.g., which change the physical or geometrical composition of an entity for example) may be determined by using the 4D-location determination data alongside any relevant technique described in or related to other sections of this document. In this way, the full scope of construction logistics related interactions may be mapped. One may also employ Machine Learning techniques described in other sections to automatically infer the interaction type with no use of prior knowledge. This may include the use of techniques outlined in Status Inference, Construction Data Linkage, Self-Detection, Pour Design & Sequencing (e.g., for pour related interactions) and other sections.

In some embodiments, the system may identify the location of any construction resource alongside associated time stamps (e.g., in a yard or on site).

In the scenario of a construction element prefabricated in a factory, and considering an abstraction of the sensors outlined herein, with a beacon synonymous with an element and a gateway with an asset, then the system may identify the location L of any element, alongside associated time stamps (e.g., in a yard or on site).

In some embodiments, the input may include the raw streaming data from the devices described herein. These are the (1) received signal strength indicator (RSSI) signals transmitted at prescribed intervals by a beacon and received by a gateway, and (2) the GPS coordinates referencing the location of a gateway at prescribed intervals.

In some embodiments, the output may include precise location and timestamp coordinate for an element. By inspection, the location specific problem statement is also answered with the answer to the interaction specific problem statement, as the location of the beacon will be known at the end of an interaction by assigning the GPS coordinate of the gateway involved in the interaction the time of the end of the interaction.

Noting that the yards have elements instrumented with beacons and are associated with specific lifting assets (gantry cranes, forklift trucks) that are all installed with operational gateways, the system may can then assume that virtually all beacons will be within range of at least one gateway several times a day. The fingerprint of the signals of these interactions, assuming no move was completed, can be translated into a location in one of two ways. Both of these methods rely on a predetermined relationship between distance of a gateway and the signals received by that gateway in the yard.

The first method of determining location directly, Proximity, can be employed when the signal strength exceeds a predetermined threshold such that it is accurate to assume that the asset and beacon passed so close to one another at time (t), that the beacon's location at time (t) what the gateways GPS coordinate at time (t).

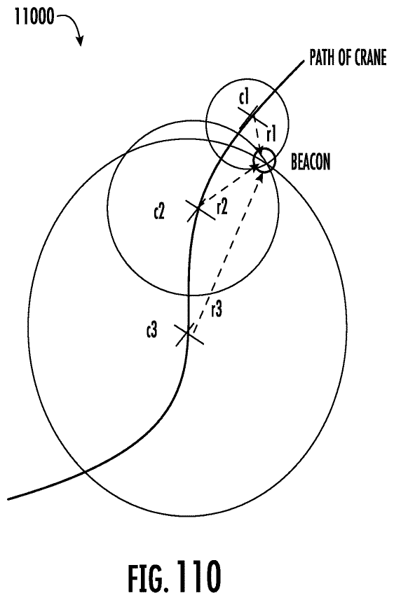

As shown in the illustration 11000 of FIG. 110, the second method of determining location directly, Trilateration, when the received signal strength of the beacon exceeds a certain minimum threshold but is also below the minimum threshold for employing proximity. One can use the GPS coordinates associated with (3) values which fall into this range and associating those signals with the predetermined signal-distance ratio, intersect 3 circles to arrive at an estimated location of the beacon. An example of this for a dynamic gateway on a crane and static beacon is shown in the figure below.

In other embodiments, the system's location system may be composed of devices (for example: gateways and beacons) that can, through novel proprietary algorithms that leverage machine learning, signal strength correlation logic & sensor inference, track location of assets. In the most general case gateways and beacons can communicate as long as they are within range, the beacons transmit information and gateways act as receivers. This relationship may be wrapped into a single device, where every device listens to all other devices on a public channel and prior private data exchanges through alternate means allows us to decrypt the information and add context, thus ensuring secure data even over standard channels.

The specific subtleties of the algorithms for location determination may be different for each scenario, but the general logic of using signal strength correlation remains the same. The beacons or gateways may collect timestamps alongside each signal or sensor measurement point, in this way this becomes 4D Location Tracking. The system may synchronize & manage time drift through various network topologies.

This foundational location determination technique may be enhanced in a number of ways. One may give beacons the ability to communicate with each other. In such a paradigm, it would be possible to create a daisy chain/mesh network of distributed, strategically placed beacons surrounding a gateway. In such a paradigm, signals from beacons theoretically out of range of the gateway may be relayed to the gateway by beacons closer to it, such that the location of those may be tracked. Another example where this may be particularly valuable is in refining the position/location of several precast units relative to each other in a stack of units in a yard. By relying on a mesh network of beacons, one could precisely determine the stacking order, further refining the positioning algorithm.

All techniques described in or related to Context Awareness may be applied for location determination, as well as techniques described in or related to Status Inference for statuses of elements and element locations and all the techniques and data types considered in or related to Construction Data Linkage.

All techniques described in or related to Context Awareness may be applied for beacon signal normalization or any other use case as described in Situational Context Awareness. Signals may vary with respect to weather conditions, installation configuration (embedded vs. non-embedded, depth of embedding, and the like are all variables which may affect the output signal). For example, for a case where the element is a precast concrete unit, using self-detection techniques, the embedding depth may be determined, and used as a parameter in the location inferencing algorithm to increase the accuracy of positioning.

Advanced embodiments include the augmentation of the beacon & gateway system (and the RSSI method) to include Time of Arrival (ToA) based localization. Time of Arrival based localization leverages time domain analysis. Assuming a synchronized clock (or by establishing one), the relative time difference between a signal being sent and received can be established. In light of sight scenarios, this can be used to detect the distance between construction objects. In practicality, reflections and multi-path interference may need to be cleaned out. The amplitude of any reflected signal should be lower, and there may be a phase shift, so it should be possible to identify the line of sight signal amongst a plurality of signals.

Another advanced embodiment employs angle-of-arrival based sensing, through antenna arrays. This may augment or replace RSSI-based and/or ToA methods. In AoA sensing, instead of estimating the distance of a signal (e.g. based on its RSSI) or the ToA, the angle of arrival of the signal is computed, using an array of receiving antennas. This can be done by comparing the differences in the time of arrival of a signal at a plurality of spatially separated antennas (separated with a known distance). This is known as the phase difference. By analyzing the phase differences, the system is able to determine the angle of the incident signal relative to a reference (which is known as the angle of arrival). Advanced signal processing techniques may be employed where significant multi-path interference is present, to clean the signal (optionally this is done using a machine learning model, trained on construction site data, or on synthetic simulated data for construction environments—for both embedded and non-embedded cases). Knowledge by the device, through other sensors such as wave based sensors, of its host material characteristics (e.g. in concrete, and geometry) can be used to augment the AoA method.

Another advanced embodiment employs accelerometer, altimeters, pressure sensors and/or other inertial sensor data to augment positioning and interaction accuracy of all the above methods. These sensors may be mounted on the beacon of interest, or on one or more gateways in proximity to the beacon, or on one or more nearby beacons, and will provide information on the acceleration, rotations and altitude of each device. This can be used to increase the accuracy of positioning. For example, in dynamic systems, accelerometer data may be integrated (over short periods of time) to estimate a velocity vector for the beacon or gateway. Over long periods of time, this will suffer from integration errors, but over short periods of time, it can be used to refine positioning estimations. Altimeter and pressure data may be used to locate the device in 3D space (including the floor it is on). These sensor data may be fed into a model (optionally a machine learning model), which may be executed on the device, a nearby device, or a server (or a combination of those), to provide higher accuracy positioning estimates.

In a further embodiment, the system is treated as a distributed system. RSSI, AoA and ToA data, sensor data of all of the above kinds is analyzed across a plurality of beacons, gateways, mobile phones and the like (where beacons are in both transmission, but optionally also receiving mode—e.g. through daisy chaining). This network of datasets can be combined to build a better positioning map. The multiplicity of data sources can be used to generate a higher resolution positioning determination and remove the influence of noise and/or multipath.

In another embodiment, a different global positioning or satellite system is used (e.g., Galileo, but also other satellites). In a further embodiment, the RF module is used to analyze opportunistic reference signals may be used (from satellites, FM radio stations, LTE or 5G mobile towers, Wi-Fᵢ access points, mobile phones or other sources). Optionally, the positioning of these signal sources is known. These signals will include synchronization sequences (which in some cases, may be encrypted). For example, these other third party devices may employ OFDM (orthogonal frequency division multiplexing). Synchronization sequences (such as the CRS emitted by an LTE cell-tower) can be extracted, and the period and changing frequencies of these signals can be characterized, and used for opportunistic positioning. This can be done with or without any prior knowledge of the expected signal structure. The applicable ground-based or satellite-base stations are detected. Their signals are analyzed for periodicity and synchronization sequences extracted. These are then used to obtain characteristics related to the position of the beacon and/or gateway.

In opportunistic positioning systems, positioning can be carried out without any uplink communication back to the signal source, which carries significant advantages. Further embodiment may employ the use of RFID or NFC-based positioning (with RFID or NFC-based beacons). These, in particular, would be better suited to low cost units. QR codes disposed on the units, alongside high resolution cameras (e.g. embedded in the gateways) may also be employed for positioning. Ultrawideband-based positioning may also be employed, which leverages high frequency radio (3 to 10 GHz), pulsed signals. Short (picosecond long) pulses are sequentially sent by the transmitter. ToA analysis is carried out (which can be carried out with very high precision given how short the pulses are). This allows for distance determination with accuracy of the order of 10 cm. Trilateration techniques (as already described) are then applied to determine the position. UWB carries particular advantages in non-light of sight scenarios.

In a further embodiments, one or more of the following is done: Quadrilateration is carried out for 3D positioning (that includes height). RTK GPS techniques are employed. Real-time Kinematic GPS augments GPS with fixed base stations of known locations. Positioning information is fused with laser scanning data (from total stations on the construction site). This allows the positioning of fixed (static) gateways and beacons (e.g. those that may have been mounted on the crane base can be considered static, and beacons embedded in units that have been installed can be considered static). Smartphones and other personal devices acting as gateways (either through a mobile application, or in the background, or otherwise).

As the construction of the structure completes, with embedded beacons, those units are installed in known locations (as defined by, for example, the BIM model, or laser scanning data operated by an operative). This provides further information to the system's models, for further refinement of positioning accuracy.

The advanced embodiments may also be combined (so trilateration/quadrilateration, angle of arrival, time domain analysis positioning, inertial and other sensor data, and nearby device data, a priori knowledge from BIM models and schedules would be combined into a model to output a highly accurate positioning determination). Expanding on the ideas described herein, the system may look at the specific aspects associated with the family of algorithms in the enabling toolkit.

### Register (R)

In some embodiments, the purpose may include creating a non-public (ideally encrypted) link between construction resource (asset or object) and its associated device. This may be implemented using construction data linkage techniques, and the techniques herein may also be used to augment construction data linkage.

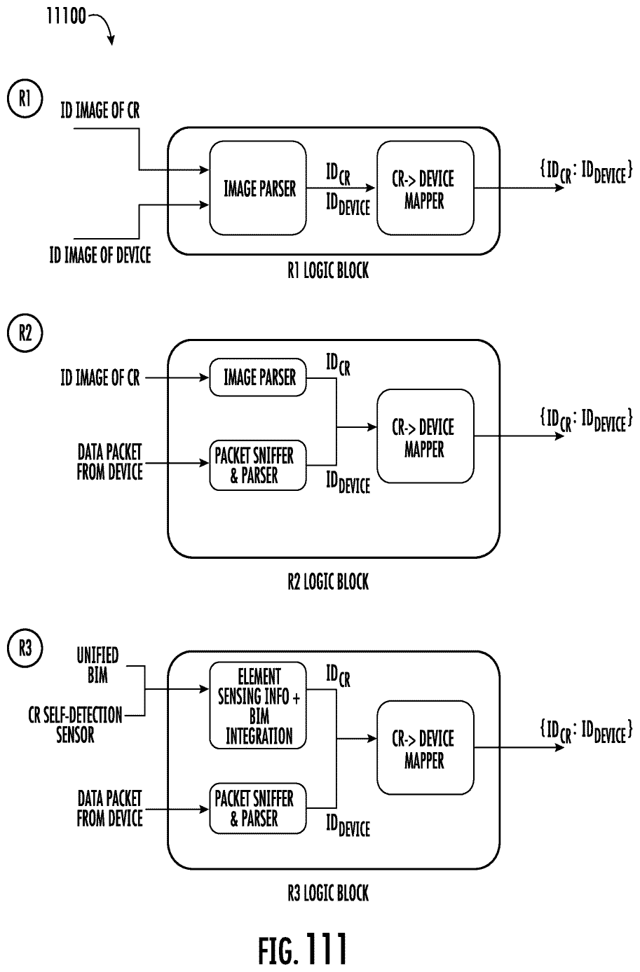

Broadly, the algorithm will use separate input data streams to connect the device to its associated resource. As shown in illustration 11100 in FIG. 111, this may include any construction resource-object or asset may be instrumented. Therefore, an identification system such as a raw image, or image of a barcode or QR-code for both the element and the device will be fed into system. The method effectively reads the inputs from element and device, where the reading method is dependent on input type (e.g., OCR for alpha-numeric codes, barcode/QR code reader for ID or 2D matrix of data, or any similar ID encoding information processor) that can extract the unique identifier from the image.

The algorithm may take the form of different embodiments. The R1, or Generation 1 algorithm, where the first data stream in an input that includes an image reader (with OCR/QR code/barcode reading) that converts images to textual data (or direct textual input of the element identifier), the second data stream is a similar textual/QR code/barcode. The internal logic creates a 1:1 mapping between the two, in order that they may be accessed. Internal logic includes error-checking to prevent non-unique mapping.

R1 inherently involves humans to use the application to registers the units. Double tagging can introduce inefficiencies and errors, hence in the 2nd generation (R2) the system may include packet sniffing logic to eliminate one less input stream/one less source of error.

Third generation (R3) may include integrating this invention with the tools available through sensor context awareness and construction data linkage the system may identify the Element Id and with the packet sniffer from R2 and completely eliminate any sources of human error.

### Store(S)

The purpose of the store(S) may include tracking the use of storage facilities for construction resources to improve/maximize throughput. Broadly, the algorithm will utilize tracking information about elements (historically and currently) stored in the yard, combined with enabling information to track storage space and stored units the system may require, which may include information about the state of the storage yard and its availability (supply and demand) of storage in the yard and the baseline method (e.g., effectively reads the locations of elements for a given snap-shot in time, and compares with storage availability).

### Track (T)

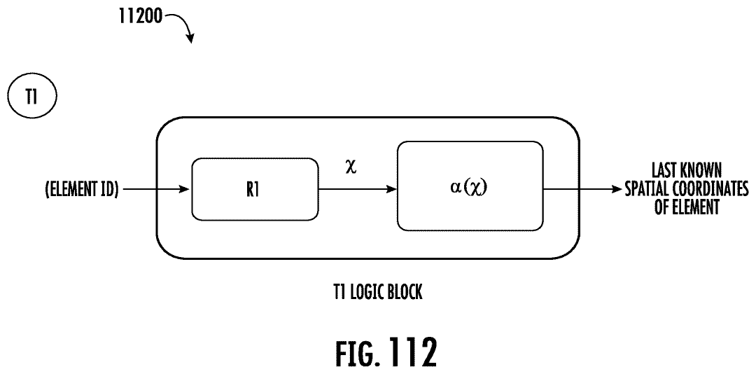

With reference to illustration 11200 of FIG. 112, the purpose of the track (T) may include keeping track of all construction resources anywhere and at all times. At its fundamental level the algorithm directly uses the location algorithm from the core toolkit where the location of every beacon is tracked for all time. The combination with the registration step provides the information about a given element. Increases levels of sophistication and integration provide further details. In some embodiments, this may include the element identifier and the baseline method (e.g., use block R1 to convert element ID into beacon unique ID). The location algorithm a infers beacon location and ascribes it to the element.

Generation 1 (T1) algorithm (base case), is the essential utilization of two tools in the system's kit-a from core toolkit and R1 from the enabling toolkit. The output will be a position coordinate for the element.

### State Determination: Loads (U) & Install (V)

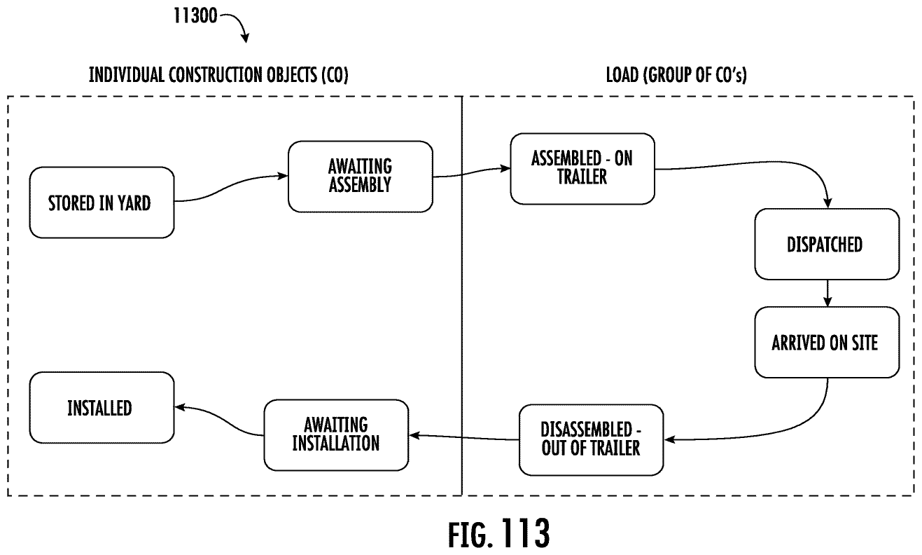

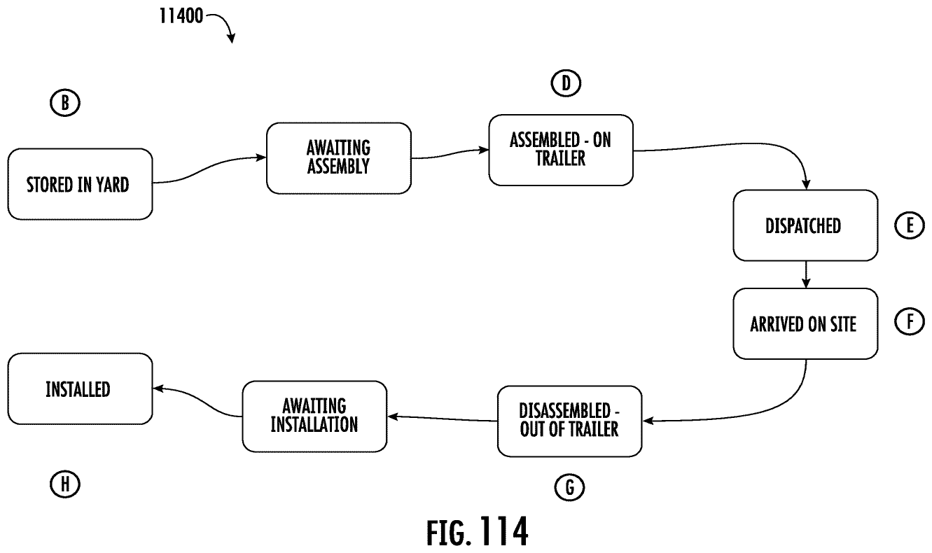

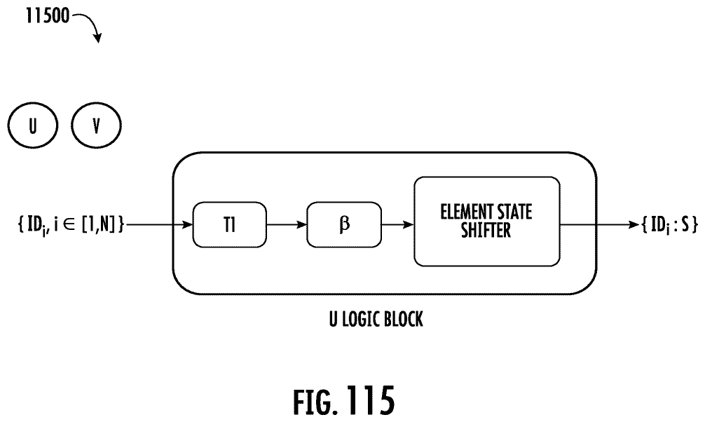

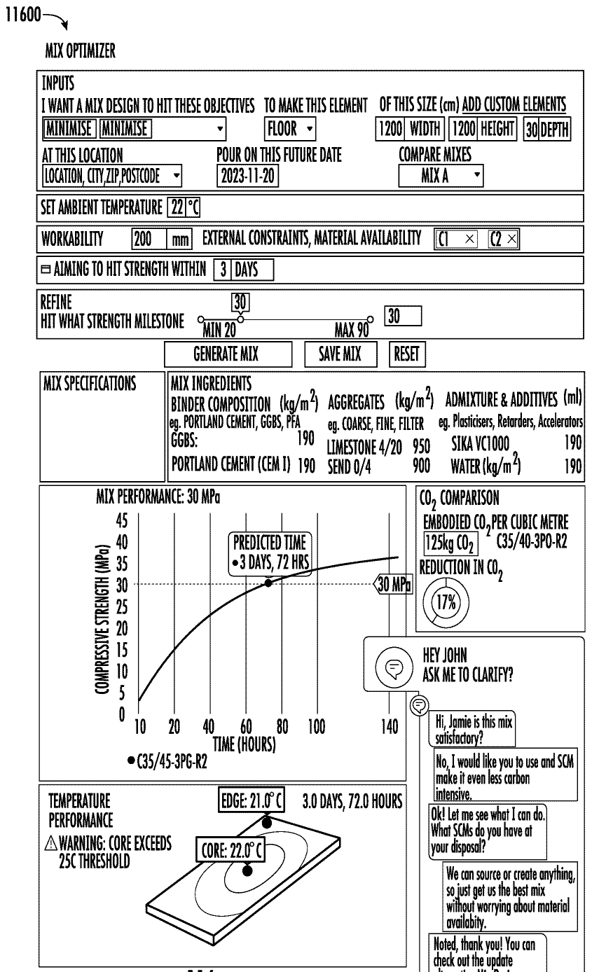

In some embodiments, the purpose may include tracking when an element is to become part of a load, on its destination to installation. An element is a separate entity until it is ready for dispatch, when it will be part of a load. Once it becomes associated with a load, its status is due for continuous update and a unidirectional state machine helps to keep track as illustrations 11300 and 11400 in FIGS. 113-114. As long as it is not destined for dispatch it will stay in ‘stored-in-yard’ status. When a grouping that this element belongs to is provided, it is immediately associated with a group and its status switches to ‘awaiting-assembly’. The logic block 11500 identified in FIG. 115 ingests the load list and tracks the location (T1) as well as interactions (core tools block) to identify when a unit interacted with an asset/was lifted on/off trailer. The final block is a state shifter that allows self-loops or forward loops (no reverting to prior status is allowed).

### Detailed Description: Logistics Value-Chain Toolkit

The value-chain toolkit essentially maps the key milestones in the life of an element as outlined in table in FIG. 101, to the tools developed in the enabling toolkit.

In some embodiments, the motivation may include determining at any time during a given project timeline if any construction object exists. Identifying that a construction object has been created and exists is extremely important in the construction logistics supply chain. This action naturally underpins all future interactions a particular construction object is scheduled to be a part of. The system's methodology provides proof of existence by connecting the object creation and its mapping to a device as an extra step in the object manufacture process. This step enables information capture and ensures that the rest of the steps (B)—(H) in FIG. 114 will be realized and recorded. In some embodiments, this may be achieved using techniques from construction data linkage

This algorithm uses Enabling Tool (R). This step is to ensure each element-device pair is uniquely identified to minimize information mismatch or loss. Derivative measures include productivity metrics such as delays between plan and execution.

As an example, a factory may have primary objectives (e.g., 100% construction resource instrumentation) and additional objectives (e.g., determine if production schedule is being attained. The description may include 100% CR instrumentation still requires humans in the loop, which are sources of error. Therefore SOPs will need to include steps for registration of devices to COs and CAs. CO registration is more prone to error due to the sheer numbers involved (O(10\hat{ }5) versus O(10) for CO and CA respectively). The algorithm may include loss functions (e.g., information loss (due to mismatch or error), Delay in plan vs execution of production). The inputs may include QR code for element: beacon-device, and barcode for gateway, registration plate for forklift truck. The logic block outlined in FIG. 111 is perfectly tuned to this implementation where QR code readers are developed to accept mobile camera inputs, image parser block is hence a QR code reader that extracts the encoded ID for the element and another for its matched beacon. The two sources of data are stored in the database with a unique identifier that connects element to device. Thus all manifestations are represented and tethered to the element identifier, ID_{CR}. Status inference and linkage techniques may also be used.

In some embodiments, the system may determine if the Production Schedule is being attained. This may include tracking construction kit from other non-precast suppliers (such as MEP), other on-site equipment are some examples of on-site registration, and/or on a construction site, having an accurate visibility of what construction objects have been installed to date allows for project managers to have more informed progress meetings. The algorithm may include the on-site instantiation would be virtually identical to the factory implementation. Status inference and linkage techniques may also be used.

### Store Construction Object (B)

The motivation may include providing visibility into storage capacity and stored objects, which may include tracking units in storage and capacity for unit storage compared to free units. The algorithm may include similar to enabling tool S, with the additional functionality of determining and providing storage metrics (such as availability) for a given state of the site.

As an example, factory objectives may include generating storage tracking insights (e.g., availability of storage, free units, units seeking storage, density of units (number per meter squared, or meter cubed)). The inputs may include location history of CO, interaction history of CO, and if all elements in storage are not instrumented, supplementary inputs of time-elapsed drone footage of yards. Objectives would be similar to factory, although turnover ought to be lower, storage areas smaller.

### Find Construction Object (C)

The motivation may include many times in the construction supply chain, it will occur that construction objects cannot be located. Without the ability to locate construction objects, interactions cannot proceed. Understanding the spatial information around any construction resource is fundamental to understanding and optimizing any interaction. This algorithm utilizes the tools defined in Enabling Tool (T).

Finding units in the factory yard-factories are sources that can store at any one given time thousands of construction objects that will be stored for days, weeks, or even months awaiting delivery to their respective site. Given the volume and relative size of elements, Factory storage yards can easily be up to 500,000 square meters in size. This means that locating construction objects can present a logistical challenge at these facilities, just based on accounting for the spatial aspect of construction objects. Quite often, manual tracking techniques result in poor location information, which in turn result in lost elements which must be located by brute force searching by operatives in the yard. This operation may result in countless hours of operatives driving assets around the yard randomly searching for construction objects. By using beacons and gateways to track construction objects live at the factory, this task may be automated.

The algorithm may include inputs (e.g., element ID) and logic (e.g., enabling algorithm toolkit T (T1)).

### Assemble Load (D)

In some embodiments, the motivation may include when construction objects are assembled in preparation for dispatch to site, these are assembled as loads. Here the state estimation logic where an element becomes part of a grouping is relevant and FIG. 114 outlines the progression from a single entity stored in a yard (B) to one that is assembled (D) onto an outgoing asset such as a trailer. Detecting and tracking when a load has been assembled provides clarity on possible sources of delays, the number of elements in a load, the time taken to load and more. This algorithm utilizes the tools defined in Enabling Tool (U). This step detects delayed loads and solves the issue of a lag in information being passed onto site. Typically once a load is ready for dispatch sites, operatives on site need to be made aware of this, however information broadcast to site is slow at best. An automated solution that is accurate and responsive, will inform up front of delays and impending loads.

In the prefabrication use case (where elements are prefabricated units), the invention further contemplates software and machine learning-based tools to track the loading process. One of the approaches taken by the inventors is to leverage a machine learning based computer implemented method that relies on the principles outlined in the logic below.

The logic may include calculating the centroid of a load for the hour (based on location and interaction data from units), calculate the distance of each member (element, unit etc.) from that hourly centroid, compute the number of members that are within critical distance, determine the load completion, based upon location-interaction between truck and element+location of element being inside “critical zone” during an agreed time period. The verification of these two criteria may imply whether load has been loaded or not. This invention seeks to expose granular detail of the load algorithmically. One embodiment created by the inventors is to leverage a machine learning based computer implemented method that relies on the following principles: ingest planning information about the load (specific unit ID's, stacking order, delivery time, etc.) from a factory ERP system, and calculating the time in which the load assembly has commenced (t0). From to, analyzing the historical 4D information of all units on the load, and using an AI to determine which units were assembled into the load at what time. Using unit topological information in conjunction with this semantic information, the AI can present a user with a probabilistic tracking estimate of the stacking order and makeup of the load as it was assembled.

This has value to multiple stakeholders in the construction supply chain, including, but not limited to the following applications: Load Weight Determination may include load weight influences decisions related to handling, transportation, and scheduling. ML-based determination of load weight, and utilization in follow-on recommendations and algorithms carries particular value. Delay Alerts may include factory managers can be alerted when the system sees that a load still exists at the factory when in fact, the dispatch schedule ingested from the ERP dictates the load should have already been dispatched.

Stacking order determination may include, for discrete construction objects such as precast concrete elements or prefabricated MEP modules, these are generally produced in a factory, stacked onto the back of a lorry, and delivered to site for installation. Given the spatially congested and constrained nature of a construction site, in general, there will be an unloading in which trucks pulling the lorries will arrive and wait for an asset to remove the construction objects (an important interaction). In general, this interaction isn't visible to stakeholders using traditional methods, and the stacking order is only realized to the site operatives once the lorry arrives at site. This gives site personnel little time to prepare for loads that need special attention. The methods herein solve this problem by providing visibility into these loads.

### Dispatch Load (E)

In some embodiments, the motivation may include, when construction objects are dispatched to site, these are dispatched as loads. Here the state estimation logic where a load is dispatched to site in FIG. 114 is marked by the progression to dispatch from factory (E). Understanding when a load has left the factory allows the site to prepare for its arrival. Ensuring the site is ready for a load will reduce delays on site. This algorithm utilizes the tools defined in Enabling Tool (U). The principal may include determining when the load left the site. FIG. 114 labels the Value-chain tool on the element state-diagram. From this, insights may be determined such as number of elements in the load, ETA, etc.

Tracking the continuous presence of the load and when it was last heard from can then be used to infer where the load is physically located.

Handling instances where sites cancel orders and providing the evidence required for this. Also providing insight into the frequency & reasons for order cancellations by sites. Detecting load composition, and deviations or anomalies (how frequently loads are encountered with compositions different from those initially in the specified order sheet). Construction resources travel spatially between various parts of the supply chain. For instance, a precast concrete unit might leave a factory, go to a staging yard, go to a project site, be rejected for quality purposes, only to finally return to the factory from where it started.

By using logistics devices (and/or optionally any other device herein), each one of these moves between sites will be captured, allowing for site dispatch and arrival times to be recorded. This information can be stored immediately and may optionally be integrated into a unit's data passport. Such information will give managers useful analytics for reducing miscommunication and poorly-informed decisions and increasing productivity of their project progress. The proposed invention will understand how the units have been loaded onto the lorry and when the lorry has been dispatched from the factory. This will allow construction personnel to receive an alert about not only when a load has left the factory, but also, the makeup of what the load contains in an unbiased manner. This can give them an idea of when they can expect the load to arrive and when it will help them make better plans for when it arrives. If a gateway is attached to the truck or units on the lorry, they will be able to see the entire journey as well.

### Load Arrives (F)

This item is a mirror of E, where the load will arrive once the trailer reaches site. Delivery may be determined automatically from the beacon/gateway system. Load delivery confirmation may be automatically generated by the system. This can be used for information logging and contributes to the data passport of a load and element.

### Disassemble Load (G)

For disassembling the load (G), this item is a mirror of D, where the load will be disassembled as the trailer is unloaded, in preparation for installation.

### Install (H)

In some embodiments, the motivation may include understanding a CO's installation time is of critical importance for determining project progress. Note, this technique and any other technique herein may be used for construction status determination. Installation of a construction object represents one of the largest milestones in a construction object's history in a construction project, as it is when it physically attaches to and becomes part of the final form of the project. For many elements, this will represent their final major interaction in the creation of the project. It is likely associated with the object's final interaction (see above) which resulted in a large spatial move. From a project perspective, this interaction represents a step forward in terms of the percentage completion of the project, but also, unlocks a series of other interactions. For instance, installing the final facade unit on a building project makes the building watertight, thereby unlocking all interactions related to installation of electrical or ICT equipment.

The aim is to determine the installation status of a construction object. Key steps include the ingestion of the BIM model which represents the final state of all precast units for a site. Using the BIM target location and, comparing against the distance as a function of time between the BIM target and the location of the physical precast unit over time. From these two data sources, determining with the use of historical movement data and logistics device data from assets, when the installation was probabilistically completed.

Project managers can have an understanding of live installation status, which can be cross referenced against the project plan to determine if installation happened after or before when it was planned to be installed. Integrating this information over time will result in determining whether the project finishes early or late.

The current state of the art to judge installation status involves human site walks, paper markups, and double entry of data into digital systems. This process requires a lot of human capital, but also, is ripe for human bias/inaccuracies to be injected. This system not only will be live and automated, but also, unbiased which will lead to the next benefit.

Automatically provides a transparent, complete view of the installation progress of construction objects to site operatives, which are able to allocated resources accordingly. This may for example be presented in the form of a “percentage complete” metric—i.e. the amount of a certain task (i.e. the MEP) that is complete in a certain area of the project. (i.e. the MEP on Floor 2 is 30% complete).

### Other Tools: Construction Resource and Interaction Calculated Metrics

The aforementioned value chain inventions are broken down into the semantic categories A-H. There are some inventions unlocked by this technology that span multiple categories.

A construction object might be the object of an interaction multiple times in the course of its existence. There are numerous examples in the supply chain where tracking the history of these interactions would be valuable. One example of this would be in certain jurisdictions for certain element types, there is a finite number of lifts that are acceptable for quality assurance purposes. If recorded using sensors, these interactions could be tracked and stored in the object's Data Passport and exposed to various stakeholders.

The use of machine learning techniques (and other data analysis techniques as described herein) to analyze load information collected from beacons & gateways and provide tracking insights (e.g. % of loads loaded on time) will provide significant benefit to improve factory and site performance, coordination, and overall orchestration activities. This will enable the production of key performance indicators that inform decision making.

At all levels of the supply chain, measuring the efficiency of asset use is rarely performed. By instrumenting assets, efficiency can be measured. For example, a tower crane on site interacts with dozens of construction objects every hour. If by instrumenting this asset, a project manager can see that the time length of these interactions with precast concrete elements for precast concrete elements follows a normal distribution whose average is 6.5 minutes, whereas their assumptions for the project planning called for 3, they will know that there is an average of 3.5 minutes worth of delays per lift which cumulatively, will result in a project delay. They can then use this information to determine how to improve site operations.

Any and all data generated herein may form part of a unit's data passport as described in the linkage section. This may be particularly relevant to historical and real-time location data, historical and real-time interaction data (passport may include sequence of interactions), as well as a registration identifier representing the device-construction resource pairing, its status/state (e.g. logistics enabling toolkit U or V), and finally its state along the logistics value-chain lifecycle and any data generated by any logistics value-chain toolkit method.

### Example User Interfaces

With reference to FIGS. 116-120, various example user interfaces 11600, 11700, 11800, 11900, and 12000 are provided. The user interfaces of the present disclosure maty operate to present, display, and/or the like mix optimization outcomes or data (e.g., user interface 11600), sensor context awareness and building structure data (e.g., user interface 11700), construction site resource and utilization data (e.g., user interface 11800), mis fingerprinting outcomes or data (e.g. user interface 11900), and/or pour design and sequencing outcomes or data (e.g., user interface 12000). As would be evident to one of ordinary skill in the art in light of the present disclosure, the user interfaces generated by the systems, methods, and devices described herein may be configured to display any data type described herein in any configuration, format, or orientation without limitation.

### Frames

Frames themselves may be made of various materials (e.g., intrinsic or characteristic impedances of any kind defined herein). For example, frame impedances may be designed to be lower than those of the host material of interest, or higher which will lead to different properties. A plurality of frames may be employed, together or separately, in conjunction with one or a plurality of wave based sensor devices (or any of their constituent parts). Principal purpose of frames are: Oscillations: Generate, enhance or shift oscillatory resonances (e.g mechanical vibratory resonances, LCR circuit type resonances, driven by capacitive/inductive/resistive properties, or their analogues in other domains—e.g. elastic/kinetic/dissipative energy in mechanics). Generally, manipulate oscillatory behavior and properties. Waves: Generate, enhance or shift travelling wave-based resonances (e.g. resonances caused by standing wave modes, due to destructive and constructive interference). This is typically achieved through cavities. The resonance modes of these resonators are related to the properties of the medium through which the standing wave is generated, so the medium can be probed by measuring the resonant frequency (which will be a strong signal). This means that resonances frequencies will be stronger and shift as host materials change property. Generate particular wave propagation modes (e.g. TM, TE or TEM modes for E&M waves), which may be influenced by host medium, which can then be measured. This is typically achieved through waveguides. The inside or surroundings of waveguides will also influence the allowable modes on waveguides (it will feature in the wavenumber).

Generally, manipulate waves, by directing them, attenuating them, reflecting them, concentrating them etc. This can be achieved by parabolic mirrors, by prisms, diffraction gratings, lenses and so on. There are a plethora of devices that can achieved this. They can also be configured in such a way as to generate standing wave resonances.

Create isolated environments of host materials for sensing purposes. In concave frames, with open faces, material can flow into the frame, and be probed (a miniaturized shielded environment).

Particularly advantageous for tomography-Shields the sample of interest from stray interference (e.g. external waves). Important: Two kinds of resonances: As per above, resonance can be induced by standing waves, or by oscillatory systems (two similar, but different phenomena, not to be confounded). These are not the same thing, but they will both manifest as resonance peaks in host structures (they are different phenomena to begin with, but they are exciting the same thing: a resonance in the structure). E.g. a device may have a vibrational resonance because of the way it is constructed (based on say its spring constant), and can be oscillated. Alternatively, sending an acoustic wave through it may also cause reflections & transmission, leading to standing waves, and resonant modes.

Ultimately, they both couple into the host material. But important to make the distinction as they will lead to different kinds of frames. Generally, frames can be made of various materials: Absorbing materials (with lower impedance than the medium of interest), Reflective materials (with higher impedance than the medium of interest), For propagating waves, Phase shifting materials, Attenuating materials, Polarising materials, Frequency shifting materials, Definition of impedance is domain-dependent here: if you're dealing with electric signal, electric impedance will determine transmission and reflection coefficients. If you're dealing with electromagnetic waves, E&M wave impedance (so for a dielectric, its permittivity) will determine whether or not you get reflection.

### Example of Wave Manipulating Frames:

Waveguides; Cavities; Reflectors, Concentrators, Prisms, Beamformers, Diffractors, Refractors and similar wave-directing, propagators and wave-shaping devices. In the broadest sense, in the context of propagating waves, these frames may act as E&M or mechanical wave manipulation devices-directing, guiding and modifying waveforms to meet particular requirements which may lead to resonances. They may also act as mechanical (or other) resonance manipulators (oscillation resonances).

### Example of Oscillation Manipulating Frames:

Springs, masses, mechanical dampeners (that convert motion to heat through friction). Rigid frames that may affect mechanical vibrational properties of a system. Bonding layers and/or coatings of different kinds; They may be made, in part, by elastic or stiff materials, capacitors or dielectrics, inductors or tunable masses, and other analogues in different domains (e.g. in the magnetic impedance, or optical impedance domain, and so on, or related to the coupling employed). Think of the components that will change the resonance modes of harmonic or damped oscillators.

### Advanced Frames:

Beyond overall geometry, the microstructure of frames may play a big role in its properties. Advanced frames can be machined, or micromachined. They may also be made of meta-materials with various unusual properties. Frames may have variable impedance along them (impedance of any kind-electric, electromagnetic, mechanical and so on). These may be controllable or tunable. Frames may have adaptive geometries or features (which can be electrically controlled)

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. The disclosed embodiments relate primarily to a network interface environment, however, one skilled in the art may recognize that such principles may be applied to any scheduler receiving commands and/or transactions and having access to two or more processing cores. Alternative embodiments that result from combining, integrating, and/or omitting features of the embodiment(s) are also within the scope of the disclosure. Accordingly, the scope of protection is not limited by the description set out above.

### Construction Resource Positioning (Embodiment Examples):

Example embodiments for a construction resource positioning and interaction method are set out below.

### Embodiments Directed at the Association of Construction Resources to Positioning Devices:

In one example, the embodiment includes a computer implemented method, wherein a construction resource is associated to a positioning device using construction data linkage.

Additionally or alternatively in any of the embodiments described herein, the association between a construction resource and a positioning device is determined using context awareness.

### Embodiments Directed at Positioning of Construction Resources:

Additionally or alternatively in any of the embodiments described herein, the computer implemented method may determine the position of a construction resource. In some embodiments, the computer implemented method: wherein the determination is based on first data received; and/or wherein the determination is based on a model; and/or wherein the determination is based on, generated by, or related to a positioning device coupled or associated to the construction resource; and/or wherein the coupling is a mechanical attachment; and/or wherein the position is determined, in whole or in part using context awareness, mix fingerprinting and/or status inference methods; and/or wherein the position is determined using a wave-based sensor; and/or wherein the device is embedded or forms an integral part of the construction resource; and/or wherein the construction resource is a concrete pour or unit, and the device is either surface mounted, directed at, in proximity of, or embedded within the concrete pour or unit; and/or wherein the position determination is based on two or more devices, where one device is connected a local communications network, and the second device is connected to a global positioning system and the internet (e.g. through a cellular module); and/or wherein the position determination is based on a distributed system of devices with a time synchronized clock established over a wireless interface (e.g. bluetooth or LoRa); and/or wherein the position determination is based on a model which takes as input data (optionally live data) from one or more devices for RSSI, inertial data (acceleration, gyroscope, tilt, magnetometer and the like), angle of arrival, time of arrival; and/or wherein the position determination is based on proximity, wherein proximity is determined using a signal strength and a defined threshold; and/or wherein the position determination is based on a model comprising a trilateration or quadrilateration algorithm; and/or wherein the position determination is based on one or more beacons, and at least two static gateways; and/or wherein the position determination is based on one or more beacons coupled to the construction resource, and one or more dynamic gateways, where the dynamic gateway is battery powered, aware of its position (globally, or relative to a defined frame of reference), and its position is time-varying; and/or wherein the position is determined for one or more dynamic (moving) gateway, and one or more dynamic (moving) construction resources, coupled to beacons; and/or wherein the position determination is based on at least one positional measurement (absolute or relative) of another device networked to the first device; and/or wherein the positioning is determined using two or more dynamic, mobile construction resources, and one of the construction resources is tethered to an internet connected global positioning device, and each of the other construction resources are tethered to a device comprising a wireless interface that are able to communicate to each other, and to the internet connected construction resource device; and/or wherein the positioning devices are battery powered or energy harvesting bluetooth beacons (or similar) and bluetooth to cellular gateway devices (or alternatively, LoRa, Sigfox, NB-Iot and the like); and/or wherein the beacon is surface mounted or embedded in a construction resource, and one or more gateways are mounted on to construction plant and/or machinery; and/or wherein the beacon and/or gateway employ ultra-low power duty cycling and adaptive sampling to reduce power consumption; and/or wherein a position determination is adjusted (or a positioning model is adjusted) based on characteristics relating to the embedment of a beacon; and/or wherein context awareness data is used to determine whether a positioning sensor is embedded, and optionally determine characteristics related to its embedded configuration (such as its depth, or position in a pour or proximity to rebar); and/or wherein the positioning model determination is adjusted based on the output of a context awareness model; and/or wherein a positioning model determination is adjusted based on the output of a mix fingerprinting model; and/or wherein a positioning model determination is adjusted for an embedded positioning sensor, to account for such embedment, and optionally based on characteristics related to its embedded configuration (such as its depth, or position in a pour, or proximity to rebar); and/or wherein context awareness data is provided, such as a floorplan or BIM model, ERP data, scheduling data, and is used alongside sensor measurements from one or more devices to determine position of a construction resource; and/or wherein the position determination of two or more construction resources relative to each other is determined (in any frame of reference); and/or wherein the two or more construction resources which are positioned relative to each other are stacked prefabricated units, and their stacking order and position in a stack is determined using positioning sensors; and/or wherein the relative positioning in a stack is determined by a plurality of beacons communicating with each other, which may be embedded or buried within stacked units, to compensate for loss of line of sight to one or more gateways; and/or wherein the stack is a load of prefabricated building elements (e.g. intended for loading, dispatch or unloading), and the relative position of the units in such load is determined; and/or wherein stacking order and/or relative positioning of the units in a load is determined in whole or in part based on context awareness data; and/or wherein one or more construction resources are positioned relatively or absolutely to one another based on a plurality of beacons embedded within at least two construction resources, and optionally, one or more internet-connected globally positioned gateway; and/or wherein the one or more construction resources in a stack or load are positioned by employing a mesh-network topology (wherein signals may be sent and/or transmitted by one embedded beacon to another, and to or from gateways or any other device), and/or wherein positioning of a construction resource is determined through opportunistic navigation; and/or wherein the positioning of a construction resource is determined through cognitive opportunistic navigation, wherein opportunistic signals are detected and characterized, and their reference signals are employed to determine a position.

### Embodiments Directed at the Interaction of Two or More Construction Resources:

Additionally or alternatively, in any of the embodiments described herein, the method is used to determine one or more interactions between two or more construction resources.

Additionally or alternatively in any of the embodiments described herein, the interaction determination is based on a model.

Additionally or alternatively in any of the embodiments described herein, wherein the interaction determination is based on data from a device coupled or associated to at least one of the construction resources;

Additionally or alternatively in any of the embodiments described herein, additional embodiments are described herein: the device is coupled to the construction resource through a mechanical attachment; and/or the device is embedded or forms an integral part of the construction resource; and/or the construction resource is a concrete pour or unit, and the device is either tethered, surface mounted, directed at, or embedded in the construction unit; and/or the interaction determination is based on one or more position determinations from one or more position sensor devices; and/or the interaction is determined based on a fingerprint derived from signals from one or more devices coupled to construction resources involved in the interaction, wherein such signals includes the RSSIs r1 and r2 between a pair of devices, and the GPS position of one of the devices; and/or the type of interaction is determined based on the interaction fingerprint (constructed from one or more signals derived from the one or more devices coupled to the one or more construction resources); and/or the type of interaction includes a crane lift (including a tower crane, a straddle crane, a gantry crane, crawler crane and the like), a fork lift, loading on a shunter or trailer, transport by a shunter or trailer; and/or wherein one of the construction resources involved in an interaction is a construction asset, and the other is a construction object; and/or the utilization of a construction asset (including construction uptime and downtime) is determined based on the determination of one or more interactions executed or experienced by such construction asset over a period of time; and/or the construction asset is a crane, and the output of the utilization determination includes one or more of lifts, lift sequences, lift times or durations, lift downtime, and average productivity rates per interaction type for such crane over a period of time.

### Embodiments Directed at Composition of Position & Interaction:

Additionally or alternatively in any of the embodiments described herein, a method for construction status determination wherein a construction resource's construction status is determined based on a position determination and an interaction determination.

Additionally or alternatively in any of the embodiments described herein, wherein one or more historical interactions and/or positions for a construction resource over a period of time is determined, based on prior interaction and/or position determinations from sensor devices.

Additionally or alternatively in any of the embodiments described herein, wherein the construction status determined are one of: the creation of the unit; and/or the storage of the unit in a yard; and/or the loading of a unit for transportation; and/or the dispatch of the unit from the factory; and/or the arrival of the unit on a construction site; and/or the unloading of the unit on the site; and/or the storage of the unit on a site; and/or the lifting or movement of a unit on a site; and/or the installation of a unit at its target position in the project.

### Sensor Context Awareness:

### Example Embodiments for Sensor Context Awareness are Set Out Below.

Additionally or alternatively in any of the embodiments described herein, an example embodiment is made up of a computer-implemented method for sensor context awareness in building material related implementations, the method comprising: receiving a first dataset comprising one or more first data entries; and generating sensor context awareness data based upon the one or more first data entries of the first dataset, wherein the sensor context awareness data comprises: one or more data entries associated with a first sensor device considering a building material; one or more data entries associated with the building material under consideration by the first sensor device; one or more data entries associated with a building element implicating the building material under consideration by the first sensor device; and/or one or more data entries associated with an environment of the building material under consideration by the first sensor device.

In some embodiments, the computer-implemented method, wherein the one or more first data entries of the first dataset are generated by the first sensor device.

Additionally or alternatively in any of the embodiments described herein, wherein the sensor device may be a wave-based sensor device comprising one or a plurality of wave-based sensors, transducers and/or actuators; and/or wherein the wave-based sensor device is configured to execute tomography based-techniques to generate sensor context awareness data; and/or wherein the sensor device may be a temperature and/or maturity sensor device; and/or wherein the temperature-based sensor device is configured to generate sensor positioning data; and/or wherein the building element is one of a concrete batch, and/or a concrete load (in transport in the wagon), and/or a concrete pour, and/or a concrete slab, and/or a concrete element, and/or a concrete precast unit; and/or wherein the first sensor device is embedded within, disposed on, in proximity of, and/or directed at the building material; and/or wherein the first sensor device is embedded within the building material, the method further comprising determining a position (which may be relative or absolute) of the first sensor device within the building material; and/or further comprising receiving a second dataset comprising one or more second data entries, wherein generating the sensor context awareness data is further based upon the second dataset; and/or wherein one or more of the first dataset and the second dataset comprise first data and second data, respectively, generated by the first sensor device; and/or the computer-implemented method, wherein the first dataset comprises first data generated by the first sensor device, and/or the second dataset comprises second data generated by a second sensor device; and/or wherein receiving the first dataset comprising the one or more first data entries further comprises accessing a building information model (BIM) implicating the building material and/or the first sensor device, and optionally the method further comprising updating the BIM based upon the generated sensor context awareness data; and/or wherein at least one of the one or more first data entries of the first dataset is associated with a first measurement type of the building material, the method further comprising: generating a material identifier associated with the building material based upon the first dataset, wherein the material identifier is indicative of one or more of: a composition of the building material, and/or a unique mixture related classifier of the building material, and/or one or more material properties of the building material; and/or further comprising performing one or more static and/or dynamic normalization and/or tuning operations on the first dataset based upon the sensor context awareness data.

### Pour Design & Sequencing

### Example Embodiments for Pour Design and Sequencing are Set Out Below

Additionally or alternatively in any of the embodiments described herein, a computer-implemented method for construction design and/or scheduling, the method comprising: receiving a first dataset comprising one or more first data entries; generating, selecting, recommending or adjusting one or more structural building blocks associated with a structure formed of one or more building elements based on the first dataset; and outputting the structural building block; and/or wherein the one or more structural building blocks are generated based on data from a first sensor device embedded within, disposed on, or directed at a building material associated with a first building element of the structure, or another structure; and/or further comprising: determining a status change associated with the first building element based upon the one or more first data entries of the first dataset generated by the first sensor device, and/or modifying a structural building block based upon the status change; and/or further comprising: identifying at least a second building element associated with the structure, and/or modifying one or more operations associated with the second building element based upon a modified structural building block.

Additionally or alternatively in any of the embodiments described herein, the computer-implemented method, further comprising: receiving first or second data indicative of the real-time status of the construction project; comparing first data with one or more structural building block; and executing one or more of the following: Determining a status change/anomaly/perturbation/deviation based upon the comparison; Determining the schedule impact of the status change based upon any one of the first or second data, the comparison and/or the status change; Generating construction analytics based upon any one of the first or second data, the comparison, the status change, and/or the schedule impact; and/or Modifying the structural building blocks or generating new structural building blocks based upon any one of the first or second data, the status change, the schedule impact and the construction analytics.

Additionally or alternatively in any of the embodiments described herein, the computer-implemented method wherein the first or second data are generated based on data by a first sensor device embedded within, disposed on, in proximity of, or directed at a construction resource associated with the structure.

Additionally or alternatively in any of the embodiments described herein, the computer-implemented method, wherein the structural building block comprises a material design identifier indicative of one or more of the identity, configuration and dimensions of a material for one or more of the plurality of building elements forming the structure.

Additionally or alternatively in any of the embodiments described herein, the computer-implemented method, wherein the material is a cementitious mix.

Additionally or alternatively in any of the embodiments described herein, the computer-implemented method, wherein the material is steel rebar.

Additionally or alternatively in any of the embodiments described herein, the computer-implemented method, wherein the structural building block comprises a pour sequence indicative of the series of pour operations associated with a plurality of building elements forming the structure.

Additionally or alternatively in any of the embodiments described herein, the computer-implemented method, wherein the structural building block comprises a pour layout indicative of the relative positioning and shape of each of the plurality of building elements forming the structure.

Additionally or alternatively in any of the embodiments described herein, the computer-implemented method, wherein the structural building block comprises a geometry design indicative of the absolute shape and positioning of each of the plurality of building elements forming the structure.

Additionally or alternatively in any of the embodiments described herein, the computer-implemented method, wherein the structural building block comprises a construction joint identifier indicative of one or more of the identity, type, relative positioning, dimensions configuration of a construction joint for one or more of the plurality of building elements forming the structure.

Additionally or alternatively in any of the embodiments described herein, the computer-implemented method, wherein the structural building block comprises a construction schedule indicative of the coordination and timing of pour operations associated with a plurality of building elements forming the structure.

Additionally or alternatively in any of the embodiments described herein, the computer-implemented method, wherein the pour operation is a collection of activities associated with start and end times, building up to a Gantt chart.

Additionally or alternatively in any of the embodiments described herein, the computer-implemented method, wherein the structural building block comprises a formwork identifier indicative of the coordination and timing of pour operations associated with a plurality of building elements forming the structure.

Additionally or alternatively in any of the embodiments described herein, the computer-implemented method wherein the generated structural building block includes one or more concrete cycles indicative of the coordination and timing of pour operations associated with singular pours.

Additionally or alternatively in any of the embodiments described herein, the computer-implemented method wherein: the concrete cycle includes a mix pouring phase; and/or the concrete cycle includes steel fixing and removal phases; and/or the concrete cycle includes a formwork installation and removal phases.

Additionally or alternatively in any of the embodiments described herein, the computer-implemented method, further comprising predicting one or more of: contextual material properties for any building material associated with the structure; structure properties associated with the structure.

Additionally or alternatively in any of the embodiments described herein, the computer-implemented method wherein the structure properties are (i) compositional structure properties; and/or (ii) structure physical properties.

Additionally or alternatively in any of the embodiments described herein, the computer-implemented method wherein the predictions comprise one or more of of the following, for given contextual conditions: Shrinkage predictions indicative of the expected shrinkage of any building element associated with the structure, over time; Thermal predictions indicative of the expected thermal distribution of any building element associated with the structure, over time; Cracking predictions indicative of the expected crack size, crack location and cracking risk of any building element associated with the structure, over time; Load predictions indicative of the expected load experienced by any building element associated with the structure, over time; Stress predictions indicative of the mechanical stress experienced by any building element associated with the structure, over time; Shear predictions indicative of the shear experienced by any building element associated with the structure, over time; Strain predictions indicative of strain experienced by any building element associated with the structure, over time;

Additionally or alternatively in any of the embodiments described herein, the computer-implemented method, wherein receiving the first dataset further comprises receiving one or more design constraints associated with the structure.

Additionally or alternatively in any of the embodiments described herein, the computer-implemented method, wherein the one or more design constraints comprise one or more of: a number of levels forming the building structure; a number of building elements forming the structure; a positioning of the building elements forming the structure; one or more target material properties of the building elements forming the structure; one or more sensor contextual conditions; one or more material contextual conditions;

Additionally or alternatively in any of the embodiments described herein, the computer-implemented method, wherein receiving the first dataset comprising the one or more first data entries further comprises accessing construction documentation associated with the structure.

Additionally or alternatively in any of the embodiments described herein, the computer-implemented method, wherein the construction documentation is one or more of: a building information model (BIM); and/or a building specification; a building code; and optionally where the method is further configured to extract a design constraint from the construction documentation.

Additionally or alternatively in any of the embodiments described herein, the computer-implemented method, wherein the first dataset comprises: first data generated by a first sensor device; and second data generated by a second sensor device.

Additionally or alternatively in any of the embodiments described herein, the computer-implemented method, wherein the building material is a cementitious mixture, a steel structure, or a timber structure.

Additionally or alternatively in any of the embodiments described herein, the computing-implemented method, wherein the structural building block is configured to minimize one or more of: a carbon cost associated with the structure; a construction time associated with the structure.

Additionally or alternatively in any of the embodiments described herein, the computer-implemented method, wherein the method is executed using ML techniques.

Additionally or alternatively in any of the embodiments described herein, the computer-implemented method, wherein the generation or adjustment of the structural building blocks comprises the use of evolutionary and/or genetic algorithm methods.

Additionally or alternatively in any of the embodiments described herein, the computer-implemented method, wherein the generation or adjustment of the structural building blocks comprises the use of physico-chemical models and methods, or a hybrid machine learning physico-chemical model.

Additionally or alternatively in any of the embodiments described herein, the computer-implemented method, wherein the generation of one or more structural building blocks further comprises the generation of any associated construction documentation.

Additionally or alternatively in any of the embodiments described herein, the computer-implemented method, wherein the construction documentation comprises of one or more of: 3D-BIM Model; Specifications; EPD Requirements; Timeline Milestone

### Requirements; Building Designs.

Additionally or alternatively in any of the embodiments described herein, the computer-implemented method, wherein the structure is one or more of a building, a tower, a bridge, a road, a tunnel or vertical shaft, a railway, an industrial warehouse, a mine, a power plant, water treatment facility, or any other residential, commercial, industrial or civil infrastructure structure.

Additionally or alternatively in any of the embodiments described herein, the computer implemented-method, wherein the building elements are prefabricated units.

Additionally or alternatively in any of the embodiments described herein, the computer implemented-method, wherein the building elements are one or more of; piles, substructures, superstructures.

### Mix Fingerprinting Embodiments:

### Example Embodiments for Mix Fingerprinting are Set Out Below.

In one example embodiment, a computer-implemented method for building material related determinations is described, the method comprising: receiving a first dataset comprising one or more first data entries associated with a first measurement type of a building material; generating a material identifier associated with the building material based upon the first dataset; and outputting the material identifier or material classification of the building material.

Additionally or alternatively in any of the embodiments described herein, the computer-implemented method, wherein the material identifier is indicative of one or more of: A Representation of Mix Space; A Material Classification System; A Material Class; A

### Material Identity.

Additionally or alternatively in any of the embodiments described herein, the computer-implemented method, wherein the material identifier or material classification is indicative of one or more of: a formulation of the building material; a unique mixture related classifier of the building material; or one or more material properties of the building material; or sensor measurements of the building material.

Additionally or alternatively in any of the embodiments described herein, the computer-implemented method, wherein generating the material identifier or material classification further comprises: accessing a database storing material identification data associated with a plurality of building material identifiers or material classifications; comparing one or more of the first data entries associated with the first measurement type of the building material with one or more material identification data entries associated with the first measurement type; and determining the material identifier based upon the comparison.

Additionally or alternatively in any of the embodiments described herein, the computer-implemented method, wherein generating the material identifier of the building material further comprises deploying a machine learning (ML) model on the first dataset.

Additionally or alternatively in any of the embodiments described herein, the computer-implemented method, further comprising: receiving sensor context awareness data; and performing one or more normalization operations on the first dataset based upon the sensor context awareness data, wherein the one or more first data entries of the first dataset and the sensor context awareness data are generated by a first sensor device, and wherein the sensor context awareness data comprises: one or more data entries associated with the first sensor device considering the building material; one or more data entries associated with the building material under consideration by the first sensor device; one or more data entries associated with a pour implicating the building material under consideration by the first sensor device; and/or one or more data entries associated with an environment of the building material under consideration by the first sensor device.

Additionally or alternatively in any of the embodiments described herein, the computer-implemented method, further comprising, following generating the material identifier, determining one or more material properties of the building material.

Additionally or alternatively in any of the embodiments described herein, the computer-implemented method, wherein, prior to generating the material identifier, the method comprises: determining one or more material properties of the building material based upon the one or more first data entries of the first dataset, wherein generating the material identifier of the building material is based at least in part upon the one or more determined material properties.

Additionally or alternatively in any of the embodiments described herein, the computer-implemented method, further comprising: receiving expected material identifier data; comparing the material identifier data with the expected material identifier data; detecting an anomaly associated with the building material based upon the comparison; and, optionally, determining a source associated with the detected anomaly; and, optionally, generating a compensation recommendation configured to mitigate the detected anomaly.

Additionally or alternatively in any of the embodiments described herein, the computer-implemented method, further comprising: indexing the material identifier against a database of calibration curves; determining a calibration curve based upon the indexing; determining a maturity function from amongst a plurality of maturity functions; and determining, via a maturity method, an in-situ strength development of the building material over a time.

Additionally or alternatively in any of the embodiments described herein, the computer-implemented method, wherein the one or more first data entries of the first dataset are generated by a first sensor device.

Additionally or alternatively in any of the embodiments described herein, the computer-implemented method, wherein the first sensor device is embedded within, disposed on, in proximity of, and/or directed at the building material.

Additionally or alternatively in any of the embodiments described herein, the computer-implemented method, wherein the first dataset comprises one or more first data entries generated by a spectroscopy-based sensor device.

Additionally or alternatively in any of the embodiments described herein, the computer-implemented, wherein the spectroscopy-based sensor device is configured to one or more of: generate one or more first data entries via Laser Induced Breakdown Spectroscopy (LIBS); and/or perform acoustic based measurements for generating the one or more first data entries.

Additionally or alternatively in any of the embodiments described herein, the computer-implemented method, wherein the first sensor device comprises a piezoelectric sensor device configured to perform mechanical-based measurements or electrochemical-based measurements for generating the one or more first data entries, optionally wherein such measurements are impedance or impedance spectroscopy measurements.

Additionally or alternatively in any of the embodiments described herein, the computer-implemented method, further comprising receiving a second dataset comprising one or more second data entries associated with a second measurement type of a building material, wherein generating the material identifier associated with the building material is further based upon the second dataset.

Additionally or alternatively in any of the embodiments described herein, the computer-implemented method, wherein one or more of the first dataset and the second dataset comprise first data and second data, respectively, generated by a first sensor device.

Additionally or alternatively in any of the embodiments described herein the computer-implemented method wherein: the first dataset comprises first data generated by a first sensor device; and the second dataset comprises second data generated by a second sensor device.

Additionally or alternatively in any of the embodiments described herein, the computer-implemented method wherein the building material is a cementitious mixture.

### Mix Optimization:

### Example Embodiments for Mix Optimization are Set Out Below.

Additionally or alternatively in any of the embodiments described herein: a computer-implemented method for building material selections, the method comprising: receiving a first dataset comprising one or more first data entries associated with one or more material properties, and/or determining a material identifier associated with a building material based upon the first dataset, and/or outputting the material identifier of the building material; and/or wherein the material identifier is indicative of a formulation defining a proportion of constituent elements forming the building material; and/or wherein the material identifier is indicative of a chemical composition of constituent elements forming the building material; and/or wherein the one or more material properties comprise: one or more static material properties, and/or one or more compositional material properties, and/or one or more contextual conditions, and/or one or more contextual material properties.

Additionally or alternatively in any of the embodiments described herein, wherein: the first dataset comprises data entries associated with one or more static material properties associated the building material, and the determined material identifier comprises at least one constituent element forming the building material.

Additionally or alternatively in any of the embodiments described herein, wherein: the first dataset comprises data entries associated with at least a first static material property associated the building material, and the determined material identifier comprises at least a second static material property associated with the building material.

Additionally or alternatively in any of the embodiments described herein, wherein: the first dataset comprises data entries associated with one or more static material properties and/or one or more compositional material properties of the building material, and the determined material identifier is indicative of the formulation defining a proportion of constituent elements forming the building material.

Additionally or alternatively in any of the embodiments described herein, wherein: the first dataset comprises data entries associated with a first static material property and/or a first compositional material property of the building material, and the determined material identifier comprises at least a second static material property and/or a second compositional material property associated with the building material.

Additionally or alternatively in any of the embodiments described herein, wherein: the first dataset comprises data entries associated with one or more static material properties and/or one or more compositional material properties of the building material, and the determined material identifier comprises one or more contextual materials properties associated with the building material.

Additionally or alternatively in any of the embodiments described herein, the computer-implemented method wherein the material identifier comprises a determined formulation defining a proportion of constituent elements forming the building material, and the method further comprising determining one or more contextual conditions associated with the building material.

Additionally or alternatively in any of the embodiments described herein, the computer implemented-method wherein the first dataset comprises one or more static material properties, the method further comprising: determining one or more target static material properties for the determined formulation at the one or more contextual conditions, and generating an indication indicative of a degree of similarity between the one or more target static material properties and the one or more static material properties of the first dataset based on a comparison between the one or more target static material properties and the one or more static material properties of the first dataset.

Additionally or alternatively in any of the embodiments described herein, further comprising: determining one or more target contextual material properties for the determined formulation at the one or more contextual conditions, predicting one or more contextual material properties for the determined formulation at the one or more contextual conditions, and generating an indication indicative of a degree of similarity between the one or more target contextual material properties and the one or more predicted contextual material properties based on a comparison between the one or more target contextual material properties and the one or more predicted contextual material properties.

Additionally or alternatively in any of the embodiments described herein, wherein: the first dataset comprises data entries associated with one or more target contextual material properties associated with the building material, and determining the material identifier based on the target contextual material properties.

Additionally or alternatively in any of the embodiments described herein, wherein generating the material identifier further comprises: accessing a database storing material identification data associated with a plurality of building material identifiers, wherein each building material identifier includes one or more associated contextual material properties, comparing one or more of the first data entries associated with the target contextual material properties with one or more material identification data entries associated with contextual material properties, and determining the material identifier based upon the comparison.

Additionally or alternatively in any of the embodiments described herein, the first dataset comprises data entries associated with one or more target contextual material properties associated with the building material, the method further comprising: generating a modification to one or more static material properties of the building material, one or more compositional material properties, and/or one or more contextual conditions, wherein the modification is configured to cause one or more contextual material properties for the building material to satisfy the one or more target contextual material properties.

Additionally or alternatively in any of the embodiments described herein, wherein generating the material identifier of the building material further comprises deploying a machine learning (ML) model on the first dataset.

Additionally or alternatively in any of the embodiments described herein, further comprising: receiving one or more utility functions that at least partially constrain the machine learning (ML) model as related to one or more target contextual material properties, and generating the material identifier of the building material based on deployment of the ML model on the first dataset as constrained by the one or more utility functions.

Additionally or alternatively in any of the embodiments described herein, wherein the one or more first data entries of the first dataset are generated by a first sensor device.

Additionally or alternatively in any of the embodiments described herein, wherein the first sensor device is embedded within, disposed on, and/or directed at the building material.

Additionally or alternatively in any of the embodiments described herein, wherein the building material is a cementitious mixture.

### Further Mix Optimization Embodiments

Further embodiments for mix optimization are set out below

Additionally or alternatively in any of the embodiments described herein, wherein modifying one or more static material properties, and/or one or more compositional material properties; and/or one or more contextual conditions, and/or one or more contextual material properties, wherein the modification is configured to cause one or more static material properties, and/or one or more compositional material properties, and/or one or more contextual conditions, and/or one or more contextual material properties, to satisfy one or more static material properties, one or more compositional material properties, one or more contextual conditions, and/or one or more contextual material properties, and wherein the modification occurs by utilizing a generalized optimization procedure on the input variables to a given model, such that the input variables can be any mixture of discrete or continuous variables.

Additionally or alternatively in any of the embodiments described herein, wherein the statistical uncertainty associated with any input is propagated to the outputs, where the inputs and outputs can represent any number of static material properties, compositional material properties, contextual conditions or contextual material properties. The inputs and outputs can also be composed of an arbitrary mixture of continuous or discrete variables.

Additionally or alternatively in any of the embodiments described herein, wherein the output can be converted from point data to range data, and wherein the range data represents the Bayesian probability of the output, given the chosen set of inputs.

Additionally or alternatively in any of the embodiments described herein, wherein the output (whether a point or range type) can its associated causal attributes calculated (with respect to the model and the data from which the model was created). The implementation is such that a model (or ensemble of models) can be placed within a generally cyclic causal graph, and the causal dependencies between outputs and input are modelled bi-directionally via weighted multiplicative values. The weighted multiplicative values are altered to simulate changes in causal links, and the causal links that best describe the data are chosen. Those links are then used to describe the causal dependencies between any set of inputs or outputs (outside of the training data

Additionally or alternatively in any of the embodiments described herein, wherein the generalized input adjustment method is used to recommend or generate an output that meets some target conditions.

Additionally or alternatively in any of the embodiments described herein, wherein a genetic search algorithm is used to recommend or generate an output that meets some target conditions.

Additionally or alternatively in any of the embodiments described herein, wherein the model is continuously trained on new data. New data can derive from any of the listed and non-exhaustive information sources.

Additionally or alternatively in any of the embodiments described herein, wherein the model can be made to adjust predictions, evaluations or recommendations based on sensor contextual conditions (e.g. when the sensor is embedded at a certain depth within the concrete, the predicted future strength will differ depending upon depth).

Additionally or alternatively in any of the embodiments described herein, wherein the model can be made to recommend adjustments to contextual conditions in the form of real-world actions that are to be taken, to satisfy a set of target material properties.

Additionally or alternatively in any of the embodiments described herein, wherein human feedback on the calculated prediction, evaluation or recommendation can update the internal representations of the model, so as to create a model that will better adhere to the human user's preferences.

Additionally or alternatively in any of the embodiments described herein, wherein the calculated prediction, evaluation or recommendation can be compared against a desired value, and an automated alerting system will send messages to a preferred user device, or a preferred digital platform, wherein the message will contain the absolute calculation, or the calculation relative to the desired value.

Additionally or alternatively in any of the embodiments described herein, wherein the alert is triggered by a change in forecasted future measurements (such as the predicted future weather), which leads to a change in model prediction, evaluation or recommendation, and which leads to a modification of prior alerts, or the generation of new alerts.

### Embodiments Relating to Electro-Chemical and Electro-Acoustic Material Characterization

Additionally or alternatively in any of the embodiments described herein, wherein the chemical composition of constituent elements forming the building material can be derived from embedded or external piezo-electric or piezo-acoustic device sensors.

Additionally or alternatively in any of the embodiments described herein, wherein the static or contextual material parameters of the building material can be derived from embedded or external piezo-electric or piezo-acoustic device sensors.

Additionally or alternatively in any of the embodiments described herein, wherein the material contextual conditions of the building material can be derived from embedded or external piezo-electric or piezo-acoustic device sensors.

Additionally or alternatively in any of the embodiments described herein, a system that can predict, evaluate or recommend based on measurements from piezo-electric and piezo-acoustic device sensors, and whose predictions, evaluations or recommendations generate insights about the detected chemical composition of the constituent elements, with respect to desired static, compositional or contextual material properties, or with respect to material contextual conditions.

### Embodiments Directed at Status Inference

In one example, the embodiment includes a computer-implemented method for construction status determinations, the method comprising: receiving a first dataset comprising one or more first data entries, and/or identifying at least a first construction site resource associated with a structure based upon the first dataset, and/or generating a construction status identifier associated with the first construction site resource, and/or outputting the construction status identifier.

Additionally or alternatively in any of the embodiments described herein: wherein the first construction site resource is a first building element associated with the structure; wherein the one or more first data entries of the first dataset are generated by a first sensor device embedded within, disposed on, or directed at the first construction site resource; and/or wherein receiving the first dataset comprising the one or more first data entries further comprises accessing a spatial representation associated with the structure; and/or further comprising: accessing a structural progress flow associated with the structure and the first construction site resource, and/or determining expected construction status data associated with the structure, and/or comparing the construction status identifier with the expected construction status data, and/or detecting an anomaly associated with structure based upon the comparison; and/or further comprising: determining a source associated with the detected anomaly, and/or generating a compensation recommendation configured to mitigate the detected anomaly; and/or further comprising: determining a status change associated with the structural progress flow based upon the detected anomaly, and/or modifying the structural progress flow based upon the status change; and/or further comprising: identifying at least a second building element associated with the structure based upon construction status identifier, and/or modifying one or more operations associated with the second building element based upon the construction status identifier; and/or wherein: one or more first data entries of the first dataset are generated by a first sensor device, and/or one or more first data entries of the first dataset are generated by a second sensor device; and/or wherein the building material is a cementitious mixture; and/or further comprising, based on the generated construction status identifier, performing one or more of: a causal link analysis, and/or a productivity rate analysis and/or a critical path analysis; and/or further comprising: generating an optimized structural progress flow for completing the structure based upon one or more of: a causal link analysis, and/or a productivity rate analysis, and/or a critical path analysis, and/or a carbon accounting analysis, and/or a cost accounting analysis, and/or a time accounting analysis, and/or a progress curve analysis, and/or a volume accounting analysis; and/or wherein the construction status identifier is associated with a status level from amongst a plurality of status levels; and/or wherein the construction status identifier comprises an aggregation of a plurality of status identifiers associated with the structure; and/or wherein the plurality of status identifiers associated with the structure further comprise one or more sub-statuses and/or one or more super-statuses; and/or wherein the construction status identifier is related to one or more of, a pour of a first building element associated with the structure and/or a curing of the first building element associated with the structure; and/or wherein generating the construction status identifier further comprises: supplying the first dataset to a machine learning model, and/or generating the construction status identifier based upon the output of the machine learning model, wherein the generation of the construction status identifier refers to a: a prediction of a status associated with the first construction site resource at a future time, and/or an inference of the status associated with the first construction site resource based at least in part on the one or more first data entries of the first dataset; and/or further comprising: providing the construction status identifier to a user, and/or receiving one or more inputs from the user responsive to the construction status identifier, and/or modifying the construction status identifier in response to the one or more user inputs; and/or wherein the construction status identifier is communicated to a user via a natural language model based system, and/or the natural language model based system is configured to receive one or more inputs from the user; and/or further comprising: accessing a database storing material identification data associated with a plurality of building material identifiers, and/or determining the material identifier based at least in part on the construction status identifier.

### Wave-Based Devices

In one example, the embodiment includes a device for use in building material related determinations comprising: a housing embedded within, disposed on, and/or directed at a building material; and a wave-based sensor device supported by the housing, wherein the wave-based sensor device is configured to generate one or more first data entries based on an input signal which excites the building material, or a medium associated with the building material.

Additionally or alternatively, in any of the embodiments described herein: wherein the excitation is either mechanical, electric, magnetic, photonic, thermal, chemical, or electromagnetic-based; and/or wherein the excitation is associated with a wave based impulse that is absorbed, reflected and/or emitted by or into the building material, or an associated medium; and/or wherein the wave-based sensor device comprises a spectroscopy-based device configured to generate the one or more first data entries based upon electromagnetic energy that is absorbed, reflected, and/or emitted by or into the building material; and/or further comprising a computing device operably coupled with the spectroscopy-based sensor device, wherein the computing device is configured to: receive a first dataset comprising one or more first data entries associated with a first measurement type of the building material from the spectroscopy-based sensor device; generate a material identifier associated with the building material based upon the first dataset; and/or output the material identifier of the building material; and/or wherein the material identifier is indicative of one or more of: a composition of the building material, and/or a unique mixture related classifier of the building material and/or one or more material properties of the building material; and/or wherein the spectroscopy-based sensor device is configured to generate the one or more first data entries via one or more of: Laser Induced Breakdown Spectroscopy (LIBS), and/or Raman spectroscopy, and/or Fourier transform infrared (FTIR) spectroscopy, and/or Hyperspectral imaging spectroscopy, and/or Nuclear magnetic resonance (NMR) spectroscopy, and/or X-ray diffraction (XRD) spectroscopy, and/or Diffuse Reflectance Spectroscopy (DRS); and/or wherein the spectroscopy-based sensor device is further configured to perform mechanical pressure-based measurements for generating the one or more first data entries; and/or further comprising a computing device operably coupled with the spectroscopy-based sensor device that is further configured to perform mechanical stress-based measurements, wherein the computing device is configured to: receive a first dataset comprising one or more first data entries associated with a first measurement type of the building material from the spectroscopy-based sensor device that performs mechanical pressure-based measurements, and/or generate a material identifier associated with the building material based upon the first dataset, and/or output the material identifier of the building material; and/or wherein the material identifier is indicative of one or more of: a composition of the building material, and/or a unique mixture related classifier of the building material, and/or one or more material properties of the building material; and/or wherein the wave-based sensor device comprises a mechanical stress-based device configured to generate the one or more first data entries based upon an input signal which mechanically stresses the building material, or a medium associated with the building material; and/or wherein the mechanical stresses induce mechanical waves that are absorbed, reflected, and/or emitted by the building material or an associated medium; and/or further comprising a computing device operably coupled with the mechanical stress-based sensor device, wherein the computing device is configured to: receive a first dataset comprising one or more first data entries associated with a first measurement type of the building material from the mechanical stress-based sensor device, and/or generate a material identifier associated with the building material based upon the first dataset, and/or output the material identifier of the building material; and/or wherein the material identifier is indicative of one or more of: a composition of the building material, and/or a unique mixture related classifier of the building material, and/or one or more material properties of the building material; and/or wherein the spectroscopy-based sensor device further comprises a light source configured to emit the electromagnetic energy applied to the building material; and/or wherein the spectroscopy-based sensor device further comprises one or more detectors configured to receive the electromagnetic energy reflected and/or emitted by the building material; and/or wherein the spectroscopy-based sensor device is further configured to modify a direction at which the electromagnetic energy emitted by the light source is applied to the building material; and/or wherein the spectroscopy-based sensor device further comprises an adaptive lens operably coupled with the light source and configured to at least partially direct the electromagnetic energy emitted by the light source; and/or wherein the adaptive lens is movable relative the housing and/or the building material so as to modify a direction at which the electromagnetic energy emitted by the light source is applied to the building material; and/or, wherein: the housing is configured to be embedded in the building material, and/or the housing defines a spherical shape, and/or the spectroscopy-based sensor device is movably attached to the spherically shaped housing so as to rotate about the housing to apply electromagnetic energy to the building material in any direction; and/or wherein the wave-based sensor device further comprises: a spectroscopy-based device configured to generate the one or more first data entries based upon electromagnetic energy that is absorbed, reflected, and/or emitted by the building material, and/or a mechanical stress-based device configured to generate the one or more first data entries based upon mechanical stresses induced in a medium associated with the building material, wherein the wave-based sensor device is operably coupled with a computing device configured to: receive the first dataset comprising the one or more first data entries and/or determine one or more material properties of the building material based upon the first dataset; and/or wherein the induced mechanical stresses are mechanical waves that are absorbed, reflected, and/or emitted by the building material; and/or wherein one or more of the operating parameters of the spectroscopy-based sensor device are modified in response to the generated material identifier; and/or further comprising a computing device operably coupled with the wave-based sensor device, wherein the computing device is configured to: receive a first dataset comprising one or more first data entries associated with a first measurement type of the building material from the wave-based sensor device, and/or determine one or more material properties of the building material based upon the first dataset; and/or further comprising one or more additional sensors and/or actuators to enable context awareness measurements in association with the wave-based measurements; and/or wherein the context awareness data includes one of environmental data, temperature data, depth data, positioning data, building material geometry data and the context awareness data is used to correct the wave-based measurement based on the device contextual conditions of the wave-based device.

### Further Wave-Based Sensor Device Related Embodiments

In one example, the embodiment includes a method for material characterization whereby one or more measurements of the material are taken, optionally at different times/curing ages and/or different locations within the materials, from one or mode devices disposed on, embedded in, or disposed in proximity of, or directed at the material.

Additionally or alternatively, in any of the embodiments described herein: wherein the one or more measurements are related to a material response (including passive or active responses); and/or wherein the one or more measurement are impedance or admittance measurements of the material (or other related quantities); and/or wherein the measurement is related to a frequency, amplitude, intensity, field strength, power, attenuation, polarization, frequency shift, time, phase shift or spatial response (including wave diffraction, refraction, dispersion) of the material or of the measured characteristic of the material; and/or wherein the measurement is related to the time of flight, time of arrival, time of departure, relaxation time or response time of the material; and/or wherein the impedance or admittance is one of: mechanical, acoustic, elastic, electrical, magnetic, electromagnetic wave, optical, electrochemical, magnetochemical, electromechanical, magnetomechanical, electromagnetomechanical, opto-mechanical, opto-electric, opto-magnetic, opto-chemical impedance or admittance; and/or wherein the characteristic (e.g. impedance or admittance) is frequency dependent, and is determined for one or more frequencies, and one or more locations within or on the surface of the material, and optionally, where a characteristic (e.g. impedance or admittance spectrum, or any of its real or imaginary components) is determined over a frequency and/or input power range; and/or wherein the material characteristic (e.g. impedance) is measured at a one or more frequencies by exciting an actuator with an excitation signal, and measuring the response of the material using a sensor (optionally where the material characteristic is a complex number, and its real and imaginary parts, or amplitude and phase, are determined); and/or wherein an actuator and/or sensor are coupled, directly or indirectly, to concrete; and/or wherein the excitation signal is one of: a single-sine, a multi-sine, a single or multi-frequency pulse, a frequency sweep (optionally with up-chirping or down-chirping), optionally wherein the excitation is driven through a time-varying electric field (e.g. current or potential); and/or wherein the same element acts as an actuator and a sensor; and/or wherein the sensor and actuator are separate elements, which may be colocated or spatially separated within the material; and/or wherein the actuator element and/or sensor element are coupled to one or more other element, wherein such other elements exhibits one or more field coupling (e.g. electro-mechanical, magneto-mechanical, opto-mechanical, electromagneto-mechanical, electrochemical, magnetochemical, opto-electric), and wherein such element either transduces between different forms of energy, or changes property based on such field coupling; and/or wherein the one or more other elements are bonded or directed at, directly or indirectly, to the material (e.g. concrete), across one or more locations within a building element; and/or wherein the one or more other elements are a piezoelectric, piezoresistive, electrostrictive, magnetoelastic, magnetostrictive, photoelastic, photomechanical, mechanoluminescent, thermoelectric material, or a CMUT transducer, an EMAT transducer, a speaker or microphone; and/or wherein the resonance peaks of the material characteristic spectrum (e.g. impedance) are identified; and/or wherein properties of the material are determined based on the measurements or characteristic, optionally wherein such determination is carried out by a machine learning or physico-chemical model, or hybrid machine learning physico-chemical model; and/or wherein the one or more elements are coupled to, disposed in, or in proximity of a frame; and/or wherein the frame is one or more of a waveguide, membrane, convex volume with an open face that is able to contain concrete etc; and/or wherein the frame induces or enhances resonance modes of the system, which are then measured using one or more sensing element, and optionally the frame dimensions are related to the wavelength of the components of the excitation signal(s); and/or wherein the frame induces wave reflections, which are then detected by the one or more sensor elements;

Additionally or alternatively, in any of the embodiments described herein: wherein the frame is made up of one or more of: a mechanical oscillation absorber or reflector; and/or an electromagnetic wave reflector or absorber; and/or an electric signal absorber or reflector; and/or a magnetic signal absorber or reflector; and/or a photonic signal absorber or reflector; and/or a hybrid material (which may have a custom mechanical and/or electromagnetic absorption and/or reflection spectra or properties); and/or wherein the one or more elements are constructed in geometrical configurations to generate or enhance resonance modes (such as rings, tuning forks, cylinders); and/or wherein the one or more elements are macroscopic or microscopic composite materials, optionally, where they have been micromachined to exhibit particular characteristics; and/or wherein the actuator is an EMAT transducer, and it is electromagnetically coupled to a frame, which is itself coupled (directly or indirectly) to the concrete, and optionally such frame is geometrically designed to act as resonator; and/or wherein the system is configured to characterize S or T parameters at one or more frequencies of sensors disposed within the material; and/or wherein the actuator is configured to send one or a plurality of electromagnetic wave (e.g. RF, Radar, Terahertz) at one or a plurality of frequencies through the medium, and the response is characterized; and/or wherein the electromagnetic wave is a GPR pulse of one or more predetermined frequencies, and where characteristics of the material are determined based on one or more of: the time of reflection or transmission of the GPR signal (optionally determined based on the time difference between peaks in the GPR signal), or the attenuation of of one or more reflected signals (optionally calculated based on the decay of the peak amplitude of the signal), or the GPR signal measurement at different frequencies; and/or wherein a receiver antenna (sensor) and transmitter antenna (actuator) are colocated and configured to measure signal reflections within the material based on either an opportunistic reflector present in the medium, or a reflector or cavity that forms part of the device assembly; and/or wherein the device is embedded in a cementitious mixture, and the dielectric of the cementitious mixture (at one or more frequencies) is determined based on the GPR measurement, optionally from which the water to cement ratio is determined.

Additionally or alternatively, in any of the embodiments described herein, combined with an additional sensor datasource, configured to determine the water to cement ratio, and another characteristic of the cementitious mixture (e.g. its compressive strength);

Additionally or alternatively, in any of the embodiments described herein: wherein the actuator and sensor are mechanical in nature, and the actuator is excited (through an applicable coupling), to generate mechanical oscillations in the medium at one or more frequencies, with the sensor configured to sense mechanical displacements experienced by the medium; and/or wherein the actuator is bonded to the material through a flexible material or coating to ensure good adherence; and/or wherein the mechanical actuator is integrated into, disposed in, within, or in proximity of a frame, and optionally wherein such frame is able to envelope or contain part of the material, to enhance mechanical resonance modes; and/or wherein the active element of the mechanical actuator (or a composite made up of mechanically active/coupled material, and inactive material) is shaped to generate or enhance resonance modes (e.g. shaped like a ring, hollow cylinder, tuning fork etc.) in the material; and/or wherein the mechanical actuator and sensor are one or a combination of an electromechanical, magnetomechanical, optomechanical, electro-magneto-mechanical (or other similar) actuators; and/or wherein the mechanical element is made up of one or multiple piezoelectric devices, a CMUT transducer, a speaker or microphone, a photomechanical material, a photoelastic material; and/or wherein the measurement is an mechanical impedance spectrum measurement (including an electromechanical, magnetomechanical or photomechanical impedance measurement), and features are extracted from the impedance spectrum; and/or wherein the material is a cementitious mixture, and the feature of the measurement are resonance peaks, from which the speed of sound in the medium and/or the dynamic modulus of the material is determined, and optionally, are used to determine the static modulus or compressive strength, or any other static or contextual material property; and/or wherein the sensors and/or actuators are spatially distributed; and/or wherein the plurality of actuators are excited with one or more signals of predetermined phase shifts (e.g. in or out of phase), sequentially or in parallel, to construct a phased array; and/or wherein the phased array is used for spatial tomography mapping of the material, to construct a spatial distribution of the material response, and optionally map material inhomogeneities; and/or wherein the measurement is adjusted, corrected, normalized, compensated, or transformed based on contextual material and/or device condition data, optionally using context awareness methods; and/or wherein the contextual condition data is derived from another sensor and/or actuator, which may be colocated or separated from the first sensor and/or actuator, optionally on the same device, or on a different device; and/or wherein the contextual condition data being is temperature and/or humidity and/or moisture data or other environmental characteristic, which is used to correct the adjust the material measurement (e.g. impedance) to determine a material characteristic; and/or wherein the actuator and/or sensors form part of one or more battery-powered or energy harvesting devices, designed to be embedded in concrete, and be fixed to reinforcement, employs advanced RF techniques to communicate out of the concrete, and where signal excitations are generated by the MCU using PWM techniques, and responses are sampled by the MCU; and/or wherein the material is a cementitious mixture, and the measurements are derived using photonic waveguides;

### Opto-Mechanical Device Embodiments:

In one example, additionally or alternatively, in any of the embodiments described herein, the wave-based device may be an opto-mechanical device, comprising one or more of: a photoelastic material; and/or a photomechanical material; and/or a mechano-luminescent material.

Additionally or alternatively, in any of the embodiments described herein: wherein one of a photoelastic material, or mechano-luminescent material, are embedded into or disposed into one another (in any possible combination), or embedded into or disposed into another material, to create a composite; and/or wherein the embedding or disposition of one material into the other (or into another material) is isotropic and/or microscopic, optionally within the material's matrix, so as to create one or more of: a mechano-luminescent photomechanical material, and/or a photoelastic photomechanical material, and/or a photo-elastic mechanoluminescent material; and/or a photomechanical and mechano-luminescent materials are disposed in one another (or into another material), and the wavelength response of the mechano-luminescent material spans a different frequency range to that of the photomechanical material; and/or wherein the materials are used either as a sensor for mechanical displacements, or as an actuator to generate mechanical displacements and deformations, which is optionally embedded into a host material; and/or wherein the sensors or transducers are further coupled to an electronic control system, or a photonic control system, which is able to control the sensor or actuator; and/or wherein electronically controlled sensors or actuators are embedded in a cementitious mixture, to measure mechanical properties of the cementitious mixture, such as shrinkage or mechanical impedance; and/or wherein the composite element is used as both a sensor and an actuator; and/or wherein the device spans an area or volume which can be spatially excited at different positions using incident light, to spatially sample or excite the element and/or the host material; and/or wherein the incident light is used to produce adaptive geometries, which can enhance particular resonance modes, or excitation properties; and/or wherein the composite is a component of a micro-opto-mechanical-system (MOMS); and/or wherein the device is configured to measure a hyperspectral image of a concrete surface; and/or wherein the hyperspectral device also includes an actuator which is a light source which, that can be used to illuminate a surface of the material; and/or wherein the device is disposed on the surface of, or embedded in the concrete, and bonded with the material so as to create a light-proof chamber, in which the hyperspectral sensor and the light source are disposed; and/or wherein the light source is a broadband light source which is excited to illuminate the concrete surface, and the hyperspectral imaging sensor is used to construct a hyperspectral image; and/or wherein the light source is composed of a plurality of narrow-band light emitters, that can be excited individually to adaptively illuminate the concrete surface with different wavelengths of light, and a regular camera sensor is used to record the response at each excitation frequency, from which a hyperspectral image of the surface is determined; and/or wherein the hyperspectral image is processed, and characteristics of the material are determined, optionally where such processing utilizes a machine learning model, or a physico-chemical model, or a hybrid model; and/or wherein the characteristic being determined is a static or contextual or compositional material property; and/or wherein the device is a mobile device that executes any of (or parts of) the methods of the preceding claims.

### Frames-Related Device Embodiments:

Additionally or alternatively, in any of the embodiments described herein, a device comprising: one or more frames (optionally interlocking) designed to form a geometric structure in the concrete, optionally designed to contain a local volume of concrete surrounding the frame, or to include voids to allow concrete to flow into an inner volume; One or more wave-based sensing elements, an MCU, a power source, and a wireless communication interface (Bluetooth, BLE, WiFi, LoRa, NB-IoT, satellite or similar).

Additionally or alternatively, in any of the embodiments described herein: wherein such elements are either permanently or modularly mounted on to the one or more frames (e.g. through modular ‘cards’); wherein the wave-based sensing elements are configured for E&M, Mechanical or Thermal Wave-Based sensing (e.g. impedance spectroscopy); wherein the device assembly includes a means for fixing the interlocking frame such that it is embedded within a concrete pour.

Additionally or alternatively, in any of the embodiments described herein, devices employ actuators to excite host materials, or a second material which is coupled to the host material, wherein the excitation is a time-varying (optionally periodic) signal (which may be an oscillatory signal, a wave, or a custom excitation profile in the field of interest). Devices may also employ sensors to measure the response of the host material (directly, or indirectly through the response of an another material coupled to the host material).

Additionally or alternatively, in any of the embodiments described herein, the device is configured to measure one or more responses of the following type: amplitude, intensity, field strength, power or attenuation responses; polarization shift or responses; frequency shift or responses and/or dispersion relations; time-based responses, including but not limited to one of phase shifts or responses, absolute times of flight, or response times and relaxation times; spatial responses, including but not limited to one of refraction, dispersion and diffraction patterns; or any other secondary effect wherein energy is transformed into another form and can be measured (e.g. material expansion).

Additionally or alternatively in any of the embodiments described herein, these responses can also be measured over multiple positions in space (spatially distributed excitation & spatial response of each of the above); and/or multiple input frequencies (excitation at a plurality of frequencies, with response of each of the above measured at each frequency); and/or combinations of the above, including one or more S parameters & T parameters and/or Tomography.

Additionally or alternatively in any of the embodiments described herein, wave-based sensor may also measure any of impedance, admittance, intensity, field strength vectors, power, wave velocity (group velocity or phase velocity), amplitudes, phase shifts, S or T parameters or their analogues, polarization, absorptions, transmission, reflection, transfer functions, amplitudes, phase shifts, frequency shifts, dispersion relations, fourier spectrums, resonance peaks, coherence, beam width, diffraction patterns, time of flight, frequency, wavelength.

Additionally or alternatively in any of the embodiments described herein, sensor outputs may be scalars, vectors, or tensors, may vary in time, or in space.

As would be evident to one of ordinary skill in the art in light of the present disclosure, each of the aforementioned embodiments may be implemented as part of or otherwise performed by a computer program product comprising at least one non-transitory computer-readable storage medium storing program instructions that, when executed, cause an apparatus to perform the operations described herein.

Additionally, the section headings used herein are provided for consistency with the suggestions under 37 C.F.R. 1.77 or to otherwise provide organizational cues. These headings shall not limit or characterize the invention(s) set out in any claims that may be issued from this disclosure.

Use of broader terms such as “comprises,” “includes,” and “having” should be understood to provide support for narrower terms such as “consisting of,” “consisting essentially of,” and “comprised substantially of” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

What is claimed is:

1. A computer-implemented method for construction data linkage, the method comprising:
receiving a first data element comprising one or more first data values;
receiving a second data element comprising one or more second data values;
determining an association between the first data element and the second data element; and
generating a data linkage between the first data element and the second data element based on the association.

2. The computer-implemented method according to claim 1, wherein the first data element and the second data element are associated with a building element.

3. The computer-implemented method according to claim 1, wherein one or more of the first data element and the second data element are associated with one or more of:
a spatial representation associated with a structure;
a structural progress flow associated with the structure;
one or more data entries associated with at least a first sensor device;
one or more data entries associated with a crush test result;
one or more data entries associated with a mix identifier; and/or
a status identifier associated with a construction site resource.

4. The computer-implemented method according to claim 1, wherein the data linkage between the first data element and the second data element is determined based on the one or more first data values and the one or more second data values.

5. The computer-implemented method according to claim 1, wherein the data linkage between the first data element and the second data element is determined based on one or more data entities other than the first data element and the second data element.

6. The computer implemented method according to claim 1, wherein the data linkage between the first data element and the second data element is probabilistic and defines an associated confidence value, confidence distribution, or probability distribution function over a parameter of interest.

7. The computer-implemented method according to claim 1, wherein the data linkage between the first data element and the second data element defines one or more data dependencies between the first data element and the second data element, wherein the one or more data dependencies are configured to:
dynamically modify the second data element in response to a modification associated with the first data element; and/or
dynamically modify the first data element in response to a modification associated with the second data element.

8. The computer-implemented method according to claim 1, wherein the one or more first data values and/or the one or more second data values are generated based at least in part operations associated with a sensor device.

9. The computer-implemented method according to claim 1, wherein the data linkage between the first data element and the second data element is updated or determined in response to performance of one or more machine learning (ML) models.

10. The computer-implemented method according to claim 1, where the first data element and the second data element are stored by a database comprising a plurality of data elements, one or more of which are associated with material identifiers indicative of respective formulations defining a proportion of constituent components forming the building material.

11. The computer-implemented method according to claim 1, further comprising:
upsampling or downsampling a granularity of one or more data elements; and
associating at least one aspect of a subdivided or aggregated first data element to one aspect of a subdivided or aggregated second data element.

12. The computer-implemented method according to claim 11, wherein:
the first data element is a BIM model or a construction schedule, and
the second data element is associated with a sensor.

13. A computer-implemented method for construction data access, the method comprising:
receiving an access request, wherein the access request includes one or more data entries associated with a user;
determining one or more access permissions for the access request; and
providing access to a database comprising a plurality of data elements, one or more of which are associated with material identifiers indicative of respective formulations defining a proportion of constituent components forming the building material.

14. The computer-implemented method according to claim 13, wherein the access request is received in response to one or more sensor device registration operations.

15. The computer-implemented method according to claim 13, wherein the access to the database for the user is limited based at least in part on the one or more access permissions.

16. The computer-implemented method according to claim 13, wherein the access request is received in response to one or more measurement operations performed by a sensor device.

17. The computer-implemented method according to claim 16, wherein the one or more access permissions for the access request are determined based at least in part on a material identifier associated with the one or more measurement operations.

18. The computer-implemented method according to claim 13, further comprising supplying the one or more data entries associated with the user that are received with the access request to a machine learning (ML) model, wherein the one or more access permissions for the access request are based at least in part on an output of the ML model.

19. The computer-implemented method according to claim 13, further comprising modifying the one or more access permissions of the access request in response to a modification to the one or more data entries associated with the user.

20. The computer-implemented method according to claim 13, wherein the database comprising the plurality of data elements, one or more of which are associated with material identifiers indicative of respective formulations defining a proportion of constituent components forming the building material is iteratively updated.
